(19) United States
(12) Patent Application Publication
(10) Pub. No.: US 2016/0197993 A1
(43) Pub. Date: Jul. 7, 2016

(54) Meosk/Weosk-Based Private and Social Media Management And Communication System Network

(71) Applicant: BKS Networks,Inc., Darien, CT (US)

(72) Inventors: Thomas J. Perkowski, Darien, CT (US); Richard M. Targett, Moraga, CA (US)

(21) Appl. No.: 14/590,004

(22) Filed: Jan. 6, 2015

(51) Int. Cl. H04L 29/08; H04L 29/06

(52) U.S. Cl. CPC H04L 67/1097; H04L 67/02; H04L 67/306; H04L 69/16; H04L 67/42

(57) ABSTRACT

An Internet-based private and social media management and communication system network supporting the creation and deployment of activity-specific meosk structures, and activity-specific weosk structures deployed on the system network, supported on the display screens of client systems, and linked to the specific activities of system users, allowing users pursuit their interests and activities, while brand marketers are invited to provide their support to such consumer interests, activities and pursuits.

### BACKGROUND OF INVENTION

1. Field of Invention

The present invention relates to new and improved methods of and apparatus for helping individuals, and groups of individuals, including families of diverse structures, during the various phases of their life journeys and pursuits, to better capture, store, organize, manage and communicate digital information content over the Internet infrastructure, within private and social media networks, while enlisting the support of product and service brands they enjoy and trust.

2. Brief Description of the State of Knowledge in the Art

From the earliest moments of life, each individual struggles to make sense of knowing who they are, what they stand for and against, and what legacies (e.g. contributions) they will leave behind so they will be remembered by their families, friends and society at large.

During daily life, with the freedoms available to most individuals, any individual can easily loose their sense of self-identify, self-worth and purpose while seeking to identify with others and gaining acceptance and ranking on today's social networks. During such competitive social struggles, nothing can be more purposeful than showcasing ones interests, talents and dreams, and fueling ones passions, to set the anchor in one's sense of self-worth, self-identify and self-appreciation.

An individual's reasons for pursuing this quest may be to discover: (i) new purposes beyond work; (ii) new opportunities for enjoyable activities and self-expression; (iii) new ways of achieving personal fulfillment and self-enrichment; or (iv) new ways of spiritual expression. These purposeful activities, or rather experiences, play a large role in determining how individuals see themselves, and define their identities, beyond work, family and social status. Such purposeful interests and activities—that build a strong sense of self-worth and reinforce one's self-identity—can help individuals safely navigate through the rough and dangerous waters of life.

Currently, there is a growing awareness of the value that recreational interests and activities play in the lives of all individuals that is, in terms of developing a strong sense of self-worth, self-identity and purpose. Most individuals invest in interests and activities (e.g. arts, recreational sports, crafts, hobbies, etc) that follow or fuel their passions, whatever they might be. Also, the market is growing for recreational interests and activities—helping to give life a deeper sense of purpose beyond the workplace. In 2013, there are millions of people around the world: practicing particular religions; playing little league baseball; playing soccer; participating in ballet; quilting; skate boarding; following football; home brewing; knitting; hiking/backpacking; and the list goes on.

Also, as personal experiences influence and change an individual's interests and recreational activities over the course of their lifetime, typically the individual's passions for things are less likely to change over time, and often persist, as if encoded into the individual's inner nature. It is not uncommon for the interests and activities in which an individual may have invested a great amount of time, energy and resources during an earlier part of their life, to appear less vested and important as the individual grows older. However, the life experiences beneath these prior interests and activities can be of great value to the individual during self-reflection and self-discovery, as well helping to remind where individual has been, what the individual has done, what the individual has stood (up) for, and what has actually mattered in the life of the individual. This self-reflection and self-discovery process can often help reinforce and anchor an individual's sense of self-worth and self-identity later in life when they are less active with respect to their past interests and activities, and find themselves caught up in the storms and rising tides of their lifetime.

As individuals press on with their lives, struggles and aspirations, brand marketers continue to pursue ways of influencing individuals to buy and consume their particular brands of products and services. When an individual consumer finds a product or service brand they truly like or love, then they may decide to pledge their allegiance to that brand with a sense of loyalty if it suits them to do so. While brand marketers seek to develop such brand loyalists, the truth is that most individuals usually find and adopt brands that support them, their needs, and the purposes of their lives.

In the individual's quest for happiness and meaning in life, they do things for themselves and also for others, they do things that bring enjoyment, self-satisfaction and energy to their lives. They do things that are not necessarily going to improve their social rankings on any social network, but which are central and influential in (i) developing their sense of self-identity, (ii) assessing and defining their sense of self-worth, and (iii) representing things that matter dearly to them above thousands of other things seeking their attention. These activities constitute an individual's legacy and are truly the hallmarks of their lives because these activities often mark their lives in unique and special ways that strike to the nature and character of the individual.

Along this journey called life, it's natural and common to ask—what really matters?

Each individual knows things about themselves that no one else does. Some of these things they want to share with others, and some things they do not wish to share. And the things individuals do share rarely tell the whole story about their true lives and what was significant to them while they walked the face of our Earth. It is a simple fact of life that few care to know all the details of an individual's lives, except the individual himself/herself. However, individuals make decisions, often quick ones, about disclosing information to the public about their lives, for various reasons: to improve social ranking status, achieve a sense of class mobility, to inform others, and/or achieve a sense of self-expression.

As each individual progresses through different life stages, many individuals will hope to someday reflect upon, and share their legacies with themselves to re-enforce their self-identity, and also in the future with others who want to learn more about who the individual was, where the individual has been, and what the individual actually did with their lifetime, beyond a resume or curriculum vitae. As an individual's future remains an unwritten part of his or her legacy, representing great potential, it cannot actually be a part of their legacy until this potential is realized sometime in the future. With this understanding, each individual can continue to discover and define their legacy on their own terms, and not on the terms of others.

In addition to wishing for blessing such as good health and economic prosperity, most everyone also wishes that those they deeply love, such as their children, grandchildren, nieces, nephews and younger relatives, will grow up with a strong sense of self-awareness, self-identity and self-confidence, necessary to meet the challenges they face in today's world and throughout their future lives.

Historically, when families lived closely together, and were not distributed across states, countries and the globe, stories of family history, struggles, triumphs and heritage were passed on to children by oral storytelling so that children would grow up with a strong sense of self-awareness, self-identity and self-confidence. Back then, family members who lived locally were able to actively and meaningfully contribute to the lives of the younger generation of children in their family, though such oral storytelling traditions. However, over time, with improvements in transportation and travel, and expansion of economies, people dispersed from their families in geographical directions, making it more difficult for family members to actively and meaningfully contribute to the lives of the younger generation of children in their family. Over the past hundred years, advances in communication technologies such photographs, movies, the telephone, the Internet, Internet-based video-conferencing (e.g. Skype), social-networks (e.g. Facebook) and mobile have provided the younger generation with greater options in speaking with distant family members and the older generation, often living many miles aware, from acquiring knowledge, history, heritage and wisdom.

However, even with modern advancements in video-conferencing, social networking, and digital imaging and archiving in cloud-based servers, there are many family members in every child's life who will pass away during the first four-five years of a child's life, and there will be little or no record of their great interest, concern and love for the child, or what might exist, will never be understood by the child as they grow up. Clearly, this sort of knowledge about these family members in the child's life would be of great value to the child as he or she grows a little older, and is able understand the world around them with greater sense that only comes with age and maturity.

Also, there currently exist other challenges and factors preventing family members from actively and meaningfully contributing to the lives of the younger generation of children in their family. Among these challenges and factors are that:

(1) both parents are required to work full-time jobs to make the economics of their family households work, make it increasingly difficult for them to raise their children and spend quality time with them;
(2) it is very difficult to find the right work/life balance that addresses (i) the economic and emotional aspects of our lives, and (ii) how to positively impact those we care most deeply about;
(3) important family members (e.g. grandmothers, grandfathers, uncles, aunts and relatives) are not in the social networks of most people raising children;
(4) current social networking tools fail to provide adequate message sharing, handling and access to support the needs of the extended family ecosystem; and
(5) current social networking tools also fail to provide adequate access to many extended family members not having access to the Internet through their mobile cellular phones.

Consequently, almost each one of us walks through life with “missing pieces” of our personal and family history which only works against the development of a stronger sense of self-awareness, self-identity and self-confidence. Also, studies have shown that a young child with a strong sense of awareness of the roles and interest shown by extended family is the single biggest factor contributing to the development of a strong sense of self-identity and self-confidence

While most individuals would welcome help organizing and managing information and media relating to the things that interest and matter to them, conventional cloud-based, and off-line, information managers, organizers and social networking tools offer little help, leaving the individual to his or her own devices.

For example, conventional online Social Networks, such as Facebook, Google+et al, seek to serve the needs for love/belonging and esteem. However, social networks currently do not serve well the human need for “esteem” or “self-actualization”, and encourages all personal information about an individual to be published in effort to improve social ranking

While Pinterest, an online social-network based pin-board system network, allows individuals to collect and share what interests and inspires them with others publically, it does not encourage or support personal introspection, reflection and strategic thinking about ones life, but rather encourages continuous open disclosure on whatever comes to mind, or might be of interest.

In past few years, cloud-based information storage and retrieval services, such as Evernote®, have been deployed allowing individuals to upload notes, photos, videos and other digital assets to an individual's user account, and access stored information using mobile and other devices. While this tool provides a useful way of storing and retaining all sorts of personal and business information, it offers little or nothing in the way of while helping individuals develop a deeper sense of self-identity, self-worth and purpose while traveling along a pathway of self-actualization.

Also, cloud-based electronic portfolio technology, such online portfolio management systems (also known as an e-portfolio, or digital portfolio) is a collection of electronic evidence assembled and managed by a user, usually on the Web. Such systems allow users to display and organize their information in a straightforward manner, designed to empower students, professionals and educators to organize, manage and display academic and career information to enhance education, promote achievement and advance careers. Such electronic evidence may include inputted text, electronic files, images, multi-media, blog entries, and hyperlink. E-portfolios can be used as platforms for self-expression, and, if they are online, can be maintained dynamically over time. E-portfolios can go viral and be passed on to be easily viewed by many on the WWW. Also, e-portfolio can be used to promote the history and the goals of an individual.

The mobile service, HOOK-IT™, allows extreme sports athletes to create e-portfolio around the scheduled sports activities, build interest, attract fans and solicit sponsorship of brands, as they work towards entering the professional world of sports, this service offers little for those with interests outside of the sports field. However, this service fails to recognize that millions of individuals around world seek things other than growing fan-bases and fame in sporting activities.

The recent rise of interest-based social networks such as Interest based networks such as Pinterest, Quora, Mightybell, PandaWhale, Thumb and Fitocracy indicates that people are organizing around particular interests, and that brands and advertisers are searching for new opportunities to adapt and connect more effectively with their target markets.

Over the past decade, there is a growing interest in recording and preserving the voices and experiences of everyday people. The national project, Storycorps.com, seeks to instruct and inspire people to record each others' stories in sound. Also, web-based tools such as LifeStory.com encourage others to create a lifestory that allows one to remember and share the inspiring stories of someone who has passed away. Sites like lifestorynet.com, and greatlifestories.com, support online life-stories (i.e. obituaries) that can be viewed by others to carry on the legacy of the deceased.

At the same time, social media networks have re-ignited relationships with past acquaintances where physical distances and changing stages of life had once interceded. However, a typical user's circle of friends does not include many from their extended family. Targeted ads support this business model.

Spontaneous social media sites such as Instagram are convenient for capturing and posting events in the moment and then to suddenly disappear Typically, short lived “in the moment” events do not build lasting memories. Also, while current photo-sharing sites such as Flikr et al are more closely aligned with extended family and group activities, these sites stop well short of trying to provide a meaningful contribution to the lasting story.

While the Facebook platform's “group technology” provides a powerful means for organizing groups of Facebook members around particular topics of interest, and providing group members with access to albums of photos, videos, and various kinds of files, administration of Facebook groups is challenging for most Facebook users due to sharing issues, permission and authentication requirements which can prevent different members from not having proper access to the social media about which the group was formed. Also, when using Facebook group technology, group creation and account management is shackled with many restrictions that prohibit creative uses of this technology. While messaging among members in a Facebook group is enabled, the storage of these group messages is highly restricted, thereby preventing many innovative applications from realization. Current restrictions imposed on social media management between different groups, and also constraints on interaction between group members prevents potentially great things from happening, thereby encouraging a very restricted class of social behavior. Also, searching for and managing social media within any Facebook group is very limited and restricted, again preventing innovative forms of information management, social communication, and human behavior that hinders individual reflection, growth and freedom.

Also, Applicant has developed and deployed object-oriented based, server-sided driven multi-mode virtual kiosk (MMVK) technology to help solve various marketing communications problems facing consumer product and services industry, as taught in U.S. Pat. Nos. 8,458,055; 7,904,333; 7,848,492; 7,711,598, incorporated herein by reference. However, Applicant's MMVK technology has been very limited in its functionalities and unable to address the media management and communication problems arising in private and social media network environments.

Clearly, there is a great need for better systems, methods and technologies for organizing and managing information on things that interest and matter to individuals, without abandoning the many benefits that conventional social networks seek to offer, while allowing brands new and improved ways of building relationships with consumers who are interested in their products and services, and overcoming the shortcomings and drawbacks of prior art apparatus and methodologies.

Also, there is a great need in for better systems, methods and technologies that help communicate stories and build memories with the children of their younger generation about their lives and the people who were an important part of it, so as to the better prepare the next generation of children to live happier, more productive and fulfilling lives, while overcoming the shortcomings and drawbacks of prior art apparatus and methodologies.

### SUMMARY AND OBJECTS OF THE PRESENT INVENTION

Accordingly, a primary object of the present invention is to provide a new and improved Internet-based method of and system network for deploying and managing meosk-based and weosk-based virtual file and operating (VFOS) systems over a cloud-computing system architecture for managing and sharing information and media relating to the moments in an individual's lifetime, as well as groups of individuals over their lifetimes, while overcoming the shortcomings and drawbacks of prior art apparatus and methodologies.

Another object of the present invention is to provide such an Internet-based method of and system for managing information and media relating to the personal pursuits and legacies of individuals over the various phases of their lifetimes, and supporting them in their effort to live meaningful lives and building a deeper sense of self-identity, self-worth and purpose while traveling along a pathway of self-actualization.

Another object of the present invention is to provide a novel Internet-based system network that bridges the divide between young and old, breaks down geographic distances and rebuilds and reignites the foundation of the extended family ecosystem network.

Another object of the present invention is to provide a novel Internet-based system network that comprises client application software for mobile devices, tablets and desktops, and supports a communication and message processing infrastructure that allows conventional mobile phones supporting SMS and/or email to share captured moments (e.g. photographs) with those users using the client application software on their smart phone devices.

Another object of the present invention is to provide a novel Internet-based system network that helps enhance or children's emotional IQ in a fun and meaningful way that has never been seen or done before.

Another object of the present invention is to provide a novel Internet-based system network that enables family members, who are geographically distributed around the globe and/or traveling extensively, to become active and meaningful contributors to the lives of children in next generation of their family ecosystem network.

Another object of the present invention is to provide a novel Internet-based system network enables grandmothers, grandfathers, uncles, aunts and other extended family, who are not typically included in the social networks of most people raising children, to actively participate in and contribute to the development of important memories in the family's younger generation of children.

Another object of the present invention is to provide a novel Internet-based system network enables extended family members, not having access to the Internet through their mobile cellular phones, to capture, share, contribute, respond and give gifts during the memory building process across the extended family.

Another object of the present invention is to provide a novel Internet-based system network that makes it easier for parents working full-time jobs to positively impact those they care most deeply about, namely their children.

Another object of the present invention is to provide a novel Internet-based system network that is realized using desktop, tablet and mobile HTML5 applications that allow individuals to easily collect, store and sharing information and media about an individual's personal experiences, organized about their special interests and activities pursued with passion, to help support an individual in their life pursuits.

Another object of the present invention is to provide a novel Internet-based system network that allows individuals to request product and/or service brands to establish contact with the individual, and build 1-on-1 relationships with individual consumers who seek brand support while doing the things they enjoy doing with passion and personal interest.

Another object of the present invention is to provide such an Internet-based system network that helps individual users meet the challenge of building a strong sense of self-worth and reinforcing one's self-identity, in a socially competitive world, by recording and managing digital information in Web-based activity specific information portfolios.

Another object of the present invention is to provide an Internet-based system network for managing Web-based meosk structures for the various interests and activities of individuals over the various phases of their lifetimes, helping to strengthen the sense of self-worth and self-identity, documenting their life legacies, enjoying the support of their requested brands, and living a life that matters.

Another object of the present invention is to provide an Internet-based system network for managing Web-based meosk structures for the various interests and activities of families over the various phases of their lifetimes, helping to strengthen the relationships between its members, building their memories, documenting legacies and traditions, while enjoying the support of requested brands.

Another object of the present invention is to provide an Internet-based method of and system for creating, deploying and managing activity-specific meosks designed to enable individual users to collect, organize and manage digital assets relating to their personal activities, interests and experiences, and to share any of these digital assets with others, as shared or public views, accessible over diverse social networks, in a user-controlled manner.

Another object of the present invention is to provide an Internet-based method of and system for creating, deploying and managing activity-specific meosk structures enabling individual users to easily collect, organize, manage and share digital assets relating to personal activities, interests, and experiences, to build a deeper sense of self-identity, self-worth and purpose, and achieve self-actualization.

Another object of the present invention is to provide an Internet-based personal pursuit and legacy information management system for creating, deploying and managing activity-specific meosk structures that can be accessed and managed from any mobile computing device, including desktop computers, mobile computers and other mobile computing devices, and selected views of these meosks shared with others using the same computing technology.

Another object of the present invention is to provide an Internet-based system network for creating, deploying and managing activity-specific meosk structures that can relate to almost any activity, interest, goal, dream, plan or thing that an individual user is pursuing, or in which the individual is otherwise engaged, experiencing and forming memories of past and present experiences, and wherein these meosk structures can be subsequently merged to create composite stories of various aspects of the life of the individual.

Another object of the present invention is to provide an Internet-based method of and system for creating, deploying and managing activity-specific meosk structures, wherein the individual user is prompted to select an interest or activity around which to create and deploy an activity-specific meosk structure, and thereafter, in response to the activity selection by the individual user, the system automatically generates and displays the following items in a graphical user interface (GUIs): (i) a set of generic groups or classes of equipment/goods and/or services that are typically required or used in connection with the selected activity and/or interest; and also (ii) a set of particular brands for each generic group or class of equipment/goods required by the selected activity, from which the individual is requested to select a favorite brand and provide permission to be contacted by the brand for relationship building and other marketing communication purposes which may include, but are not limited to, brand support and sponsorship during the individual's pursuit of his or her activity, for which the activity-specific meosk structure has been created.

Another object of the present invention is to provide such Internet-based system network, wherein individual users who show passion for particular brands can be recruited as a member of the brand's street marketing team, to help promote the brand as the individual naturally shares digital content of their activities and interests being managed within his or her activity-specific meosk structures.

Another object of the present invention is to provide an Internet-based method of creating, deploying and managing activity-specific meosk structures, wherein after an individual user/consumer identifies at least one brand about which the individual user is passionate, and creates and deploys an activity-specific meosk structure on the system network, the system admin automatically sends a message to the identified brand signally or indicating that an individual who is passionate about or interested in the particular brand, wishes to become a member of the brand's street-marketing team, and engaged in communication with the brand in a private and anonymous manner.

Another object of the present invention is to provide such an Internet-based method of creating, deploying and managing activity-specific meosk structures, wherein after a consumer accepts the terms and conditions of using the system network, the brand sends its brand assets and corresponding messages to the system database (via XHTML, email, ftp, or other means), and made available to requesting consumers in their activity-specific meosk structures, and consumers receive notifications on receipt of the brand's assets and message (e.g. invitation, offers etc).

Another object of the present invention is to provide such an Internet-based method of creating, deploying and managing activity-specific meosk structures, wherein upon registration with the system network, the brand management team members gain access to a private brand management center for use when communicating with consumers through activity-specific meosk structures, created and deployed on the system network.

Another object of the present invention is to provide such an Internet-based method of creating, deploying and managing activity-specific meosk structures, wherein upon accepting the terms and conditions of using the system and completing registration with the system network, the brand gains access to a private brand management center containing a pre-constructed set of message forms for use when communicating with consumers through activity-specific meosk structures, created and deployed on the system network.

Another object of the present invention is to provide such an Internet-based method of creating, deploying and managing activity-specific meosk structures, wherein the individual consumer may choose to open and accept a message sent by a brand sponsor, reject the message and whatever it may offer, or simply ignore the brand's message.

Another object of the present invention is to provide an Internet-based method of creating, deploying and managing activity-specific meosk structures, wherein daily, the brand receives metric reports on activity-specific meosk structures, while the consumer is encouraged to strengthen its relationship with its brand, but may expressly terminate the relationship, or neglect the relationship, however the case may be, both informing and providing insight to the brand's management team.

Another object of the present invention is to provide an Internet-based system network for creating, deploying and managing activity-specific meosk structures, wherein digital assets collected and organized within activity-specific meosk structures can be automatically archived to remote servers, desktops and other network computing systems and devices.

Another object of the present invention is to provide an Internet-based system network for creating, deploying and managing activity-specific meosk structures, wherein the individual user can select specific digital assets collected and organized with the activity-specific meosk structure, and share them with others via posts to social communication network web pages, as well as through a public view of the activity-specific meosk structure, which can displayed in one of a variety of possible display formats.

Another object of the present invention is to provide an Internet-based system network for creating, deploying and managing activity-specific meosk structures, wherein the individual user can select specific digital assets collected and organized with the activity-specific meosk structure, and share them with others via a public view of the activity-specific meosk structure, displayed to others in one of a variety of possible display formats.

Another object of the present invention is to provide an Internet-based system network for creating, deploying and managing activity-specific meosk structures, wherein the public view of the activity-specific meosk structure, can be used to display a product, article or any thing created by the individual user, and the public view of the meosk structure can be provided with an e-commerce/show-n-tell button to allow other consumers to purchase the creation, or purchase a good (e.g. product of a brand sponsor) that was used by the individual creator to make the thing showcased in the public view of the activity-specific meosk structure.

Another object of the present invention is to provide such an Internet-based system network, wherein the individual typically creates, deploys and maintains a set of activity-specific meosk structures on a number of different activities and interests being pursued by the individual at any moment in time, and wherein this master activity/interest course list can be exported as a pdf or like document and shared with family, friends and others trusted persons, from whom the individual wishes support and encouragement during their pursuits.

Another object of the present invention is to provide such an Internet-based system network, wherein the master course list of an individual's activities and interests, being time/date stamped, can be compared with others master course at different points of time and at different stages of an individual's life to see how an individual's activities and interests have changed, and evolved, over time, providing an opportunity for reflection and consideration, and development of self-awareness and knowledge.

Another object of the present invention is to provide such an Internet-based system network for creating, deploying and managing activity-specific meosk structures, wherein the public view of the e-commerce/show-n-tell enabled activity-specific meosk structure can be searched for, discovered and viewed on an e-commerce/show-n-tell marketplace that indexes things according to the following criteria: from what things are made; by whom things are made; how long does it take to make the thing.

Another object of the present invention is to provide an Internet-based system network for creating, deploying and managing activity-specific meosk structures, wherein the digital assets in existing activity-specific meosk structures can be combined together in various ways to produce full life-story meosk structures, and these life-story meosk structures can subsequently used to create biographies during later stages of the individual's lifetime, and also to draft obituaries and eulogies at the end of the individual's lifetime.

Another object of the present invention is to provide such an Internet-based system network for use by those who are passionate about their activities and vested interests, as well as those who are concerned about the self-esteem and self-identity of others for whom they care, including, parents, guardians, educational leaders, religious organizations, community leaders, brand marketers, life coach professionals, sports professionals, celebrities standing for individual strength, growth and independence, et al, who are poised to create awareness for the system and encourage the downloading of the system network, and the use of the system which, in turn, will send out positive social messages to recruit others to use the application.

Another object of the present invention is to provide an Internet-based system network for creating, deploying and managing activity-specific meosk structures, wherein each activity-specific meosk structure can be automatically configured around any one of numerous possible interests and/or activities selected by the individual user based on his or her life pursuits at the time of meosk creation and deployment, with the understanding that such interests and/or activities may change over time, as the individual's life unfolds.

Another object of the present invention is to provide an innovative Web-based platform that bridges the divide between young and old, breaks down geographic distances and rebuilds and reignites the foundation of the family ecosystem network.

Another object of the present invention is to provide a Web-based platform enables families to build their own private-social media network supporting collaborative communication and media and information sharing among inner circles of parents, grandparents, aunts, uncles, cousins and extended family—people who contribute to the building of a strong sense of self-awareness in the younger generation and instill them with the self-confidence to go out and make a difference in the world.

Another object of the present invention is to provide a novel Internet-based system network that enables grandmothers, grandfathers, uncles, aunts and other relatives, who are not typically included in the social networks of most people raising children, to actively participate in and contribute to the development of important memories in the family's younger generation of children.

Another object of the present invention is to provide a novel Internet-based system network that enables extended family members, not having access to the Internet through their mobile cellular phones, to capture, share, contribute, respond and give gifts during the memory building process across the extended family.

Another object of the present invention is to provide a novel Internet-based system network that supports the needs of the modern extended family ecosystem in unprecedented ways, allowing everyone to contribute to and participate in the building of family memories, history, and heritage.

Another object of the present invention is to provide a novel Internet-based system network that helps extended family members to fill in the “missing pieces” of the younger generation's personal and family history by capturing, sharing and contributing moments, responding and gifting and building memories with the younger generation, helping to make them aware of their family members, history and heritage.

Another object of the present invention is to provide a novel Internet-based system network that enables the younger generation of children to become more well-rounded persons with a stronger sense of self-awareness, self-identity and self-confidence, essential to meeting the many challenges they face in today's world and throughout the course of their lives.

Another object of the present invention is to provide a novel Internet-based system network that provides its users with easy-to-use moment capture tools for capturing moments of any kind, especially “first moments” in a child's life.

Another object of the present invention is to provide a novel Internet-based system network for storing moments in meosks and sharing among ones family's inner circle.

Another object of the present invention is to provide a novel Internet-based system network for creating weosks for capturing moments for sharing with others.

Another object of the present invention is to provide a novel Internet-based system network.

Another object of the present invention is to provide a novel Internet-based private and social media management and communication system that support simple “his and her” family circles making it easy to store captured moments.

Another object of the present invention is to provide a novel Internet-based private and social media management and communication system can also support family circles in complex arrangements created by divorces and remarriages.

Another object of the present invention is to provide a novel Internet-based private and social media management and communication system that allows the sharing of selected moments with friends and acquaintances across social networks.

Another object of the present invention is to provide a novel Internet-based private and social media management and communication system that enables the generation of storyboards to build and share family memories.

Another object of the present invention is to provide a novel Internet-based private and social media management and communication system that enables the generation of moment-based storybooks containing a set of yearbooks and activity-based books created for review by children using a browser-based application.

Another object of the present invention is to provide such an Internet-based private and social media management and communication system network, wherein each year-based storybook contains a set of messages by family members, linked to each moment in the storybook and available for instant access by the family members, including its younger generation, using a browser-based application.

Another object of the present invention is to provide such an Internet-based private and social media management and communication system network, wherein messages by family members can be text, audio or a combination of text and audio, to bring the message and family member back to life.

Another object of the present invention is to provide such an Internet-based private and social media management and communication system network. wherein moments in its deployed storybooks can be photographic, video, audio, drawings, journal entries, web-clippings, almost any digital media or information element.

Another object of the present invention is to provide such an Internet-based private and social media management and communication system network, wherein storybooks also reflect what gifts family members may have given to the subject of the meosk structure.

Another object of the present invention is to provide such an Internet-based private and social media management and communication system network, wherein deployed storybooks include activity-based storybooks as well as annual-based storybooks and contain favorite moments, capture high school and college memories, memories of family members when you were in college, early family memories, and memories of family members when starting one's family

Another object of the present invention is to provide such an Internet-based private and social media management and communication system network, wherein moments can be easily imported from one's Facebook timeline into activity-based meosk structures that have been set up for one's interests and activities.

Another object of the present invention is to provide an Internet-based private and social media management and communication system that allows users to reconstruct memories from past moments grabbed from ones social media timeline, and then to share them again with family and friends.

Another object of the present invention is to provide such an Internet-based private and social media management and communication system makes it easier for parents working full-time jobs to positively impact those they care most deeply about, namely their children.

Another object of the present invention is to provide such an Internet-based private and social media management and communication system that enables family members, who are geographically distributed around the globe and/or traveling extensively, to become active and meaningful contributors to the lives of children in next generation of their family ecosystem network.

Another object of the present invention is to provide an Internet-based private and social media management and communication system enables grandmothers, grandfathers, uncles, aunts and other relatives, who are not typically included in the social networks of most people raising children, to actively participate in and contribute to the development of important memories in the family's younger generation of children.

Another object of the present invention is to provide an Internet-based private and social media management and communication system also enables extended family members, not having access to the Internet through their mobile cellular phones, to capture, share, contribute, respond and give gifts during the memory building process across the extended family.

Another object of the present invention is to provide an Internet-based private and social media management and communication system providing an innovative suite of message sharing, handling and accessing tools.

Another object of the present invention is to provide an Internet-based private and social media management and communication system that supports the needs of the modern extended family ecosystem in unprecedented ways, allowing everyone to contribute to and participate in the building of family memories, history, and heritage.

Another object of the present invention is to provide an Internet-based private and social media management and communication system which, by enabling the building and sharing of memories with the younger generation, helps to make them aware of their family history and heritage, allowing extended family members to empower its younger generation of children to become well-rounded persons with a stronger sense of self-awareness, self-identity and self-confidence, essential to meeting the many challenges they face in today's world and throughout the course of their lives.

Another object of the present invention is to provide an Internet-based private and social media management and communication system which allows extended families all around the world to share stories and build memories with the children of their younger generation, about their lives and the people who were an important part of it, so as to better prepare the next generation of children to live happier, more productive and fulfilling lives.

Another object of the present invention is to provide an Internet-based private and social media management and communication system enabling everyone in the extended family ecosystem network, including grandmothers, grandfathers, aunts, uncles, and other relatives and friends, regardless of their geographical location, to actively participate in the building and sharing of memories with the younger generation of their family structure.

Another object of the present invention is to provide an Internet-based private and social media management and communication system which allows family members to enhance the emotional IQ of children and developing in them a stronger sense of self-awareness, self-identity and self-confidence, necessary to meet the challenges they face in today's world and throughout their future lives.

Another object of the present invention is to provide an Internet-based private and social media management and communication system comprising network servers and mobile client devices with displays for displaying graphical user interfaces (GUIs) that support the various modules comprising the system network of the present invention and the functions and services supported by the same over a distributed packet-switched communications network, such as the Internet.

Another object of the present invention is to provide an Internet-based private and social media management and communication system that supports social networks consisting of heterogeneous types of actors in family and group structures, with various interactions occurring between the actors who are members of inner circles associated with meosk structures deployed on the system network.

Another object of the present invention is to provide an Internet-based private and social media management and communication system which supports data analysis tools for identifying communities in such social networks, evolving groups, communities and sub-communities, and group membership interactions and relationships, which can help understand the structural properties of the social networks, and assist brands in targeted marketing and finding influential actors within or between groups on the social network.

These and other objects of the present invention are fulfilled by a novel meosk/weosk-based private and social media management and communication system network for creating and deploying (i) a plurality of activity-specific meosk structures for organizing and managing information-based moments related to the activities of individuals and (ii) a plurality of activity-specific weosk structures for organizing and managing information-based moments related to the activities of group of individuals sharing an interest in a common activity.

In the illustrative embodiment, the meosk/weosk-based private and social media management and communication system network comprises:

a plurality of communication servers, operably connected to the infrastructure of the Internet, for supporting http and other TCP/IP based communication protocols on the meosk/weosk-based private and social media management and communication system network;

a plurality of client systems operably connected to the infrastructure of the Internet, and each said client subsystem having a computing platform and a display screen for displaying graphical user interfaces (GUIs) associated with one or more programs executing on said computing platform, and supporting services for system users on said system network;

a distributed information file storage and retrieval system including (i) a relational database management system (RDBMS) for organizing information files associated with information-based moments organized and managed in each activity-specific meosk structure and each activity-specific weosk structure created and deployed on the meosk/weosk-based private and social media management and communication system network, and (ii) information storage devices for storing the information files associated with information-based moments organized in the plurality of activity-specific meosk structures and the plurality of activity-specific weosk structures;

one or more object-oriented application servers operably connected to the infrastructure of the Internet and the RDBMS, for storing and executing modules of object-oriented code and generating processes having a server-side and a client-side and supporting a graphical user interface (GUI) based environment available on the client-side and displayed on the display screens of the client systems;

wherein each client subsystem supports the client-side of the processes generated by the one or more modules of object-oriented code executing on the one or object-oriented application servers; and

wherein the object-oriented application servers and the modules are configured so that system users can receive the following enumerated services, through the GUI screens displayed on the display screen of each client system:

(1) enabling each individual to register as a system user on the meosk/weosk-based private and social media management and communication system network, and automatically create and assign a system network user account to the system user upon completing registration on the meosk/weosk-based private and social media management and communication system network,

wherein the system network user account is stored and maintained within the information storage devices of the distributed information file storage and retrieval system, and

wherein the system user can be any individual seeking to use the meosk/weosk-based private and social media management and communication system network while pursuing ones interests and activities during ones life, as well as any brand management team member seeking to use the meosk/weosk-based private and social media management and communication system network while promoting a particular brand of products and/or services on the WWW;

(2) enabling any system user to create and deploy an activity-specific meosk structure for organizing and managing information-based moments related to the activities of an individual,

wherein each activity-specific meosk structure is assigned an activity specific (AS) code identifying the activity for which the activity-specific meosk structure is being created and deployed,

wherein the system user creating and deploying the activity-specific meosk structure identifies and invites one or more other system users to be inner circle members who shall have access to information-based moments organized and managed within the activity-specific meosk structure, wherein transmission of the invitation by the system user (i.e. meosk master) to said other system users, to join the inner circle of the activity-specific meosk structure, can be sent using (i) a messaging facility supported on said meosk/weosk-based private and social media management and communication system network, (ii) an active email address supported on the Internet, and (iii) an active SMS account supported by one of the client systems,

wherein one or more system users identified as said inner circle members shall include the system user creating said activity-specific meosk structure, who shall also be identified as a or master administrator of the activity-specific meosk structure, or its meosk master,

wherein the system user creating and deploying the activity-specific meosk structure identifies and invites one or more other system users to be inner circle members, who shall have access to information-based moments organized and managed within the activity-specific meosk structure,

wherein transmission of the invitation by the system user (i.e. meosk master) to other system users, to join the inner circle of the activity-specific meosk structure, and acceptance or rejection thereof can be transmitted using (i) a messaging facility supported on the meosk/weosk-based private and social media management and communication system network, (ii) an active email address supported on the Internet, and (iii) an active SMS account supported by one of the client systems;

wherein the activity-specific meosk structure contains a plurality of moment store icons logically representing different locations where information-based moments can be organized and managed, while information files, corresponding to the information-based moments, are stored in the information storage devices of the distributed information file storage and retrieval system,

wherein each moment store icon indicates a unique location where a collection of moment icons is grouped, and

wherein each moment icon represents at least one information-based moment having a corresponding information file that is stored in the information storage devices of the distributed information file storage and retrieval system;

(3) enabling any system user to create and deploy an activity-specific weosk structure for organizing and managing information-based moments related to the activities of group of individuals sharing an interest in or around a common activity,

wherein each activity-specific weosk structure is assigned an activity specific (AS) code identifying the activity for which the activity-specific weosk structure is being created and deployed,

wherein the system user, creating and deploying the activity-specific weosk structure, identifies one or more system users to be inner circle members who shall have access to the information-based moments organized and managed within the activity-specific weosk structure,

wherein one or more system users identified as said inner circle members shall include the system user creating the activity-specific weosk structure, who shall also be identified as a master administrator of the activity-specific weosk structure, or its weosk master,

wherein the system user creating and deploying the activity-specific weosk structure identifies and invites one or more other system users to be inner circle members, who shall have access to information-based moments organized and managed within the activity-specific weosk structure,

wherein transmission of the invitation by the system user (i.e. weosk master) to other system users, to join the inner circle of the activity-specific weosk structure, and acceptance or rejection thereof, can be transmitted using (i) a messaging facility supported on the meosk/weosk-based private and social media management and communication system network, (ii) an active email address supported on the Internet, and (iii) an active SMS account supported by one of the client systems;

wherein the activity-specific weosk structure contains a plurality of moment store icons logically representing different locations where information-based moments can be organized and managed, while information files, corresponding to the information-based moments, are stored in the information storage devices of said distributed information file storage and retrieval system,

(4) enabling any system user to capture an information-based moment using moment capture tools accessed on one of the client machines deployed on the meosk/weosk-based private and social media management and communication system network, store the information file corresponding to the captured information-based moment in the information storage devices of the distributed information file storage and retrieval system, and organize and manage the moment icon associated with the captured information-based moment within one of the activity-specific meosk structures;

(5) enabling any system user to capture an information-based moment using a moment capture tool accessed from within one of said activity-specific meosk structures deployed on the meosk/weosk-based private and social media management and communication system network, store the information file corresponding to the captured information-based moment in the information storage devices of the distributed information file storage and retrieval system, and organize and manage the moment icon associated with the captured information-based moment within said activity-specific meosk structure; and

(6) enabling any system user to capture an information-based moment using a moment capture tool accessed from within one of said activity-specific weosk structures deployed on said meosk/weosk-based private and social media management and communication system network, store the information file corresponding to the captured information-based moment in the information storage devices of said distributed information file storage and retrieval system, and organize and manage the moment icon associated with the captured information-based moment within said activity-specific weosk structure;

(7) enabling any system user, who is an inner circle member to any one of the activity-specific meosk structures, to use a messaging facility supported within the activity-specific meosk structure for sending messages to and receiving messages from other members in the inner circle of the activity-specific meosk structure;

(8) enabling any system user, who is an inner circle member to any one of the activity-specific weosk structures, to use a messaging facility supported within the activity-specific weosk structure for sending messages to and receiving messages from other members in the inner circle of said activity-specific weosk structure;

(9) enabling any system user, who is an inner circle member of one of said activity-specific meosk structures, to organize and manage the moment icons assigned to information-based moments within the activity-specific meosk structure, while corresponding information files associated with these information-based moments are stored in the information storage devices of the distributed information file storage and retrieval system;

(10) enabling any system user, who is an inner circle member of one of the activity-specific meosk structures, to access and review the information-based moments having moment icons organized and managed within the activity-specific meosk based structures, while corresponding information files are stored in the information storage devices of the distributed information file storage and retrieval system;

(11) enabling any system user, who is an inner circle member of one of the activity-specific meosk structures, to attach a note to any information-based moment organized and managed within the activity-specific meosk structure, while the information file corresponding to the note is stored in the information storage devices of the distributed information file storage and retrieval system;

(12) enabling any system user, who is an inner circle member of one of the activity-specific meosk structures, to attach an information-based moment to any information-based moment having moment icons organized and managed in the activity-specific meosk structure, while the information file corresponding to the information-based moment is stored in the information storage devices of the distributed information file storage and retrieval system;

(13) enabling any system user, who is an inner circle member of one of the activity-specific meosk structures, to affix a favorite index to any selected information-based moment having a moment icon organized and managed within the activity-specific meosk structure, while the information file corresponding to the favorite index is stored in the information storage devices of the distributed information file storage and retrieval system;

(14) enabling any system user, who is an inner circle member of one of the activity-specific meosk structures, to grab information-based moments located on one or more of social networks deployed on the WWW, and copy and store the information-based moments in the information storage devices of the distributed information file storage and retrieval system, while organizing and managing the moment icons corresponding to the grabbed and copied information-based moments under the moment store icons of the activity-specific meosk structure;

(15) enabling any system user, who is an inner circle member of one of the activity-specific meosk structures, to share the information-based moments having moment icons organized and managed within the activity-specific meosk structure, with selected inner circle members of said activity-specific meosk based structure, while information files corresponding to the shared information-based moments are stored in the information storage devices of the distributed information file storage and retrieval system;

wherein said sharing of said information-based moments among inner circle members involves sending each inner circle member a notification that an information-based moment has been sent;

(16) enabling any system user, who is an inner circle member of one of the activity-specific meosk structures, to post on one or more of social networks, one or more of the information-based moments having moment icons organized and managed within the activity-specific meosk structure, while the information files corresponding to the posted moments are stored in the information storage devices of the distributed information file storage and retrieval system;

(19) enabling any system user, who is an inner circle member of one of the activity-specific meosk structures, and a master user of the activity-specific meosk structure, to allow guest users in the inner circle of the activity-specific meosk structure to add other system users to, or remove system users from, the inner circle of the activity-specific meosk structure, to either expand or reduce the inner circle thereof, respectively;

(20) enabling any system user, who is a master user of one of the activity-specific weosk structures, to configure the object-oriented application servers and the modules so that a private activity-specific meosk structure is automatically created and deployed for each inner circle member of the activity-specific weosk structure;

whereupon the inner circle member tags and copied selected moments in the activity-specific weosk structure using tag an copy icons within the activity-specific weosk structure, while information files corresponding to tagged and copied moments are stored in the information storage files of the distributed information file storage and retrieval system, and moment icons for the tagged and copied information-based moments appear in said private activity-specific meosk structure, while information filed corresponding to said tagged and copied moment icons are stored in the information storage devices of the distributed information storage and retrieval system;

(21) enabling any system user, who is a master user of one of the activity-specific weosk structures, to allow guest users to tag information-based moments having moment icons organized and managed within a first one of the activity-specific meosk structures, and to copy the tagged information-based moments to a second one or the activity-specific meosk structures, while the information files corresponding to the tagged and copied information-based moments are stored in the information storage devices of the distributed information file storage and retrieval system;

(22) enabling any system user, who is a master user of one of the activity-specific meosk structures, to link a selected one of the activity-specific meosks structures to a particular event marked on a calendar maintained for the activity-specific meosk structure, deployed on the meosk-based private and social media management and communication system network;

(23) enabling any system user, who is a master user of one of the activity-specific weosk structures, to link a first selected one of the activity-specific meosk structures to a second selected one of the activity-specific meosk structures, deployed on the meosk-based private and social media management and communication system network;

(24) during or after the creation and deployment of each activity-specific meosk structure, the system user creating said activity-specific meosk structure (i.e. meosk master) is (i) presented with one or more GUI screens displaying a generic list of products and/or services, related to the practice of the activity identified by the activity code assigned to the activity-specific meosk structure, and (ii) requested to select one or more brands of product and/or services about which the meosk master would like to receive information and/or contact from the brand by way of messaging services supported on the meosk/weosk-based private and social media management and communication network;

(25) enabling any system user, who is a master user of one of the activity-specific meosk structures, to enabling a media-player implemented brand channel supported within the activity-specific meosk structure so that members of the inner circle of the activity-specific meosk structure can view videos and other programmed media played by the media-player implemented brand channel, and wherein the brands which the system user has selected for brand contact have a right to contribute to the programming of the said media-player implemented brand channel;

(26) enabling any system user, who is a master user of one of the activity-specific meosk structures, to enabling a media-player implemented favorites channel supported within said activity-specific meosk structure so that members of the inner circle of the activity-specific meosk structure can view information-based moments indexed as favorite, can be programmed into and displayed for viewing from the media-player implemented favorites channel;

(27) enabling any system user, who is a master user of one of the activity-specific meosk structures, to enabling the generation of journey books, each composed of moments selected from particular the activity-specific meosk structures, which the meosk master has created and deployed;

(28) enabling any system user, who is an inner circle member of one of the activity-specific meosk structures, to send information-based moments to another system user who is a master user of one the activity-specific meosk structure, by way of user-specific SMS message delivery method supported on the system network;

(29) enabling any system user, who is an inner circle member of one of the activity-specific meosk structures, to send information-based moments to another system user who is a master user of one the activity-specific meosk structure, by way of an user-specific email message delivery method supported on the system network;

(30) enabling any system user, who is an inner circle member of one of the activity-specific meosk structures, receive one or more of the following notification services, through said GUI screens displayed on the display screen of each said client system:

a notification relating to received messages from inner circle members;

a notification relating to received messages from brand representatives;

a notification relating to a request for build inner circles for particular said activity-specific meosk structures;

a notification from an inner circle member relating to a request to view a shared moment in a certain activity-specific meosk structure; and

a notification from an inner circle member relating to a request to join the inner circle of a particular activity-specific meosk structure;

(31) enabling any system user, who is an inner circle member of one of the activity-specific meosk structures, receive one or more of the following messaging services, through said GUI screens displayed on the display screen of each said client system:

a message from an inner circle member expressing gratitude for something;

a message from an inner circle member making an inquiry;

a message requesting the system user (i.e. meosk master) to select preferred brands from a list of generic products and/or service categories typically required when enjoying or participating in the identified interest or activity selected by the meosk master, for the created and deployed meosk structure; and

a message from a brand selected during creation of a particular activity-specific meosk structure; and

(32) enabling any system user, who is an inner circle member of one of the activity-specific meosk structures, to send a response to a message sent during a message notification.

On the meosk/weosk-based private and social media management and communication system network of the present invention, each client system is a device selected from the group consisting of smart phones, wireless tablet computers, desktop computers, computer workstations. Preferably, each client system comprises a computing platform supporting a web-browser application and a native client application running on the operating system of a client system, to support both online and limited off-line modes of system operation. The native application should have access to local memory on the computing platform accessible during off-line modes of operation to enabling users to use certain or many of the system functions supported by the system network during off-line/off-network modes of operation. Such system functions include functions selected from the group consisting of reviewing recently stored/shared moments in said meosk structures; capturing and storing moments in said meosk structures; writing notes for attachment to moments in stored/shared said activity-specific meosk structures, writing journal entries for storing in said activity-specific meosk structures, and creating new activity-specific meosk structures.

On the meosk/weosk-based private and social media management and communication system network, the modules stored and executing in the object-oriented application servers also include a user account management module which enables any system user to create and manage collections of the activity-specific meosk structures and activity-specific weosk structures for himself/herself, as well as on behalf of others, under a trusted relationship with a beneficiary user. Using the user account management module, each system user can create and maintain a personal user account (PUA) for managing their own personal activity-specific meosk structures and activity-specific weosk structures, and also trustee user accounts (TUA) for managing activity-specific meosk structures and activity-specific weosk structures for other beneficiary users (e.g. their children, grandchildren, elderly parents or someone incapable of using the system without assistance). At any time, the trustee user accounts can be returned by the trustee system users to the beneficiary users at a later date, for future use and benefit, when they are older enough to manage their user accounts on the system network.

On the meosk/weosk-based private and social media management and communication system network, the modules stored and executing in the object-oriented application servers also include a brand management module that generates GUI screens for display on client systems to enable brand management team members to perform one or more of the following marketing functions on said system network, including: (i) communicate directly with consumers via messaging facilities through said system network, while the user maintains its anonymous user credentials; (ii) manage digital assets for the brand's products and services, within each brand's digital asset library supported on said system network, including videos, photos, audio/podcasts and brand widgets; (iii) manage brand-messages/marketing-communications through brand channels supported within activity-specific meosk structures and activity-specific weosk structures; (iv) manage meosk and weosk messaging using customizable forms and templates for distribution to targeted consumers and demographics; and (v) access targeted consumer metrics in real time on demand and customizable to specific campaigns and market research. Through the GUI screens displayed on the display screen of the client system, brand management team members can:

(i) select product/service categories, list products/services, add products/services to the client brand's catalog, and product reports on the client's product/service catalogs;

(ii) review inbound, outbound and draft messages from a single central location on said system network;

(iii) review advertising, promotional and product information spots running on brand channels of deployed meosk structures and weosk structures that are supported by the client brand's products and/or services;

(iv) review messages sent by the brand manager or agent to the message center of meosk structures and weosk structures supported by the client brand's products and/or services;

(v) create, preview, run and manage new advertising, promotional, and product information spots running on brand channels of meosk structures and weosk structures supported by selected brands;

(vi) control marketing communications across the brand's networks of meosks and weosks deployed along, in and about consumer social media channels.

On the meosk/weosk-based private and social media management and communication system network of the present invention, the object-oriented application servers and the modules are configured so that system users, who are registered with a client brand, can use the GUI screens displayed on the display screen of their client systems, to program digital content on a particular subject or topic to appear in the brand channel of any given activity-specific meosk structure (or activity-specific weosk structure) created and deployed on the system network. System users, who are registered with a client brand, can also generate from a wide array of large datasets, metrics on meosk structures, metrics on weosk structures, metrics on inner circles, metrics on stored moments, metrics on messages, metrics on brands, metrics on brand channels, metrics on attachments to moments, metrics on grabbed moments, metrics on favorites, metrics on moment sharing, and metrics on moment posts.

In the illustrative embodiment of the meosk/weosk-based private and social media management and communication system network of the present invention, the object-oriented application servers and the modules are configured so that the display screen of each client system used by a registered system user (wishing to create and deploy meosk and weosk structures and capture moments for organization and management therein) is provided with GUI screens comprising: a header control panel with various interface objects; a display frame for displaying content; and a footer control panel with various interface objects; wherein the header control panel displays icons for accessing a home page module, a capture moments module, a master meosks module, a master weosks module, an inner circles module, a message center module and my brands module; and wherein the footer control panel displays icons for accessing a login module, a settings module, a contacts module, a search module, a synch module, and a help module. Also, the object-oriented application servers and the modules are configured so that the display screen of each such client system is provided with a GUI screen supported by the home page module which displays icons for instantiating a message center module, a capture moments module, a master meosks module, a master weosks module, a favorite moments module, a my brands module, and a formal stuff module. System users can further receive one or more of the following services, through said GUI screens displayed on the display screen of each said client system:

(i) capturing a photographic or video recording;

(ii) capturing text documents;

(iii) capturing drawings using a drawing pencil or pen;

(iv) capturing a sound recording;

(v) capturing a web page clipping (i.e. a file or a URL); and

(vi) capturing a file by file uploading.

The meosk/weosk-based private and social media management and communication system network also includes a master meosks module supporting a set graphical icons for selecting specifically organized modules namely, my meosk structures, create new meosk structure, inner circles module, view my bin module, share moments module, post meosks module, and also print shop module, where journey books are configured, ordered and generated.

These and other objects will become apparent hereinafter and in the Claims to Invention.

### BRIEF DESCRIPTION OF THE DRAWINGS

FIG. 1 is a schematic diagram illustrating a first network architecture of the meosk/weosk-based private and social media management and communication system network of the present invention for the case where the system of the present invention is implemented as a stand-alone platform designed to work independent from but alongside of one or more social networks deployed on the Internet, and comprising web-based client machines, web servers, object-oriented application software servers, relational database management system (RDBMS) servers, SMS gateway servers, email servers and processors arranged and configured in accordance with the principles of the present invention;

FIG. 1A is a schematic representation illustrating the system architecture of the system network of the present invention, show comprising (i) web servers accessed by web-enabled clients used by individuals users, brand managers and team members, and consumers, through the infrastructure of the Internet, (ii) application servers for implementing the many core and compositional object-oriented software modules supporting the system network of the present invention, and (iii) a scalable, distributed computing and data storage system based, for example on the Apache Hadoop® Java frameworks that enables applications to work with thousands of nodes and petabytes of data, and for using SQL to query and manage large datasets residing in such a distributed storage environment;

FIG. 1B is a schematic representation of the meosk/weosk-based private and social media management and communication system network of the present invention, supporting integrated email and SMS messaging, handling and processing services that enable flexible messaging across the system network;

FIG. 1B-1 is a schematic representation of the system architecture of the Apache Hadoop® ecosystem employed in the preferred implementation of the scalable, distributed computing and data storage system supporting the meosk/weosk-based private and social media management and communication system network of the present invention;

FIG. 1B-2 is a schematic representation of the software architecture of the Apache Hadoop® ecosystem employed in the preferred implementation of the scalable, distributed computing and data storage system supporting the meosk/weosk-based private and social media management and communication system network of the present invention, enabling the system's applications to run on thousands of nodes involving thousands of petabytes of data storage, where the distributed file system facilitates rapid data transfer rates among nodes and allows the system to continue operating uninterrupted in case of a node failure;

FIG. 1C is a schematic representation of the system architecture of an exemplary mobile client system (e.g. device) that is deployed on the system network of the present invention and supporting the many services offered by system network servers of the present invention;

FIG. 2A is a schematic representation of an email data message processing subsystem network, and an email processing server, that is configured for delivering user-specific email message services within the system network of the present invention illustrated in FIGS. 1 through 1B-2;

FIG. 2B is a flow chart describing the primary steps of a method carried out by the email data message processing subsystem of FIG. 2A for handling and processing email messages and delivering user-specific email message services supported on the system network of the present invention;

FIG. 2C is a schematic representation of an email data message processing subsystem network, including the email processing server shown in FIG. 2A, that is configured for delivering general email message services within the system network of the present invention;

FIG. 2D is a flow chart describing the primary steps of a method carried out by the subsystem of FIG. 2C for handling and processing email messages and delivering general-user email message services supported on the system network of the present invention illustrated in FIGS. 1 through 1B-2;

FIG. 2E is a schematic representation of a SMS data message processing subsystem network, including an SMS gateway server, that is configured for delivering user-specific SMS message services within the system network of the present invention;

FIG. 2F is a flow chart describing the primary steps of a method carried out by the subsystem of FIG. 2A for handling and processing SMS messages and delivering the user-specific SMS message services supported on the system network of the present invention;

FIG. 2G is a schematic representation of an SMS data message processing subsystem network, including the SMS gateway server shown in FIG. 2E, that is configured for delivering general-user SMS message services illustrated in FIGS. 1 through 1B-2;

FIG. 2H is a flow chart describing the primary steps of a method carried out by the subsystem of FIG. 2A for handling and processing SMS messages and delivering general-user SMS message delivery supported on the system network of the present invention;

FIG. 3 is a schematic diagram illustrating a second network architecture of the system network of the present invention for the case where the system of the present invention is implemented as an application supported within one or more social networks deployed on the Internet;

FIG. 4 is a schematic representation providing a data schema for the object-oriented system-engineered (DOSE) software component of the system network of the present invention, executing on the client-server architecture specified in great detail throughout the present patent Specification;

FIGS. 5A-1 and 5A-2, taken together, provide a schematic representation of a set of “core” object-oriented software modules, containing classes (written in an object-oriented programming language) supporting the system network of the present invention including the User Registration Module, User Account Management Module, Log-In Module, Setting Module, Contacts Module, Search Module, Synch Module, Help Module, My Meosks Module, Create New Meosk For Myself Module, Create New Meosk For Others Module, inner circles module: Expand An Inner Circle; Reduce An Inner Circle, View My Bin Module: Delete Moment; Move Moment; Return Moment, Share Moments (Over Meosks) Module, Post Meosks Module, Print Shop Module, Gift Shop Module, My Weosks Module, Create New Weosk For My Family Module, Create New Weosk For My Group Module, Share Moments (Over Weosks) Module, Post My Weosks Module, Message Center Module (Notifications, Messages), Capture Moments Module: Set Store Location; Select Capture Tool; Capture Moment, Favorite Moments Module, My Brands Module (Manage Brands Module, Gift Wish List Module, Gift-It Module), and Formal Stuff Module, Favor-It Module, Play-It Module, Note-It Module, Gift-It Module, Attach-It Module, Share-It Module, Grab-It Module, Post-It Module, Camera/Video Module, Drawing And Doodle Module, Microphone Module, Webclipper Module, Uploader Module, Manage Brands Module, Gift Wish List Module, Meosk Messaging Module, and Weosk Messaging Module;

FIGS. 5B-1, 5B-2, 5B-3, 5B-4, and 5C-1, taken together, provide a schematic representation of a set of “compositional-type” object-oriented software modules, containing classes (written in an object-oriented programming language) supporting the system network of the present invention including (i) Header/Footer Control Module comprising Home Page Module, Capture New Moment Module, Master Meosks Module, Master Weosks Module, Inner Circle Module, Message Center Module, My Brands Module, and Footer Control Module, (ii) The Home Page Module comprising the Message Center, Capture Moments Module, Master Meosks Module, master weosks module, Favorite Moments Module, My Brands Module and Formal Stuff Module, (iii) The Footer Control Module (Panel) comprising the Log-In Module, Setting Module, Contacts Module, Search Module, Synch Module and Help Module, (iv) The Formal Stuff Module, About Us Module, Quest Product Tour Module, Privacy Policy Module, User Agreement Module, and Contact Us Module, (v) The Master Meosks Module comprising the my meosks module, Meosk Module, Create New Meosks (For My Self and For Others), inner circles module, View My Bin Module, Share Moments Module, Print Shop Module, (vi) The Master Weosks Module comprising the My Weosks Module, Weosk Module, Create New Weosks (For My Family and For My Groups), Inner Circles Module and Share Moments Module, (vii) Meosk Module comprising the Capture Moments Module: (Camera/Video Module, Drawing And Doodle Module, Microphone Module, Webclipper Module, Uploader Module), Store My Journal Module (Add-To-It Module), Store My Album Module (Add-To-It Module), Store My Favorites Module (Add-To-It Module), Add-To-It Module (Favor-It Module, Play-It Module, Note-It Module, Gift-It Module, Attach-It Module, Share-It Module, Grab-It Module, and Post-It Module), Print Shop Module, Favorite (Moments) Channel Module, Brand Channel Module, My Brands Module, and Meosk Messaging Module, (viii) Weosk Module comprising the Capture Moments Module (Camera/Video Module, Drawing And Doodle Module, Microphone Module, Webclipper Module, Uploader Module), Store My Guest Book Module, Store Shared Album Module (Add-To-It Module), Add-To-It Module (Favor-It Module, Play-It Module, Note-It Module, Gift-It Module, Attach-It Module, Share-It Module, Grab-It Module, and Post-It Module), Group Calendar Module, Gift Shop Module, Favorite Channel Module, Brand Channel Module, My (Family/Group) Brands Module Weosk Messaging Module, (ix) Our Brands Module comprising the Manage Brands Module, Gift Wish List Module and Gift-It Module, and (x) the Journey Book Module comprising the Log-In Module, Library Module, Set-Up Module, Search Module, Help Module, Journey Book Display Module (Display Journey Books By Year or By Activity) and the Journey Book Module;

FIG. 5D is a schematic representation illustrating how the user account management module employed in the system network of the present invention enables each registered user to create and maintain “personal user accounts” for managing their own personal meosks (M) and (W), and also “trustee user accounts” for managing meosk structures and weosk structures for other beneficiary users (e.g. their children, grandchildren, elderly parents or someone incapable of using the system without assistance), where these trustee user accounts can be returned to the beneficiary users at a later date when they are older enough to manage their user accounts on the system network of the present invention;

FIG. 5E is a schematic representation showing, along the privacy continuum, the basic functions that are supported within meosk structures deployed on the system network of the present invention;

FIG. 5F is a schematic representation showing, along the privacy continuum, the basic functions that are supported within weosk structures deployed on the system network of the present invention;

FIG. 5G is a schematic representation illustrating the system architecture of and primary data flow pathways within activity-specific meosk structures created and deployed on the system network of the present invention, modeled in terms of the object-oriented system engineered software modules used to implement the system network of the illustrative embodiment of the present invention;

FIG. 5H is a schematic representation illustrating the system architecture of and primary data flow pathways within activity-specific weosk subsystems created and deployed on the system network of the present invention, modeled in terms of the object-oriented system engineered software modules used to implement the system network of the illustrative embodiment of the present invention;

FIG. 6A-1 through 6A-6 show a series of GUI screens supported by the Brand Manager Module of the system network of the present invention, wherein a brand user can easily log-into the system via a mobile wireless tablet or computer (e.g. Apple® iPad), configure the consumer product catalog of associated with the client brand user's account, and select the brand, category, products and services to be managed on the system network, using simple to use pull-down menus, and touch screen controls, as shown in these GUI screens;

FIG. 6B-1 through 6B-7 show a series of GUI screens supported by the Brand Manager Module of the system network of the present invention, wherein a client brand user can select product/service categories, list products/services, add products/services to the client brand's catalog, and product reports on the client's product/service catalogs;

FIG. 6C-1 through 6C-5 show a series of GUI screens supported by the Brand Manager Module of the system network of the present invention, wherein a client brand user can review inbound, outbound and draft messages from a single central location on the system network;

FIG. 6D-1 through 6D-5 show a series of GUI screens supported by the Brand Manager Module of the system network of the present invention, wherein, from a single central location on the system network, a client brand user can (i) review advertising, promotional and product information spots running on brand channels of deployed meosks and weosks that are supported by the client brand's products and/or services, (ii) review messages sent by the brand manager or agent to the message center of meosks and weosks supported by the client brand's products and/or services, (iii) create, preview, run and manage new advertising, promotional, and product information spots running on brand channels of meosks and weosks supported by selected brands, and (iv) control marketing communications across the brand's networks of meosks and weosks deployed along, in and about consumer social media channels;

FIG. 6E-1 through 6E-6 show a series of GUI screens supported by the Brand Manager Module of the system network of the present invention, wherein, from a single central location on the system network, a client brand user can store, manage and use, on the system network, all of the brand assets for its product/service catalogs, including (i) digital photographs of the client brand's products and services and the lifestyle of consumers which the brand serves, (ii) digital videos of advertisements, promotions and product and service tours/demos, communicating the value and lifestyle which selected product and service brands promise to deliver, (iii) audio/video podcasts of interviews, product and service tutorials, endorsements, Reviews and the like, (iv) widgets and apps that build and communicate a brand's uniqueness and value in the marketplace, (v) message forms for use by the brand's marketing communication specialists during meosk and weosk messaging operations, to send out messages that deliver Welcome Letters, Update on Events in Your Area communications, Invitations To Special Exclusive Sales, Invitations To Private Sales, Surveys, Haven't Heard From You In A While communications, Video Transmittals, Podcast Transmittals, Brand Sponsorship Offers etc;

FIG. 6F-1 through 6F-15 show a series of GUI screens supported by the Brand Manager Module of the system network of the present invention, wherein, from a single central location on the system network, a client brand user can generate from a wide array of large datasets, metrics on meosk structures, metrics on weosk structures, metrics on inner circles, metrics on stored moments, metrics on messages, metrics on brands, metrics on brand channels, metrics on attachments to moments, metrics on grabbed moments, metrics on favorites, metrics on moment sharing, and metrics on moment posts;

FIGS. 7A and 7B, taken together, set forth a flow chart describing the primary steps involved in carrying out the method of meosk-based marketing communication by a client brand registered to use the system network of the present invention;

FIGS. 8A and 8B, taken together, set forth a flow chart describing the primary steps involved in carrying out the method of producing metrics from data collected on a meosk/weosk-based system network comprising the steps of (a) a client brand logging into a meosk/weosk-based system network and accessing a brand management module configured for the client brand, (b) accessing the brand management module for analyzing data stored in a database, relating to the activities, interests, products, services and behavior of consumer users of the system network, including user interaction with meosks and weosks and/or journey books deployed on the system network, and other system objects including inner circles, stored moments, messages, brands, brand channels, attachments to moments, grabbed moments, favorites, moment sharing, and moment posts, (c) using the brand management module to formulate queries that seek to discover insights hidden within such collected stored data, (d) running the queries against the data stored in the database, (e) based on the results of running queries run against the data in the database, generating metrics for use in understanding consumer behavior, and (f) logging out from the meosk/weosk-based system network.

FIGS. 9A and 9B, taken together, provide a flow chart describing the primary steps involved in carrying out the method of messaging within the meosk-based private and social media management and communication system network of the present invention;

FIG. 10A is a graphical user interface (GUI) splash screen supported by the user registration module, and displaying the login interface to the consumer-side of the meosk/weosk-based private and social media management and communication system network (i.e. called the Quest™ System in the illustrative embodiment), realized as mobile web-browser and native applications having a “responsive-design” and being adapted to run on any client computing device (e.g. iPhone, iPad, Android or other Web-enabled computing device) and designed to be used by anyone interested in managing, storing and sharing information, including media, associated with their life or the life of another, for whom they are entrusted to manage the same (e.g. as a parent or grandparent might manage information about the life, interests, activities and moments in the life of their child or grandchild);

FIG. 10B is GUI screen supported by the user registration module, and displaying the first step in registering with the system network, requiring only the first name and last initial of the last name of the user, and his or her year or birth, gender and email address and SMS number if available;

FIG. 10C is a GUI screen supported by the user registration module, and displaying the second step involved in registering with the system network asking if there are others in ones family to add to the user's registration so as to enable for the system network to set up accounts for the added family members;

FIG. 10D is a GUI screen supported by the user registration module, and displaying the third and final step of user registration on the system network, indicating that the user needs to go to his or her email to verify identity to complete the registration process;

FIG. 10E is a GUI screen showing the receipt of an email from the system network confirming that the user need to confirm his or her email address to complete the user registration process on the system network of the present invention;

FIG. 10F is a GUI screen communicating confirmation that the user registration process has been to completed and the user can now use the system network of the present invention;

FIG. 10G is a GUI screen supporting user log-in to the system network of the present invention;

FIG. 11A is a GUI screen supporting both user registration and login modules employed on the system network of the present invention;

FIG. 11B is a GUI screen supported by the user login module of the system network, where the user enters account credentials to login to the system network;

FIG. 12 is a GUI screen supported by the header/footer control module of the system network, and providing the logged-in user with access to all points of entry into the system network, using a mobile client device, wherein the GUI contains a header control panel with various graphical interface objects, a display frame for displaying content, and a footer control panel with various graphical interface objects, and wherein the control panels displays icons for accessing the home page module, capture moments module, master meosks module, master weosks module, inner circles module, message center module and my brands module, wherein the footer control panel displays icons for the login module, settings module, contacts module, search module, synch module and help module;

FIG. 13A is a GUI screen supported by the home page module, which displays icons for instantiating the message center module, capture moments module, master meosks module, master weosks module, favorite moments module, my brands module and the formal stuff module;

FIG. 13B is a GUI screen supported by the formal stuff module, which displays icons for the about us module, Quest product tour module, privacy policy module, user agreement module, and contact us module;

FIG. 14 is a flow chart describing the steps involved in the method of notifying users about the receipt of system notifications and messages from inner circle members and brand representatives;

FIG. 14A is a GUI screen supported by the message center module displaying a notification from the system admin to a registered system user relating to a request for build inner circles for certain meosk structures that have been created and deployed for the particular user;

FIG. 14B is a GUI screen supported by the message center module displaying a notification from the system admin to a registered system user relating to a request for build inner circles for certain meosk structures that have been created and deployed for the particular user;

FIG. 14C is a GUI screen supported by the message center module displaying a notification from an inner circle member to a registered system user relating to a request to view as hared moment in a certain meosk created and deployed by the particular user;

FIG. 14D is a GUI screen supported by the message center module displaying a notification from an inner circle member to a registered system user relating to a request to join the inner circle of a particular meosk;

FIG. 14E-1 is a GUI screen supported by the message center module displaying a message from the system admin requesting the system user (i.e. meosk master) to select preferred brands from a list of generic products and/or service categories typically required when enjoying the identified interest or activity selected by the meosk master;

FIG. 14E-2 is a GUI screen supported by the my meosks module displaying a list of brands from a list of generic products and/or service categories typically required or desired when enjoying the identified interest or activity selected by the meosk master, from which the meosk master is asked to make selections to authorized these brands to send messages to the message communication facilities provided by said activity-specific meosk structure;

FIG. 14F-1 is a GUI screen supported by the message center module displaying a message received by the meosk master from a brand selected during the selection presented in FIG. 14E-2;

FIG. 14F-2 is a GUI screen supported by the my meosk module displaying the inner circle messaging panel where the meosk master is responding to a message sent during the message notification illustrated in FIG. 14F-2;

FIG. 14G is a GUI screen supported by the message center module displaying a notification from an inner circle member to a registered system user relating to a request to join the inner circle of a particular weosk structure;

FIG. 14H is a GUI screen supported by the message center module displaying a notification of a request by the system admin to build the meosk and weosk inner circles of the registered system user;

FIG. 14I is a GUI screen supported by the message center module displaying a message from an inner circle member to the registered system user expressing thank you for something;

FIG. 14J is a GUI screen supported by the message center module displaying a message from an inner circle member to the registered system user inquiring about where Thanksgiving Dinner will be hosted;

FIG. 15A is a GUI screen supported by the capture moments module in the system network, and displaying an introduction to its suite of media-based moment capture tools;

FIG. 15B is a GUI screen supported by the capture moments module and displaying the current store setting page, indicating where the current store location has been set, and where the user is provide with the choice of changing where captured moments will be stored in a default manner, or to keep the current moment store setting;

FIG. 15C is a GUI screen supported by the capture moments module and displaying where captured moments can be stored, with the option of selecting from (i) my meosks where all available meosk structures are listed in a pull-down menu, (ii) my weosks where all available meosk structures are listed in a pull-down menu, and (iii) my default setting where all captured moments can be stored if this option is selected, and afterwards, from which the user can move captured moments to designated meosks and/or weosks are the case may be;

FIG. 15D is a GUI screen supported by the capture moments module and displaying the available meosk structures in the user's my meosks list;

FIG. 15E is a FIG. 15D is a GUI screen supported by the capture moments module and displaying the available weosks in the user's my weosks list;

FIG. 15F is a FIG. 15D is a GUI screen supported by the capture moments module and displaying the meosk structures, weosks and my bin available for selection when configuring the default moment store setting;

FIG. 15G is a GUI screen supported by the capture moments module and displaying that “my bin” has been selected as the default moment store setting;

FIG. 16A is a GUI screen supported by the capture moments module and displaying the menu of moment capture tools that are available for selection in the capture moments module;

FIG. 16B is a GUI screen supported by the capture moments module and displaying the video/image capture tool, where the video/image capture option has been selected and an image of the subject in the camera's field of view (FOV) is shown and ready to be captured as a video recording and exported to the selected video format;

FIG. 16C is a GUI screen supported by the capture moments module and displaying the captured moment handling screen showing the options available for handling the captured video/image moment, namely, (i) storing the captured moment and returning to the capture moments tool selection screen, (ii) storing the captured moment and sharing the same, and thereafter returning to the capture moments selection tool screen, and (iii) storing the captured moment and posting the captured moments to selected social media channels of the registered user, and then returning to the captured moments tool selection screen;

FIG. 16D is a GUI screen supported by the capture moments module and displaying the captured moment sharing screen, from which the user can select inner circle members with whom the captured video/image moments should be shared over the system network illustrated in FIGS. 1 and 1A;

FIG. 16D-1 is a schematic representation of an inner circle of members associated with a particular meosk created and deployed on the system network by the registered user, illustrating (i) inner subcircle associated with one side of the user's family, (ii) the inner subcircle associated with the other side of the user's family, and (ii) the user's core family circle, with each of whom captured video/image moments can be shared using the system of the present invention;

FIG. 16E is a GUI screen supported by the capture moments module and displaying the share the video/image moments across social media channels, to which the registered user can post captured moments;

FIG. 17A is a GUI screen supported by the capture moments module and displaying the capture moments selection tool screen, where the user selects the type tool;

FIG. 17B is a GUI screen supported by the capture moments module and displaying the type screen, for capturing moments using a typewriter, drawing pencil or pen;

FIG. 17C is a GUI screen supported by the capture moments module and displaying the captured moment handling screen showing the options available for handling the captured type moment, namely, (i) storing the captured moment and returning to the capture moments tool selection screen, (ii) storing the captured moment and sharing the same, and thereafter returning to the capture moments selection tool screen, and (iii) storing the captured moment and posting the captured moments to selected social media channels of the registered user, and then returning to the captured moments tool selection screen;

FIG. 17D is a GUI screen supported by the capture moments module and displaying the captured moment sharing screen, from which the user can select inner circle members with whom the type moment should be shared over the system network illustrated in FIGS. 1 and 1A;

FIG. 17E is a GUI screen supported by the capture moments module and displaying the share the text moments across social media channels, to which the registered user can post captured moments;

FIG. 17F is a GUI screen supported by the capture moments module and displaying the screen for capturing moments using a typewriter, drawing pencil or pen which the user may select from the icons displayed on the GUI screen;

FIG. 17G is a GUI screen supported by the capture moments module and displaying the captured moment sharing screen, from which the user is presented with options available for handling the captured type moment, namely, (i) storing the captured moment and returning to the capture moments tool selection screen, (ii) storing the captured moment and sharing the same, and thereafter returning to the capture moments selection tool screen, and (iii) storing the captured moment and posting the captured moments to selected social media channels of the registered user, and then returning to the captured moments tool selection screen;

FIG. 17H is a GUI screen supported by the capture moments module and displaying the captured moment sharing screen, from which the user can select inner circle members with whom the drawing/doodle moment should be shared over the system network illustrated in FIGS. 1 and 1A;

FIG. 17I is a GUI screen supported by the capture moments module and displaying the share the drawing/doodle moments across social media channels, to which the registered user can post captured moments;

FIG. 18A is a GUI screen supported by the capture moments module and displaying the capture moments selection tool screen, where the user selects the sound recording tool;

FIG. 18B is a GUI screen supported by the capture moments module and displaying the sound recording screen, for capturing moments using the microphone contained in the iPhone;

FIG. 18C is a GUI screen supported by the capture moments module and displaying the captured moment handling screen showing the options available for handling the captured type moment, namely, (i) storing the captured sound recording moment and returning to the capture moments tool selection screen, (ii) storing the captured moment and sharing the same, and thereafter returning to the capture moments selection tool screen, and (iii) storing the captured sound recording moment and posting the captured moments to selected social media channels of the registered user, and then returning to the captured moments tool selection screen;

FIG. 18D is a GUI screen supported by the capture moments module and displaying the captured moment sharing screen, from which the user can select inner circle members with whom the sound recording moment should be shared over the system network illustrated in FIGS. 1 and 1A;

FIG. 18E is a GUI screen supported by the capture moments module and displaying the share the sound recording moment across social media channels, to which the registered user can post captured moments;

FIG. 19A is a GUI screen supported by the capture moments module and displaying the capture moments selection tool screen, where the user selects the web page clipping (i.e. capture and store as a file) tool;

FIG. 19B-1 is a GUI screen supported by the capture moments module and displaying the web page clipping screen for capturing web page moments using this tool in its capture and save web pages as a pdf document;

FIG. 19B-2 is a GUI screen supported by the capture moments module and displaying the web page URL capture screen for capturing web page moments using this tool in its capture and save URLs capture mode;

FIG. 19C is a GUI screen supported by the capture moments module and displaying the captured moment handling screen showing the options available for handling the captured web page moment, namely, (i) storing the captured sound recording moment and returning to the capture moments tool selection screen, (ii) storing the captured moment and sharing the same, and thereafter returning to the capture moments selection tool screen, and (iii) storing the captured sound recording moment and posting the captured moments to selected social media channels of the registered user, and then returning to the captured moments tool selection screen;

FIG. 19D is a GUI screen supported by the capture moments module and displaying the captured moment sharing screen, from which the user can select inner circle members with whom the clipped web page moment should be shared over the system network of the present invention illustrated in FIGS. 1 and 1A;

FIG. 19E is a GUI screen supported by the capture moments module and displaying the share the clipped web page moment across social media channels, to which the registered user can post captured moments;

FIG. 20A is a GUI screen supported by the capture moments module and displaying the capture moments selection tool screen, where the user selects the file upload tool;

FIG. 20B is a GUI screen supported by the capture moments module and displaying the file upload screen, for uploaded moments (captured in a digital information file) using this tool;

FIG. 20C is a GUI screen supported by the capture moments module and displaying the file upload screen;

FIG. 20D is a GUI screen supported by the capture moments module and displaying the file capture screen, when capturing uploaded moments using this tool;

FIG. 20E is a GUI screen supported by the capture moments module and displaying the captured moment handling screen showing the options available for handling the uploaded moment, namely, (i) storing the uploaded file moment and returning to the capture moments tool selection screen, (ii) storing the captured moment and sharing the same, and thereafter returning to the capture moments selection tool screen, and (iii) storing the uploaded file moment and posting the captured moments to selected social media channels of the registered user, and then returning to the captured moments tool selection screen;

FIG. 20F is a GUI screen supported by the capture moments module and displaying the captured moment sharing screen, from which the user can select inner circle members with whom the uploaded file moment should be shared over the system network illustrated in FIGS. 1 and 1A;

FIG. 20G is a GUI screen supported by the capture moments module and displaying the share the uploaded file moment across social media channels, to which the registered user can post captured moments;

FIG. 21 is a GUI screen supported by the master meosks module and displaying icons for selecting specifically organized modules namely, my meosk structures, create new meosk structure, inner circles, view my bin, share moments, and print shop where journey books are configured, ordered and generated;

FIG. 22 is a GUI screen supported by the my meosks module selected from the master meosks module, and showing graphical panels for each of the meosk structures that have been created, deployed and associated with the registered user (e.g. Christine P.) of the exemplary embodiment;

FIG. 23 is a GUI screen supported by the my meosks module, and displaying a selected meosk structure (e.g. Christopher's FM (First Moments) Meosk) for viewing and illustration of its various modules, namely, capture moments, my journal, my album, my favorites, print shop, favorites (moments) channel, my brand channel, and message center;

FIG. 24 is a GUI screen supported by the my meosks module, and displaying the selected meosk structure and the selected module, capture new moment, providing a selection of moment multi-media moment capture tools from which the user can select to capture new moments which will be automatically stored in one of the moment store locations within the meosk structure's file subsystem and virtual operating system (VOS) structure;

FIG. 25A is a GUI screen supported by the my meosks module, and displaying the selected meosk structure (e.g. Christopher's FM Meosk) and the selected module, capture new moment, providing a selection of moment multi-media moment capture tools from which the user can select to capture new moments which will be automatically stored in one of the moment store locations within the meosk structure's GUI-based virtual file and operating system (VFOS);

FIG. 25A is a GUI screen supported by the my meosks module, and displaying the selected meosk structure and the selected module, capture new moment, where the video/image recording moment capture tool has been selected and used to capture a video/image recording moment;

FIG. 25B is a GUI screen supported by the my meosks module, and displaying the selected meosk structure and the selected module, capture new moment, where four options are shown for storing the captured video/image recording moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the captured moment along selected social media channels;

FIG. 25C is a GUI screen supported by the my meosks module, and displaying the selected meosk structure and the selected module, capture new moment, where the option (i) store in my album and share with members of the meosk inner circle, has been selected and displayed, and certain members of the meosk structure's inner circle are being selected for sharing;

FIG. 25D is a GUI screen supported by the my meosks module, and displaying the selected meosk structure and the selected module, capture new moment, where the option (i) store in my album and post along selected social media channels, has been selected and displayed, and certain social media channels are being selected for posting the captured moments;

FIG. 26A is a GUI screen supported by the my meosks module, and displaying the selected meosk structure (e.g. Christopher's FM Meosk) and the selected module, capture new moment, providing a selection of moment multi-media moment capture tools from which the user can select to capture new moments which will be automatically stored in one of the moment store locations within the meosk structure's GUI-based virtual file and operating system (VFOS) structure;

FIG. 26B is a GUI screen supported by the my meosks module, and displaying the selected meosk structure and the selected module, capture new moment, where the text moment capture tool has been selected and used to capture a text-based moment;

FIG. 26C is a GUI screen supported by the my meosks module, and displaying the selected meosk structure and the selected module, capture new moment, where four options are shown for storing the captured text moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the captured moment along selected social media channels;

FIG. 26D is a GUI screen supported by the my meosks module, and displaying the selected meosk structure and the selected module, capture new moment, where the option (i) store in my album and share with members of the meosk inner circle, has been selected and displayed, and certain members of the meosk structure's inner circle are being selected for sharing;

FIG. 26E is a GUI screen supported by the my meosks module, and displaying the selected meosk structure and the selected module, capture new moment, where the option (i) store in my album and post along selected social media channels, has been selected and displayed, and certain social media channels are being selected for posting the captured text moments;

FIG. 27A is a GUI screen supported by the my meosks module, and displaying the selected meosk structure (e.g. Christopher's FM Meosk) and the selected module, capture new moment, providing a selection of moment multi-media moment capture tools from which the user can select to capture new moments which will be automatically stored in one of the moment store locations within the meosk structure's GUI-based virtual file and operating system (VFOS) structure;

FIG. 27B is a GUI screen supported by the my meosks module, and displaying the selected meosk structure and the selected module, capture new moment, where the drawing/doodling moment capture tool has been selected and used to capture a drawing/doodle-based moment;

FIG. 27C is a GUI screen supported by the my meosks module, and displaying the selected meosk structure and the selected module, capture new moment, where four options are shown for storing the captured drawing/doodle moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the captured moment along selected social media channels;

FIG. 27D is a GUI screen supported by the my meosks module, and displaying the selected meosk structure and the selected module, capture new moment, where the option (i) store in my album and share with members of the meosk inner circle, has been selected and displayed, and certain members of the meosk structure's inner circle are being selected for sharing;

FIG. 27E is a GUI screen supported by the my meosks module, and displaying the selected meosk structure and the selected module, capture new moment, where the option (i) store in my album and post along selected social media channels, has been selected and displayed, and certain social media channels are being selected for posting the captured text moments;

FIG. 28A is a GUI screen supported by the my meosks module, and displaying the selected meosk structure (e.g. Christopher's FM Meosk) and the selected module, capture new moment, providing a selection of moment multi-media moment capture tools from which the user can select to capture new moments which will be automatically stored in one of the moment store locations within the meosk structure's GUI-based virtual file and operating system (VFOS) structure;

FIG. 28B is a GUI screen supported by the my meosks module, and displaying the selected meosk structure and the selected module, capture new moment, where the sound recording moment capture tool has been selected and used to capture a recorded sound moment;

FIG. 28C is a GUI screen supported by the my meosks module, and displaying the selected meosk structure and the selected module, capture new moment, where four options are shown for storing the captured sound moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the recorded sound moment along selected social media channels;

FIG. 28D is a GUI screen supported by the my meosks module, and displaying the selected meosk structure and the selected module, capture new moment, where the option (i) store in my album and share with members of the meosk inner circle, has been selected and displayed, and certain members of the meosk structure's inner circle are being selected for sharing;

FIG. 28E is a GUI screen supported by the my meosks module, and displaying the selected meosk the selected module, capture new moment, where the option (i) store in my album and post along selected social media channels, has been selected and displayed, and certain social media channels are being selected for posting the recorded sound moments;

FIG. 29A is a GUI screen supported by the my meosks module, and displaying the selected meosk structure (e.g. Christopher's FM Meosk) and the selected module, capture new moment, providing a selection of moment multi-media moment capture tools from which the user can select to capture new moments which will be automatically stored in one of the moment store locations within the meosk structure's GUI-based virtual file and operating system (VFOS) structure;

FIG. 29B-1 is a GUI screen supported by the my meosks module, and displaying the selected meosk structure and the selected module, capture new moment, where the web page clipping and moment capture tool has been selected and used to capture a clipped web-page moment as a pdf document;

FIG. 29B-2 is a GUI screen supported by the my meosks module, and displaying the selected meosk structure and the selected module, capture new moment, where the web page clipping and moment capture tool has been selected and used to capture a web-page moment as a saved URL when this tool is configured in its capture URL capture mode;

FIG. 29C is a GUI screen supported by the my meosks module, and displaying the selected meosk structure and the selected module, capture new moment, where four options are shown for storing the captured web-clipped moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the web-page clipped moment along selected social media channels;

FIG. 29D is a GUI screen supported by the my meosks module, and displaying the selected meosk structure and the selected module, capture new moment, where the option (i) store in my album and share with members of the meosk inner circle, has been selected and displayed, and certain members of the meosk structure's inner circle are being selected for sharing;

FIG. 29E is a GUI screen supported by the my meosks module, and displaying the selected meosk structure and the selected module, capture new moment, where the option (i) store in my album and post along selected social media channels, has been selected and displayed, and certain social media channels are being selected for posting the web-page clipped moments;

FIG. 30A is a GUI screen supported by the my meosks module, and displaying the selected meosk structure (e.g. Christopher's FM Meosk) and the selected module, capture new moment, providing a selection of moment multi-media moment capture tools from which the user can select to capture new moments which will be automatically stored in one of the moment store locations within the meosk structure's GUI-based virtual file and operating system (VFOS) structure;

FIG. 30B is a GUI screen supported by the my meosks module, and displaying the selected meosk structure and the selected module, capture new moment, where the file uploading and moment capture tool has been selected and used to find, upload and capture moments represented in uploaded files (e.g. photos, documents, applications etc);

FIG. 30C is a GUI screen supported by the my meosks module, and displaying the selected meosk structure and the selected module, capture new moment, where the file uploading and moment capture tool has been selected and used to find and upload uploaded files (e.g. photos, documents, applications etc);

FIG. 30D is a GUI screen supported by the my meosks module, and displaying the selected meosk structure and the selected module, capture new moment, where the file uploading and moment capture tool has been selected and used to captured moments in uploaded files (e.g. photos, documents, applications etc);

FIG. 30E is a GUI screen supported by the my meosks module, and displaying the selected meosk structure and the selected module, capture new moment, where four options are shown for storing the captured moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the captured moment along selected social media channels;

FIG. 30F is a GUI screen supported by the my meosks module, and displaying the selected meosk structure and the selected module, capture new moment, where the option (i) store in my album and share with members of the meosk inner circle, has been selected and displayed, and certain members of the meosk structure's inner circle are being selected for sharing;

FIG. 30G is a GUI screen supported by the my meosks module, and displaying the selected meosk structure and the selected module, capture new moment, where the option (i) store in my album and post along selected social media channels, has been selected and displayed, and certain social media channels are being selected for posting the web-page clipped moments;

FIG. 31A is a GUI screen supported by the my meosks module, and displaying the selected meosk structure (e.g. Christopher's FM Meosk) and its menu of service functions that are supported within the GUI-based virtual file and operating system (VFOS) environment of each meosk structure supported on the system network 1 of the present invention;

FIG. 31B is a GUI screen supported by the my meosks module, and displaying the selected meosk structure and the selected module, “my journal”, where a particular moment or “page” in the journal has been selected and all messages associated with (i.e. linked to) the moment, by inner circle members of the meosk structure, are displayed for the register user to either (i) play it (i.e. the selected moment) back for review and experience as illustrated in the GUI screens of FIGS. 31C and 31D, or (ii) add or contribute to the selected moment in any number of ways indicated in the GUI screens of FIGS. 31F through 31Y, described below;

FIG. 31C is a GUI screen supported by the my meosks module, and displaying the selected meosk structure and the selected module, my journal, where a selected message associated with the selected moment is recalled from system network memory storage and represented within the meosk structure for the registered user to experience the past message left by the inner circle member, regarding the once shared moment;

FIG. 31D is a GUI screen supported by the my meosks module, and displaying the selected meosk structure and the selected module, my journal, where the user is returned to the GUI screen shown in FIG. 31B, and makes the selection, to “add to it (the selected moment)”, advancing the client system to the GUI screen shown in FIG. 31E;

FIG. 31E is a GUI screen supported by the my meosks module, and displaying the selected meosk) and the selected module, my journal, where a menu of service function icons are displayed in connection with making a contribution to the selected moment in the my journal information store associated with the selected meosk structure;

FIG. 31F is a GUI screen supported by the my meosks module, and displaying the selected meosk structure and the selected module, my journal, where the “favorite it” service function was selected (via its displayed icon) and its corresponding GUI screen displayed allows the user to indicate that the moment should be indexed as a favorite moment;

FIG. 31G is a GUI screen supported by the my meosks module, and displaying the selected meosk and the selected module, my journal, where the “note it” service function was selected (via its displayed icon) and its corresponding GUI screen displayed allows the user to create and link a new message to the moment for persistent storage on the system network;

FIG. 31H is a GUI screen supported by the my meosks module, and displaying the selected meosk the selected module, my journal, where the a created message (i.e. note) is played back for review before linking it to the corresponding moment, for persistent storage on the system network;

FIGS. 31I, 31J and 31K show a series of GUI screens supported by the my meosks module, and displaying the selected meosk structure and the selected module, my journal, where the “gift it” service function was selected (via its displayed icon) and its corresponding GUI screen displayed to allow the user to (i) buy a gift for the person associated with the moment, selected from either the person's wish list, or top ten or more trending gifts for the person in that gender/age group, and (ii) recording this gifting event associated with the moment for persistent storage on the system network;

FIG. 31L shows a GUI screens supported by the my meosks module, and displaying the selected meosk structure and the selected module, my journal, where the “attach it” service function was selected (via its displayed icon) and its corresponding GUI screen displayed allow the user to attach another moment (e.g. associated one or more moments with a particular moment) and link for persistent storage on the system network

FIG. 31M shows a GUI screens supported by the my meosks module, and displaying the selected meosk structure and the selected module, my journal, where the “share it” service function was selected (via its displayed icon) and its corresponding GUI screen displayed allows the user to share the moment and associated messages and attachments with any one or more members of the meosk structure's inner circle, and store a persistent record thereof on the system network;

FIGS. 31N, 31O, 31P and 31Q shows a series of GUI screens supported by the my meosks module, and displaying the selected meosk structure and the selected module, my journal, where the “grab it” service function was selected (via its displayed icon) and its corresponding displayed GUI screen allows the user to grab (i.e. point to and copy) any moment in any of the user's meosks or weosk structures, as well as social media sites, and photo-sharing sites, and copy it into the album store in the current meosk structure;

FIG. 31R shows a GUI screen supported by the my meosks module, and displaying the selected meosk structure and the selected module, my journal, where the “post it” service function was selected (via its displayed icon) and its corresponding displayed GUI screen allows the user to post the moment and associated messages and attachments on any more or more of the user's social media channels, and store a persistent record thereof within the meosk structure;

FIG. 32A is a GUI screen supported by the my meosks module, and displaying the selected meosk structure (i.e. Christopher's FM Meosk) and its menu of service functions that are supported within the GUI-based virtual file and operating system (VFOS) environment of each meosk structure (i.e. object-oriented subsystem) supported within the Quest web-based application;

FIG. 32B is a GUI screen supported by the my meosks module, and displaying the selected meosk structure and the selected module, “my album”, where a particular moment or “page” in the album has been selected and all messages associated with (i.e. linked to) the moment, by inner circle members of the meosk structure, are displayed for the register user to either (i) play it (i.e. the selected moment) back for review and experience as illustrated in the GUI screens of FIGS. 32C and 32D, or (ii) add or contribute to the selected moment in any number of ways indicated in the GUI screens of FIGS. 32F through 31T, described below;

FIG. 32C is a GUI screen supported by the my meosks module, and displaying the selected meosk structure and the selected module, my album, where a selected message associated with the selected moment is recalled from system network memory storage and represented within the meosk structure for the registered user to experience the past message left by the inner circle member, regarding the once shared moment;

FIG. 32D is a GUI screen supported by the my meosks module, and displaying the selected meosk structure and the selected module, my album, where the user is returned to the GUI screen shown in FIG. 31B, and makes the selection, to “add to it (the selected moment)”, advancing the client system to the GUI screen shown in FIG. 31E;

FIG. 32E is a GUI screen supported by the my meosks module, and displaying the selected meosk structure and the selected module, my album, where a menu of service function icons are displayed in connection with making a contribution to the selected moment in the my journal information store associated with the selected meosk structure;

FIG. 32F is a GUI screen supported by the my meosks module, and displaying the selected meosk structure and the selected module, my album, where the “favorite it” service function was selected (via its displayed icon) and its corresponding GUI screen displayed allows the user to indicate that the moment should be indexed as a favorite moment;

FIGS. 32G and 32H show a series of GUI screens supported by the my meosks module, and displaying the selected meosk structure and the selected module, my album, where the a created message (i.e. note) is played back for review before linking it to the corresponding moment, for persistent storage within the meosk;

FIGS. 32I and 32J show a series of GUI screens supported by the my meosks module, and displaying the selected meosk structure and the selected module, my album, where the “note it” service function was selected (via its displayed icon) and its corresponding GUI screen displayed allows the user to create and link a new message to the moment for persistent storage within the meosk;

FIGS. 32K, 32L and 32M show a series of GUI screens supported by the my meosks module, and displaying the selected meosk structure and the selected module, my album, where the “gift it” service function was selected (via its displayed icon) and its corresponding GUI screen displayed to allow the user to (i) buy a gift for the person associated with the moment, selected from either the person's wish list, or top ten or more trending gifts for the person in that gender/age group, and (ii) recording this gifting event associated with the moment for persistent storage within the meosk;

FIG. 32N shows a GUI screens supported by the my meosks module, and displaying the selected meosk structure and the selected module, my album, where the “attach it” service function was selected (via its displayed icon) and its corresponding GUI screen displayed allow the user to attach another moment (e.g. associated one or more moments with a particular moment) and link for persistent storage within the meosk

FIG. 32O shows a GUI screens supported by the my meosks module, and displaying the selected meosk structure and the selected module, my album, where the “share it” service function was selected (via its displayed icon) and its corresponding GUI screen displayed allows the user to share the moment and associated messages and attachments with any one or more members of the meosk structure's inner circle, and store a persistent record thereof within the meosk;

FIGS. 32P, 32Q, 32R and 32S shows a series of GUI screens supported by the my meosks module, and displaying the selected meosk structure and the selected module, my album, where the “grab it” service function was selected (via its displayed icon) and its corresponding displayed GUI screen allows the user to grab (i.e. point to and copy) any moment in any of the user's meosks or weosk structures, as well as social media sites, and photo-sharing sites, and copy it into the album store in the current meosk structure;

FIG. 32T shows a GUI screen supported by the my meosks module, and displaying the selected meosk structure and the selected module, my album, where the “post it” service function was selected (via its displayed icon) and its corresponding displayed GUI screen allows the user to post the moment and associated messages and attachments on any more or more of the user's social media channels, and store a persistent record thereof within the meosk;

FIG. 33A is a GUI screen supported by the my meosks module, and displaying the selected meosk structure (i.e. Christopher's FM Meosk) and its menu of service functions that are supported within the GUI-based virtual file and operating system (VFOS) environment of each meosk structure (i.e. object-oriented subsystem) supported within the Quest web-based application;

FIG. 33B is a GUI screen supported by the my meosks module, and displaying the selected meosk structure and the selected module, “my favorites”, where a particular moment or “page” in the favorites album has been selected and all messages associated with (i e linked to) the moment, by inner circle members of the meosk structure, are displayed for the register user to either (i) play it (i.e. the selected moment) back for review and experience as illustrated in the GUI screens of FIGS. 33C and 33D, or (ii) add or contribute to the selected moment in any number of ways indicated in the GUI screens of FIGS. 33F through 33T, described below;

FIG. 33C is a GUI screen supported by the my meosks module, and displaying the selected meosk structure and the selected module, my favorites, where a selected message associated with the selected moment is recalled from system network memory storage and represented within the meosk structure for the registered user to experience the past message left by the inner circle member, regarding the once shared moment;

FIG. 33D is a GUI screen supported by the my meosks module, and displaying the selected meosk structure and the selected module, my favorites, where the user is returned to the GUI screen shown in FIG. 31B, and makes the selection, to “add to it (the selected moment)”, advancing the client system to the GUI screen shown in FIG. 33E;

FIG. 33E is a GUI screen supported by the my meosks module, and displaying the selected meosk structure and the selected module, my favorites, where a menu of service function icons are displayed in connection with making a contribution to the selected moment in the my journal information store associated with the selected meosk structure;

FIG. 33F shows a GUI screen supported by the my meosks module, and displaying the selected meosk structure and the selected module, my favorites, where the “favorite it” service function was selected (via its displayed icon) and its corresponding GUI screen displayed allows the user to indicate that the moment should be indexed as a favorite moment;

FIG. 33G shows a GUI screen supported by the my meosks module, and displaying the selected meosk structure and the selected module, my favorites, where the a created message (i.e. note) is played back for review before linking it to the corresponding moment, for persistent storage within the meosk;

FIG. 33H shows a GUI screen supported by the my meosks module, and displaying the selected meosk structure and the selected module, my favorites, where the “note it” service function was selected (via its displayed icon) and its corresponding GUI screen displayed allows the user to create and link a new message to the moment for persistent storage within the meosk;

FIG. 33I shows GUI screen supported by the my meosks module, and displaying the selected meosk structure and the selected module, my favorites, where the “gift it” service function was selected (via its displayed icon) and its corresponding GUI screen displayed to allow the user to (i) buy a gift for the person associated with the moment, selected from either the person's wish list, or top ten or more trending gifts for the person in that gender/age group, and (ii) recording this gifting event associated with the moment for persistent storage within the meosk;

FIG. 33J shows a GUI screen supported by the my meosks module, and displaying the selected meosk structure and the selected module, my favorites, where the “attach it” service function was selected (via its displayed icon) and its corresponding GUI screen displayed allow the user to attach another moment (e.g. associated one or more moments with a particular moment) and link for persistent storage within the meosk

FIG. 33K shows a GUI screen supported by the my meosks module, and displaying the selected meosk structure and the selected module, my favorites, where the “share it” service function was selected (via its displayed icon) and its corresponding GUI screen displayed allows the user to share the moment and associated messages and attachments with any one or more members of the meosk structure's inner circle, and store a persistent record thereof within the meosk;

FIG. 33L shows a GUI screen supported by the my meosks module, and displaying the selected meosk structure and the selected module, my favorites, where the “grab it” service function was selected (via its displayed icon) and its corresponding displayed GUI screen allows the user to grab (i.e. point to and copy) any moment in any of the user's meosks or weosk structures, as well as social media sites, and photo-sharing sites, and copy it into the album store in the current meosk structure;

FIG. 33M shows a GUI screen supported by the my meosks module, and displaying the selected meosk structure and the selected module, my favorites, where the “post it” service function was selected (via its displayed icon) and its corresponding displayed GUI screen allows the user to post the moment and associated messages and attachments on any more or more of the user's social media channels, and store a persistent record thereof within the meosk;

FIG. 34A is a GUI screen supported by the my meosks module, and displaying the selected meosk structure (i.e. Christopher's FM Meosk) and its menu of service functions that are supported within the GUI-based virtual file and operating system (VFOS) environment of each meosk structure (i.e. object-oriented subsystem) supported within the system network;

FIGS. 34B and 34C show a series of GUI screens supported by the my meosks module, and displaying the selected meosk the selected module, “Print Shop”, where all or certain moments, and associated messages, stored in selected albums in the meosk structure are selected and used to produce a journey book for the individual or individuals (e.g. ones children or grandchildren) who are uniquely associated with the meosk structure, so that that the journey book be generated and reviewed by such individuals at later date in their lives through any web browser running on any client machine, such as an iPad and like tablet computers;

FIG. 34D is a GUI screen supported by the my meosks module, and displaying the selected meosk structure (i.e. Christopher's FM Meosk) and the selected module, “Print Shop”, where moments, and associated messages, stored in selected albums in the meosk structure are selected for the production (i.e. printing) and publishing of either an online or offline version of an HTML-encoded journey book, for viewing either online or offline using a web browser;

FIG. 34E is a GUI screen supported by the my meosks module, and displaying the selected meosk structure (i.e. Christopher's FM Meosk) and the selected module, “Print Shop”, where the HTML-encoded journey book has been published at a predesignated URL on the WWW, for viewing using a web browser;

FIG. 35A is a GUI screen supported by the my meosks module, and displaying the selected meosk structure (i.e. Christopher's FM Meosk) and its menu of service functions that are supported within the GUI-based virtual file and operating system (VFOS) environment of each meosk structure (i.e. object-oriented subsystem) supported within the system network;

FIG. 35B shows a GUI screen supported by the my meosks module, and displaying the selected meosk structure (i.e. Christopher's FM Meosk) and the selected module, “Favorites Channel”, where all moments, and optionally all associated messages, that have been tagged or indexed as “favorite” in the meosk structure, are automatically displayed in a streamed manner within a media player embedded within the meosk structure;

FIG. 36A is a GUI screen supported by the my meosks module, and displaying the selected meosk structure (i.e. Christopher's FM Meosk) and its menu of service functions that are supported within the GUI-based virtual file and operating system (VFOS) environment of each meosk structure (i.e. object-oriented subsystem) supported within the system network;

FIG. 36B shows a GUI screen supported by the my meosks module, and displaying the selected meosk structure (i.e. Christopher's FM Meosk) and the selected module, “Brand Channel”, where brand advertisements, promotions and other marketing communications from brands associated with products and services associated with the specific-activity linked to the meosk structure, are automatically displayed in a streamed manner within a media player embedded within the meosk structure;

FIG. 37A is a GUI screen supported by the my meosks module, and displaying the selected meosk structure (i.e. Christopher's FM Meosk) and its menu of service functions that are supported within the GUI-based virtual file and operating system (VFOS) environment of each meosk structure (i.e. object-oriented subsystem) supported within the system network;

FIG. 37B shows a GUI screen supported by the my meosks module, and displaying the selected meosk structure and the selected module, “Brand Channel”, where brand advertisements, promotions, product/service information and other marketing communications from brand marketers associated with the products and services selected by the user for use with the specific-activity linked to the meosk structure, are automatically displayed in a streamed manner within a media player embedded within the meosk structure;

FIG. 38A is a GUI screen supported by the my meosks module, and displaying the selected meosk structure (i.e. Christopher's FM Meosk) and its menu of service functions that are supported within the GUI-based virtual file and operating system (VFOS) environment of each meosk structure (i.e. object-oriented subsystem) supported within the system network;

FIG. 38B shows a GUI screen supported by the my meosks module, and displaying the selected meosk structure and the selected module, “Inner Circle Messaging”, where the user can send and receive messages with inner circle members associated with the meosk structure, as well as with any brands linked thereto;

FIG. 38C shows a GUI screen supported by the my meosks module, and displaying the selected meosk structure and the selected module, “Inner Circle Messaging”, where the user receives a message from a brand to which the user sent a message, or from which the user has requested brand contact within the meosk structure;

FIG. 39A shows a GUI screen supported by the “create new meosk” module, and displaying options for creating a new meosk structure for my self (e.g. the user), or a new meosk structure for others (e.g. a child, spouse, grandparent of the user, or another for whom the user will be acting in a trusted or trustee manner);

FIG. 39B shows a GUI screen supported by the create new meosk module, and displaying the first steps involved in creating a new meosk structure for my self (i.e. for the user), involving (i) selecting a field of interest about which the user (or the meosk beneficiary) is passionate or has great interest, and (ii) selecting, in that field, an activity for which the user wishes to create a meosk structure in accordance with the principles of the present invention;

FIG. 39C shows a GUI screen supported by the create new meosk module, and displaying a complete of all of the fields of interest supported by the system of the illustrated embodiment, and from which the user is urged to select a field of interest about which the user (or the meosk beneficiary) is passionate or has great interest;

FIG. 39D shows a GUI screen supported by the create new meosk module, and displaying the first major step involved in creating a new meosk structure for my self (i.e. for the system user), involving the selection of an activity (e.g. ice skating) in the selected field of interest, for which the user wishes to create a meosk structure in accordance with the principles of the present invention;

FIG. 39D-1 is a schematic representation illustrating exemplary activity sets (as) for different stages of an individual's life, for which a meosk structure or a weosk structure might be created and deployed on the system network of the present invention;

FIGS. 39D-2 through 39D-21, taken together, set forth a tree structure representing a primary set of classes of human activity which can be used to classify a very wide range of human activities and interests, and function as a foundation for the activity/product/service/brand index used to support the reverse inquiry based method of brand contact request and marketing communication supported by the meosk/weosk-based private and social media management and communication system network of the present invention;

FIG. 39E shows a GUI screen supported by the create new meosk module, and displaying the second major step involved in creating a new meosk structure for my self (i.e. for the system user), involving proposing a name for the meosk being created;

FIG. 39F shows a GUI screen supported by the create new meosk module, and displaying the third major step involved in creating a new meosk structure for my self (i.e. for the system user) involving capturing a photo or digital image for the meosk structure (e.g. a thumbnail photo of the meosk structure's subject involved in his or her activity of interest);

FIGS. 39G, 39H and 391 show a series of GUI screens supported by the create new meosk module, and displaying the fourth major step involved in creating a new meosk structure for my self (i.e. for the system user), involving building an inner circle of users for the meosk selected from registered users, from selected the user's contacts, and/or added by name and email address (and SMS number), to build up the meosk structure's inner circle list;

FIG. 39J shows a GUI screen supported by the create new meosk module, and displaying the fifth major step involved in creating a new meosk structure for my self (i.e. for the system user), involving the selection and enablement (i.e. activation) of meosk functions such as (i) tagging and copying moments anywhere, (ii) creating public views of meosk structures, (iii) tagging moments as private and non-copy able, (iv) posting meosk structures on social networks and WWW, (v) allowing inner circle members to add new members and expand the inner circle, (vi) linking group meosk structure to other meosk structures, and (vii) linking meosk structures to events, which are to be supported within the meosk structure once deployed, for use by the master user;

FIG. 39K shows a GUI screen supported by the create new meosk module, and displaying the fifth major step involved in creating a new meosk structure for my self (i.e. for the system user), involving the selection and enablement (i.e. activation) of meosk functions such as capture moments, my journal, my album(s), my favorites, my brand channel, my favorites channel, my brands, and inner circle messaging, that are to be supported within the meosk structure once deployed, for use by the master user;

FIG. 39L shows a GUI screen supported by the create new meosk module, and displaying the fifth major step involved in creating a new meosk structure for my self (i.e. for the system user), involving the selection and enablement (i.e. activation) of moment functions such as store-it, favor-it, play-it, note-it, gift-it, attach-it, share-it, grab-it, and post-it, that are to be supported within the meosk structure once deployed, for use by the master user;

FIG. 39M shows a GUI screen supported by the create new meosk module, and displaying the sixth major step involved in creating a new meosk structure for my self (i.e. for the system user), involving the selection of functions that are to be supported within the meosk structure once deployed, for use by guest users, such as such as tagging and copying moments, tagging moments as private and non-copyable, posting meosk structures on social networks and the WWW, and allowing inner circle members to add new members and expand the inner circle, which are to be supported within the meosk structure once deployed, for use by guest users;

FIG. 39N-1 shows a GUI screen supported by the create new meosk module, and displaying the sixth major step involved in creating a new meosk structure for my self (i.e. for the user), involving the selection of meosk functions such as capture moments, my journal, my album(s), my favorites, my brand channel, my favorites channel, my brands, and inner circle messaging, that are to be supported within the meosk structure once deployed, for use by guest users;

FIGS. 39N-2 shows a series of GUI screens supported by the create new meosk module, and displaying the sixth major step involved in creating a new meosk structure for my self (i.e. for the user), involving the selection and enablement (i.e. activation) of moment functions such as store-it, favor-it, play-it, note-it, gift-it, attach-it, share-it, grab-it, and post-it, that are to be supported within the meosk structure once deployed, for use by guest users;

FIG. 39O shows a GUI screen supported by the create new meosk module, and displaying the seventh step involved in creating a new meosk structure for my self (i.e. for the system user), involving the selection of brands and their products and services to support the activity-specific meosk being created;

FIG. 39P shows a GUI screen supported by the create new meosk module, and displaying the eighth step involved in creating a new meosk structure for my self (i.e. for the user), involving the acceptance of the selected brands and request to create the activity-specific meosk that has been specified in the previous steps described above;

FIG. 39Q shows a GUI screen supported by the my meosk module, and displaying the current list of meosk structures that have been created and deployed on the system network;

FIG. 39R shows a GUI screen supported by the my meosk module, and displaying the private soccer meosk created for another and listed on the user's my meosk list because the user is currently the master user of the private soccer meosk created for the benefit of the user's child;

FIG. 40A shows a GUI screen supported by the “create new meosk” module, and displaying options for creating a new meosk structure for my self (i.e. for the system user), or a new meosk structure for others (e.g. a child, spouse, grandparent of the user, or another for whom the user will be acting in a trusted or trustee manner);

FIG. 40B shows a GUI screen supported by the create new meosk module, and displaying the first steps involved in creating a new meosk structure for others (e.g. a child, spouse, grandparent, etc) and identifying for whom the user wishes to create the meosk structure (i.e. name, email address, SMS number, year of birth, gender etc);

FIG. 40C shows a GUI screen supported by the create new meosk module, and displaying the second steps involved in creating a new meosk structure for others, involving (i) selecting a field of interest about which the meosk beneficiary is passionate or has great interest, and (ii) selecting, in that field, an activity for which the user wishes to create a meosk structure in accordance with the principles of the present invention;

FIG. 40D shows a GUI screen supported by the create new meosk module, and displaying the third major step involved in creating a new meosk structure for another, involving the selection of an activity (e.g. ice skating) in the selected field of interest, for which the user wishes to create a meosk structure in accordance with the principles of the present invention;

FIG. 40D-1 is a schematic representation illustrating the tree structure representing a primary set of classes of human activity which can be used to classify a very wide range of human activities and interests, and function as a foundation for the activity/product/service/brand index used to support the reverse inquiry based method of brand contact request and marketing communication supported by the meosk/weosk-based private and social media management and communication system network of the present invention;

FIG. 40E shows a GUI screen supported by the create new meosk module, and displaying the fourth major step involved in creating a new meosk structure for another, involving proposing a name for the meosk being created;

FIG. 40F shows a GUI screen supported by the create new meosk module, and displaying the fifth major step involved in creating a new meosk structure for another involving capturing a photo or digital image for the meosk structure (e.g. a thumbnail photo of the meosk structure's subject involved in his or her activity of interest);

FIGS. 40G, 40H and 401 show a series of GUI screens supported by the create new meosk module, and displaying the sixth major step involved in creating a new meosk structure for another, involving building an inner circle of users for the meosk selected from registered users, from selected user's contacts, and/or added by name and email address (and SMS number), to build up the list of inner circle members for the meosk;

FIG. 40J shows a GUI screen supported by the create new meosk module, and displaying the seventh major step involved in creating a new meosk structure for another, involving the selection and enablement (i.e. activation) of meosk functions such as (i) tagging and copying moments anywhere, (ii) creating public views of meosk structures, (iii) tagging moments as private and non-copyable, (iv) posting meosk structures on social networks and WWW, (v) allowing inner circle members to add new members and expand the inner circle, (vi) linking group meosk structure to other meosk structures, and (vii) linking meosk structures to events, which are to be supported within the meosk structure once deployed, for use by the master user;

FIG. 40K shows a GUI screen supported by the create new meosk module, and displaying the seventh major step involved in creating a new meosk structure for my self (i.e. for the system user), involving the selection and enablement (i.e. activation) of meosk functions such as capture moments, my journal, my album(s), my favorites, my brand channel, my favorites channel, my brands, and inner circle messaging, that are to be supported within the meosk structure once deployed, for use by the master user;

FIG. 40L shows a GUI screen supported by the create new meosk module, and displaying the seventh major step involved in creating a new meosk structure for another, involving the selection and enablement (i.e. activation) of moment functions such as store-it, favor-it, play-it, note-it, gift-it, attach-it, share-it, grab-it, and post-it, that are to be supported within the meosk structure once deployed, for use by the master user;

FIG. 40M shows a GUI screen supported by the create new meosk module, and displaying the eighth major step involved in creating a new meosk structure for another, involving the selection and enablement (i.e. activation) of the selection and enablement (i.e. activation) of meosk functions such as tagging and copying moments, tagging moments as private and non-copyable, posting meosk structures on social networks and WWW, allowing inner circle members to add new members and expand the inner circle, that are to be supported within the meosk structure once deployed, for use by guest users;

FIG. 40N-1 shows a GUI screen supported by the create new meosk module, and displaying the eighth major step involved in creating a capture moments, new meosk structure for another, involving the selection of meosk functions such as my journal, my album(s), my favorites, my brand channel, my favorites channel, my brands, and inner circle messaging, that are to be supported within the meosk structure once deployed, for use by guest users;

FIG. 40N-2 shows a GUI screen supported by the create new meosk module, and displaying the eighth major step involved in creating a new meosk structure for others, involving the selection and enablement (i.e. activation) of moment functions such as store-it, favor-it, play-it, note-it, gift-it, attach-it, share-it, grab-it, and post-it, that are to be supported within the meosk structure once deployed, for use by guest users;

FIG. 40O shows a GUI screen supported by the create new meosk module, and displaying the ninth step involved in creating a new meosk structure for others, involving the selection of brands and their products and services to support the activity-specific meosk being created;

FIG. 40P shows a GUI screen supported by the create new meosk module, and displaying the tenth step involved in creating a new meosk structure for another, involving the acceptance of the selected brands and request to create and deploy the activity-specific meosk structure on the system network as specified and configured in the previous steps described above;

FIG. 40Q shows a GUI screen supported by the my meosk module, and displaying the current list of meosk structures that have been created and deployed on the system network;

FIG. 40R shows a GUI screen supported by the my meosk module, and displaying the First Moments (FM) meosk created for another (i.e. the system user's child, “Christopher”) and listed on the user's my meosk list because the user is currently the master user of the private soccer meosk created for the benefit of the user's child;

FIG. 41A shows a GUI screen supported by the inner circles module, and displaying the introduction screen inviting users to build the inner circles for their meosks and weosks managed on the system network;

FIG. 41B shows a GUI screen supported by the inner circles module, and displaying a list of inner circles for each meosk and weosk created and deployed by the user on the system network cloud computing platform, and where options are provided for selecting a listed inner circle and then either adding members to it, or removing members from it, as the case may require or suggest;

FIG. 41C shows a GUI screen supported by the inner circles module, and displaying a list of inner circles for each meosk and weosk created and deployed by the user on the cloud computing platform, and where the user has selected one meosk inner circle and the option to add members to it and then update the same;

FIG. 41D shows a GUI screen supported by the inner circles module, and displaying a list of inner circles for each meosk and weosk created and deployed by the user on the system network cloud computing platform, and where the user has selected one meosk and the option to remove members from the inner circle and then update the same;

FIG. 42A shows a GUI screen supported by the master meosks module, and displaying the view my bin module, where the user can view all un-stored moments in the user's “my bin” and then choose to delete a selected moment, or move it to a desired meosk structure for storage in one of its selected moment store locations (e.g. journal, album, favorites);

FIG. 42B shows a GUI screen supported by the master meosks module, and displaying the view my bin module, where the user selects a moment for movement to a desired meosk structure, and storage in one of its selected moment store locations (e.g. journal, album, favorites);

FIG. 42C shows a GUI screen supported by the master meosks module, and displaying the view my bin module, where the my bin reflects that the moment selected and moved in the workflow illustrated in the GUI screen of FIG. 42B is now removed from the my bin list;

FIG. 43A shows a GUI screen supported by the master meosks module, and displaying the share moments module, where the user can share moments with inner circle members from meosk structures in either an automated or manual manner;

FIG. 43B shows a GUI screen supported by the master meosks module, and displaying the share moments module, where either an automated or manual manner;

FIG. 43C shows a GUI screen supported by the master meosks module, and displaying the share moments module, where the user sets automatic moment generation to occur every 20 uploads to the meosk structure, but this figure could be greater or less than 20 by user selection and choice;

FIG. 43D shows a GUI screen supported by the master meosks module, and displaying the share moments module, where the user proceeds to reset automatic moment generation to occur every 6 hours;

FIG. 43E shows a GUI screen supported by the master meosks module, and displaying the share moments module, where the user returns to the mode selection GUI and selects manual moment generation to occur within the meosk structure, and over its inner circle;

FIG. 43F shows a GUI screen supported by the master meosks module, and displaying the share moments module, where the user sets manual moment generation within the meosk and over its inner circle;

FIG. 43G shows a GUI screen supported by the master meosks module, and displaying the share moments module, where the user identifies for whom a moment will be created, and what is the subject or theme of the moment (optional);

FIG. 43H shows a GUI screen supported by the master meosks module, and displaying the share moments module, where the user selects and links moments together to compose new moments;

FIG. 43I shows a GUI screen supported by the master meosks module, and displaying the share moments module, where the user selects when the composed moment will be shared across the inner circle of the meosk;

FIG. 43J shows a GUI screen supported by the master meosks module, and displaying the share moments module, where the user sets the terms for sharing the moment across the inner circle (e.g. share one time only, share annually on a recurring basis, share bi-annually on a recurring basis);

FIG. 43K shows a GUI screen supported by the master meosks module, and displaying the share moments module, where the user previews the specially composed moment;

FIG. 43L shows a GUI screen supported by the master meosks module, and displaying the share moments module, where the user adds text and/or voice over the specially composed moment;

FIG. 43M shows a GUI screen supported by the master meosks module, and displaying the share moments module, where the user indicates where the specially composed moment will be shared on the posting date (e.g. over Christopher's First Moments (FM) Channel or other channel);

FIG. 43N shows a GUI screen supported by the master meosks module, and displaying the share moments module, where the user receives an notification that a special moment invitation has been sent to all members of the inner circle of the meosk structure (e.g. Christopher's FM Meosk Channel on Sep. 12, 2014), to be shared on an annually recurring basis;

FIG. 43O shows a GUI screen supported by the master meosks module, and displaying icons for various modules therein, including the post my meosks module, where the master user (i.e. meosk master) and also guests who have been authorized by the meosk master, can post meosk structures to their social media sites and photo-sharing sites, and also “un-post” their posted meosks as desired;

FIG. 43P shows a GUI screen supported by the master meosks module, and displaying the post my meosks module, where the master user selects “Christine's Skating Meosk” for posting to a social media site which has been pre-configured with the system network;

FIG. 43Q shows a GUI screen supported by the master meosks module, and displaying the post my meosks module, where the master user selects a social medial site (e.g. Facebook) to which the selected meosk should be posted using the application programming interface (API) used to interface the system network and this social media site network;

FIGS. 43R and 43S show a series of GUI screens supported by the master meosks module, and displaying the post my meosks module, where the front panel of the Christine's Skating Meosk bears the (social media network) post icon, on both interfaces, for notification purposes;

FIG. 43T shows a GUI screen supported by the master meosks module, and displaying the post my meosks module, where the master user selects the “un-post” button to remove Christine's Skating Meosk from its prior Facebook post (e.g. equivalent to a delete post on the Facebook platform);

FIGS. 43U and 43V shows a series of GUI screens supported by the master meosks module, and displaying the post my meosks module, where the front panel of the un-posted meosk (i.e. Christine's Skating Meosk) no longer bears the post icon, on either user interfaces, for notification purposes;

FIG. 44A shows a GUI screen supported by the master meosks module, and displaying all of the modules available therewithin, including the print shop module;

FIG. 44B shows a GUI screen supported by the master meosks module, and displaying the introduction GUI screen for the print shop module, where the user is invited to proceed forward (i.e. “Let's Go!”) and produce journey books (i.e. storybooks) based on moments captured in meosks;

FIG. 44C shows a GUI screen supported by the master meosks module, and displaying a GUI screen for the print shop module, where the user is asked to identify for whom a journey book is to be created, and then select particular meosks from which the journey book will be composed and prepared for private publishing;

FIG. 44D shows a GUI screen supported by the master meosks module, and displaying a GUI screen for the print shop module, where the user is asked to select particular a journey book to be published;

FIG. 44E shows a GUI screen supported by the master meosks module, and displaying a GUI screen for the print shop module, where the user is asked to publish the selected journey book on a particular host site (e.g. www.questmeosk structure.com) or generate an html-encoded journey book for downloading to the user's desktop or other computing device;

FIG. 44F shows a GUI screen supported by the master meosks module, and displaying a GUI screen for the print shop module, where the user is notified of the fact that the selected journey book has been published at a designated URL and can be accessed and viewed using certain confidential credentials;

FIG. 45 shows a GUI screen supported by the master weosks module, and displaying all of the modules available therewithin, including my weosk structures, create new weosk structure, inner circles, and share moments;

FIG. 46 shows a GUI screen supported by the master weosks module and the my weosks module, and displaying a list of all created and deployed weosk structures, of which the user is an inner circle member;

FIG. 47A shows a GUI screen supported by the my weosks module, and displaying the selected weosk structure (i.e. Soccer Weosk) and its menu of service functions that are supported within the GUI-based virtual file and operating system (VFOS) environment of each weosk structure (i.e. object-oriented subsystem) (i.e. subsystem) including functions such as capture moments, guest book, our album, group calendar, gifts, favorites channel, brand channel our brands, and inner circle messaging;

FIG. 47B shows a GUI screen supported by the my weosks module, and displaying the selected weosk structure and the selected module, capture new moment, providing a selection of moment multi-media moment capture tools from which the user can select to capture new moments which will be automatically stored in one of the moment store locations within the weosk structure's GUI-based virtual file and operating system (VFOS) structure;

FIG. 48A shows a GUI screen supported by the my weosks module, and displaying the selected weosk structure and the selected module, capture new moment, where the video/image recording moment capture tool has been selected and used to capture a video/image recording moment;

FIG. 48B shows a GUI screen supported by the my weosks module, and displaying the selected weosk structure and the selected module, capture new moment, where three options are shown for storing the captured video/image recording moment, namely, (i) store in the shared album and return to the capture tool menu, (iii) store in the shared album and share with members of the inner circle of the selected weosk structure, and (iii) store in the shared album and post the captured moment along selected social media channels;

FIG. 48C shows a GUI screen supported by the my weosks module, and displaying the selected weosk structure and the selected module, capture new moment, where the option (i) store in the shared album and share with members of the weosk structure's inner circle, has been selected and displayed, and certain members of the weosk structure's inner circle are being selected for sharing using the various sharing methods supported on the system network of the present invention;

FIG. 48C-1 shows a schematic representation of the client system application, configured in its weosk support mode, to share moments across the weosk structure's inner circle in connection with the exemplary soccer team weosk structure, where each inner circle member are able to share moments into the shared album of the weosk using any the email, SMS and IMS based techniques of the present invention illustrated in FIGS. 69 though 75B-4;

FIG. 48D shows a GUI screen supported by the my weosks module, and displaying the selected weosk structure and the selected module, capture new moment, where the option (i) store in the shared album and post along selected social media channels, has been selected and displayed, and certain social media channels are being selected for posting the captured moments;

FIG. 49A shows a GUI screen supported by the my weosks module, and displaying the selected weosk structure and the selected module, capture new moment, where the text moment capture tool has been selected and used to capture a text-based moment;

FIG. 49B shows a GUI screen supported by the my weosks module, and displaying the selected weosk structure and the selected module, capture new moment, where three options are shown for storing the captured text moment, namely, (i) store in the shared album and return to the capture tool menu, (ii) store in the shared album and share with members of the inner circle of the selected weosk structure, and (iii) store in the shared album and post the captured moment along selected social media channels;

FIG. 49C shows a GUI screen supported by the my weosks module, and displaying the selected weosk structure and the selected module, capture new moment, where the option (i) store in shared album and share with members of the weosk structure's inner circle, has been selected and displayed, and certain members of the weosk structure's inner circle are being selected for sharing;

FIG. 49D shows a GUI screen supported by the my weosks module, and displaying the selected weosk structure and the selected module, capture new moment, where the option (i) store in the shared album and post along selected social media channels, has been selected and displayed, and certain social media channels are being selected for posting the captured text moments;

FIG. 49E shows a GUI screen supported by the my weosks module, and displaying the selected weosk structure and the selected module, capture new moment, where the drawing/doodling moment capture tool has been selected and used to capture a drawing/doodle-based moment;

FIG. 49F shows a GUI screen supported by the my weosks module, and displaying the selected weosk structure and the selected module, capture new moment, where three options are shown for storing the captured drawing/doodle moment, namely, (i) store in the shared album and return to the capture tool menu, (iii) store in the shared album and share with members of the inner circle of the selected weosk structure, and (iii) store in the shared album and post the captured moment along selected social media channels;

FIG. 49G shows a GUI screen supported by the my weosks module, and displaying the selected weosk structure and the selected module, capture new moment, where the option (i) store in the shared album and share with members of the weosk inner circle, has been selected and displayed, and certain members of the weosk structure's inner circle are being selected for sharing;

FIG. 49H shows a GUI screen supported by the my weosks module, and displaying the selected weosk structure and the selected module, capture new moment, where the option (i) store in the shared album and post along selected social media channels, has been selected and displayed, and certain social media channels are being selected for posting the captured moments;

FIG. 50A shows a GUI screen supported by the my weosks module, and displaying the selected weosk structure and the selected module, capture new moment, where the sound moment capture tool has been selected and used to capture a recorded sound moment;

FIG. 50B is a GUI screen supported by the my weosks module, and displaying the selected weosk structure and the selected module, capture new moment, where three options are shown for storing the captured sound moment, namely, (i) store in the shared album and return to the capture tool menu, (ii) store in the shared album and share with members of the inner circle of the selected weosk structure, and (iii) store in the shared album and post the recorded sound moment along selected social media channels;

FIG. 50C shows a GUI screen supported by the my weosks module, and displaying the selected weosk structure and the selected module, capture new moment, where the option (i) store in the shared album and share with members of the weosk inner circle, has been selected and displayed, and certain members of the weosk structure's inner circle are being selected for sharing;

FIG. 50D shows a GUI screen supported by the my weosks module, and displaying the selected weosk structure and the selected module, capture new moment, where the option (i) store in the shared album and post along selected social media channels, has been selected and displayed, and certain social media channels are being selected for posting the recorded sound moments;

FIG. 51A shows a GUI screen supported by the my weosks module, and displaying the selected and the selected module, capture new moment, where the web page clipping and moment capture tool has been selected and used to capture a clipped web-page moment;

FIG. 51B shows a GUI screen supported by the my weosks module, and displaying the selected weosk structure and the selected module, capture new moment, where three options are shown for storing the captured web-clipped moment, namely, (i) store in the shared album and return to the capture tool menu, (ii) store in the shared album and share with members of the inner circle of the selected weosk structure, and (iii) store in the shared album and post the web-page clipped moment along selected social media channels;

FIG. 51C shows a GUI screen supported by the my weosks module, and displaying the selected weosk structure and the selected module, capture new moment, where the option (i) store in the shared album and share with members of the weosk inner circle, has been selected and displayed, and certain members of the weosk structure's inner circle are being selected for sharing;

FIG. 51D shows a GUI screen supported by the my weosks module, and displaying the selected weosk structure and the selected module, capture new moment, where the option (i) store in the shared album and post along selected social media channels, has been selected and displayed, and certain social media channels are being selected for posting the web-page clipped moments;

FIG. 52A shows a GUI screen supported by the my weosks module, and displaying the selected weosk structure and the selected module, capture new moment, where the file uploading and moment capture tool has been selected and used to find and upload uploaded files (e.g. photos, documents, applications etc);

FIG. 52B shows a GUI screen supported by the my weosks module, and displaying the selected weosk (and the selected module, capture new moment, where three options are shown for storing the captured moment, namely, (i) store in the shared album and return to the capture tool menu, (ii) store in the shared album and share with members of the inner circle of the selected weosk structure (i.e. GUI-based virtual file and operating system—VFOS), and (iii) store in the shared album and post the captured moment along selected social media channels;

FIG. 52C shows a GUI screen supported by the my weosks module, and displaying the selected weosk (and the selected module, capture new moment, where the option (i) store in the shared album and share with members of the weosk inner circle, has been selected and displayed, and certain members of the weosk structure's inner circle are being selected for sharing;

FIG. 52D shows a GUI screen supported by the my weosks module, and displaying the selected weosk structure and the selected module, capture new moment, where the option (i) store in the shared album and post along selected social media channels, has been selected and displayed, and certain social media channels are being selected for posting the web-page clipped moments;

FIG. 53A shows a GUI screen supported by the my weosks module, and displaying the selected weosk structure and the selected module, “guest book”, where a particular “page” in the guest book has been selected and all messages associated with (i.e. linked to) the page, by inner circle members of the weosk structure, are displayed for the registered user to review and/or write some notes on the page for posterity purposes;

FIG. 53B shows a GUI screen supported by the my weosks module, and displaying the selected weosk structure and the selected module, “guest book”, where the user posts a note or message in the guest book;

FIG. 53C shows a GUI screen supported by the my weosks module, and displaying the selected weosk structure and the selected module, “guest book”, where the user returns to the guest book after writing and posting a note to the guest book;

FIG. 54A shows a GUI screen supported by the my weosks module, and displaying the selected weosk structure (i.e. soccer team weosk) and the selected module, shared album, where a particular moment or “page” in the shared album has been selected and all messages associated with (i.e. linked to) the moment by inner circle members of the weosk are displayed for the register user to either (i) play it (i.e. the selected moment) back for review and experience as illustrated in the GUI screens of FIG. 54B, or (ii) add or contribute to the selected moment in any number of ways indicated in the GUI screens of FIGS. 54C through 54V described below;

FIG. 54B shows a GUI screen supported by the my weosks module, and displaying the selected weosk structure and the selected module, shared album, where a selected message associated with the selected moment is recalled from system network memory storage and represented within the weosk structure for the registered user to experience the past message left by the inner circle member, regarding the once shared moment;

FIG. 54C shows a GUI screen supported by the my weosks module, and displaying the selected weosk structure and the selected module, shared album, where upon selecting the “add to it (the selected moment)” selection shown in FIG. 54A, a menu of service function icons are displayed in connection with making a contribution to the selected moment in the shared journal store associated with the selected weosk structure;

FIG. 54D shows a GUI screen supported by the my weosks module, and displaying the selected weosk structure and the selected module, shared album, where the “favorite it” service function was selected (via its displayed icon) and its corresponding GUI screen displayed allows the user to indicate that the moment should be indexed as a favorite moment;

FIGS. 54E and 54F shows a series of GUI screens supported by the my weosks module, and displaying the selected weosk structure and the selected module, shared album, where the “copy it” service function was selected (via its displayed icon) and its corresponding GUI screen displayed allows the user to tag moments selected in the shared album and copy the tagged moments into a selected meosk structure of the user (e.g. Christopher's Personal Soccer Meosk) for persistent storage on the system network;

FIG. 54G shows a GUI screen supported by the my weosks module, and displaying the selected weosk structure and the selected module, shared album, where the “note it” service function was selected (via its displayed icon) and its corresponding GUI screen displayed allows the user to create a note in text or voice form and link it to a selected moment for persistent storage on the system network;

FIGS. 54H, 541, 54J, 54K, 54L and 54M show a series of GUI screens supported by the my weosks module, and displaying the selected weosk structure and the selected module, shared album, where the “gift it” service function is selected (via its displayed icon) and corresponding GUI screens displayed to allow the user to (i) buy a gift for the person associated with the moment, selected from either the person's wish list, or top ten or more trending gifts for the person in that gender/age group, and (ii) recording this gifting event associated with the moment for persistent storage within the weosk structure;

FIG. 54N shows a GUI screens supported by the my weosks module, and displaying the selected weosk structure and the selected module, the shared album, where the “attach it” service function has been selected (via its displayed icon) and its corresponding GUI screen displayed allowing the user to attach another moment (e.g. associated one or more moments with a particular moment) and link for persistent storage within the meosk

FIG. 54O shows a GUI screens supported by the my meosks module, and displaying the selected meosk structure (i.e. Christopher's FM Meosk) and the selected module, the shared album, where the “share it” service function has been selected (via its displayed icon) and its corresponding GUI screen displayed allowing the user to share the moment and associated messages and attachments with any one or more members of the meosk structure's inner circle, and store a persistent record thereof within the meosk;

FIGS. 54P, 54Q, 54R, 54S, 54T and 54U shows a series of GUI screens supported by the my weosks module, and displaying the selected weosk structure and the selected module, the shared album, where the “grab it” service function has been selected (via its displayed icon) and its corresponding displayed GUI screen allowing the user to grab (i.e. point to and copy) any moment in any of the user's meosks or weosk structures, as well as social media sites, and photo-sharing sites, and copy it into the shared album store in the current weosk structure;

FIG. 54V shows a GUI screen supported by the my weosks module, and displaying the selected weosk structure and the selected module, the shared album, where the “post it” service function has been selected (via its displayed icon) and its corresponding GUI screen displayed allowing the user to post the moment and associated messages and attachments on any more or more of the user's social media channels, and store a persistent record thereof within the weosk structure;

FIG. 55 shows a GUI screen supported by the my weosks module, and displaying the selected weosk structure and the selected module, “group calendar”, where any user who is an inner circle member of the group can post events to the group calendar to notify members of upcoming events and the like;

FIGS. 56A through 56D show a series of GUI screens supported by the my weosks module, and displaying the selected weosk structure and the selected module, “gift shop” (or gift it), where a user selects a gift (e.g. for the soccer team coach) and sends it to her via the e-commerce services supported by the system of the present invention;

FIG. 57 is a GUI screen supported by the my weosks module, and displaying the selected weosk structure and the selected module, “favorites channel”, where a playlist-driven or like media player is supported for displaying moments tagged as “favorite” in the weosk structure, in a manner and style determined by a program controlling the video streaming process running on the media player integrated into the weosk structure;

FIG. 58 is a GUI screen supported by the my weosks module, and displaying the selected weosk structure and the selected module, “brand channel”, where a media player is supported for displaying advertisements, promotions and product/service information associated with the brands selected by the different members of the weosk structure's inner circle;

FIGS. 59A through 59C show a series of GUI screens supported by the my weosks module, and displaying the selected weosk structure and the selected module, brands, where the user (i.e. inner circle member) can select the brands they wish to be associated with in the selected weosk structure, and receive contact and communication from such brands;

FIGS. 59D and 59E show a series of GUI screen supported by the my weosks module and displaying the soccer team weosk and its inner circle messaging, wherein the user is provide with a GUI for sending a message to inner circle members currently listed on the inner circle weosk list, or any brand on the soccer team brand list;

FIG. 60A shows a GUI screen supported by the “master weosks” module, and displaying options for selecting the “create new weosk” module from a menu list of options;

FIG. 60B shows a GUI screen supported by the “create new weosk” module, and displaying options for creating a new weosk structure for my family or for my group;

FIG. 60C-1 shows a GUI screen supported by the create new weosk module, and displaying the first step involved in creating a new weosk structure for my family, involving (i) identifying the family leader or leaders by name, year of birth, gender etc.;

FIG. 60C-2 shows a GUI screen supported by the create new weosk module, and displaying instructions for the second step involved in creating a new weosk involving providing (i) the name of the side of the family for which one is creating the weosk structure, or (ii) the names of both sides of the family for which one is creating the weosk structure;

FIG. 60D-1 shows a GUI screen supported by the create new weosk module, and displaying the next two steps involved in creating a new weosk structure for my family, involving (i) selecting the field of interest about which the group is passionate (e.g. sports and athletics) and (ii) in the that field, selecting an activity for which the family's admin (i.e. weosk master) wishes to create a family weosk structure;

FIG. 60D-2 shows a schematic representation illustrating the tree structure representing a primary set of classes of human activity which can be used to classify a very wide range of human activities and interests, and function as a foundation for the activity/product/service/brand index used to support the reverse inquiry based method of brand contact request and marketing communication supported by the meosk/weosk-based private and social media management and communication system network of the present invention;

FIG. 60E shows a GUI screen supported by the create new weosk module, and displaying the third step involved in creating a new weosk structure for my family involving capturing a photo or digital image for the weosk structure (e.g. a thumbnail photo of the family, grandparents or house or location identified involved with the family);

FIGS. 60F, 60G and 60H show a series of GUI screens supported by the create new weosk module, and displaying the fourth step involved in creating a new weosk structure for my family, involving building an inner circle of users for the family weosk selected from registered users, the user's contacts, and/or individuals added by name and email address (and SMS number), to build up the family weosk's inner circle list;

FIG. 60I shows a GUI screen supported by the create new weosk module, and displaying the fifth step involved in creating a new weosk structure for family, involving the optional identification of which members of the family inner circle have parents, grandparents, spouses and children, what are the names and years of birth of these parents, grandparents, spouses and children, to assist in the automatic generation of family inner circle structures that can facilitate communications and messaging on the system network;

FIG. 60J shows a GUI screen supported by the create new weosk module, and displaying the sixth major step involved in creating a new weosk structure for my family, involving the selection and enablement (i.e. activation) of weosk functions such as (i) tagging and copying moments, (ii) create public views of the weosk structure, (iii) tag moments as private/non-copyable, (iv) post weosk on social networks & elsewhere on the WWW, (v) allowing inner circle members to add new members and expand the inner circle, and (vi) linking the weosk structure to events, all of which are weosk functions to be supported within the weosk structure once deployed, for use by the master user;

FIG. 60K-1 shows a GUI screen supported by the create new weosk module, and displaying the sixth major step involved in creating a new weosk structure for my family, involving the selection and enablement (i.e. activation) of weosk functions such as capture moments, my journal, my album(s), my favorites, my brand channel, my favorites channel, my brands, and inner circle messaging, that are to be supported within the weosk structure once deployed, for use by the master user;

FIG. 60K-2 shows a GUI screen supported by the create new weosk module, and displaying the sixth major step involved in creating a new weosk structure for my family, involving the selection and enablement (i.e. activation) of moment functions such as store-it, favor-it, play-it, note-it, gift-it, attach-it, share-it, grab-it, and post-it, that are to be supported within the weosk structure once deployed, for use by the master user;

FIG. 60K-3 shows a GUI screen supported by the create new weosk module, and displaying the seventh major step involved in creating a new weosk structure for my family, involving the selection and enablement (i.e. activation) of the selection and enablement (i.e. activation) of weosk functions such as tagging and copying moments, tagging moments as private and non-copyable, posting weosks on social networks and WWW, allowing inner circle members to add new members and expand the inner circle, that are to be supported within the weosk structure once deployed, for use by guest users;

FIG. 60K-4 shows a GUI screen supported by the create new weosk module, and displaying the seventh major step involved in creating a new weosk structure for my family, involving the selection of weosk functions such as capture moments, my journal, my album(s), my favorites, my brand channel, my favorites channel, my brands, and inner circle messaging, that are to be supported within the weosk structure once deployed, for use by guest users;

FIG. 60K-5 shows a GUI screen supported by the create new weosk module, and displaying the seventh major step involved in creating a new weosk structure for my family, involving the selection and enablement (i.e. activation) of moment functions such as store-it, favor-it, play-it, note-it, gift-it, attach-it, share-it, grab-it, and post-it, that are to be supported within the weosk structure once deployed, for use by guest users;

FIG. 60L shows a GUI screen supported by the create new weosk module, and displaying the eighth step involved in creating a new weosk structure for my family, involving the indication and identification of any event(s) that should be associated with the family weosk being created;

FIG. 60M shows a GUI screen supported by the create new weosk module, and displaying the ninth step involved in creating a new weosk structure for my family, involving the listing and capturing of favorite family traditions;

FIG. 60N shows a GUI screen supported by the create new weosk module, and displaying the tenth step involved in creating a new weosk structure for my family, involving the identification of brands to support my family, which may be selected from a variety of diverse fields such as finance and insurance, sports and entertainment, college and education, faith and religion, etc.;

FIG. 60O shows a GUI screen supported by the create new weosk module, and displaying the eleventh step involved in creating a new weosk structure for my family, involving the identification of local brand to support my family, which may be selected from a variety of diverse fields such retailers and restaurants, businesses and merchants, and schools, churches and associations, etc.;

FIG. 60P shows a GUI screen supported by the my weosk module, and displaying the twelfth step involved in creating a new weosk structure for my family, where the weosk administrator (i.e. weosk master) determines when to archive the family weosk on the system network of the present invention;

FIG. 60Q shows a GUI screen supported by the my weosk module, and displaying the thirteen step involved in creating a new weosk structure for my family, involving the acceptance of the previous selections made and making a request to create my family weosk structure and invite all identified family members to join the weosk structure's inner circle;

FIG. 60R shows a GUI screen supported by the my weosk module, and displaying the current lists of weosks that have been created and deployed on the network, and of which the logged-in user (e.g. a weosk master or weosk guest) is an inner circle member;

FIG. 60S shows a GUI screen supported by the my weosk module, and displaying the GUI of the “family weosk” created during the previous illustrated workflow, and listed on the user's my weosk listed in FIG. 60R;

FIG. 61A shows a GUI screen supported by the “master weosks” module, and displaying options for selecting the “create new weosk” module from a menu list of options;

FIG. 61B shows a GUI screen supported by the “create new weosk” module, and displaying options for creating a new weosk structure for my group;

FIGS. 61C, 60D and 60E show a series of GUI screens supported by the create new weosk module, and displaying the first step involved in creating a new weosk structure for my group, involving (i) selecting the field of interest about which the group is passionate (e.g. sports and athletics) and (ii) in the that field, selecting an activity for which the group's admin (i.e. weosk master) wishes to create a group weosk structure;

FIG. 61E-1 is a schematic representation illustrating the tree structure representing a primary set of classes of human activity which can be used to classify a very wide range of human activities and interests, and function as a foundation for the activity/product/service/brand index used to support the reverse inquiry based method of brand contact request and marketing communication supported by the meosk/weosk-based private and social media management and communication system network of the present invention;

FIG. 61F shows a GUI screen supported by the create new weosk module, and displaying instructions for the second step involved in creating a new weosk structure, allowing the weosk master to identify an event that should be associated with the creation of the group weosk structure;

FIG. 61G shows a GUI screen supported by the create new weosk module, and displaying a GUI screen supported by the second step involving indicating whether the planned or upcoming event (associated with the new weosk being created) is either a (ii) holiday, or (ii) special occasion;

FIGS. 61H and 611 show a series of GUI screens supported by the create new weosk module, in response to the selection of “holiday” in FIG. 61G, allowing the weosk master to specify what is the name of the upcoming holiday event;

FIGS. 61J and 61K show a series of GUI screens supported by the create new weosk module, in response to the selection of “special occasions” in FIG. 61G, allowing the weosk master to specify what is the name of the upcoming special occasion;

FIG. 61L shows a GUI screen supported by the create new weosk module, and displaying a GUI screen supported by the third step allowing the weosk master to specify when the specified event is the scheduled to happen, using a calendar widget supported within the weosk structure;

FIG. 61M shows a GUI screen supported by the create new weosk module, and displaying a GUI screen supported by the fourth step allowing the weosk master to specify where the specified event is the scheduled to happen, using a template driven widget supported within the weosk structure to capture such event location information, including online location (e.g. URL), GPS coordinates where appropriate and the like;

FIGS. 61N, 610 and 61P show a series of GUI screen supported by the create new weosk module, and displaying GUI screens supported by the fifth step allowing the weosk master determining whether to activate or deactivate automatic moment generation across the inner circle of the weosk being created;

FIG. 61Q shows a GUI screen supported by the create new weosk module, and displaying a GUI screen supported by the sixth step allowing the weosk master to confirm and accept the name that the system proposes for the group weosk structure, or provide an alternative name desired by the weosk master;

FIG. 61R shows a GUI screen supported by the create new weosk module, and displaying a GUI screen supported by the seventh step allowing the weosk master to capture and assign a photo or digital image for the weosk structure (e.g. a thumbnail photo of group members engaged in their activity of interest);

FIGS. 61S, 61T and 61U show a series of GUI screens supported by the create new weosk module, and displaying the eighth step involved in creating a new weosk structure for my group, involving building an inner circle of users for the group weosk selected from registered users, the user's contacts, and/or individuals added by name and email address (and SMS number), to build up the group weosk's inner circle list;

FIG. 61V shows a GUI screen supported by the create new weosk module, and displaying the ninth step involved in creating a new weosk structure for my group, allowing the meosk master to identify the name and year or birth of each player or actor related to and associated with each member of the group's inner circle so as to facilitate communications among group members and players/actors;

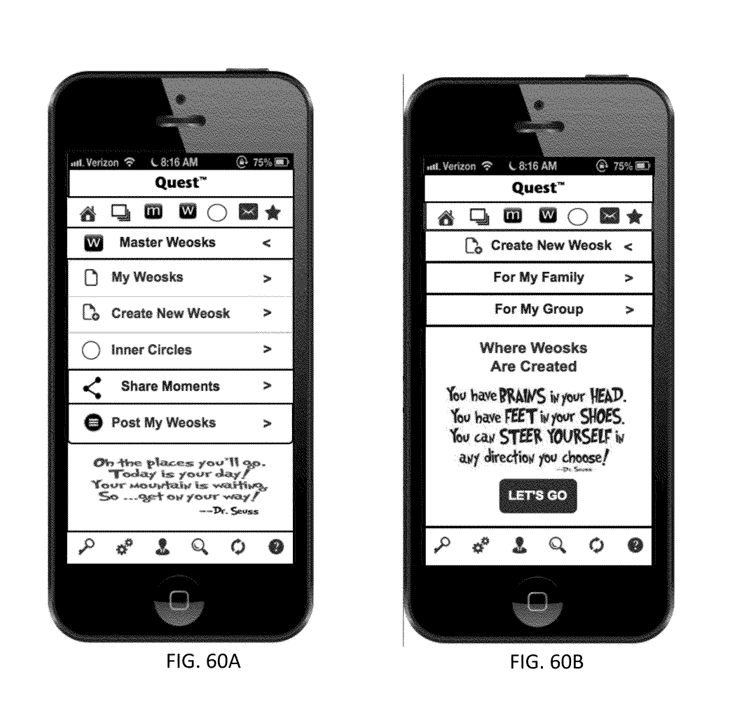

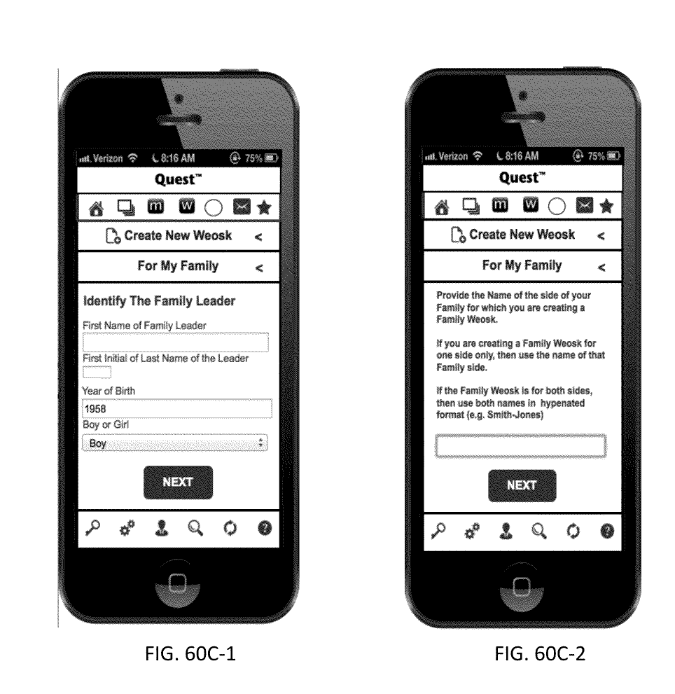

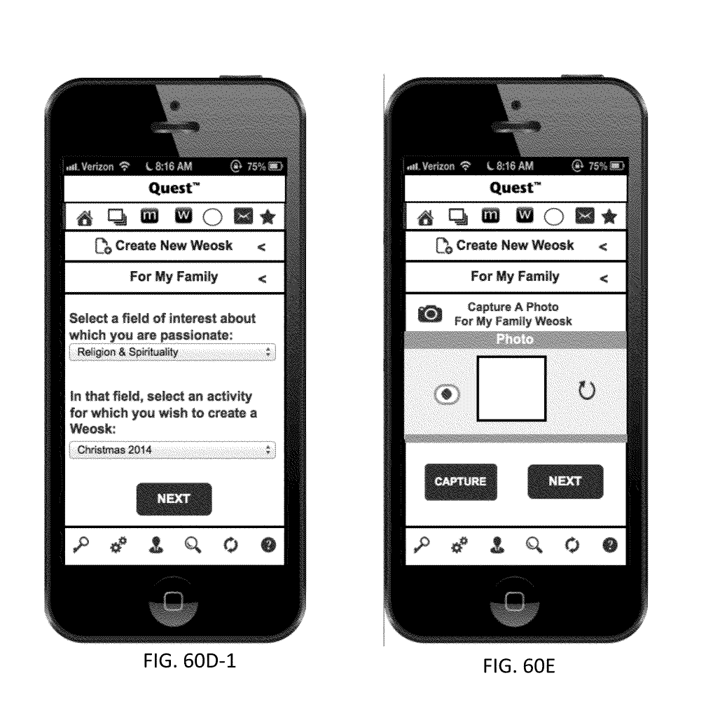

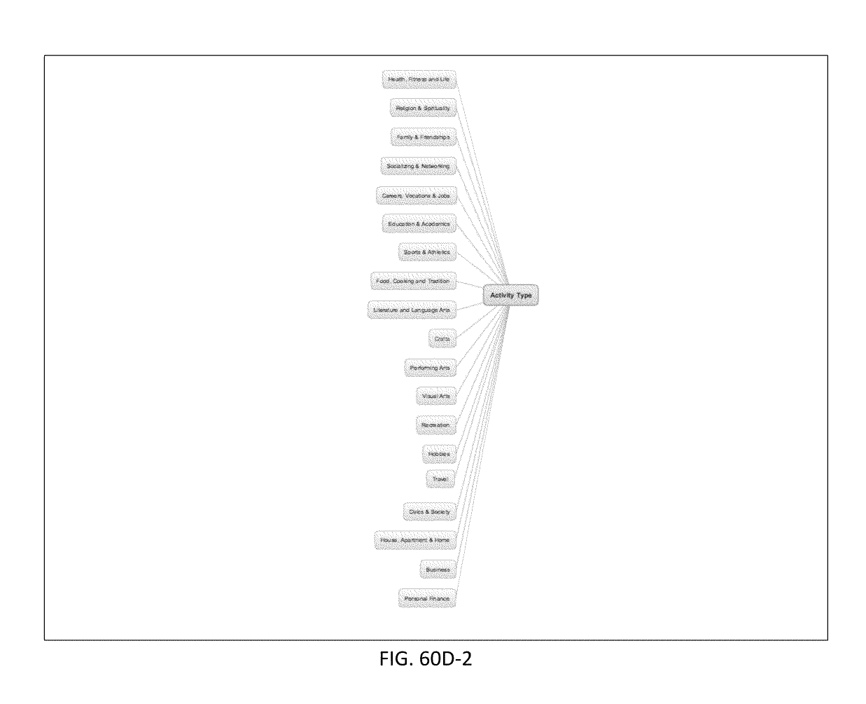

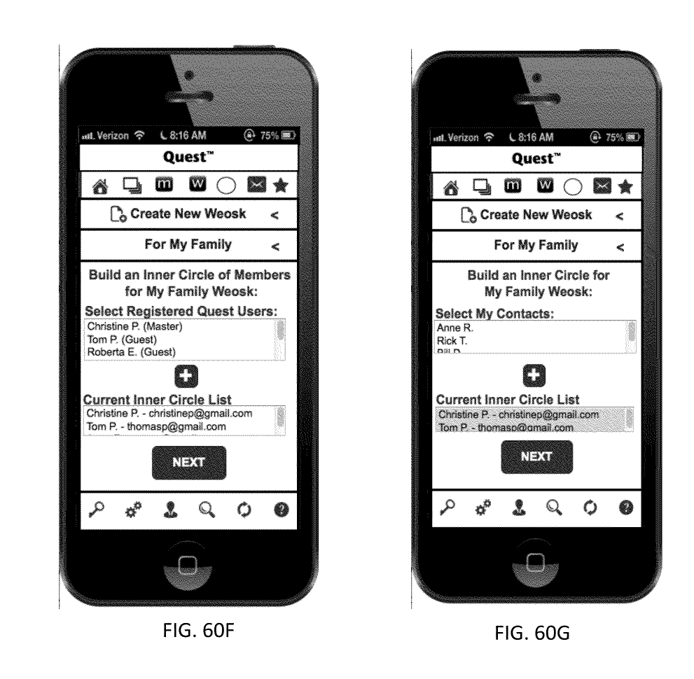

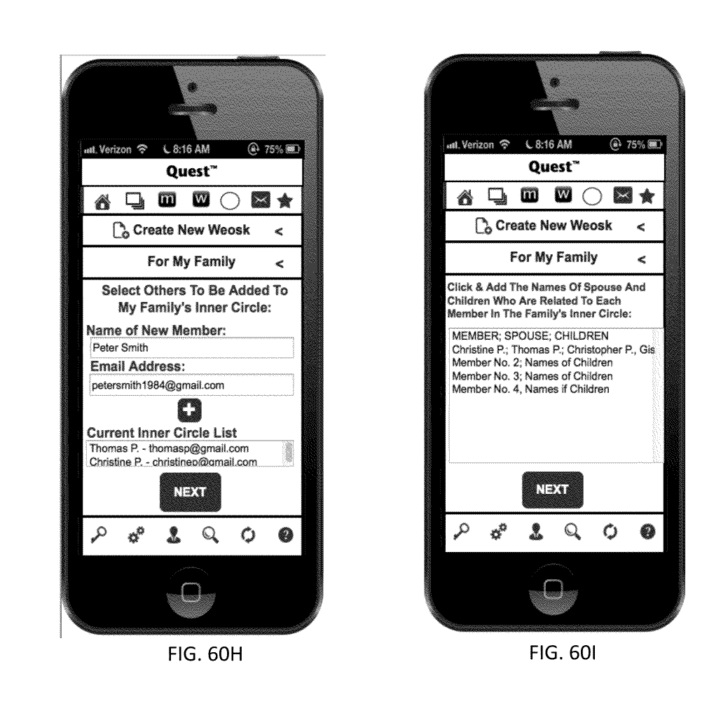

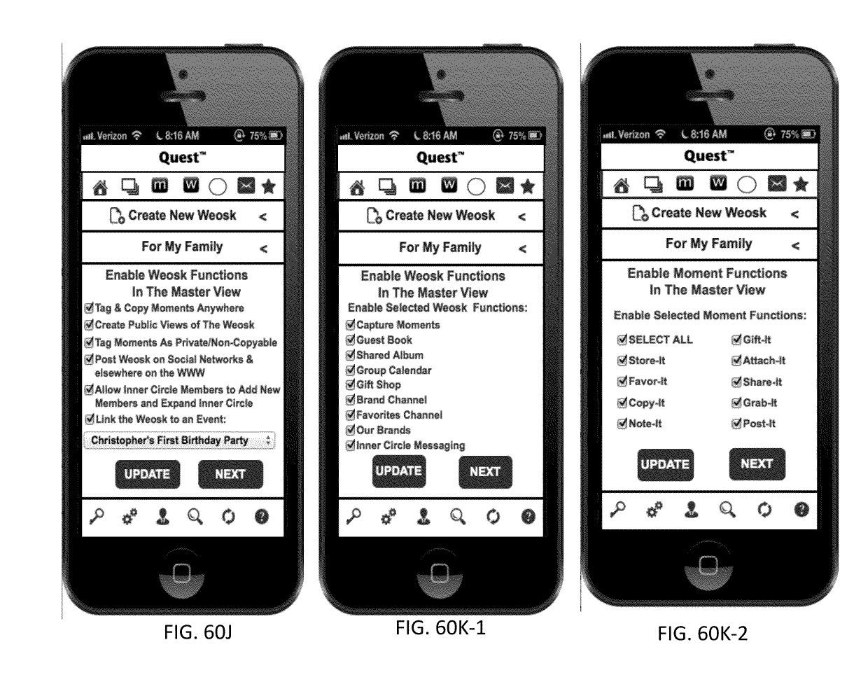

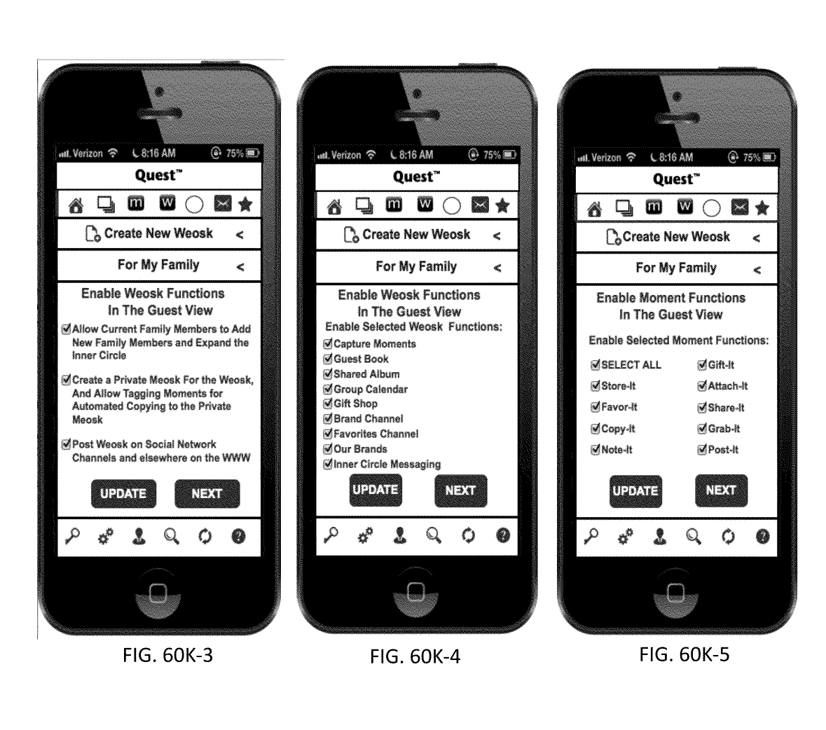

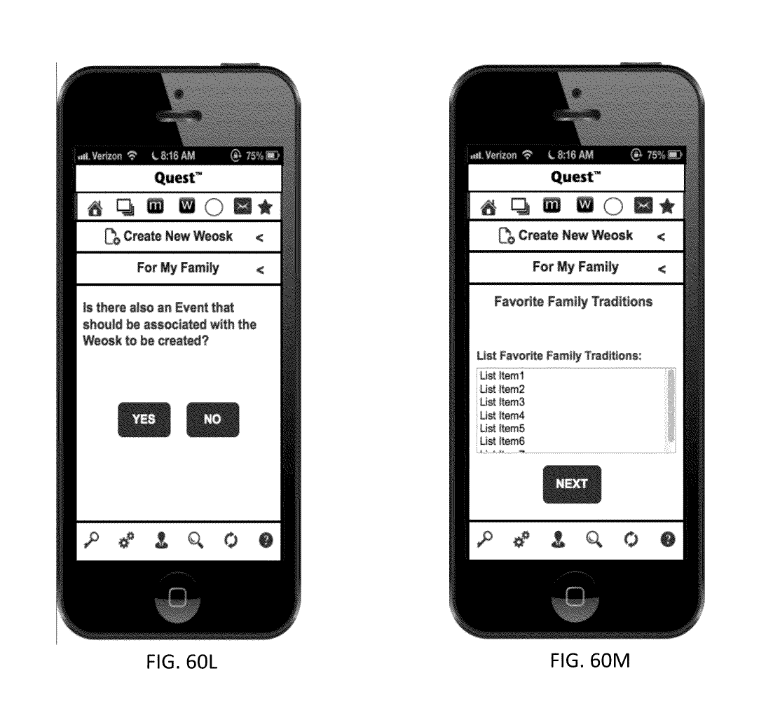

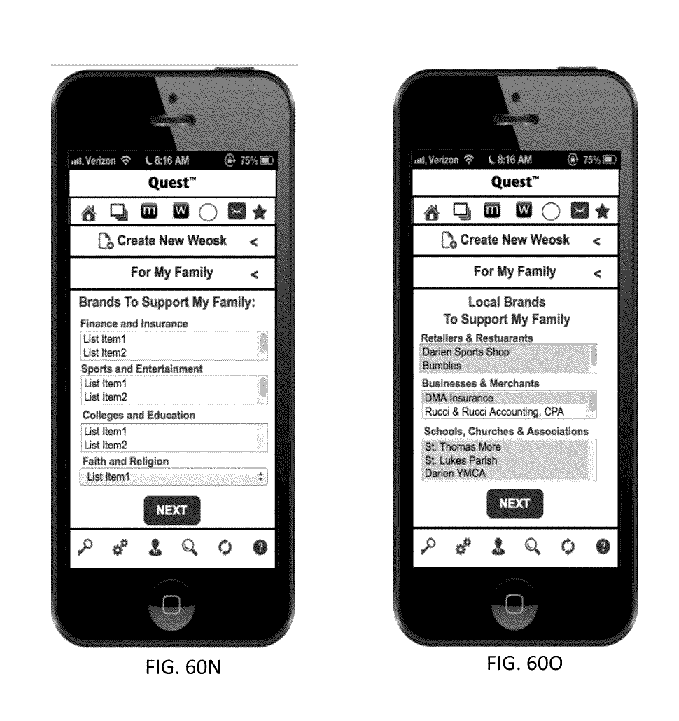

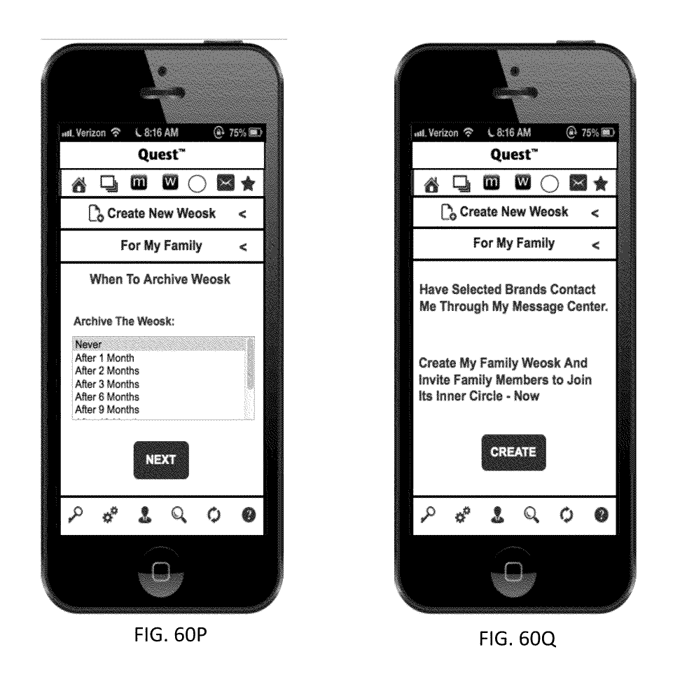

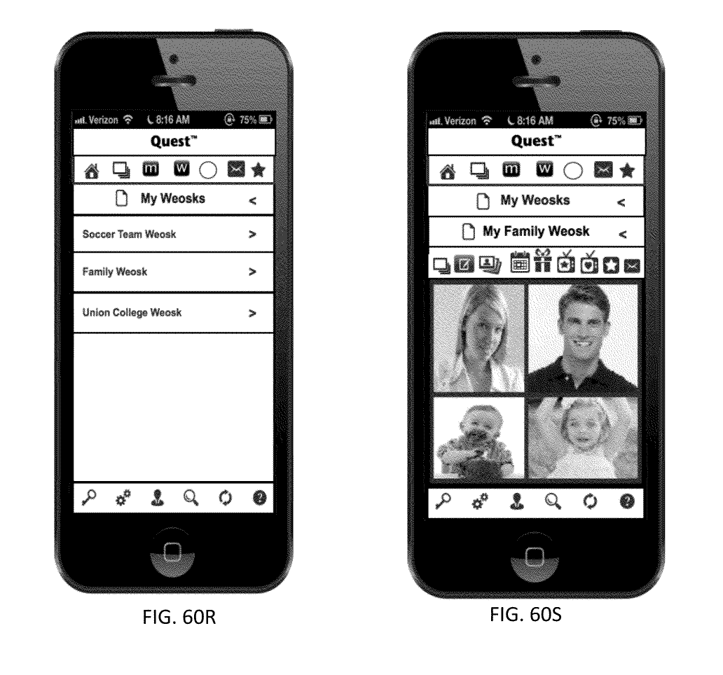

FIG. 60W shows a GUI screen supported by the create new weosk module, and displaying the sixth major step involved in creating a new weosk structure for my family, involving the selection and enablement (i.e. activation) of weosk functions such as (i) tagging and copying moments, (ii) create public views of the weosk structure, (iii) tag moments as private/non-copyable, (iv) post weosk on social networks & elsewhere on the WWW, (v) allowing inner circle members to add new members and expand the inner circle, and (vi) linking the weosk structure to events, all of which are weosk functions to be supported within the weosk structure once deployed, for use by the master user;

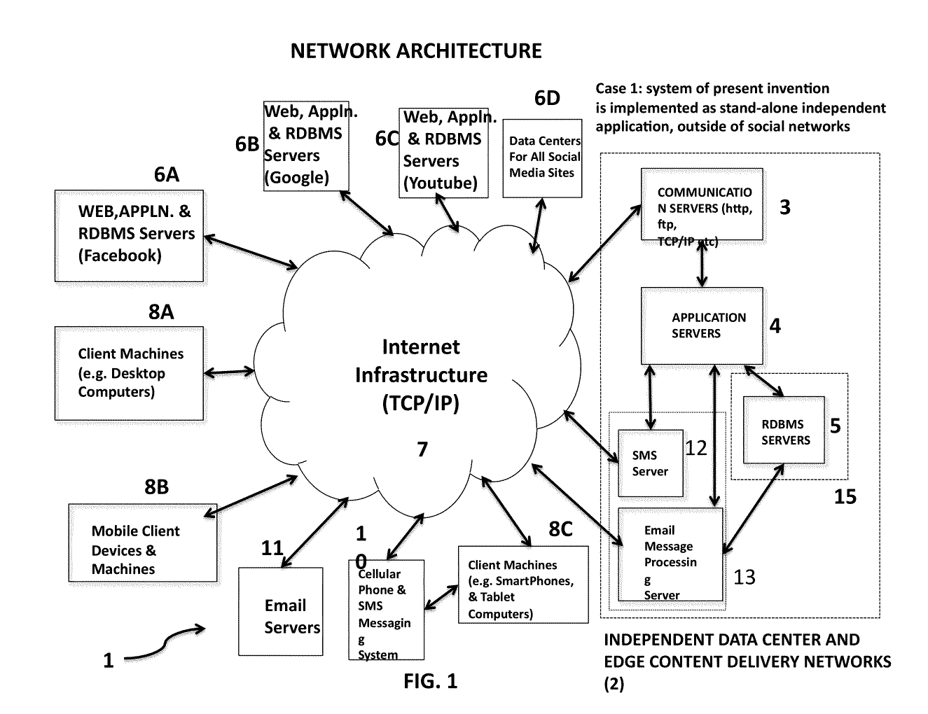

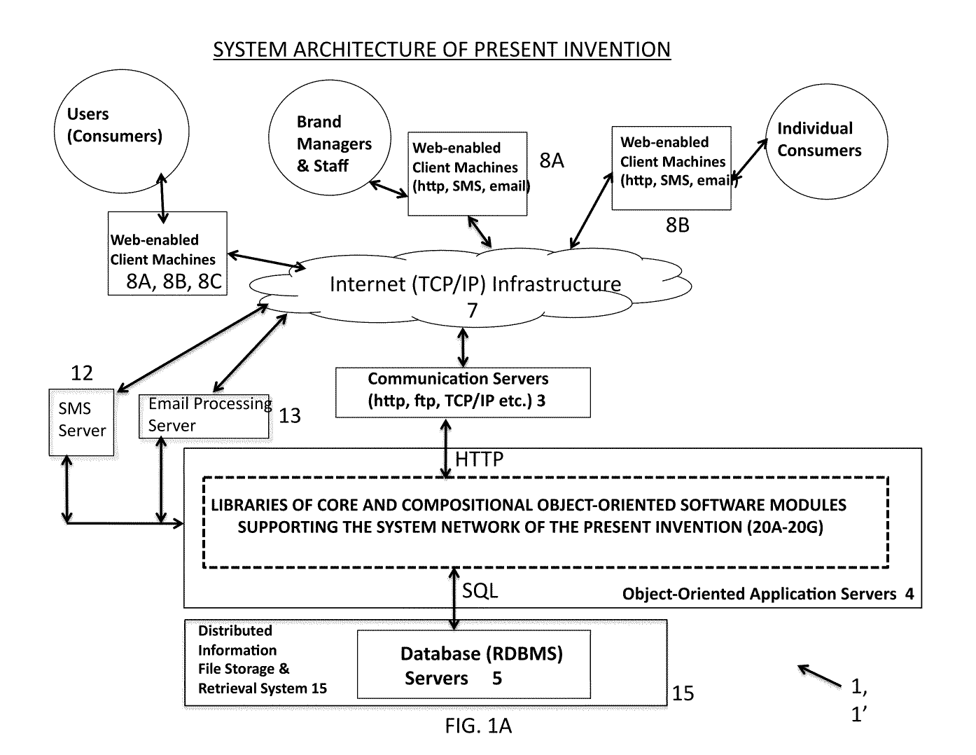

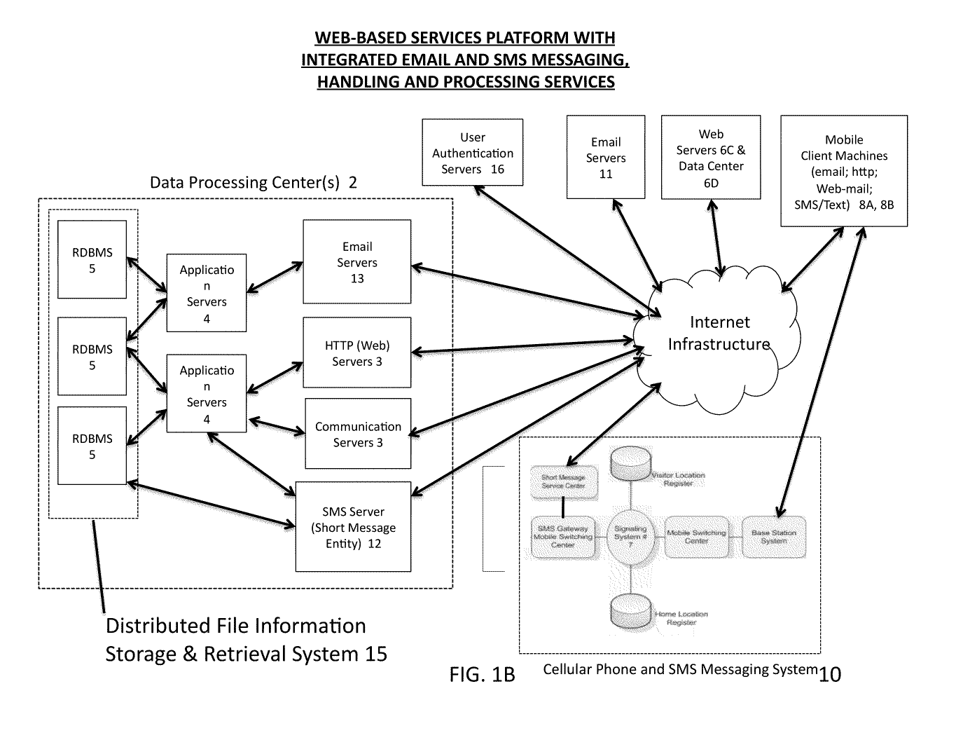

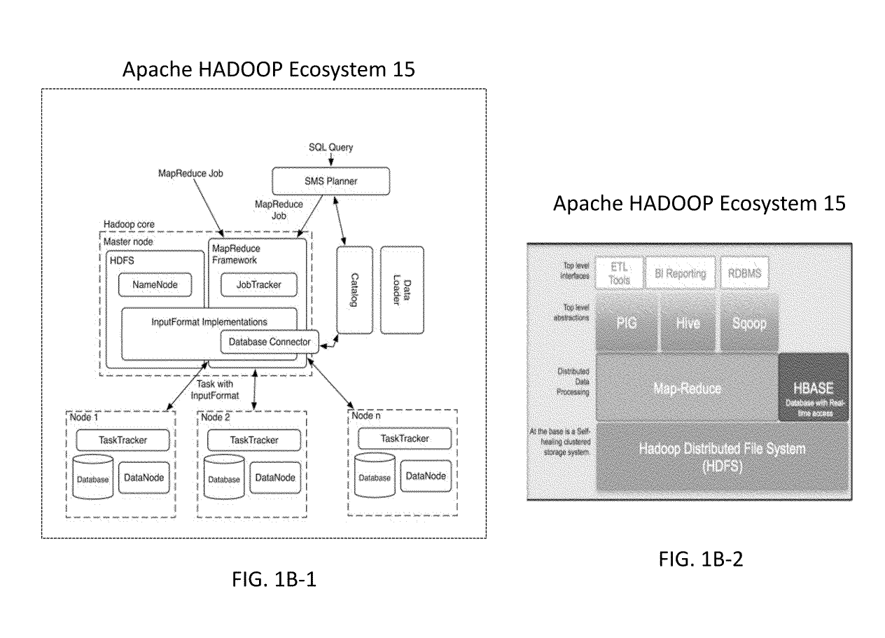

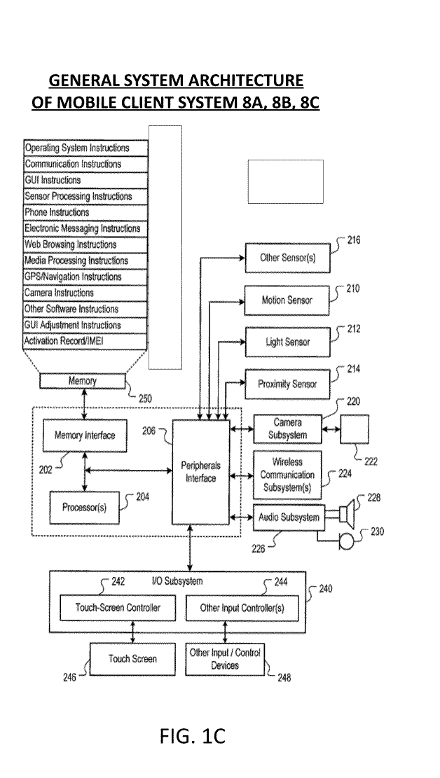

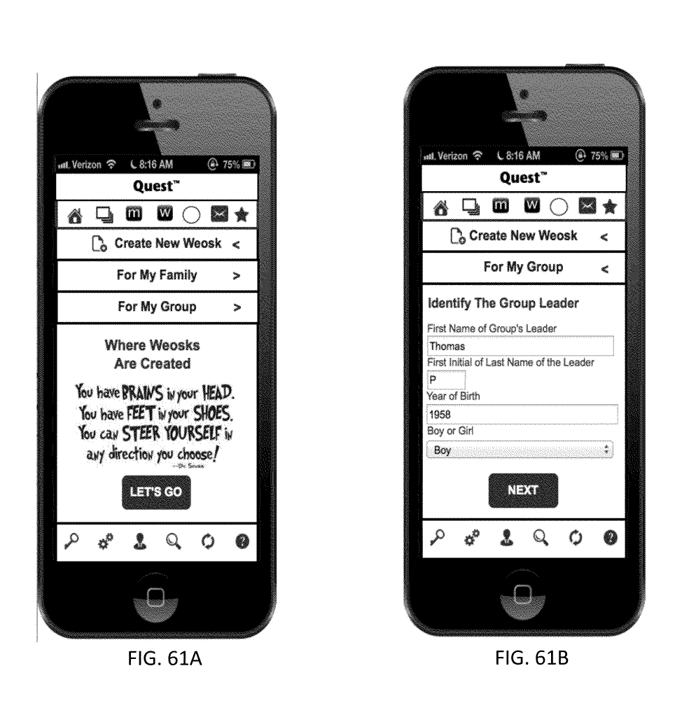

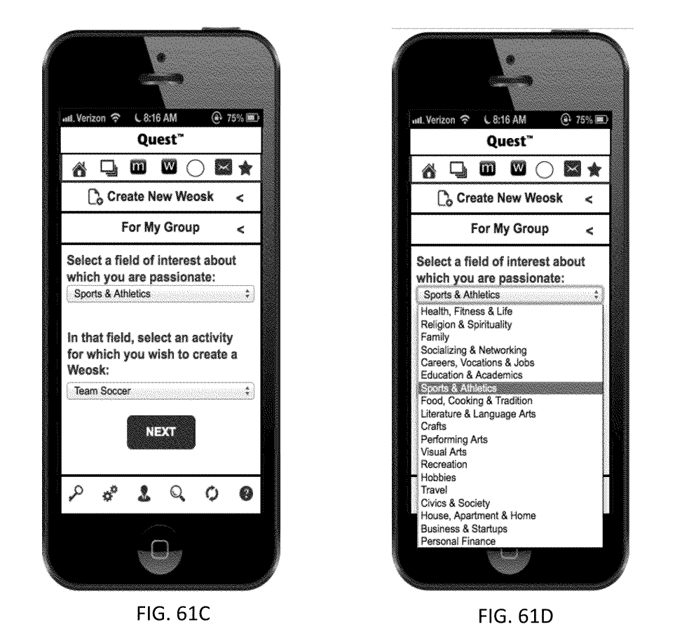

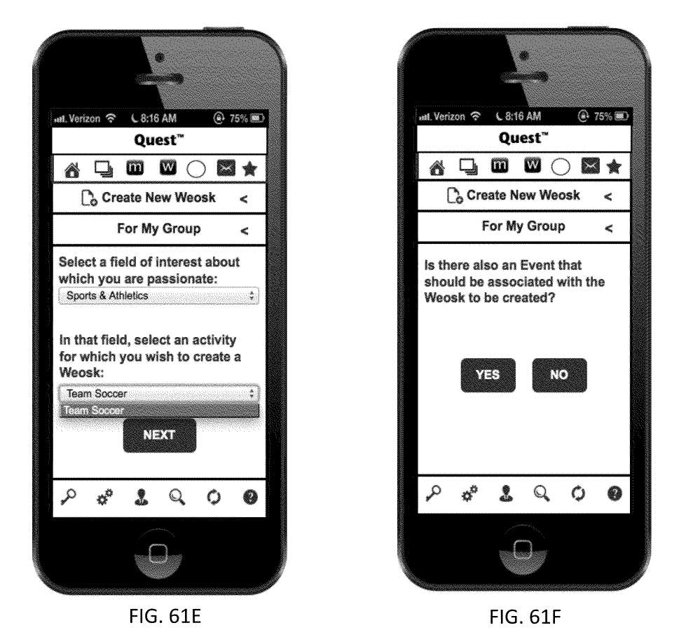

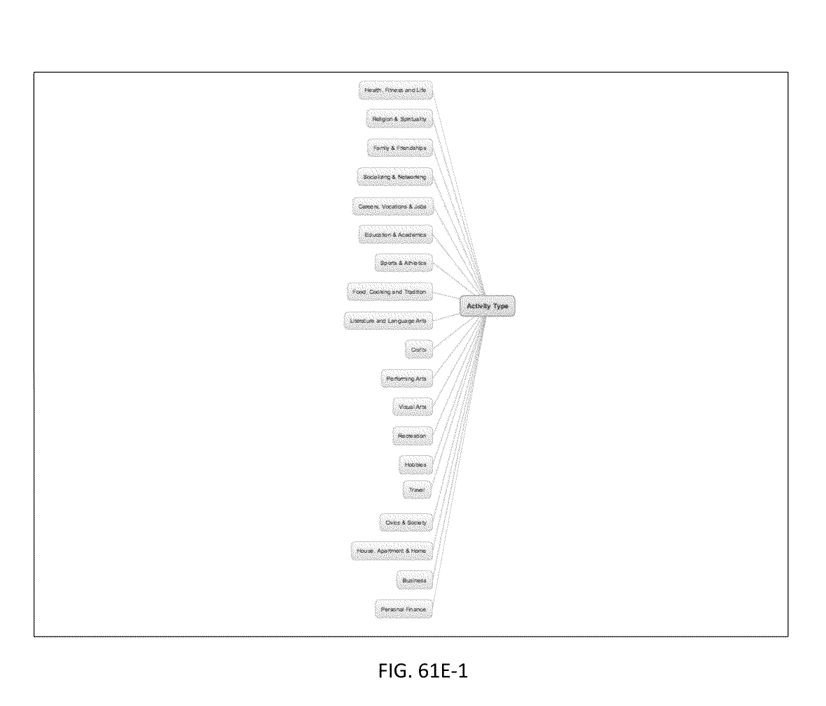

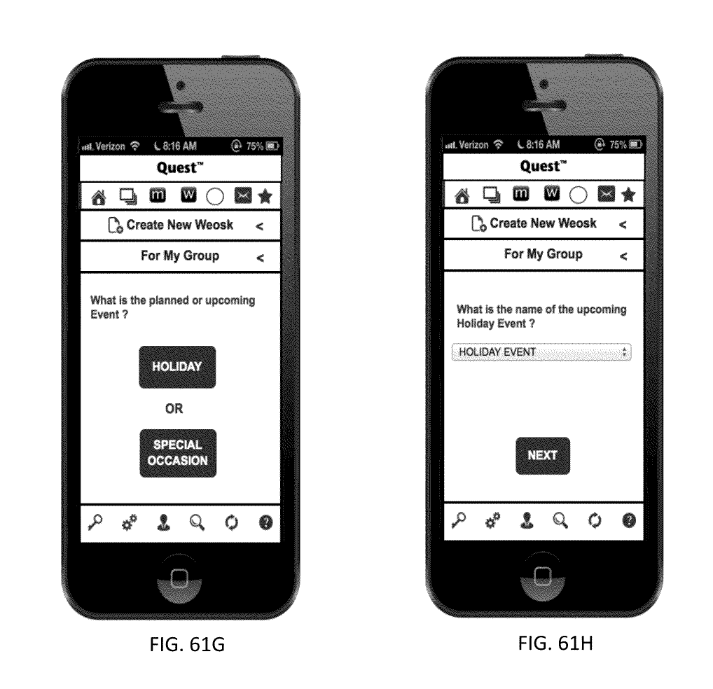

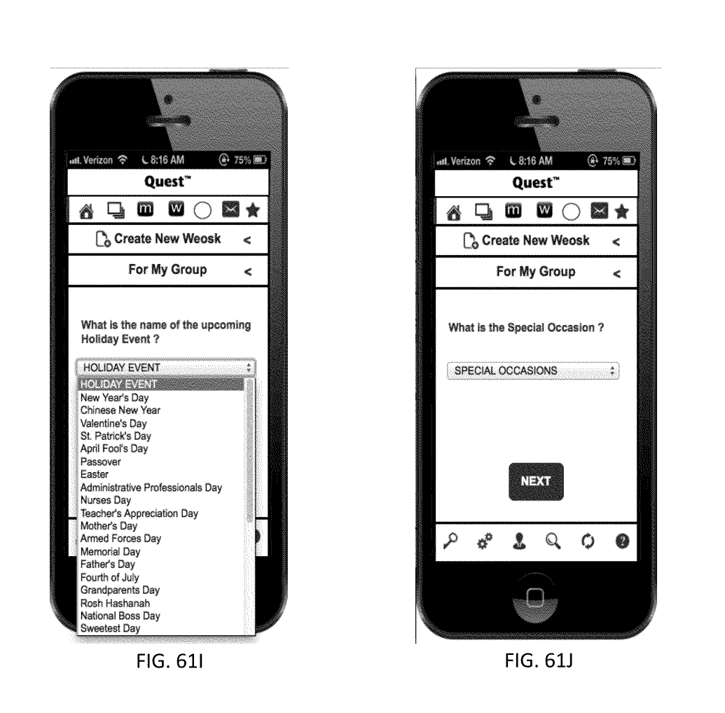

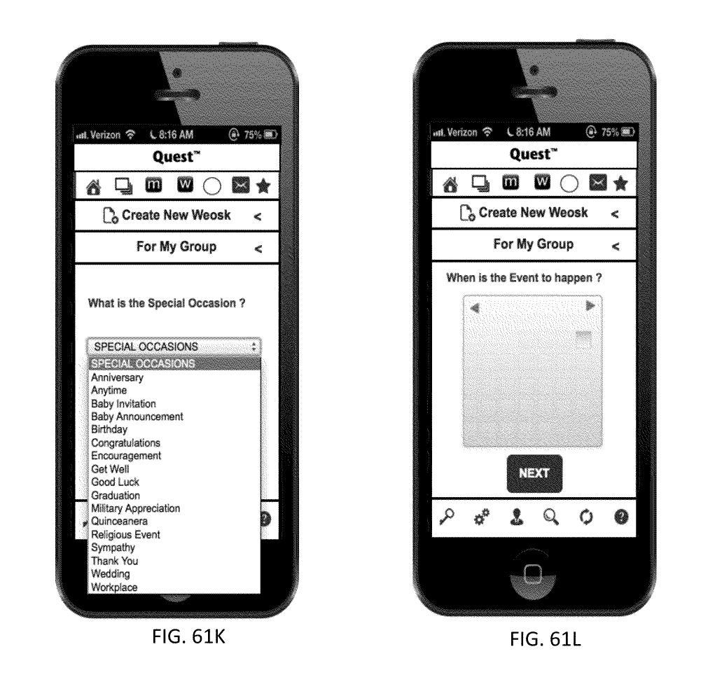

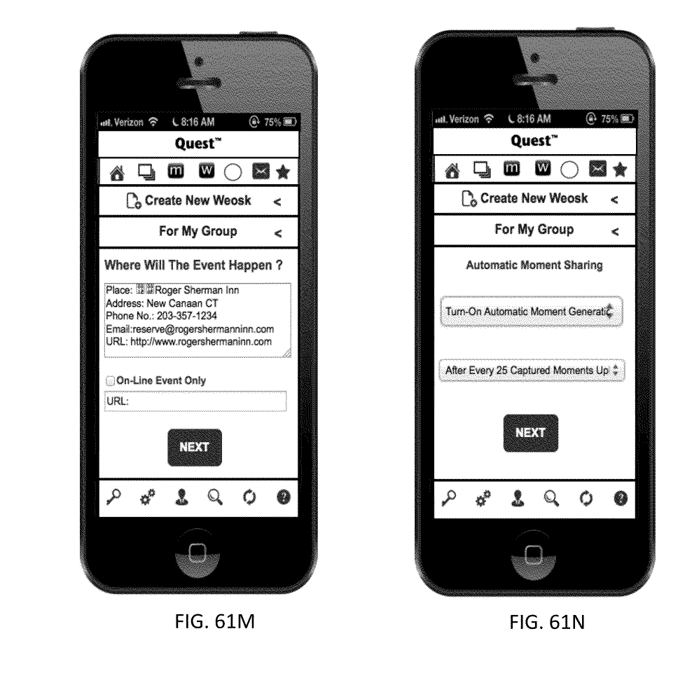

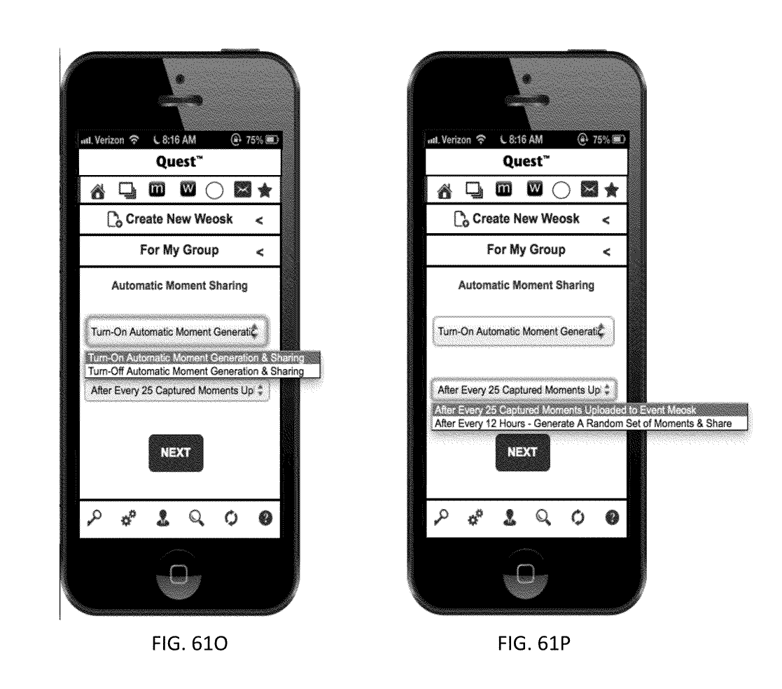

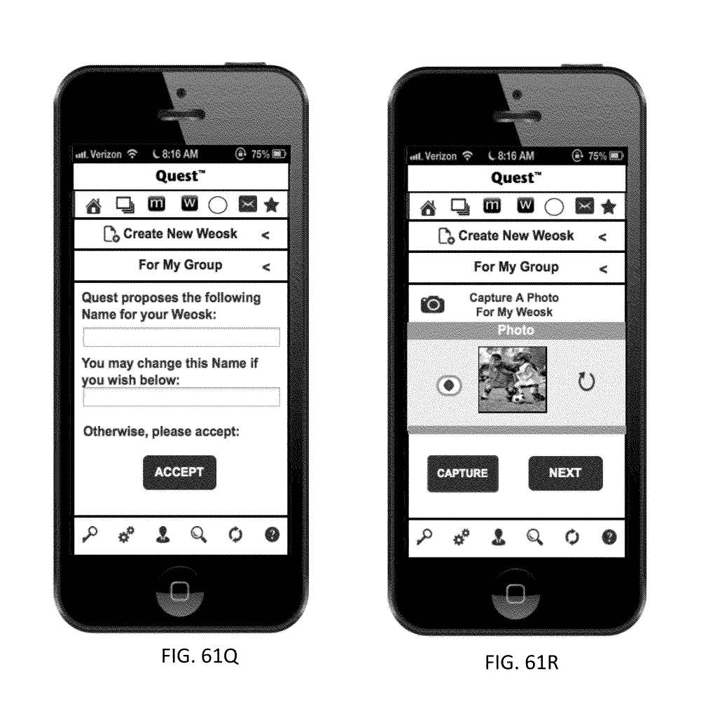

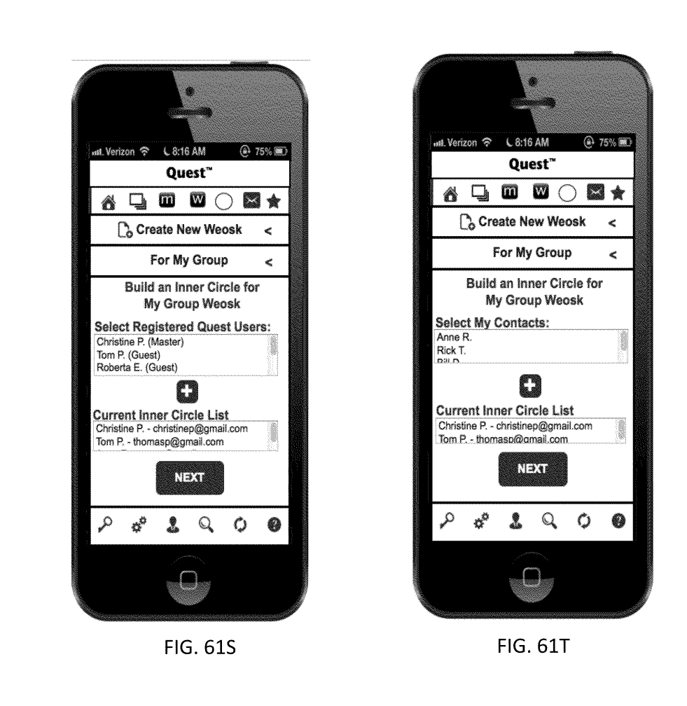

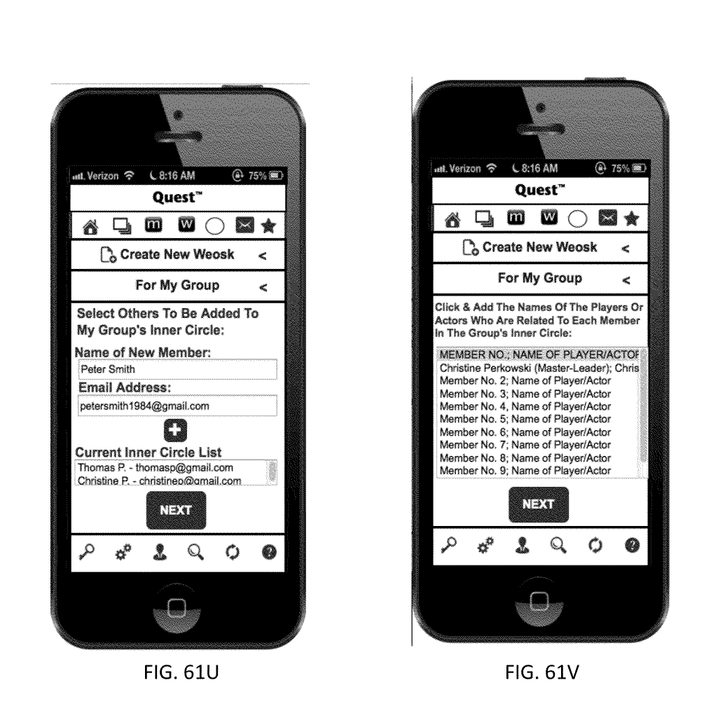

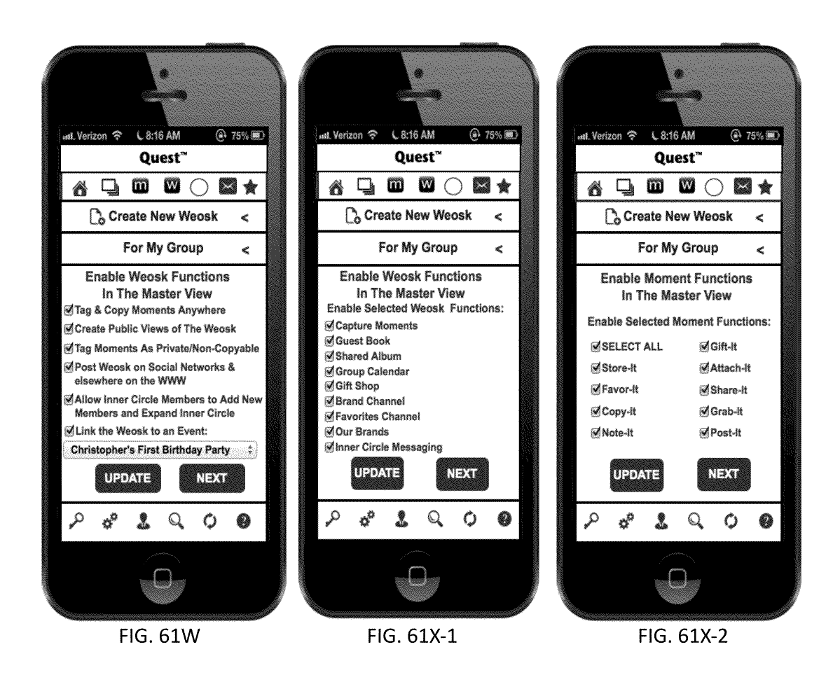

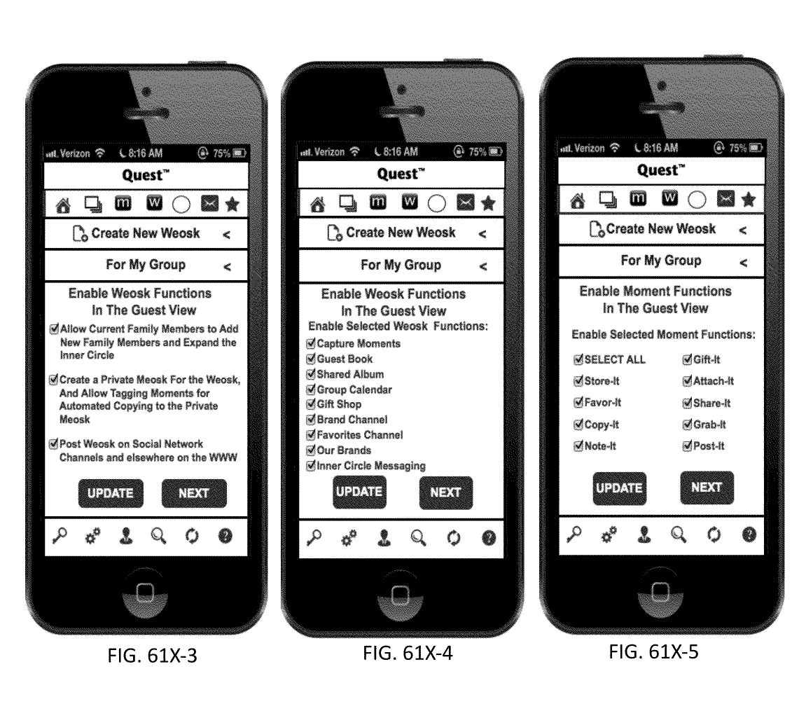

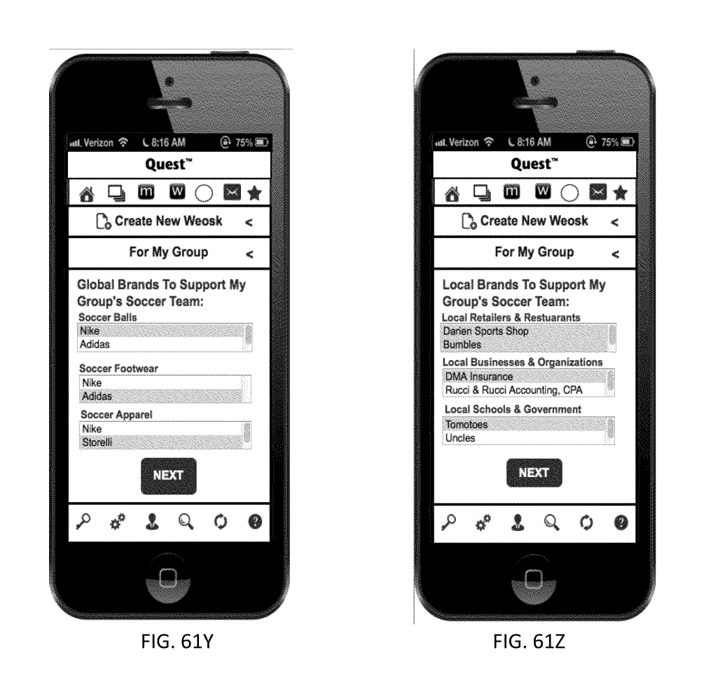

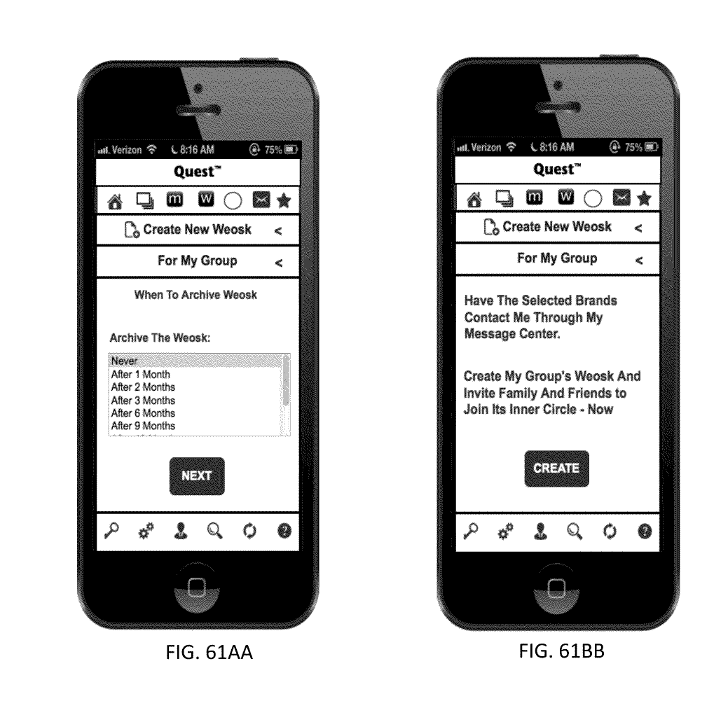

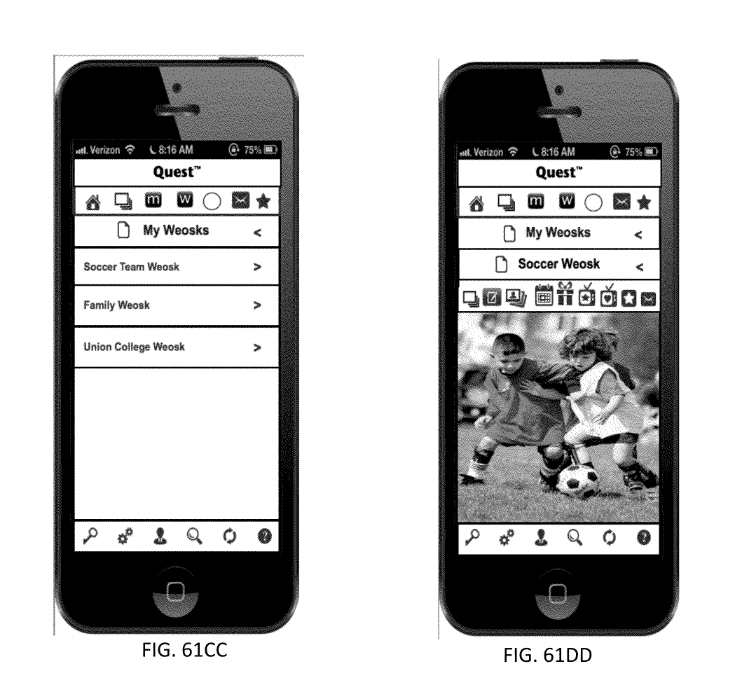

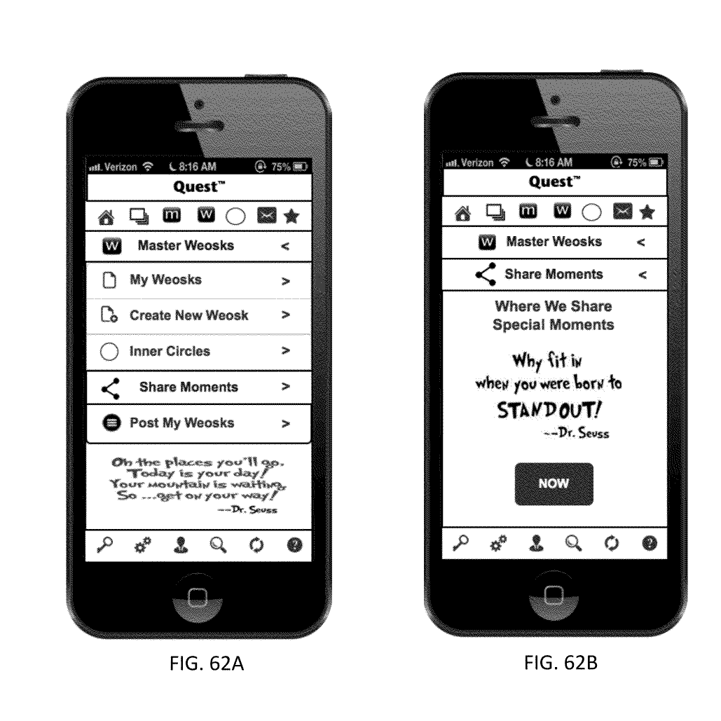

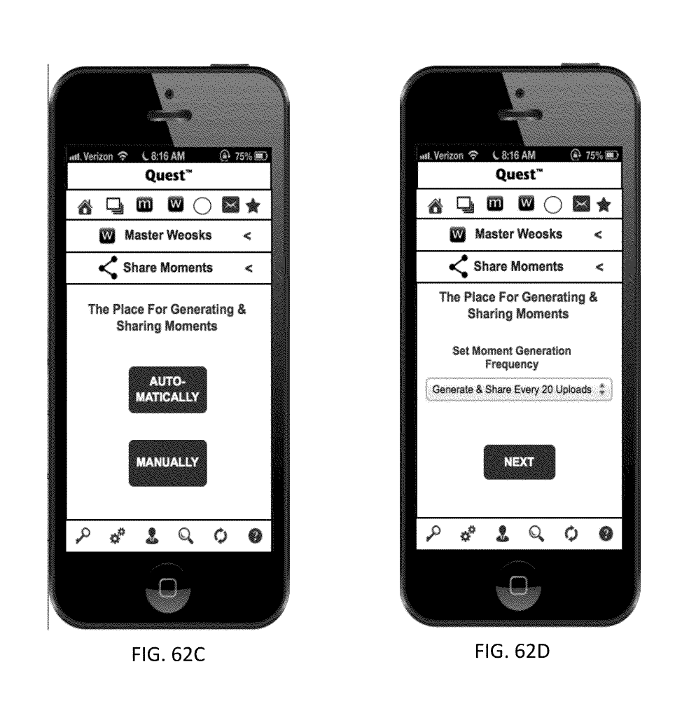

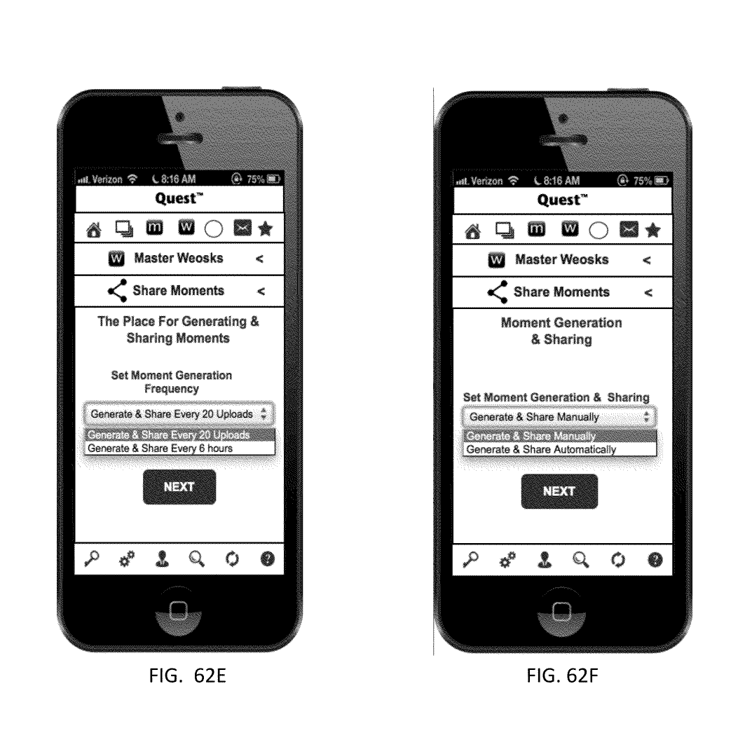

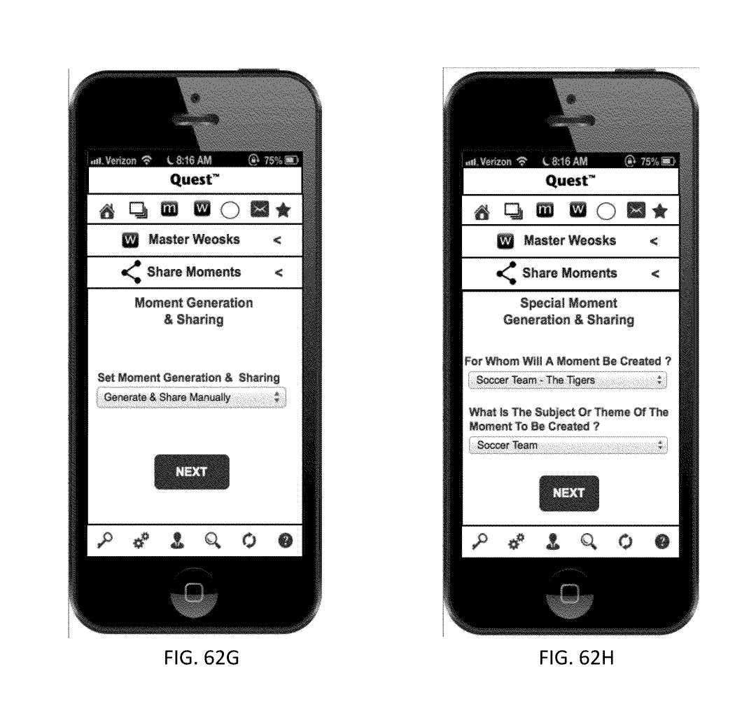

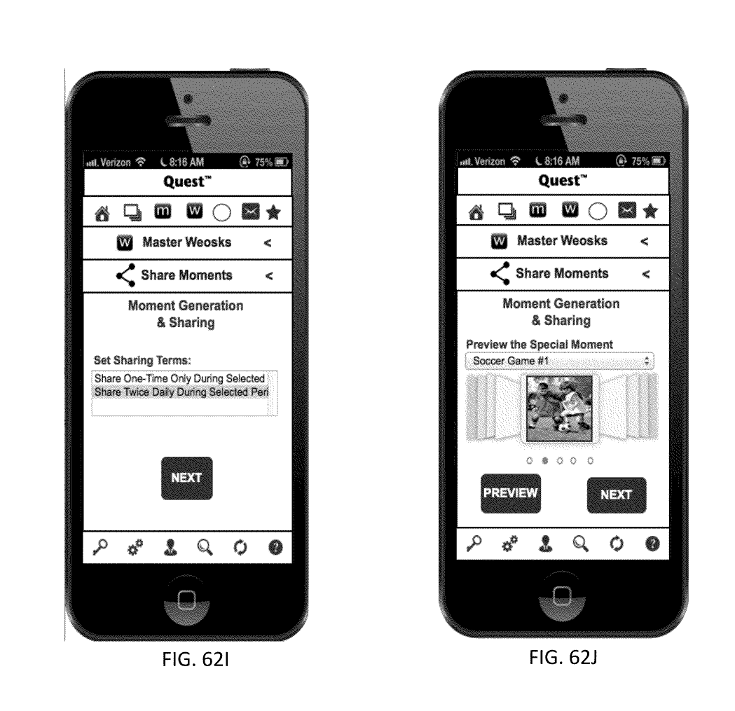

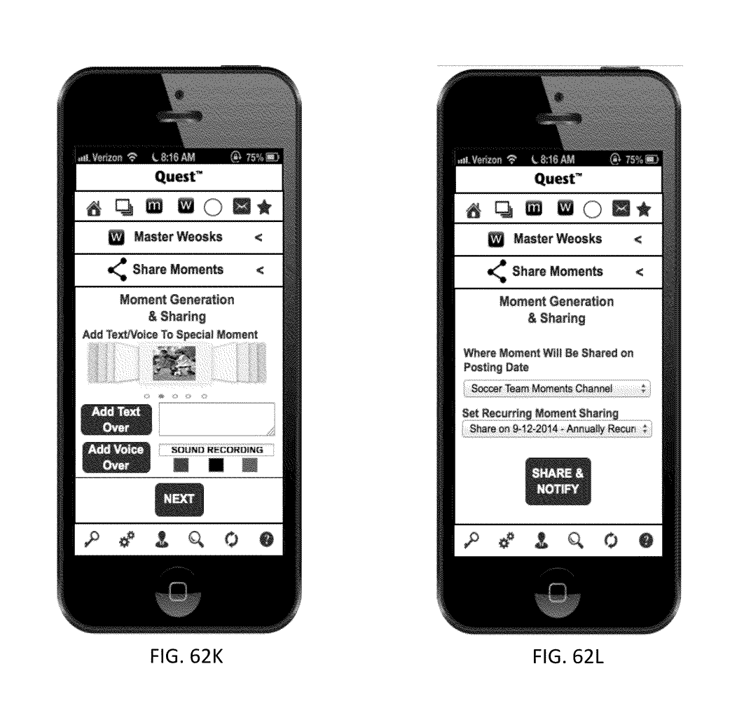

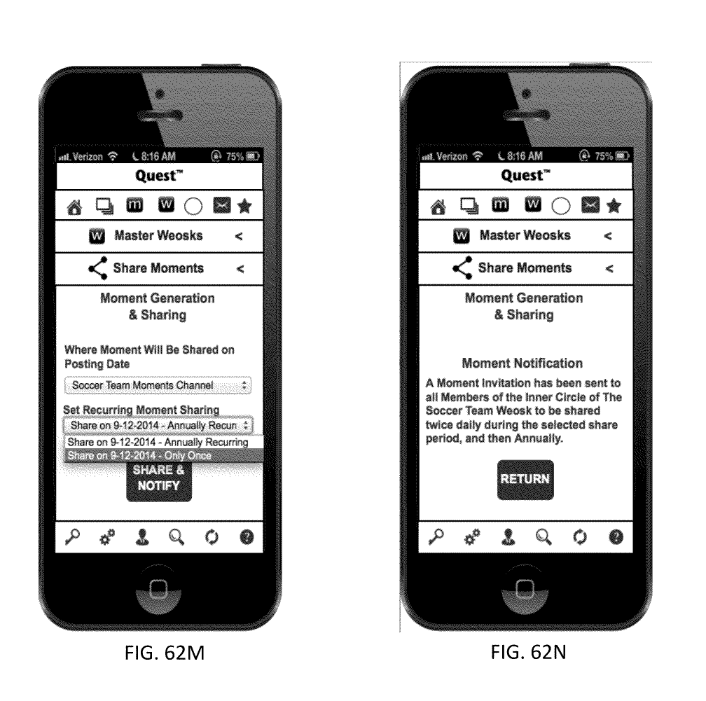

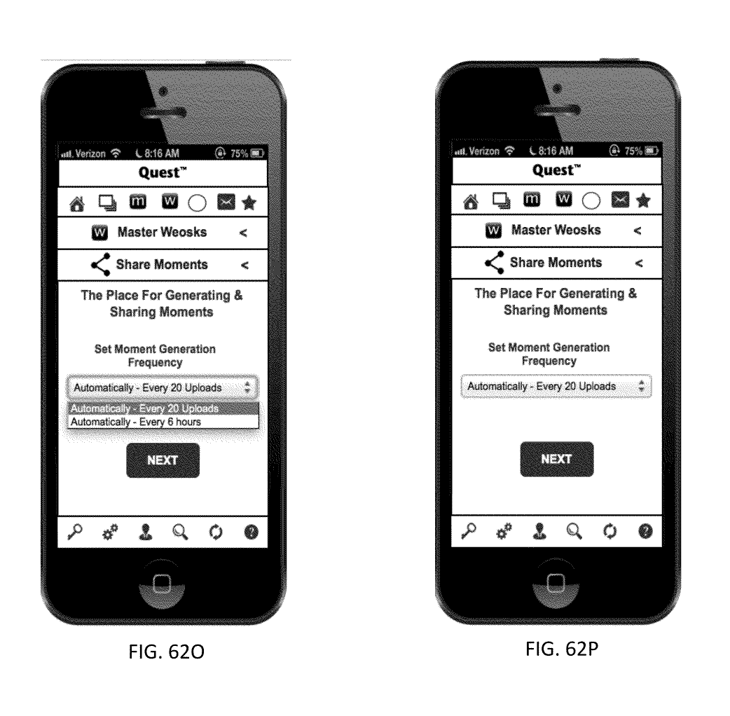

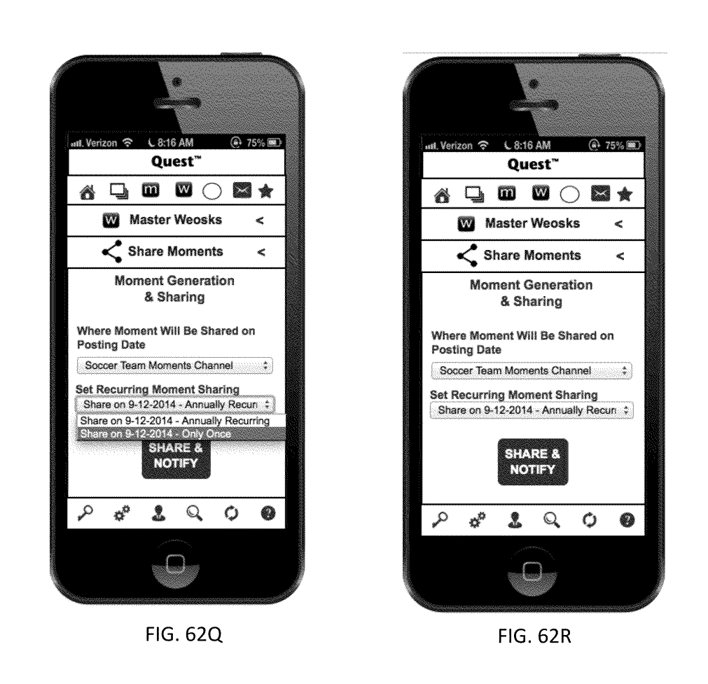

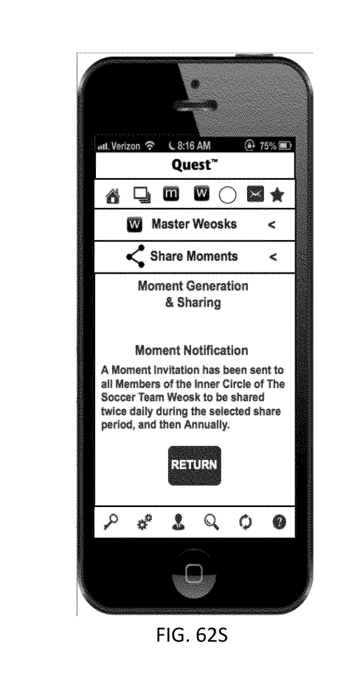

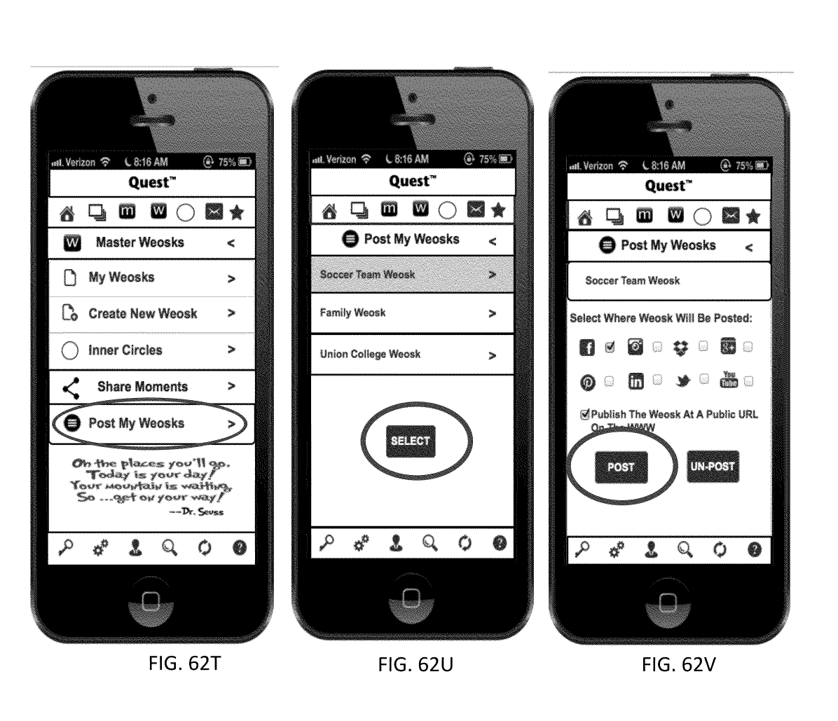

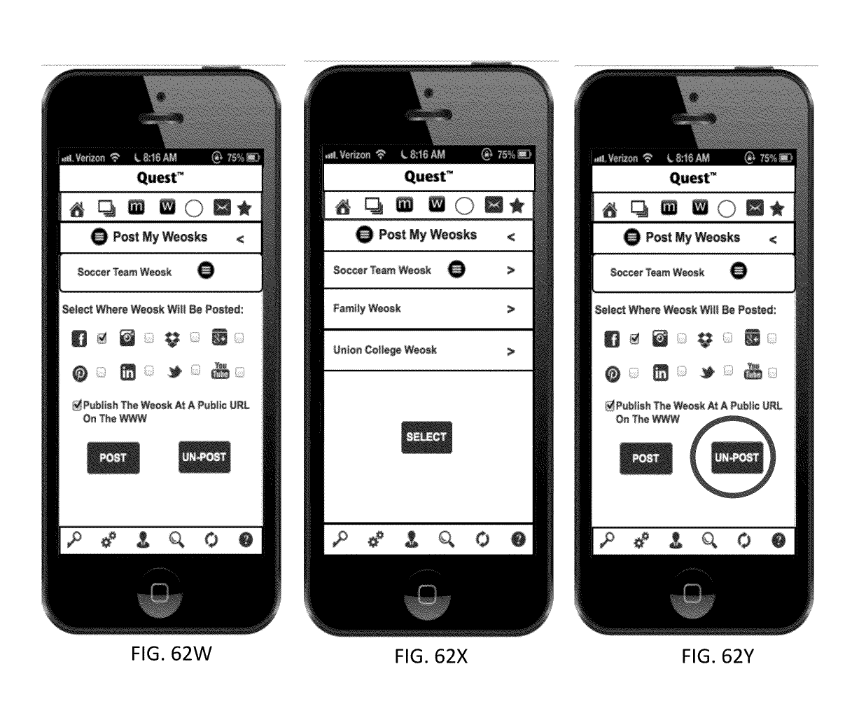

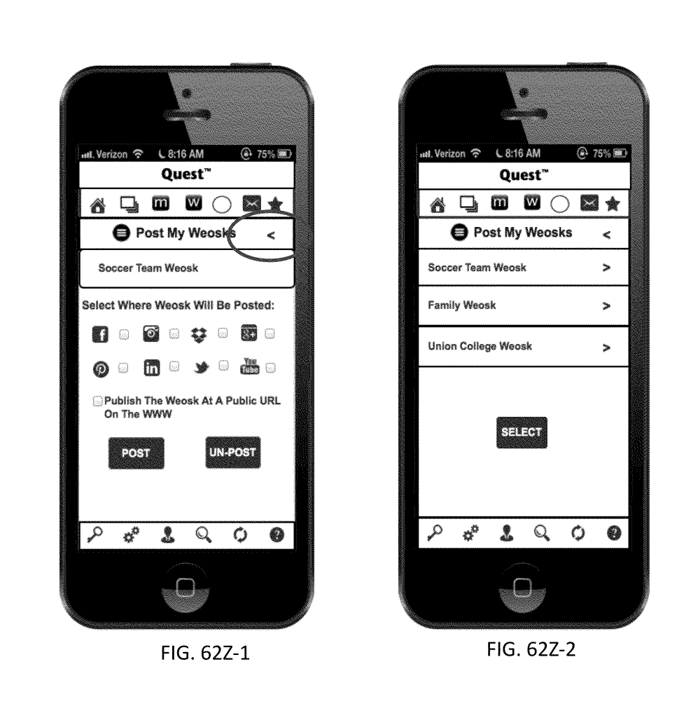

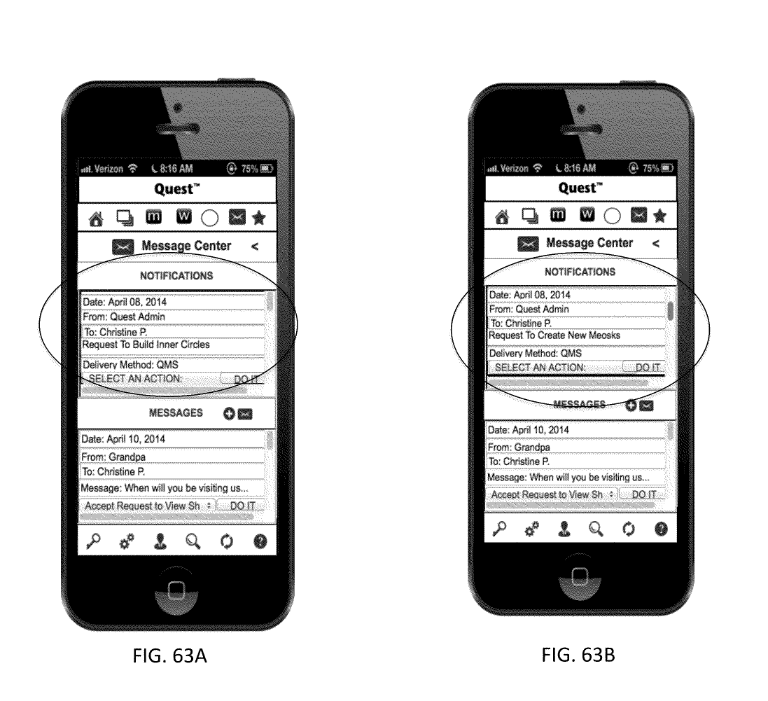

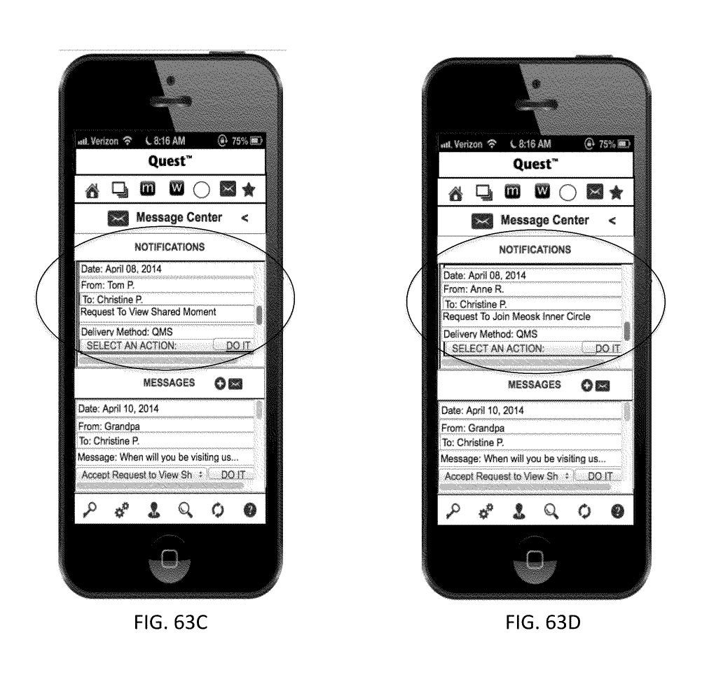

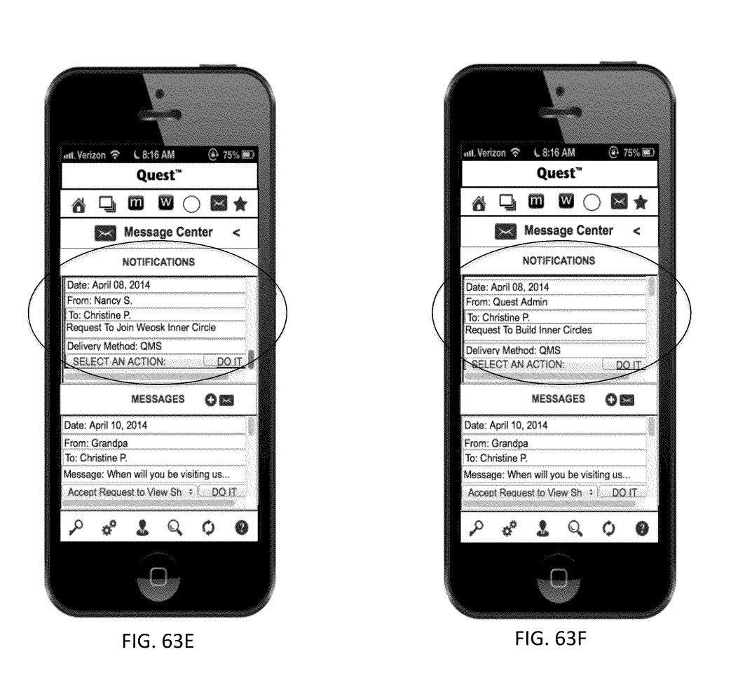

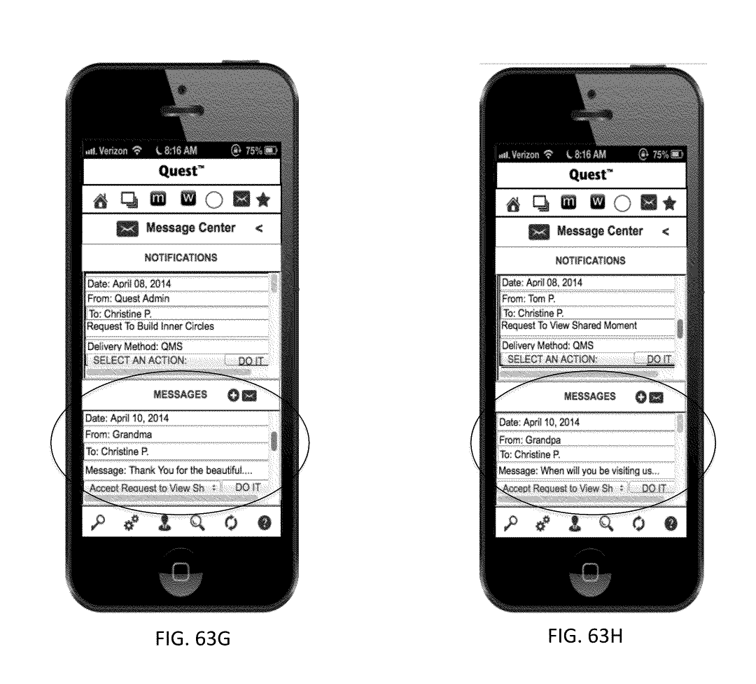

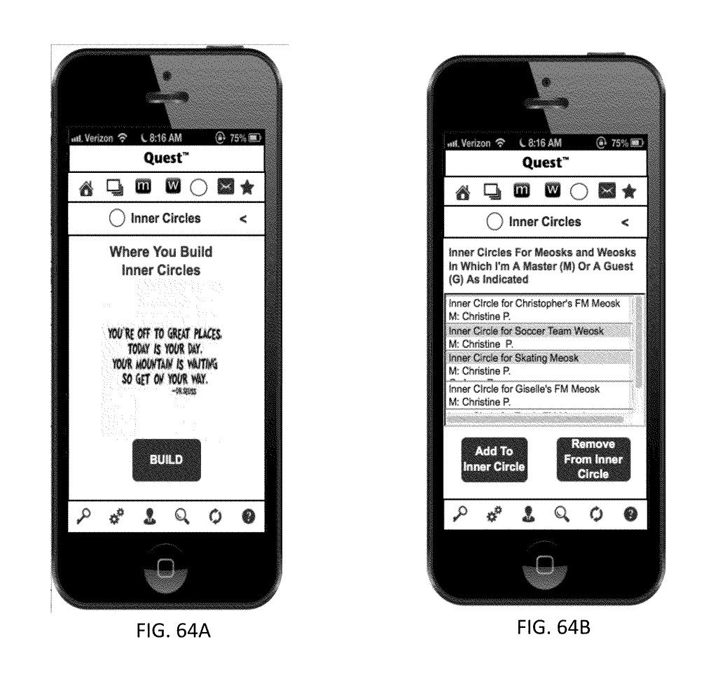

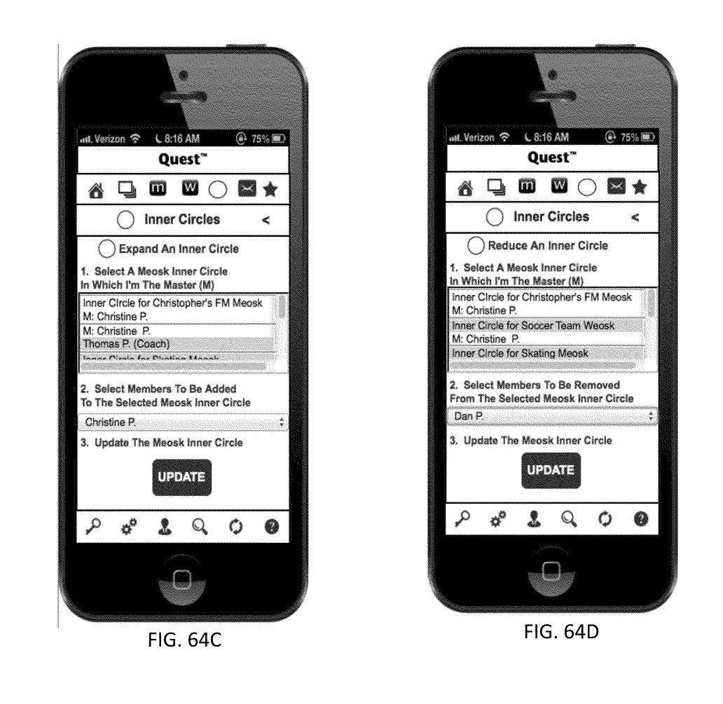

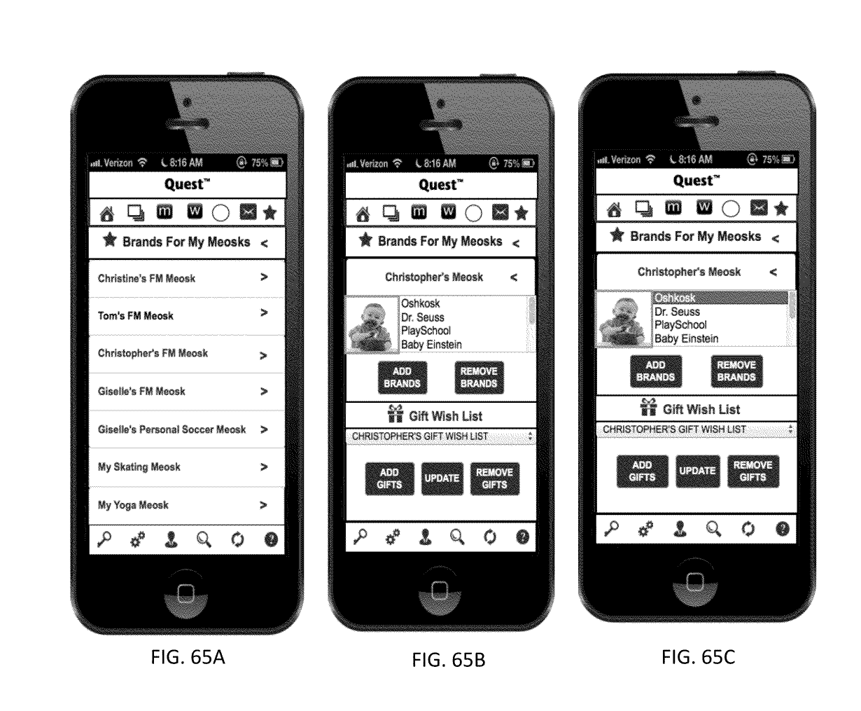

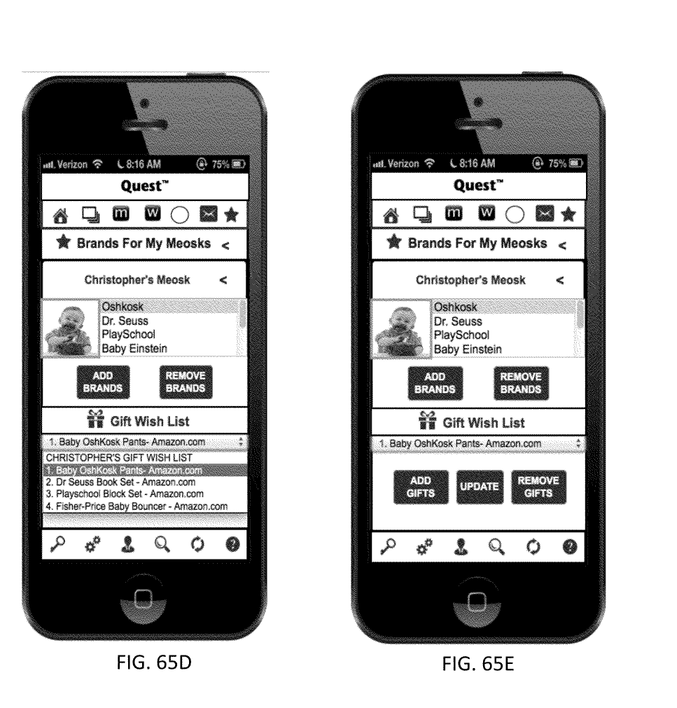

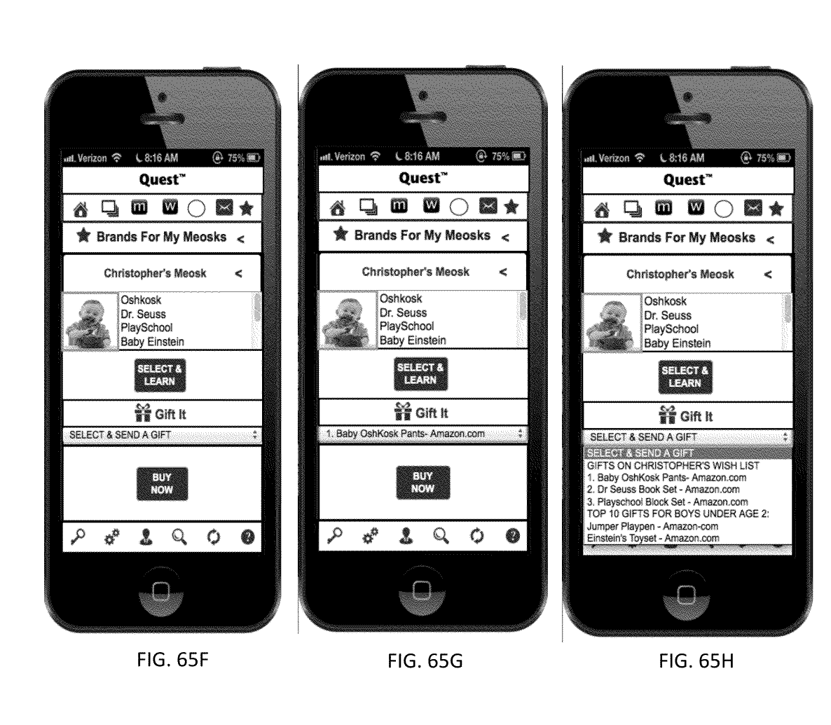

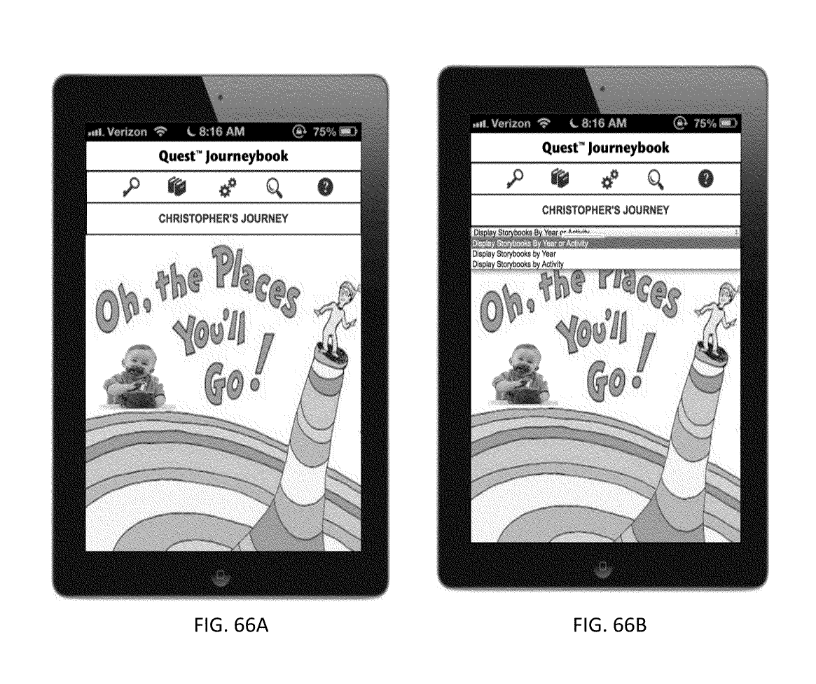

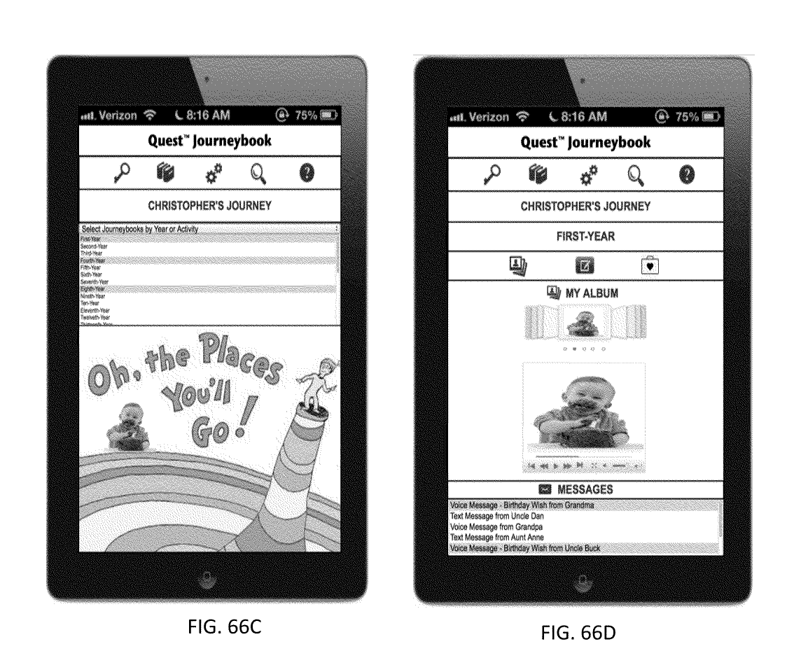

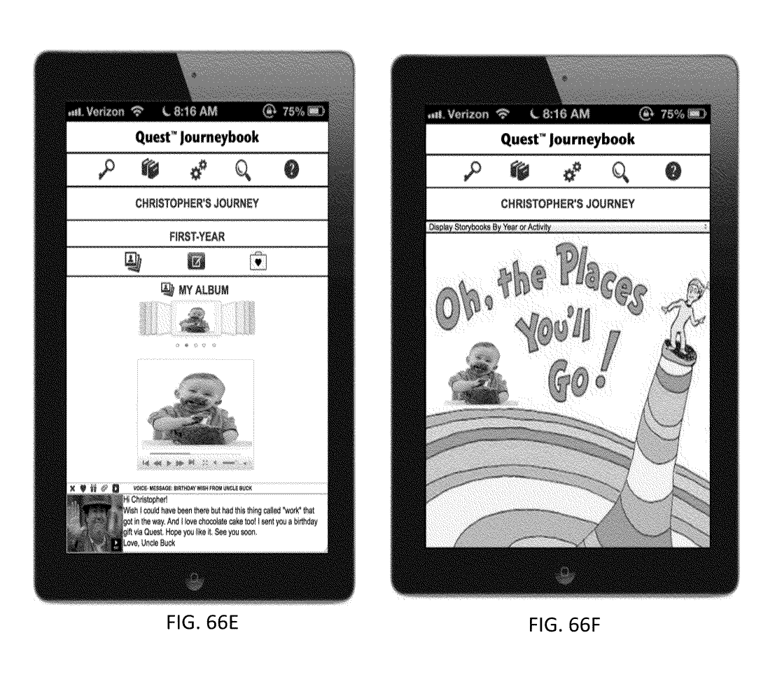

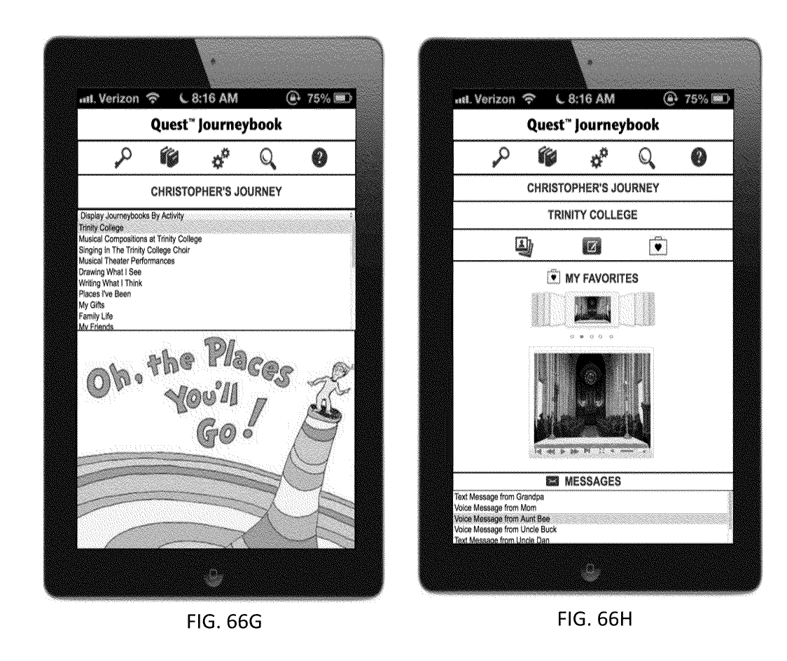

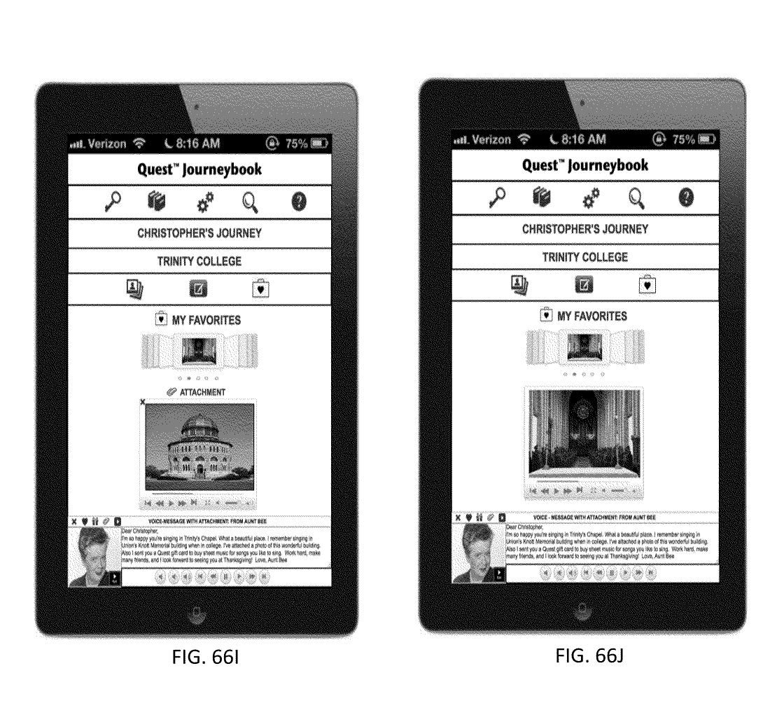

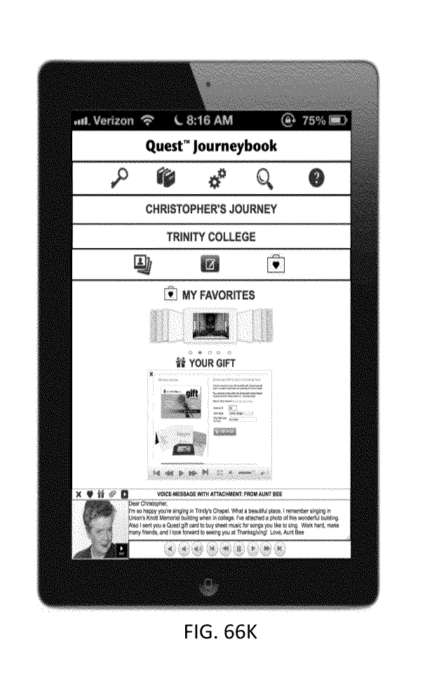

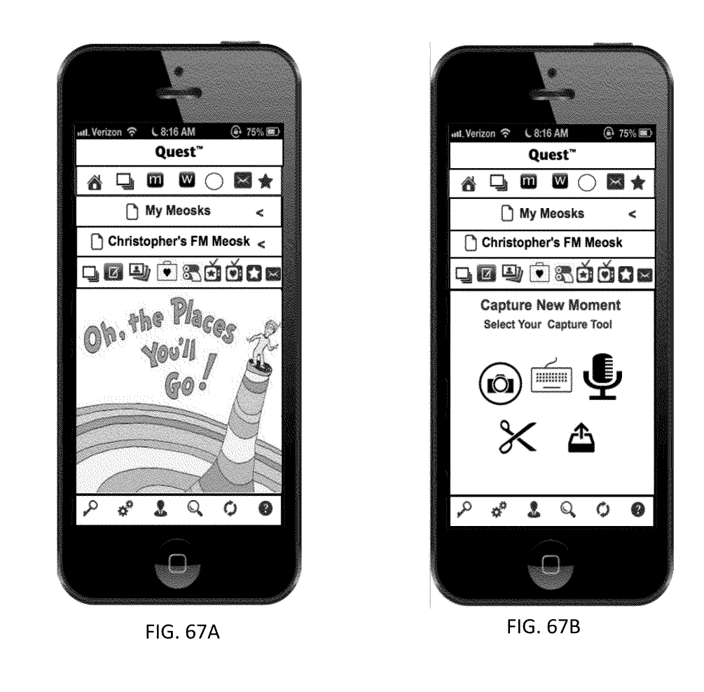

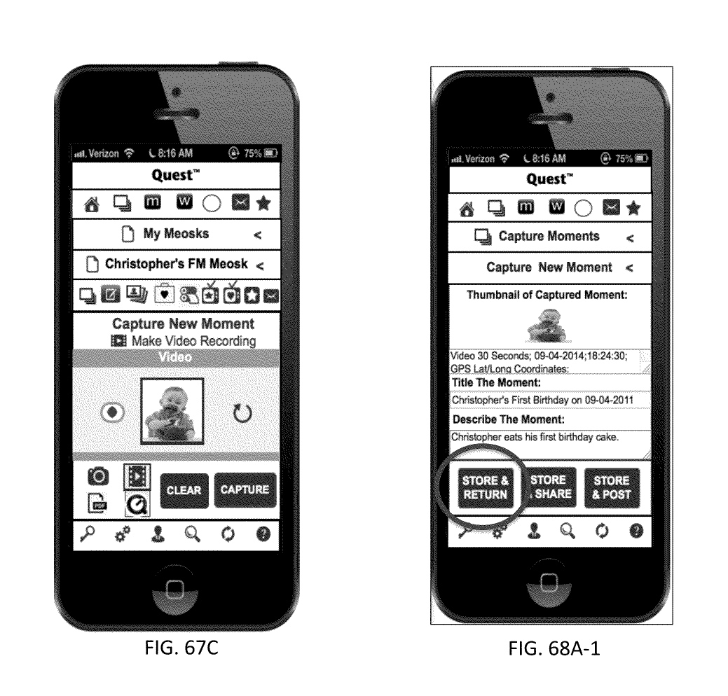

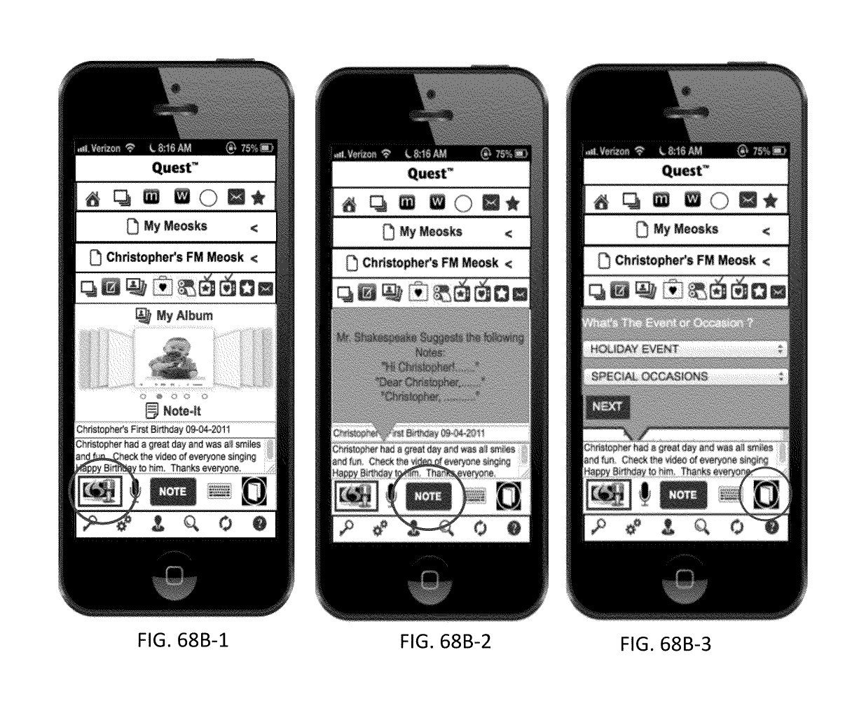

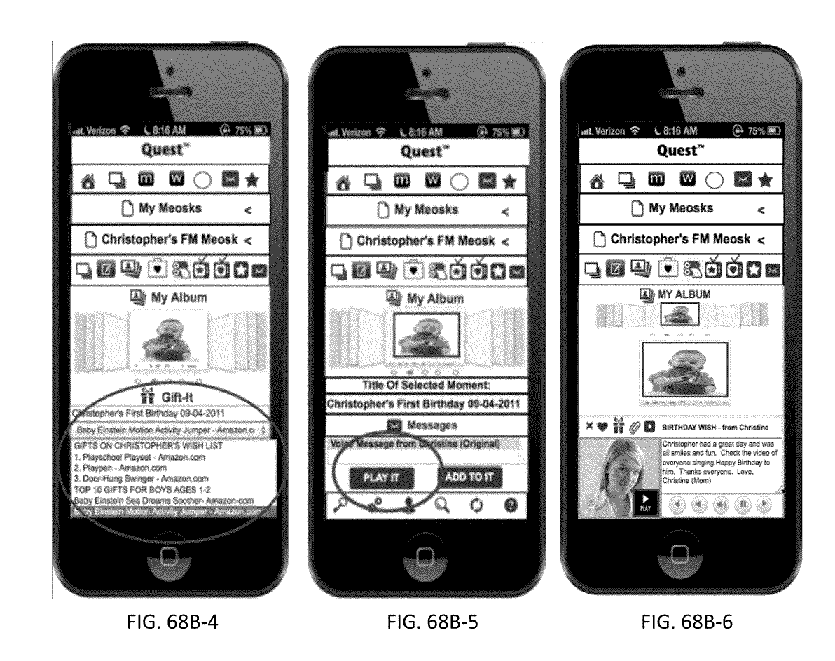

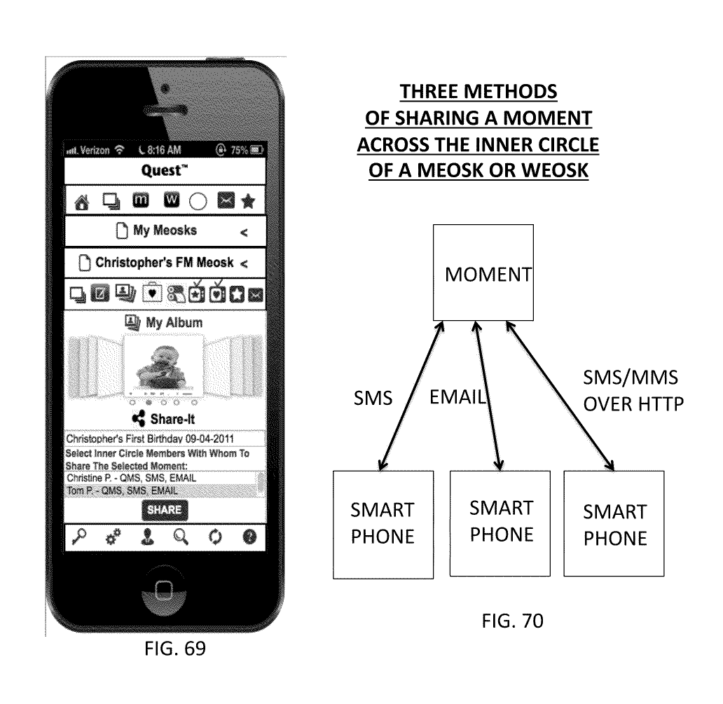

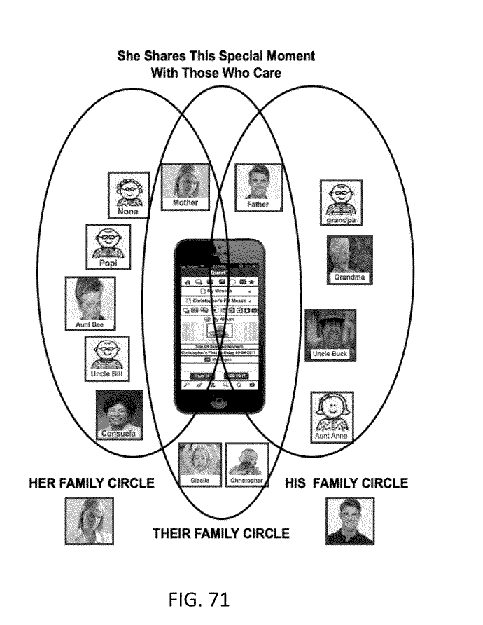

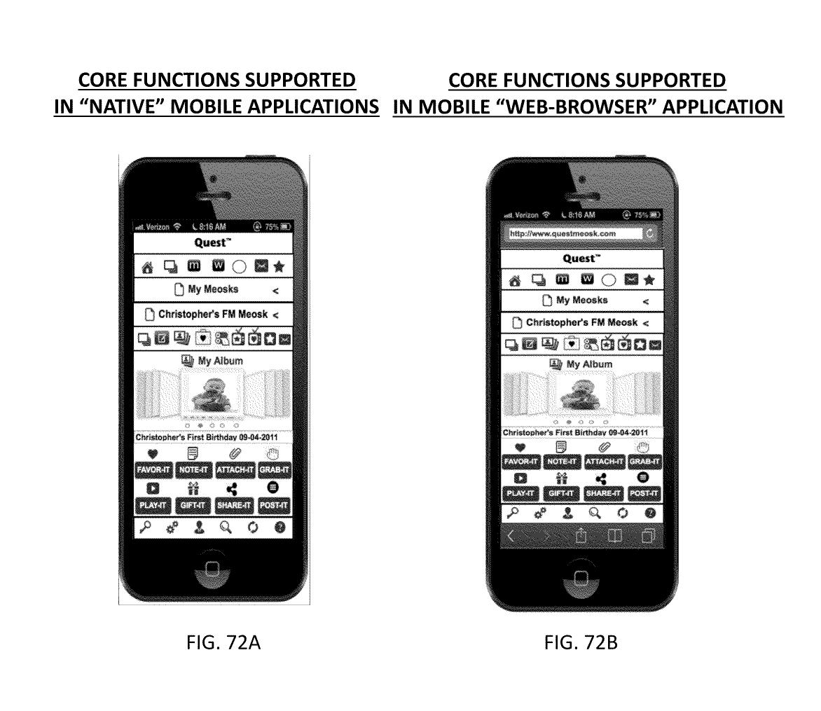

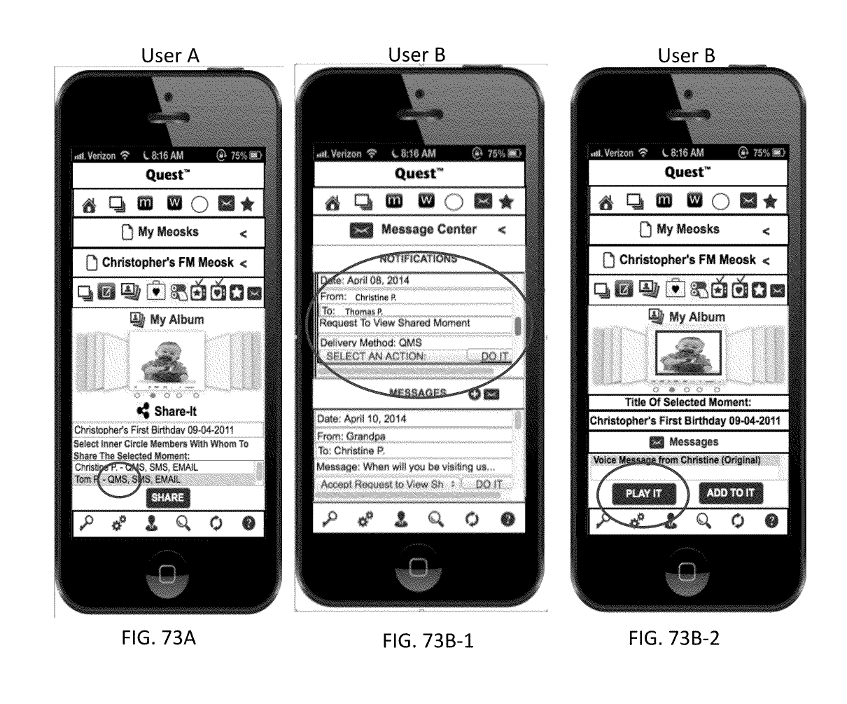

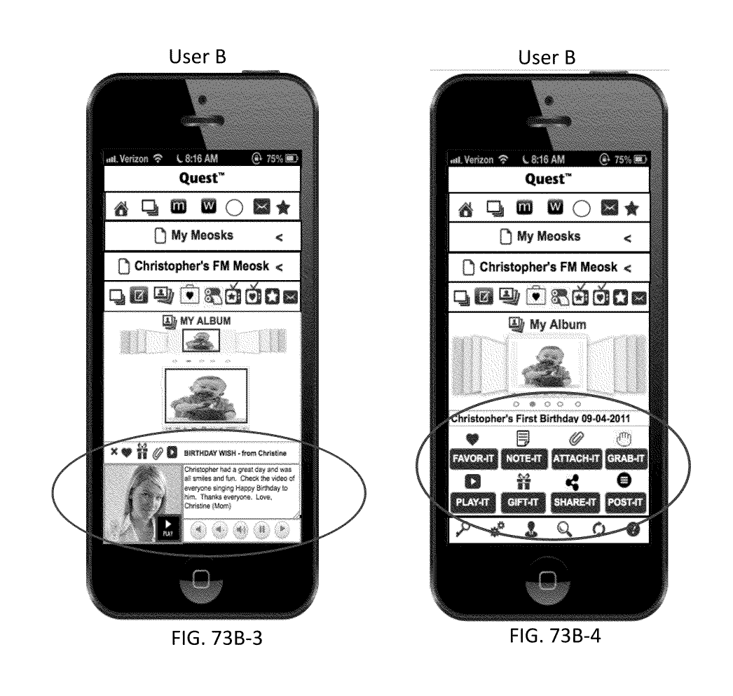

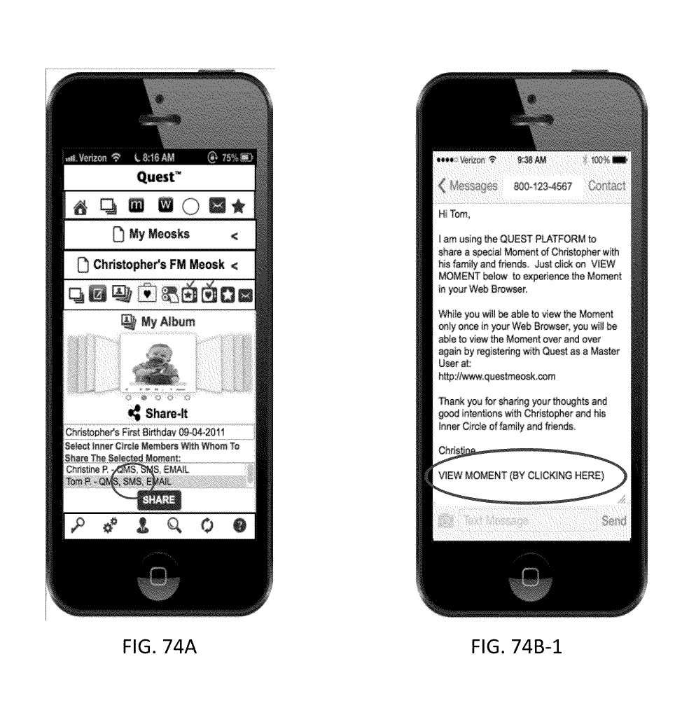

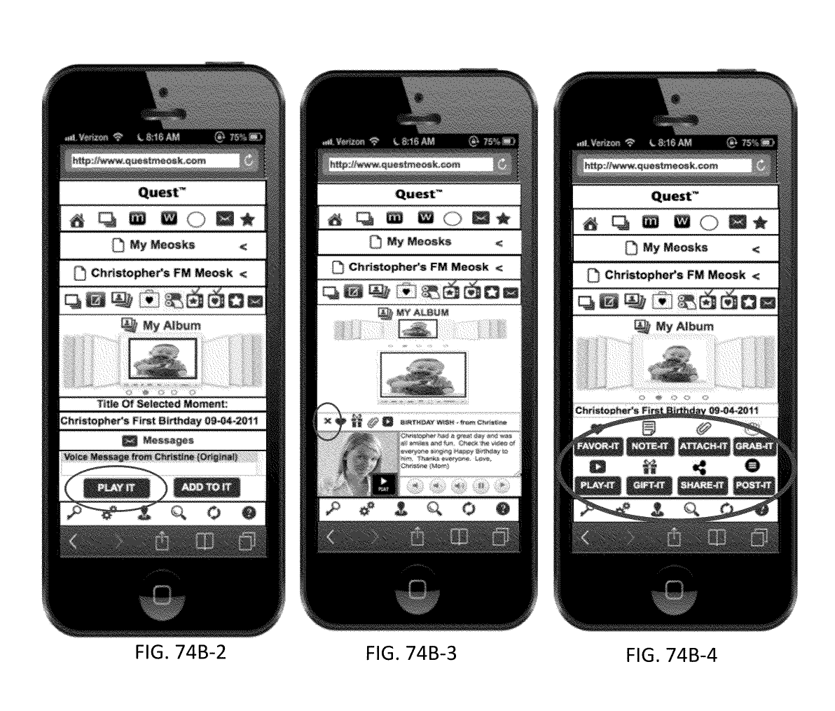

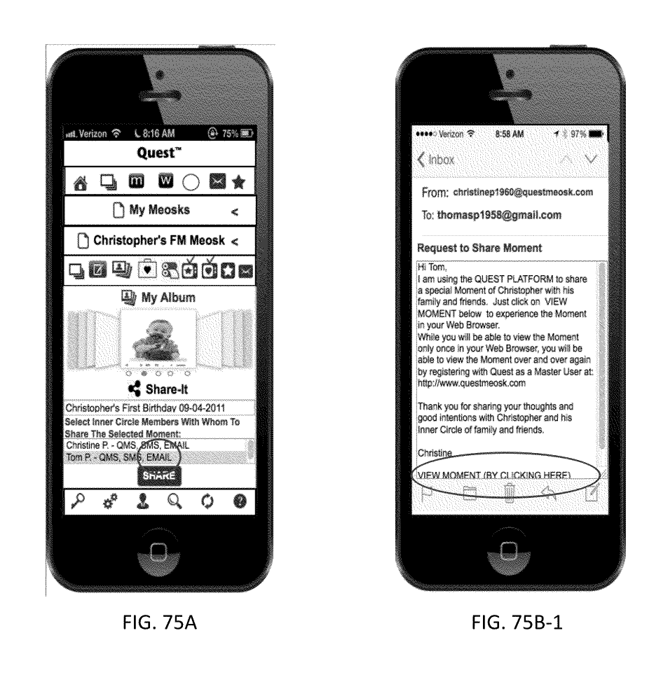

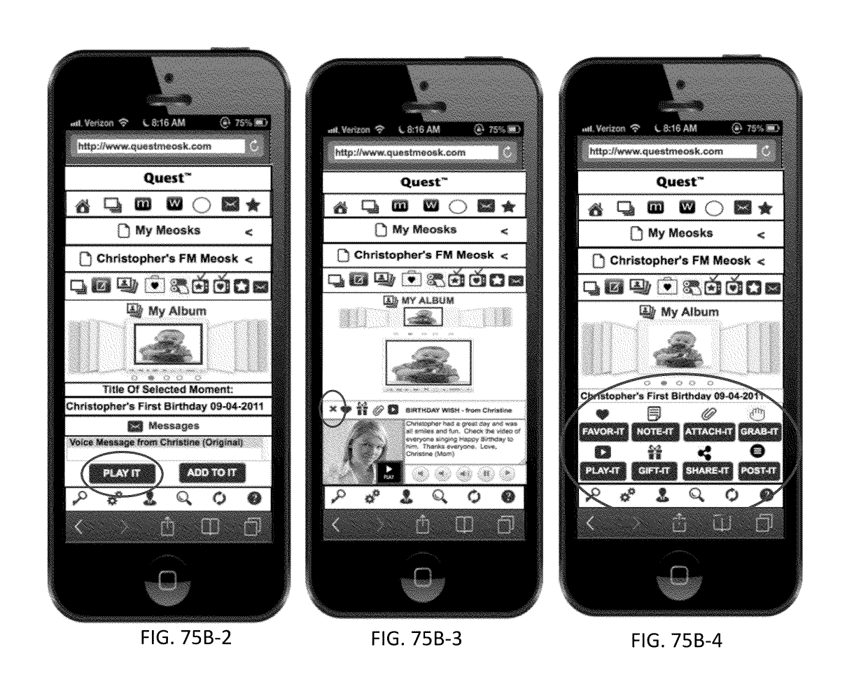

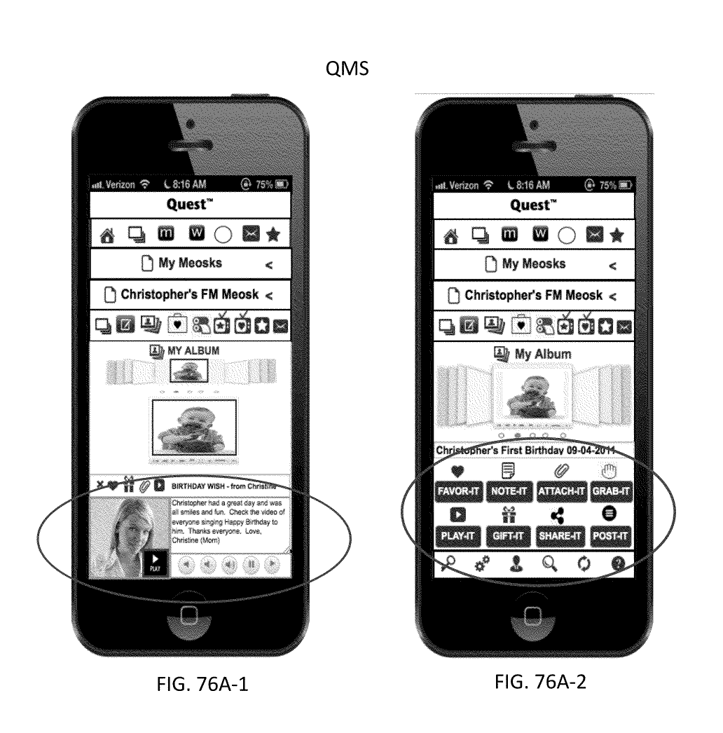

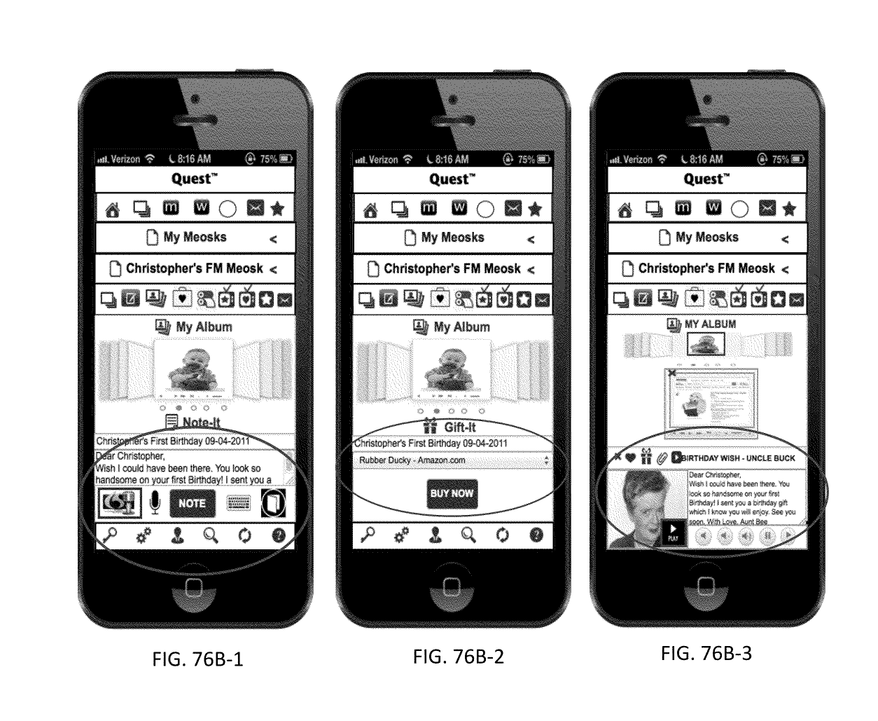

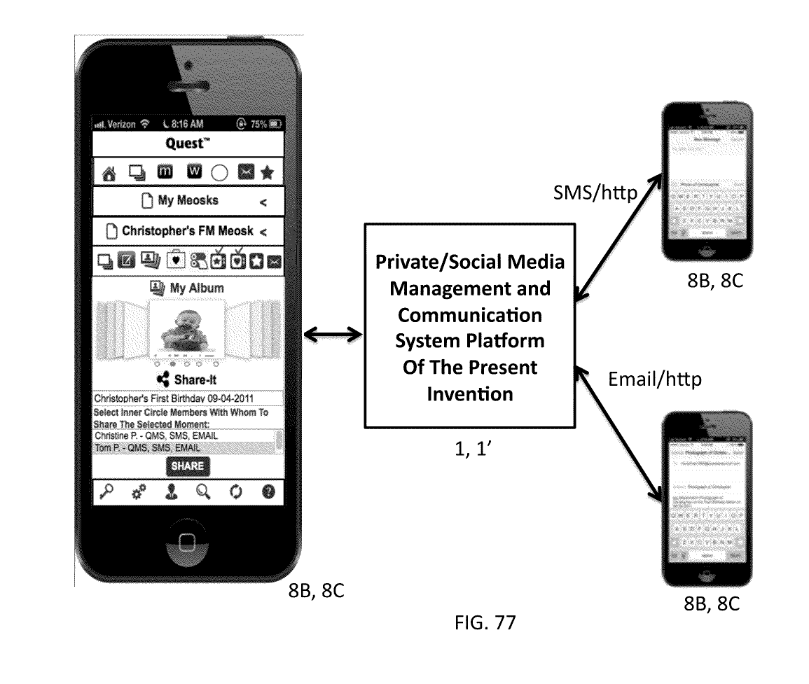

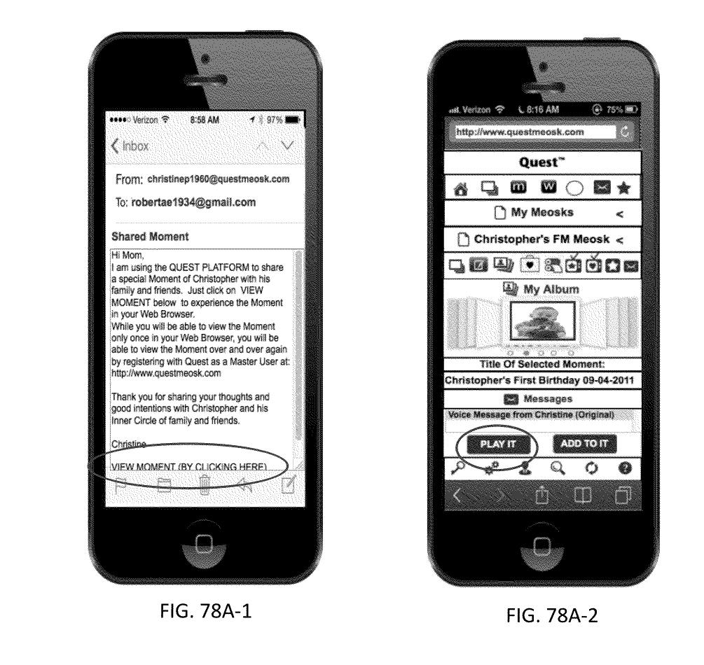

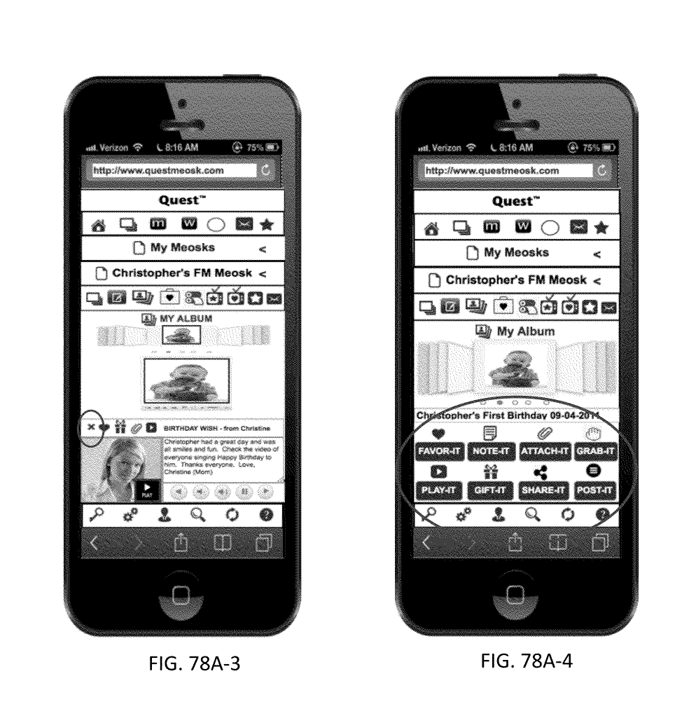

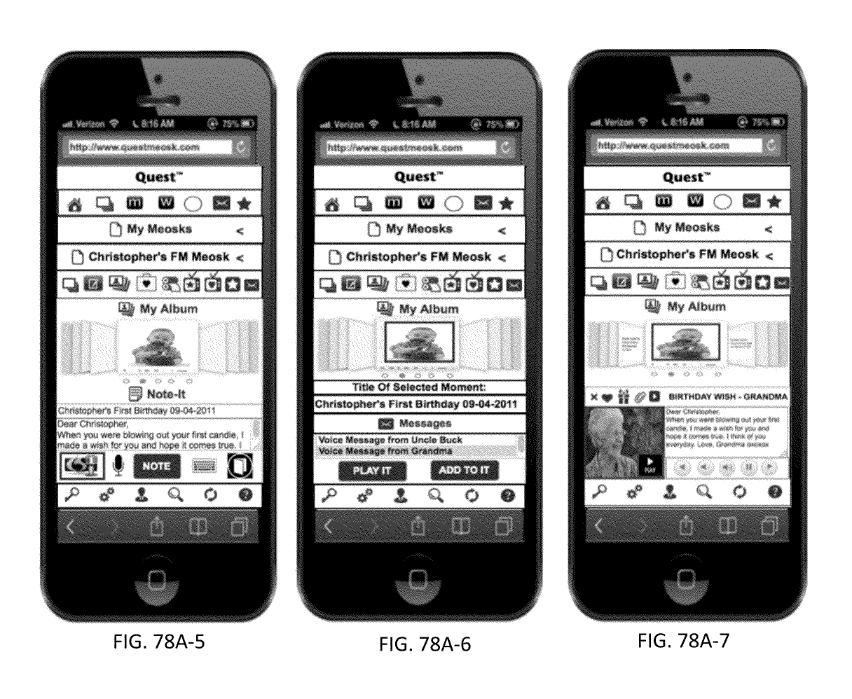

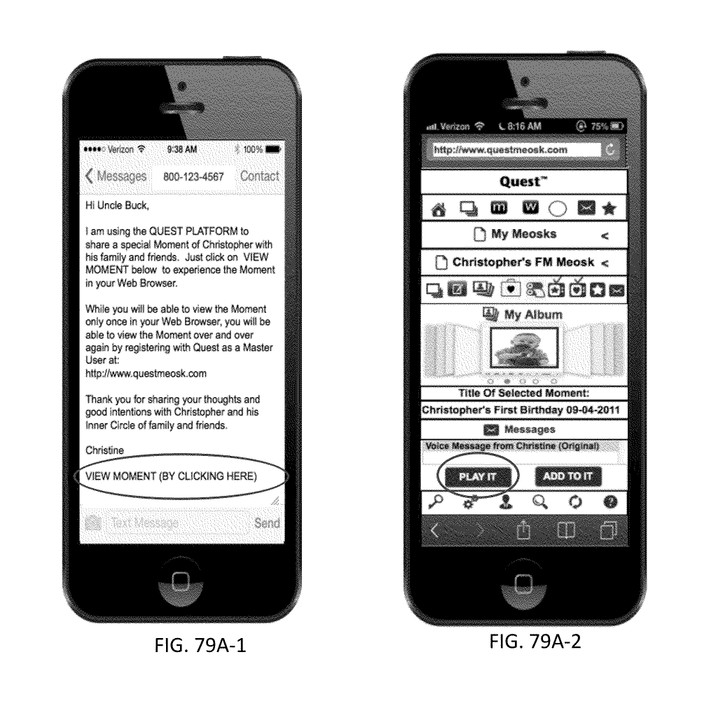

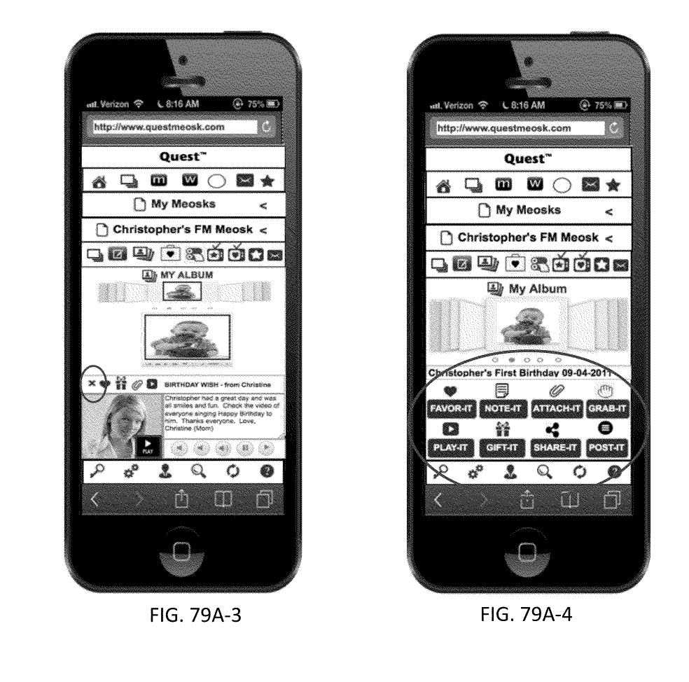

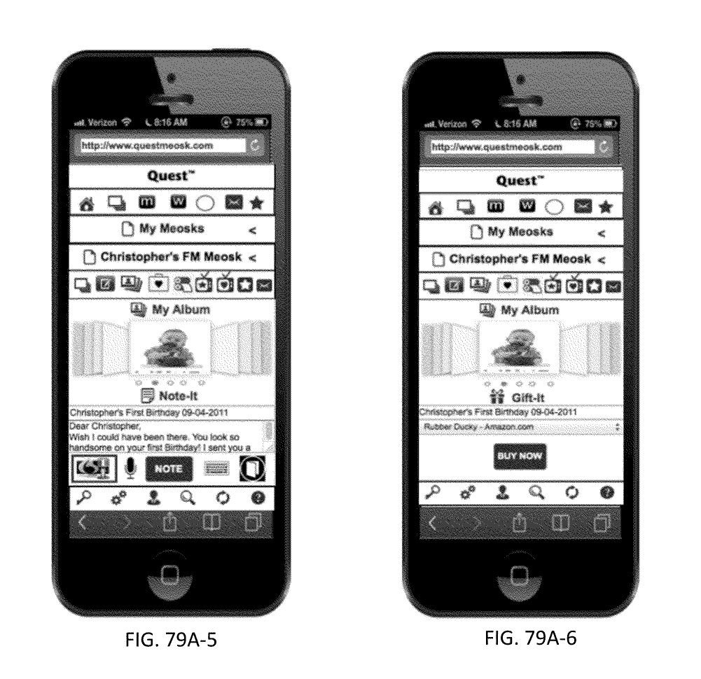

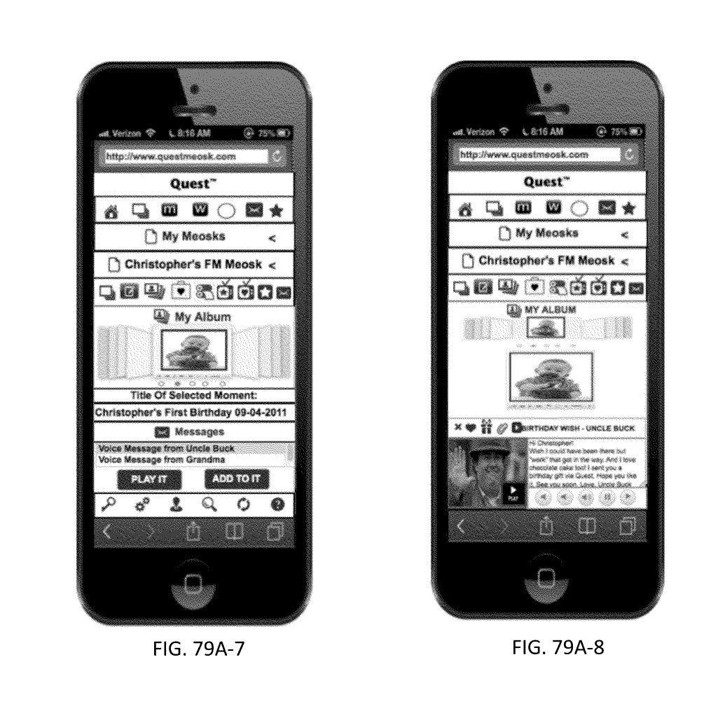

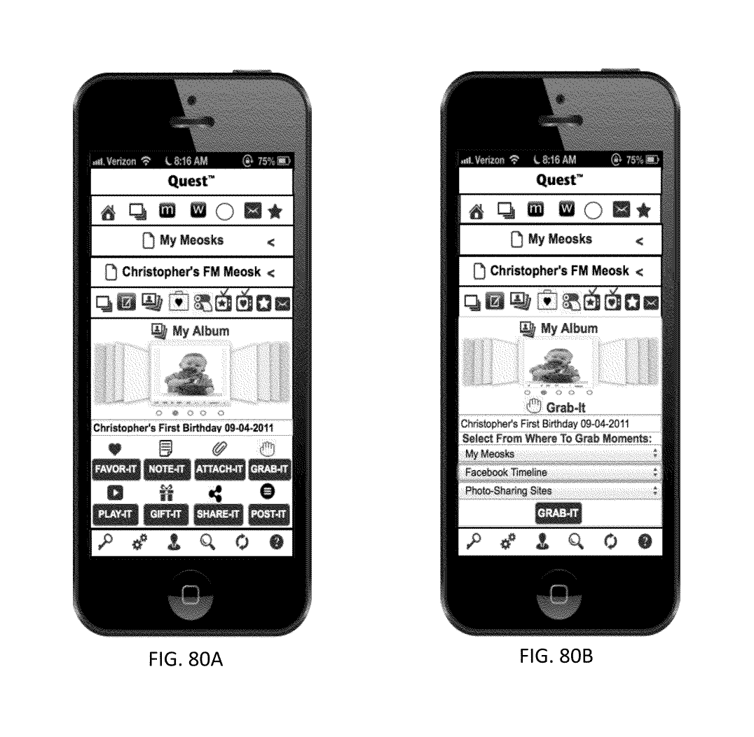

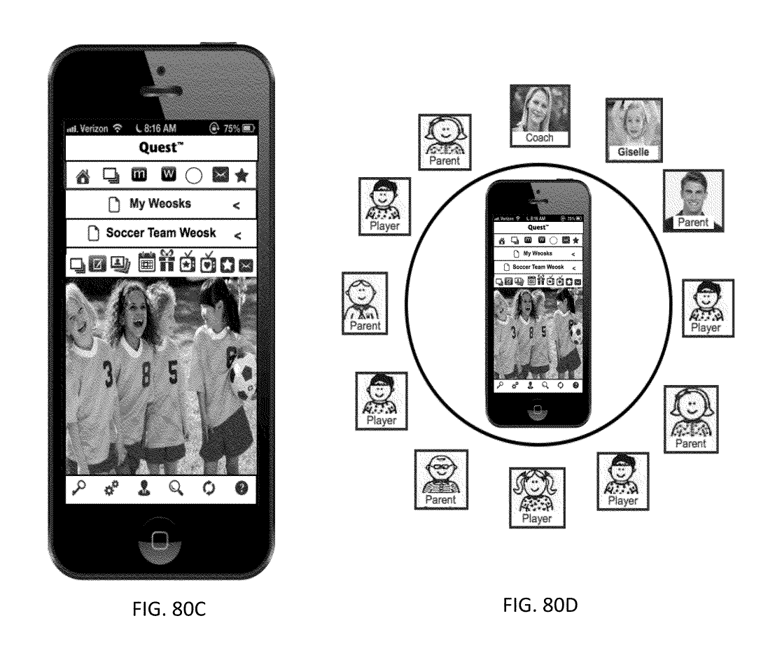

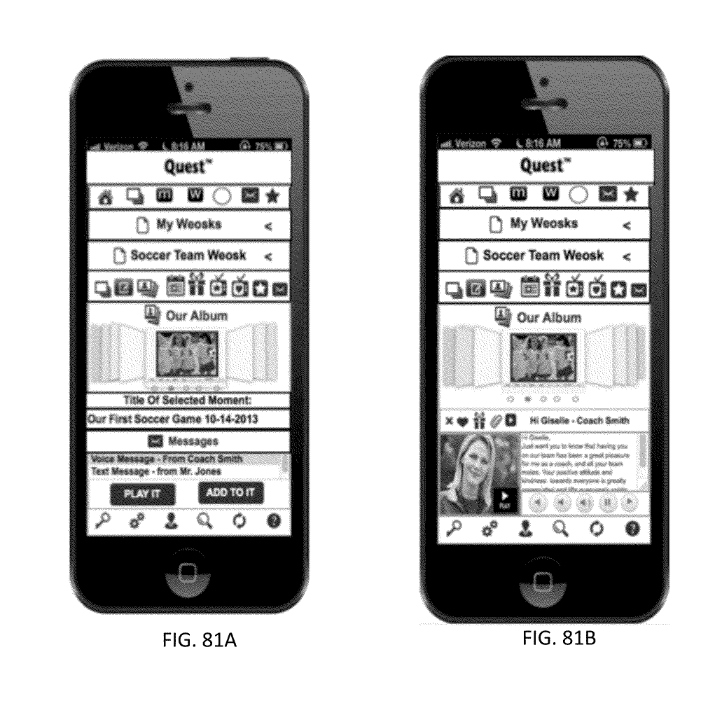

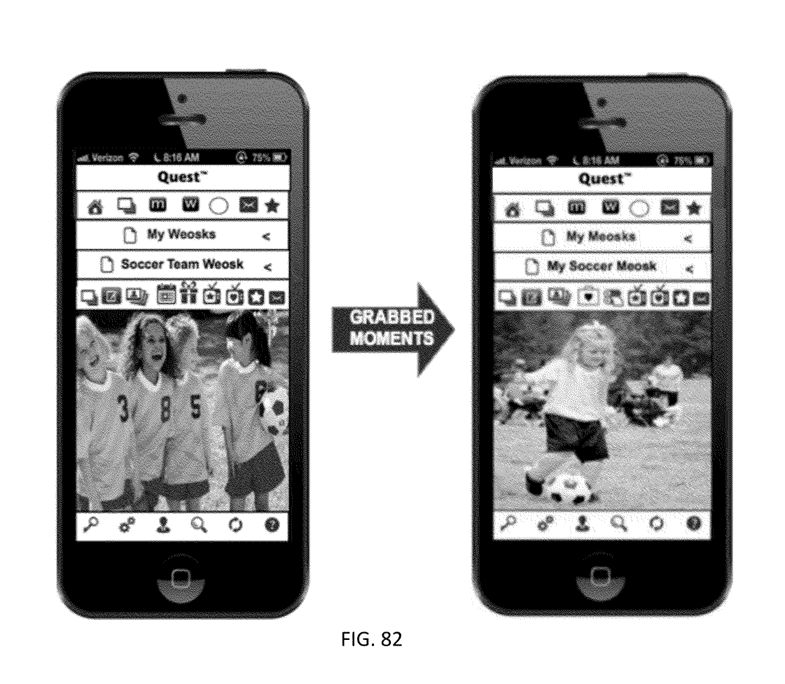

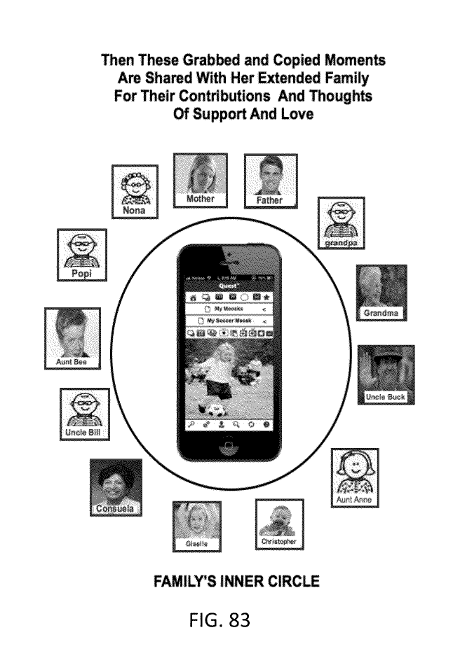

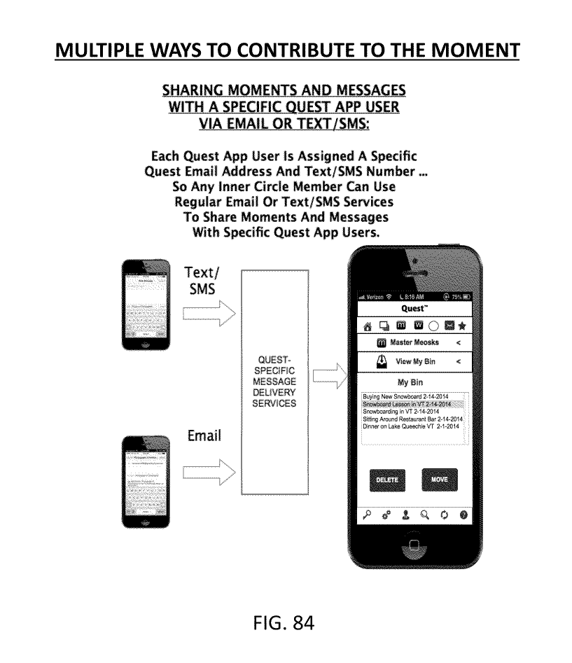

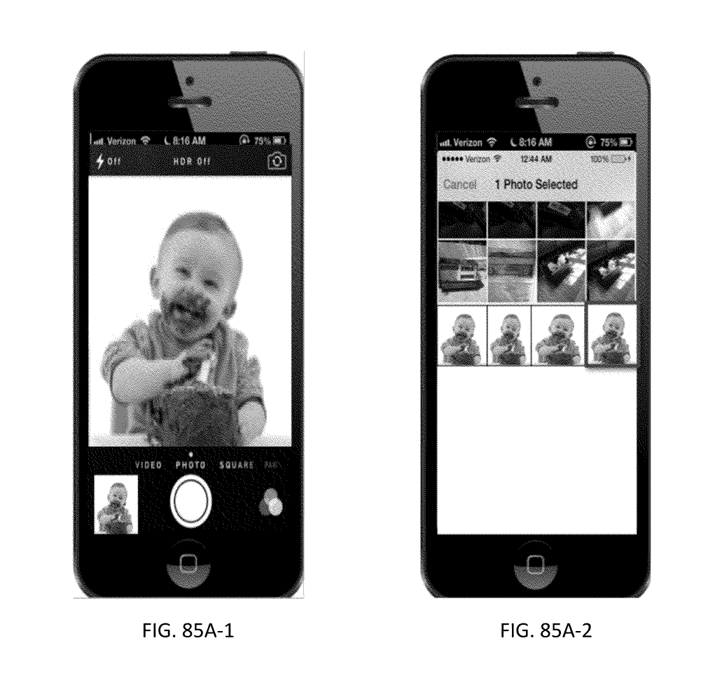

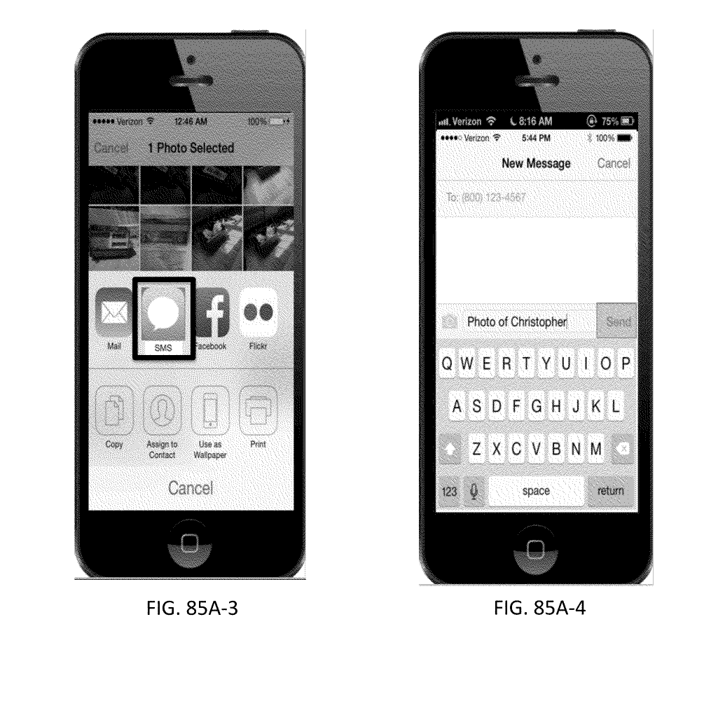

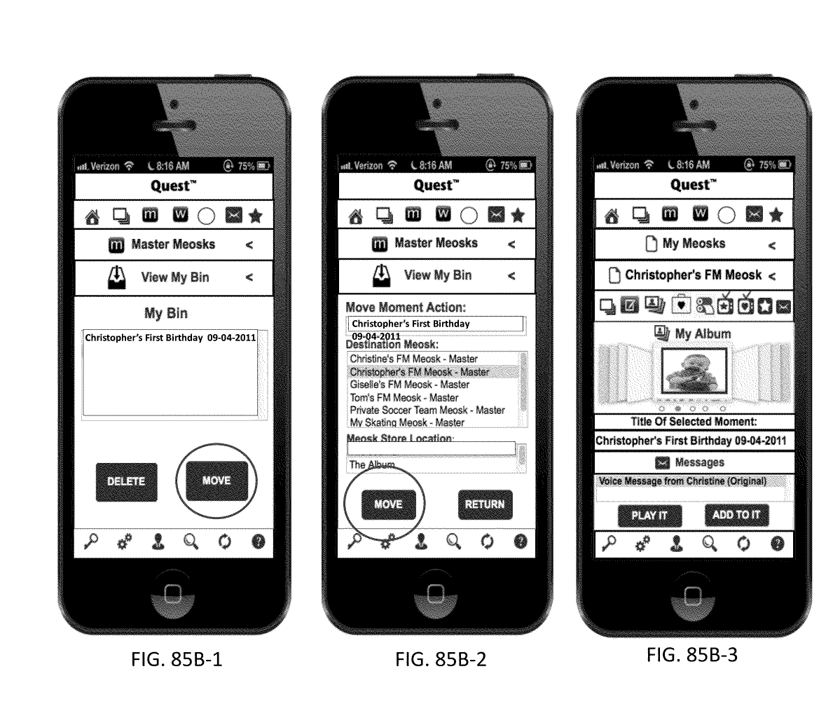

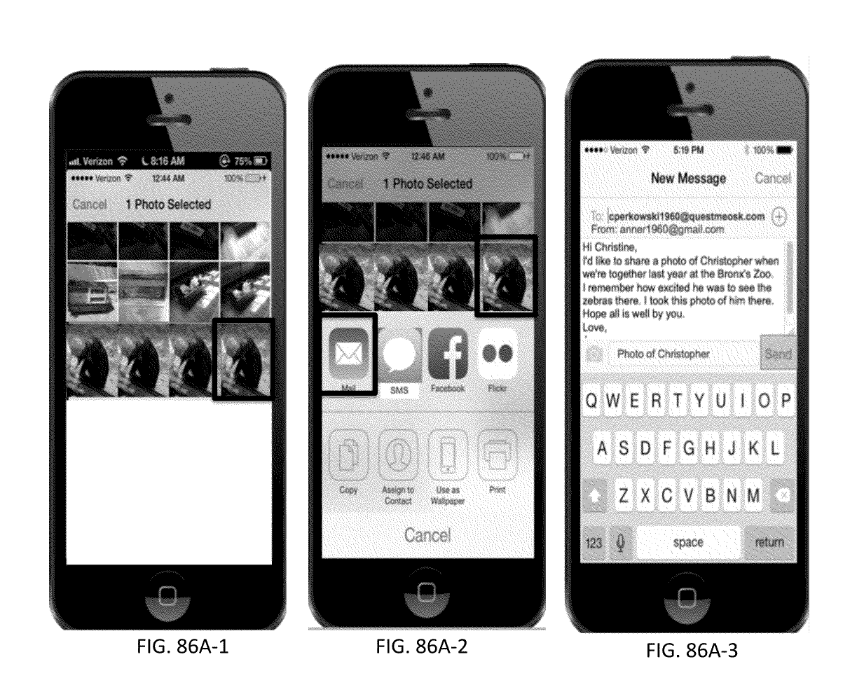

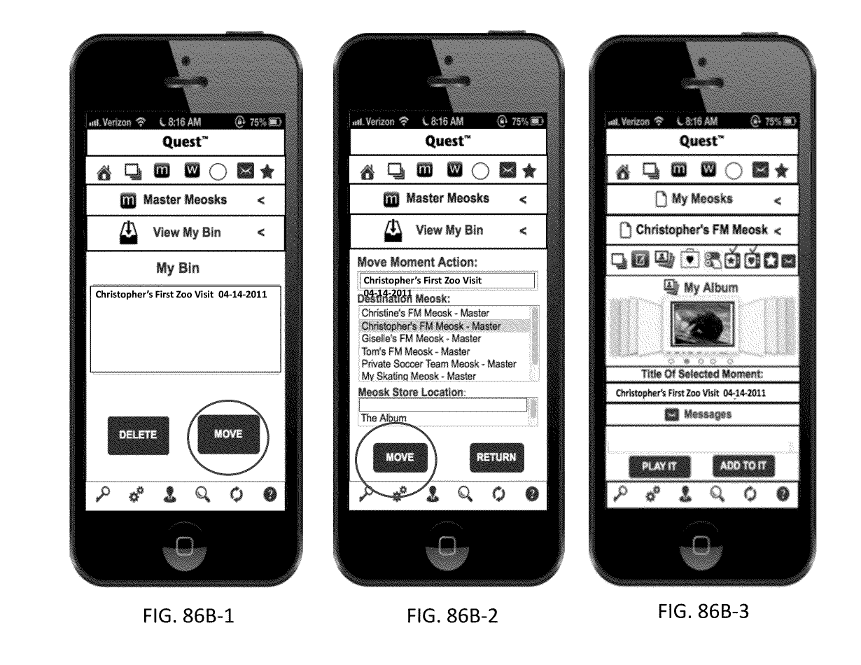

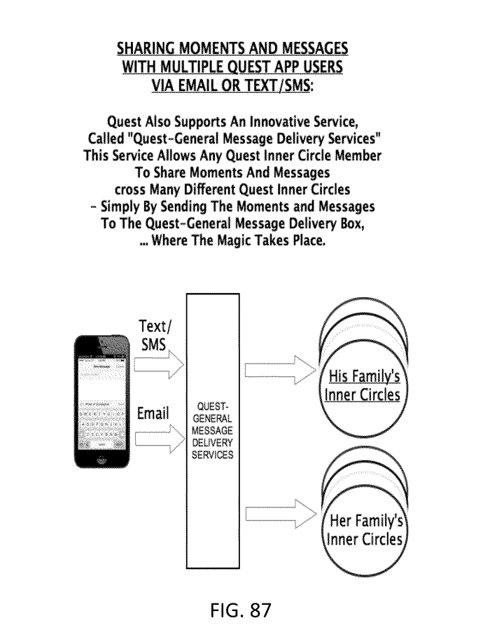

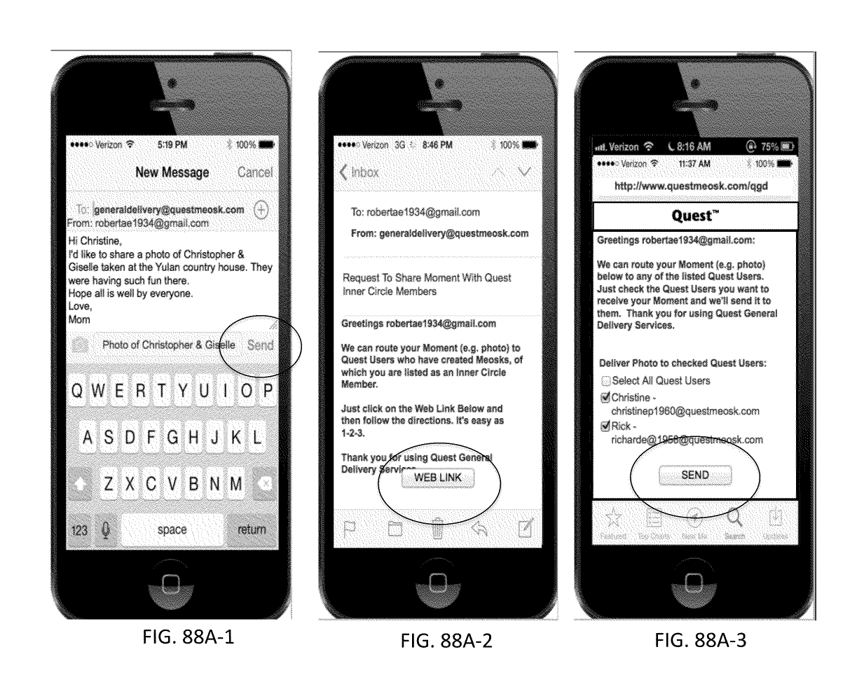

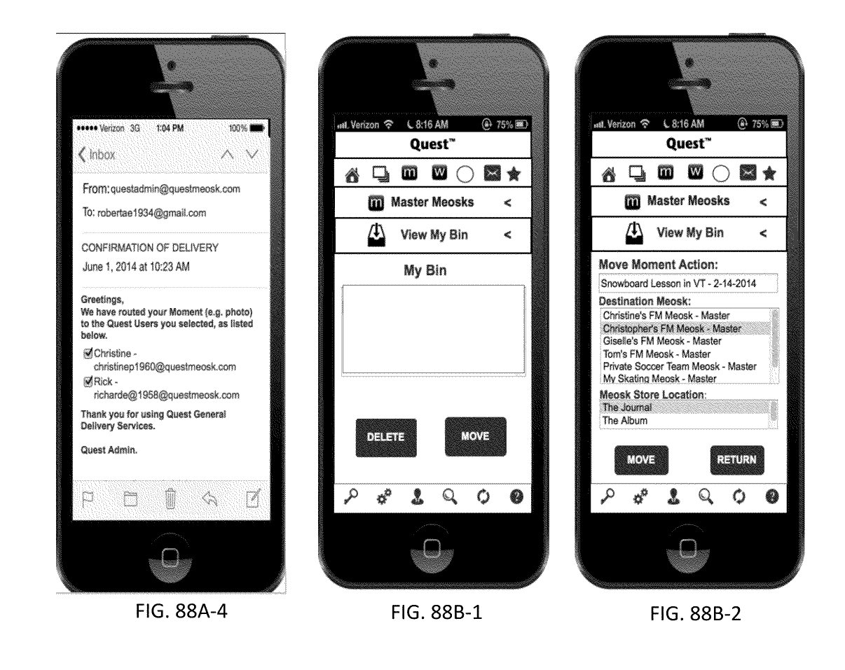

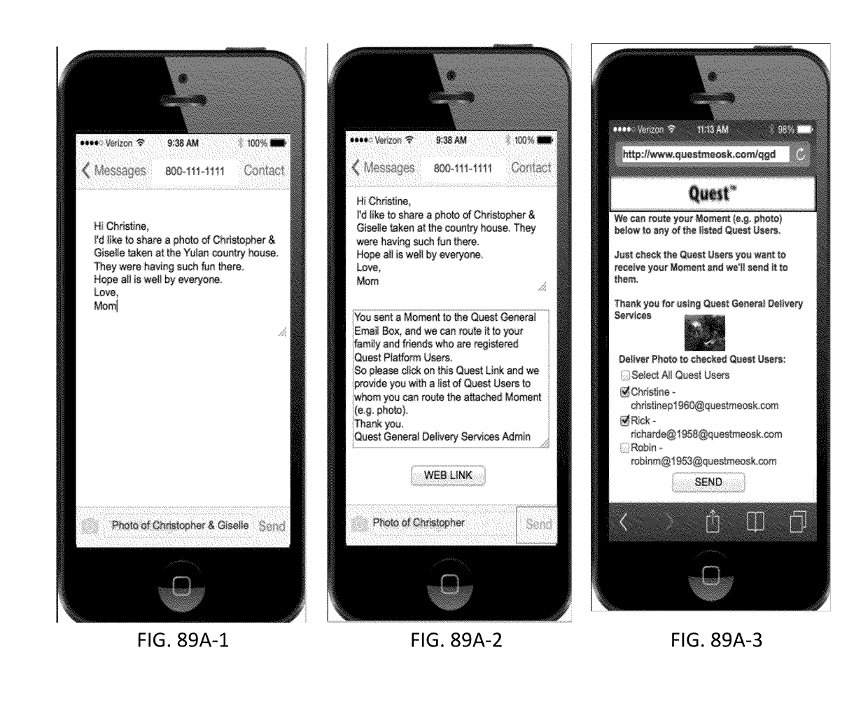

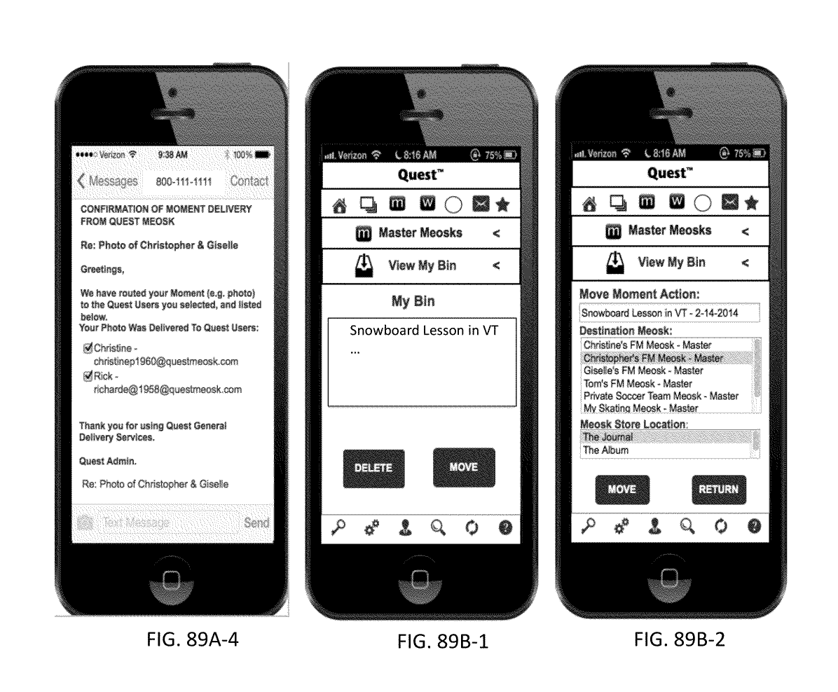

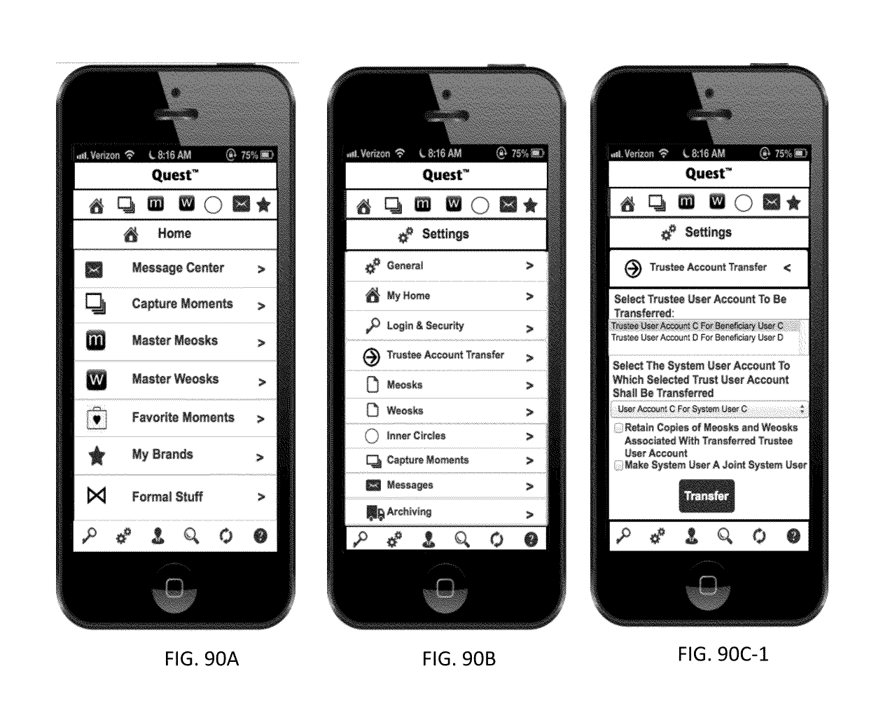

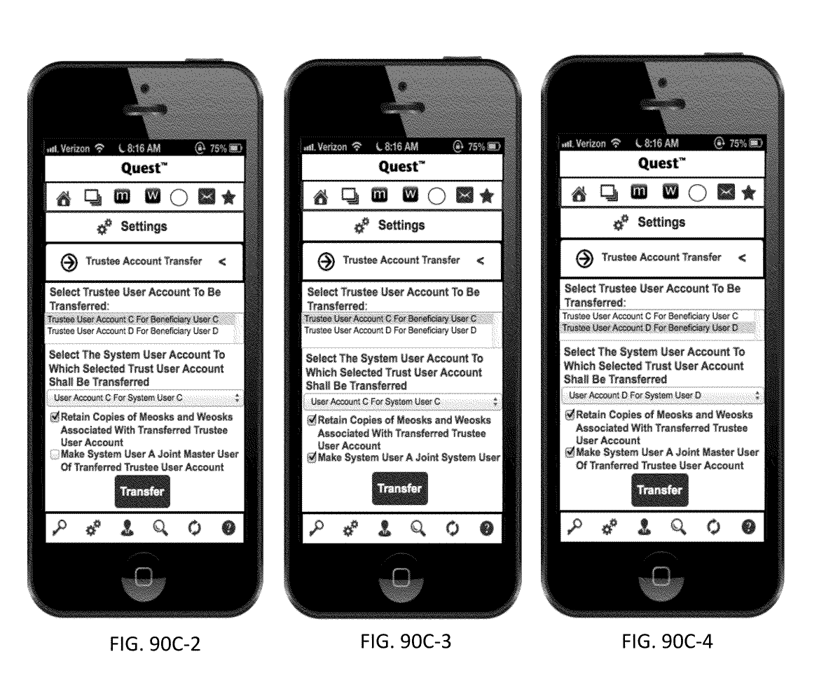

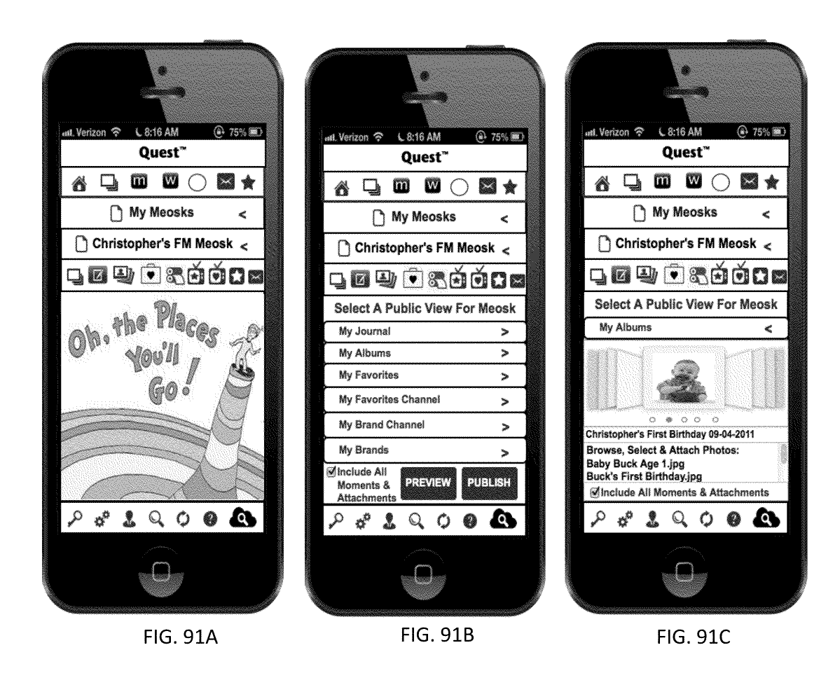

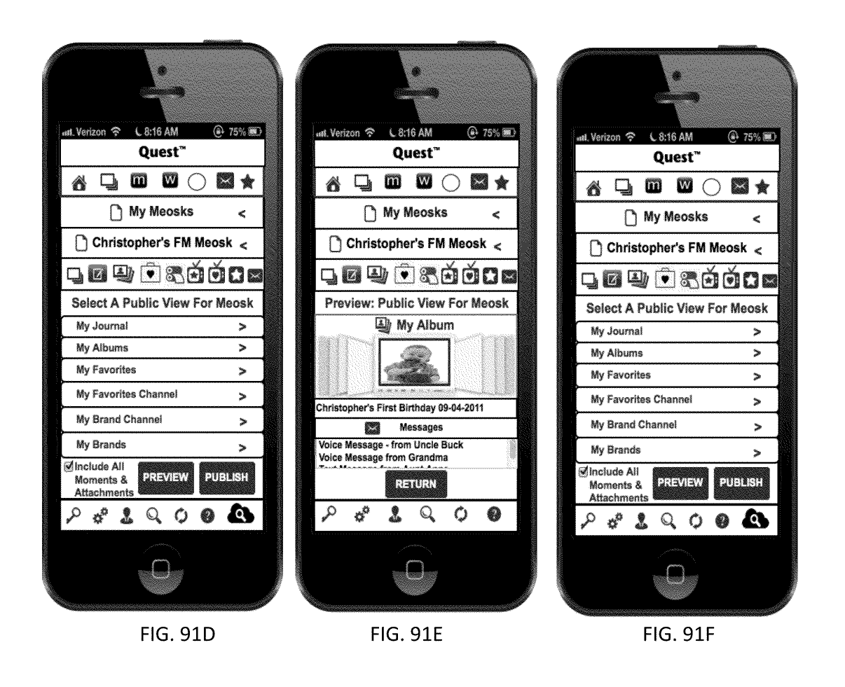

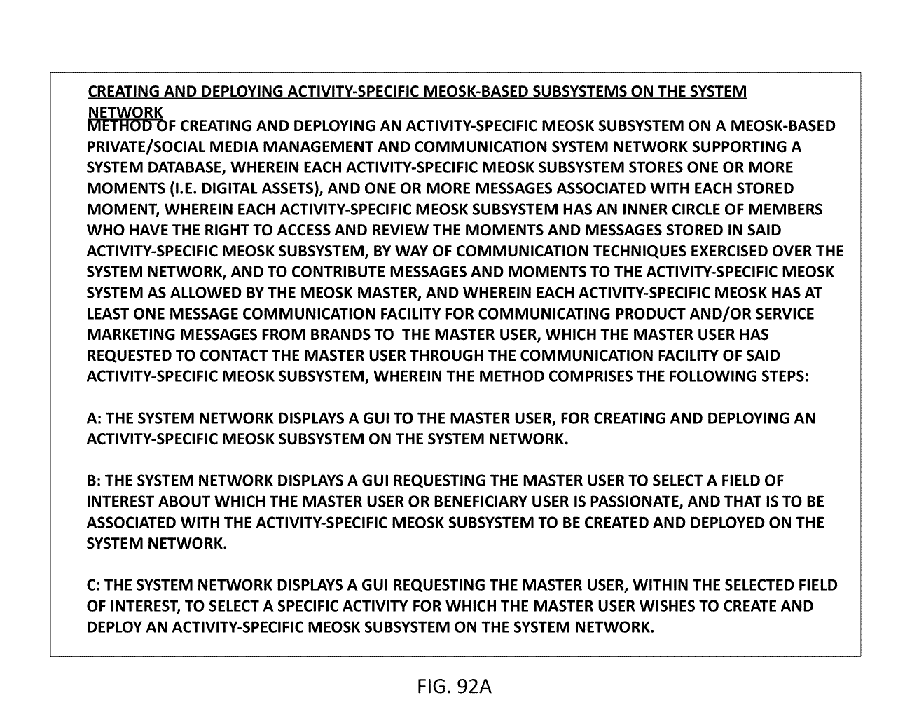

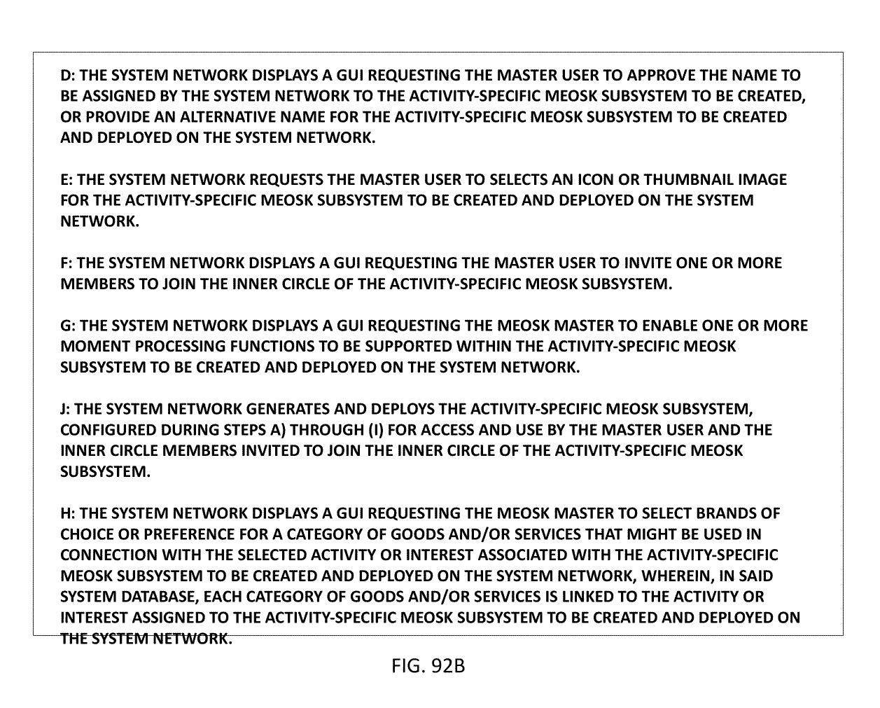

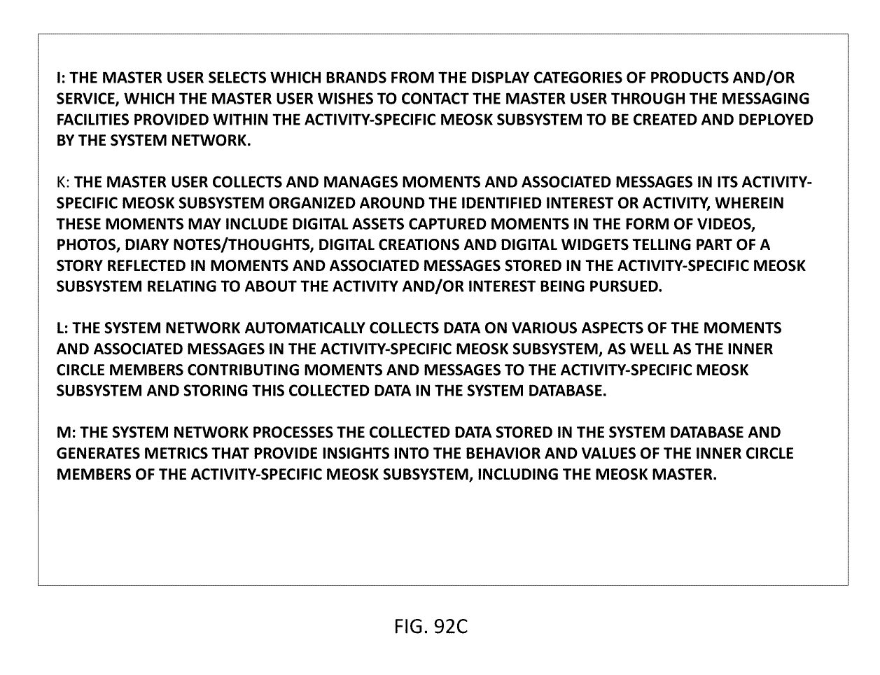

FIG. 61X-1 shows a GUI screen supported by the create new weosk module, and displaying the tenth major step involved in creating a new weosk structure for my group, involving the selection and enablement (i.e. activation) of weosk functions such as capture moments, my journal, my album(s), my favorites, my brand channel, my favorites channel, my brands, and inner circle messaging, that are to be supported within the weosk structure once deployed, for use by the master user;

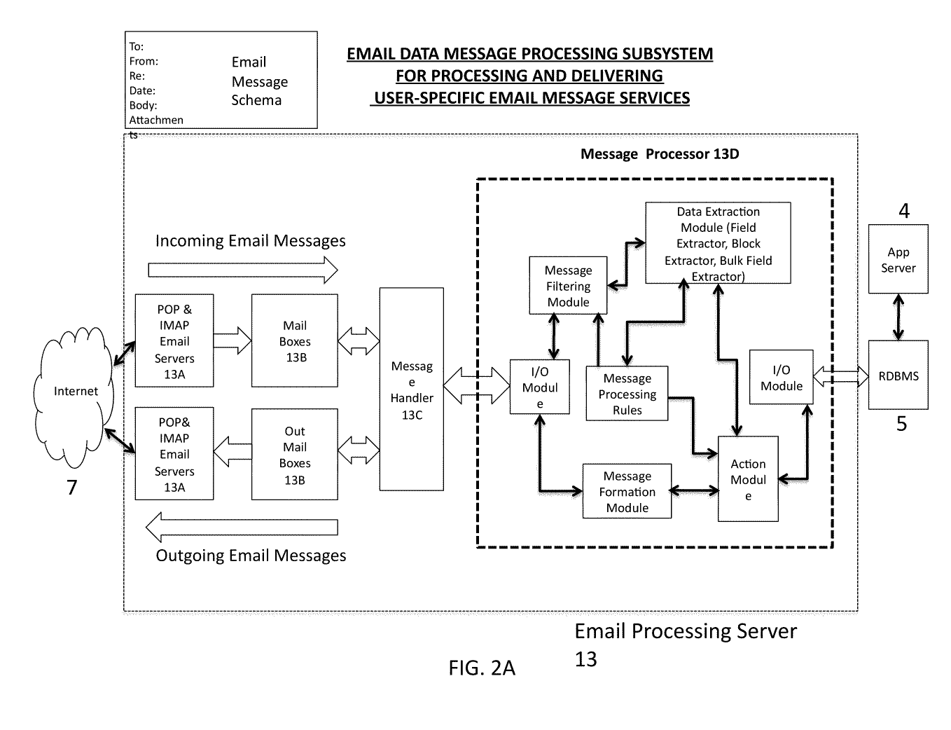

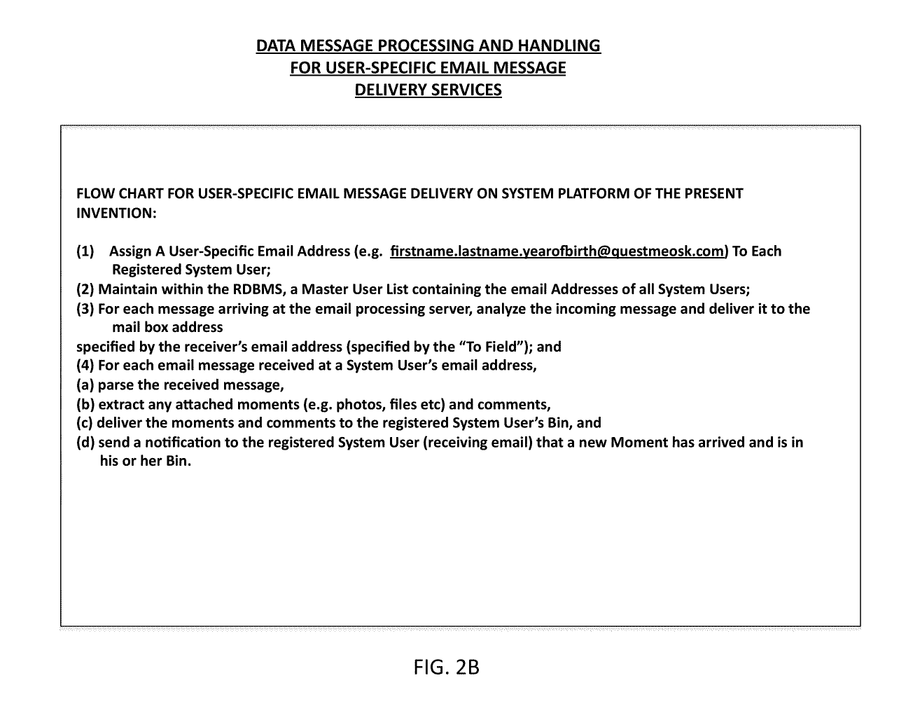

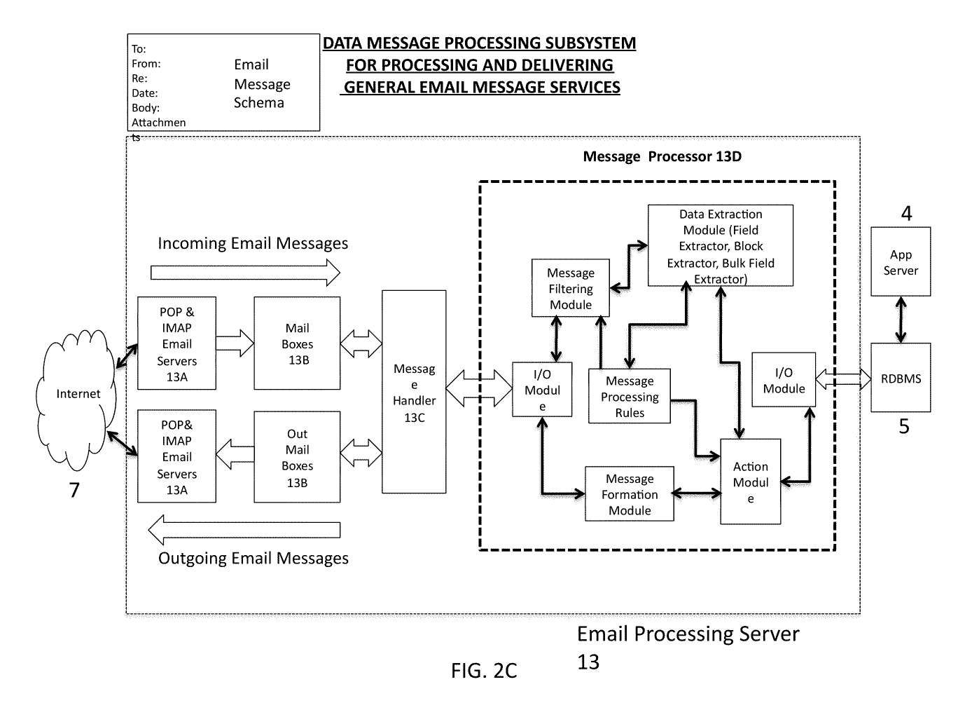

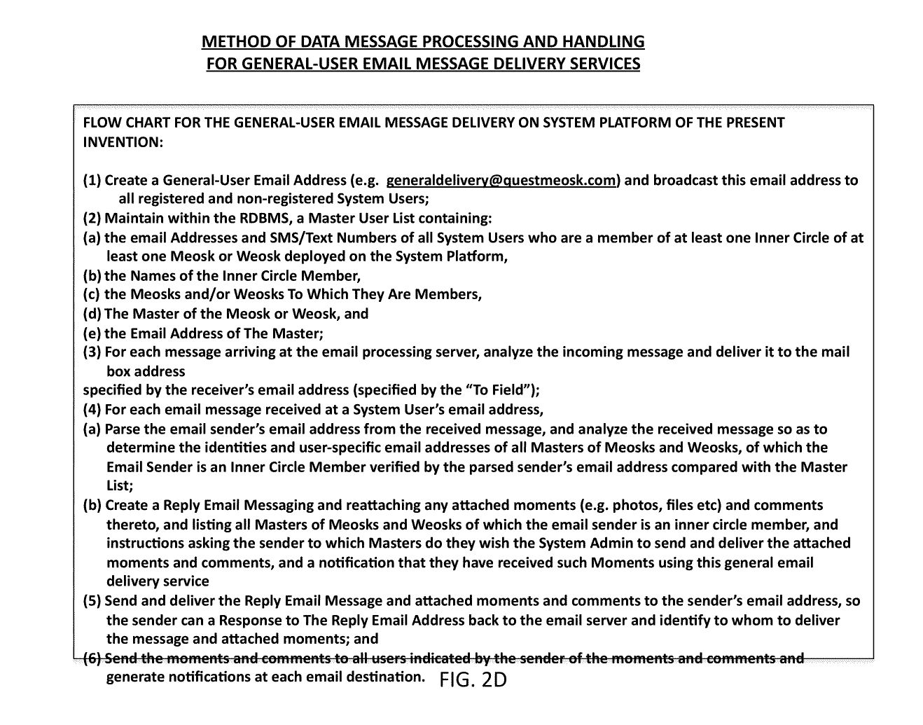

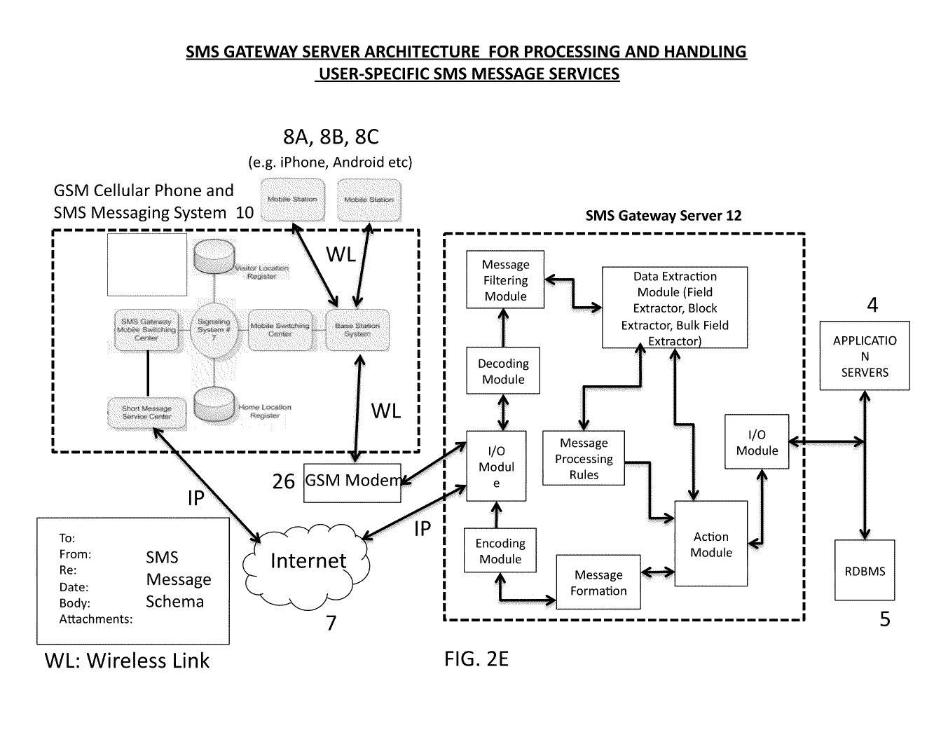

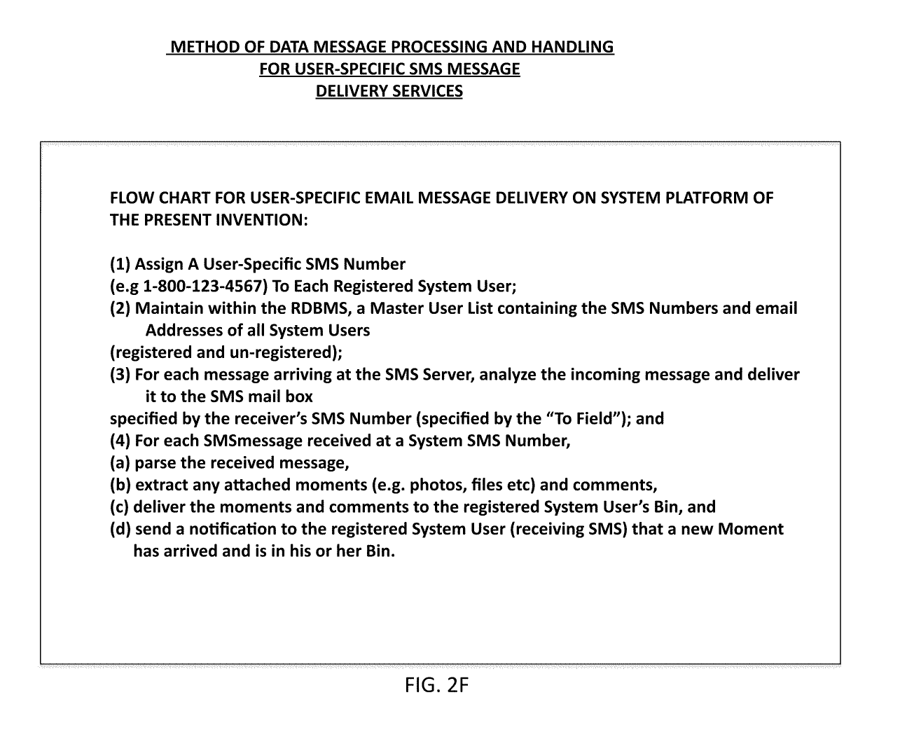

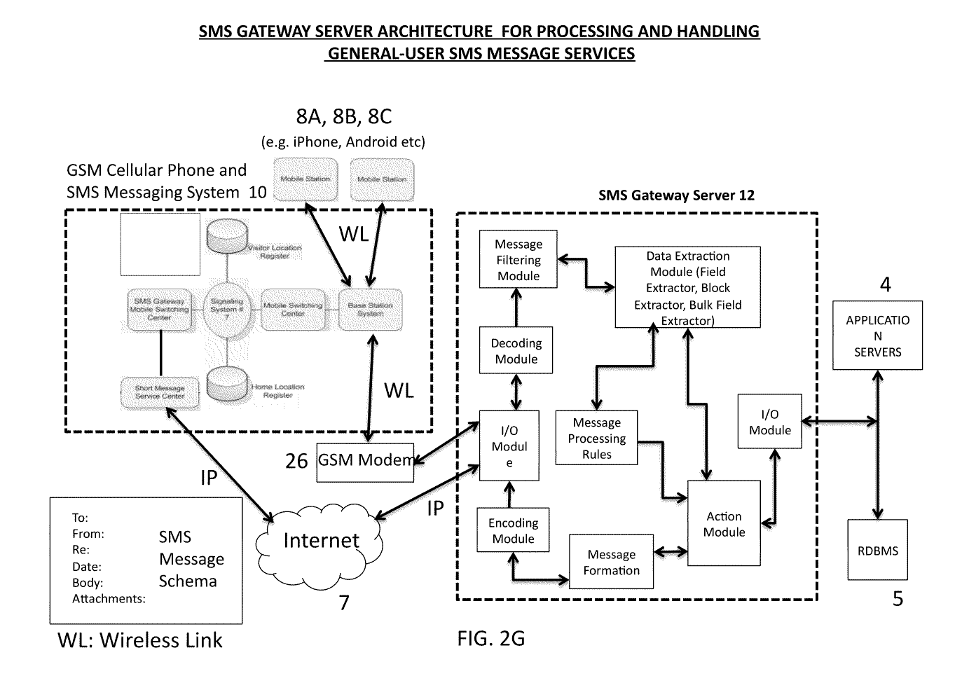

FIG. 61X-2 shows a GUI screen supported by the create new weosk module, and displaying the tenth major step involved in creating a new weosk structure for my group, involving the selection and enablement (i.e. activation) of moment functions such as store-it, favor-it, copy-it, note-it, gift-it, attach-it, share-it, grab-it, and post-it, that are to be supported within the weosk structure once deployed, for use by master user;

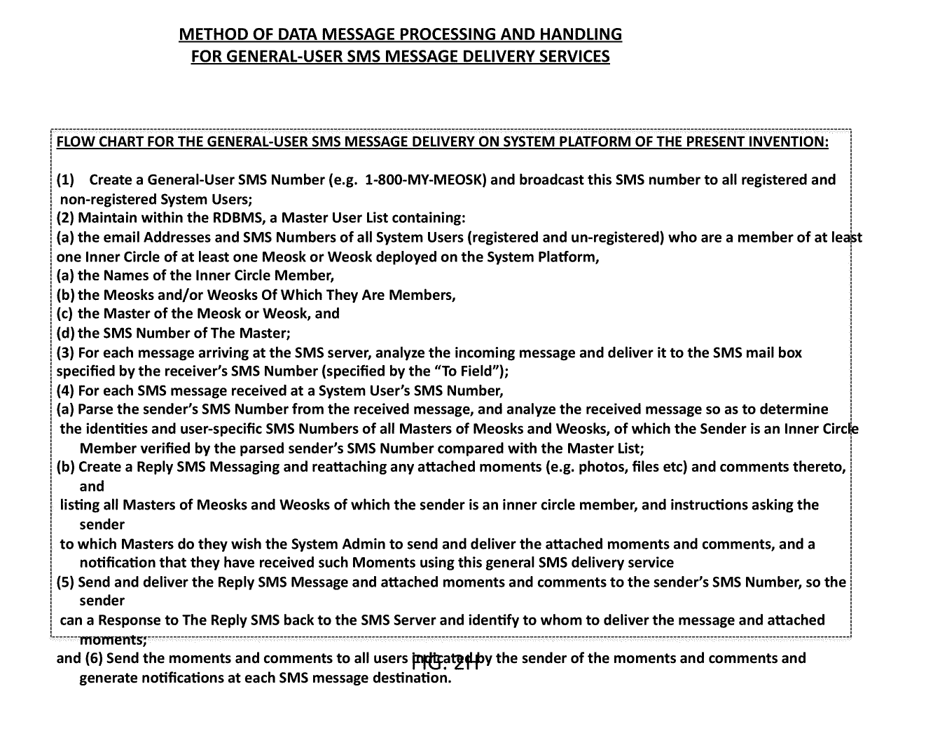

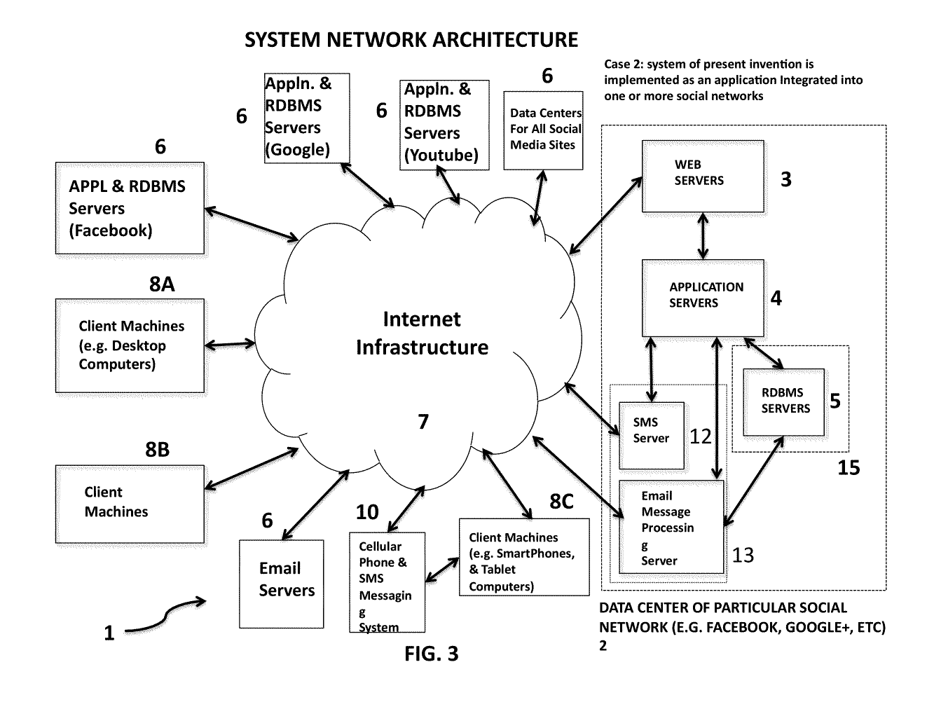

FIG. 61X-3 shows a GUI screen supported by the create new weosk module, and displaying the eleventh major step involved in creating a new weosk structure for my group, involving the selection and enablement (i.e. activation) of the selection and enablement (i.e. activation) of weosk functions such as tagging and copying moments, tagging moments as private and non-copyable, posting meosk structures on social networks and WWW, allowing inner circle members to add new members and expand the inner circle, that are to be supported within the weosk structure once deployed, for use by guest users;

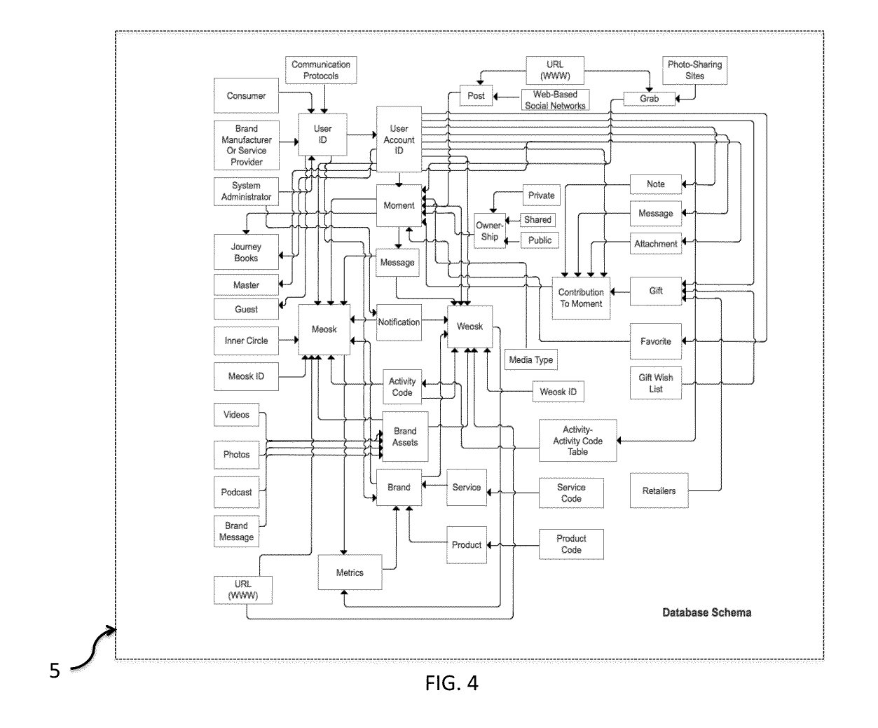

FIG. 61X-4 shows a GUI screen supported by the create new weosk module, and displaying the eleventh major step involved in creating a new weosk structure for my group, involving the selection of meosk functions such as capture moments, my journal, my album(s), my favorites, my brand channel, my favorites channel, my brands, and inner circle messaging, that are to be supported within the weosk structure once deployed, for use by guest users;

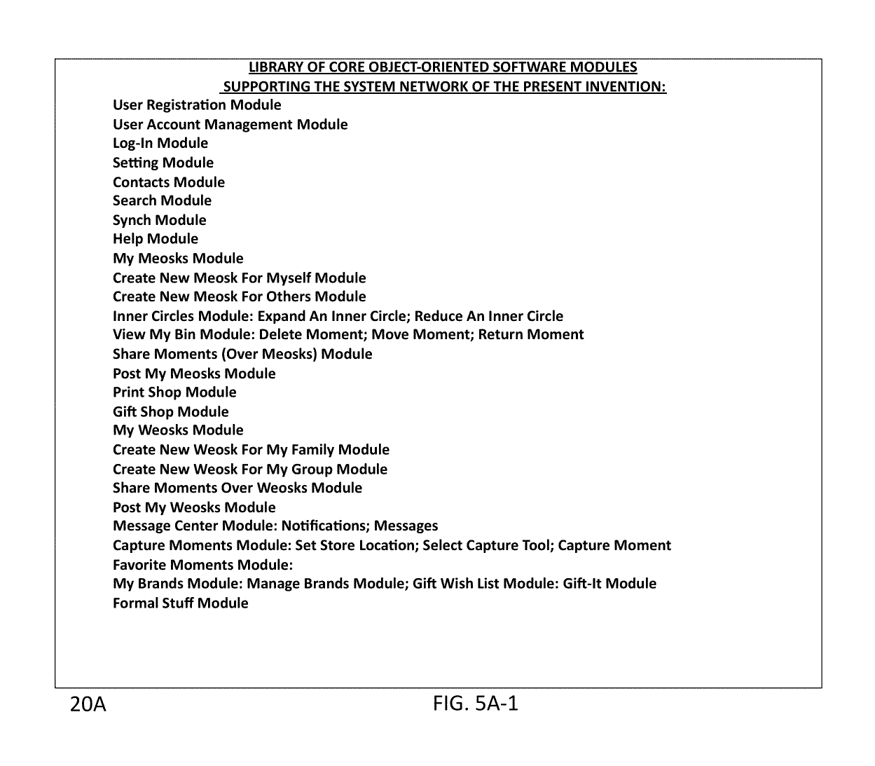

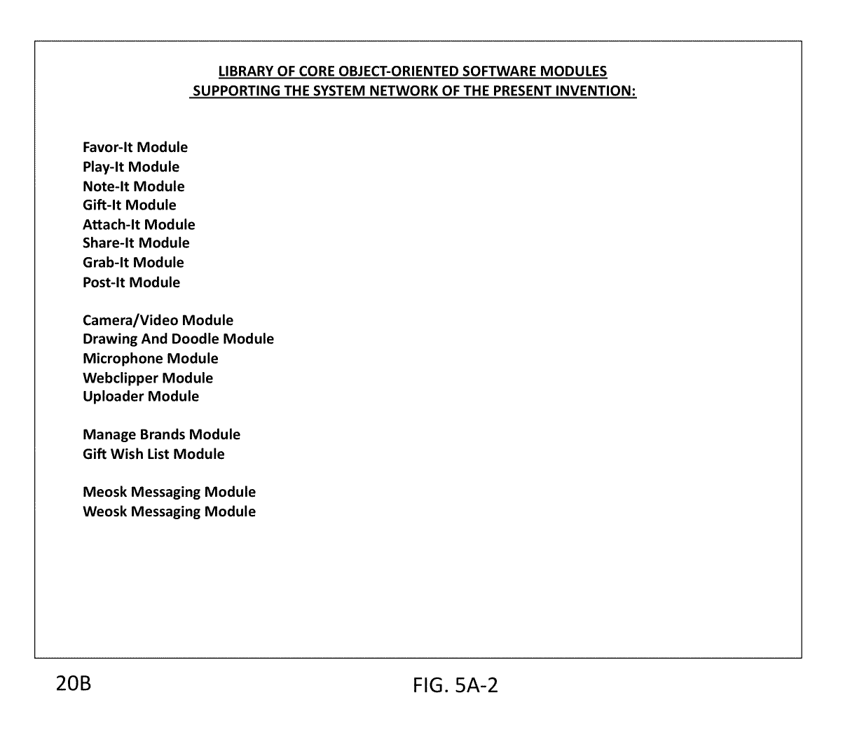

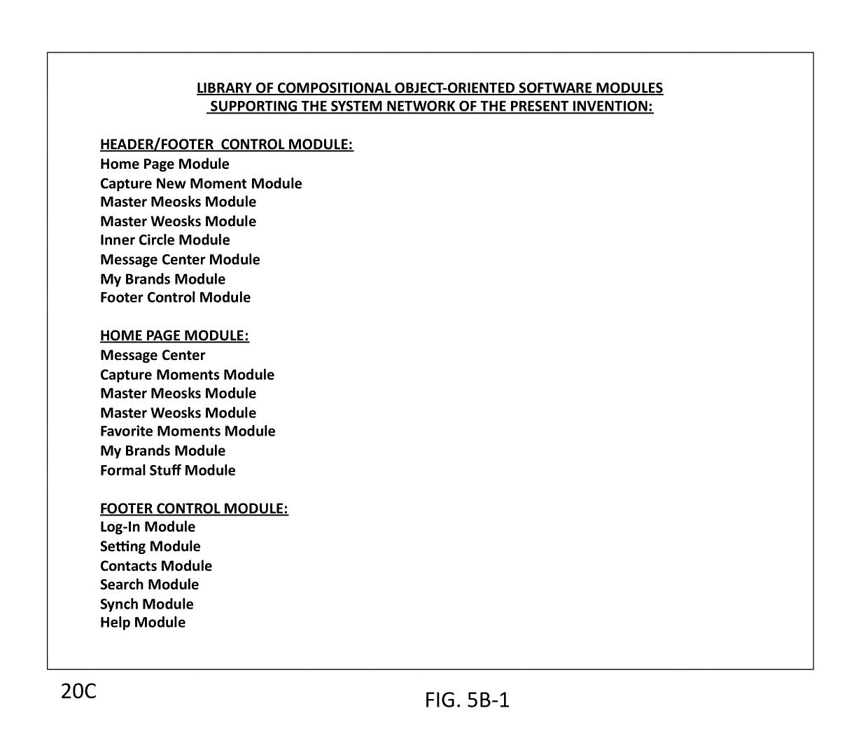

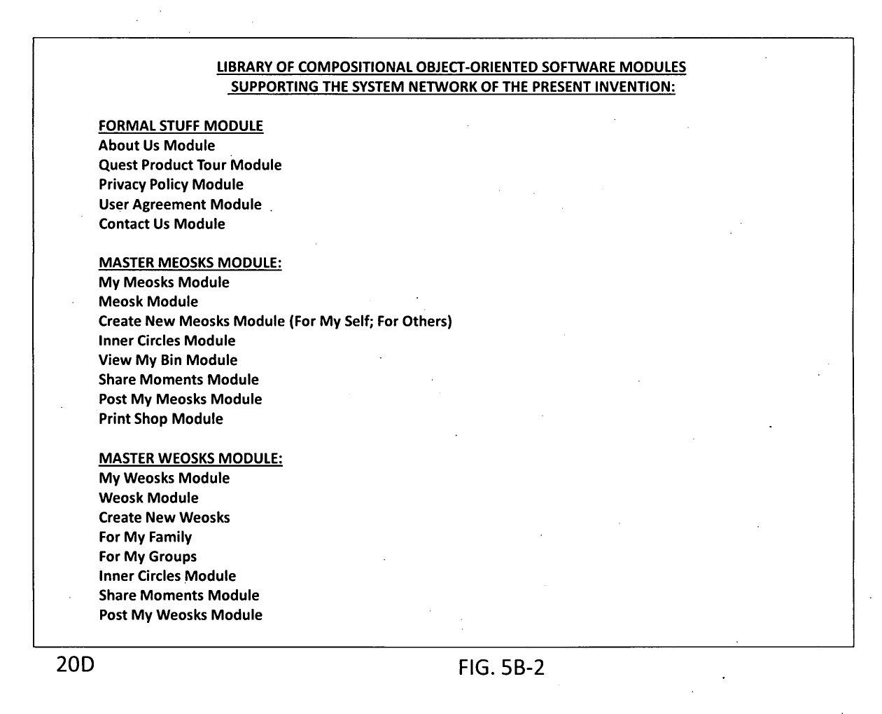

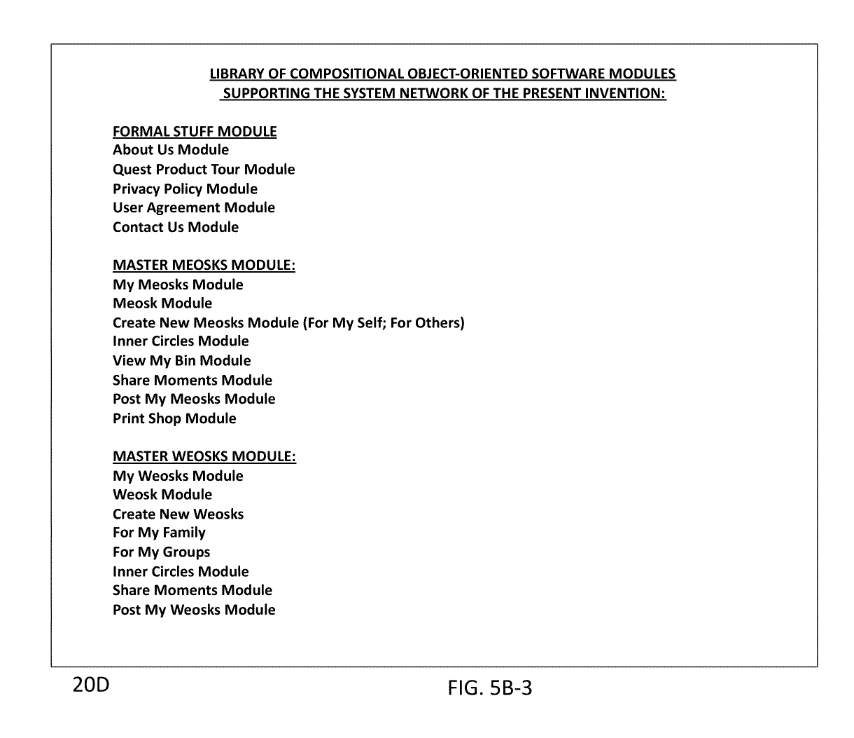

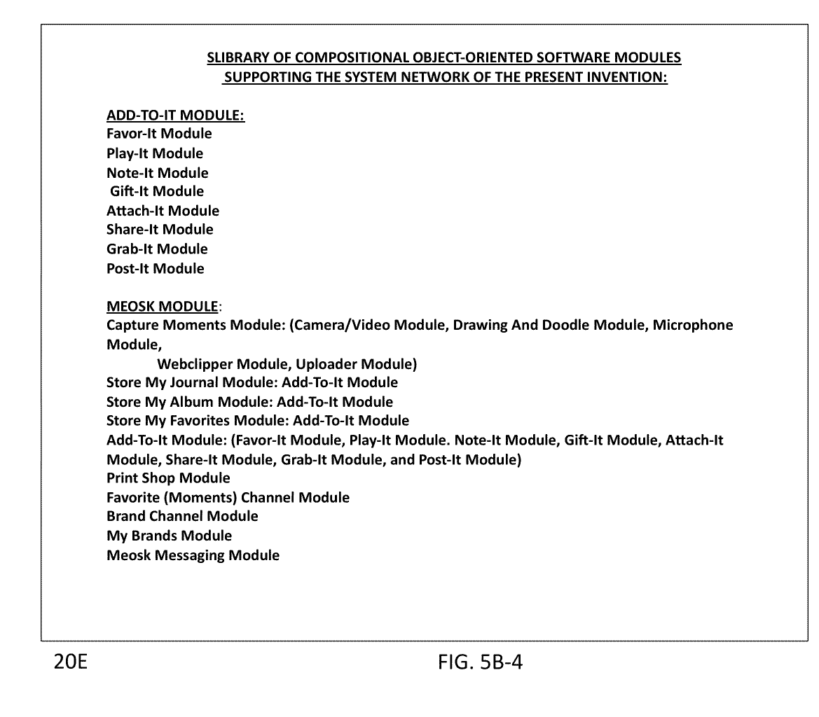

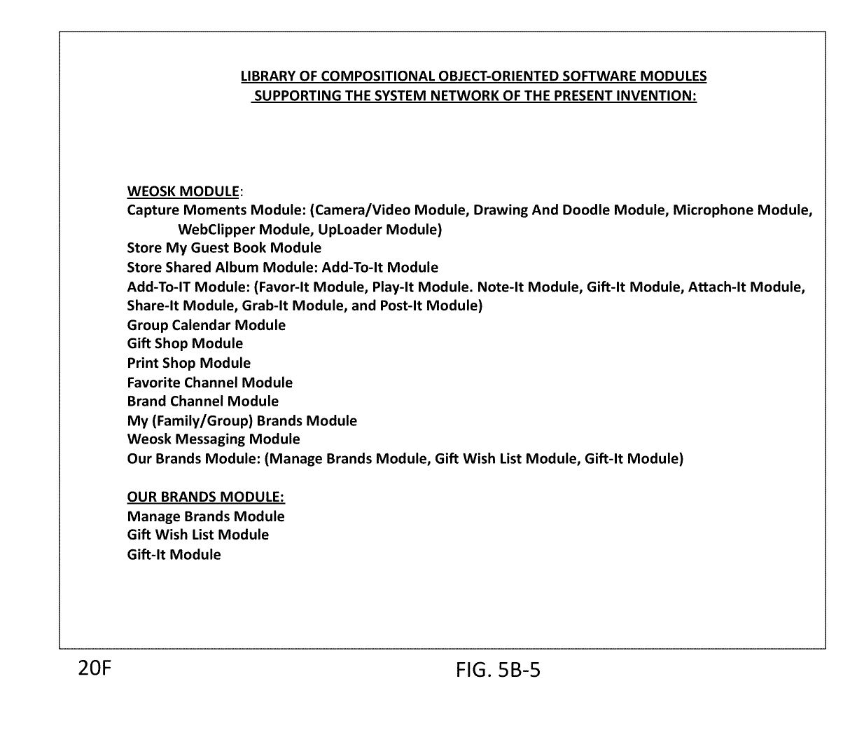

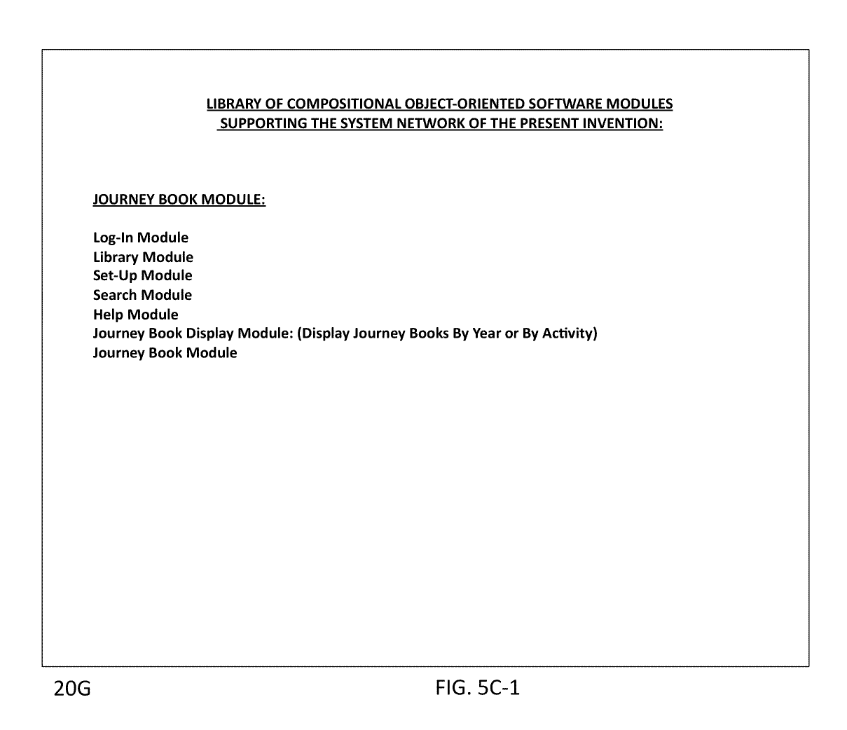

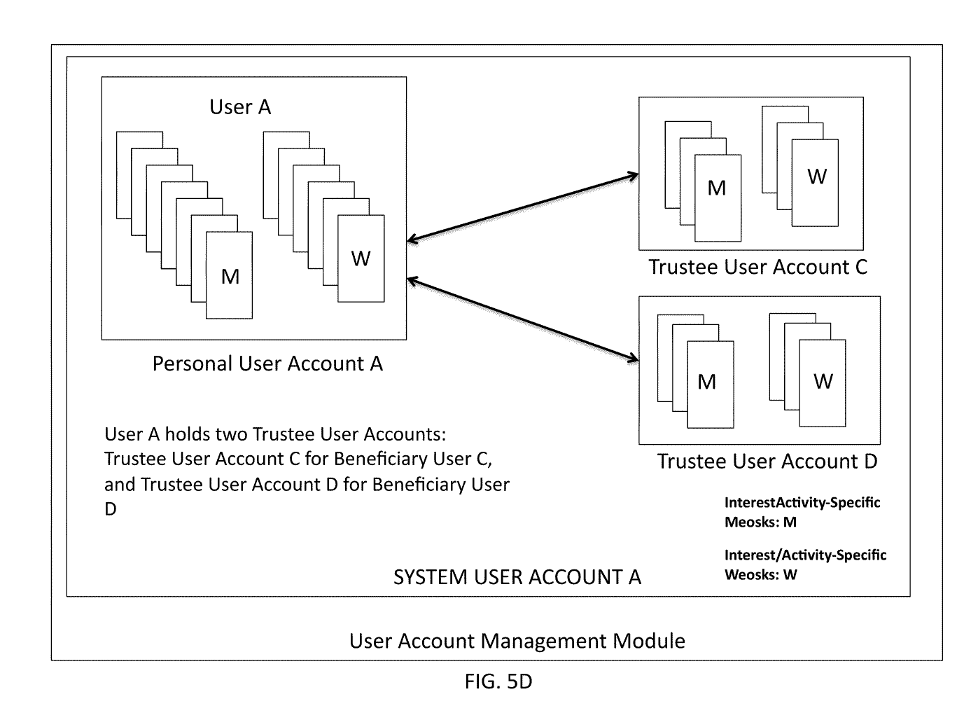

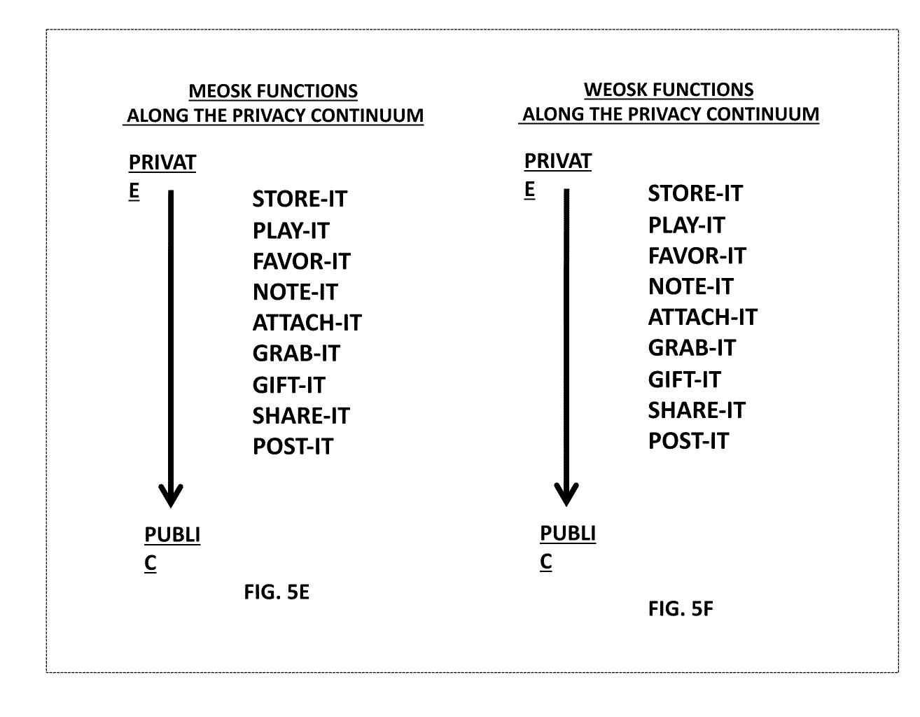

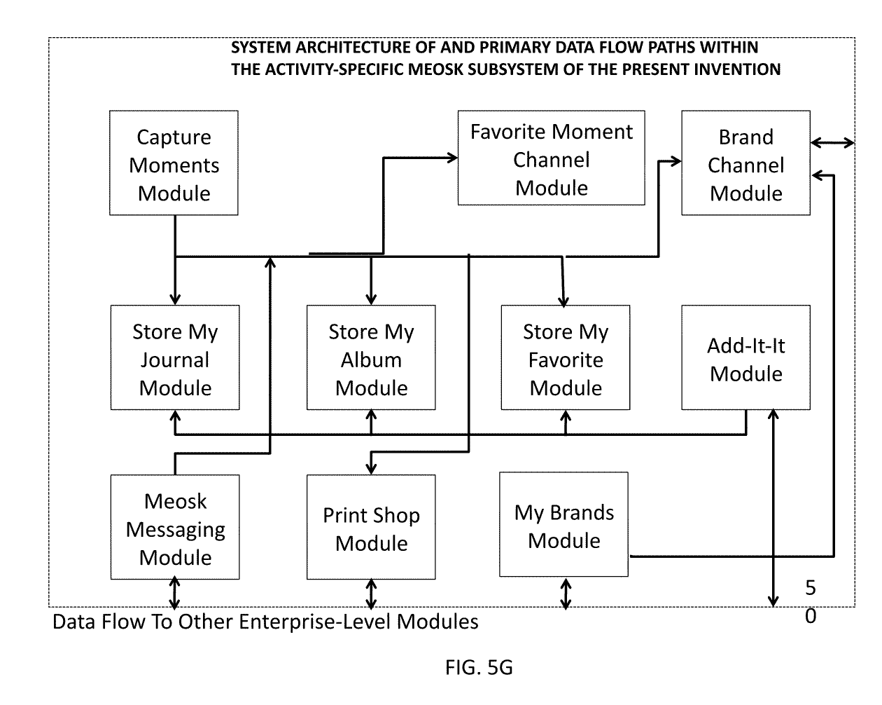

FIG. 61X-5 shows a GUI screen supported by the create new weosk module, and displaying the eleventh major step involved in creating a new weosk structure for my group, involving the selection and enablement (i.e. activation) of moment functions such as store-it, favor-it, play-it, note-it, gift-it, attach-it, share-it, grab-it, and post-it, that are to be supported within the weosk structure once deployed, for use by guest users;

FIG. 61Y shows a GUI screen supported by the create new weosk module, and displaying the twelfth step involved in creating a new weosk structure for my group, involving the weosk master selecting some initial global/national brands to support the group, selected from a variety of diverse fields related to the activity and interest about which the weosk structure is formed;

FIG. 61Z shows a GUI screen supported by the create new weosk module, and displaying the thirteenth step involved in creating a new weosk structure for my group, involving the weosk master selecting some initial local brands to support the group, selected from a variety of diverse fields related to the activity and interest about which the weosk structure is formed;

FIG. 61AA shows a GUI screen supported by the create new weosk module, and displaying the fourteenth step involved in creating a new weosk structure for my group, involving the weosk master selecting some initial global/national brands to support the group, selected from a variety of diverse fields related to the activity and interest about which the weosk structure is formed;

FIG. 61BB shows a GUI screen supported by the create new weosk module, and displaying the fifteenth step involved in creating a new weosk structure for my group, where the weosk master requests the selected brands to contact and communicate with the weosk structure and create the group's weosk and invite the weosk inner circle members;

FIG. 61CC shows a GUI screen supported by the my weosk module, and displaying the current lists of weosks that have been created and deployed on the system network, and of which the logged-in user is an inner circle member;

FIG. 61DD shows a GUI screen supported by the my weosk module, and displaying the GUI of the “group weosk” created during the previous illustrated workflow, and listed on the user's my weosk listed in FIG. 61CC;

FIG. 62A shows a GUI screen supported by the “master weosks” module, and displaying options for selecting the “share moments” module from a menu list of options;

FIG. 62B shows a GUI screen supported by the “master weosks” module, and displaying the introduction screen for the share moments module;

FIG. 62C shows a GUI screen supported by the “master weosks” module, and displaying the share moments module, where the user can share moments with inner circle members of a weosk in either an automated or manual manner;

FIG. 62D shows a GUI screen supported by the master weosks module, and displaying the share moments module, where the user sets automatic moment generation to occur every 20 uploads to the weosk structure, although this figure could be greater or less than 20 by user selection and choice;

FIG. 62E shows a GUI screen supported by the master weosks module, and displaying the share moments module, where the user proceeds to reset automatic moment generation to occur every 6 hours;

FIG. 62F shows a GUI screen supported by the master weosks module, and displaying the share moments module, where the user returns to the mode selection GUI and selects manual moment generation to occur within the weosk structure, and over its inner circle;

FIG. 62G shows a GUI screen supported by the master weosks module, and displaying the share moments module, where the user sets manual moment generation within the weosk structure and over its inner circle;

FIG. 62H shows a GUI screen supported by the master weosks module, and displaying the share moments module, where the user identifies for whom a moment will be created (e.g. soccer team), and what is the subject or theme of the moment (e.g. team soccer);

FIG. 62I shows a GUI screen supported by the master weosks module, and displaying the share moments module, where the user sets the terms for sharing the moment across the inner circle (e.g. share one time only, share annually on a recurring basis, share bi-annually on a recurring basis);

FIG. 62J shows a GUI screen supported by the master weosks module, and displaying the share moments module, where the weosk master previews the specially composed moment;

FIG. 62K shows a GUI screen supported by the master weosks module, and displaying the share moments module, where the user adds text and/or voice over the specially composed moment;

FIG. 62L shows a GUI screen supported by the master weosks module, and displaying the share moments module, where the user indicates where the specially composed moment will be shared on the posting date (e.g. over Soccer Team Moments Channel);

FIG. 62M shows a GUI screen supported by the master weosks module, and displaying the share moments module, where the user receives an notification that a special moment invitation has been sent to all members of the inner circle of the weosk structure to be shared (e.g. Sep. 12, 2014) on an annually recurring basis;

FIG. 62N shows a GUI screen supported by the master weosks module, and displaying a notification that an invitation has been sent to all members of the weosk inner circle that the special moment will be shared, for example, twice daily during the selected share period, and then annually;

FIGS. 62O and 62P show a series of GUI screens supported by the master weosks module, and displaying the share moments module, where, during the selection of the automatic moment generation mode, the weosk master is allowed to set the frequency of moment generation and sharing (e.g. every 20 uploads, every 6 hours, etc.);

FIGS. 62Q and 62R show a series of GUI screens supported by the master weosks module, and displaying the share moments module, where, during the selection of the automatic moment generation mode, the weosk master is allowed to set where the special moment will be shared on posting date;

FIG. 62S shows a GUI screen supported by the master weosks module, and displaying the share moments module, where, during the selection of the automatic moment generation mode, the weosk master receives notification that an invitation has been sent to all members of the weosk structure's inner circle to be shared, for example, twice daily during the selected sharing period and then annually on a recurring basis;

FIG. 62T shows a GUI screen supported by the master weosks module, and displaying icons for various modules therein, including the post my weosks module, where the master user (and also guest users authorized by weosk masters) can post weosk structures to social media sites and photo-sharing sites, and also un-post posted weosks as desired;

FIG. 62U shows a GUI screen supported by the master weosks module, and displaying the post my weosks module, where the master user selects “soccer team weosk” for posting to a social media site which has been pre-configured with the system network;

FIG. 62V shows a GUI screen supported by the master weosks module, and displaying the post my weosks module, where the master user selects a social medial site (e.g. Facebook) to which the selected weosk should be posted using the application programming interface (API) used to interface the system network and this social media site network;

FIGS. 62W and 62X shows a series of GUI screens supported by the master weosks module, and displaying the post my weosks module, where the front panel of the soccer team weosk now bears the post icon, in both user interfaces, for notification purposes;

FIG. 62Y shows a GUI screen supported by the master weosks module, and displaying the post my weosks module, where the weosk master selects the “un-post” button to remove the soccer team weosk from its prior Facebook post (e.g. equivalent to a delete post on the Facebook platform);

FIGS. 62Z-1 and 62Z-2 shows a series of GUI screens supported by the master weosks module, and displaying the post my weosk module, where the front panel of the un-posted weosk (i.e. soccer team weosk) no longer bears the post icon, on either interface, for notification purposes;

FIG. 63A shows a GUI screen supported by the message center module, and displaying a “Request to Build Inner Circles” notification in the Notifications Frame, and a first ordinary message (“When will you be visiting us . . . ”) from a first family member (“Grandma”) an inner circle member is displayed in the Messages Frame;

FIG. 63B shows a GUI screen supported by the message center module, and displaying a “Request to Create New Meosks” notification in the Notifications Frame, and a first ordinary message (“When will you be visiting us . . . ”) from a first family member (“Grandma”) an inner circle member is displayed in the Messages Frame;

FIG. 63C shows a GUI screen supported by the message center module, and displaying a “Request to View Shared Moment” notification in the Notifications Frame, and a first ordinary message (“When will you be visiting us . . . ”) from a first family member (“Grandma”) is displayed in the Messages Frame;

FIG. 63D shows a GUI screen supported by the message center module, and displaying a “Request to Join Meosk Inner Circle” notification in the Notifications Frame, and a first ordinary message (“When will you be visiting us . . . ”) from a first family member (“Grandma”) is displayed in the Messages Frame;

FIG. 63E shows a GUI screen supported by the message center module, and displaying a “Request to Join Weosk Inner Circle” notification in the Notifications Frame, and a second ordinary message (“When will you be visiting us . . . ”) from the first family member (“Grandma”) is displayed in the Messages Frame;

FIG. 63F shows a GUI screen supported by the message center module, and displaying a “Request to Build Inner Circles” notification in the Notifications Frame, and a second ordinary message (“Thank you for the beautiful . . . ”) from a second family (“Grandma”) in the Messages Frame;

FIG. 63G shows a GUI screen supported by the message center module, and displaying a “Request to Build Inner Circles” notification in the Notifications Frame, and a third ordinary message (“Where will Thanksgiving Dinner . . . ”) from a second family (“Buck P.”) in the Messages Frame;

FIG. 63H shows a GUI screen supported by the message center module, and displaying a “Request to Build Inner Circles” notification in the Notifications Frame, and a fourth ordinary message from an unspecified inner circle member in the Messages Frame;

FIG. 64A shows a GUI screen supported by the Inner Circle Module, and displaying an introductory screen inviting master and guest users alike to build inner circles for their meosks and weosks;

FIG. 64B shows a GUI screen supported by the Inner Circle Module, and displaying a list of inner circles, of which the user is a meosk inner circle member or weosk inner circle member, and GUI buttons for (i) adding members to the inner circle of selected meosks or weosks of which the user is a master or a guest with the power to add new members, and (ii) removing members to the inner circle of selected meosks or weosks;

FIG. 64C shows a GUI screen supported by the Inner Circle Module, including the selection of a meosk or weosk of which the user is a master, and the addition of members to the inner circle of selected meosks or weosks;

FIG. 64D shows a GUI screen supported by the Inner Circle Module, including the selection of a meosk or weosk of which the user is a master or a guest with the power to add new members, and the removal of members to the inner circle of selected meosks or weosks;

FIG. 65A shows a GUI screen supported by the Brands For My Meosk Module, and displaying a list of deployed meosk structures, of which the user is either a master or guest and inner circle member;

FIGS. 65B through 65C shows a series of GUI screens supported by the Brands For My Meosk Module, and Christopher's FM Meosk, where the master user of Christopher's FM Meosk is displayed, from the master's user account, a list of favorite brands associated with this meosk structure to which the master user can Add Brands and/or Remove Brands to update the products and service offers that might be displayed in the Brand Channel of Christopher's FM Meosk, and brand messages that might be sent to the messaging center of Christopher's FM Meosk;

FIGS. 65D and 65E shows a series of GUI screens supported by the Brands For My Meosk Module, and Christopher's FM Meosk, where the master user of Christopher's FM Meosk views the Gift Wish List for the meosk structure, to which the master user can Add Gifts, from which the master user can Remove Gifts and also Update The List as well, so that the updated Gift Wish List appears in the Gift-It widget presented in different locations within Christophe's FM Meosk;

FIG. 65F shows a GUI screen supported by the Brands For My Meosk Module, and the Christopher's FM Meosk, where the guest user of Christopher's FM Meosk is displayed, from the guest user's account, (i) a list of brands selected by the meosk master to support the meosk structure, and (ii) Gift-It widget enabling the guest user to select and send a gift from a master-managed gift wish list, as well as a top trending gift list;

FIGS. 65G and 65H show a series of GUI screens supported by the Brands For My Meosk Module, and the Christopher's FM Meosk, where the guest user of Christopher's FM Meosk selects a “Baby Oshkosh Pants” gift for purchase from the online retailer amazon.com, and then supports the consumer transaction, with the gift receipt being automatically stored in the journal of Christopher's FM Meosk;

FIG. 66A shows a GUI screen supported by the journey book module, and displaying the illustrative storybook (e.g. meosk-based journey books) using the system network of the present invention, wherein each produced journey book comprises a header function menu supporting user login, a user library (i.e. my library), user configuration settings, search, and technical help and support;

FIG. 66B shows a GUI screen supported by the journey book module, and the display of the illustrative storybook of FIG. 66A, where, after selection of the my library icon from the header function menu, the system presents the user with the option of viewing storybooks either by year or storybooks by activity of the subject user;

FIG. 66C shows a GUI screen supported by the illustrative storybook of FIGS. 66A and 66B, displaying storybooks by year of the subject user;

FIG. 66D shows a GUI screen supported by the illustrative storybook of FIGS. 66A through 66C, displaying the subject user's “First Year” storybook, presenting a set of moments (and all linked messages, attachments, gifts and responses associated with each moment) in an album, from which to select one and review and experience the moment and its associated messages (e.g. voice, text and video message types supported), attachments, gifts sent and responses associated with the moment;

FIG. 66E shows a GUI screen supported by the illustrative storybook of FIGS. 66A through 66D, displaying the subject user's “First Year” storybook, presenting a selected moment, and linked messages, attachments, gifts and responses associated with the moment, for playback and review by the subject user and others with access authorization, to help build memories of past events captured in such moments;

FIGS. 66F and 66G show a series of GUI screens supported by the illustrative storybook of FIGS. 66A and 66B, displaying storybooks by activity of the subject user;

FIGS. 66H, 661, 66J and 66K show a series of GUI screens supported by the illustrative storybook of FIGS. 66A through 66C, displaying the subject user's “Trinity College” storybook, presenting a set of moments (and all linked messages, attachments, gifts and responses associated with each moment) in “my favorites” album, from which the user selects, reviews and experiences one moment (e.g. singing in Trinity College Chapel) and its associated messages (e.g. voice, text and video message types supported) by a particular friend/relative who shared, an attachment (e.g. a photo of the Knott Memorial Library at Union College), a gift (e.g. a digital sheet musical gift card) sent and responses associated with the moment);

FIGS. 67A, 67B and 67C show a series of GUI screens supported by the my meosks module, and displaying the user interface to the First Moments (FM) Meosk created for a young child of a user (e.g. the mother's young child or caregiver's young child), and capturing and storing a new moment using the meosk's integrated video capture tool module, while her young child is experiencing a first moment in his or her life;

FIGS. 68A-1 through 68B-6 show a series of GUI screens supported by the my meosks module, and displaying the user (e.g. a mother of a young child) visiting her child's first moments (FM) meosk structure (e.g. Christopher's FM Meosk), selecting the moment that was captured and stored in the my album store of the meosk structure, and then adding a note (e.g. message) to the captured moment, as shown in FIGS. 68B-1 and 68B-2, adding an e-card to the moment in FIG. 68B-3, sending a gift in connection with the moment as shown in FIG. 68B-4, and then playing back and reviewing the moment and its associated messages, attachments and gifts, as shown in FIGS. 68B-5 and 68B-6;

FIG. 69 shows a GUI screen supported by the my meosks module, and displaying the user (e.g. the mother of a young child) visiting her child's FM meosk structure (e.g. Christopher's FM Meosk), selecting a particular moment stored in the my album of the meosk structure, and then selecting the share-it function to share this privately maintained moment in the private FM meosk structure, with other selected members of the meosk structure's inner circle, by way of any and all of the methods of moment sharing supported on the system network of the present invention including HTTP/SMS/MMS based message sharing (IMS), SMS and email techniques supported by most conventional smart phones (e.g. Apple iPhone, Google Android devices, etc.);

FIG. 70 is a schematic representation illustrating three different methods of messaging communication supported on the system network of the present invention, including SMS, email (POP/IMAP) and SMS/MMS over http, etc);

FIG. 71 is a schematic representation illustrating a social network comprising an inner circle of extended family members who have access rights to a meosk structure deployed on the system network of the present invention, by a parent for a child in a trustee-based relationship, wherein this particular inner circle of family members and friends in the parent's family ecosystem is organized into a “his” inner family member circle, and a “her” inner family member circle for the family structure involved in this illustrative exemplary with the understanding than many different types and styles of family structures can be represented within and supported by the system network of the present invention, in accordance with the lifestyle and values of the diverse family members involved;

FIG. 72A shows a GUI screen from a “native” mobile implementation of the Quest client component of the system network, written in a native computer programming language (e.g. Objective-C for Apple IOS, Java for Android, and C for Microsoft) executing on a mobile operating system (OS), such as Apple IOS, or Google Android OS, or Microsoft CE, etc, supporting the my meosks module, and displaying the entire suite of functions (i.e. favor-it, play-it, note-it, gift-it, attach-it, share-it, grab-it and post-it) supported by the application within any meosk structure, or weosk subsystem network, created and deployed on the system network of the present invention of the illustrative embodiment;

FIG. 72B shows a GUI screen from a “web-browser” mobile implementation of the client component of the system network, written in a conventional mark-up language, such as HTML5 or alternative language, running within the web-browser application (e.g. Apple Safari, MS Explorer, Mozilla Firefox, etc) executing on a mobile operating system (OS), such as Apple IOS, or Google Android OS, or Microsoft CE, etc, and supporting the my meosks module, and displaying the entire suite of functions (i.e. favor-it, play-it, note-it, gift-it, attach-it, share-it, grab-it and post-it) supported by the application within any meosk structure, or weosk subsystem network, created and deployed on the system network of the present invention of the illustrative embodiment;

FIG. 73A shows a GUI screen supported by the my meosks module within the system network, where a first user displays a FM Meosk subsystem and selects to share a moment with one or more members of the meosk inner circle using the IMS method supported on the system network;

FIGS. 73B-1 through 73B4 show a series of GUI screens supported by the message center module within the system network, where a second user, within the selected inner circle to which the moment is sent in FIG. 73A, receives in a notification in the Message Center shown in FIG. 73B-1 as to the moment shared by the first user in FIG. 73A, and the second user views this moment by selecting “Do It” in FIG. 73B-1, automatically taking the second user to the my meosks module shown in FIG. 73B-2 where the moment is displayed in the appropriate meosk structure (e.g. Christopher's FM Meosk) and the second user is allowed to play back the moment as shown in FIG. 73B-3, as well as add or contribute to the moment using the various functions displayed in FIG. 73B-4;

FIG. 74A shows a GUI screen supported by the my meosks module within the system network, where a first user displays a FM Meosk subsystem and selects to share a moment with one or more members of the meosk inner circle using the SMS-based method supported on the system network;

FIGS. 74B-1 through 74B4 show a series of GUI screens illustrating the SMS client application on a mobile client device, operated by a second user within the selected inner circle to which the moment is sent in FIG. 74A, receiving an SMS message from an SMS gateway server supported on the system network as shown in FIGS. 1A, 1B and 74B-1 regarding the moment shared by the first user in FIG. 74A, and where the second user views this moment by selecting “VIEW MOMENT” html tag (URL) in the SMS message, as shown in FIG. 74B-1, automatically launching the web browser application on the mobile client device of the second user as shown in FIG. 74B-2 where the web application is executed and displayed in the web browser and the shared moment is displayed in the appropriate meosk structure (e.g. Christopher's FM Meosk) and the second user is allowed to play back the moment as shown in FIG. 74B-3, as well as add or contribute to the moment using the various functions displayed in FIG. 74B-4;

FIG. 75A shows a GUI screen supported by the my meosks module within the system network, where a first user displays a FM Meosk subsystem and selects to share a moment with one or more members of the meosk inner circle using the Email-based method supported on the system network;

FIGS. 75B-1 through 75B4 show a series of GUI screens illustrating the e-mail client application on a mobile client device, operated by a second user within the selected inner circle to which the moment is sent in FIG. 75A, receiving an email message from an email server supported on the system network as shown in FIGS. 1A, 1B and 74B-1 regarding the moment shared by the first user in FIG. 75A, and where the second user views this moment by selecting “VIEW MOMENT” html tag (URL) in the email message, as shown in FIG. 75B-1, automatically launching the web browser application on the mobile client device of the second user as shown in FIG. 75B-2 where the web application is executed and displayed in the web browser and the shared moment is displayed in the appropriate meosk structure (e.g. Christopher's FM Meosk) and the second user is allowed to play back the moment as shown in FIG. 75B-3, as well as add or contribute to the moment using the various functions displayed in FIG. 75B-4;

FIGS. 76A-1 and 76A-2 show a series of GUI screens supported by the my meosks module within the system network, where within Christopher's FM Meosk, a third user who is a member of the inner circle of the meosk reviews the moment captured and message/note created by Christopher's mother (i.e. the meosk master) and decides to contribute to the moment by selecting the note-it function supported in the GUI shown in FIG. 76A-2;

FIGS. 76B-1 through 76B-3 show a series of GUI screens supported by the my meosks module within the system network, where within Christopher's FM Meosk, the third user contributes to the moment selected in FIGS. 76A-1 by creating and linking a note to the moment as shown in FIGS. 76B-1, then sending the meosk structure's subject (e.g. Christopher) a gift as shown in FIG. 76B-2, and thereafter reviewing the note and gift associated with the moment as shown in FIG. 76B-3;

FIG. 77 is a schematic representation illustrating how any inner circle member of a meosk structure deployed on the system network of the present invention can use a mobile smart phone or like device to (i) receive a request to view a shared moment via an SMS message using the smart phone's SMS client application, or an email message using the smart phone's email client application, (ii) then use the smart phone and its web browser to access and view the shared moment stored within its meosk structure, and “play back” (i.e. review) the moment and its associated notes, attachments, gift receipts, and other messages using the play-it function supported in the web-browser based client application, and (iii) thereafter use the web browser application to add or contribute to the moment using any of the eight core functions supported by the client-server based system network of the present invention;

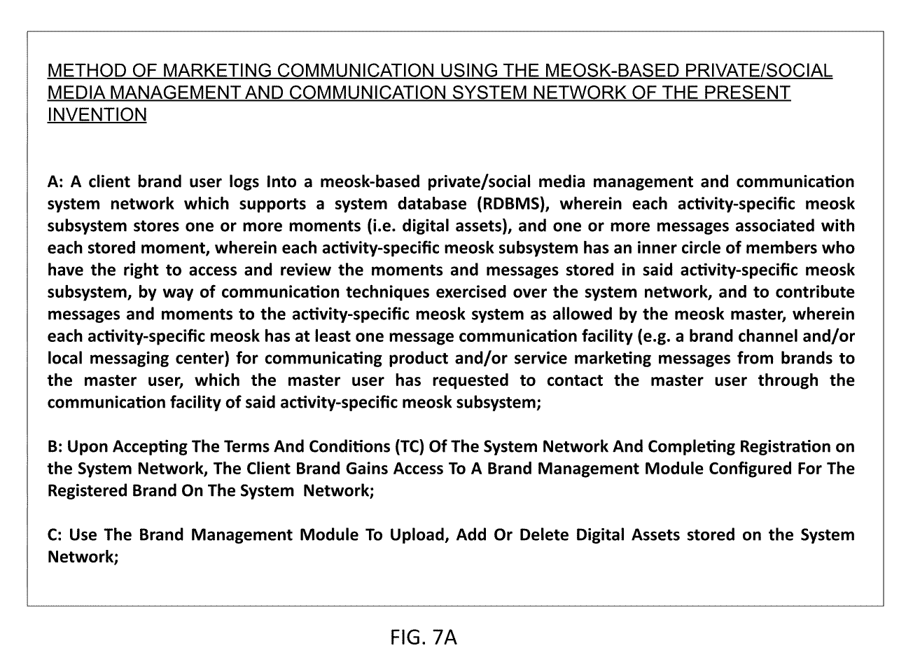

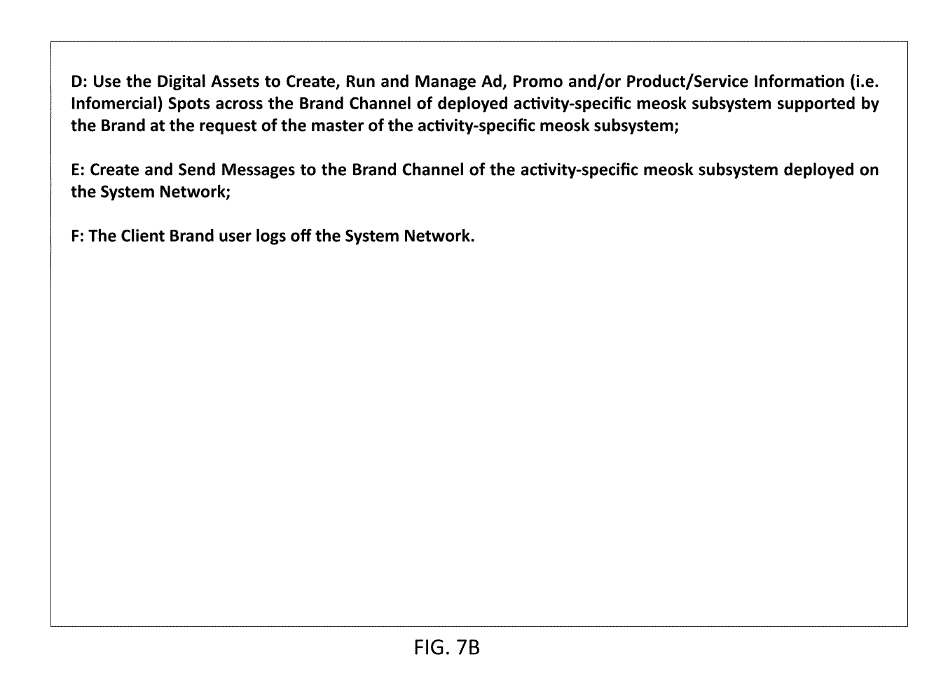

FIGS. 78A-1 through 78-A7 show a series of GUI screens supported by the web-browser implementation of the system network of the present invention, where any inner circle member of a meosk structure can use a mobile smart phone to (i) receive a request to view a shared moment via an email message using the smart phone's email client application as shown in FIG. 78A-1, (ii) then use the smart phone and its web browser to access and view the shared moment stored within its meosk structure on the system network of the present invention as shown in FIGS. 78A-1 and 78A-2, and “play back” (i.e. review) the moment and its associated notes, attachments, gift receipts, and other messages using the play-it function supported in the web-browser based client application as shown in FIGS. 78A-2 and 78A-3, and (iii) thereafter use the web browser application to add or contribute to the moment using any one or more of the eight core functions supported by the client-server based system network, as shown in FIG. 78A-4, including adding a note (e.g. voice, text and/or video message) to the moment as shown in FIG. 78A-5, and then reviewing the message as shown in FIGS. 78A-7 and 78A-7;

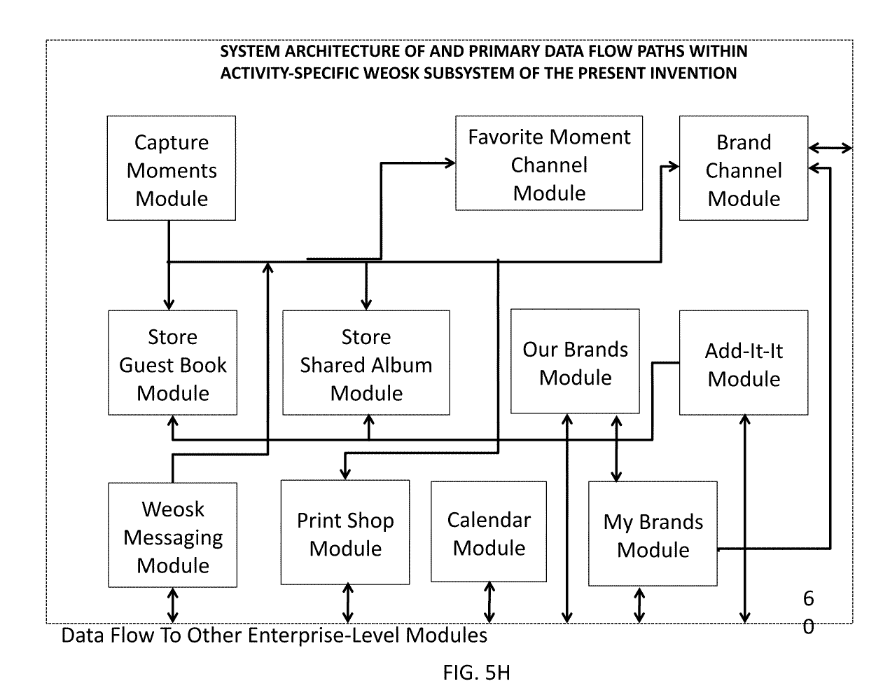

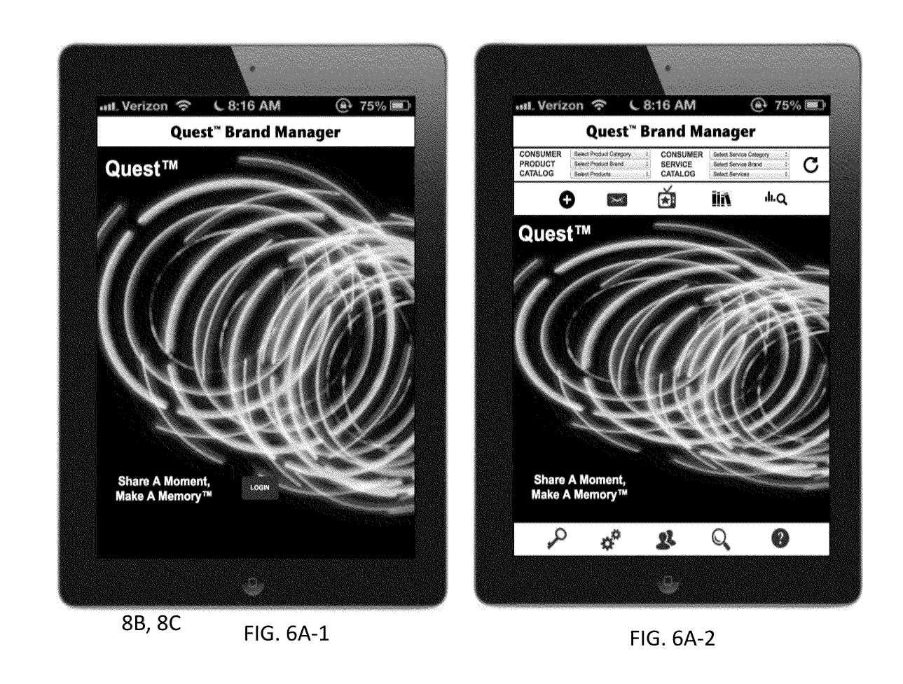

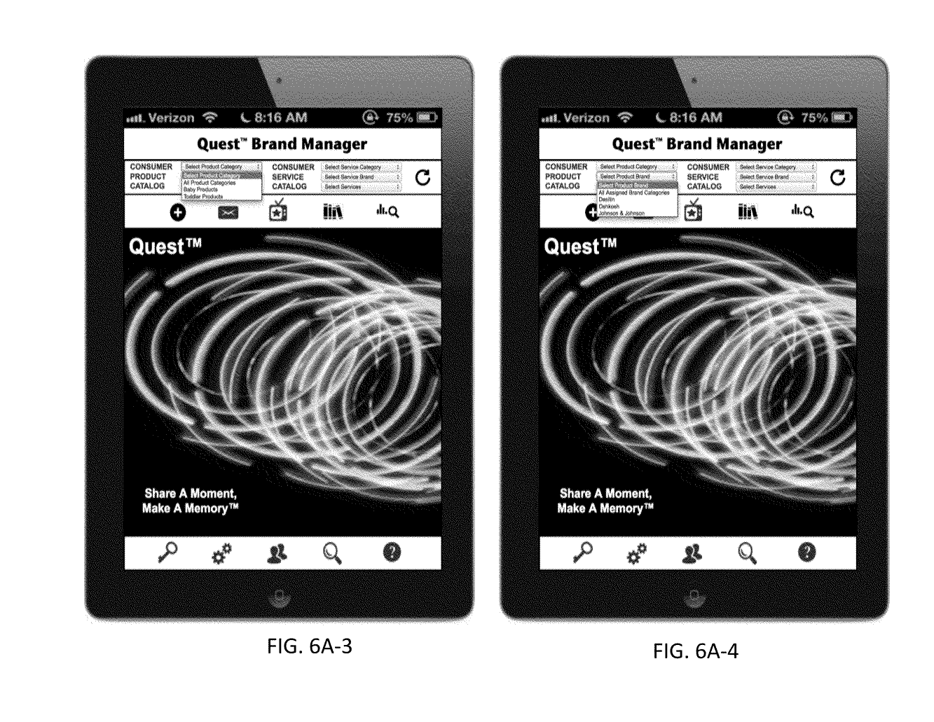

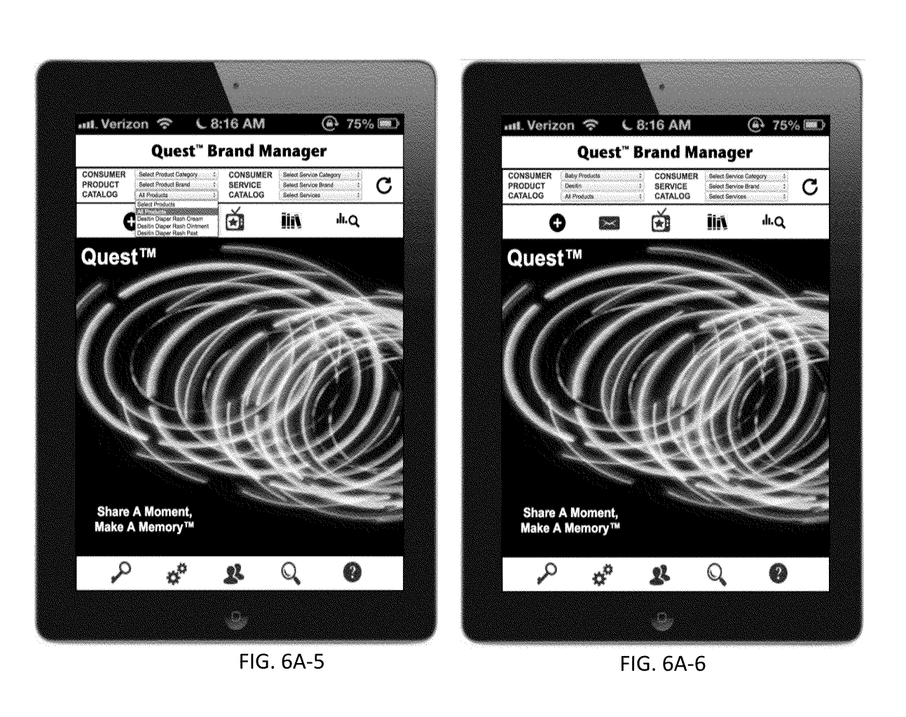

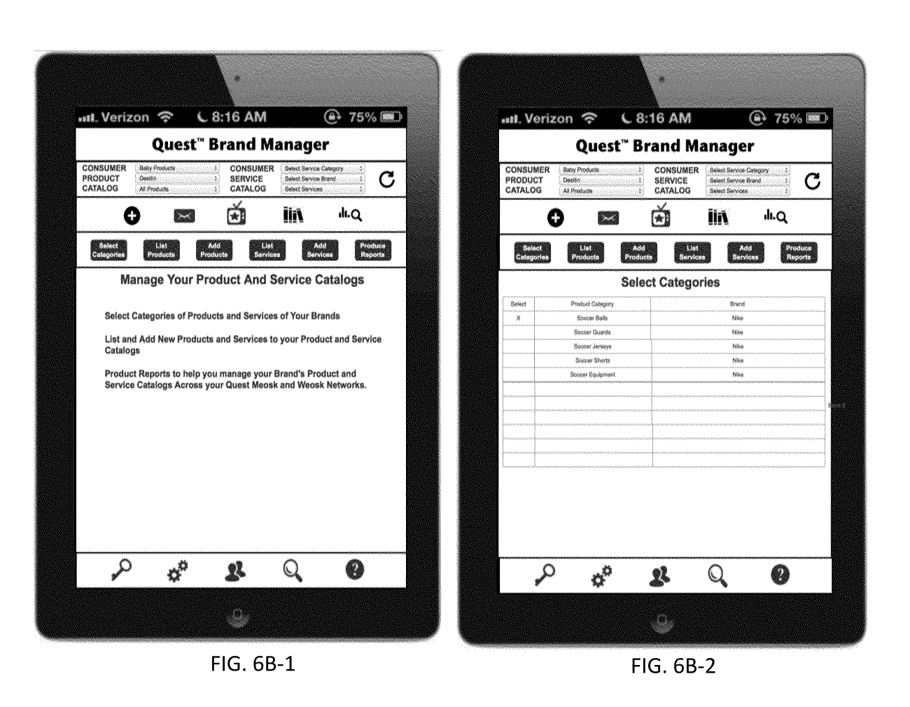

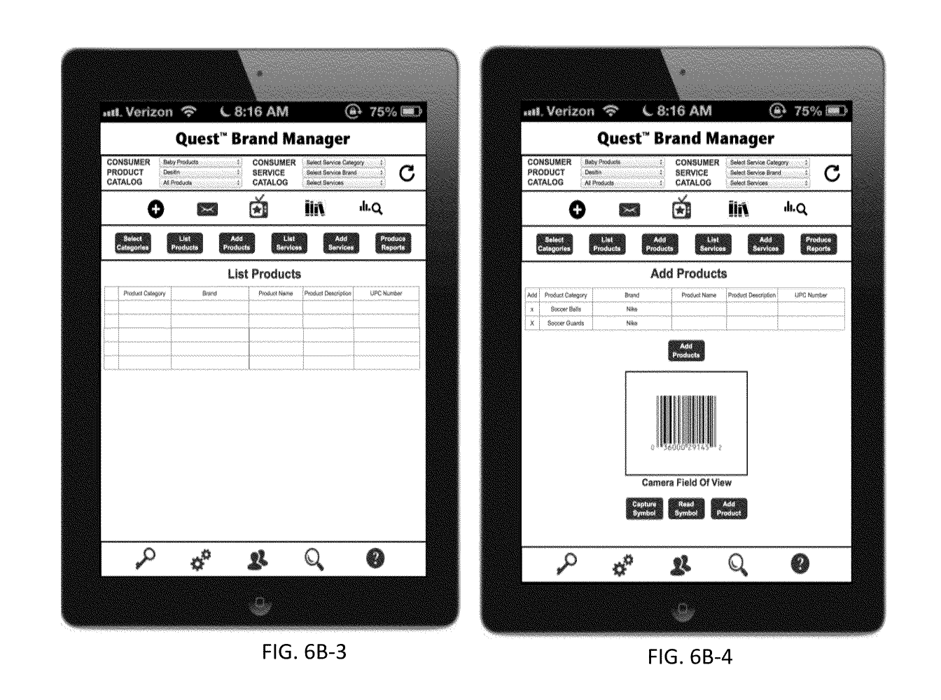

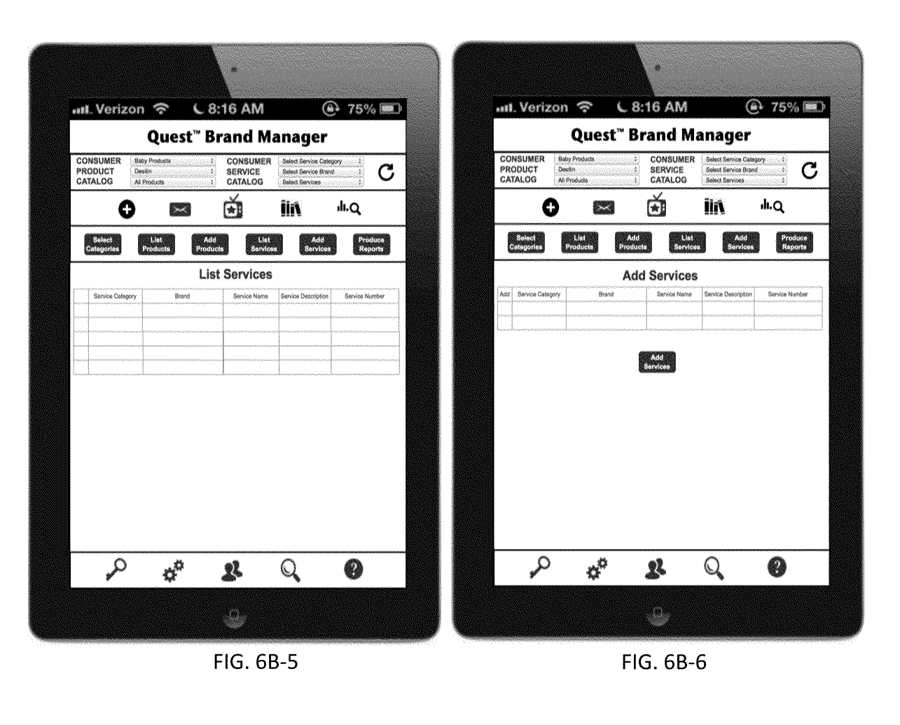

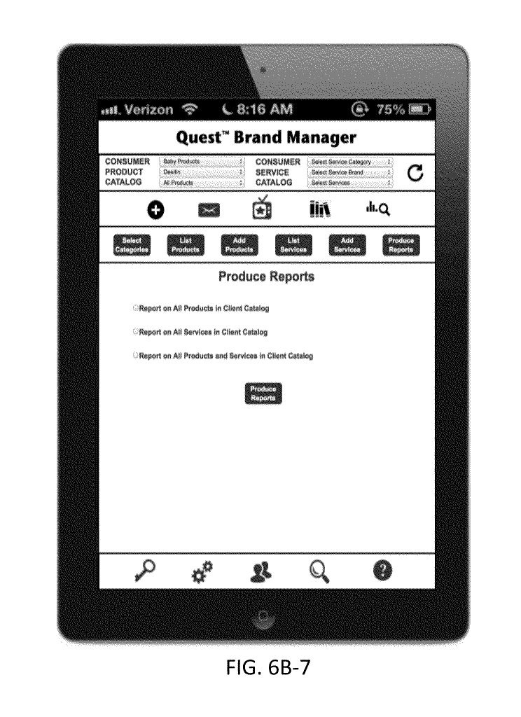

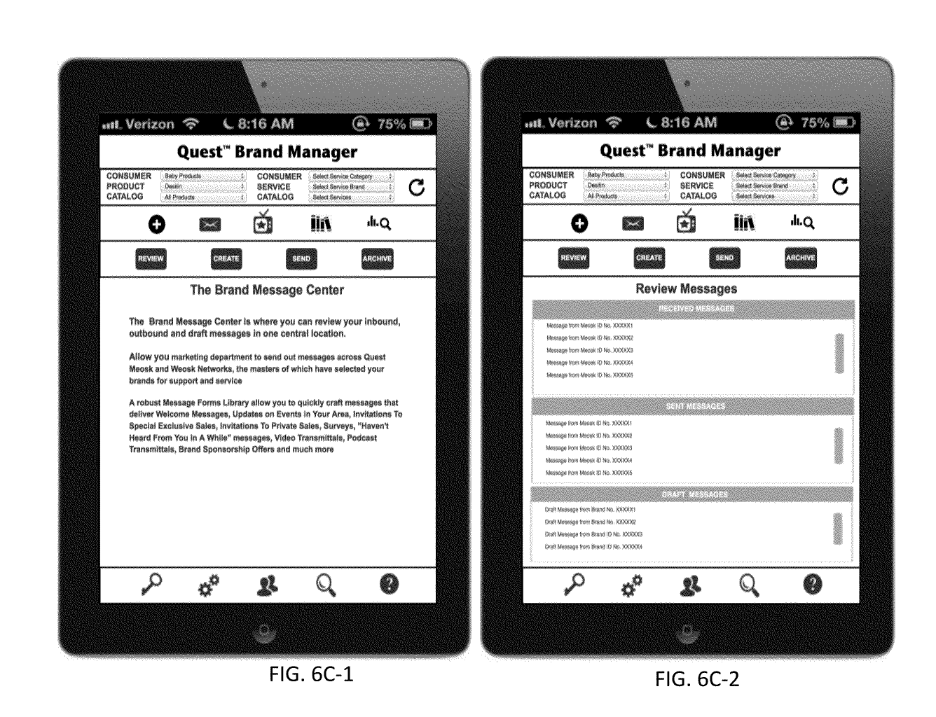

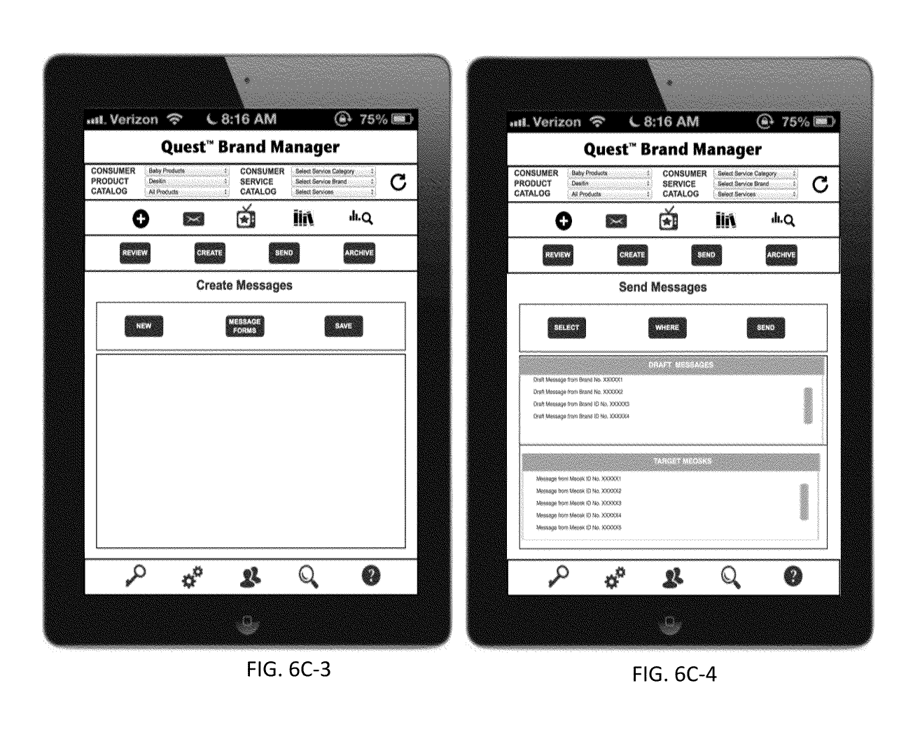

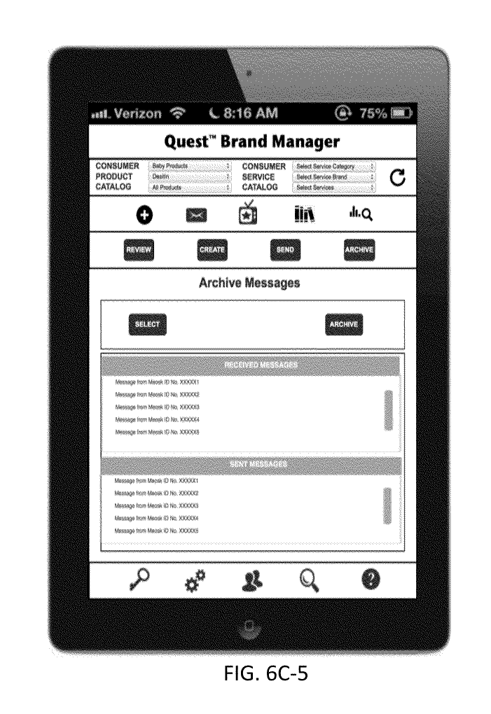

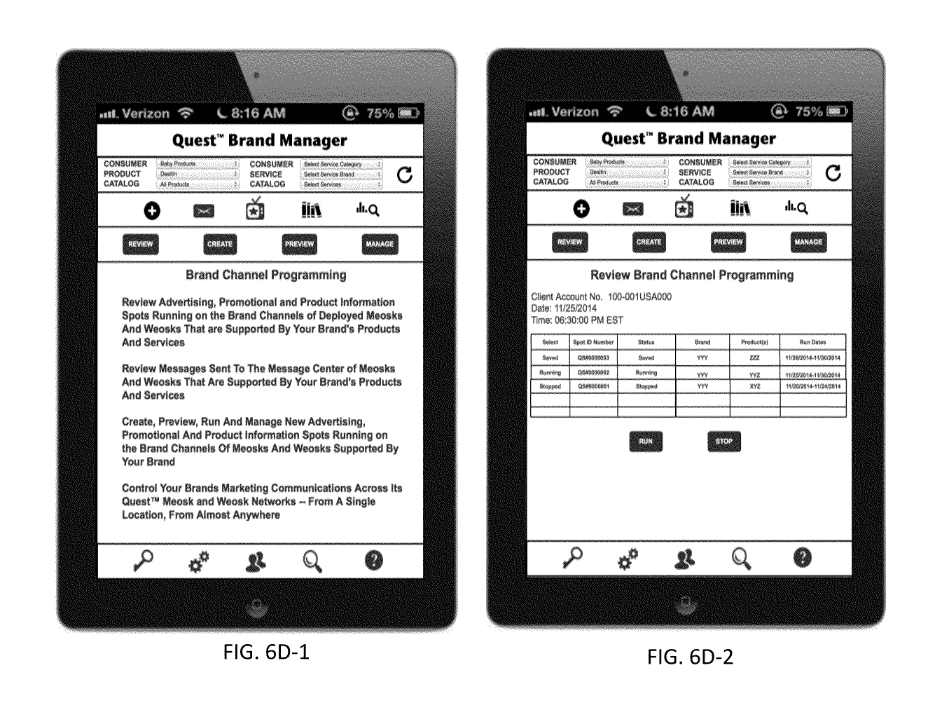

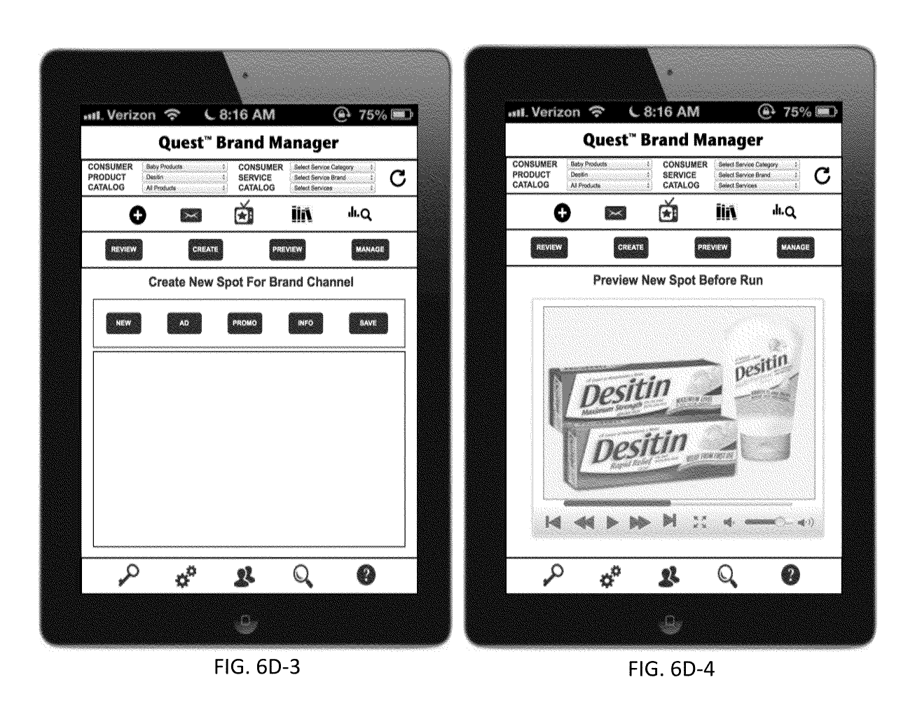

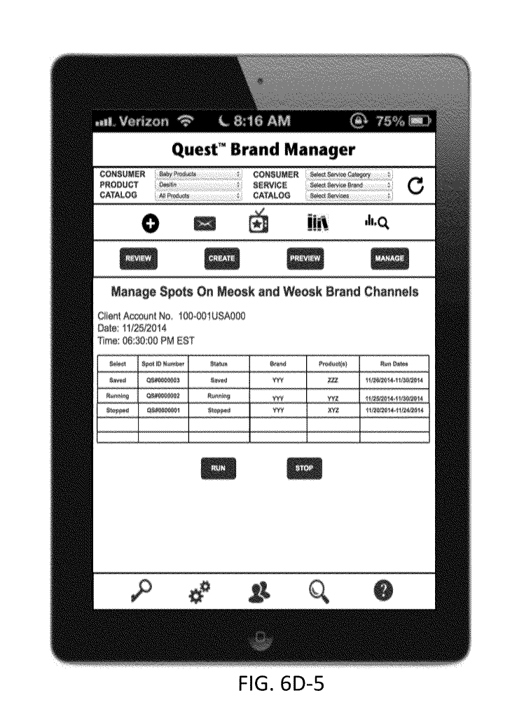

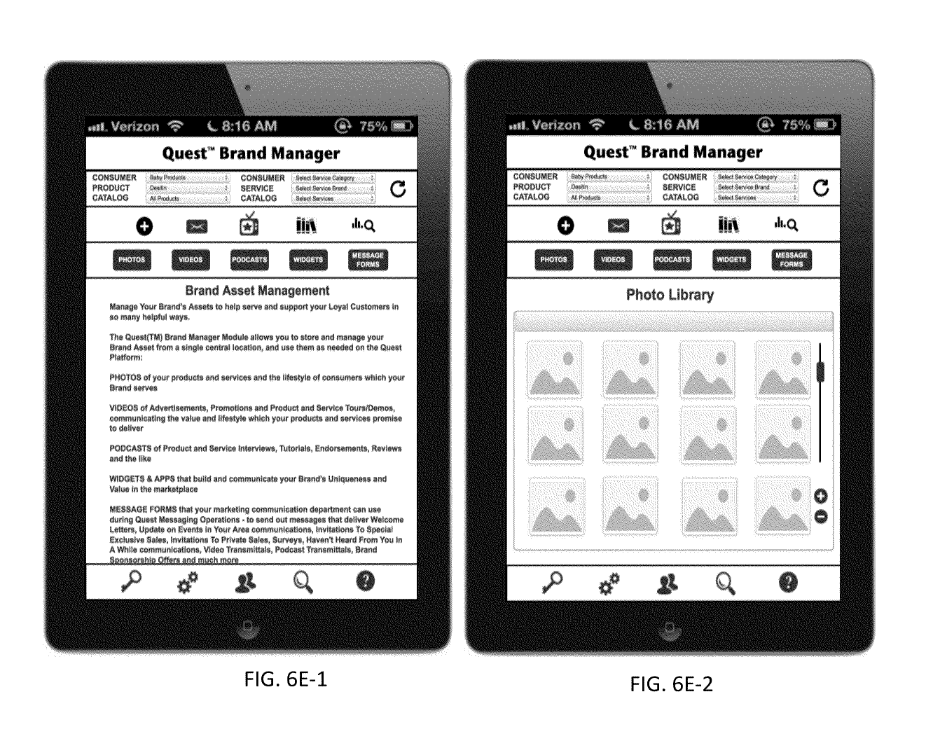

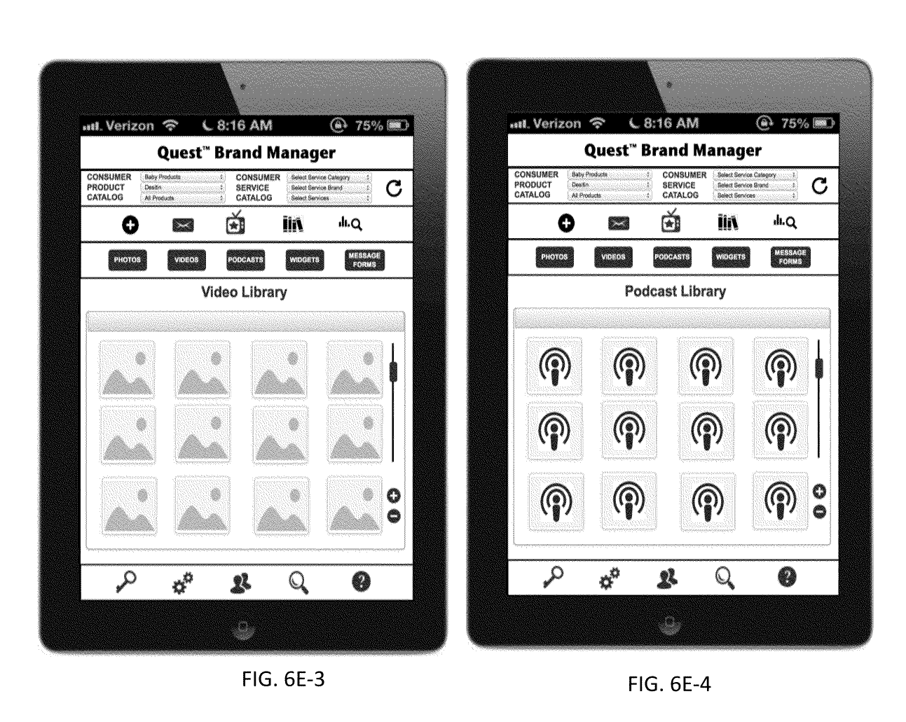

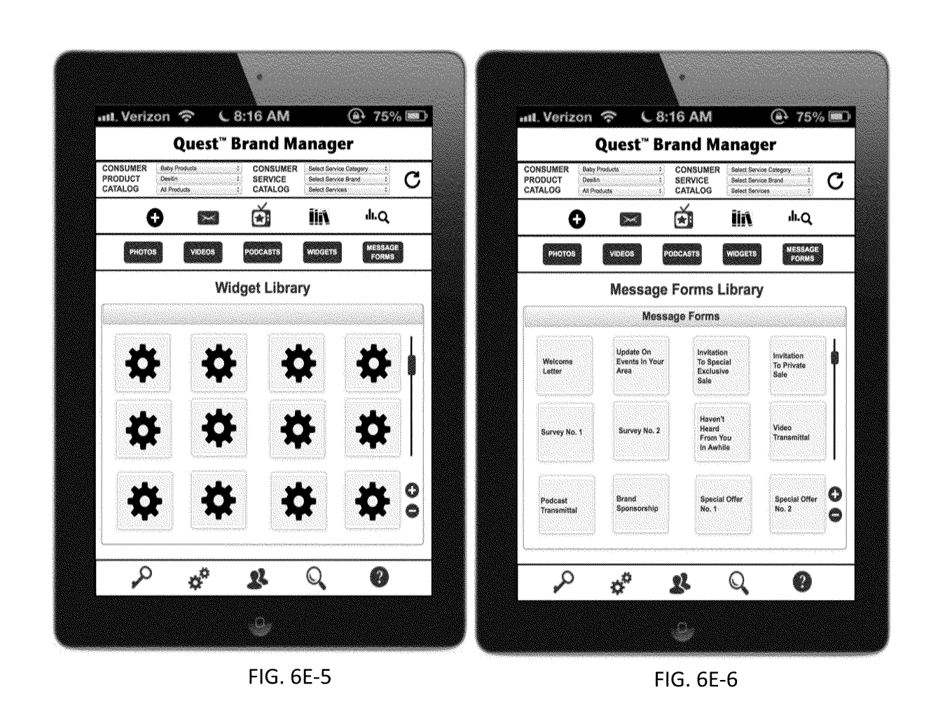

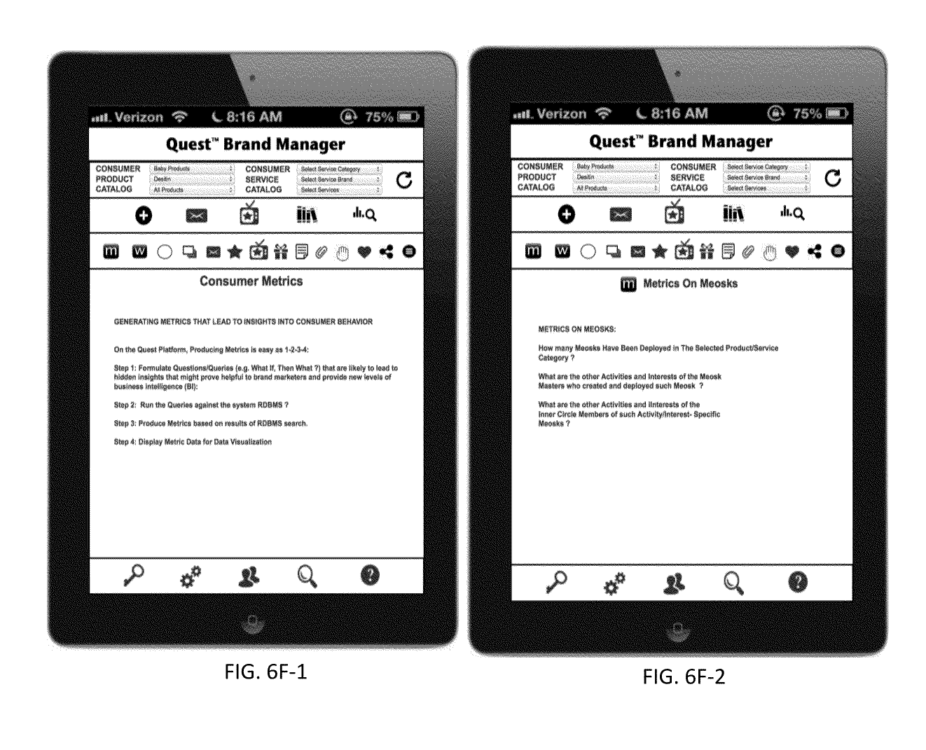

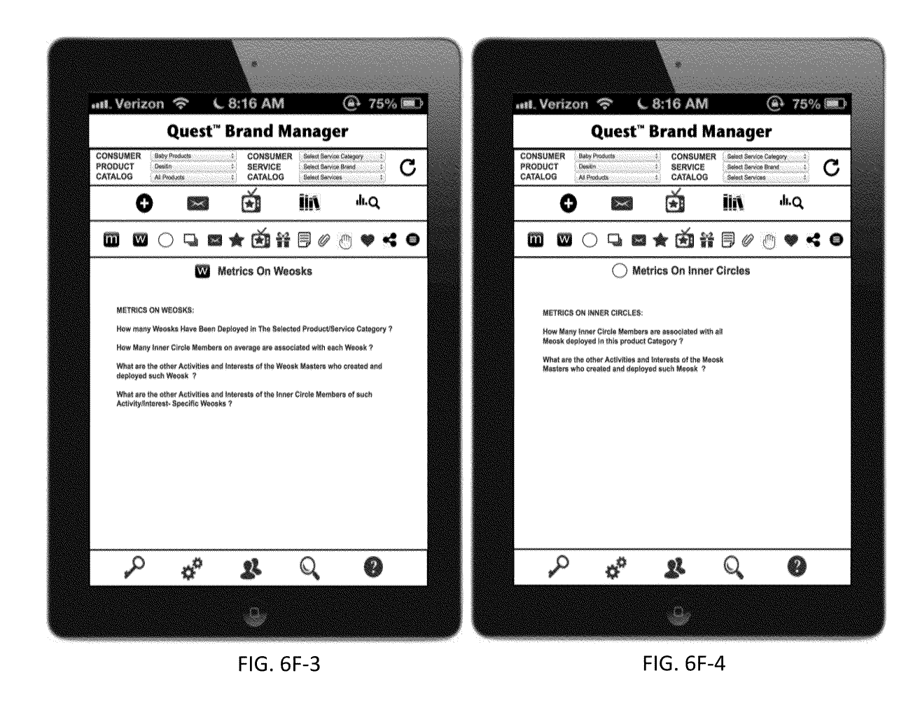

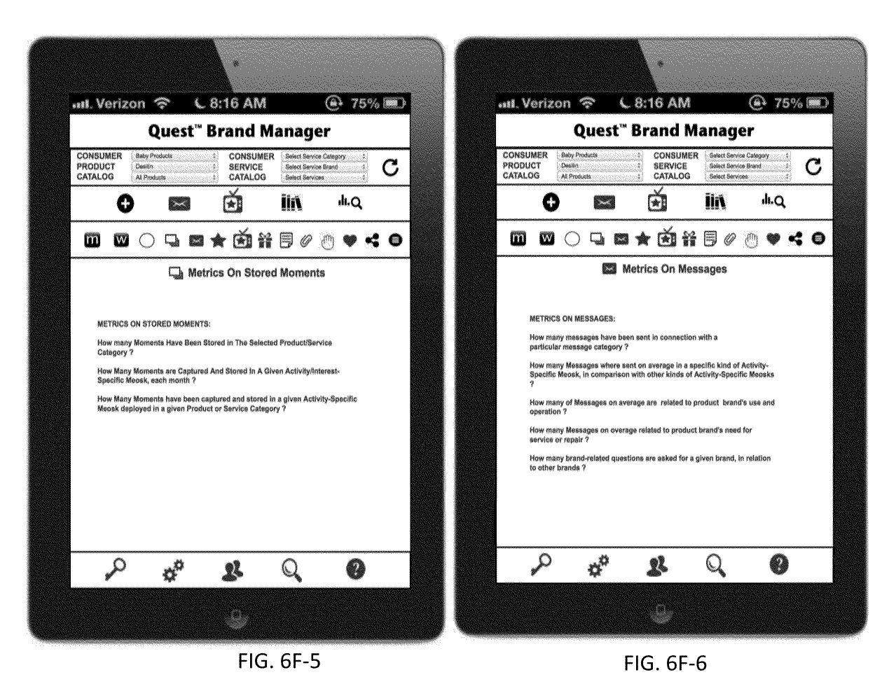

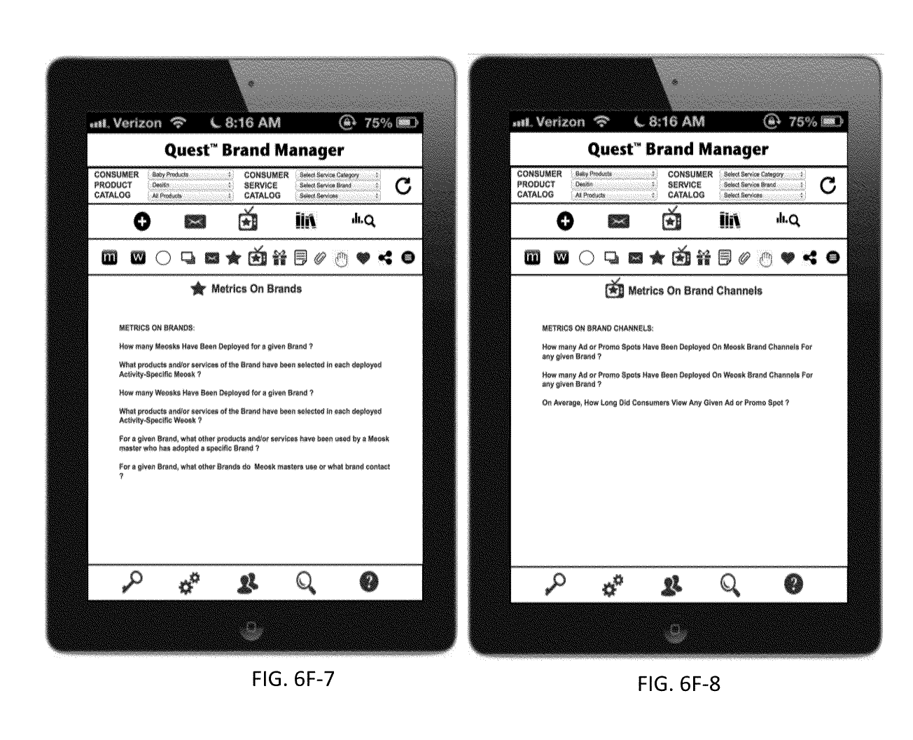

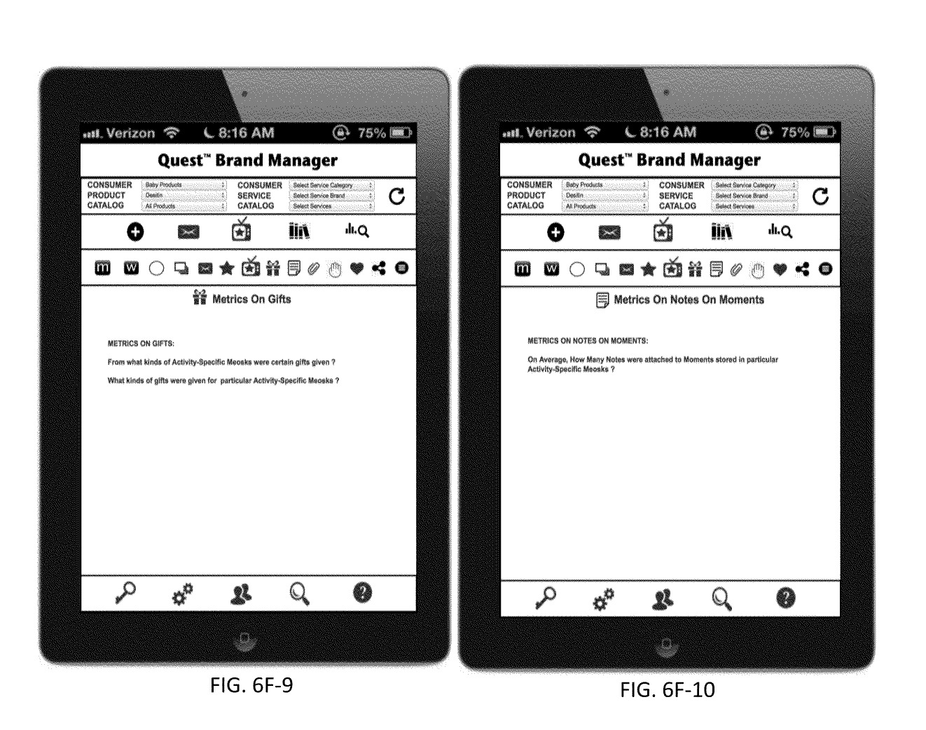

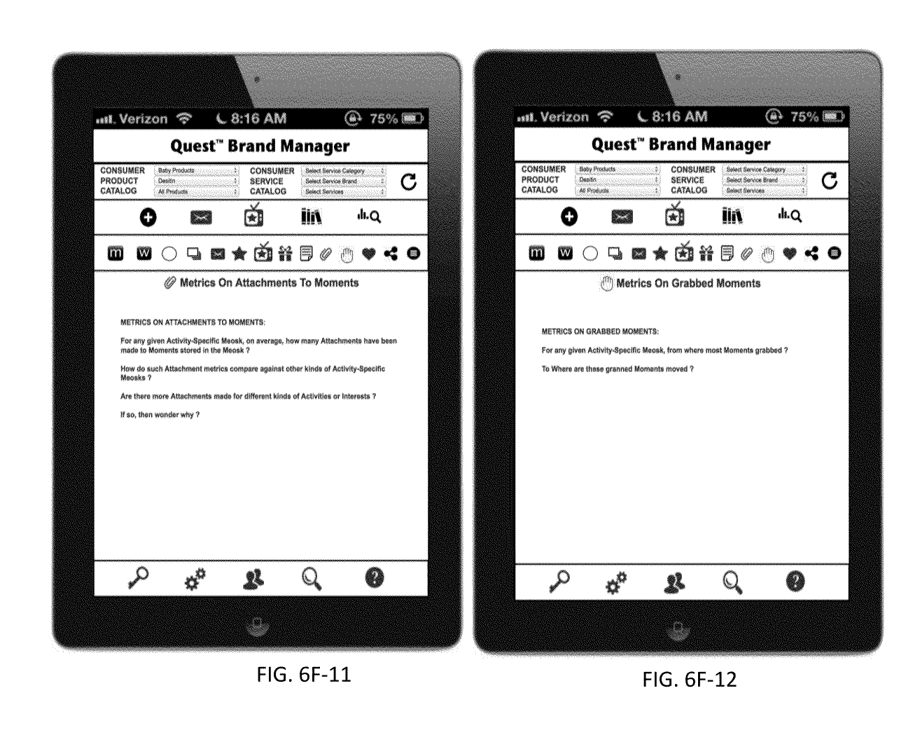

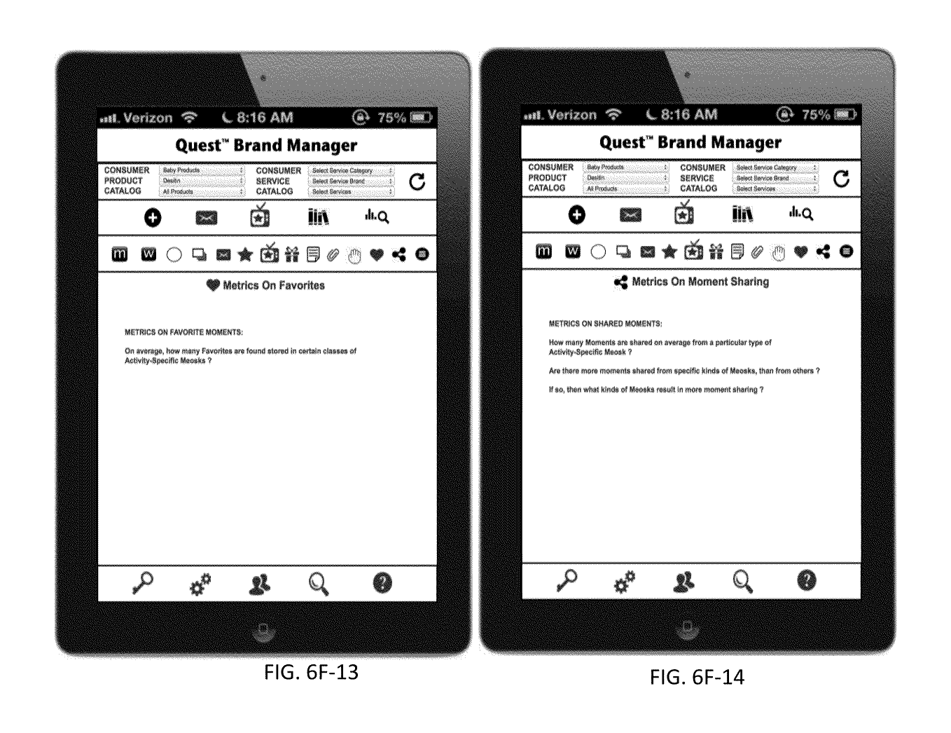

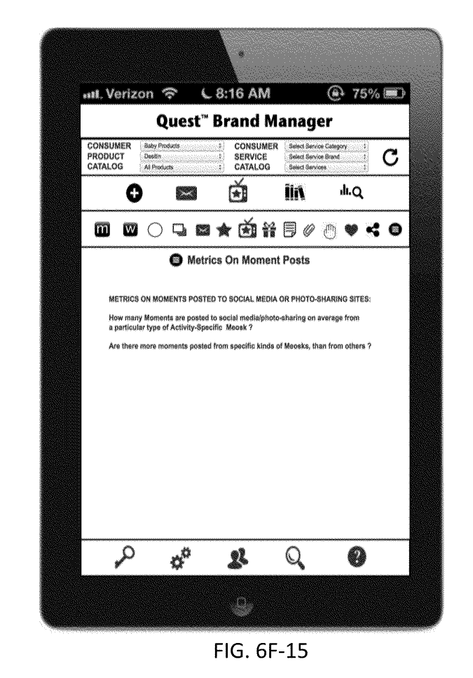

FIGS. 79A-1 through 79-A8 show a series of GUI screens supported by the web-browser implementation of the system network of the present invention, where any inner circle member of a meosk structure can use a mobile smart phone to (i) receive a request to view a shared moment via an SMS message using the smart phone's SMS client application as shown in FIG. 79A-1, (ii) then use the smart phone and its web browser to access and view the shared moment stored within its meosk structure on the system network of the present invention as shown in FIGS. 79A-1 and 79A-2, and “play back” (i.e. review) the moment and its associated notes, attachments, gift receipts, and other messages using the play-it function supported in the web-browser based client application as shown in FIGS. 79A-2 and 79A-3, and (iii) thereafter use the web browser application to add or contribute to the moment using any one or more of the eight core functions supported by the client-server based system network, as shown in FIG. 79A-4, including adding a note (e.g. voice, text and/or video message) to the moment as shown in FIG. 79A-5, and then reviewing the message as shown in FIGS. 79A-6 through 79A-8;

FIGS. 80A and 80B show a series of GUI screens supported by the my meosks module of the system network, where the user selects the “grab-it” function supported within each meosk structure deployed on the system network, and then selects from where to grab and copy a moment (e.g. my meosk structures, my social networks or my photo-sharing sites) and then store the copied moment(s) to a destination meosk;

FIG. 80C shows a GUI screen supported by the my weosk module of the system network, displaying the soccer team weosk created by a weosk master, and having an inner circle of members who are parents of the players, one of which is the child of the exemplary user who is the parent of Christopher, the subject of Christopher's FM Meosk illustrated in the illustrative embodiment;

FIG. 80D is a schematic representation of the inner circle of members having access to the weosk structure shown in FIG. 80C, including the soccer team coach, the parent of each player on the soccer team, and each player on the soccer team;

FIGS. 81A and 81B show a series of GUI screens supported by the my weosks module of the system network, where the weosk master user is shown selecting and reviewing the voice/text message created by the soccer team coach (i.e. Coach Smith) for a specific moment stored in the our album of the weosk structure;

FIG. 82 is a schematic representation comprising the cover GUI screen of the soccer team weosk shown in FIG. 80C, and the cover GUI screen of the personal soccer meosk created for one of the players, and illustrating the process, whereby an inner circle member of the weosk structure (e.g. a soccer team parent) selects and tags particular moments stored in the weosk structure to be automatically copied over into specific storage locations in the personal soccer meosk by programmably-controlled operation of the system network;

FIG. 83 is a schematic representation of the inner circle of family and friends having access to the meosk structure shown in FIG. 82, wherein each member has access to all the moments and linked messages, attachments, gift receipts and the like associated therewith, to help them build a robust memory around this moment (e.g. event) and others captured and stored moments in the life of the meosk subject;

FIG. 84 is a schematic representation illustrating how any inner circle member of a meosk structure deployed on the system network of the present invention can use a mobile smart phone or like device to send a captured moment(s) (e.g. photographs, sound recordings, videos, etc) to the moment storage bin (i.e. “Bin”) of a specific meosk master, in a user-transparent manner, by way of either (i) an SMS message sent to the meosk master's user-specific SMS number (assigned to the master by the system admin during user registration) using the SMS client application on the master's smart phone, or (ii) an email message sent to the meosk master's user-specific email number (assigned to the master by the system admin during user registration) using the email client application on the master's smart phone, so that after automated SMS/email message routing, handling and processing by the system network using the subsystem illustrated in FIGS. 2A. 2B, 2E and 2F, and upon arrival of the sent moment in the master's bin, a notification of a shared moment is transmitted to the message center of the master's system client application, and thereafter, the meosk master can access the bin and decide how to handle the received moment shared by the inner circle member (e.g. delete the moment or move it to one or more specific meosk storage locations);

FIGS. 85A-1 through 85A-4 and 85B1 through 85B-3 show a series of GUI screens displayed on the mobile smart phone of a user who uses the integrated camera aboard the mobile smart phone to capture a photograph, sound recording or video of a special moment and uses its SMS client application, shown in FIG. 85A-4, to send the captured moment(s) to a user-specific SMS number that is associated with a registered user and his/her mailbox hosted on the SMS gateway server supported by the system network, as illustrated in FIGS. 2E and 2F, so that the SMS gateway server can process the SMS message and retrieve the associated moment and transmit it to the bin of the client application of the intended registered user, as shown in FIG. 85B-1, and then the user can move the retrieved moment to a specified location in a particular meosk structure on the user's my meosk list, as shown in FIG. 85B-2, for eventual playback and review as illustrated in FIG. 85B-3;

FIGS. 86A-1 through 86A-3 and 86B-1 through 86B-3 show a series of GUI screens displayed on the mobile smart phone of a user who uses the camera roll (i.e. image store) of the integrated camera aboard the mobile smart phone to provide a photograph or video of a special moment and uses its email client application, shown in FIG. 86A-3, to send the captured moment(s) to a user-specific email number that is associated with a registered user and his/her mailbox hosted on the email server supported by the system network, as illustrated in FIGS. 2A and 2B, so that the email server can process the email message and retrieve the associated moment and transmit it to the bin of the client application of the intended registered user, as shown in FIG. 85B-1, and then the user can move the retrieved moment to a specified location in a particular meosk structure on the user's my meosk list, as shown in FIG. 86B-2, for eventual playback and review as illustrated in FIG. 86B-3;

FIG. 87 is a schematic representation illustrating how any inner circle member of a meosk structure deployed on the system network of the present invention can use a mobile smart phone or like device to send a captured moment(s) (e.g. photographs, sound recordings, videos, etc) to the moment storage bin (i.e. “Bin”) of any number of specific meosk masters, in a user-transparent manner, by way of either (i) an SMS message sent to the “general-delivery” SMS number (assigned to the system by the system admin) using the SMS client application on the master's smart phone, or (ii) an email message sent to the “general-delivery” email number (assigned to the system by the system admin) using the email client application on the master's smart phone, so that after automated SMS/email message routing, handling and processing by the system network using the subsystem illustrated in FIGS. 2C, 2D 2B, 2G, 2H, the user is automatically sent an SMS message, or email message, containing an embedded web-link (i.e. URL) pointing to a web page listing all master users of meosk structures, of which the user is an inner circle member, and requesting that the user decide and select the meosk masters to whom the attached moment(s) should be sent, and after sending the user a confirmation email message that the user's message/moment routing selections have been accepted and implemented, notifying each selected meosk master that a moment has been sent to their bin, for access and retrieval and subsequent deletion or movement to an appropriate meosk structure, using the system network of the present invention;

FIGS. 88A-1 through 88A-4 and 88B-1 through 88B-2 show a series of GUI screens illustrating how any inner circle member of a meosk structure deployed on the system network of the present invention can use a mobile smart phone or like device to send a captured moment(s) (e.g. photographs, sound recordings, videos, etc) to the moment storage bin (i.e. “Bin”) of any number of specific meosk masters, in a user-transparent manner, by way of an email message sent to the “general-delivery” email address (assigned to the system by the system admin) using the SMS client application on the master's smart phone, so that after automated email message routing, handling and processing by the system network using the subsystem illustrated in FIGS. 2C and 2D, the user is automatically sent an email message, as shown in FIG. 88A-2, containing an embedded web-link (i.e. URL) pointing to a web page displayed in the user's web browser, as shown in FIG. 88A-3, and listing all master users of meosk structures, of which the user is an inner circle member, and requesting that the user decide and select the meosk masters to whom the attached moment(s) should be sent, and after sending the user a confirmation email message that the user's message/moment routing selections have been accepted and implemented, as shown in FIG. 88A-4, notifying each selected meosk master that a moment has been sent to their bin, as shown in FIG. 88B-1, for access and retrieval and subsequent deletion or movement to an appropriate meosk structure, as shown in FIG. 88B-2, using the system network of the present invention;

FIGS. 89A-1 through 89A-4 and 89B-1 through 89B-2 show a series of GUI screens illustrating how any inner circle member of a meosk structure deployed on the system network of the present invention can use a mobile smart phone or like device to send a captured moment(s) (e.g. photographs, sound recordings, videos, etc) to the moment storage bin (i.e. “Bin”) of any number of specific meosk masters, in a user-transparent manner, by way of an SMS message sent to the “general-delivery” SMS number (assigned to the system by the system admin) using the SMS client application on the master's smart phone, so that after automated SMS message routing, handling and processing by the system network using the subsystem illustrated in FIGS. 2G and 2H, the user is automatically sent an SMS message, as shown in FIG. 88A-2, containing an embedded web-link (i.e. URL) pointing to a web page displayed in the user's web browser, as shown in FIG. 88A-3, and listing all master users of meosk structures, of which the user is an inner circle member, and requesting that the user decide and select the meosk masters to whom the attached moment(s) should be sent, and after sending the user a confirmation SMS message that the user's message/moment routing selections have been accepted and implemented, as shown in FIG. 89A-4, notifying each selected meosk master that a moment has been sent to their bin, as shown in FIG. 88B-1, for access and retrieval and subsequent deletion or movement to an appropriate meosk structure, as shown in FIG. 88B-2, using the system network of the present invention;

FIG. 90A shows a GUI screen supported by the home page module, and displaying the footer control panel, where the setting module is accessible by selecting its icon;

FIG. 90B shows a GUI screen supported by the settings module, and displaying the list of modules in which settings can be adjusted according to system user preference;

FIG. 90C-1 shows a GUI screen supported by the settings module, and displaying the trustee account transfer module being used by a master (system) user to select a particular trustee user account (e.g. Trustee User Account C for Beneficiary User C, i.e. the system user's child) so that the trustee system user can transfer this trustee user account back to its beneficiary who is now a system user and capable of managing this trustee user account, and its meosks and weosk structures, within the beneficiary's system user account, as the beneficiary believes appropriate on a going forward basis;

FIG. 90C-2 shows a GUI screen supported by the settings module, and displaying the trustee account transfer module being used by a master (system) user to select a particular trustee user account (e.g. Trustee User Account C for Beneficiary User C) so that the trustee system user can transfer this Trustee User Account back to its beneficiary who is now a system user and capable of managing this trustee user account, and its meosks and weosk structures, within the beneficiary's system user account, while the trustee system user retains copies of all meosks and weosks associated with the transferred trustee user account;

FIG. 90C-3 shows a GUI screen supported by the settings module, and displaying the trustee account transfer module being used by a master (system) user to select a particular trustee user account (e.g. Trustee User Account C for Beneficiary User C) so that the trustee system user can transfer this Trustee User Account back to its beneficiary who is now a system user and capable of managing this trustee user account, and its meosks and weosk structures, within the beneficiary's system user account, while the trustee system user (i) retains copies of all meosks and weosks associated with the transferred trustee user account, and (ii) is made a joint master user of the transferred user account, including all meosks and weosks contained therein, and new meosks and weosks which might be created and deployed after the trustee account transfer process on the system network of the present invention;

FIG. 90C-4 shows a GUI screen supported by the settings module, and displaying the trustee account transfer module being used by a master (system) user to select a another, different trustee user account (e.g. Trustee User Account D for Beneficiary User D) so that the trustee system user can transfer this Trustee User Account back to its beneficiary who is now a system user and capable of managing this trustee user account, and its meosks and weosk structures, within the beneficiary's system user account, while the trustee system user (i) retains copies of all meosks and weosks associated with the transferred trustee user account, and (ii) is made a joint master user of the transferred user account, including all meosks and weosks contained therein, and new meosks and weosks which might be created and deployed after the trustee account transfer process on the system network of the present invention;

FIG. 91A shows a GUI screen supported by the settings module with “the public view mode” enabled for meosks and weosks, and displaying the my meosk module, and the selected Christopher FM Meosk structure;

FIG. 91B shows a GUI screen supported by the settings module with the public view mode enabled for meosks and weosks, and displaying the my meosk module, and the selected Christopher FM Meosk structure, with the public view mode for the meosk structure selected from the footer control module, displaying selectable panels for each of the moment stores in the selected meosk structure for the purpose of allowing the meosk master to select certain, if not all, moments and related content in the meosk structure for the public view thereof to be published at a public URL after previewing and selecting the publish button on the GUI display screen;

FIG. 91C shows a GUI screen supported by the settings module with the public view mode enabled for meosks and weosks, and displaying the my meosk module, and the selected Christopher FM Meosk structure, displaying the selected “My Album” panel for the purpose of allowing the meosk master to select certain, if not all, moments stored therein, to be published in the public view of the meosk structure at the public URL after previewing and selecting the publish button on the GUI display screen;

FIG. 91D shows a GUI screen supported by the settings module with the public view mode enabled for meosks and weosks, and displaying the my meosk module, and the selected Christopher FM Meosk structure, displaying the same GUI screen shown in FIG. 91B for selecting of the “preview” mode of the my meosk module;

FIG. 91E shows a GUI screen supported by the settings module with the public view mode enabled for meosks and weosks, and displaying the my meosk module, and the previewing of the configured public view for the selected structure;

FIG. 91F shows a GUI screen supported by the settings module with the public view mode enabled for meosks and weosks, and displaying the my meosk module, and the selected Christopher FM Meosk structure, displaying the same GUI screen shown in FIG. 91B for selecting of the “publish” mode of the my meosk module;

FIGS. 92A through 92C, taken together, provide a flow chart describing the primary steps of the method of creating and deploying activity-specific meosk structures on the system network of the present invention, using the robust set of object-oriented program classes supported by the system network and identified in FIGS. 5A-1 through 55C-1, where the many objects comprising the object-oriented system of the present invention are instances of classes within the set of classes;

FIGS. 93A and 93B taken together, provide a flow chart describing the primary steps of the reverse-inquiry based method of brand contact request and communication supported by the system network of the present invention;

FIG. 94 is a flow chart describing the primary steps involved in carrying out the method of using the meosk-based private and social media management and communication system network of the present invention to produce journey books for sharing with others; and

FIG. 95 sets forth a flow chart describing the primary steps involved in carrying out the method of configuring and displaying a public view of an activity-specific meosk structure in accordance with the principles of the present invention.

### BRIEF DESCRIPTION OF THE PREFERRED EMBODIMENTS OF THE PRESENT INVENTION

Referring to the accompanying Drawings, like structures and elements shown throughout the figures thereof shall be indicated with like reference numerals.

Overview on the Nature of Personal Brands and their Intended Relationship with Consumer Product and Service Brands Offered in the Marketplace

Each individual person represents a “personal brand” of sorts, similar to a service type brand in that each individual serves others around them in diverse ways, but different by virtue of the fact that each individual is uniquely different and has many dimensions, aspects and facets of character and being. Also, this personal brand aspect of an individual is related to the individual's unique persona constituted by a composition of (i) a unique set of characteristics, qualities, standards, values, sense of self-worth, and self-identify, and (ii) a unique set of life experiences, and social behaviors and actions performed in society. This “individual persona” is experienced by others through social interaction, and can be understood as having both private persona and public persona components.

In general, the private persona of an individual is based on the individual's sense of self-worth, self-identity, self-knowledge, system of beliefs (ideology), world knowledge, and life experience, and represents the character of the individual, directed to the true nature of the individual and their quest for meaning and purpose in life. The public persona of an individual is based on what others think, believe and know about the individual person—and these are generally opinions based on the perceptions of others which, through conceptual processes, form the individual's reputation in the minds of others. Such perceptions and reputation ultimately influences social ranking and other aspects of social recognition—regardless of whether built upon truth or fiction, or some combination of both. How well one's public persona corresponds with its private persona can be thought of as integrity—doing what one believes is right, and doing what one says one should do (i.e. walking the talk). When understood in such terms, integrity is more about correspondence and standards of consistency between an individual's private and public persona, rather than about any particular quality of behavior.

In general, each individual person develops and projects a public persona for public view, while developing and maintaining his or her private persona but known fully only to the individual himself or herself. The private persona of an individual may or may not correspond highly to the projected public persona of the individual, and sometimes may greatly differ. This dichotomy between an individual's private persona and public persona should not be taken as the result of deceit or an intentional attempt at concealing something about the individual's inner character or life. Rather, in many instances, few care about learning or rather knowing everything there is to know about an individual's life to make full sense out if it, and this includes what the individual thinks on particular topics, what the individual is deeply interested in, what the individual is deeply passionate about, and what is actually occurring with respect to the many relationships associated with an individual's life. The fact is that most people are simply more concerned about what is going on in their own lives, than that of others, and this tendency should be viewed as natural and healthy, to the extent that these others are minding their own life and business.

While individuals are consuming particular product/service brands, they are also projecting aspects of their public persona to others around the world. The brand marketer go to great efforts to learn what their customers find interesting, are passionate about, and enjoy with great satisfaction in their lives. And often, such aspects of individual lives are discoverable because they are private persona aspects of their lives. Ideally, brand marketers would like to learn about, and support both private and personal aspects of their customers' lives if they could be discovered without compromising the privacy interests of their customers. The reason is clear: to the extent that product and service brands serve such interests, it can be expected that such brands will have customers to server for their lifetime.

Nevertheless, as brand marketers pursue their customers in effort to build up market share, the fact remains that most individuals will have many choices when deciding how to build and live their lives, and what aspects thereof to share with others over private and public channels extending through society. In the self-actualization spirit described eloquently in Miguel Cervantes's Don Quixote, The Man of La Mancha, most individuals will have the choice to know who they are, and who they can be, if they want to be. Thus, a primary object of the meosk/weosk-based private and social media management and communication system network system of the present invention is to supports individuals in their quest to pursue their interests and achieve their dreams, on their own terms to the extent possible, while capturing moments and building memories in the minds of family, friends and the public at large.

### Overview on Uses and Benefits of the Meosk/Weosk-Based Private and Social Media Management and Communication System Network of the Present Invention

The meosk/weosk-based private and social media management and communication system network system of the present invention 1 is designed to help individuals young and old in five (5) unique ways: (i) self-identify with interests and activities in which they are heavily invested; (ii) chronicle and pursue those interests and activities digitally across various stages of their lives; (iii) pledge allegiance to product/service brands they use in the pursuit of those core activities and interests; (iv) build relationships with these brands—anonymously and privately, if needed, and receive special treatment and support; and (v) show, tell, express, communicate, teach, sell and share with others, anywhere when the individual thinks it makes sense.

The system network of the present invention is also designed to help brand marketers in three (3) unique ways: (i) build relationships with requesting consumers and segment and target these brand loyal individuals; (ii) connect products/things created and/or used by individual consumers with the people (e.g. browsers, buyers and inquirers) who view such things/products, as potentially new customers of brands; and (iii) learn more about sponsored consumers and their interests and activities through interactive structures called “meosks” and “weosks” based on the features and functions which they exhibit when deployed and used on the system network. Great value will be provided to individual consumers by aligning activities and interests that they are heavily invested in and self-identify with the brands they trust.

When using the system network of the present invention, individual consumers can align their activities and interests with the brands they trust and use the most while engaging in those activities. Consumers who can use this system are very broad: for example, a mother who makes a scrap book for her infant child as she takes her first steps; a person who makes stuff/things and wants to share with friends and the world at large; a person who is interested in learning about how to create something new things using particular materials, in a specified amount of time; a teenage girl having interests in ballet, competitive swimming, and being a devoted fan of a British boy band; a teenage boy having interests in baseball, competitive skiing, and being a devoted fan of a brand of video; a high school student interested in science, math and technology (STEM) looking for a college to continue his/her education and pursue a career in this field; a male college student having interests in intramural ice hockey, mountain hiking, and being a devoted fan of an NFL football team or professional soccer team; a senior adult reflecting on their lifetime and the legacy they hope to someday leave behind; et al.

When using the meosk/weosk-based system network of the present invention, product/service brands can build 1-on-1 relationships with those who use their products and/or services, while involved in activities or pursuit of interests, with which they self-identify and in which they are heavily invested emotionally. A brand manager can get closer with customers and learn more about there interests and likes, and other interests that loyal consumers have and learn ways of acquiring new customers for the company's brand. An advertiser can learn more about the interests and activities of consumers of her client's brand so as to create more engaging and relevant advertisements for the brand. Brand managers will readily appreciate that losing a self-identified loyalist can have immeasurable ramifications that may not be recoverable within an acceptable time horizon or at an inappropriate cost. The system will enable brand managers and their team members (including outside agencies) to do things that have been heretofore not possible, by virtue of the reverse-inquiry brand contact and communication method of the present invention, namely: (i) send messages to requesting consumers, including discounts, fermiums, specials, and offers to become member of the Brand's street-social marketing team, and use its brand logos across social network communications; (ii) send digital assets to its requesting consumer for download into its meosk (and sharing in its public meosk views); and (iii) receive periodic metrics providing valuable information and insight into the brand-consumer relationship.

By design, the meosk/weosk-based system network of the present invention is designed to be readily integrated with conventional social networks, photo-sharing sites, e-commerce sites, custom-websites, and elsewhere along the fabric of the WWW, in various ways, to support the goals and objectives of the system of the present invention, and also to enhance to conventional social networks, photo-sharing sites, and other services offered across the WWW.

### Different Degrees of Administrative Control can be Granted Over the Creation and Deployment of Activity-Specific Meosk Structures and Weosks Supported on the System Network of the Present Invention, During the Various Stages of an Individual's Life-Cycle

As will be appreciated hereinafter, different degrees of administrative control can be granted over the creation and deployment of activity-specific meosks and weosks supported on the system network of the present invention, during the various stages of an individual's life-cycle.

On the system network of the present invention, a parent can open a “trust” type user account and create and deploy activity-specific meosk structures for an individual who has not yet been born, but who is alive and growing in a mother's womb. During this phase of an individual's lifetime, all kinds of information might be captured, collected and organized within the private activity-specific meosk structure, by the individual's parent(s) and grandparents.

During the individual's early childhood stage, the parent's and/or grandparents can also create and deploy, under the parent's or grandparent's system network “trustee” user account, activity-specific meosk structures for the individual child, organized around his or her interests and activities that are typically, but not always selected or decided by the individual's parents or grandparents. At some stage of individual development, preferably earlier the better, the individual should learn about and develop a sense of independence, and over time, and will develop a sense of self-identity and self-worth. During these early stages, it is expected that parental control (including grandparent control) will reign over and administer meosks and weosks for the individual child, created in the individual child's name, for the benefit of the individual child, and that the parents and/or grandparents serve as administrators (i.e. trustees) for the individual child. However, during pre-teenage stage of the individual's lifetime, or perhaps earlier, the individual can open their own user account on the system network, and copy over, all meosk modules (i.e. computer code and data) from the parent's trustee user account to the individual's user account, and thereafter begin maintaining these meosk modules on his or her own. In some instances, the parents, grandparents or guardians who have been acting as “meosk masters” (i.e. meosk administrators) can grant joint ownership and control to the beneficiaries of such meosk modules, and assist in mastering/administrating the meosk modules, as necessary and desired. A few, but not all individuals will require parental supervision/control when creating and deploying activity-specific meosks during this phase of the individual's life.

During the teenage stage of the individual's lifetime, the individual will most likely wish to and maybe insist upon controlling the administration of the individual's system user account on the system network, and not involve parental supervision, although this will depend on the individual user and his or her parents/grandparents/guardians.

During the adult stage of the individual's lifetime, as a general rule, the individual will control the administration of the individual's system user account, and therefore define and discover his or her own interests and activities that give a sense of purpose and enjoyment, and hopefully paving the way for the individual to leave his or her legacy upon the world.

During the elderly stage, when adults retire and may begin to reflect on their lives and their legacy in their family, community and world, it may be advantageous to assign shared administrative rights to their children and/or grandchildren who may be able or rather interested in helping their parents/grandparents compose first moments (FM), activity-specific, and also lifetime meosk structures on the system network of the present invention. Such shared meosk administration control supported on the system network will allow families to work together to develop and record biographies and life stories about their parents as a legacy for their family, and its history. Preferably, the individual about whom a biography is being written, is alive and well and able to contribute to such works. However, the system network can be used in such cases where the subject is not well and incapable of participating in the legacy building process on the system network.

The above-described methods of individual and shared administration will be supported during the registration process, and also during subsequent account administration management processes supported on the system network for each system user.

Identifying Different Classes of Activities and Interests for Individuals During the Different Phases of their Lifetime

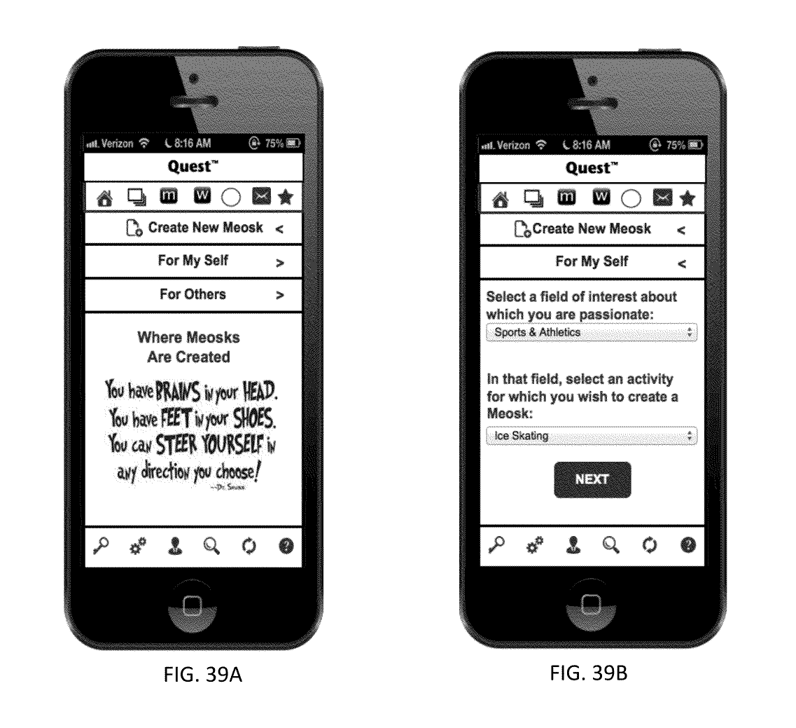

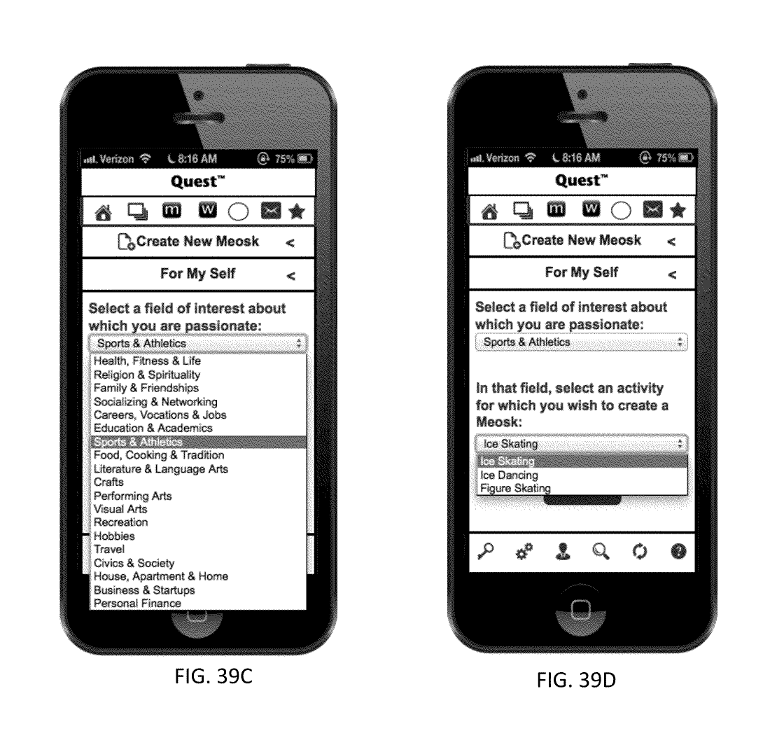

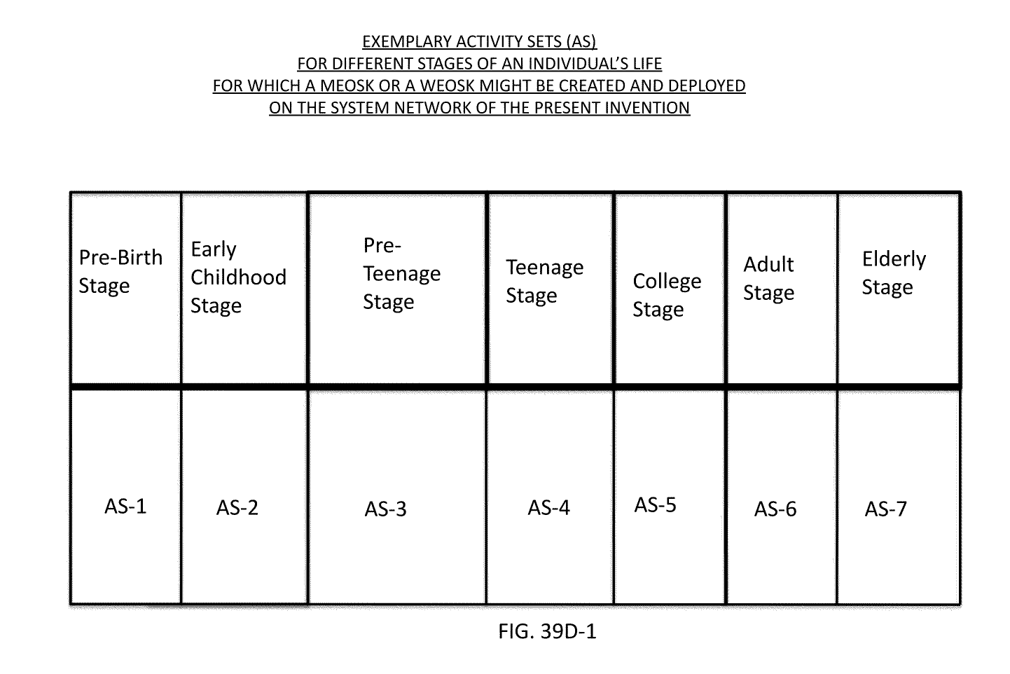

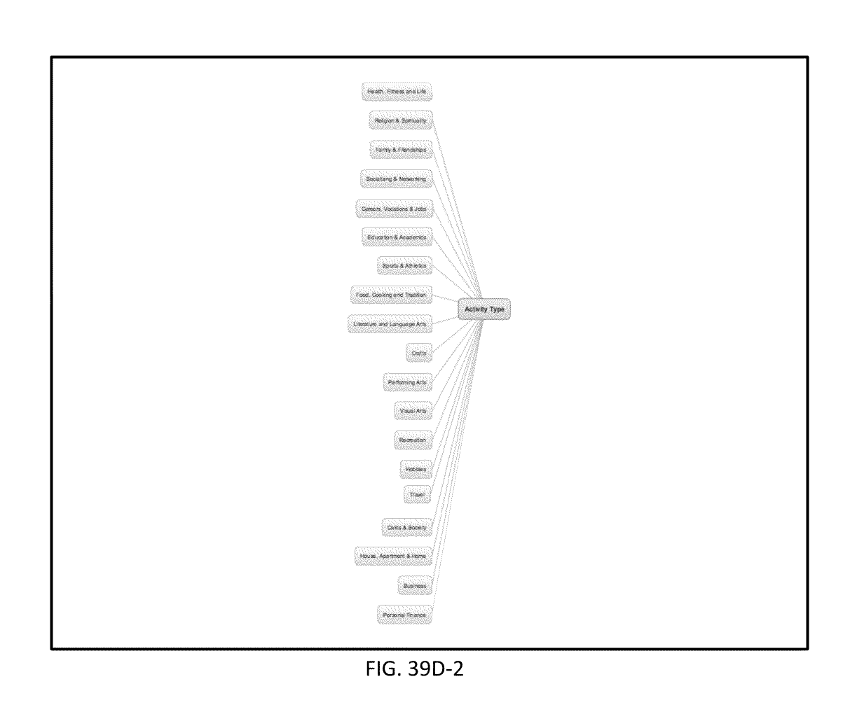

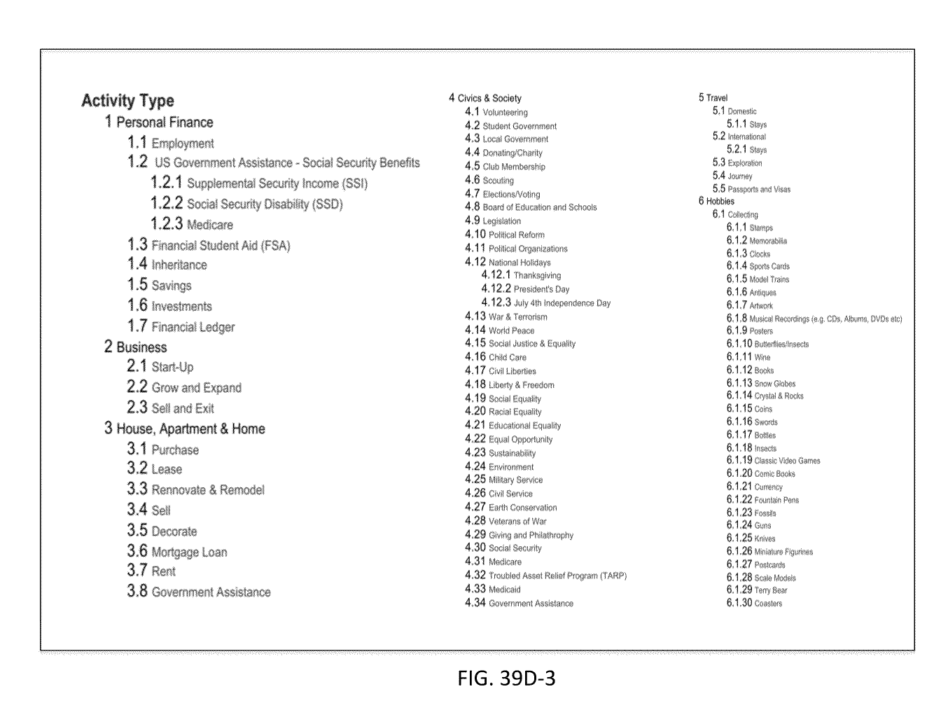

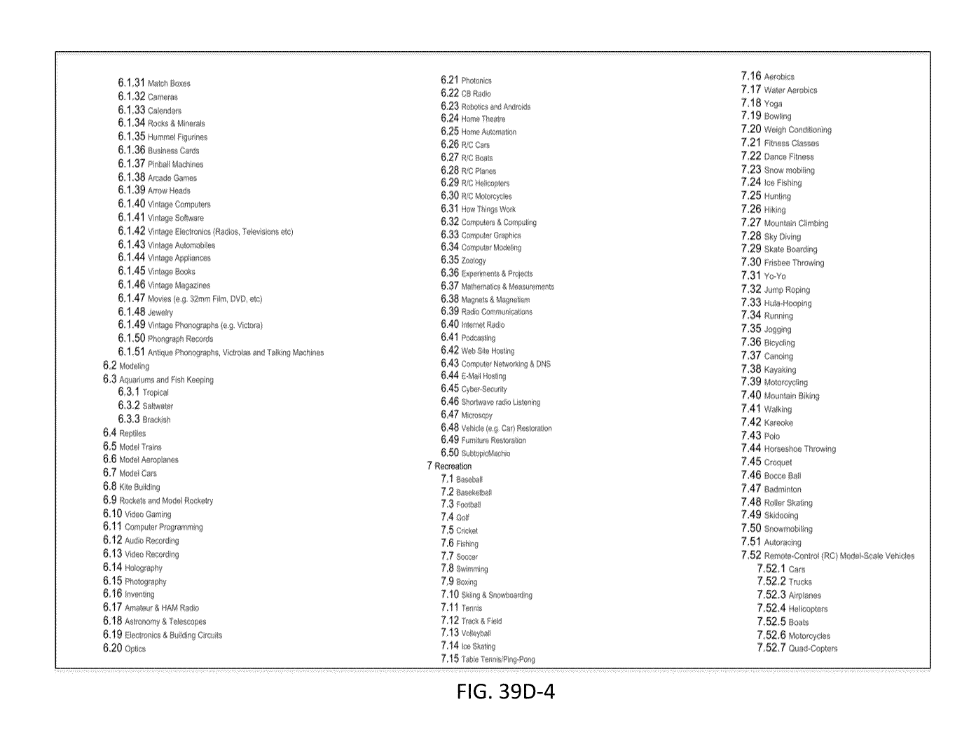

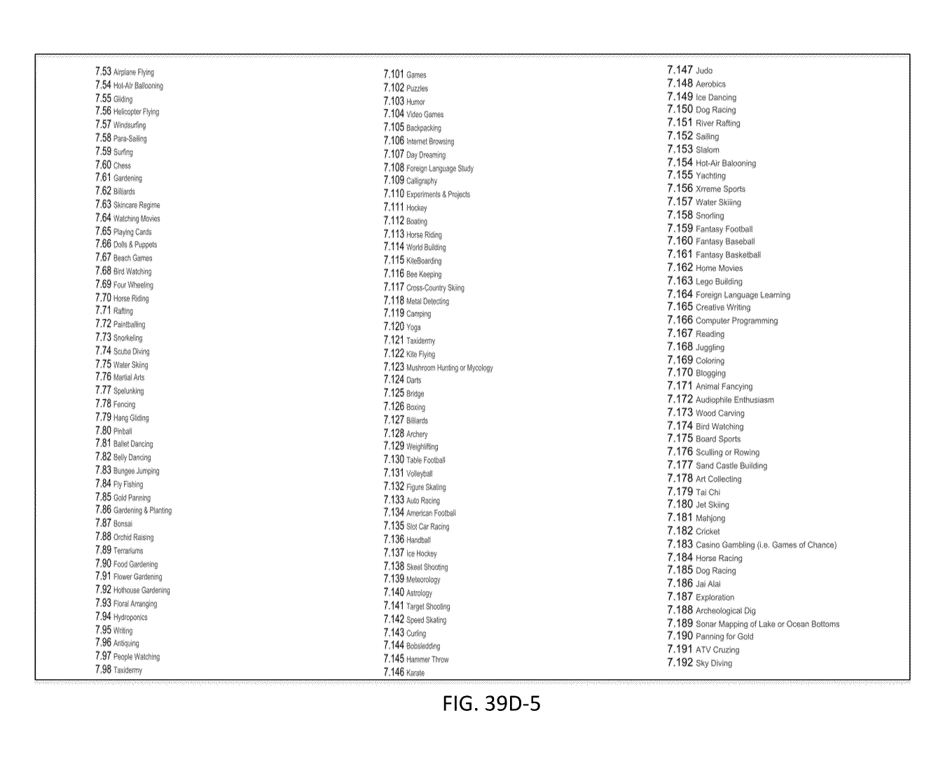

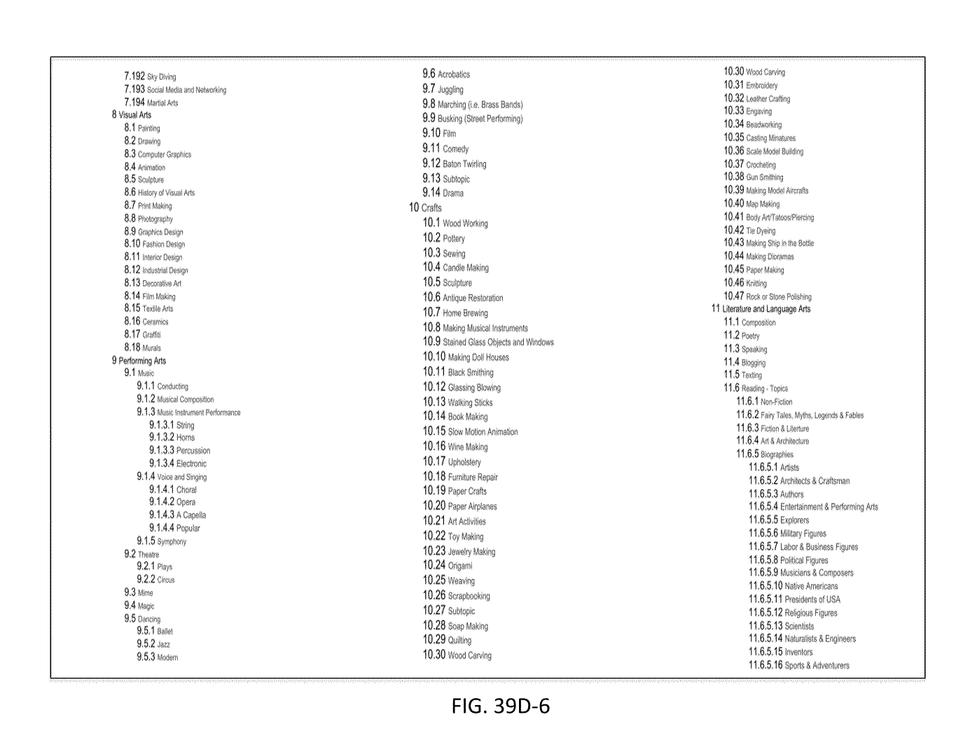

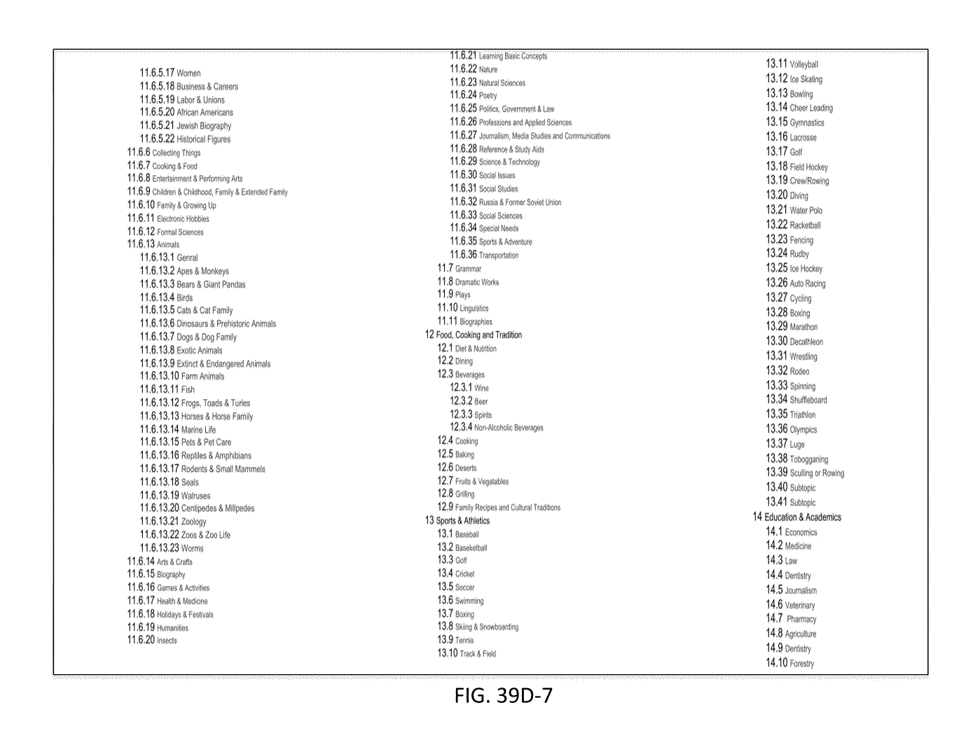

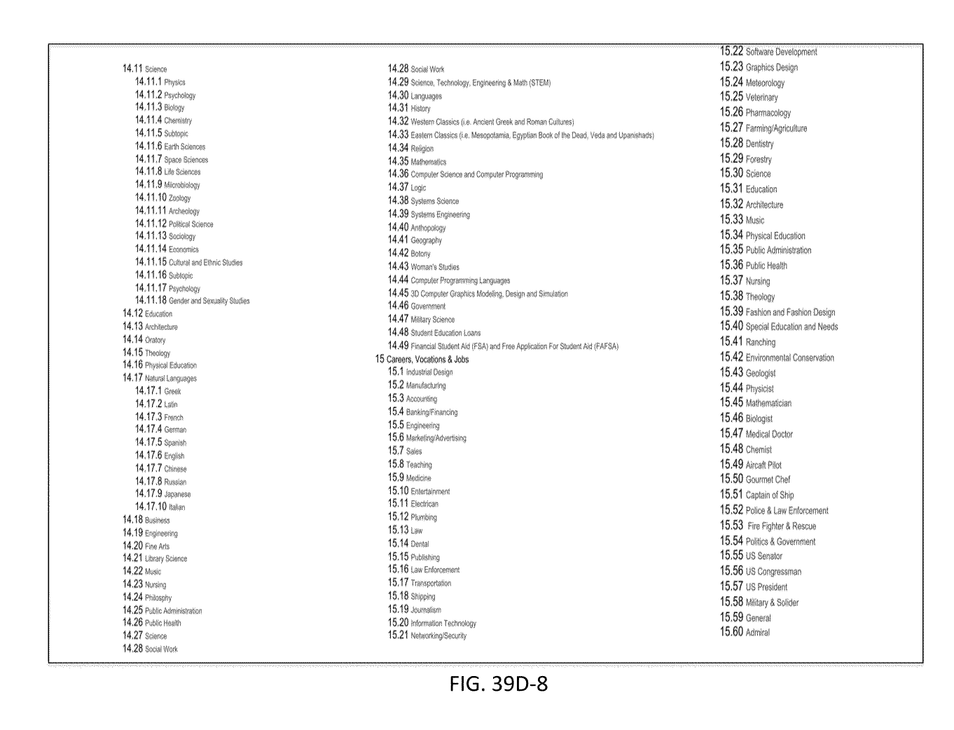

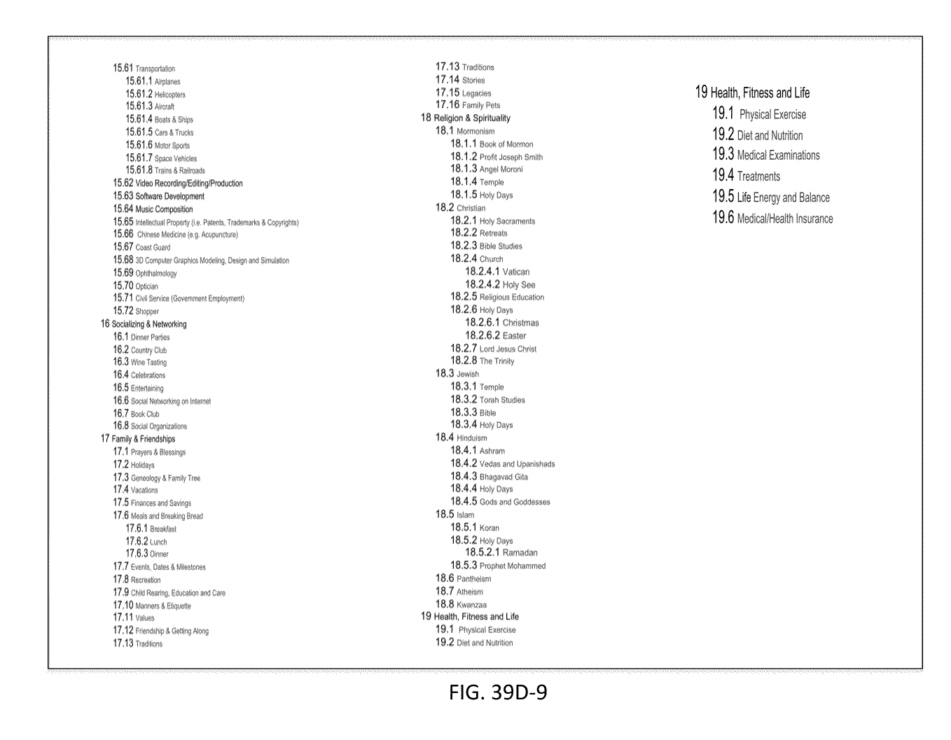

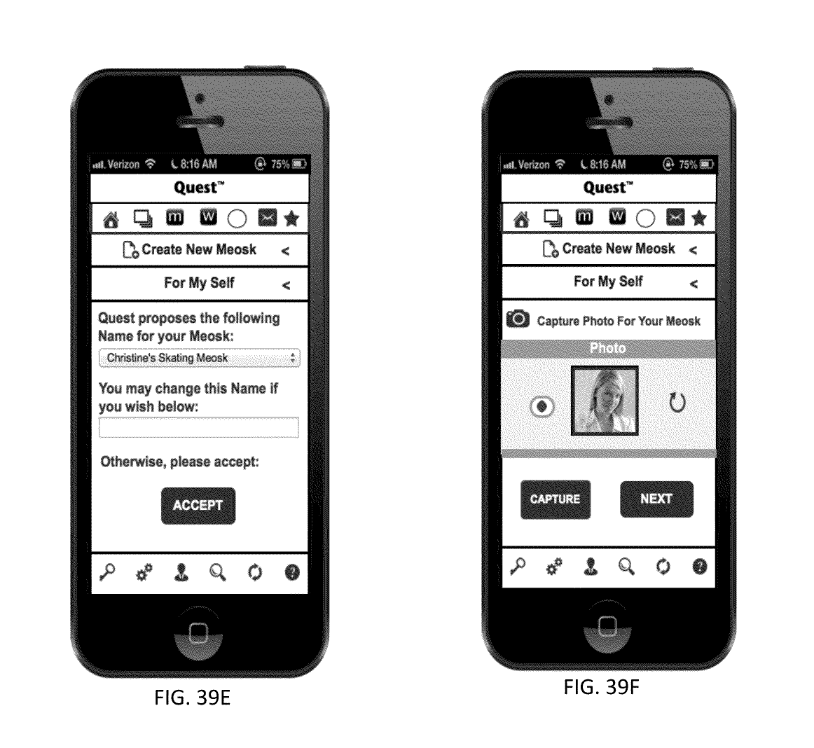

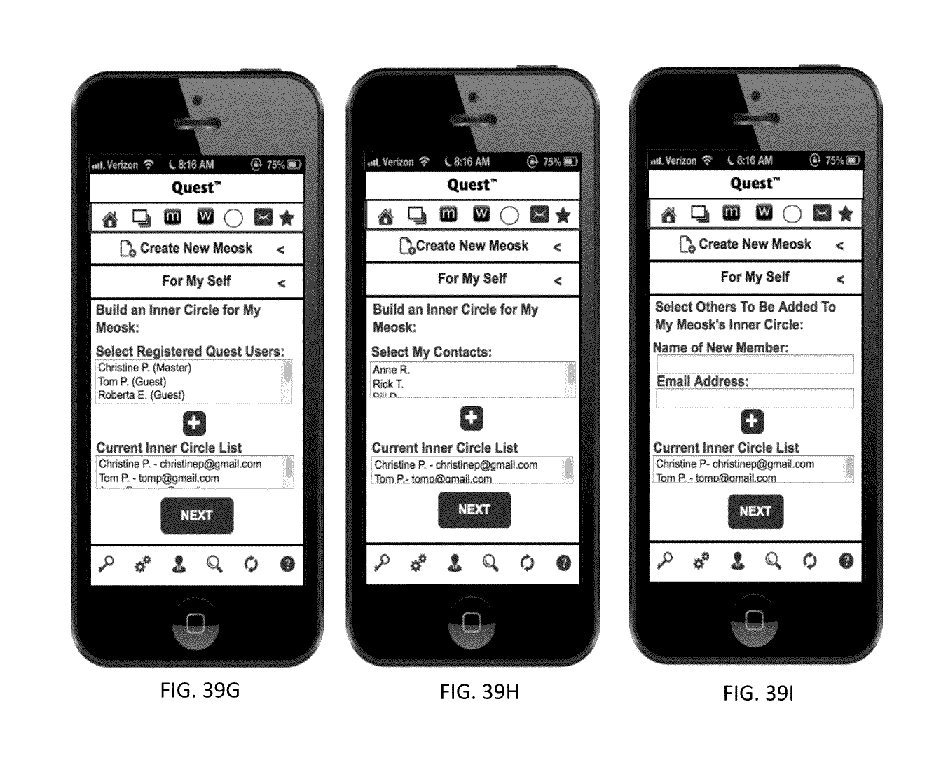

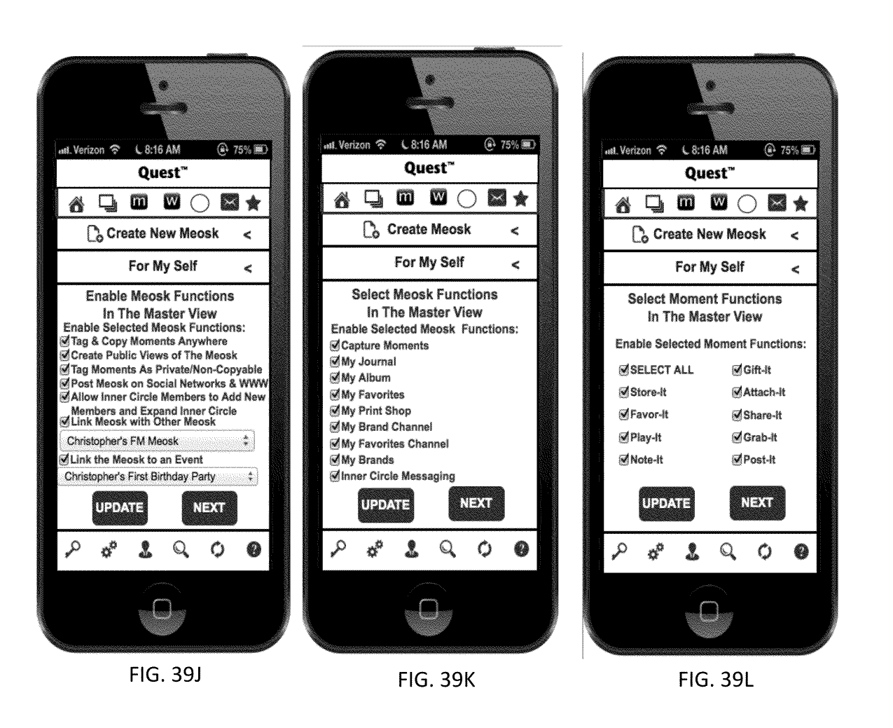

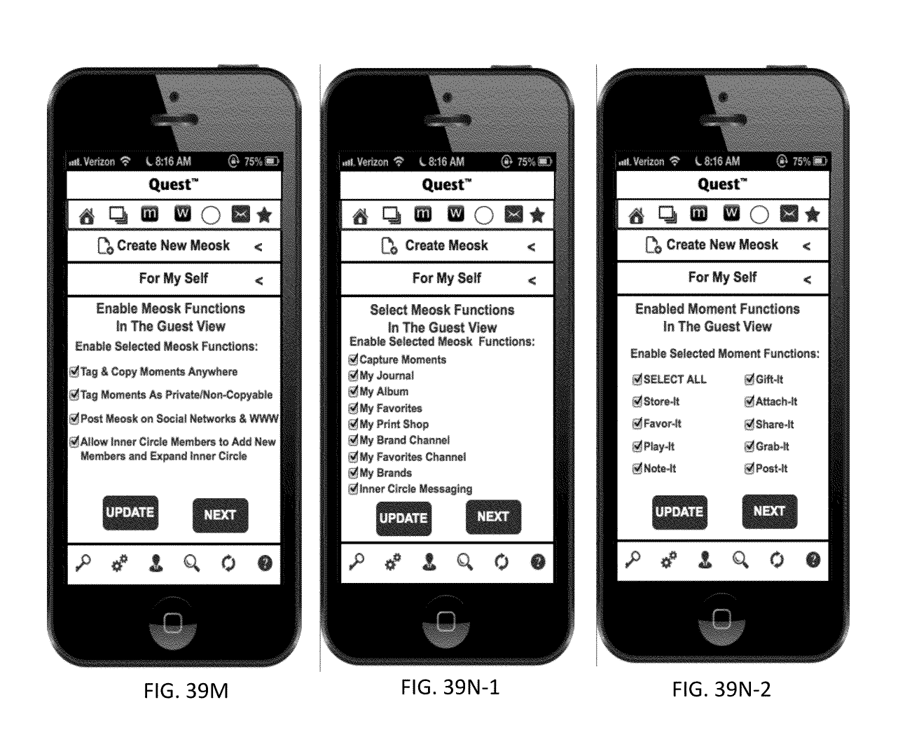

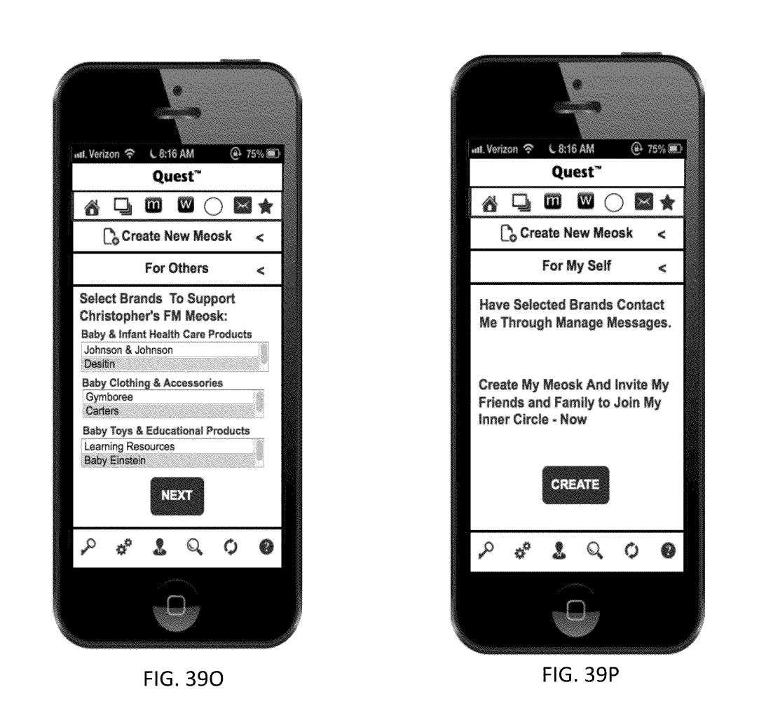

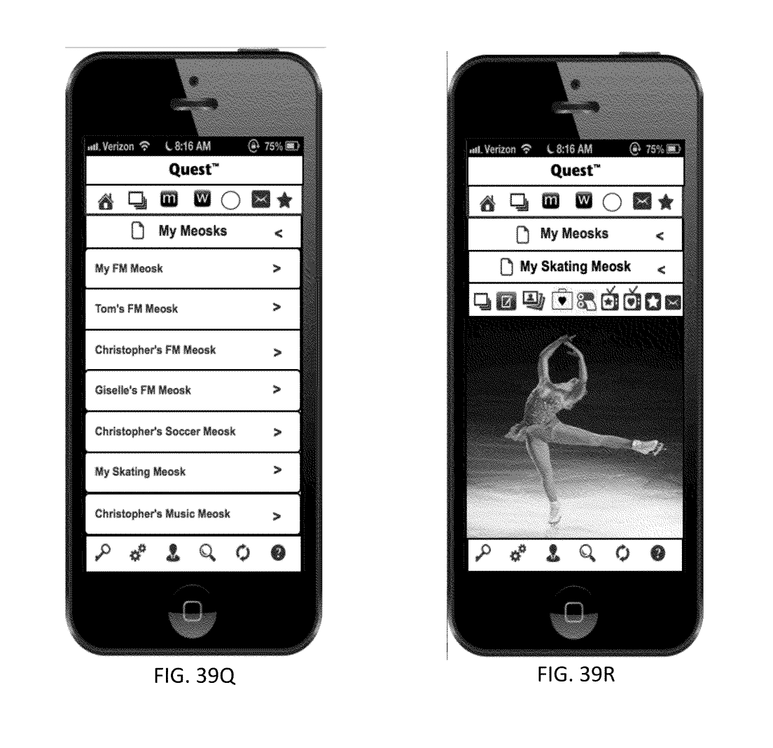

FIGS. 39D-1 identifies different phases of an individual's lifetime, and with each such phase, different exemplary classes of activities and interests denoted by “activity sets (AS)” which any individual might choose to pursue. In this schematic representation, is understood that interests and activities will overlap among the phases of any particular individual's lifetime. Typically these activities lists or activity sets (AS) will be culturally and geographically defined around the world, and will be drawn from the categories of activities and interests set forth below, which are merely exemplary and in no way are intended to limit the scope of such activities and interests. On the system network of the present invention, each activity (or interest) is pre-assigned an unique activity code (AC) within the RDBMS 5 of the system network. Also, each Activity Set (AS) that any individual might be maintaining within their collection or library of activity-specific meosk structures, during any phase or phases of their lifetime, will comprise a set of activities each having it own activity code (AC).

For example, the activity set for Pre-Birth Stage (AS-1) might include: New Baby; New Experiences—Going To The Doctor; Emotions & Feelings; etc.

The activity set (AS) for Early Childhood Stage (AS-2) might include: Fairy Tales, Myths & Fables; Individual Fairy Tales; Family & Growing Up; Bedtime, Dreams & Sleep; Poetry—Rhymes, Nursery Rhymes & Finger Plays; Fiction—Children's Classics; Toys, Dolls & Puppets; New Experiences—Starting School; Toilet Training; Christian Holidays—Christmas; Christian Holidays—Easter, Christmas; Soccer; Swimming; Trains & Railroads; Singing;

The activity sets for the other stages of an individual life can be constructed by selecting any set of activities from the exemplary classes of activities and interests, taking into the consideration the appropriateness of the activities for the given age range and gender of the individual for whom an activity-specific meosk structure is being created and deployed on the system network.

### Exemplary Classes of Activities and Interests

Animals: Animal Habitats; Animals; Apes & Monkeys; Bears & Giant Pandas; Birds; Cats & Cat Family; Dinosaurs & Prehistoric Animals; Dogs & Dog Family; Exotic Animals; Extinct & Endangered Animals; Farm Animals; Fish; Frogs, Toads & Turtles; Horses & Horse Family; Marine Life; Pets & Pet Care; Reptiles & Amphibians; Rodents & Small Mammals; Seals, Walruses; Worms, Centipedes & Millipedes; Zoology; Zoos & Zoo Life.

### Art & Architecture; Architecture, Buildings & Construction; Art History & Movements; Art Techniques & Activities; Artists; Clothes & Fashion; Painting; Photography; Sculpture.

Arts & Crafts; Art Techniques & Activities; Crafts & Hobbies; Making Things Blacksmithing; Making Dollhouses; Knife-Making; Making Dioramas; Making Telescopes; Making Musical Instruments; Home Brewing; Woodworking; Pottery; Candles; Sculpture; Radio Controlled Cars And Planes; Cooking; Film Making; Go Karts; Stained Glass Objects And Windows; Shadow Boxes; Doll Making; Sewing; Restoring Antiques; Book Making; Walking Sticks; Stop Motion Animation; Glass Blowing.
Biography; African Americans—Biography; Artists, Architects & Craftsmen—Biography; Authors—Biography; Entertainment & Performing Arts—Biography; Explorers—Biography; Historical Figures—Biography; Jewish Biography; Labor & Business Figures—Biography; Military Figures—Biography; Musicians & Composers—Biography; Native Americans—Biography; Political Figures—Biography; Presidents Of The U.S.A.—Biography; Regional Biography; Religious Figures—Biography; Scientists,

### Naturalists & Engineers—Biography; Sports & Adventurers—Biography; Women—Biography; Business & Careers; Careers; Labor & Union.

Collecting Things; Coins; Stamps; Memorabilia; Clocks; Sports Cards; Model Trains; Antiques; Artwork; Musical works like CD's or Albums; Posters; Butterflies/Insects; Wine; Books; Snow Globes; Swords; Movies; Bottles; Insects; Bottles and Cans; Classic Video Games; Comic Books; Crystals and Rocks; Currency; Fountain Pens; Fossils; Guns; Knives; Miniature Figures; Postcards; Scale Models; Terry Bear; Toys; Coasters; matchboxes; Cameras; Calendars; Rocks & Minerals; Hummel Figurines; Business Cards; Pinball Machines; Arcade Games; Arrow Heads.

### Cooking & Food; Baking & Desserts; Cooking; Food & Beverage Industry; Food & Drink; Food Habits; Fruits & Vegetables.

### Entertainment & Performing Arts; Circus; Dance; Drama & Plays; Film; Magic; Music Performing Arts—General & Miscellaneous; Singing; Dancing; Playing a Musical Instrument.

### Fairy Tales, Myths & Fables; Arthur & Camelot—Myths & Legends; Fairy Tales & Folklore; Individual Fairy Tales; Legends, Myths & Fables.

### Family & Growing Up; Bedtime, Dreams & Sleep; Boys & Men; Brothers & Sisters.

Children & Childhood; Extended Family; Family—General & Miscellaneous; Girls & Women; Growing Up & Aging; House & Home; Marriage & Divorce; New Baby; New Experiences—Going To The Doctor/Dentist/Hospital; New Experiences—Starting School; Parents; Self-Help; Toilet Training
Fiction & Literature; Fiction—Adventure, Adventurers & Heroes; Fiction—African; Fiction—African American; Fiction—Animals; Fiction—Anthologies & Collections Fiction—Basic Concepts; Fiction—Children's Classics; Fiction—Clothes & Fashion; Fiction—Comic Books & Graphic Novels; Fiction—Early Readers; Fiction—Emotions & Behaviors; Fiction—Entertainment & The Arts; Fiction—Family Life; Fiction—Fantasy & Magic; Fiction—Favorite Characters; Fiction—Food; Fiction—Games & Activities; Fiction—General & Miscellaneous; Fiction—Health & Medicine; Fiction—Historical Fiction; Fiction—Historical People; Fiction—Holidays & Festivals; Fiction—Horror, Monsters & Ghosts; Fiction—Movie/TV Tie-In; Fiction—Mysteries & Thrillers; Fiction—Native Americans; Fiction—Nature; Fiction—Occupations; Fiction—People With Special Needs; Fiction—People, Places & Cultures; Fiction—Religion & Beliefs; Fiction—Schools & Friendship; Fiction—Science Fiction; Fiction—Social Issues; Fiction—Sports & Recreation; Fiction—Transportation & Travel; Literature—Criticism & History.

### Electronic Hobbies; Amateur And HAM Radio; CB Radio; Building Circuits; Robotics; Home Theatre; Home Automation; R/C Cars; R/C Boats; R/C Planes; R/C Helicopters

### Formal Sciences; Computer Sciences; Logic; Mathematics; Statistics; Systems Science

Games & Activities; Crafts & Hobbies; Humor; Magic; Paper Crafts/Paper Airplanes; Parties; Puzzles; Toys, Dolls & Puppets; Travel; Travel—North America; Travel Games; Beach Games; Music; Dance; Watching Movies; Video Games; Internet Browsing; Art Activities; Knitting; Painting; Indoor Gardening; Reading; Table Tennis; Writing; Craft Making; Watching TV; Badminton; Cooking; Playing Cards; Chess; Skincare Regime; Aerobics; Bowling; Billiards; Daydreaming; Hiking; Rock Climbing; Nature Walking; Mountain Climbing; Bird Watching; Four Wheeling; Baseball/Softball; Rafting/Canoeing; Butterfly Collecting And Watching; Bug Collecting Backpacking; Bouldering; Gardening; Organic Gardening; Fishing; Geo-Caching; Ghost-Hunting; Horse Riding; Paintballing; Snorkeling; Scuba Diving; Skiing; Surfing; Skateboarding; Martial Arts; Spelunking; Skydiving; Fencing; Golfing; Hang Gliding; Hot Air Ballooning; Tombstone Rubbing Sailing; Table Tennis; Pinball; Ballet Dancing; Belly Dancing; Bungee Jumping; Fly Fishing; Gold Panning; Gardening And Plants; Bonsai; Orchid Raising; Terrariums; Food Gardening; Flower Gardening; Hothouse Gardening; Floral Arranging; Hydroponics; Writing; Antiquing; People Watching; Taxidermy; Fly Tying (For Fly Fishing); Making Walking Sticks.
Arts & Crafts; Scrapbooking; Pottery; Candle Making; Painting And Drawing; Sculpture; Origami; Jewelry Making; Leather Crafting; Glass Blowing; Weaving; Soap Making; Quilting; Sculpting Miniatures; Embroidery; Paper Making; Enamels; Wood Carving; Engraving; Beadwork And Beading; Wire Jewelry Making; Crochet; Painting; Gun-Smithing; How To Cast Miniatures; Scale Model Building; Dioramas; Make Models; Make Military Dioramas; Model Aircraft; Model Railroads; Model Figures; Model Rockets; Model Ships; Model Yachts; War Game Terrain Making; Make A Ship In A Bottle; Map Making; Body Art/Tattoos/Piercings; Tie Dyeing; Genealogy.
Health & Medicine; Anatomy & Physiology; Beauty & Hygiene; Diet & Nutrition; Diseases & Ailments; Doctors & Nurses; Emotions & Feelings; Eyes, Ears & Teeth; Fitness & Exercise; General & Miscellaneous Health & Medicine; Hospitals; New Experiences—Going To The Doctor/Dentist/Hospital; Psychology; Safety; Sex Education; Toilet Training
History; Africa—History; African American History; Ancient History; Canada—History; European History; Exploration & Discovery—History; History—General & Miscellaneous; Latin American & The Caribbean—History; Middle East—History; Military History; United States History; World History.

### Holidays & Festivals; Christian Holidays—Christmas; Christian Holidays—Easter; Halloween; Islamic Holidays; Jewish Holidays; Multicultural & International Holidays; Thanksgiving; Valentine's Day.

### Humanities; History; Linguistics; Literature; Performing Arts; Philosophy; Religion; Visual Arts.

### Insects; Ants & Termites; Bees, Hornets & Wasps; Butterflies & Moths.

### Learning Basic Concepts; Alphabet; Colors; Counting; Memory; Motor Skills; Opposites; Penmanship; Sense & Sensation; Size & Shape; Time & Money; Word Books

Nature; Agriculture, Farming & Ranching; Earthquakes & Volcanoes Environmental Conservation & Protection; Environmental Science & Ecosystems; Flowers & Plants; Forests & Trees; Fossils; Freshwater & Marine Ecology; Fruits & Vegetables; Gardening; Go Green!; Natural History; Nature & The Natural World; Nature Experiments & Activities; Rocks, Minerals & Metals; Weather, Climate & Seasons.

### Natural Sciences; Space Sciences; Earth Sciences; Life Sciences; Chemistry; Physics.

### Poetry; African American Poetry; Poetry—Assorted Topics; Poetry—Rhymes, Nursery Rhymes & Finger Plays.

### Politics, Government & Law; Fire Fighting & Rescue; Police & Law Enforcement; Politics & Government—General & Miscellaneous; Politics & Government—United States; Presidents & Politics (U.S.);

Professions And Applied Sciences; Agriculture; Architecture And Design; Business; Divinity; Education; Engineering; Environmental Studies And Forestry; Family And Consumer Science; Healthcare Science; Human Physical Performance And Recreation. Journalism, Media Studies And Communication; Law; Library And Museum Studies; Military Sciences; Public Administration; Social Work; Transportation.
Reference & Study Aids; Foreign Language Study; Handwriting Language Arts—English Language; Penmanship; Reference—Curiosities & Wonders; Reference—Dictionaries; Reference—General & Miscellaneous; Reference—Sign Language; School & Education; Study Aids—General & Miscellaneous; Study Aids—Workbooks.

### Religion & Beliefs; Bible; Bible—Stories; Christianity; Islam; Judaism; Prayer & Prayer Books; Religion—General & Miscellaneous;

Science & Technology; Anatomy & Physiology; Astronauts & Space Flight; Astronomy; Biology; Chemistry; Computers And Computing; Earth Science; Experiments & Projects; General & Miscellaneous Science; How Things Work; Inventions & Inventors; Machinery & Tools; Magnets; Mathematics & Measurement; Physics; Power & Energy; Zoology; Astronomy; Microscopy; Model Rocketry; Model Airplanes; Electronics; Telescope Making; Spelunking; Rock Collecting.
Social Issues; Drugs, Alcohol, & Substance Abuse; Emotions & Feelings; Friendship & Getting Along; Growing Up & Aging; Manners & Etiquette; Self-Help; Social Issues—General & Miscellaneous; Values; Violence, War & Terrorism; World Peace.
Social Studies; Africa—Peoples & Places; African American History; African American Studies; Ancient Cultures; Asia—Peoples & Places; Australia & Oceania—Peoples & Places; Canada—Peoples & Places; Customs, Traditions, Anthropology; Ethnic Studies—Indigenous Peoples—General & Miscellaneous; Europe—Peoples & Places; Latin America & Caribbean—Peoples & Places; Lifestyles Around The World; Media Studies; Middle East—Peoples & Places; Native American Studies; People & Places—General & Miscellaneous.

### Russia & Former Soviet Union—Peoples & Places; Social Science—General & Miscellaneous; United States—People & Places; Women's Studies & History.

### Social Sciences; Anthropology; Archaeology; Area Studies; Cultural And Ethnic Studies; Economics; Gender And Sexuality Studies; Geography; Political Science; Psychology; Sociology.

### Special Needs; People With Special Needs; Special Needs—Advocates & Services.

Sports & Adventure; Adventure & Outdoor Activities; Baseball; Basketball; Basketball—Players & Teams; Boxing; Golf; Gymnastics; Hockey; Motor Sports; Olympics; Skateboards, In-Line & Roller Skates; Soccer; Sports & Recreation—General & Miscellaneous; Track & Field; Water Sports; Winter Sports; Volleyball; River Rafting; Bungee Jumping; Hiking; Scuba Diving; Swimming; Golf; Lawn Tennis; Team Games; Nature Walk; Cycling; Surfing; Horse Riding; Boating; Traveling; Fishing.

### Transportation; Airplanes, Helicopters & Aircraft; Boats & Ships; Cars & Trucks; Motor Sports; Space Vehicles; Trains & Railroads; Transportation—General & Miscellaneous.

Preferably, the system network of the present invention will maintain pre-designed activity sets (containing core activities) with its RDBMS 5 that might be selected and pursued by individuals with particular goals in mind, much like grade schools, high schools and colleges design curriculums (or courses of work) to be followed by individual students to be prepared for life, work and other aspects of living. Preferably, these Master Activity Course (MAC) Lists are selected from a MAC template widget implemented in the GUI of the my meosks module, and indexed as “Master Activity Course (MAC) Templates” or the like, and upon selection of a MAC template listed in such a GUI, the system will automatically create, configure and deploy a set of activity-specific meosk structures that are indexed to the prescribed activities in the selected MAC template. Thereafter, these MACs can be customized by removing and/or adding particular activities to the master activity course (MAC) list being pursued by the specific individual. This feature can make it easier to set up the system network by virtue of the fact that it prescribes activities and sets up meosk structures to help encourage the individual to follow such pursuits (or courses of pursuit) during any particular phase or phases of their lifetime.

Referring to FIGS. 40D-2 through 40D-23, there is shown a tree structure representing a primary set of classes of human activity which can be used to classify a very wide range of human activities and interests. In the illustrative embodiment, this tree structure functions as a foundation for the Activity/Product/Service/Brand Index that is used to implement the reverse inquiry based method of brand contact request and marketing communication illustrated in FIGS. 92A though 92C, and supported by the meosk/weosk-based private and social media management and communication system network of the present invention, detailed throughout the present Specification. The index is constructed by adding categories of product and/or services to each branch in the tree structure shown in FIGS. 40A-2 through 40D-23, so that each listed “activity” in the tree structure therein is supported categories of products and/or services. For example, for the activity “swimming”, a set of categories of products might include: goggles; masks; swim caps; swimsuits (swimwear); ear-plugs; swimming accessories, etc. Categories of services for “swimming” might include, for example: swimming instructors; swimming pools. Swimming clubs & organizations; swimming magazines; etc. Adding product and service categories to the primary branches of the tree structure will generate more sub-branches on the tree structure. Then at each product or service category added to the tree structure, a list of brands (i.e. characterized by trademarks and other intellectual property) available for such products and services should be added to the tree structure. Also, for each product/brand encoded tree branch, a list of actual commercial products identified by UPC/EAN number or other product identifier should be added to the product brand encoded branch of the tree structure. Likewise, for each service/brand encoded tree branch, a list of commercial services identified by service codes wherever available should be added to each service brand encoded branch of the tree structure. The resulting extended tree structure will be quite complex and provide the Activity/Product/Service/Brand Index needed to support the system network of the present invention, including its reverse-inquiry driven method of brand contact request and communication, described in FIGS. 92A through 92C and corresponding portions of the present patent Specification. Notably, each Activity/Product/Service/Brand Index will be geographically defined so there will be different Activity/Product/Service/Brand Indices for different markets around the world, and the system network will support many such different indices as required by its consumers and brands using the system network.

### Specification of the Network Architecture of the System Network of the Present Invention

FIG. 1 illustrates the network architecture of the meosk/weosk-based private and social media management and communication system network of the present invention 1 for the case where the system of the present invention is implemented as a stand-alone platform designed to work independent from but alongside of one or more social networks deployed on the Internet. As shown in FIG. 1, the Internet-based system network of the present invention 1 is shown comprising various system components, including an cellular phone and SMS messaging systems 10, and one or more industrial-strength data centers 2, preferably mirrored with each other and running Border Gateway Protocol (BGP between its router gateways, and each data center 2 comprising: a cluster of communication servers 3 for supporting http and other TCP/IP based communication protocols on the Internet; cluster of application servers 4; a cluster of email processing servers 13; and a cluster of RDBMS servers 5 configured within an Apache Hadoop® distributed file storage and retrieval ecosystem/system 15, and interfaced around the TCP/IP infrastructure of the Internet well known in the art. As shown, the system network architecture further comprises; a plurality of video and other media servers 6 (e.g. Google RDBMS, Youtube RDBMS, Facebook RDBMS, Vimeo RDBMS etc) operably connected to the infrastructure of the Internet 7; a plurality of Web-enabled client machines 8A, 8B, 8C (e.g. desktop computers, mobile computers such as iPad, and other Internet-enabled computing devices with graphics display capabilities, etc) running native mobile applications and mobile web browser applications supported modules, identified in FIGS. 5A-1 through 5C-1, supporting client-side and server-side processes on the system network of the present invention. The advantage of this particular system network realization would be great freedom in implementing terms and conditions and privacy policies of the system network, while the drawback would be to realize all computing, storage and communication resources required by the system network 1, independent from all social networks and media sharing systems, with which the system network 1 is seamlessly integrated.

In general, regardless of the method of implementation employed in any particular embodiment, the system network of the present invention will be in almost all instances realized as an industrial-strength, carrier-class Internet-based network of object-oriented system design, deployed over a global data packet-switched communication network comprising numerous computing systems and networking components, as shown. As such, the information network of the present invention is often referred to herein as the “system” or “system network”. The Internet-based system network can be implemented using any object-oriented integrated development environment (IDE) such as for example: the Java Platform, Enterprise Edition, or Java EE (formerly J2EE); Websphere IDE by IBM; Weblogic IDE by BEA; a non-Java IDE such as Microsoft's .NET IDE; or other suitably configured development and deployment environment well known in the art. Preferably, although not necessary, the entire system of the present invention would be designed according to object-oriented systems engineering (OOSE) methods using UML-based modeling tools such as ROSE by Rational Software, Inc. using an industry-standard Rational Unified Process (RUP) or Enterprise Unified Process (EUP), both well known in the art. Implementation programming languages can include C, Objective C, C⁻, Java, PHP, Python, Google's GO, and other computer programming languages known in the art.

Preferably, the system network is deployed as a three-tier server architecture with a double-firewall, and appropriate network switching and routing technologies well known in the art. For details on the design and implementation of server-side driven web-based communication instruments, reference should be made to Applicant's U.S. Pat. Nos. 8,458,055; 7,904,333; 7,848,492; 7,711,598 which are incorporated herein by reference as if set forth fully herein.

Referring to FIG. 1A, the system architecture of the present invention is shown comprising: (i) a cluster of communication servers 3 (supporting http and other TCP/IP based communication protocols on the Internet and hosting Web sites) accessed by web-enabled clients (e.g. smart phones, wireless tablet computers, desktop computers, computer workstations, etc) 8A, 8B, 8C used by individuals users, brand managers and team members, and consumers, through the infrastructure of the Internet; (ii) a cluster of application servers 4 for implementing the many core and compositional object-oriented software modules 20A-20G described in FIGS. 5A-1 through 5C1 and supporting the system network of the present invention, (iii) a scalable, distributed computing and data storage system network, including a cluster of RDBMS servers 5, based, for example on the Apache Hadoop® Java frameworks that enables applications to work with thousands of nodes and petabytes of data, and for using SQL to query and manage large datasets residing in such a distributed storage environment; web-enabled client SMS gateway servers 12 supporting integrated email and SMS messaging, handling and processing services that enable flexible messaging across the system network; and a cluster of email processing servers 13.

Referring to FIG. 1B-1, the system architecture is described for the Apache Hadoop® system 15 which currently is the preferred implementation of the scalable, distributed computing and data storage system supporting the meosk/weosk-based private and social media management and communication system network of the present invention 1. As shown, the Apache Hadoop® ecosystem 15 comprises: an SMS Planner with SQL Query input; a Catalog; a Data Loader; a Apache Hadoop® core including (i) a master node including HDFS with NameNode, (ii) a MapReduce Framework for handling MapReduce Jobs, and including a jobtracker, and (iii) InputFormat Implementations with a Database Connector; and a plurality of nodes, each including a task tracker, a database and data node.

Referring to FIG. 1B-2, the software architecture for the Apache Hadoop® ecosystem 15 is shown comprising; top-level abstractions such as (i) the PIG platform for analyzing large data sets that consists of a high-level language for expressing data analysis programs, coupled with infrastructure for evaluating these programs, (ii) the Hive data warehouse software that facilitates querying and managing large datasets residing in distributed storage, and (iii) the Sqoop tool for efficiently transferring bulk data between Apache Hadoop® and structured datastores such as relational databases (RDBMSs); (ii) a Map-Reduce programming model and associated implementation for processing and generating large data sets with a parallel, distributed algorithm on a cluster, and a HBase Database with real-time access (non-relational database modeled after Google's Bigtable distributed storage system for structured data) for distributed data processing; the Apache Hadoop® Distributed File System (HDFS) at the base, providing a self-healing clustered data file storage system network.

By virtue of the Apache Hadoop® distributed computing and data storage system 15, system application modules 20A-20G supported by the system network 1 can run on thousands of nodes involving thousands of terabytes of data storage, where the distributed computing and data file storage system 15 facilitates rapid data transfer rates among the nodes and allows the system to continue operating uninterrupted in case of a node failure.

### Different Ways of Implementing the Client Machines and Devices on the System Network of the Present Invention

In one illustrative embodiment, the enterprise-level system network of the present invention is realized as a robust suite of hosted services delivered to Web-based client subsystems using an application service provider (ASP) model. In this embodiment, the Web-enabled clients 8A, 8B, 8C can be realized using a web-browser application running on the operating system (OS) of a computing device (e.g. Linux, Application IOS, etc), to support online modes of system operation, only. However, it is understood that some or all of the services provided by the system network can be accessed using Java clients, or a native client application running on the operating system of a client computing device, to support both online and limited off-line modes of system operation. In such embodiments, the native application would have access to local memory (e.g. a local RDBMS) on the client device, accessible during off-line modes of operation to enable consumers to use certain or many of the system functions supported by the system network during off-line/off-network modes of operation (e.g. reviewing recently stored/shared moments in meosk structures; capturing and storing moments in meosk structures; writing notes for attachment to moments in stored/shared meosk structures, writing journal entries for storing in meosk structures, and creating new meosk structures). During such off-line modes of operation, supported by native application implemented client subsystems, the system users (e.g. consumers) can also share and post moments and meosk structures, with the understanding that the such operations will be completed when the client system network, running the native application, goes back online, i.e. restores connectivity with the system network's data center 2, and synchronization between all clients and system servers has automatically taken place. Notably, mobile native application implemented client systems 8A, 8B, 8C are preferred over web-browser implemented client systems because the former offers off-line modes of operation which can be valuable when system users are located in remote regions, where network connectivity is not available, but when users have time to capture moments, create notes, messages and the like using recent data stored locally in the client machine's RDBMS and/or persistent data storage devices.

### Specification of System Architecture of an Exemplary Mobile Client System Deployed on the System Network of the Present Invention

FIG. 1C is a schematic representation of the system architecture of an exemplary mobile client system (e.g. device) 8B, 8C that is deployed on the system network of the present invention and supporting the many services offered by system network servers of the present invention. As shown, the mobile device 8B, 8C can include a memory interface 202, one or more data processors, image processors and/or central processing units 204, and a peripherals interface 206. The memory interface 202, the one or more processors 204 and/or the peripherals interface 206 can be separate components or can be integrated in one or more integrated circuits. The various components in the mobile device can be coupled by one or more communication buses or signal lines. Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions. Other sensors 216 can also be connected to the peripherals interface 206, such as a positioning system (e.g., GPS receiver), a temperature sensor, a biometric sensor, a gyroscope, or other sensing device, to facilitate related functionalities. A camera subsystem 220 and an optical sensor 222, e.g., a charged coupled device (CCD) or a complementary metal-oxide semiconductor (CMOS) optical sensor, can be utilized to facilitate camera functions, such as recording photographs and video clips. Communication functions can be facilitated through one or more wireless communication subsystems 224, which can include radio frequency receivers and transmitters and/or optical (e.g., infrared) receivers and transmitters. The specific design and implementation of the communication subsystem 224 can depend on the communication network(s) over which the mobile device 8B, 8C is intended to operate. For example, a mobile device 100 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device 100 may be configured as a base station for other wireless devices. An audio subsystem 226 can be coupled to a speaker 228 and a microphone 230 to facilitate voice-enabled functions, such as voice recognition, voice replication, digital recording, and telephony functions. The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230. Such buttons and controls can be implemented as a hardware objects, or touch-screen graphical interface objects, touched and controlled by the system user. Additional features of device 8B, 8C can be found in U.S. Pat. No. 8,631,358 incorporated herein by reference in its entirety.

Applications and Uses for the Meosk/Weosk-Based Private and Social Media Management and Communication System Network of the Present Invention Involving the Capturing, Storing and Selectively Communicating f Informational Moments During the Activities of Individuals and/or Groups of Individuals Including Family Structures and Business, Educational and Social Enterprises

In general, there are unlimited applications and uses for the meosk/weosk-based private and social media management and communication system network of the present invention. This involves capturing, storing and selectively communicating many different kinds of informational moments that created during the activities of individuals and/or groups of individuals, including family structures and business, educational and social enterprises. Therefore, the system network of the present invention can be readily used and/or adapted for a very wide ranges of enterprise-level collaboration, sharing and communication applications in many diverse fields including, but not limited to: family ecosystem development and reinforcement; historical documentation and communication; primary, secondary and graduate education (e.g. colleges, high schools, elementary schools, vocational, training); business projects; workforce training; financial planning, accounting and investment efforts; transportation programs and studies; sales and marketing campaigns; healthcare programs; governmental services (e.g. social services, health-care services, education services, defense and prepared service, internal revenue services, military and defense etc.); retailing operations; e-commerce marketing communications and related transactions; focus-group testing and measurement; personal information management; group information management; scientific research; and the like.

As used herein, the terms “moment” and “moments” describe the content associated with digital information media and information objects, information and data files, and digital assets, of all kinds and types currently known and expected to be developed in the future. While the terms “moment” and “moments” also refers to digital information content, as understood by conventional information theory and science, pioneered by Claude E. Shannon, Harry Nyquist, et al at Bell Laboratories, such terms will also be understood to embrace the physical (e.g. material, electrical, chemical, biological etc.) nature of objects of any kind, including performing arts including music, theater and dance, as well as mathematical and other abstract and conceptual objects typically covered in the fields of mathematics, physics and other sciences, as well as mental and symbolic representations covered in the fields of logic, linguistics, cognitive science, artificial intelligence (AI), language translation and compiling, computer programming, cryptology, communications, networking, engineering, scientific theory development, etc.

In short, it is understood that the terms “moment” and “moments” shall embrace any subject of mankind as well as any object of mankind's inquiry that is capable of being (i) captured in some form, (ii) stored in a digitally-represented information medium, and (iii) knowable to some extent or otherwise subject to human inquiry within the sensory and epistemological limits of human beings, with or without tools or instruments to aid during investigation and/or analysis.

While the information stores (i.e. storage containers) for such information-based moments are called “album”, “albums”, “journal” “journals”, “guest book” and “guest books” throughout the illustrative embodiments, it is understood that such terms are merely exemplary, and other terms may be used to represent the function of storing information-based “moments” or “objects”, in the spirit of the present invention, where such information-based objects are represented in binary/digital or other type memory structures or devices supported within remote Internet-accessible information servers and/or in local client-machine memory devices, implemented using available digital information storage technology.

Consequently, the terms “moment” and “moments” as used herein shall mean objects captured within a digital information containing structure, such a digital image, video recording, audio recording, a hologram, and like structures and forms, and will relate to many different kinds of activities, interests, concepts, knowledge, intelligence, beliefs, prejudices, ideologies, emotions, aspirations, and feelings possible in human nature. Therefore, it is expected that many different captions may be used to represent the stores provided for moments (i.e. objects) in meosk and weosk structures and subsystems that have been created and deployed on the system network of the present invention. Also, many different terms may be used to refer to objects (i.e. moments) stored in a system user's meosk structures and weosk structures, such as, for example, but not limited to the following expressions: moments of being; moments of life; moments of thought; moments of speech; moments of writing; moments of understanding; moments of knowledge; moments of discovery; moments of scientific understanding; moments of recognition; moments of happiness; moments of sorrow; moments of cognition; moments of experience; moments of progress; moments of evolution; moments of revolution; moments of clarity; moments of confusion; moments of invention; moments of innovation; moment of truth; moments of love; moments of impact; moments of learning; moments of sharing; moments of creation; moments of inspiration; moments of labor; moments of leisure; moments of sacrifice; moments of generosity; moments of beauty; moments of opportunity; moments of achievement; moments of celebration; moments of vision; moments of cooperation; moments of attention; moments of education; moments of courage; moments of fear; moments of patriotism; moments of giving; moments of security; moments of protection; moments of consumption; moments of suffering; moments of fulfillment; moments of suffering; moments of meaning; moments of expression; moments of destruction; moments of friendship; moments of curiosity; moments of involvement; moments of struggle; moments of transition; moments of paradox; moments of solace; moments of escape; moments of caring; moments of neglect; moments of nature; moments of humanity; moments of relaxation; moments of stress; moments of peace; moments of war; moments of wisdom; moments of foolishness; moments of folly; moments of consciousness; moments of nostalgia; moments of worship; moments of grace; moments of disgrace; moments of transportation; moments of flight; moments of travel; moments of journey; moments of wonder; moments of fantasy; moments of playfulness; moments of seriousness; moments of light; moments of darkness; moments of color; moments of balance; moments of contrast; moments of adventure; moments of amusement; moments of learning; moment of victory; moments of defeat; moments of forgiveness; moments of revenge; moments of joy; moments of sorrow; moments of pleasure; moments of pain; moments of anger; moments of frustration; moments of hope; moments of risk; moments of security; moments of hunger; moments of comfort; moments of discomfort; moments of holidays; moments of celebration; moments of power; moment of weakness; moments of confidence; moments of fear; moments of freedom; moments of moments of time; moments of space; etc.

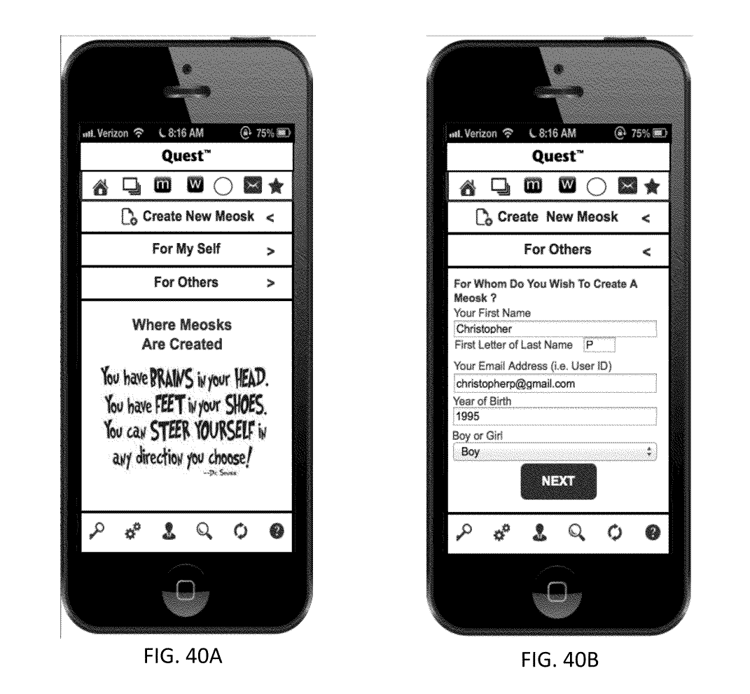

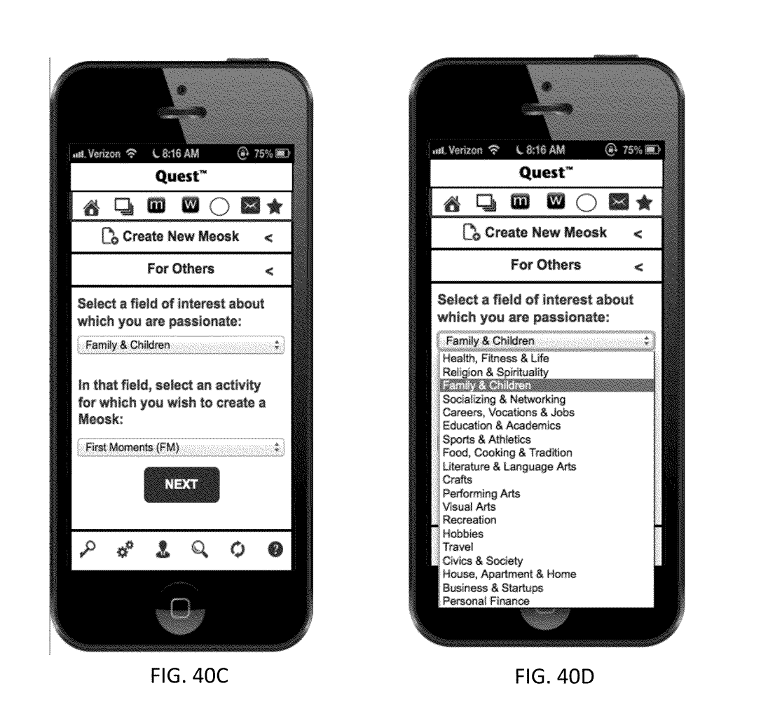

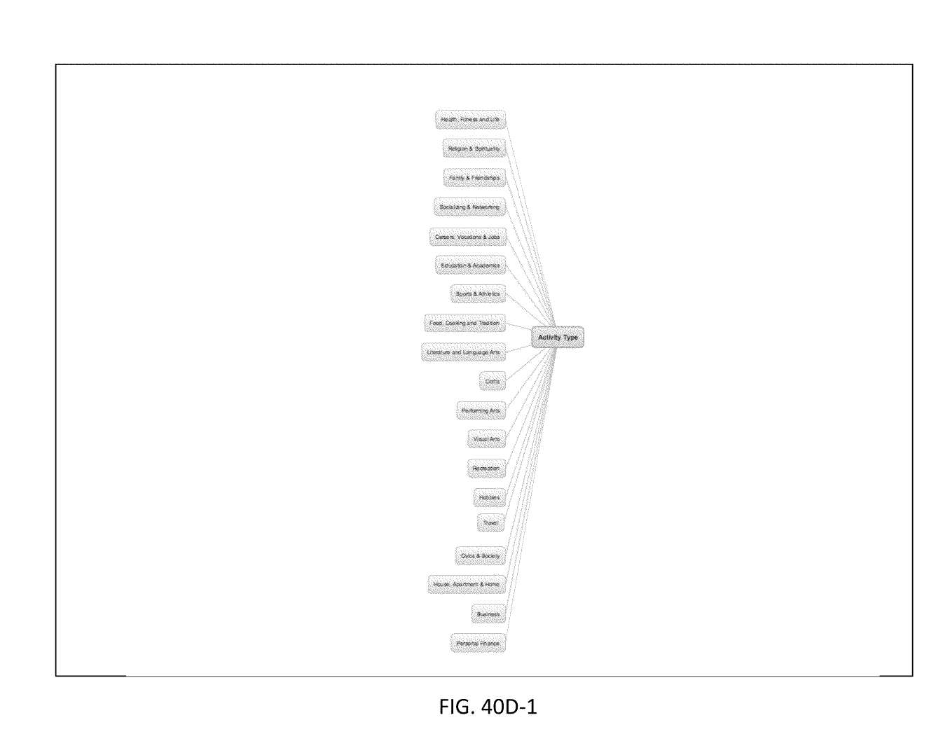

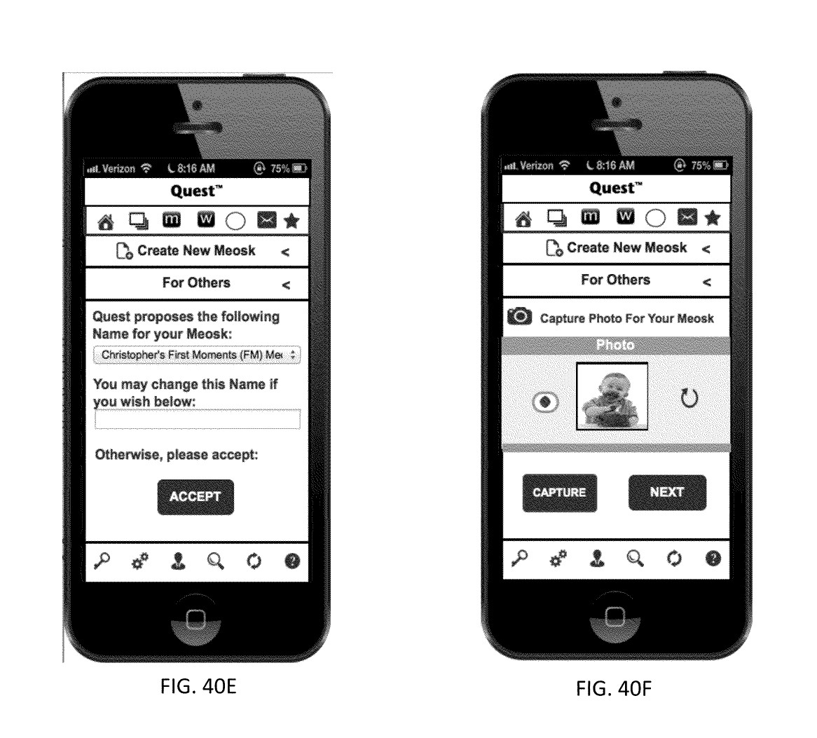

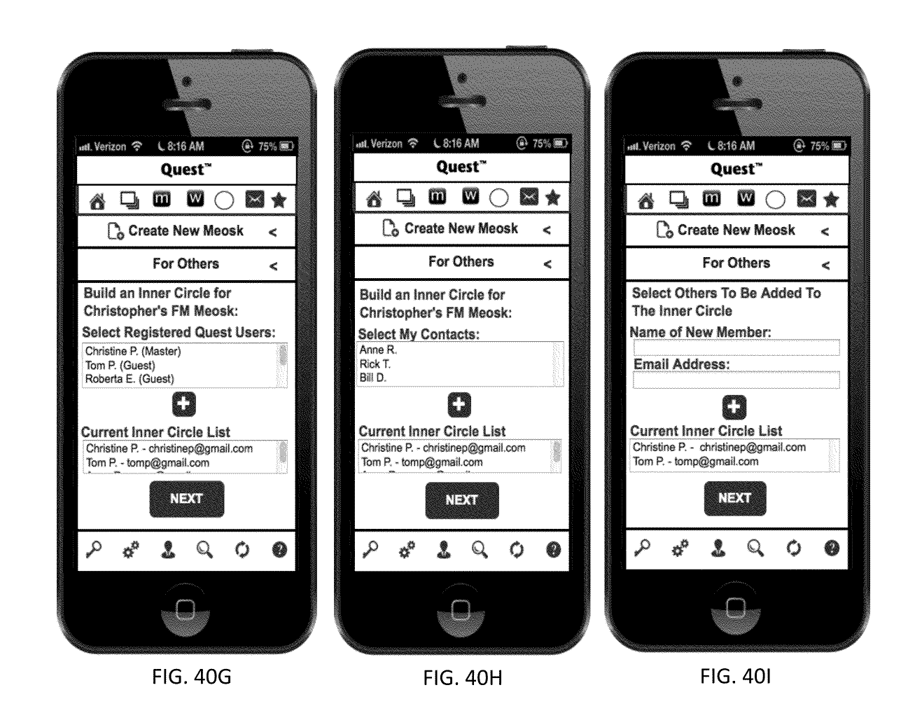

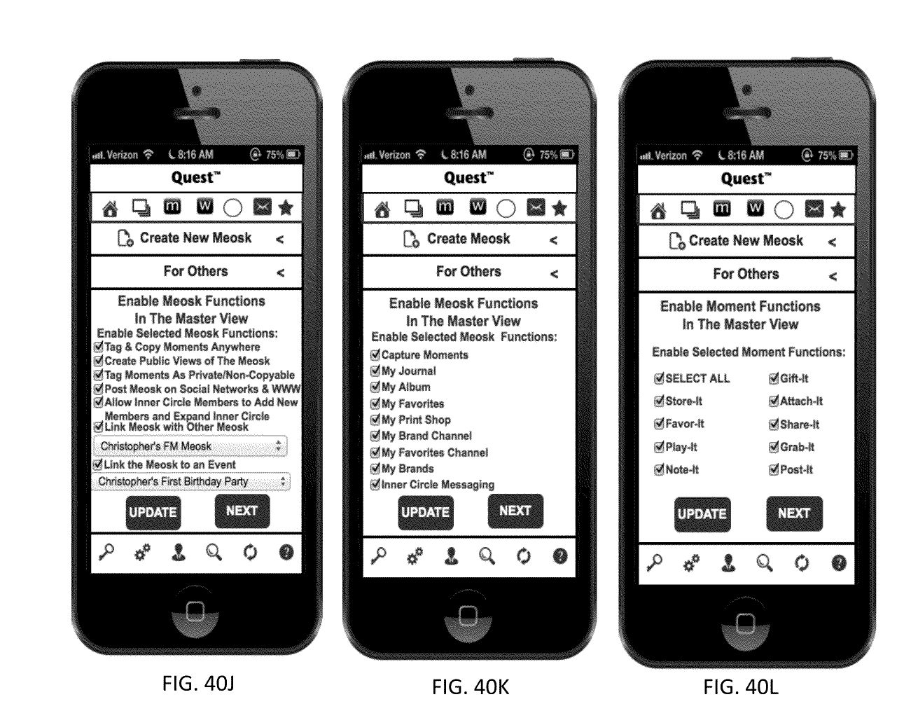

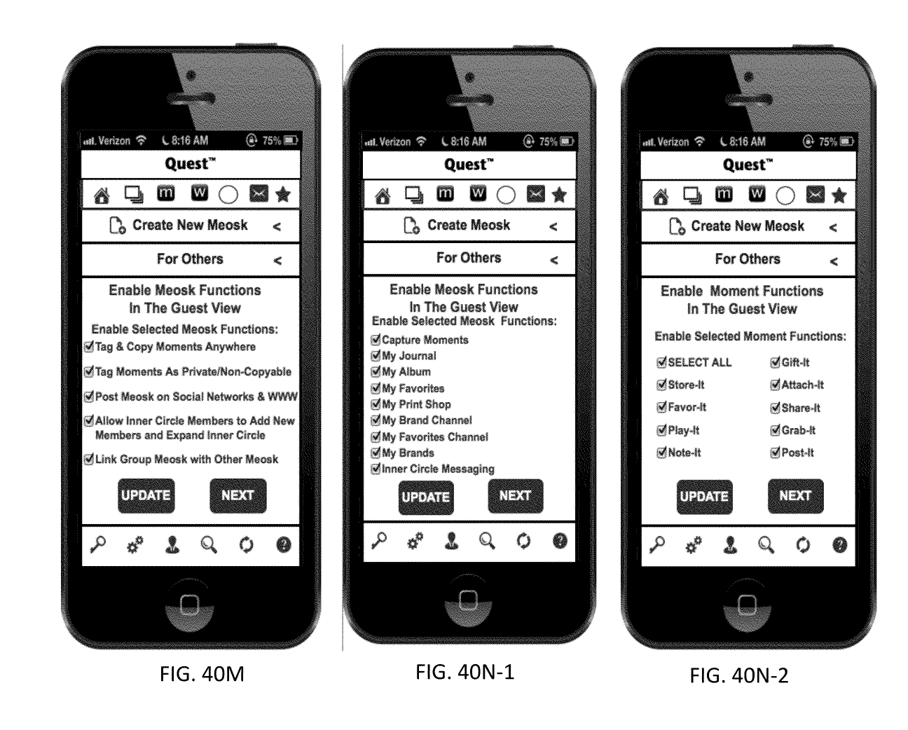

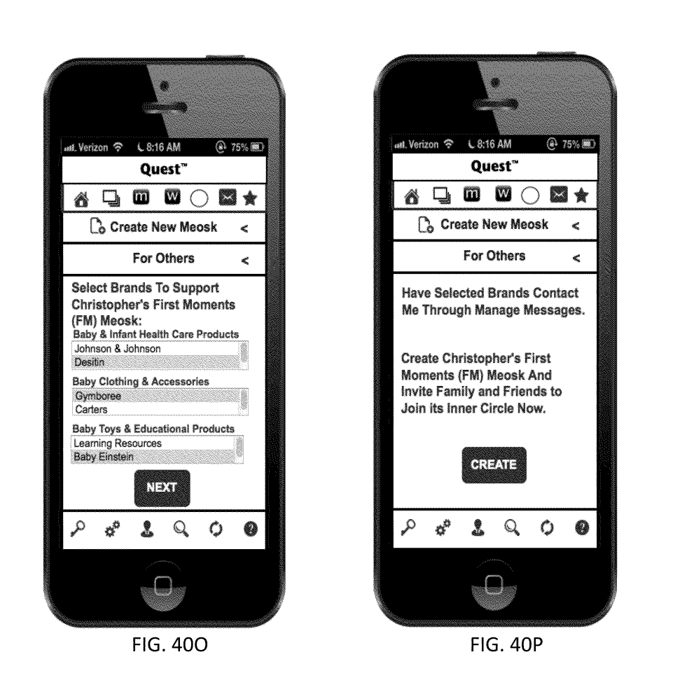

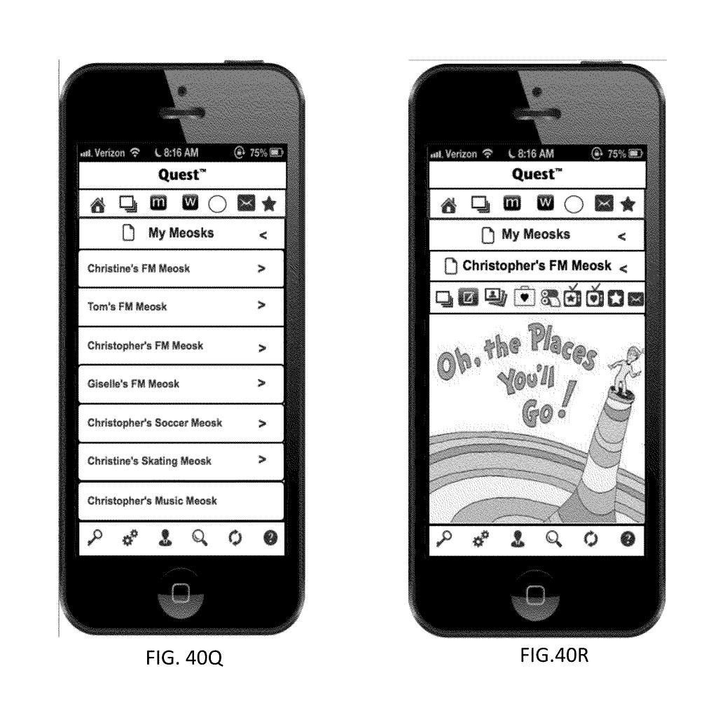

Such “moment storage” terminology explored above can be made available to system users during meosk and weosk creation processes, using very simple pull-down menu selection techniques, where, for example, depending on the type of activity selected by the meosk master (i.e. system user) for the meosk or weosk structure to be created and deployed (ultimately in C programming structures executed by multi-core microprocessors on servers), a different group of conceptually related moment terms identified above can be displayed to the meosk/weosk master to choose so that “moment stores” in the meosk or weosk structures/subsystems to be created will be labeled and indexed by the file system using such selected terminology, rather than the default “moment storage” labels used in the illustrative GUI screens of the system network of the present invention (e.g. “my album” and “my journal” for meosk structures, and “shared album” and “guest book” for weosk structures). Such features of the present invention can be implemented as one or more additional steps performed during the execution of the create new meosk module, illustrated in FIGS. 39A through 39R, and FIGS. 40C through 40U, and/or during the execution of the create new weosk module illustrated in FIGS. 60B through 60Q, and FIGS. 61A through 61BB, and as described hereinafter. This additional feature will provide the meosk/weosk master ways of and the freedom to customize their meosk structures and weosk structures for their intended purposes and consistent with the cultural environment of their choice and possibly creation. The system network of the present invention can support all human languages known to mankind Thus, the system network of the present invention can be implemented to support all natural human languages at the GUI level of system representation.

Also, while reference is made herein to moments and objects being stored in meosk and weosk structures of the present invention, it is understood that such statements about moment/object storage are made with respect to the logical layer/representation of the moment/object storage, and that digital information corresponding to such moments/objects stored in the specified meosk structures and weosk structures will (i) physically reside at the physical layer/representation within memory storage devices located in remove information servers within (i) the Apache Hadoop® distributed digital file storage and retrieval system 15, (ii) local client machines 8A, 8B, 8C and/or (iii) elsewhere on the Internet. Also, the network address of such memory storage locations will be specified typically using uniform resource locators (URLs) and other memory storage, accessing and management techniques, well know in the cloud (i.e. Internet) computing storage and networking arts.

### Specification of the Email Data Message Processing Architecture Supported on the System Network of the Present Invention for Processing and Delivering User-Specific Email Message Services

Referring to FIG. 2A, the email message processing server subsystem 13 is shown configured for delivering user-specific email message services within the system network of the present invention illustrated in FIGS. 1 through 1B-2.

As shown in FIG. 2A, the subsystem 13 comprises: POP and IMAP email servers 13A operably connected to the TCP/IP infrastructure of the Internet, and in mailboxes and out mailboxes 13B, that are interfaced with a message handler 13C; a message processor 13D. As shown in FIG. 2A, the message processor 13D comprises the subcomponents: a first I/O module 13D1 for interfacing with the message handler module 13C in communication with in and out mailboxes 13B; a message filtering module 13D2 for instructing an embedded program (e g running on local microprocessor and memory architecture within server 13D) to process email messages according to the message processing rules 13D3 stored in the processor 13D (e.g. for parsing incoming messages, looking or the subject, subject and body, header fields, email addresses, etc) and processing the data to meet the terms and conditions set forth in the method described in FIG. 2B; message processing rules 13D3 for processing email message data to carry out the method of FIG. 2B; data extraction module 13D4 for extracting any data from the message that is required by the method specified in FIG. 2B; a second I/O module 13D5 for interfacing with the RDBMS 5 and application servers 4; an action module 13D6 for performing various actions with the extracted data and with the email message itself, such as inserting extracted data into the database (RDBMS) 5, updating or deleting data from the database 5, saving the extracted data to a file, sending a reply message to the recipients, forwarding the original message to a specified destination, and performing all other actions required to carry out the preferred embodiment of the method specified in FIG. 2B; and a message formation module 13D7 for forming messages required by the method specified in FIG. 2B.

Referring to FIG. 2B, the method of email message processing and user-specific email message delivery on system network 1 comprises the steps of: (1) assigning a User-Specific Email Address (e.g. firstname.lastname.yearofbirth@questmeosk.com) to each registered system user; (2) maintaining within the RDBMS 5, a Master User List containing the email addresses of all registered system users; (3) for each message arriving at the email processing server, analyze the incoming message and deliver it to the mail box address specified by the receiver's email address (specified by the “To Field”); and (4) for each email message received at a system user's email address, (a) parse the received message, (b) extract any attached moments (e.g. photos, files etc) and comments, (c) deliver the moments and comments to the registered system user's Bin, and (d) send a notification to the registered system user (receiving email) that a new moment has arrived and is available for access in his or her Bin for review.

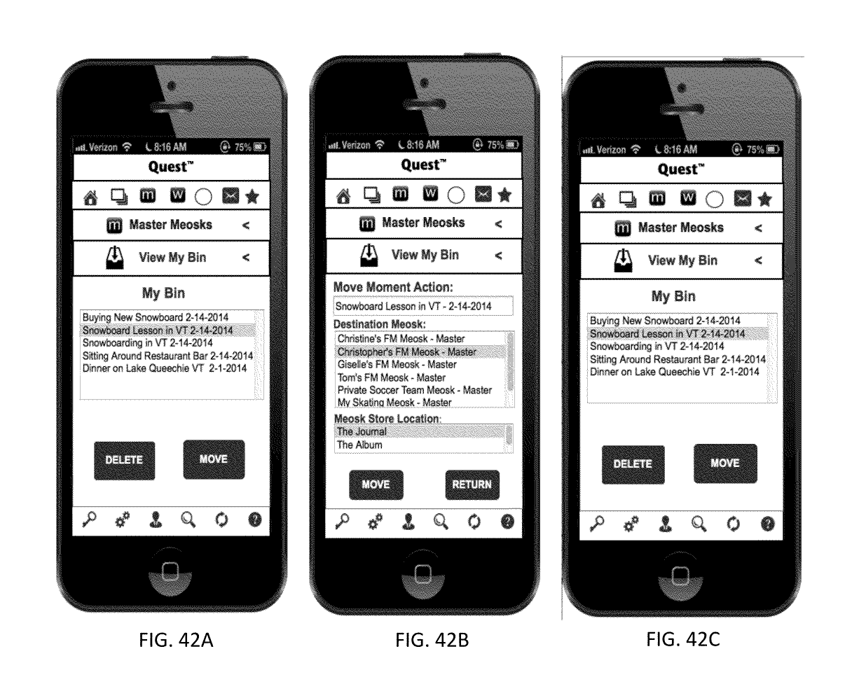

During system network operation, the message processor 13D automatically reads email messages from POP3 and IMAP mailboxes 13B at intervals determined by the program scheduler, running on the embedded microprocessor. The message processor 13D (i) extracts data fields and data content from incoming messages sent to the user-specific email addresses (e.g. firstname.lastname.yearofbirth@questmeosk.com), and (ii) processes the extracted data as required to carry out the method described in FIG. 2B, including inserting extracted data elements to the database 5, search for system user email-address/SMS-number information in the database 5, as required to carry out the data processing method specified in FIG. 2B. During such operations, the message processor 13D selects the records from the database 5 using a determined criteria and performs required actions (specified by the method) with the selected data. The message processor 13D can work with any ODBC compatible database such as MS Access, MySQL, MS SQL, Oracle and others deployed on or accessible through the system network 1. In addition to saving specific data extracted from emails to a file, the message processor 13D will save message attachments (e.g. moments such as photos, videos, sound files, and other media types) to specified storage locations in the RDBMS 5, or on other storage devices within the Apache Hadoop® system 15. The message processor 13D can rename the attachments and save them under new names on a selected data store, or forward the attachments to their destination under their current names. Ultimately, the stored attachments (e.g. moments) are linked to the BIN of a particular meosk master, or masters, active on the system network, as shown in FIGS. 42A through 42C. Also, notifications will be generated and sent to the meosk masters in the notification center of the client subsystem when the processed email messages and associated attachments are ready for delivery to the meosk master(s) at their BIN, accessible using a client subsystem deployed on the system network, as described in great detail herein.

### Specification of the Email Data Message Processing Architecture Supported on the System Network of the Present Invention for Processing and Delivering General-User Email Message Services

Referring to FIG. 2C, the email message processing server subsystem 13 is shown configured for delivering general email message services within the system network of the present invention illustrated in FIGS. 1 through 1B-2. As shown, the subsystem 13 comprises: POP and IMAP email servers 13A operably connected to the TCP/IP infrastructure of the Internet, and in mailboxes and out mailboxes 13B, that are interfaced with a message handler 13C; and a message processor 13D.

As shown in FIG. 2C, the message processor 13D comprises the subcomponents: a first I/O module 13D1 for interfacing with the message handler module 13C in communication with in and out mailboxes 13B; a message filtering module 13D2 for instructing an embedded program (e g running on local microprocessor and memory architecture within server 13D) to process email messages according to the message processing rules 13D3 stored in the processor 13D (e.g. parsing incoming messages, looking or the subject, subject and body, header fields, email addresses, etc) and processing the data to meet the terms and conditions set forth in the method described in FIG. 2D; message processing rules 13D3 for processing email message data to carry out the method of FIG. 2D; data extraction module 13D4 for extracting any data from the message that is required by the method specified in FIG. 2D; a second I/O module 13D5 for interfacing with the RDBMS 5 and application servers 4; an action module 13D6 for performing various actions with the extracted data and with the email message itself, such as inserting extracted data into the database (RDBMS) 5, updating or deleting data from the database 5, saving the extracted data to a file, sending a reply message to the recipients, forwarding the original message to a specified destination, and performing all other actions required to carry out any preferred embodiment of the method specified in FIG. 2D; and a message formation module 13D7 for forming messages required by the method specified in FIG. 2D.

Referring to FIG. 2D, a flow chart is presented describing the primary steps of a method for carrying out, by the email processing subsystem of FIG. 2C, handling and processing of email messages and delivering general-user email messages to registered system users having active user accounts supported on the system network of the present invention illustrated in FIGS. 1 through 1B-2. As shown, the method of general-user email message delivery on the system network 1 comprises the steps of: (1) creating a general-user email address (e.g. generaldelivery@questmeosk.com) and broadcast this email address to all registered and non-registered system users; (2) maintaining within the RDBMS, a Master User List containing: (a) the email addresses and SMS/text numbers of all system users (registered and un-registered) who are a member of at least one inner circle of at least one meosk structure or weosk structure deployed on the system network, (b) the names of the inner circle member, (c) the meosk structures and/or weosk structures to which they are members, (d) the master of the meosk structure or weosk structure, and (e) the email address of the master; (3) for each message arriving at the email processing server, analyzing the incoming message and deliver it to the mail box address specified by the receiver's email address (specified by the “To Field”); (4) for each email message received at a system user's email address, (a) parsing the email sender's email address from the received message, and analyze the received message so as to determine the identities and user-specific email addresses of all masters of meosk structures and weosk structures, of which the email sender is an inner circle member verified by the parsed sender's email address compared with the master list; (b) creating a reply email messaging and reattaching any attached moments (e.g. photos, files etc) and comments thereto, and listing all masters of meosk structures and weosk structures of which the email sender is an inner circle member, and instructions asking the sender to which masters do they wish the system admin to send and deliver the attached moments and comments, and a notification that they have received such moments using this general email delivery service; (5) sending and delivering the reply email message and attached moments and comments to the sender's email address, so the sender can a response to the reply email address back to the email server and identify to whom to deliver the message and attached moments; and (6) sending the moments and comments to all users indicated by the sender of the moments and comments and generate notifications at each email destination.

During system network operation, the message processor 13D automatically reads email messages from POP3 and IMAP mailboxes 13B at intervals determined by the program scheduler, running on the embedded microprocessor. The message processor 13D (i) extracts data fields and data content from incoming messages sent to the general-user email address (e.g. generaldelivery@questmeosk_structure.com) configured for the system network 1, and (ii) processes the extracted data as required to carry out the method described in FIG. 2D, including inserting extracted data elements to the RDBMS 5, search for system user email-address information in the database 5, as required to carry out the data processing method specified in FIG. 2D. During such operations, the message processor 13D selects the records from the database 5 using a determined criteria and performs required actions (specified by the method) with the selected data. The message processor 13D can work with any ODBC compatible database such as MS Access, MySQL, MS SQL, Oracle and others deployed on or accessible through the system network 1. In addition to saving specific data extracted from emails to a file, the message processor 13D will save message attachments (e.g. moments such as photos, videos, sound files, and other media types) to specified storage locations in the RDBMS 5, or on other storage devices within the Apache Hadoop® system 15. The message processor 13D can rename the attachments and save them under new names on a selected data store, or forward the attachments to their destination under their current names. Ultimately, the stored attachments (e.g. moments) are linked to the BIN of a particular meosk master, or masters, active on the system network. Also, notifications will be generated and sent to the meosk masters when the processed email messages and associated attachments are ready for delivery to the meosk master(s) at their BIN, as shown in FIGS. 42A through 42C, accessible using a client subsystem deployed on the system network, as described in great detail herein.

### Specification of the SMS Data Message Processing Architecture Supported on the System Network of the Present Invention for Processing and Delivering User-Specific SMS Message Services

Referring to FIG. 2E, the SMS message processing server and system 12 is shown configured for delivering user-specific SMS message services within the system network of the present invention illustrated in FIGS. 1 through 1B-2.

Referring to FIG. 2E, and more specifically, within the cellular phone and SMS messaging system block 10, it will be helpful to quickly review the SMS communication process and understand how SMS messages travel from the mobile phone 8B, 8C to a Short Message Service Center (SMSC) in the GSM cellular phone network 10.

Short Messaging Entities (SME) in the GSM network 10 are the starting points (the source), and also the end points (the receiver) for SMS messages. SMEs always communicate with a Short Message Service Center (SMSC) and never communicate directly with each other. An SME can be a mobile telephone 8B, 8C. Depending on the role of the mobile phone in the communication process, there are two different kinds of SMS messages to consider: Mobile Originated (MO) messages and Mobile Terminated (MT) messages. MO messages are sent by the mobile phone to the SMSC. Mobile terminated messages are received by the mobile phone. The two messages are encoded differently during transmission.

An SME can also be a computer system equipped with a messaging software, for example the SMS Gateway Server 12, that can communicate directly with the SMSC of the service provider network 10 via an IP SMS connection, or with the Base Station System via a GSM Modem 26, configured as shown in FIG. 2E. In the SMS network operated by GSM service providers, there are four layers of transport used: SM-AL (Application Layer); SM-TL (Transfer Layer); SM-RL (Relay Layer); SM-LL (Lower Layers). The SMS Gateway Server 12 is located in the SM-AL layer. When sending an SMS, the server 12 creates protocol data units (PDU's) transported by the SM-TL layer. When the SMS gateway server 12 receives an SMS message, the message is also encoded according the SM-TL layer PDU specification. The SMS Gateway Server 12 decodes this PDU and makes the message readable for computer programs which will perform SMS message processing. The SMS Gateway Server 12 also encodes messages according to the PDU specification so that they can be transported along the SM-TL layer to the Short Message Service Center (SMSC).

As shown in FIG. 2E, the mobile phone (Mobile station) transmits the SMS message to the GSM base station (BTS) through a wireless link (WL). Then, the message goes through the backbone network of the service provider. The Mobile Switching Center (MSC), the Home Location Register (HLR) and optionally the Visitor Location Register (VLR) is used to find out the appropriate Short Message Service Center (SMSC) that will store and forward the message when the receiving party becomes available.

The Short Message Service (SMS) makes it possible to send and receive messages to and from mobile telephones. The messages can contain text or binary data. The text can comprise words or numbers or an alphanumeric combination. A single short message can contain up to 160 characters when Latin alphabets are used, and 70 characters when non-Latin alphabets such as Arabic and Chinese are used. The latest SMS standards released by ETSI provide an extension to send longer text messages in SMS. This technology is called concatenated SMS messages. An SMS message can also carry binary data. A binary SMS message has 140 bytes of used data. This user data can be split into two parts: the user data header and the actual data. The user data header can be used to inform mobile phones about certain message types. This way SMS can be used to carry operator logos, ringtones, telephone settings, WAP push messages, hyperlinks (URLs), etc.

In the illustrative embodiment, the SMS Gateway Server 12 can be implemented using the Ozeki NG SMG Gateway server, configured for sending SMS notifications and building an automated SMS information services required by the present invention. The SMS gateway server 12 can be connected to the mobile network through a wireless link (WL) by using a GSM modem 16. However, the preferred method of connecting the SMS gateway server system 12 directly to the Short Message Service Center (SMSC) of the mobile network operator is through an IP connection established through the TCP/IP infrastructure of the Internet, as shown in FIG. 2E. High-speed IP SMS connections between SMS gateway server system 12 and SMSC (e.g. SMPP, UCP, CIMD2) managed for example, by the Ozeki NG SMS Gateway by Ozeki Informatics Ltd., of Debrecen Hungary, can handle several millions of SMS messages per day. Notably, SMPP is the best protocol for SMS messaging over the Internet, because it is asynchronous, fast and reliable.

As shown in FIG. 2E, the system 12 comprises: a first I/O module 12A for interfacing with cellular phone and SMS messaging system 10, via the Internet infrastructure; a decoding module for decoding incoming PDU messages to any suitable message format that can be handled by the computer software processing and handling the received messages along the data processing and handling stages of the SMS gateway server 12; a message filtering module 12B for instructing an embedded program (running on a local microprocessor and memory architecture within server 12) to process SMS messages according to the message processing rules 12C stored in the processor 12 (e.g. parsing incoming messages, looking or the subject, subject and body, header fields, email addresses, etc) and processing the data to meet the terms and conditions set forth in the method described in FIG. 2F; message processing rules 12C for processing SMS message data to carry out the method of FIG. 2F; data extraction module 12D for extracting any data from the message that is required by the method specified in FIG. 2F; a second I/O module 12E for interfacing with the RDBMS 5 and application servers 4; an action module 12F for performing various actions with the extracted data and with the SMS message itself, such as inserting extracted data into the database (RDBMS) 5, updating or deleting data from the database 5, saving the extracted data to a file, sending a reply message to the recipients, forwarding the original message to a specified destination, and performing all other actions required to carry out any preferred embodiment of the method specified in FIG. 2F; a message formation module 12F for forming messages required by the method specified in FIG. 2F; and an encoding module for encoding messages back to the PDU format for transport along the SM-TL layer to the Short Message Service Center (SMSC), and from there, to message destinations.

Referring to FIG. 2F, a flow chart is presented describing the primary steps of a method for carrying out, by the SMS processing subsystem of FIG. 2E, handling and processing of email messages and delivering user-specific SMS message services to registered system users having active user accounts supported on the system network of the present invention illustrated in FIGS. 1 through 1B-2. As shown, the method of user-specific SMS message delivery on system network comprises: (1) assigning a user-specific SMS number (e.g. 1-800-123-4567) to each registered system user; (2) maintaining within the RDBMS 5, a master user list containing the SMS numbers and email addresses of all registered system users; (3) for each message arriving at the SMS gateway server 12, analyzing the incoming message and delivering it to the SMS mail box specified by the receiver's SMS number (specified by the “To Field”); and (4) for each SMS message received at a System SMS Number, (a) parsing the received message, (b) extracting any attached moments (e.g. photos, files etc) and comments, (c) delivering the moments and comments to the registered system user's BIN, as shown in FIGS. 42A through 42C, and (d) sending a notification to the registered system user (receiving SMS) that a new moment has arrived and is in his or her BIN.

During system network operation, the message processor 12 automatically reads SMS messages at intervals determined by the program scheduler running on the embedded microprocessor. The message processor 12 (i) extracts data fields and data content from incoming messages sent to the user-specific SMS addresses (e.g. 1-800-123-4567), and (ii) processes the extracted data as required to carry out the method described in FIG. 2F, including inserting extracted data elements to the database 5, search for system user SMS-number information in the RDBMS 5, as required to carry out the data processing method specified in FIG. 2F. During such operations, the message processor 12 selects the records from the database 5 using a predetermined criteria and performs required actions (specified by the method) with the selected data. The message processor 12 can work with any ODBC compatible database such as MS Access, MySQL, MS SQL, Oracle and others deployed on or accessible through the system network 1. In addition to saving specific data extracted from SMS messages to a file, the message processor 12 will save message attachments (e.g. moments such as photos, videos, sound files, and other media types) to specified storage locations in the RDBMS 5, or on other storage devices within the Apache Hadoop® system 15. The message processor 12 can rename the attachments and save them under new names on a selected data store, or forward the attachments to their destination under their current names. Ultimately, the stored attachments (e.g. moments) are linked to the BIN of a particular meosk master, or maters, active on the system network. Also, notifications will be generated and sent to the meosk masters when the processed email messages and associated attachments are ready for delivery to the meosk master(s) at their BIN, as shown in FIGS. 42A through 42C, accessible using a client subsystem 8A, 8B, 8C deployed on the system network, as described in great detail herein.

### Specification of the SMS Data Message Processing Architecture Supported on the System Network of the Present Invention for Processing and Delivering General-User SMS Message Services

Referring to FIG. 2G, the SMS message processing server and system 12 is shown configured for delivering general-user SMS message services within the system network of the present invention illustrated in FIGS. 1 through 1B-2.

As shown in FIG. 2G, the system 12 comprises: a first I/O module 12A for interfacing with cellular phone and SMS messaging system 10, via the Internet infrastructure; a decoding module for decoding incoming PDU messages to any suitable message format that can be handled by the computer software processing and handling the received messages along the data processing and handling stages of the SMS gateway server 12; a message filtering module 12B for instructing an embedded program (running on a local microprocessor and memory architecture within server 12) to process SMS messages according to the message processing rules 12C stored in the processor 12 (e.g. parsing incoming messages, looking or the subject, subject and body, header fields, email addresses, etc) and processing the data to meet the terms and conditions set forth in the method described in FIG. 2G; message processing rules 12C for processing SMS message data to carry out the method of FIG. 2G; data extraction module 12D for extracting any data from the message that is required by the method specified in FIG. 2G; a second I/O module 12E for interfacing with the RDBMS 5 and application servers 4; an action module 12F for performing various actions with the extracted data and with the SMS message itself, such as inserting extracted data into the database (RDBMS) 5, updating or deleting data from the database 5, saving the extracted data to a file, sending a reply message to the recipients, forwarding the original message to a specified destination, and performing all other actions required to carry out any preferred embodiment of the method specified in FIG. 2G; a message formation module 12F for forming messages required by the method specified in FIG. 2G; and an encoding module for encoding messages back to the PDU format for transport along the SM-TL layer to the Short Message Service Center (SMSC), and from there, to message destinations.

Referring to FIG. 2H, the flow chart describes the primary steps of a method carried out by the subsystem of FIG. 2G for handling and processing SMS messages and delivering general-user SMS message delivery supported on the system network of the present invention. As shown, the method of general-user SMS message delivery on system network comprises the steps of: (1) creating a general-user SMS number (e.g. 1-800-MY-MEOSK) and broadcast this SMS number to all registered system users; (2) maintaining within the RDBMS, a Master User List containing: (a) the email addresses and SMS numbers of all system users (registered and un-registered) who are a member of at least one inner circle of at least one meosk structure or weosk structure deployed on the system network, (b) the names of the inner circle member, (c) the meosk structures and/or weosk structures of which they are members, (d) the master of the meosk structure or weosk structure, and (e) the SMS number of the master; (3) for each message arriving at the SMS gateway server 12, analyzing the incoming message and deliver it to the SMS mail box specified by the receiver's SMS number (specified by the “to field”); (4) for each SMS message received at a system user's SMS number, (a) parsing the sender's SMS number from the received message, and analyze the received message so as to determine the identities and user-specific SMS numbers of all masters of meosk structures and weosk structures, of which the sender is an inner circle member verified by the parsed sender's SMS number compared with the master list; (b) creating a reply SMS messaging and reattaching any attached moments (e.g. photos, files etc) and comments thereto, and listing all masters of meosk structures and weosk structures of which the sender is an inner circle member, and instructions asking the sender to which masters do they wish the system admin to send and deliver the attached moments and comments, and a notification that they have received such moments using this general SMS delivery service; (5) sending and delivering the reply SMS message and attached moments and comments to the sender's SMS number, so the sender can send a response to the reply SMS back to the SMS gateway server 12 and identify to whom to deliver the message and attached moments, based on the sender's selections; and (6) sending the moments and comments to all users indicated by the sender of the moments and comments, and generating notifications at each SMS message destination.

During system network operation, the message processor 12 automatically reads SMS messages at intervals determined by the program scheduler running on the embedded microprocessor. The message processor 12 (i) extracts data fields and data content from incoming messages sent to the general-user SMS address (e.g. 1-800-MY-MEOSK) configured for the system network 1, and (ii) processes the extracted data as required to carry out the method described in FIG. 2H, including inserting extracted data elements to the RDBMS 5, search for system user SMS-number information in the RDBMS 5, as required to carry out the data processing method specified in FIG. 2H. During such operations, the message processor 12 selects the records from the RDBMS 5 using a predetermined criteria and performs required actions (specified by the method) with the selected data. The message processor 12 can work with any ODBC compatible database such as MS Access, MySQL, MS SQL, Oracle and others deployed on or accessible through the system network 1. In addition to saving specific data extracted from SMS messages to a file, the message processor 12 will save message attachments (e.g. moments such as photos, videos, sound files, and other media types) to specified storage locations in the RDBMS 5, or on other storage devices within the Apache Hadoop® system 15. The message processor 12 can rename the attachments and save them under new names on a selected data store, or forward the attachments to their destination under their current names. Ultimately, the stored attachments (e.g. moments) are linked to the BIN of a particular meosk master, or maters, active on the system network. Also, notifications will be generated and sent to the meosk masters when the processed email messages and associated attachments are ready for delivery to the meosk master(s) at their BIN, as shown in FIGS. 42A through 42C, accessible using a client subsystem deployed on the system network, as described in great detail herein.

### Specification of a Second Network Architecture of the System Network of the Present Invention

Referring to FIG. 3, a second network architecture is shown for the system network of the present invention 1′ for the case where the system network is implemented as an enterprise-level object-oriented system engineered (DOSE) computer application supported and executing within the data center(s) of one or more social networks deployed on the Internet. In this embodiment, the system network of the present invention is implemented using an object-oriented system-engineered (DOSE) application(s) supported by a social network (e.g. Facebook, Google+, etc) using its servers and resources for implementation, network user authentication, and log-in, etc. The advantage of this implementation would be sharing in the resources and partners of the social network platform, while the drawback might be complying with obligatory terms and conditions imposed on users and partners of the hosting social communication network.

As shown, the system network 1′ comprises: a cluster of web-based client machines 8A, 8B, 8C; a cluster of communication servers (i.e. http, ftp, TCP/IP, etc services) 3; a cluster of object-oriented application software servers 4; a cluster of relational database management system (RDBMS) servers 5; SMS gateway servers 12; email servers 13; and other servers, processors, databases, and data centers, arranged and configured in accordance with the principles of the present invention as taught herein.

### Specification of an Exemplary Database Schema for the Meosk/Weosk-Based Private and Social Media Management and Communication System Network of the Present Invention

FIG. 4 is a schematic representation providing a data schema for the object-oriented system-engineered (DOSE) software component of the system network of the present invention, executing on the client-server architecture specified in great detail throughout the present patent Specification. In general, the software component of the system network will consist of classes, and these classes can be organized into frameworks or libraries, that support the generation of graphical interface objects within GUI screens, control objects within the application or middle layer of the enterprise-level application, and enterprise or database objects represented within the system database (RDBMS) 5.

As shown in FIG. 4, the database schema comprises the following enterprise objects, represented within the system database (e.g. RDBMS 5), namely: consumer; brand manufacturer; service provider; system administrator; user ID; journey books; master; guest; inner circle; meosk; meosk ID; videos; photos; podcasts; brand message; URL; communication protocols; user ID; user account ID; moment; message; notification; activity code; brand assets; brand; post; weosk structure; weosk ID; service; product; ownership; private; shared; public; social networks; media type; activity-activity code table; service code; product code; contribution to moment; grab; photo-sharing sites; note; message; attachment; gift; favorite; gift wish list; and retailers. Theses objects are related according to the schematic representation illustrated in FIG. 4.

FIGS. 5A-1 and 5A-2, taken together, provide a schematic representation of a set of “core” object-oriented software modules, containing classes (written in an object-oriented programming language) supporting the system network of the present invention including the User Registration Module, User Account Management Module, Log-In Module, Setting Module, Contacts Module, Search Module, Synch Module, Help Module, Create New Meosk For Myself Module, Create New Meosk For Others Module, Inner Circles Module (Expand An Inner Circle; Reduce An Inner Circle), View My Bin Module: Delete Moment; Move Moment; Return Moment, Share Moments (Over Meosks) Module, Post My Meosks Module, Print Shop Module, Gift Shop Module, Create New Weosk For My Family Module, Create New Weosk For My Group Module, Share Moments (Over Weosks) Module, Post My Weosks Module, Message Center Module (Notifications, Messages) Capture Moments Module: Set Store Location; Select Capture Tool; Capture Moment, Favorite Moments Module, My Brands Module (Manage Brands Module, Gift Wish List Module, Gift-It Module), and Formal Stuff Module, Favor-It Module, Play-It Module, Note-It Module, Gift-It Module, Attach-It Module, Share-It Module, Grab-It Module, Post-It Module, Camera/Video Module, Drawing And Doodle Module, Microphone Module, Webclipper Module, Uploader Module, Manage Brands Module, Gift Wish Module, Meosk Messaging Module and Weosk Messaging Module.

FIGS. 5B-1, 5B-2, 5B-3, 5B-4, 5B-5 and 5C-1, taken together, provide a schematic representation of a set of “compositional-type” object-oriented software modules, containing classes (written in an object-oriented programming language) supporting the system network of the present invention. In the illustrative embodiment, this library includes: (i) the Header/Footer Control Module comprising the Home Page Module, Capture New Moment Module, Master Meosks Module, master weosks module, Inner Circle Module, message center module, My Brands Module, and Footer Control Module, (ii) The Home Page Module comprising the Message Center, Capture Moments Module, Master Meosks Module, Master Weosks Module, Favorite Moments Module, My Brands Module and Formal Stuff Module, (iii) The Footer Control Module (Panel) comprising the Log-In Module, Setting Module, Contacts Module, Search Module, Synch Module and Help Module, (iv) The Formal Stuff Module, About Us Module, Quest Product Tour Module, Privacy Policy Module, User Agreement Module, and Contact Us Module, (v) The Master Meosks Module comprising My Meosks Module, Meosk Module, Create New Meosks (For My Self and For Others), Inner Circles Module, View My Bin Module, Share Moments Module, Post My Meosks Module, and Print Shop Module, (vi) Master Weosks Module comprising My Weosks Module, Weosk Module, Create New Weosks (For My Family and For My Groups), Inner Circles Module, Share Moments Module, and Post My Weosks Module, (vii) Meosk Module comprising Capture Moments Module: (Camera/Video Module, Drawing And Doodle Module, Microphone Module, Webclipper Module, Uploader Module), Store My Journal Module (Favor-It Module, Play-It Module, Note-It Module, Gift-It Module, Attach-It Module, Share-It Module, Grab-It Module, and Post-It Module), Store My Album Module (Favor-It Module, Play-It Module, Note-It Module, Gift-It Module, Attach-It Module, Share-It Module, Grab-It Module, and Post-It Module), Store My Favorites Module (Favor-It Module, Play-It Module, Note-It Module, Gift-It Module, Attach-It Module, Share-It Module, Grab-It Module, and Post-It Module), Print Shop Module, Favorite (Moments) Channel Module, Brand Channel Module, My Brands Module, and Meosk Messaging Module, (viii) Weosk Module comprising the Capture Moments Module (Camera/Video Module, Drawing And Doodle Module, Microphone Module, Webclipper Module, Uploader Module), Store My Guest Book Module, Store Shared Album Module (Favor-It Module, Play-It Module, Note-It Module, Gift-It Module, Attach-It Module, Share-It Module, Grab-It Module, and Post-It Module), Group Calendar Module, Gift Shop Module, Print Shop Module, Favorite Channel Module, Brand Channel Module, My (Family/Group) Brands Module Weosk Messaging Module, (ix) Our Brands Module comprising the Manage Brands Module, Gift Wish List Module, and Gift-It Module, and (x) the Journey Book Module comprising the Log-In Module, Library Module, Set-Up Module, Search Module, Help Module, Journey Book Display Module (Display Journey Books By Year or By Activity) and the Journey Book Module.

### Specification of User Account Management Module of the Meosk/Weosk-Based Private and Social Media Management and Communication System Network of the Present Invention Supported by a Cloud Computing Platform

Referring to FIG. 5D, the user account management module employed in the system network of the present invention is illustrated in terms of a system user creating and managing collections of meosk structures and weosk structures for themselves, as well as on behalf of others, under a trusted relationship with a beneficiary user. Using the user account management module of the present invention, each registered system user can create and maintain “personal user accounts” for managing their own personal meosk structures (M) and weosk structures (W), and also “trustee user accounts” for managing meosks and weosks for other beneficiary users (e.g. their children, grandchildren, elderly parents or someone incapable of using the system without assistance), where these trustee user accounts can be returned to the beneficiary users at a later date, for future use and benefit, when they are older enough to manage their user accounts on the system network of the present invention.

As shown in FIG. 5D, exemplary User A holds her own Personal User Account, and also two Trustee User Accounts, namely: A Trustee User Account C for Beneficiary User C (e.g. her young daughter), and A Trustee User Account D for Beneficiary User D (e.g. her young son). As shown, under the Personal User Account, the master system user has created and deployed a number of activity-specific meosk structures, and a number of activity-specific weosk structures, each for her own benefit. Also, the master system user has or holds, in trust, a first Trustee User Account C for beneficiary User C, and also a second Trustee User Account D for beneficiary User D. Both of these Trustee User Accounts are linked to the master user's Personal User Account A, as shown. The User Account Management Module is used to create and maintain all user accounts maintained by system users on the system network of the present invention.

Specification of Core Functions Supported within Meosk Structures of the Present Invention Along the Privacy Continuum

Referring to FIG. 5E, the basic core functions supported within meosk structures on the system network, are displayed along the privacy continuum. On one end of the privacy continuum, the meosk structure contains only the meosk master in the meosk structure's inner circle, where the meosk structure is created around an interest or activity of an individual person, and a great sense of privacy for this person is assumed to be preserved, unless the master decides a need for others to join the inner circle of the meosk structure. If and when this is the case, then the master user invites others to join the meosk structure's inner circle members, and the inner circle grows to its appropriate size and scope as others accept these invitations to join the meosk inner circle.

Typically, the master user enables the entire set of core functions within each meosk structure (i.e. Store-It, Play-It, Favor-It, Note-It, Attach-It, Grab-It, Gift-It, Share-It, And Post-It). As will be described in greater detail hereinafter, these functions are “moment” related functions and are represented by graphical icons (e.g. labeled buttons) in many GUI screens supported by the object-oriented system application modules 20A through 20G of the system network. However, the meosk master may choose to disable any one or more of these core functions to achieve a desired degree of privacy and control through to be required or desired for the particular application at hand.

The meosk master can give inner circle members the right and power to invite other members to the inner circle. This can be done at the time when creating a new meosk structure, as illustrated in FIGS. 39L and 39M, or it can be done at any time thereafter using GUI displays provide in the Settings Module, accessible at the footer control panel of the client application. Each meosk structure supports messaging and conversations to take place within the inner circle, around stored moments and contributions being made to shared moments.

In the event the master enables the post-it function, the master or an authorized inner circle member can post a moment stored in the meosk structure to a public social media site, whereupon the meosk structure is taken into the public realm of the privacy continuum allowing others to view the moment, but not join the meosk structure's inner circle or contribute to the posted moment within the meosk structure. The meosk master may, however, allow anyone to join the meosk structure, and even post the meosk structure to a public URL on the www as illustrated in FIG. 39K, thereby placing the meosk at the other extreme end of the privacy continuum. At all times, the meosk master retains control to deactivate the meosk at any time, within their sole discretion.

Specification of Core Functions Supported within Weosk Structures of the Present Invention Along the Privacy Continuum

FIG. 5F is a schematic representation showing the basic functions supported within weosk structures deployed on the system network of the present invention along the privacy continuum. On one end of the privacy continuum, the weosk structure contains only the weosk master (i.e. master system user) in the weosk structure's inner circle. The weosk is created around an interest or activity of a group of individuals, and a great sense of privacy for this group is assumed to be preserved. As the master invites others to join the weosk structure's inner circle members, the inner circle grows quickly as others accept these invitations. If the weosk master enabled members to invite other members, as illustrated in FIGS. 60J and 61W, then it is expected that the inner circle growth can occur quite rapidly.

Typically, the master enables the entire set of core functions within each weosk structure (i.e. Store-It, Play-It, Favor-It, Note-It, Attach-It, Grab-It, Gift-It, Share-It, Post-It), but the weosk master may choose to disable certain functions to achieve a desired degree of privacy and control. As will be described in greater detail hereinafter, these functions are “moment” related functions and are represented by graphical icons (e.g. labeled buttons) in many GUI screens supported by the object-oriented system application modules 20A through 20G of the system network.

Each weosk structure supports messaging and conversations to take place within the inner circle, around stored moments and contributions being made to shared moments. Also, each member can tag and copy moments into their private meosk structures created to collect tagged and copied moments.

In the event the master enables the post-it function, the master or an authorized inner circle member can post a moment stored in the weosk structure to a public social media site, whereupon the weosk structure is taken into the public realm of the privacy continuum allowing others to view the moment, but not join the weosk structure's inner circle or contribute to the posted moment within the weosk structure. The weosk master may, however, allow anyone to join the weosk structure, and even post the weosk structure to a public URL on the WWW, thereby placing the weosk structure at the other end of the privacy continuum. at all times, the weosk master retains control to deactivate the weosk structure, at any time, within their sole discretion.

Specification of the System Architecture of and Prima Dataflow Pathways within Activity-Specific Meosk Structures Created and Deployed on the System Network of the Present Invention

Referring to FIG. 5G, the system architecture of and dataflow pathways for activity-specific meosk structures 50 are modeled in terms of the object-oriented system engineered software modules used to implement the system network of the illustrative embodiment of the present invention. As shown in FIG. 5G, these modules include: the Capture Moments Module comprising the Camera/Video Module, Drawing And Doodle Module, Microphone Module, Webclipper Module, Uploader Module; the Store My Journal Module; the Add-To-It Module comprising the Store My Album Module: the Add-To-It Module comprising the Favor-It Module, Play-It Module, Note-It Module, Gift-It Module, Attach-It Module, Share-It Module, Grab-It Module, and Post-It Module; the Print Shop Module; the Store My Favorites Module; the Add-To-It Module; the Favorite (Moments) Channel Module; the Brand Channel Module; the My Brands Module; and the Meosk Messaging Module.

Each activity-specific meosk structure 50 deployed on the system network 1 supports the various functions and services delivered on client machines 8A, 8B, 8C and illustrated by the GUI screens and workflows depicted in FIGS. 23 through 38C, and corresponding disclosure in the patent Specification. Among such functions and services are (i) capturing and storing moments in the available stores (e.g. albums, etc) supported within each meosk structure, (ii) adding or contributing to these moments using the core Add-To-It functions, (iii) selecting sharing these moments and associated contributions across meosk inner circle members, and (iv) posting these moments and associated contributions (and possibly meosk structures) across social network channels, as permitted by the meosk master. These functions will be described and illustrated in greater detail hereinafter.

Specification of the System Architecture of and Prima Dataflow Pathways within Activity-Specific Weosk Structures Created and Deployed on the System Network of the Present Invention

Referring to FIG. 5H, the system architecture of and dataflow pathways for activity-specific weosk subsystems 60 are modeled in terms of the object-oriented system engineered software modules used to implement the system network of the illustrative embodiment of the present invention. As shown in FIG. 5H, these modules include: the Capture Moments Module comprising Camera/Video Module, Drawing And Doodle Module, Microphone Module, WebClipper Module, UpLoader Module; the Store My Guest Book Module; the Store Shared Album Module; the Add-To-It Module comprising the Store My Album Module: the Add-To-It Module comprising the Favor-It Module, Play-It Module, Note-It Module, Gift-It Module, Attach-It Module, Share-It Module, Grab-It Module, and Post-It Module; the Group Calendar Module; the Gift Shop Module; the Print Shop Module; the Favorite Channel Module; the Brand Channel Module; the My (Family/Group) Brands Module; the Weosk Messaging Module; and the Our Brands Module comprising the Manage Brands Module, Gift Wish List Module, Gift-It Module.

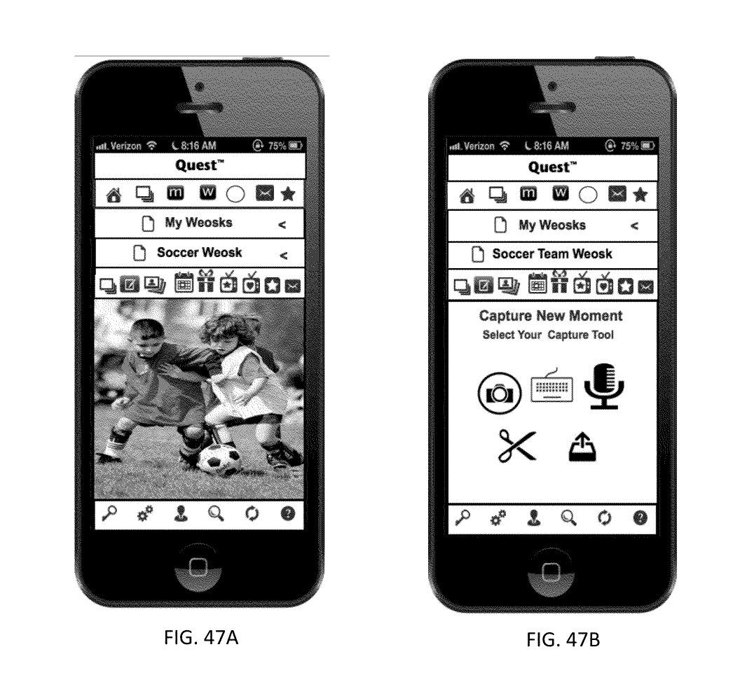

Each activity-specific weosk structure (i.e. subsystem) 60 deployed on the system network 1 supports the various functions and services delivered on client machines 8A, 8B, 8C and illustrated by the GUI screens and workflows depicted in FIGS. 47A through 59E, and corresponding disclosure in the patent Specification. Among such functions and services are (i) capturing and storing moments in the available stores (e.g. albums, etc) supported within each weosk structure, (ii) adding or contributing to these moments using the core Add-To-It functions, (iii) selecting sharing these moments and associated contributions across weosk inner circle members, and (iv) posting moments and contributing associated contributions (and also weosks) across social network channels, as permitted by the weosk master. These functions will be described and illustrated in greater detail hereinafter with reference to their GUI screen.

### Review of Technical Operation of the Meosk/Weosk-Based Private and Social Media Management and Management Communication System Network of the Illustrative Embodiment of the Present Invention

Having described the illustrative embodiment of the meosk/weosk-based private and social media management and communication system network 1 in great detail, it will be helpful to provide a consist yet comprehensive review of the system network, bringing all together how the primary system network components, GUI screens, meosk structures, weoek structures, graphical icons, information files in the information file storage and retrieval system, and the many functions and services supported by the system are delivered to client systems deployed on the system network and can used by hundreds of millions of system users representing individuals, families, social groups, companies, organizations and the like around the world.

As shown in the Figure Drawings, the meosk/weosk-based private and social media management and communication system network of the present invention 1 is capable of creating and deploying (i) a plurality of activity-specific meosk structures for organizing and managing information-based moments related to the activities of individuals and (ii) a plurality of activity-specific weosk structures for organizing and managing information-based moments related to the activities of group of individuals sharing an interest in a common activity.

As shown, the meosk/weosk-based private and social media management and communication system network comprises:

a plurality of communication servers 3, operably connected to the infrastructure of the Internet 7, for supporting http and other TCP/IP based communication protocols on the meosk/weosk-based private and social media management and communication system network;

a plurality of client systems 8A, 8B, 8C operably connected to the infrastructure of the Internet, and each the client subsystem having a computing platform shown in FIG. 1C and a display screen for displaying graphical user interfaces (GUIs) associated with one or more programs executing on the computing platform, and supporting services for system users on the system network;

a distributed information file storage and retrieval system 15 including (i) a relational database management system (RDBMS) 5 for organizing information files associated with information-based moments organized and managed in each activity-specific meosk structure (represented in FIG. 5G) and each activity-specific weosk structure (represented in FIG. 5H) created and deployed on the meosk/weosk-based private and social media management and communication system network, and (ii) information storage devices for storing the information files associated with the information-based moments organized in the plurality of activity-specific meosk structures and the plurality activity-specific weosk structures;

one or more object-oriented application servers 4, operably connected to the infrastructure of the Internet 7 and the RDBMS 5, for storing and executing modules of object-oriented code 20A through 20G, and generating processes having a server-side and a client-side and supporting a graphical user interface (GUI) based environment (FIGS. 6A-1 through 91F) available on the client-side and displayed on the client systems;

an email message processing server system 13 configured for delivering email message services within said system network, and being operably connected to the infrastructure of the Internet, and having in mailboxes and out mailboxes that are interfaced with a message handler, and a message processor, in operable communication with the object-oriented application servers 4;

an SMS message processing server system 12 configured for delivering SMS message services within said system network, and being operably connected to the infrastructure of the Internet, and comprising a SMS gateway server in operable communication with a Short Message Service Center (SMSC) in a cellular phone network 10, which is in operable communication with the object-oriented application servers 4;

wherein each client subsystem 8A, 8B, 8C supports the client-side of the processes generated by the one or more modules of object-oriented code executing on said one or object-oriented application servers; and

wherein the object-oriented application servers 4 and the modules 20A-20G are configured so that system users can receive the following services, enumerated (1) through (33) below, and delivered through the GUI screens displayed on the display screen of each client system deployed on the system network:

### Registering System Users on the System Network

(1) enable each individual to register as a system user on the meosk/weosk-based private and social media management and communication system network, and automatically create and assign a system network user account to the system user upon completing registration on the meosk/weosk-based private and social media management and communication system network, as illustrated in FIG. 5D,

wherein the system network user account is stored and maintained within the information storage devices of the distributed information file storage and retrieval system,

wherein the system user can be any individual seeking to use the meosk/weosk-based private and social media management and communication system network while pursuing ones interests and activities during ones life, as well as any brand management team member seeking to use the meosk/weosk-based private and social media management and communication system network while promoting a particular brand of products and/or services on the WWW, and

wherein each said system user is assigned a moment storage bin, linked to the system user's system network account, for storing information-based moments send by way of email and/or SMS based messaging services supported on the system network, where said moment storage bin is represented by unique graphical user interface object displayed on the display screen of the client system;

### Creating and Deploying Meosk Structures on System Network

(2) enable any said system user to create and deploy an activity-specific meosk structure for organizing and managing information-based moments related to the activities of an individual,

wherein each said activity-specific meosk structure is assigned an activity specific (AS) code identifying the activity for which said activity-specific meosk structure is being created and deployed,

wherein the system user creating and deploying said activity-specific meosk structure identifies and invites one or more other system users to be inner circle members who shall have access to information-based moments organized and managed within said activity-specific meosk structure,

wherein transmission of the invitation by said system user (i.e. meosk master) to said other system users, to join the inner circle of said activity-specific meosk structure, can be sent using (i) a messaging facility supported on said meosk/weosk-based private and social media management and communication system network, (ii) an active email address supported on the Internet, and (iii) an active SMS account supported by one of said client systems;

wherein said one or more system users identified as said inner circle members shall include the system user creating said activity-specific meosk structure, who shall also be identified as a or master administrator of said activity-specific meosk structure, or its meosk master,

wherein the system user creating and deploying said activity-specific meosk structure identifies and invites one or more other system users to be inner circle members, who shall have access to information-based moments organized and managed within said activity-specific meosk structure,

wherein transmission of the invitation by the system user (i.e. meosk master) to said other system users, to join the inner circle of the activity-specific meosk structure, and acceptance or rejection thereof can be transmitted using (i) a messaging facility supported on the meosk/weosk-based private and social media management and communication system network, (ii) an active email address supported on the Internet, and (iii) an active SMS account supported by one of the client systems;

wherein the activity-specific meosk structure contains a plurality of moment store icons logically representing different locations where information-based moments can be organized and managed, while information files, corresponding to the information-based moments, are stored in the information storage devices of the distributed information file storage and retrieval system,

wherein each the moment store icon indicates a unique location where a collection of moment icons is grouped, and

wherein each the moment icon represents at least one said information-based moment having a corresponding information file that is stored in the information storage devices of said distributed information file storage and retrieval system;

### Creating and Deploying Weosk Structures on System Network

(3) enable any system user to create and deploy an activity-specific weosk structures for organizing and managing information-based moments related to the activities of group of individuals sharing an interest in or around a common activity,

wherein each activity-specific weosk structure is assigned an activity specific (AS) code identifying the activity for which the activity-specific weosk structure is being created and deployed,

wherein the system user, creating and deploying the activity-specific weosk structure, identifies one or more system users to be inner circle members who shall have access to the information-based moments organized and managed within the activity-specific weosk structure,

wherein one or more system users identified as the inner circle members shall include the system user creating the activity-specific weosk structure, who shall also be identified as a master administrator of the activity-specific weosk structure, or its weosk master,

wherein the system user creating and deploying the activity-specific weosk structure identifies and invites one or more other system users to be inner circle members, who shall have access to information-based moments organized and managed within the activity-specific weosk structure,

wherein transmission of the invitation by the system user (i.e. weosk master) to the other system users, to join the inner circle of the activity-specific weosk structure, and acceptance or rejection thereof, can be transmitted using (i) a messaging facility supported on the meosk/weosk-based private and social media management and communication system network, (ii) an active email address supported on the Internet, and (iii) an active SMS account supported by one of the client systems;

wherein the activity-specific weosk structure contains a plurality of moment store icons logically representing different locations where information-based moments can be organized and managed, while information files, corresponding to the information-based moments, are stored in the information storage devices of the distributed information file storage and retrieval system,

wherein each the moment store icon indicates a unique location where a collection of moment icons is grouped, and

wherein each moment icon represents at least one information-based moment having a corresponding information file that is stored in the information storage devices of the distributed information file storage and retrieval system;

### Capturing Information-Based Moments Using Moment Capture Tools Accessed on a Client System on the System Network

(4) enable any system user to capture an information-based moment using moment capture tools accessed on one of the client machines deployed on the meosk/weosk-based private and social media management and communication system network, store the information file corresponding to the captured information-based moment in the information storage devices of the distributed information file storage and retrieval system, and organize and manage the moment icon associated with the captured information-based moment within one of the activity-specific meosk structures;

Capturing Information-Based Moments Using Moment Capture Tools Accessed from within an Activity-Specific Meosk Structure Deployed on the System Network

(5) enable any system user to capture an information-based moment using a moment capture tool accessed from within one of the activity-specific meosk structures deployed on the meosk/weosk-based private and social media management and communication system network, store the information file corresponding to the captured information-based moment in the information storage devices of the distributed information file storage and retrieval system, and organize and manage the moment icon associated with the captured information-based moment within the activity-specific meosk structure;

Capturing Information-Based Moments Using Moment Capture Tools Accessed from within an Activity-Specific Weosk Structure Deployed on the System Network

(6) enable any system user to capture an information-based moment using a moment capture tool accessed from within one of the activity-specific weosk structures deployed on the meosk/weosk-based private and social media management and communication system network, store the information file corresponding to the captured information-based moment in the information storage devices of the distributed information file storage and retrieval system, and organize and manage the moment icon associated with the captured information-based moment within the activity-specific weosk structure;

Messaging Services—within Each Activity-Specific Meosk Structure

(7) enable any system user, who is an inner circle member to any one of the activity-specific meosk structures, to use a messaging facility supported within the activity-specific meosk structure for sending messages to and receiving messages from other members in the inner circle of the activity-specific meosk structure;

Messaging Services—within Each Activity-Specific Weosk Structure

(8) enable any system user, who is an inner circle member to any one of the activity-specific weosk structures, to use a messaging facility supported within the activity-specific weosk structure for sending messages to and receiving messages from other members in the inner circle of the activity-specific weosk structure;

### The Store-it Moment Function

(9) enable any system user, who is an inner circle member of one of activity-specific meosk structures, to organize and manage the moment icons assigned to information-based moments within the activity-specific meosk structure, while corresponding information files associated with these information-based moments are stored in the information storage devices of the distributed information file storage and retrieval system;

### The Play-it Moment Function

(10) enable any system user, who is an inner circle member of one of the activity-specific meosk structures, to access and review the information-based moments having moment icons organized and managed within the activity-specific meosk based structures, while corresponding information files are stored in the information storage devices of said distributed information file storage and retrieval system;

### The Note-it Moment Function

(11) enable any system user, who is an inner circle member of one the activity-specific meosk structures, to attach a note to any information-based moment organized and managed within said activity-specific meosk structure, while the information file corresponding to the note is stored in the information storage devices of said distributed information file storage and retrieval system;

### The Attach-it Moment Function

(12) enable any system user, who is an inner circle member of one of the activity-specific meosk structures, to attach an information-based moment to any information-based moment having moment icons organized and managed in said activity-specific meosk structure, while the information file corresponding to the information-based moment is stored in the information storage devices of the distributed information file storage and retrieval system;

### The Favor-it Moment Function

(13) enable any system user, who is an inner circle member of one the activity-specific meosk structures, to affix a favorite index to any selected information-based moment having a moment icon organized and managed within the activity-specific meosk structure, while the information file corresponding to the favorite index is stored in the information storage devices of the distributed information file storage and retrieval system;

### The Grab-it Moment Function

(14) enable any system user, who is an inner circle member of one the activity-specific meosk structures, to grab information-based moments located on one or more of social networks deployed on said WWW, and copy and store the information-based moments in the information storage devices of the distributed information file storage and retrieval system, while organizing and managing the moment icons corresponding to the grabbed and copied information-based moments under the moment store icons of the activity-specific meosk structure;

### The Share-it Moment Function

(15) enable any system user, who is an inner circle member of one of the activity-specific meosk structures, to share said information moments having moment icons organized and managed within the activity-specific meosk structure, with selected inner circle members of the activity-specific meosk based structure, while information files corresponding to the shared information moments are stored in the information storage devices of the distributed information file storage and retrieval system;

### The Post-it Moment Function

(16) enable any system user, who is an inner circle member of one of the activity-specific meosk structures, to post on one or more of the social networks, one or more of said information moments having moment icons organized and managed within the activity-specific meosk structure, while the information files corresponding to the posted moments are stored in the information storage devices of the distributed information file storage and retrieval system;

### Manage Inner Circles

(17) enable any system user, who is an inner circle member of one of the activity-specific meosk structures, and a master user of said activity-specific meosk structure, to allow guest users in the inner circle of the activity-specific meosk structure to add other system users to, or remove system users from, the inner circle of the activity-specific meosk structure, to either expand or reduce the inner circle thereof, respectively;

### Automatically Create a Private Activity-Specific Meosk Structure for Each Activity Specific Weosk Structure

(18) enable any system user, who is a master user of one of the activity-specific weosk structures, to configure the object-oriented application servers and the modules so that a private activity-specific meosk structure is automatically created and deployed for each inner circle member of the activity-specific weosk structure,

whereupon the inner circle member tags and copied selected moments in the activity-specific weosk structure using tag an copy icons within the activity-specific weosk structure, while information files corresponding to tagged and copied moments are stored in the information storage files of the distributed information file storage and retrieval system, and moment icons for the tagged and copied information-based moments appear in the private activity-specific meosk structure, while information filed corresponding to the tagged and copied moment icons are stored in the information storage devices of the distributed information storage and retrieval system.

Tagging & Copying Moments within Activity-Specific Weosk Structures

(19) enable any system user, who is a master user of one of the activity-specific weosk structures, to allow guest users to tag information-based moments having moment icons organized and managed within a first one of the activity-specific meosk structures, and to copy the tagged information-based moments to a second one or the activity-specific meosk structures, while the information files corresponding to the tagged and copied information-based moments are stored in the information storage devices of the distributed information file storage and retrieval system;

### Linking a Moment in an Activity-Specific Meosk Structure to an Event

(20) enable any system user, who is a master user of one of the activity-specific meosk structures, to link a selected one of said activity-specific meosks structures to a particular event marked on a calendar maintained for the activity-specific meosk structure, deployed on the meosk-based private and social media management and communication system network;

### Linking an Activity-Specific Meosk Structure to an Activity-Specific Meosk Structure

(21) enable any system user, who is a master user of one of the activity-specific weosk structures, to link a first selected one of the activity-specific meosk structures to a second selected one of the activity-specific meosk structures, deployed on the meosk-based private and social media management and communication system network;

### Reverse-Inquiry Based Mechanism for Establishing Brand Contact and Communication

(22) during or after the creation and deployment of each activity-specific meosk structure, the system user creating the activity-specific meosk structure (i.e. meosk master) is (i) presented with one or more GUI screens displaying a generic list of products and/or services, related to the practice of the activity identified by the activity code assigned to the activity-specific meosk structure, and (ii) requested to select one or more brands of product and/or services about which said meosk master would like to receive information and/or contact from the brand by way of messaging services supported on the meosk/weosk-based private and social media management and communication network;

### Enabling the Brand Channel of an Activity-Specific Meosk Structure

(23) enable any system user, who is a master user of one of the activity-specific meosk structures, to enable a media-player implemented brand channel supported within the activity-specific meosk structure so that members of the inner circle of the activity-specific meosk structure can view videos and other programmed media played by the media-player implemented brand channel, and wherein the brands which said system user has selected for brand contact have a right to contribute to the programming of the media-player implemented brand channel;

### Enabling the Favorites Channel of an Activity-Specific Meosk Structure

(24) enable any system user, who is a master user of one of the activity-specific meosk structures, to enable a media-player implemented favorites channel supported within the activity-specific meosk structure so that members of the inner circle of the activity-specific meosk structure can view information-based moments indexed as favorite, can be programmed into and displayed for viewing from the media-player implemented favorites channel;

### Enabling the Brand Channel of an Activity-Specific Weosk Structure

(25) enable any system user, who is a master user of one of the activity-specific weosk structures, to enable a media-player implemented brand channel supported within the activity-specific weosk structure so that members of the inner circle of the activity-specific weosk structure can view videos and other programmed media played by the media-player implemented brand channel, and wherein the brands which the system user has selected for brand contact have a right to contribute to the programming of the media-player implemented brand channel;

### Enabling the Favorites Channel of an Activity-Specific Weosk Structure

(26) enable any system user, who is a master user of one of the activity-specific weosk structures, to enable a media-player implemented favorites channel supported within the activity-specific weosk structure so that members of the inner circle of the activity-specific weosk structure can view information-based moments indexed as favorite, can be programmed into and displayed for viewing from the media-player implemented favorites channel;

### Enabling the Print Shop of an Activity-Specific Weosk Structure

(27) enable any system user, who is a master user of one of the activity-specific meosk structures, to enable the generation of journey books, each composed of moments selected from particular the activity-specific meosk structures, which the meosk master has created and deployed;

### Sending Moments to System User Using User-Specific SMS Messaging Service

(28) enable any system user, who is an inner circle member of one of the activity-specific meosk structures, to send information-based moments to another system user who is a master user of one the activity-specific meosk structure, by way of user-specific SMS message delivery method supported on the system network comprising the steps of:

(1) assigning a user-specific SMS number to each registered system user;

(2) maintaining within the system database, a master user list containing the SMS numbers and email addresses of all registered system users;

(3) for each message arriving at a SMS gateway server, analyzing the incoming message and delivering it to the SMS mail box specified by the receiver's SMS number (specified by the “To Field”); and

(4) for each SMS message received at a System SMS Number, (a) parsing the received message, (b) extracting any attached information-based moments (e.g. photos, files etc) and comments, (c) delivering the moments and comments to the registered system user's said moment storage bin, and (d) sending a notification to the registered system user (receiving SMS) that a new moment has arrived and is in the moment storage bin;

### Sending Moments to System User Using User-Specific Email Messaging Service

(29) enable any system user, who is an inner circle member of one of the activity-specific meosk structures, to send information-based moments to another system user who is a master user of one said activity-specific meosk structure, by way of an user-specific email message delivery method supported on the system network comprising the steps of:

(1) assigning a User-Specific Email Address (e.g. firstname.lastname.yearofbirth@questmeosk.com) to each registered system user;

(2) maintaining within the system database, a Master User List containing the email addresses of all registered system users;

(3) for each message arriving at the email processing server, analyze the incoming message and deliver it to the mail box address specified by the receiver's email address (specified by the “To Field”); and

(4) for each email message received at a system user's email address, (a) parse the received message, (b) extract any attached information-based moments (e.g. photos, files etc) and comments, (c) deliver the information-based moments and comments to the registered system user's moment storage bin, and (d) send a notification to the registered system user (receiving email) that a new moment has arrived and is available for access in the moment storage bin for review.

### Sending Moments to System User Using General-Delivery SMS Messaging Service

(30) enable any system user, who is an inner circle member of one of the activity-specific meosk structures, to send information-based moments to another system user who is a master user of one the activity-specific meosk structure, by way of a general-delivery SMS message delivery method supported on the system network comprising the steps of:

(1) creating a general-user SMS number (e.g. 1-800-MY-MEOSK) and broadcast this SMS number to all registered system users;

(2) maintaining within the system database, a Master User List containing: (a) the email addresses and SMS numbers of all system users (registered and un-registered) who are a member of at least one inner circle of at least one meosk structure or weosk structure deployed on the system network, (b) the names of the inner circle member, (c) the meosk structures and/or weosk structures of which they are members, (d) the master of the meosk structure or weosk structure, and (e) the SMS number of the master user;

(3) for each message arriving at the SMS gateway server, analyzing the incoming message and deliver it to the SMS mail box specified by the receiver's SMS number (specified by the “to field”);

(4) for each SMS message received at a system user's SMS number, (a) parsing the sender's SMS number from the received message, and analyze the received message so as to determine the identities and user-specific SMS numbers of all masters of meosk structures and weosk structures, of which the sender is an inner circle member verified by the parsed sender's SMS number compared with the master list; (b) creating a reply SMS messaging and reattaching any attached moments (e.g. photos, files etc) and comments thereto, and listing all masters of meosk structures and weosk structures of which the sender is an inner circle member, and instructions asking the sender to which masters do they wish the system admin to send and deliver the attached moments and comments, and a notification that they have received such moments using this general SMS delivery service;

(5) sending and delivering the reply SMS message and attached moments and comments to the sender's SMS number, so the sender can send a response to the reply SMS back to the SMS gateway server and identify to whom to deliver the message and attached moments, based on the sender's selections; and

(6) sending the moments and comments to all users indicated by the sender of the moments and comments, and generating notifications at each SMS message destination.

### Sending Moments to System User Using General-Delivery Email Messaging Service

(31) enable any system user, who is an inner circle member of one of the activity-specific meosk structures, to send information-based moments to another system user who is a master user of one said activity-specific meosk structure, by way of a general-delivery email message delivery method supported on the system network comprising the steps of:

(1) creating a general-user email address (e.g. generaldelivery@questmeosk.com) and broadcast this email address to all registered and non-registered system users;

(2) maintaining within the system database, a Master User List containing: (a) the email addresses and SMS/text numbers of all system users (registered and un-registered) who are a member of at least one inner circle of at least one meosk structure or weosk structure deployed on the system network, (b) the names of the inner circle member, (c) the meosk structures and/or weosk structures to which they are members, (d) the master of the meosk structure or weosk structure, and (e) the email address of the master user;

(3) for each message arriving at the email processing server, analyzing the incoming message and deliver it to the mail box address specified by the receiver's email address (specified by the “To Field”);

(4) for each email message received at a system user's email address, (a) parsing the email sender's email address from the received message, and analyze the received message so as to determine the identities and user-specific email addresses of all masters of meosk structures and weosk structures, of which the email sender is an inner circle member verified by the parsed sender's email address compared with the master list; (b) creating a reply email messaging and reattaching any attached moments (e.g. photos, files etc) and comments thereto, and listing all masters of meosk structures and weosk structures of which the email sender is an inner circle member, and instructions asking the sender to which masters do they wish the system admin to send and deliver the attached moments and comments, and a notification that they have received such moments using this general email delivery service;

(5) sending and delivering the reply email message and attached moments and comments to the sender's email address, so the sender can a response to the reply email address back to the email server and identify to whom to deliver the message and attached moments; and

(6) sending the moments and comments to all users indicated by the sender of the moments and comments and generate notifications at each email destination.

Posting an Activity-Specific Meosk Structure on a Social Network Media Sharing Site and/or Elsewhere Along the Fabric of the WWW

(32) enable any system user, who is a master user of one of the activity-specific meosk structures, to post the activity-specific meosk structure on a social network, media sharing site and/or elsewhere along the fabric of the WWW at specified URL.

### Generating a Public View of AN Activity-Specific Meosk Structure and Publishing the Public View on a Social Network, Media Sharing Site and Elsewhere Along the Fabric of the WWW

(33) enable any system user, who is a master user of one of the activity-specific meosk structures, to select information-based moments organized and managed within the activity-specific meosk structure for a public view of the activity-specific meosk structure, and then publishing the public view of the activity-specific meosk structure on a social network, media sharing site and/or elsewhere along the fabric of the WWW at specified URL.

There are other additional features and functions supported by the system network of the present invention, and these features and functions will described in great technical detail hereinbelow. The primary purpose of the above review is to provide a big picture snapshot of the industry-wide enterprise-level system network of the present invention. It is understood that alternative embodiments may not employ many of the features and functions supported in the system network 1 described above, and some may add additional features and functions not disclosed herein. All such modifications should be considered with the scope and spirit of the present invention taught herein.

### Primary GUI Screens for the System Network of the Illustrative Embodiment of the Present Invention

The various services supported by system of the present invention are supported by a variety of graphical user interfaces (GUIS), shown in FIGS. 6A-1 through 89B-2. As shown, each GUI screen in the Drawings will be generated and maintained by server-side-driven, client-side-driven and/or client-server-driven processes, supported by object-oriented modules of the system application layer of the system network of the present invention. Also, each GUI screen will typically contain numerous unique, recognizable icons which, when selected, trigger server-side-driven, client-side-driven and/or client-server-driven processes and the generation and display of new or transformed GUI screens on client systems 8A, 8B, 8C, to provide the master and/or guest users with the services/functionalities associated with selected icons and supporting modules. The details of these modules, graphical icons and corresponding services will be described in greater detail hereinafter.

As shown, the system network has been designed for several different kinds of user roles including, for example: (i) individual consumers who will create meosk structures and weosk structures centered around their interests, activities and dreams; (ii) brands (i.e. brand managers and their management teams) including their advertising and promotional agencies; and (iii) administrators of the system network, depending on which role for which the user requests registration, the system network will request different sets of registration information, including name of user, address, contact information, information about the user etc. Once the user has successfully registered with the system network, the system network will automatically serve a native client GUI, or an HTML5 GUI, adapted for the registered user. In particular, for a registered Brand, the system network 1 will serve one or more of the GUIs shown in FIGS. 6A through 6F-15. For an individual consumer who wishes to create, deploy and manage meosk structures and/or weosk structures, the system network will serve one or more of the GUI screens illustrated in FIGS. 11-A through 89B-2.

In general, the system network supports registration processes for a number of different stakeholders on the system network, namely: (i) consumers and individuals; (ii) brands and agencies; and (iii) system administrators. For consumers and individuals, who wish to create meosk structures and weosk structures around the interests, activities and pursuits, the system network seeks to collect the following information for system user account management: name, age (year born), and e-mail address. For brands and agencies, the system network seeks to collect the following information for system user account management: corporate name; brand name(s) and marks owned by sponsor; brand manager contact information; e-mail address; website address. Thereafter, when the user logs into the system network, using his/her account name and password, the system network will automatically generate and serve GUI screens described below for the role that the user has been registered with the system network.

### Specification of Brand Management Module of the Meosk/Weosk-Based Private and Social Media Management and Communication System Network of the Present Invention

FIGS. 6A-1 through 6A-6 shows GUIs for the brand management module of the system network. The function of these GUIs is to enable Brands to perform a number of marketing functions on the system: (i) communicate directly with consumers via messaging through the system network, while the user maintains its anonymous user credentials; (ii) manage digital assets for the brand's products and services, within each brand's digital asset library supported on the system network, including videos, photos, audio/podcasts and brand widgets; (iii) manage brand-messages/marketing-communications through meosk and weosk brand channels; (iv) manage meosk and weosk messaging using customizable forms and templates for distribution to targeted consumers and demographics; and (v) access targeted consumer metrics in real time on demand and customizable to specific campaigns and market research “hot topics”.

As shown in FIGS. 6A1 through 6A-6, each GUI screen contains numerous unique, recognizable icons which, when selected, trigger server-side-driven, client-side-driven and/or client-server-driven processes and the generation and display of new or transformed GUI screens on client systems 8A, 8B, 8C, to provide the system users with the services/functionalities associated with selected icons and supporting modules. The details of this module, its graphical icons and corresponding services will be described in greater detail hereinafter.

FIG. 6A-1 through 6A-6 show a series of GUI screens supported by the Brand Manager Module of the system network of the present invention, wherein a brand user can easily log-into the system via a mobile wireless tablet or computer (e.g. Apple® iPad), configure the consumer product catalog of associated with the client brand user's account, and select the brand, category, products and services to be managed on the system network, using simple to use pull-down menus, and touch screen controls, as shown in these GUI screens.

FIG. 6B-1 through 6B-7 show a series of GUI screens supported by the Brand Manager Module of the system network of the present invention, wherein a client brand user can select product/service categories, list products/services, add products/services to the client brand's catalog, and product reports on the client's product/service catalogs.

FIG. 6C-1 through 6C-5 show a series of GUI screens supported by the Brand Manager Module of the system network of the present invention, wherein a client brand user can review inbound, outbound and draft messages from a single central location on the system network.

FIG. 6D-1 through 6D-5 show a series of GUI screens supported by the Brand Manager Module of the system network of the present invention, wherein, from a single central location on the system network, a client brand user can (i) review advertising, promotional and product information spots running on brand channels of deployed meosk structures and weosk structures that are supported by the client brand's products and/or services, (ii) review messages sent by the brand manager or agent to the message center of meosk structures and weosk structures supported by the client brand's products and/or services, (iii) create, preview, run and manage new advertising, promotional, and product information spots running on brand channels of meosk structures and weosk structures supported by selected brands, and (iv) control marketing communications across the brand's networks of meosks and weosks deployed along, in and about consumer social media channels.

Managing the Brand Assets and Messaging Templates of Each Brand Registered with the System Network of the Present Invention

FIGS. 6E-1 through 6E-6 show a series of GUI screens supported by the Brand Manager Module of the system network of the present invention, wherein, from a single central location on the system network, a client brand user can store, manage and use, on the system network, all of the brand assets for its product/service catalogs, including (i) digital photographs of the client brand's products and services and the lifestyle of consumers which the brand serves, (ii) digital videos of advertisements, promotions and product and service tours/demos, communicating the value and lifestyle which the brand's products and services promise to deliver, (iii) audio/video podcasts of interviews, product and service tutorials, endorsements, Reviews and the like, (iv) widgets and apps that build and communicate the brand's uniqueness and value in the marketplace, (v) message forms (i.e. templates) for use by the brand's marketing communication specialists during meosk-based and weosk-based messaging operations, to send out messages that deliver Welcome Letters, Update on Events in Your Area communications, Invitations To Special Exclusive Sales, Invitations To Private Sales, Surveys, Haven't Heard From You In A While communications, Video Transmittals, Podcast Transmittals, Brand Sponsorship Offers etc.

Anytime after registering with the system network, a registered brand can specify and manage which brand assets shall be maintained within its set of brand assets, stored on the information servers of the system network 1 so that such brand assets will be available to be pushed to and experienced within activity-specific meosk structures created and deployed by individuals, during relationship building efforts by the brand management team. As indicated, the brand management team members log out from the system network. Using the brand management module (i.e. application), brand managers and their support teams can program digital content on a particular subject or topic to appear in the brand channel of any given activity-specific meosk structure (or activity-specific weosk structure) created and deployed by an individual interested in the subject area or field of the program content channel. This subject/interest selection would be made by the individual meosk/weosk master (i.e. creator) at the time of meosk/weosk creation and deployment, to be described in greater detail below. Preferably, all activity-specific meosk structures will have one or more pre-programmed brand (content) channels produced by sponsoring brands, and these programmed content channels will be integrated into the structure of the meosk structure, and contain video content that is related to the given field of interest or activity (i) for which the activity-specific meosk structure has been created and deployed by the individual, or administrator, or (ii) which meosk guests are expected to visit, spend time and show interest.

### Specification of Brand Management Module of the Meosk/Weosk-Based Private and Social Media Management and Communication System Network of the Present Invention

FIG. 6F-1 through 6F-15 show a series of GUI screens supported by the consumer metrics part of the Brand Manager Module of the system network of the present invention. Using this brand marketing communication tool, from a single central location on the system network, a client brand and its team members can generate from a wide array of large datasets, metrics on meosk structures, metrics on weosk structures, metrics on inner circles, metrics on stored moments, metrics on messages, metrics on brands, metrics on brand channels, metrics on attachments to moments, metrics on grabbed moments, metrics on favorites, metrics on moment sharing, and metrics on moment posts.

### Specification of the Method of Marketing Communication on the Meosk/Weosk-Based Private and Social Media Management and Communication System Network of the Present Invention

FIGS. 7A and 7B, taken together, present a flow chart describing the primary steps involved in carrying out the method of meosk-based marketing communication by a client brand user registered to use the meosk-based private and social media management and communication system network 1, 1′.

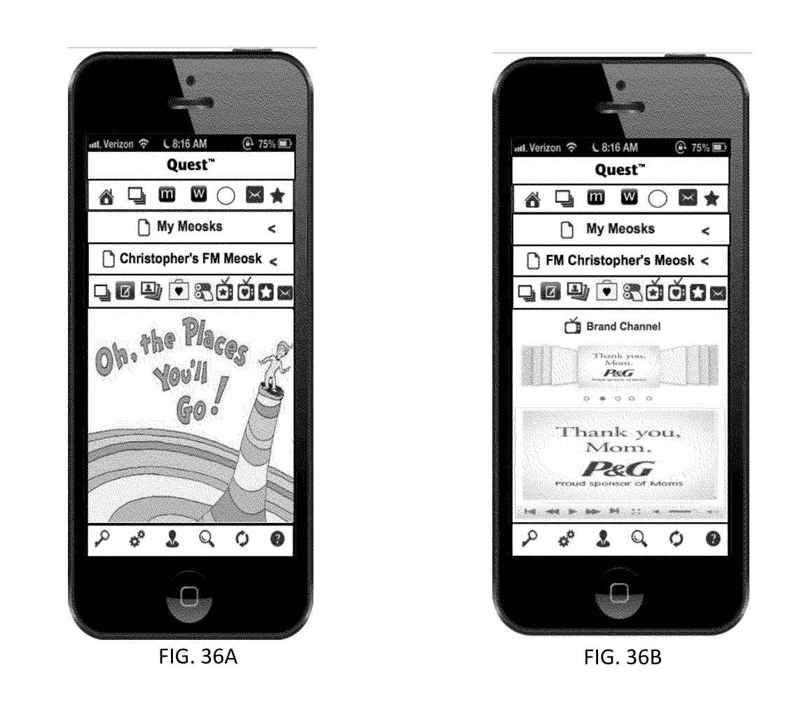

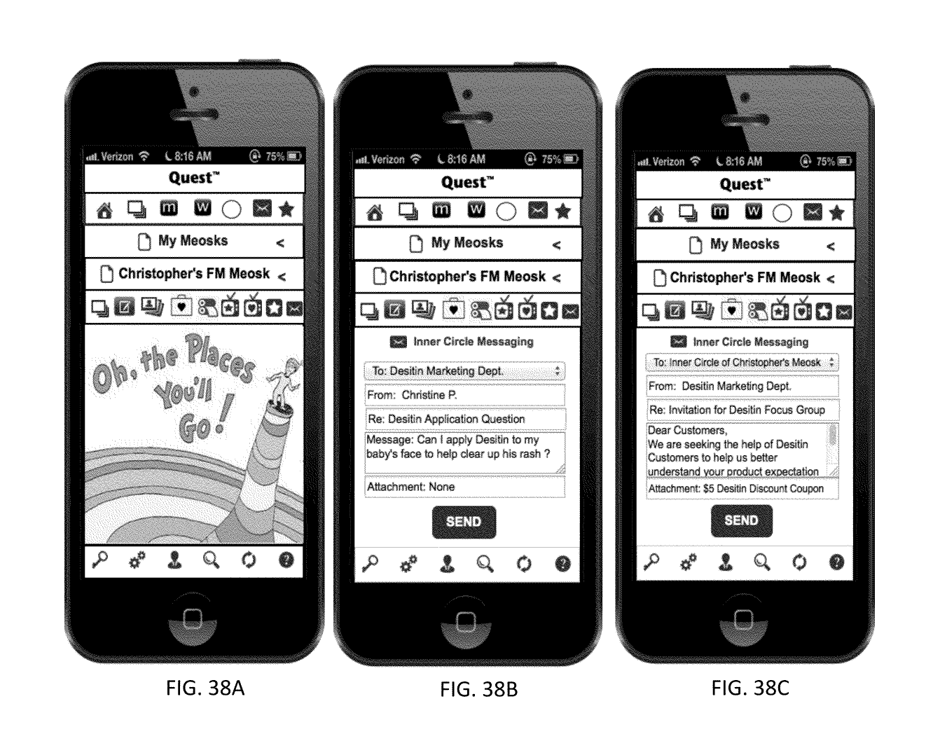

As indicated at Block A on FIG. 7A, the method of marketing communication on the meosk-based private and social media management and communication system network comprises a number of steps. The first step involves the client brand user logging into the system network 1, using the GUI screen illustrated in FIG. 6A-1. The meosk-based private and social media management and communication system network supports system database (RDBMS) 5, wherein each activity-specific meosk structure 50 stores one or more moments (i.e. digital assets), and one or more messages associated with each stored moment. Each activity-specific meosk structure 50 has an inner circle of members who have the right to (i) access and review the moments and messages organized and managed in said activity-specific meosk structure, by way of communication techniques exercised over the system network, and also (ii) contribute messages and moments to the activity-specific meosk structure as allowed by the meosk master. Each activity-specific meosk structure has at least one message communication facility (e.g. a brand channel as illustrated in FIG. 36B and/or local messaging center as illustrated in FIGS. 38B and 38C for communicating product and/or service marketing messages from brands to the master user, which the master user has requested to contact the master user through the communication facility of the activity-specific meosk structure.

As indicated at Block B in FIG. 7A, upon accepting the terms and conditions (T&C) for users of the system network and completing registration on the system network, the client brand system user gains access to a brand management module configured for the registered brand on the system network, as illustrated in GUI screens shown in FIGS. 6A-2 through 6F-15. GUI Screens shown in FIGS. 6A2-6A6 allow client brand users to configure the brand management module for the client's purposes.

Thereafter, the client brand user uses the GUI screens shown in FIGS. 6B-1 and 6B-7 to manage its product and service brand catalogs containing the products and services being marketed and offered for sale on the WWW as well as bricks & mortar, and bricks & clicks stores, as the case may be. Typically, branded products will have assigned UPC or UPC/EAN product identifiers, trademarks, and product descriptors used to manage products along the retail supply and demand chain, as described in U.S. Pat. Nos. 7,848,948; 7,844,492; and 7,430,528 by Perkowski et al, incorporated herein by reference. Similarly, branded services in the client brand user's catalog will bear assigned service identifiers, service marks and service descriptors.

As indicated at Block C in FIG. 7A, the client brand user uses the brand management module to upload, add or delete digital assets stored within the system database on the system network, using the GUI screens shown in FIGS. 6E1 through 6E-6.

As indicated at Block D in FIG. 7B, the client brand user uses the digital assets to create, run and manage ad, promo and/or product/service information (i.e. infomercial) spots across the brand channel of the activity-specific meosk structure supported by the brand at the request of the master of the activity-specific meosk structure, using the GUI screens shown in FIGS. 6D1 through 6D-5.

As indicated at Block E in FIG. 7B, the client brand user creates and sends messages to the brand channel of activity-specific meosk structure deployed on the system network, to help brand marketers establish, build and maintain their relationship with consumers, using the GUI screens in FIGS. 6C1 through 6C-5.

As indicated at Block F in FIG. 7B, the client brand user logs off the system network.

Specification of a Method of Producing Metrics from Data Sets Collected from the Meosk-Based Private and Social Media Management and Communication System Network of the Present Invention

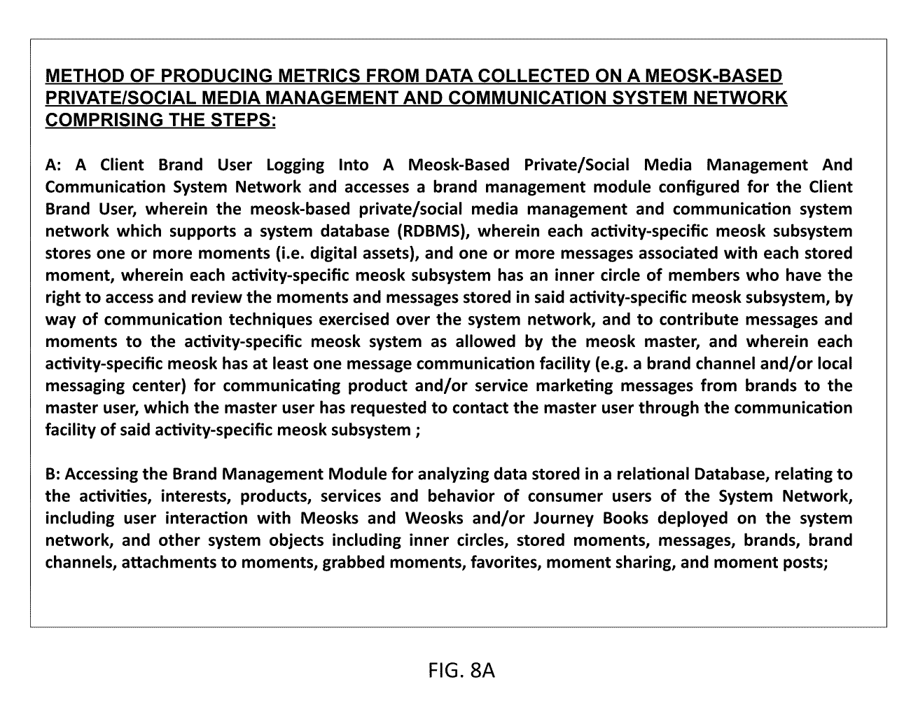

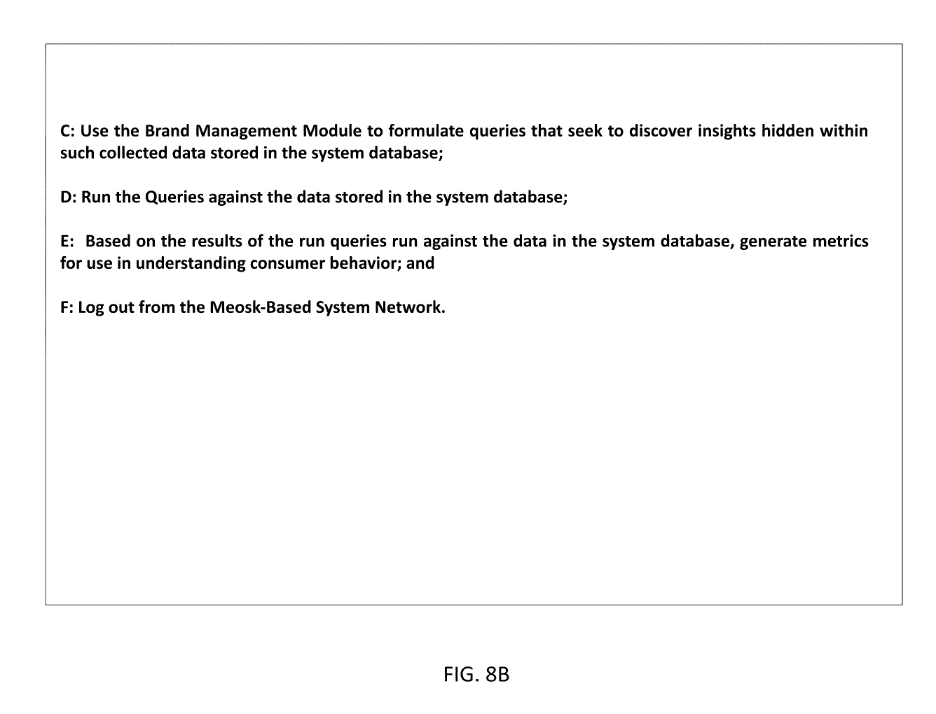

FIGS. 8A and 8B, taken together, set forth a flow chart describing the primary steps involved in carrying out a method of producing metrics from data collected on a meosk-based private and social media management and communication system network 1, using the FIGS. 6F1 through 6F-15.

As indicated in Block A of FIG. 8A, the first step of the method involves a client brand user logging into a meosk-based private and social media management and communication system network 1 and accessing the brand management module configured for the client brand. The meosk-based private and social media management and communication system network 1 supports system database (RDBMS) 5, wherein each activity-specific meosk structure 50 stores one or more moments (i.e. digital assets), and one or more messages associated with each stored moment. Each activity-specific meosk structure 50 has an inner circle of members who have the right to (i) access and review the moments and messages organized and managed in said activity-specific meosk structure, by way of communication techniques exercised over the system network, and also (ii) contribute messages and moments to the activity-specific meosk structure as allowed by the meosk master. Each activity-specific meosk structure has at least one message communication facility (e.g. a brand channel as illustrated in FIG. 36B and/or local messaging center as illustrated in FIGS. 38B and 38C for communicating product and/or service marketing messages from brands to the master user, which the master user has requested to contact the master user through the communication facility of the activity-specific meosk structure.

As indicated in Block B of FIG. 8A, the brand management module is accessed for analyzing data stored in the system database 5, relating to the activities, interests, products, services and behavior of consumer users of the system network, including user interaction with activity-specific meosk structures and/or journey books deployed on the system network, and other system objects including inner circles, stored moments, messages, brands, brand channels, attachments to moments, grabbed moments, favorites, moment sharing, and moment posts.

As indicated in Block C of FIG. 8B, the brand management module is used to formulate queries that seek to discover insights hidden within such collected stored data.

As indicated in Block D of FIG. 8B, the queries are run against the data stored in the system database 5.

As indicated in Block E of FIG. 8B, based on the results of running queries run against the data in the system database, metrics are generated for use in understanding consumer behavior.

As indicated in Block F of FIG. 8B, the client brand user logs off the meosk-based system network.

Specification of Method of Brand Messaging within a Meosk-Based Private and Social Media Management and Communication System Network of the Present Invention

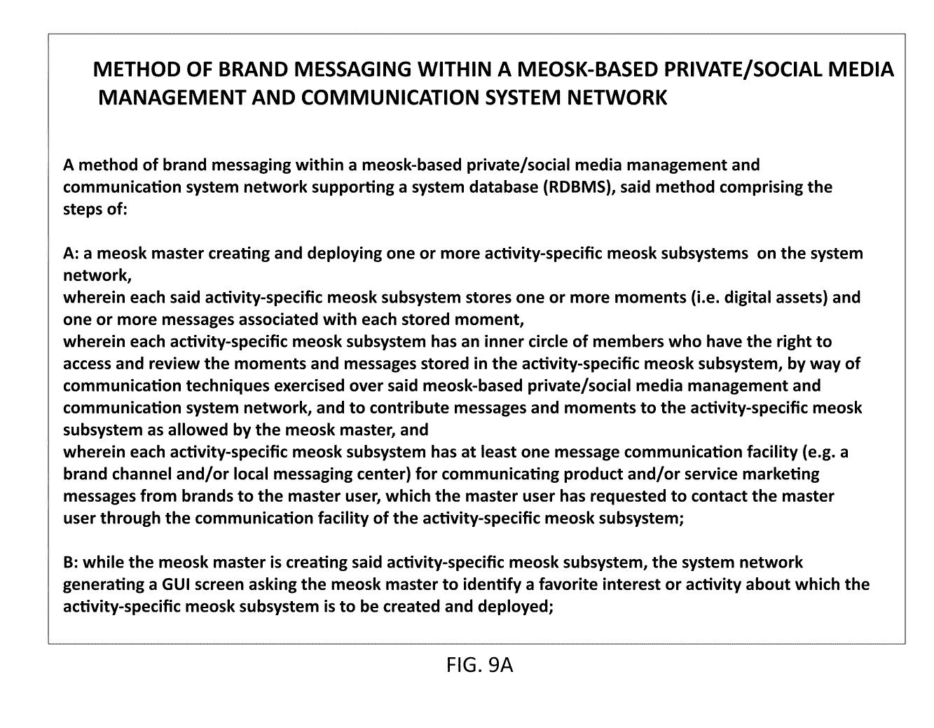

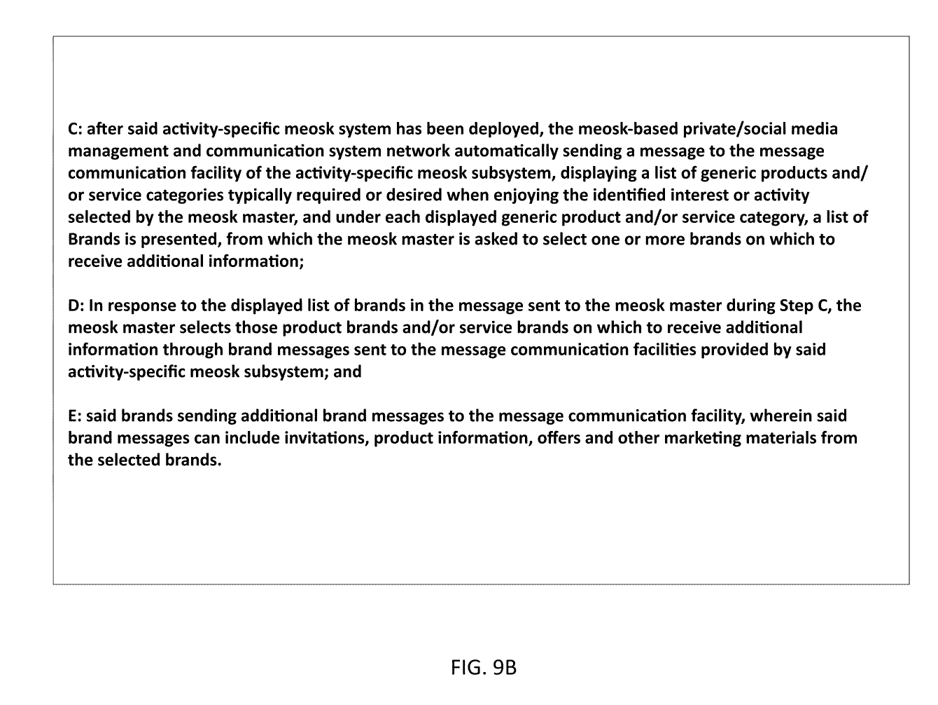

Referring to FIGS. 9A and 9B, the primary steps for carried out the method of brand messaging within a meosk-based private and social media management and communication system network 1 will be described.

As indicated at Block A in FIG. 9A, the first step in the method involves the meosk master creating and deploying one or more activity-specific meosk structures on the meosk-based private and social media management and communication system network 1. The meosk-based private and social media management and communication system network supports system database (RDBMS) 5, wherein each activity-specific meosk structure 50 stores one or more moments (i.e. digital assets), and one or more messages associated with each stored moment. Each activity-specific meosk structure 50 has an inner circle of members who have the right to (i) access and review the moments and messages organized and managed in said activity-specific meosk structure, by way of communication techniques exercised over the system network, and also (ii) contribute messages and moments to the activity-specific meosk structure as allowed by the meosk master. Each activity-specific meosk structure has at least one message communication facility (e.g. a brand channel as illustrated in FIG. 36B and/or local messaging center as illustrated in FIGS. 38B and 38C for communicating product and/or service marketing messages from brands to the master user, which the master user has requested to contact the master user through the communication facility of the activity-specific meosk structure.

As indicated at Block B in FIG. 9A, while the meosk master is creating the activity-specific meosk structure, the system network generates a GUI screen asking the meosk master to identify a favorite interest or activity about which the activity-specific meosk structure is to be created and deployed. This step is illustrated in FIG. 39D through 39D-1 through 39D-21. Notably, in the illustrative embodiment, the meosk master is required to answer this question in order to create a new meosk structure on the system network of the present invention. In other embodiments, this constraint may be relaxed at the time of new meosk creation, and instead, the system network may send a message to the meosk master, using the inner messaging center shown in FIGS. 38A and 38B, asking this question after the creation and deployment of the new meosk structure.

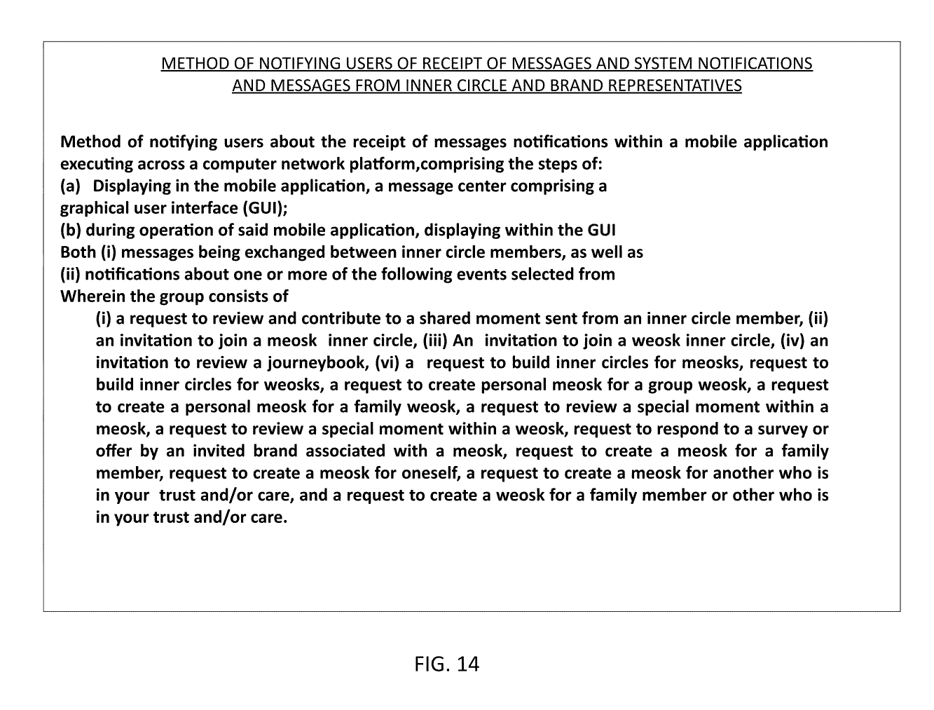

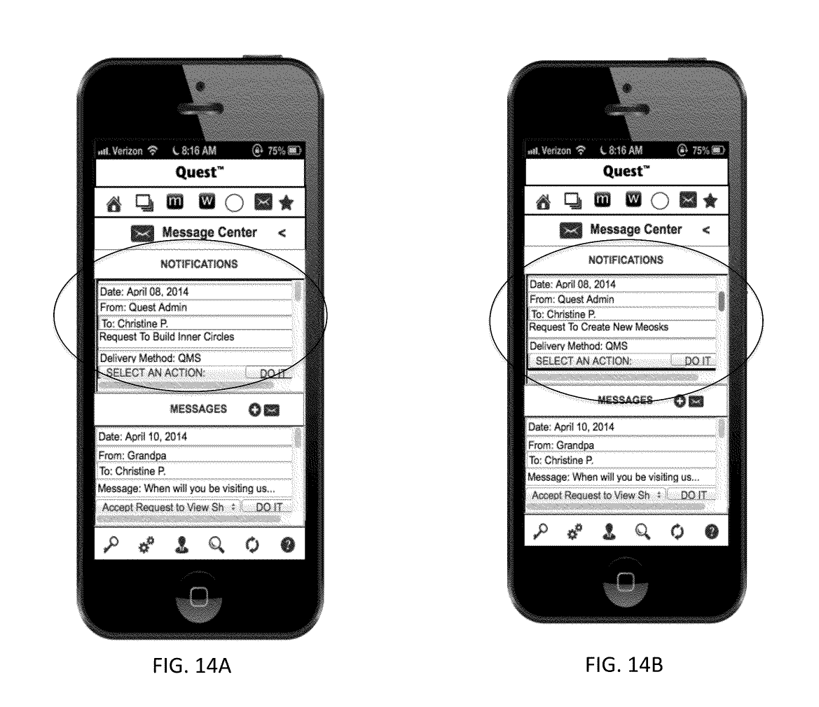

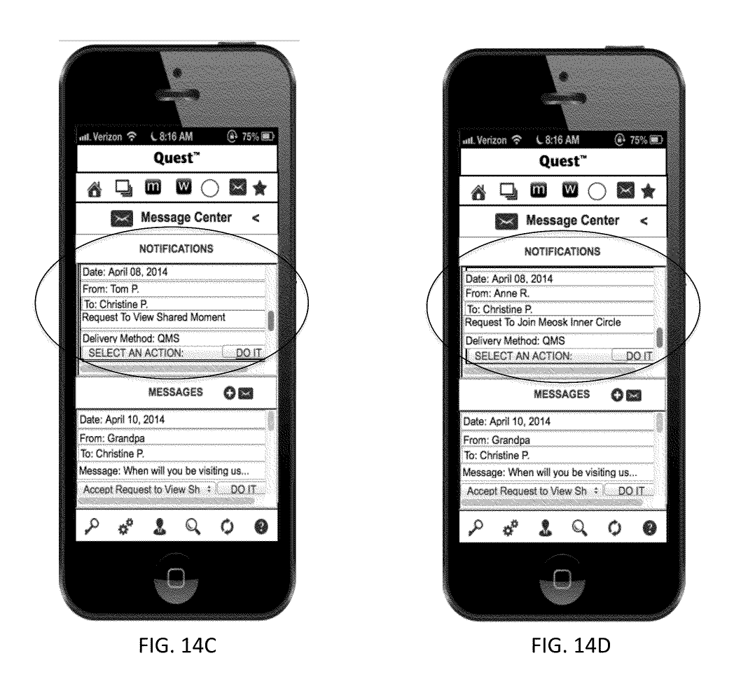

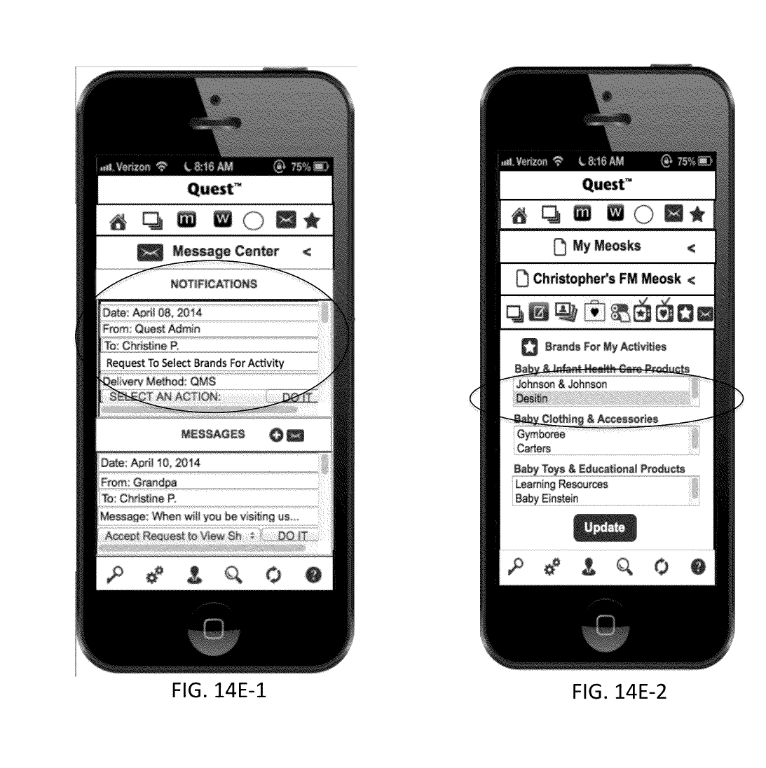

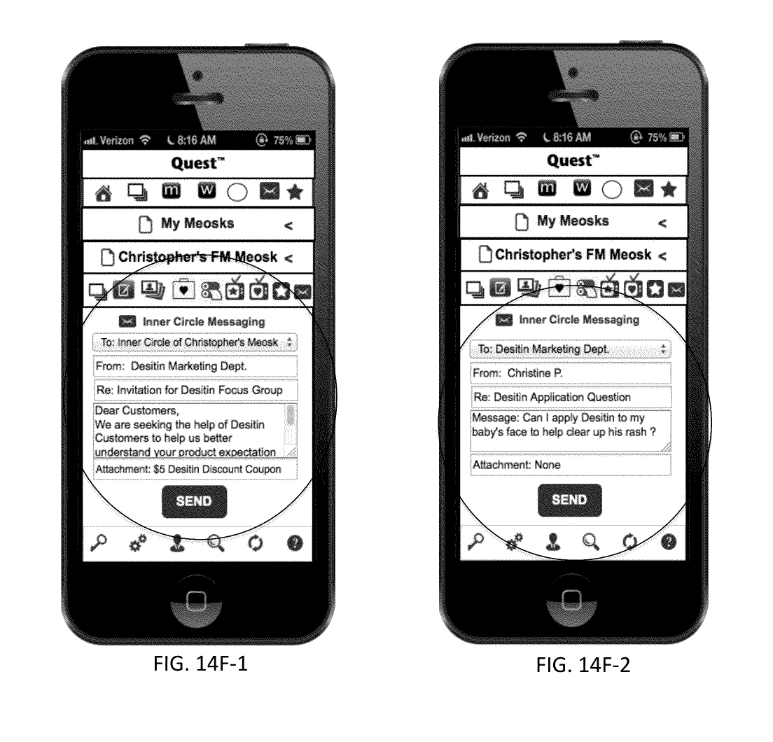

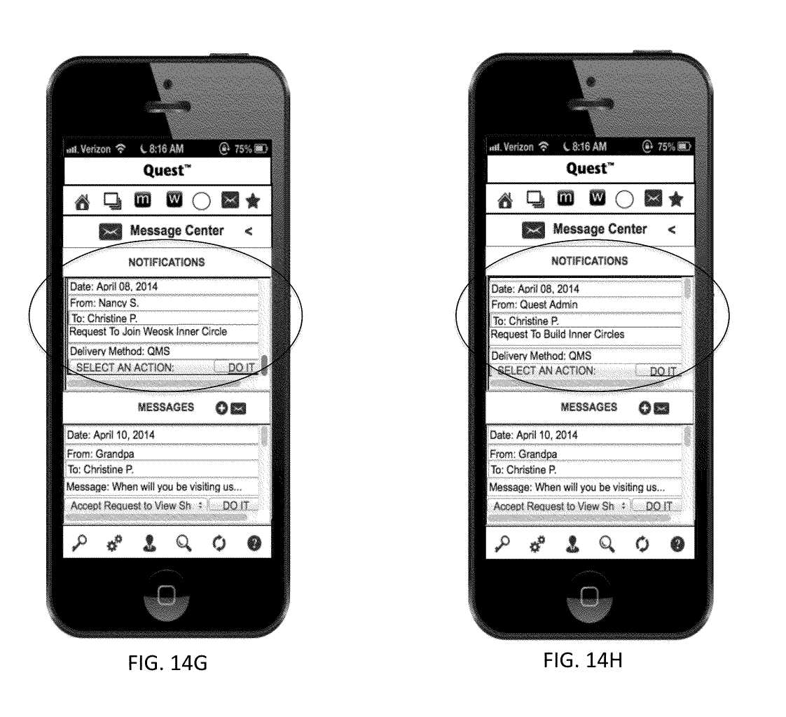

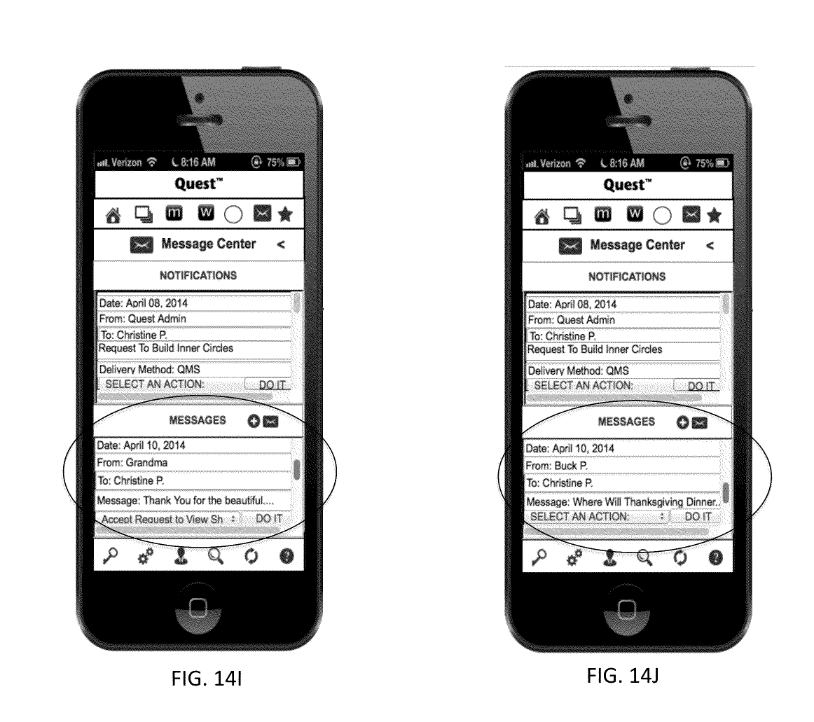

As indicated at Block C in FIG. 9B, after the activity-specific meosk structure has been deployed, the meosk-based private and social media management and communication system network automatically sends a message to the message communication facility of the activity-specific meosk structure, displaying a list of generic products and/or service categories typically required or desired when enjoying or otherwise participating in the identified interest or activity selected by the meosk master for the meosk structure. Under each displayed generic product and/or service category, a list of product and/or service brands is presented, from which the meosk master is asked to select one or more brands on which to receive brand contact, communication and additional information. This step is illustrated in FIG. 14E-1 showing a GUI screen supported by the message center module displaying a message requesting the system user (i.e. meosk master) to select preferred brands from the displayed list of generic products and/or service categories.

As indicated in Block D in FIG. 9B, in response to the displayed list of brands in the message sent to the meosk master during Block C, the meosk master selects those product brands and/or service brands on which to receive brand contact, communication and additional information through brand messages sent to the message communication facilities provided by said activity-specific meosk structure. This steps is illustrated in FIG. 14E-2 showing a GUI screen supported by the my meosks module displaying a list of brands from a list of generic products and/or service categories typically required or desired when participating in the identified interest or activity selected by the meosk master.

As indicated at Block E in FIG. 9B, the selected brand sends additional brand messages to the meosk structure's message communication facility, wherein the brand messages can include invitations, product information, offers and other marketing materials from the selected brands. This step is illustrated in FIG. 14F-1, showing a GUI screen supported by the message center module displaying a message received by the meosk master from a brand selected during the selection presented in FIG. 14E-2. FIG. 14F-2 shows a GUI screen supported by the my meosk module displaying the inner circle messaging panel where the meosk master is responding to a message sent during the message notification illustrated in FIG. 14F-2.

By virtue of the meosk messaging method of the present invention, any meosk master (i.e. system user) wishing to create a new meosk structure on the system network 1 need not select product and/or service brand preferences or favorites, during meosk creation and deployment, and can make such decisions afterwards in response to messages sent by the system admin to complete this reverse-inquiry communication process, illustrated in greater detail in FIGS. 92A and 92B. This provides both the meosk master and supporting brands with additional flexibility that contributes to a more enjoyable experience on the system network of the present invention, while enabling the important functions supported by this process.

### Specification of the Registration and Log-in Modules of the System Network of the Present Invention

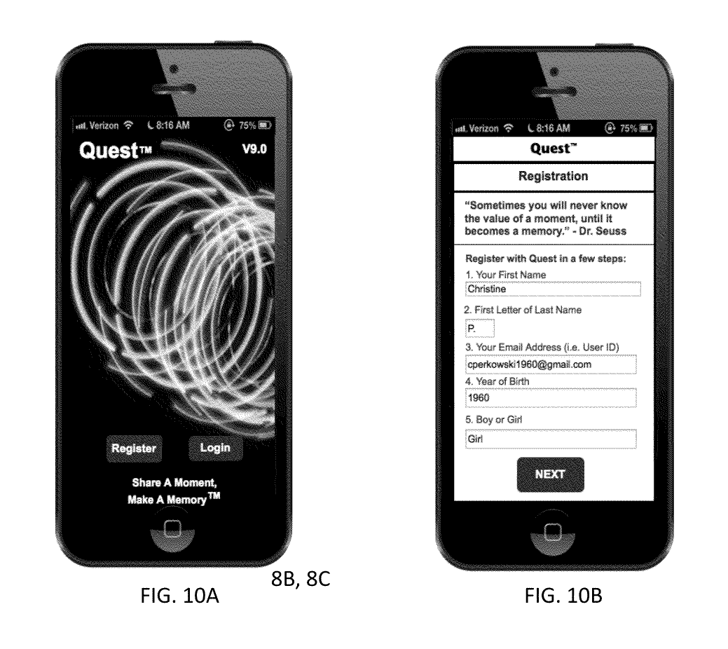

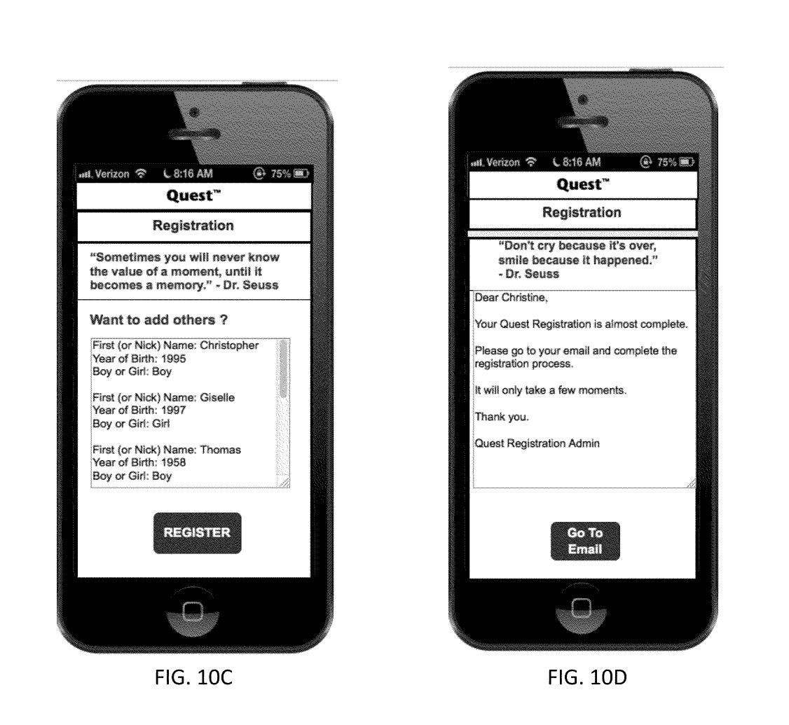

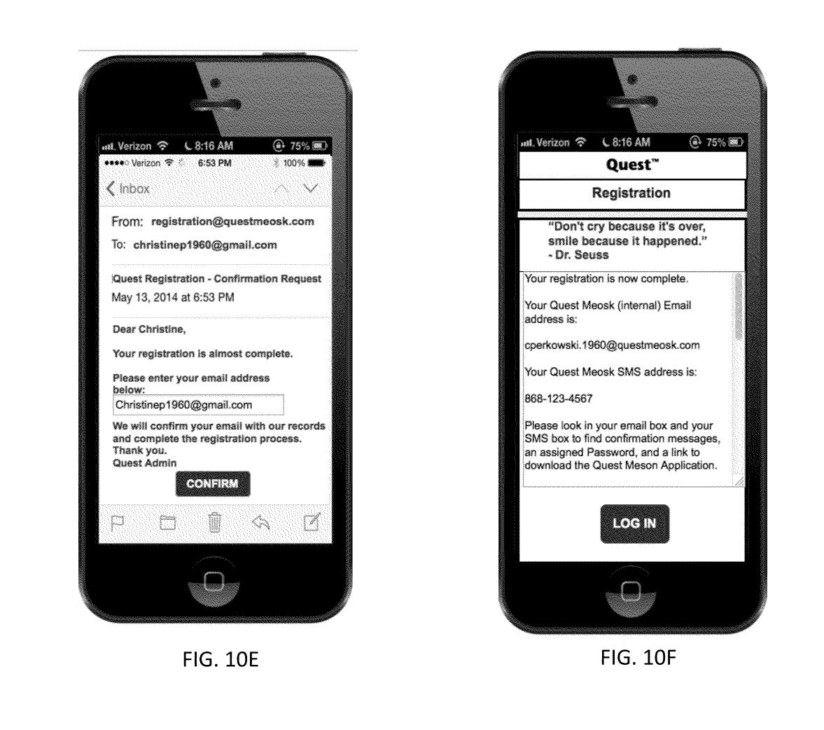

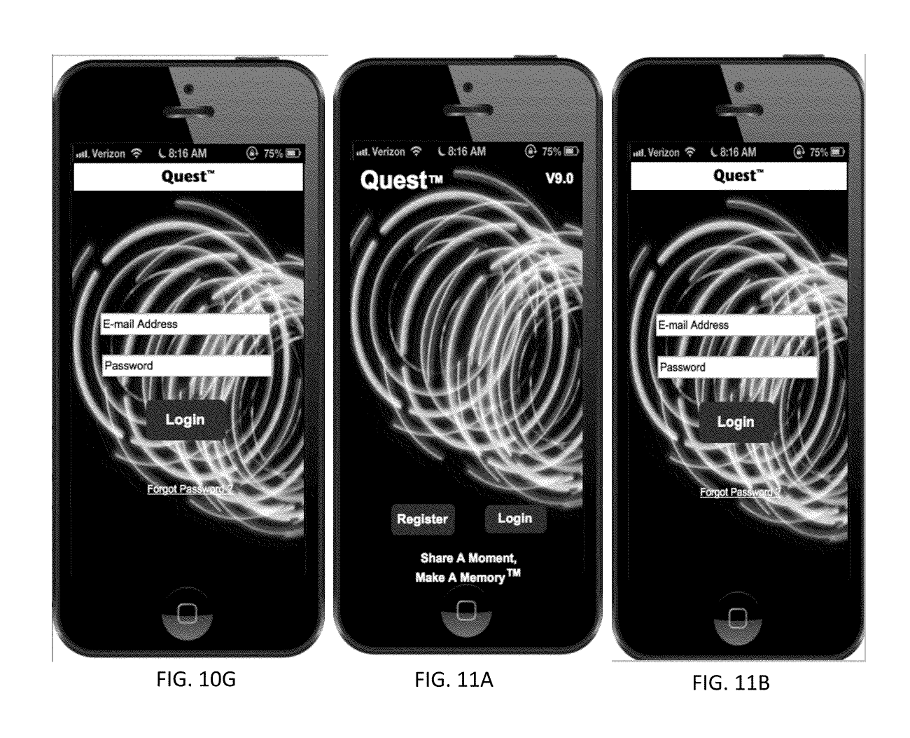

FIG. 10A shows a graphical user interface (GUI) splash screen supported by the user registration module, and displaying the login interface to the consumer-side of the meosk/weosk-based private and social media management and communication system network (i.e. called the Quest™ System in the illustrative embodiment). In the illustrative embodiment, the client-side of the system network 1 is realized as mobile web-browser and native applications having a “responsive-design” and adapted to run on any client computing device (e.g. iPhone, iPad, Android or other Web-enabled computing device) and designed for use by anyone interested in managing, storing and sharing information/media-based “moments” associated with (i) their life, (ii) the life of another, for whom they are entrusted to manage the same (e.g. as a parent or grandparent might manage information about the life, interests, activities and moments in the life of their child or grandchild), and/or (iii) the lives of any group of people related to a family, a business or other social enterprise.

FIG. 10B shows a GUI screen supported by the user registration module, and displaying the first step in registering with the system network, requiring only the first name and last initial of the last name of the user, and his or her year or birth, gender and email address and SMS number if available.

FIG. 10C shows a GUI screen supported by the user registration module, and displaying the second step involved in registering with the system network asking if there are others in ones family to add to the user's registration so as to enable for the system network to set up accounts for the added family members.

FIG. 10D shows a GUI screen supported by the user registration module, and displaying the third and final step of user registration on the system network, indicating that the user needs to go to his or her email to verify identity to complete the registration process.

FIG. 10E shows a GUI screen showing the receipt of an email from the system network confirming that the user need to confirm his or her email address to complete the user registration process on the system network of the present invention.

FIG. 10F shows a GUI screen communicating confirmation that the user registration process has been to completed and the user can now use the system network of the present invention.

FIG. 10G shows a GUI screen supporting user log-in to the system network of the present invention.

FIG. 11A shows a GUI screen supporting both user registration and login modules employed on the system network of the present invention.

FIG. 11B shows a GUI screen supported by the user login module of the system network, where the user enters account credentials to login to the system network.

### Specification of the Header/Footer Control Module of the Meosk/Weosk-Based Private and Social Media Management and Communication System Network of the Present Invention

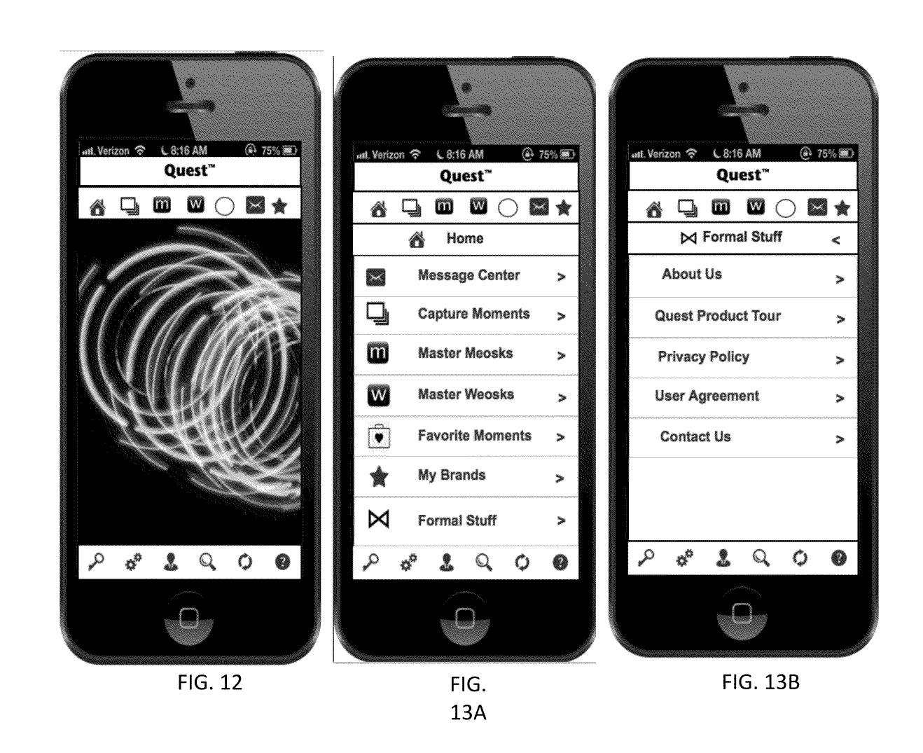

FIG. 12 shows a basic GUI screen supported by the header/footer control module of the system network, and providing the logged-in user with access to all points of entry into the client-side of system network 1 using a mobile client device 8A, 8B, 8C. This basic GUI screen is supported by one or more object-oriented modules on the system network, schematically represented in FIGS. 5A-1 through 5C-1. As shown, this basic GUI screen contains a header control panel with various graphical interface objects, a display frame for displaying content, and a footer control panel with various graphical interface objects. Notably, this GUI screen structure is reused in almost all other GUI screens supported on the system network of the present invention. The graphical interface objects in the header control panel of this basis GUI screen are realized by a first set of unique and recognizable graphical icons which, when selected, triggers the generation and display of a new or transformed GUI screen on the client system 8A, 8B, 8C, to support the service/functionality associated with the selected icon and its supporting modules. Likewise, the graphical interface objects in the footer control panel of the basic GUI screen are realized by a second set of unique and recognizable graphical icons which, when selected, triggers the generation and display of a new or transformed GUI screen on the client system 8A, 8B, 8C, to support the service/functionality associated with the selected icon and its supporting modules.

As shown, the header control panel displays icons for accessing the home page module, capture moments module, master meosks module, master weosks module, inner circles module, message center module and my brands module. The footer control panel displays graphical icons for the login module indicated by the key icon, the settings module indicated by gears, the contacts module indicated by a person's silhouette, the search module indicated by a magnifying glass, the synch module indicated by a circular-arrow synch icon, and the help module indicated by the question mark icon. The functions these modules play on the system network 1c will be described in greater detail hereinafter.

### Specification of Home the Page Module of the Meosk/Weosk-Based Private and Social Media Management and Communication System Network of the Present Invention

FIG. 13A shows a GUI screen supported by the home page module which displays icons for instantiating the message center module, the capture moments module, the master meosks module, the master weosks module, the favorite moments module, the my brands module, and the formal stuff module. From this GUI screen, system users can access all of the important client services supported on the system network of the present invention. The graphical interface objects associated with the home page module are realized by a set of unique and recognizable graphical icons which, when selected, triggers the generation and display of a new or transformed GUI screen on the client system 8A, 8B, 8C, to support the service/functionality associated with the selected icon and its supporting modules.

FIG. 13B shows a GUI screen supported by the formal stuff module which displays icons for the about us module, Quest product tour module, privacy policy module, user agreement module, and contact us module. The content disclosed from this GUI screen will depend on each particular commercial embodiment of the system network, as understood by those skilled in the art. Similarly, the graphical interface objects associated with the formal stuff module are realized by a set of unique and recognizable graphical icons which, when selected, triggers the generation and display of a new or transformed GUI screen on the client system 8A, 8B, 8C, to support the service/functionality associated with the selected icon and its supporting modules.

### Specification of the Message Center Module of the Meosk/Weosk-Based Private and Social Media Management and Communication System Network of the Present Invention

FIG. 14 describes the steps involved in the method of notifying users about the receipt of system notifications and messages from inner circle members and brand representatives.

FIG. 14A shows the message center module displaying a notification from the system admin to a registered system user relating to a request for build inner circles for certain meosk structures that have been created and deployed for the particular user.

FIG. 14B shows the message center module displaying a notification from the system admin to a registered system user relating to a request for build inner circles for certain meosk structures that have been created and deployed for the particular user.

FIG. 14C shows the message center module displaying a notification from an inner circle member to a registered system user relating to a request to view a shared moment in a certain meosk created and deployed by the particular user.

FIG. 14D shows the message center module displaying a notification from an inner circle member to a registered system user relating to a request to join the inner circle of a particular meosk structure.

FIG. 14E-1 shows the message center module displaying a message from the system admin requesting the system user (i.e. meosk master) to select preferred brands from a list of generic products and/or service categories typically required when enjoying or participating in the identified interest or activity selected by the meosk master, for the created and deployed meosk structure.

FIG. 14E-2 shows the my meosks module displaying a list of brands from a list of generic products and/or service categories typically required or desired when enjoying the identified interest or activity selected by the meosk master, from which the meosk master is asked to make selections to authorized these brands to send messages to the message communication facilities provided by said activity-specific meosk structure.

FIG. 14F-1 shows the message center module displaying a message received by the meosk master from a brand selected during the selection presented in FIG. 14E-2.

FIG. 14F-2 shows the my meosk module displaying the inner circle messaging panel where the meosk master is responding to a message sent during the message notification illustrated in FIG. 14F-2.

FIG. 14G shows the message center module displaying a notification from an inner circle member to a registered system user relating to a request to join the inner circle of a particular weosk structure.

FIG. 14H shows the message center module displaying a notification of a request by the system admin to build the meosk and weosk inner circles of the registered system user (i.e. meosk and weosk masters).

FIG. 14I shows the message center module displaying a message from an inner circle member to the registered system user expressing thank you for something.

FIG. 14J shows the message center module displaying a message from an inner circle member to the registered system user inquiring about “where Thanksgiving Dinner will be hosted”.

### Specification of the Capture Moments Module of the System Network of the Present Invention

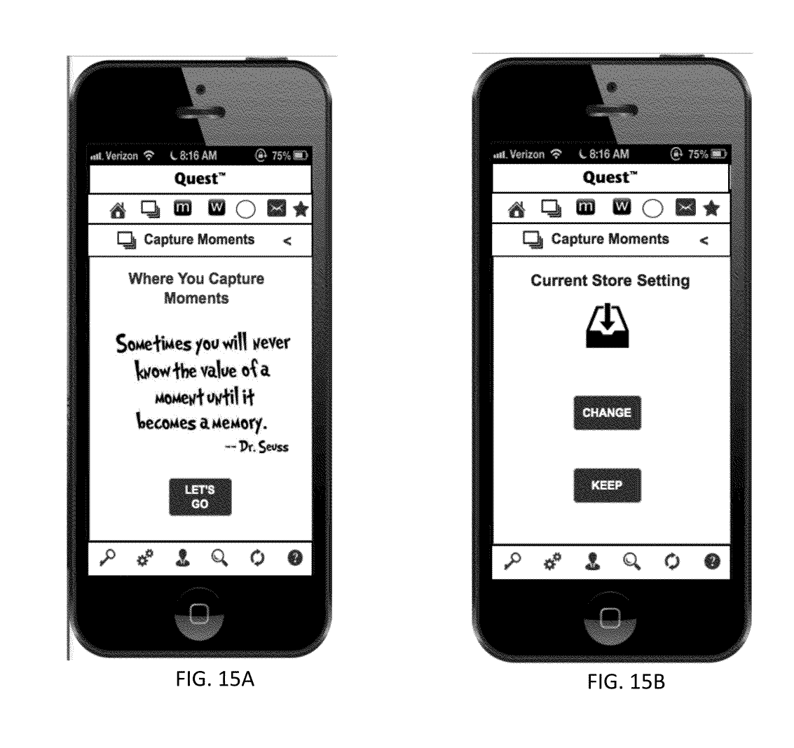

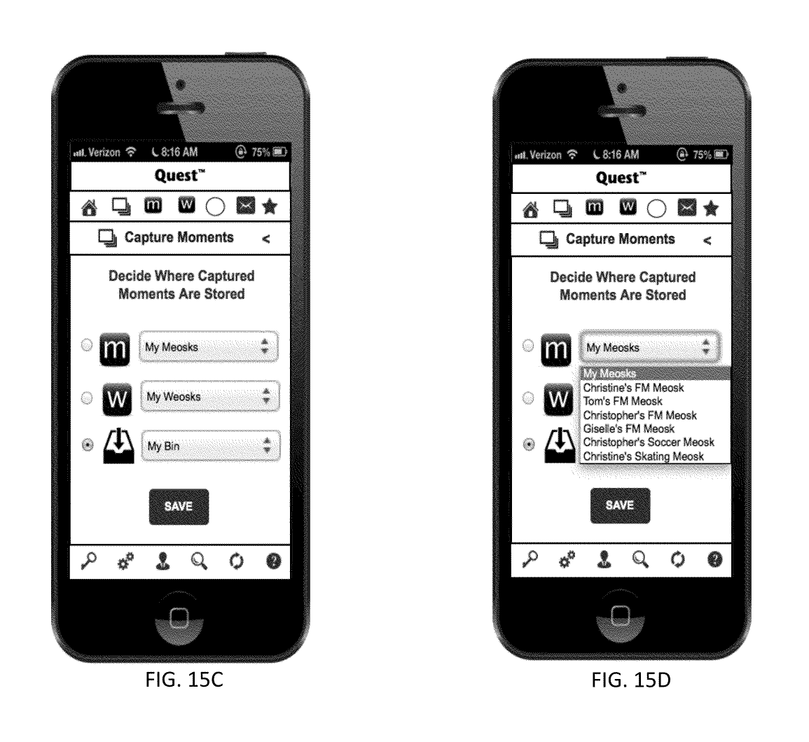

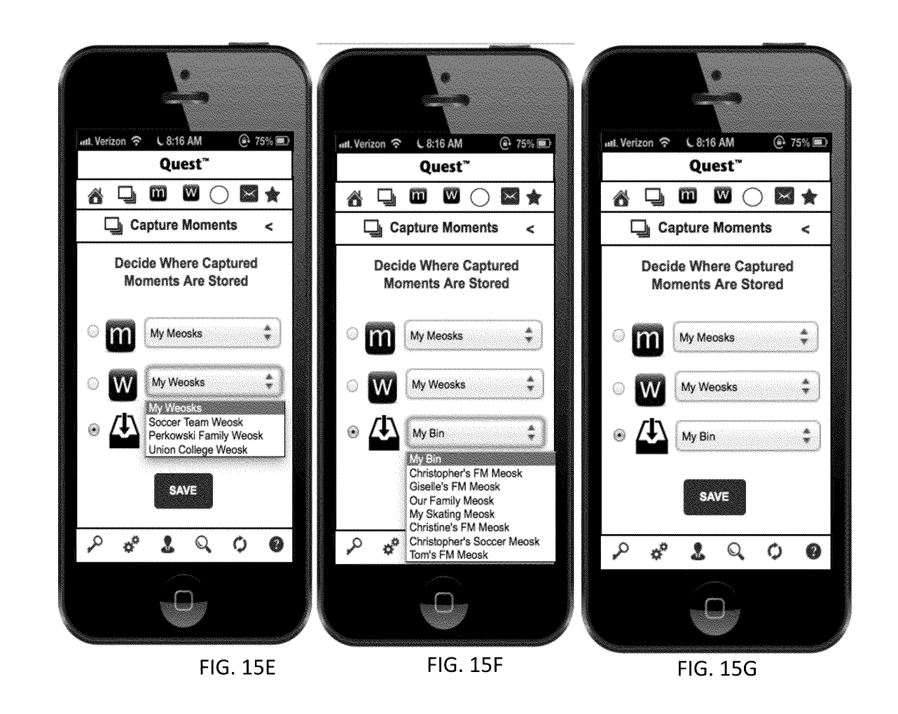

As shown, each GUI screen in FIGS. 15A through 20G contains numerous unique, recognizable icons which, when selected, trigger server-side-driven, client-side-driven and/or client-server-driven processes and the generation and display of new or transformed GUI screens on client systems 8A, 8B, 8C, to provide the master and/or guest users with the services/functionalities associated with selected icons and supporting modules. The details of this module, its graphical icons and corresponding services will be described in greater detail hereinafter.

FIG. 15A shows the capture moments module displaying an introduction to its suite of media-based moment capture tools.

FIG. 15B shows the capture moments module displaying the current store setting page, indicating where the current store location has been set, and where the user is provided with the choice of changing where captured moments will be stored in a default manner, or to keep the current moment store setting.

FIG. 15C shows the capture moments module and displaying where captured moments can be stored, with the option of selecting from (i) my meosks where all available meosk structures are listed in a pull-down menu, (ii) my weosks where all available meosk structures are listed in a pull-down menu, and (iii) my default setting where all captured moments can be stored if this option is selected, and afterwards, from which the user can move captured moments to designated meosks and/or weosks are the case may be.

FIG. 15D shows the capture moments module displaying the available meosk structures in the user's my meosks list.

FIG. 15E shows the capture moments module displaying the available weosks in the user's my weosks list.

FIG. 15F shows the capture moments module displaying the meosk structures, weosk structures and my bin available for selection when configuring the default moment store setting.

FIG. 15G shows the capture moments module displaying that “my bin” has been selected as the default moment store setting.

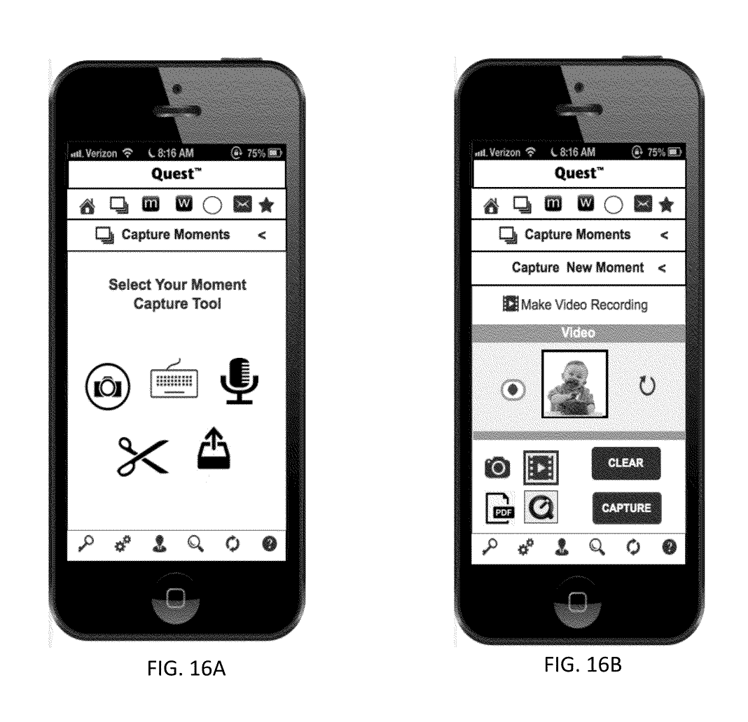

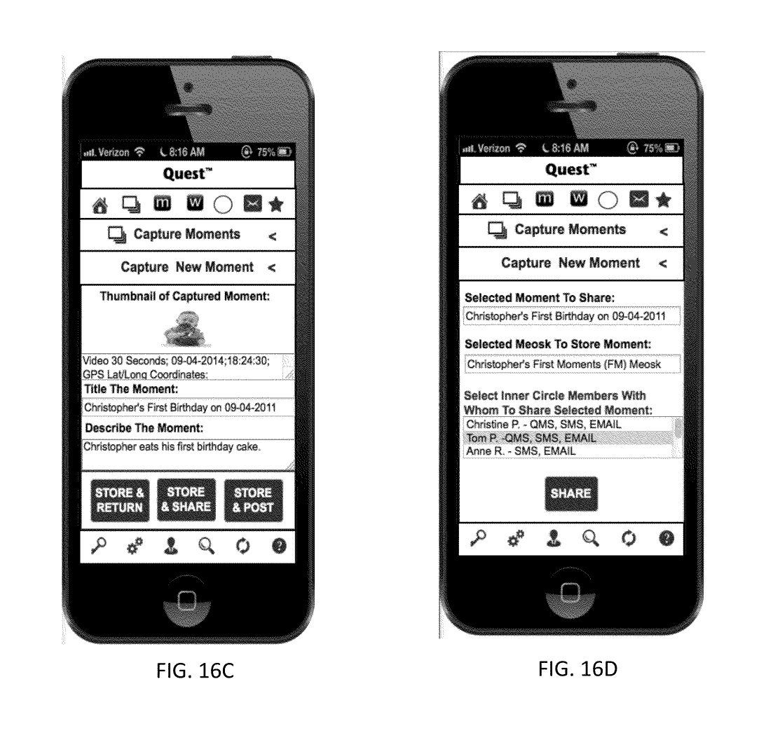

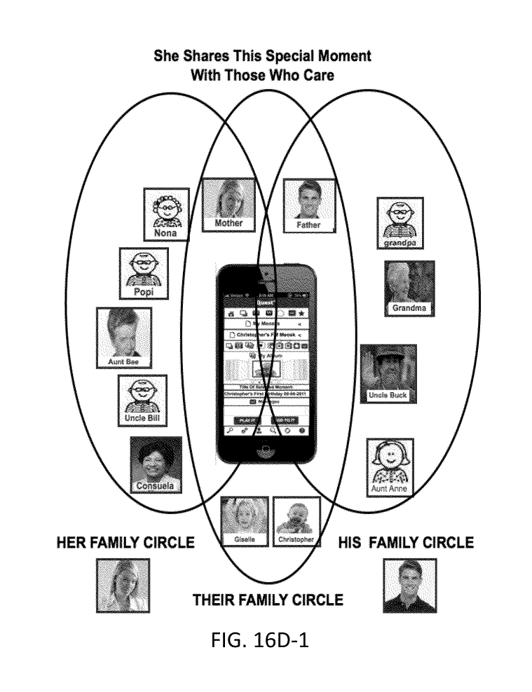

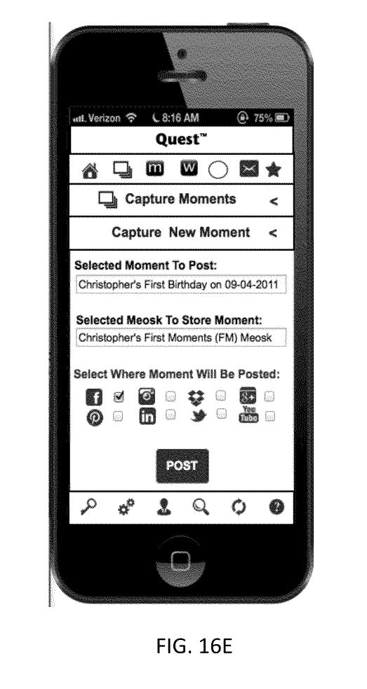

FIG. 16A shows the capture moments module and displaying the menu of moment capture tools that are available for selection in the capture moments module.

FIG. 16B shows the capture moments module displaying the video/image capture tool, where the video/image capture option has been selected and an image of the subject in the camera's field of view (FOV) is shown and ready to be captured as a video recording and exported to the selected video format.

FIG. 16C shows the capture moments module displaying the captured moment handling screen showing the options available for handling the captured video/image moment, namely, (i) storing the captured moment and returning to the capture moments tool selection screen, (ii) storing the captured moment and sharing the same, and thereafter returning to the capture moments selection tool screen, and (iii) storing the captured moment and posting the captured moments to selected social media channels of the registered user, and then returning to the captured moments tool selection screen.

FIG. 16D shows the capture moments module displaying the captured moment sharing screen, from which the user can select inner circle members with whom the captured video/image moments should be shared over the system network illustrated in FIGS. 1 and 1A.

FIG. 16D-1 shows a schematic representation of an inner circle of members associated with a particular meosk structure created and deployed on the system network by the registered user. This schematic representation illustrates (i) the inner subcircle associated with one side of the user's family, (ii) the inner subcircle associated with the other side of the user's family, and (ii) the user's core family circle, with each of whom captured video/image moments can be shared using the system of the present invention. The system network of the present invention provides meosk masters with the control necessary to select, share and communicate with such subcircles (i.e. subgroups) of inner circle members so that particular moments relevant to a certain subcircle(s), but not others, will only be sent to the relevant subcircles.

FIG. 16E shows the capture moments module displaying the share video/image moments across social media channels, to which the registered user can post captured moments.

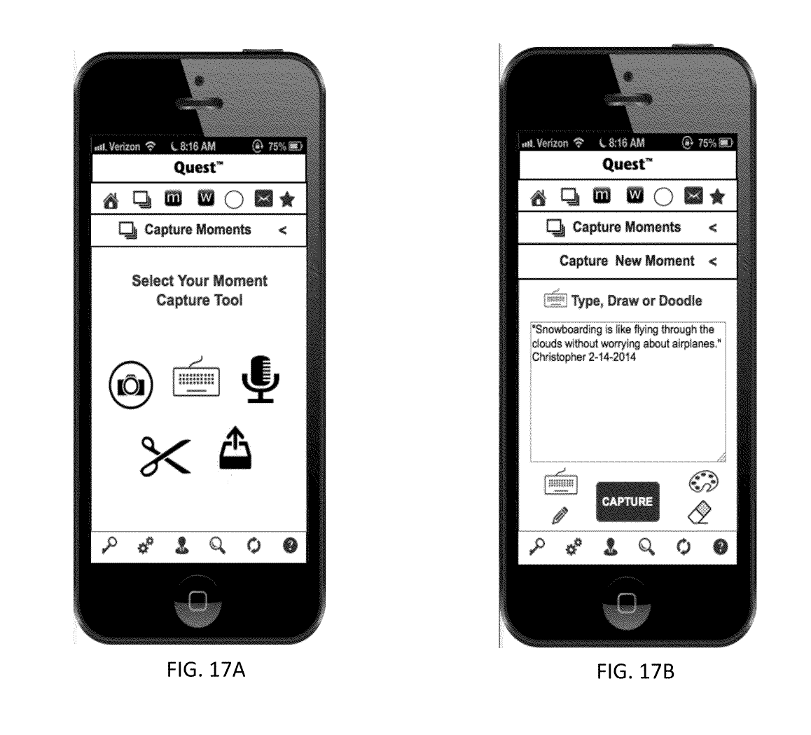

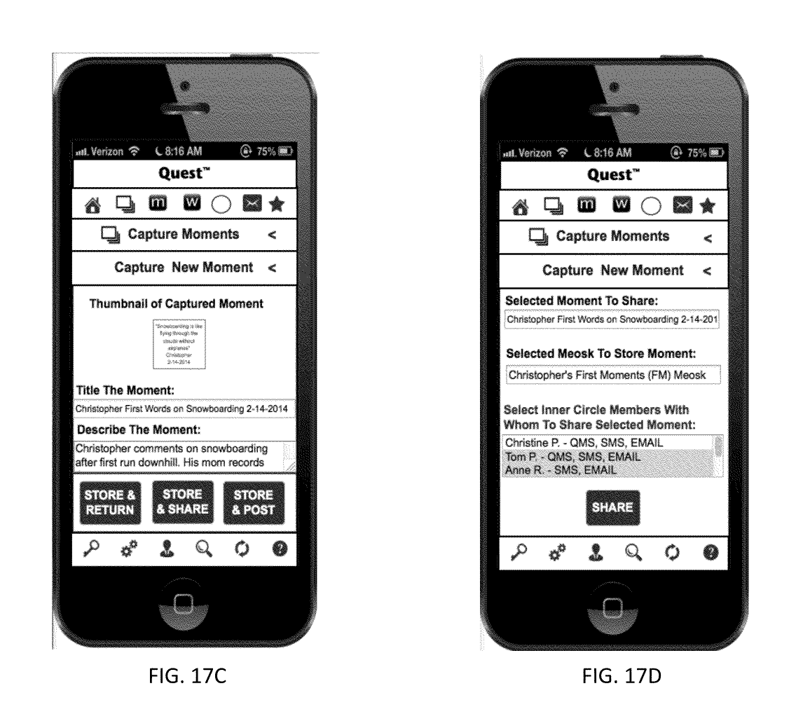

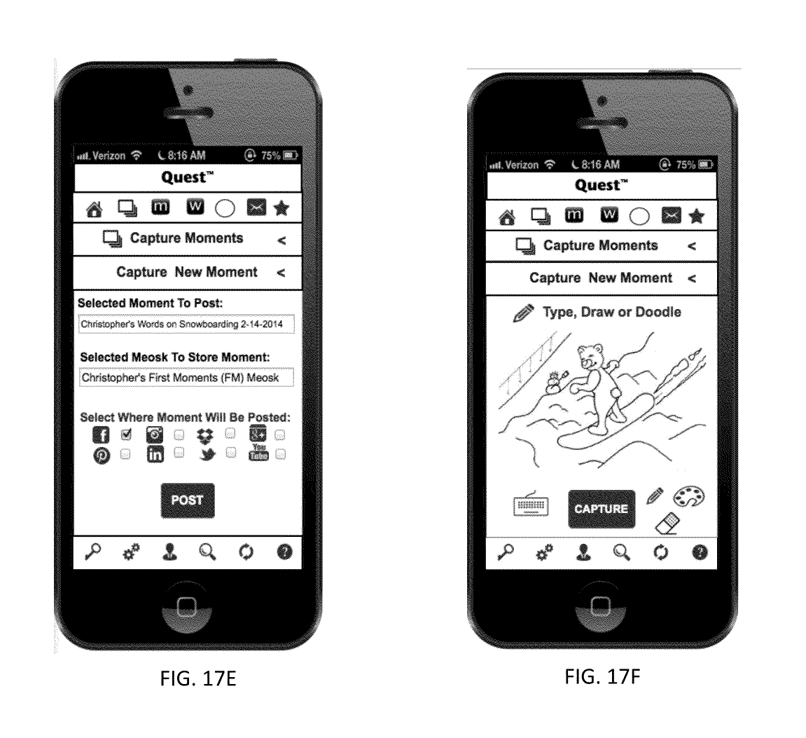

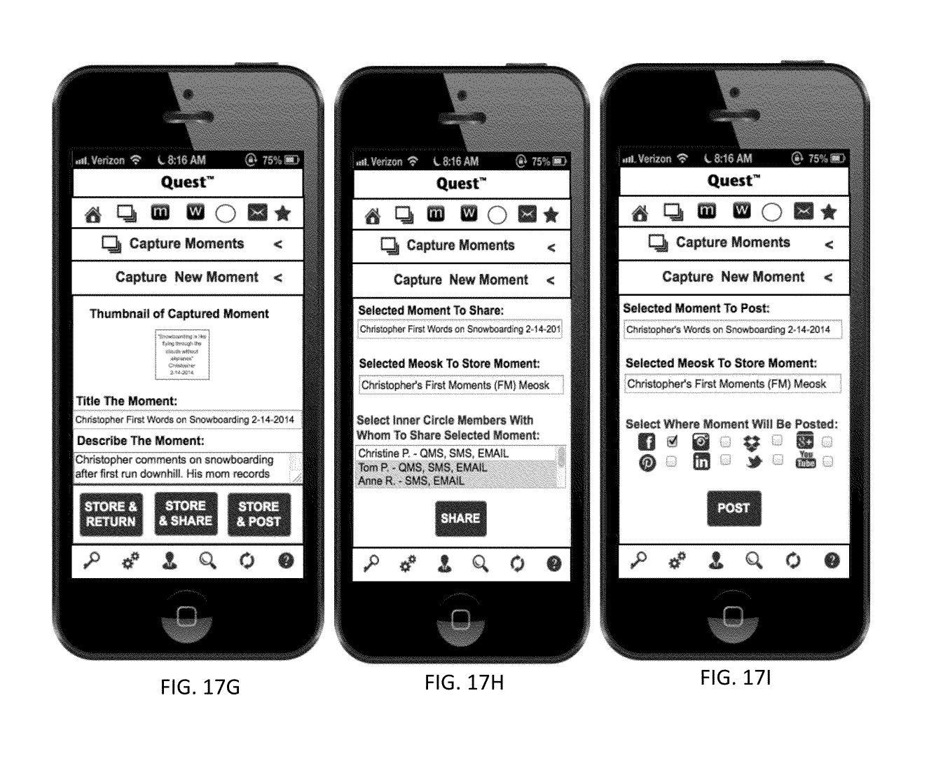

FIG. 17A shows the capture moments module displaying the capture moments selection tool screen, where the user selects the “type tool” indicated by a keyboard-like icon.

FIG. 17B shows the capture moments module displaying the type screen, for capturing moments using a typewriter, or alternatively, using a drawing pencil or pen by selecting the drawing pencil icon or paint palette icon, and make erasures using the eraser icon.

FIG. 17C shows the capture moments module displaying the captured moment handling screen showing the three options available to the system user for handling captured “typed moments”, namely, (i) storing the captured moment and returning to the capture moments tool selection screen, (ii) storing the captured moment and sharing the same, and thereafter returning to the capture moments selection tool screen, and (iii) storing the captured moment and posting the captured moments to selected social media channels of the registered user, and then returning to the captured moments tool selection screen.

FIG. 17D shows the capture moments module displaying the captured moment sharing screen, from which the user can select inner circle members with whom the “typed moment” should be shared over the system network illustrated in FIGS. 1 and 1A.

FIG. 17E shows the capture moments module displaying the share the text moments across social media channels, to which the registered user can post captured moments.

FIG. 17F shows capture moments module displaying the screen for capturing moments using a typewriter, drawing pencil or pen which the user may select from the icons displayed on the GUI screen.

FIG. 17G shows the capture moments module displaying the captured moment sharing screen, from which the user is presented with options available for handling the captured type moment, namely, (i) storing the captured moment and returning to the capture moments tool selection screen, (ii) storing the captured moment and sharing the same, and thereafter returning to the capture moments selection tool screen, and (iii) storing the captured moment and posting the captured moments to selected social media channels of the registered user, and then returning to the captured moments tool selection screen.

FIG. 17H shows the capture moments module displaying the captured moment sharing screen, from which the user can select inner circle members with whom the drawing/doodle moment should be shared over the system network illustrated in FIGS. 1 and 1A.

FIG. 17I shows the capture moments module displaying share the drawing/doodle moments across social media channels, to which the registered user can post captured moments. Here, it is understood that this moment posting option is only available to the “guest” system user if and only if the meosk master has enabled this moment posting option (i) during meosk creation and deployment steps illustrated in FIG. 39K, or (ii) in the meosk control panel illustrated in FIGS. 90A and 90B. The moment posting option is available to the “master” system user if and only if the meosk master has enabled this moment posting option (i) during meosk creation and deployment steps illustrated in FIG. 39J, or (ii) subsequently in the meosk control panel illustrated in FIGS. 90A and 90B.

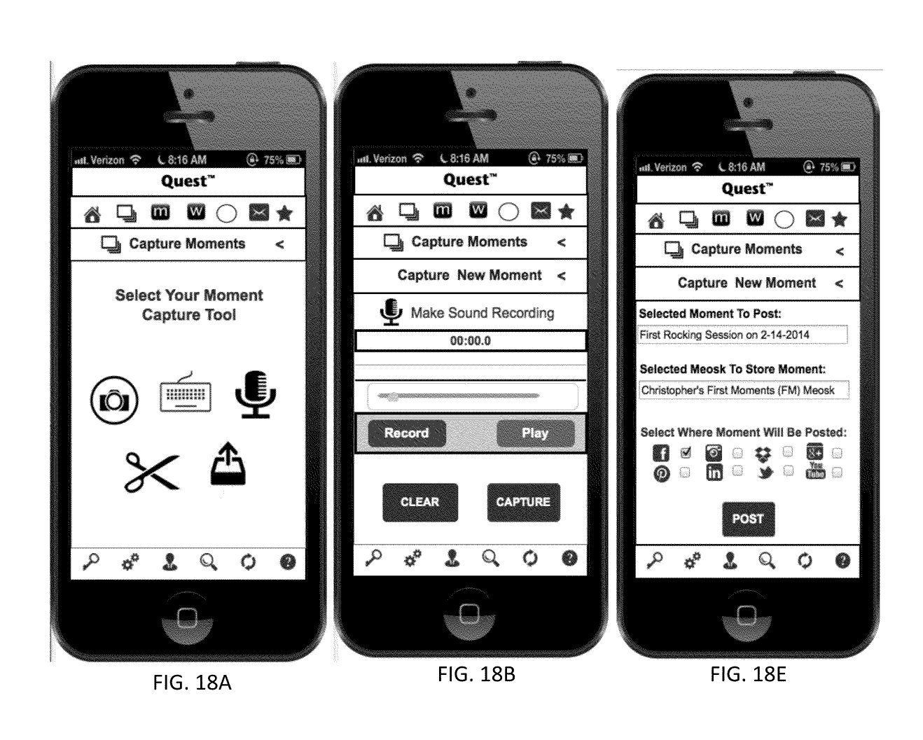

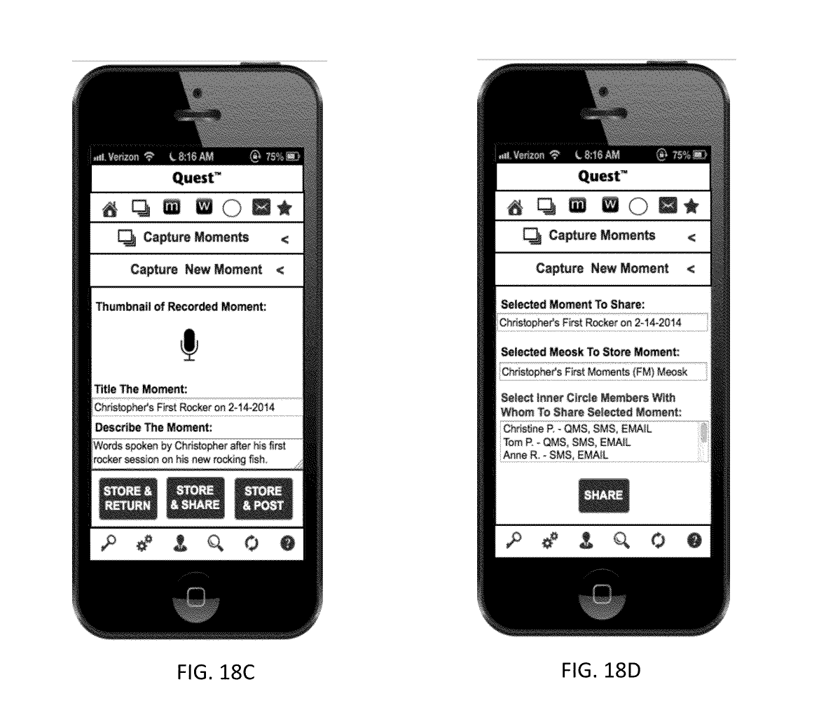

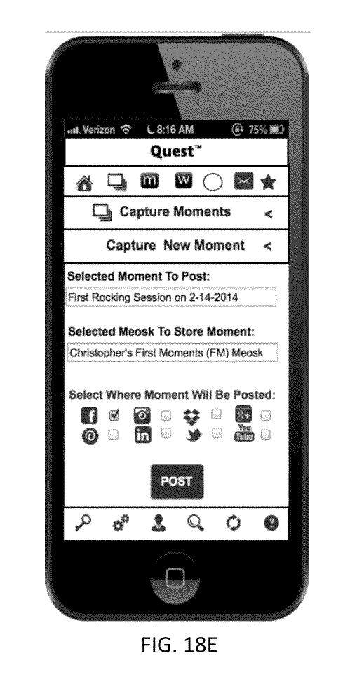

FIG. 18A shows the capture moments module displaying the capture moments selection tool screen, where the user selects the sound recording tool, indicated by the microphone icon.

FIG. 18B shows the capture moments module displaying the sound recording screen, for capturing moments using the microphone and sound recording system integrated in the Apple iPhone client device.

FIG. 18C shows the capture moments module displaying the captured moment handling screen showing the options available for handling the captured type moment, namely, (i) storing the captured sound recording moment and returning to the capture moments tool selection screen, (ii) storing the captured moment and sharing the same, and thereafter returning to the capture moments selection tool screen, and (iii) storing the captured sound recording moment and posting the captured moments to selected social media channels of the registered user, and then returning to the captured moments tool selection screen.

FIG. 18D shows the capture moments module displaying the captured moment sharing screen, from which the user can select inner circle members with whom the sound recording moment should be shared over the system network illustrated in FIGS. 1 and 1A.

FIG. 18E shows the capture moments module displaying the sound recording moment being shared across social media channels. As shown, the guest or master user selects which social media channels to which the user wishes to post the captured sound recording. Here, it is understood that this moment posting option is only available to the “guest” system user if and only if the meosk master has enabled this moment posting option (i) during meosk creation and deployment steps illustrated in FIG. 39K, or (ii) in the meosk control panel illustrated in FIGS. 90A and 90B. The moment posting option is available to the “master” system user if and only if the meosk master has enabled this moment posting option (i) during meosk creation and deployment steps illustrated in FIG. 39J, or (ii) subsequently in the meosk control panel illustrated in FIGS. 90A and 90B.

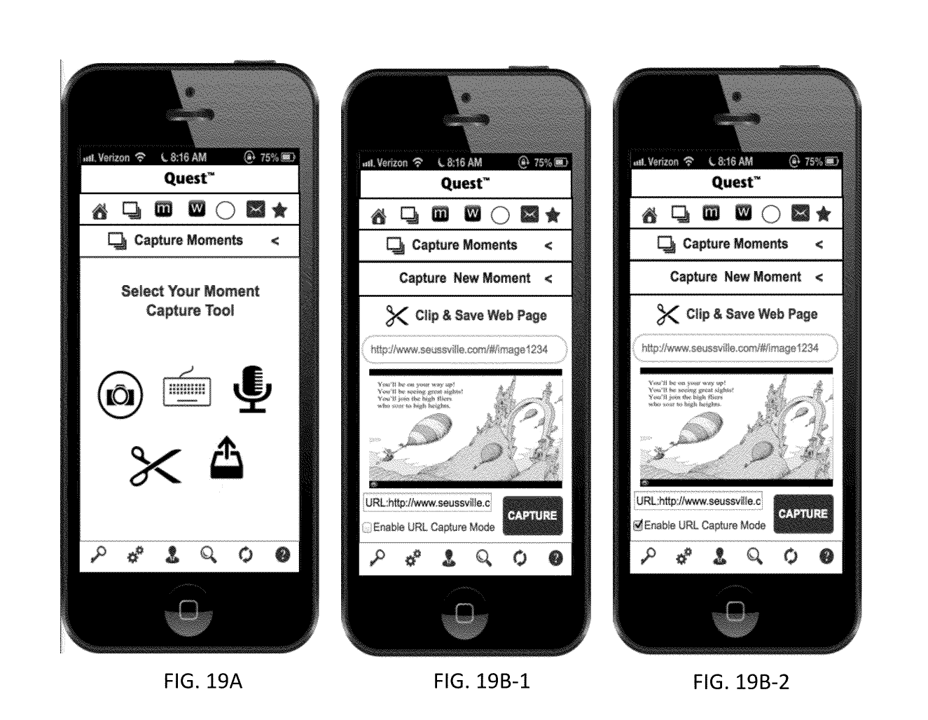

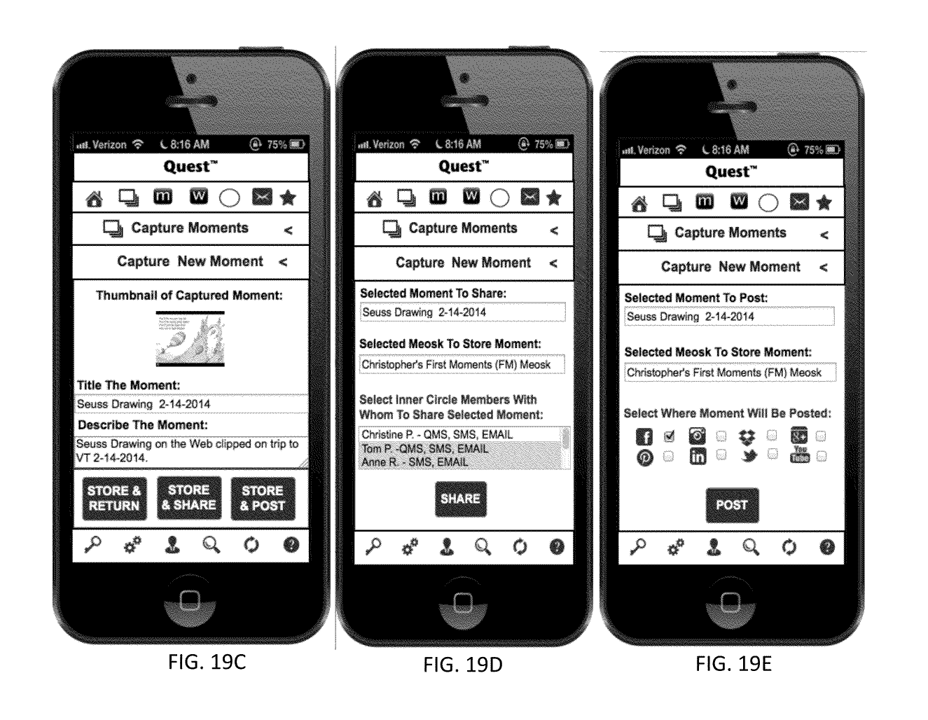

FIG. 19A shows the capture moments module displaying the capture moments selection tool screen, where the user selects the web page clipping (i.e. capture and store as a file or a URL) tool indicated by the scissors icon.

FIG. 19B-1 shows the capture moments module displaying the web page clipping screen for capturing web page moments using this tool. Using this tool, the system user has the option of either (i) capturing a webpage (i.e. web-based object) located at a particular URL on the Internet (e.g. WWW) and storing the entire file thereof, as a captured moment in the system database 5, supported by the Apache Hadoop® ecosystem 15, or (ii) capturing only the URL of a particular webpage on the WWW and storing the URL in the system database 5 within the Apache Hadoop® system 15.

As shown in FIG. 19B-2, alternatively, this capture moments tool is shown being used in its enable “URL Mode” to simply capture URLs of web-based objects, as captured moments, and store these captured URLs in the system database 5 within the Apache Hadoop® system 15, for subsequent access and retrieval of the data files located at such captured URLS. To use this mode, the system user only needs to select Enable URL Capture Mode to use this feature of this capture tool. When the URL mode is not enabled, this tool capture WebPages (i.e. html files) located at particular URLs and saves the web documents in pdf format for storage in the system database 5 of the Apache Hadoop® system 15.

FIG. 19C shows the capture moments module displaying a GUI screen showing the options available for handling the captured web page moment, namely, (i) storing the captured moment and returning to the capture moments tool selection screen, (ii) storing the captured moment and sharing the same, and thereafter returning to the capture moments selection tool screen, and (iii) storing the captured moment and posting the captured moments to selected social media channels of the registered user, and then returning to the captured moments tool selection screen.

FIG. 19D shows the capture moments module displaying the captured moment sharing GUI screen, from which the user can select inner circle members with whom the clipped web page moment should be shared over the system network of the present invention illustrated in FIGS. 1 and 1A.

FIG. 19E shows the capture moments module displaying a GUI screen for sharing the clipped web page moment across social media channels. As shown, the guest or master user selects which social media channels to which the user wishes to post the captured sound recording. Here, again, it is understood that this moment posting option is only available to the “guest” system user if and only if the meosk master has enabled this moment posting option (i) during meosk creation and deployment steps illustrated in FIG. 39K, or (ii) in the meosk control panel illustrated in FIGS. 90A and 90B. The moment posting option is available to the “master” system user if and only if the meosk master has enabled this moment posting option (i) during meosk creation and deployment steps illustrated in FIG. 39J, or (ii) subsequently in the meosk control panel illustrated in FIGS. 90A and 90B.

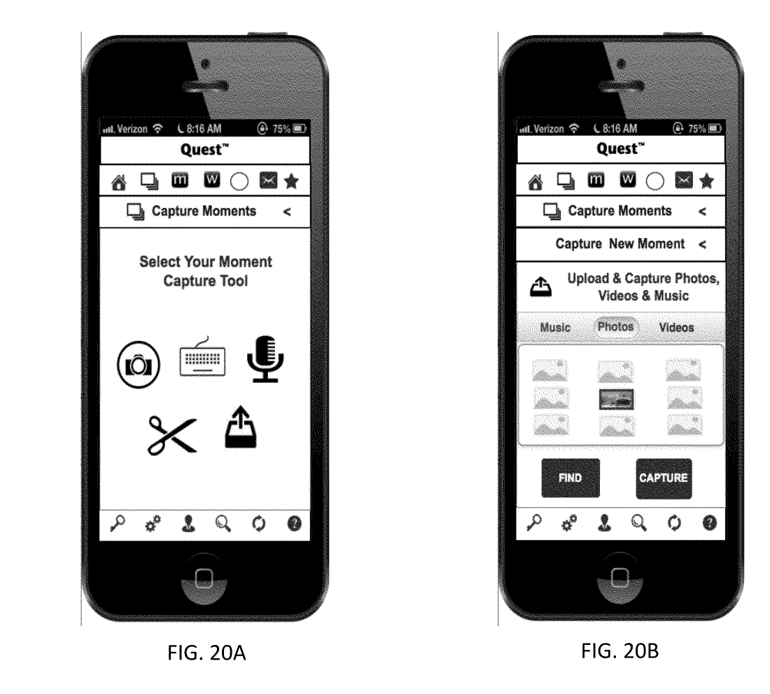

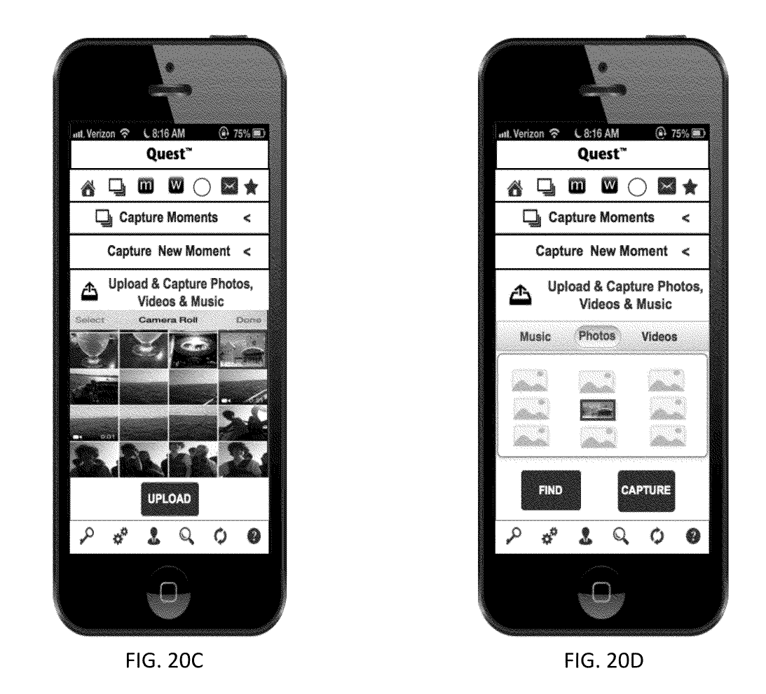

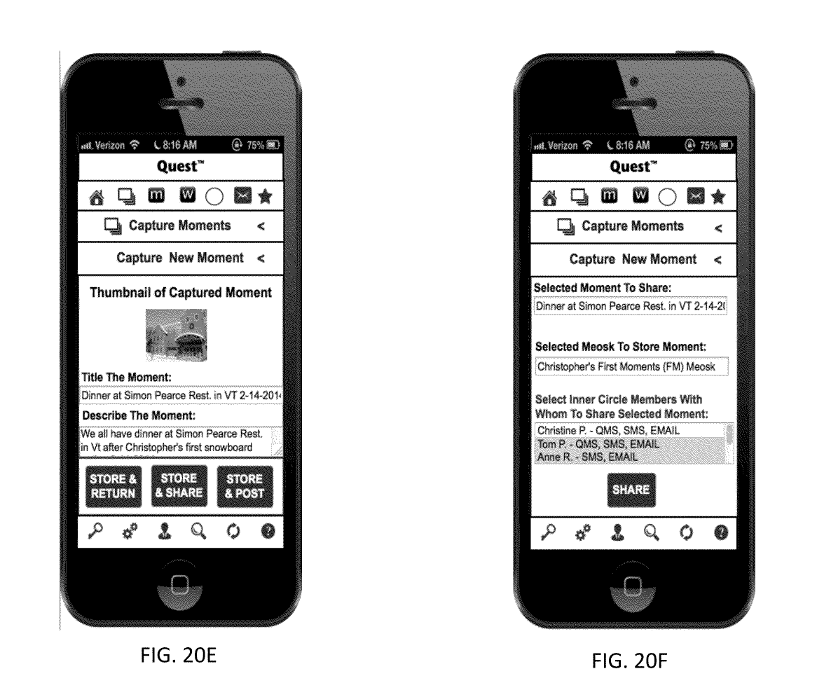

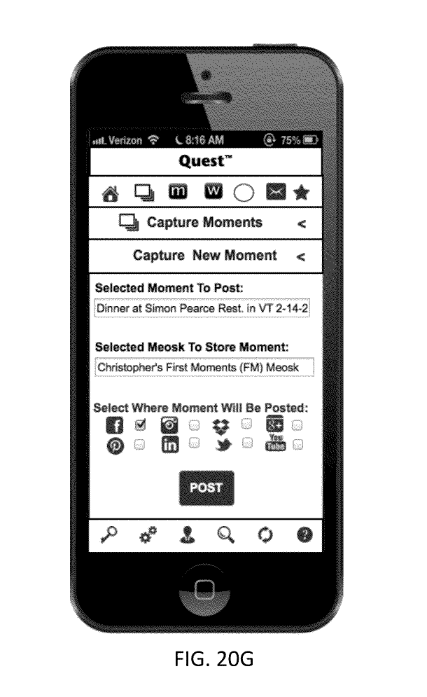

FIG. 20A shows the capture moments module displaying the capture moments selection tool screen, where the user selects the file upload tool indicated by the file upload icon.

FIG. 20B shows the capture moments module displaying the file upload GUI screen, for uploaded moments (captured in a digital information file) using this tool.

FIG. 20C shows the capture moments module displaying the file upload screen, where the photos in the camera roll of the iPhone device are shown in thumbnail view for the user to select one or more photos for uploading to the database servers of the system network using the file upload capture tool.

FIG. 20D shows the capture moments module and displaying the file capture screen, when capturing uploaded moments using this tool. The file to be uploaded is selected and then the “capture” button is selected causing the file uploading process to begin on the client-side of the system network, subject to user selections to be made in GUI screens shown at FIGS. 20E, 20F and 20G.

FIG. 20E shows the capture moments module displaying the captured moment handling GUI screen showing the options available for handling the uploaded moment, namely, (i) storing the uploaded file moment and returning to the capture moments tool selection screen, (ii) storing the captured moment and sharing the same, and thereafter returning to the capture moments selection tool screen, and (iii) storing the uploaded file moment and posting the captured moments to selected social media channels of the registered user, and then returning to the captured moments tool selection screen.

FIG. 20F shows the capture moments module displaying the captured moment sharing GUI screen, from which the user can select inner circle members with whom the uploaded file moment should be shared over the system network illustrated in FIGS. 1 and 1A.

FIG. 20G shows the capture moments module displaying the GUI screen for sharing the uploaded file moment by posting it across social media channels selected by the registered user. As shown, the guest or master user selects which social media channels to which the user wishes to post the captured file or file URL moment. Here, again, it is understood that this moment posting option is only available to the “guest” system user if and only if the meosk master has enabled this moment posting option (i) during meosk creation and deployment steps illustrated in FIG. 39K, or (ii) in the meosk control panel illustrated in FIGS. 90A and 90B. The moment posting option is available to the “master” system user if and only if the meosk master has enabled this moment posting option (i) during meosk creation and deployment steps illustrated in FIG. 39J, or (ii) subsequently in the meosk control panel illustrated in FIGS. 90A and 90B.

### Specification of the Master Meosks Module of the System Network of the Present Invention

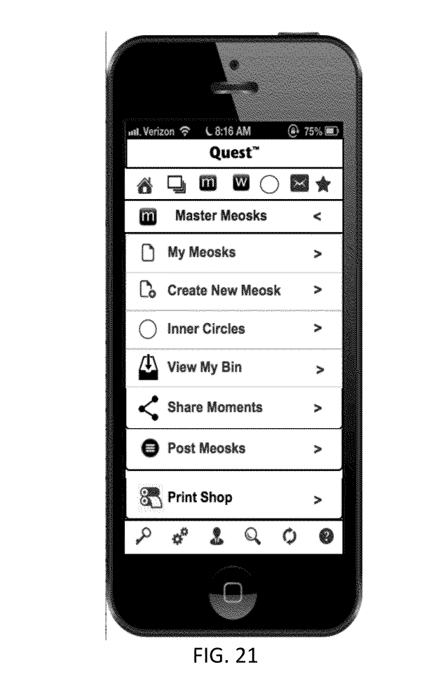

FIG. 21 shows the master meosks module displaying a set graphical icons for selecting specifically organized modules namely, the my meosk structures, the create new meosk structure, the inner circles module, the view my bin module, the share moments module, the post meosks module, and also the print shop module, where journey books, as illustrated in FIGS. 66A through 66K are configured, ordered and generated. As shown, this GUI screen contains an unique and recognizable icon for each such module which, when selected, triggers server-side-driven, client-side-driven and/or client-server-driven processes and the generation and display of new or transformed GUI screens on client systems 8A, 8B, 8C, to provide the master and/or guest users with the services/functionalities associated with the selected icon and supporting module(s). The details of the master module, its graphical icons, supporting core modules, and corresponding services will be described in greater detail hereinafter.

### Specification of the My Meosks Module of the System Network of the Present Invention

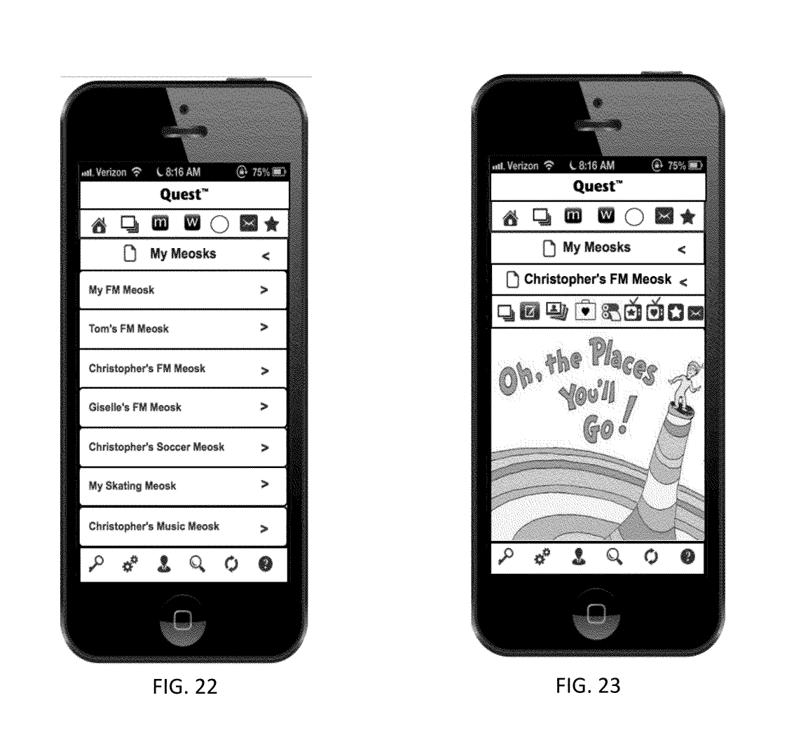

FIG. 22 shows the my meosks module selected from the master meosks module, and graphical panels for each of the activity-specific meosk structures (i.e. subsystems) that have been created, deployed and associated with the registered user (e.g. “Christine P.”) of the exemplary embodiment. As shown, this GUI screen comprises the basic GUI screen structure, as does all other GUI screens on the system network, and also an inset display panel labeled “My Meosk” that lists horizontally-oriented panels with the title of each deployed meosk structure, to which the system user of the illustrative example is an inner circle member. In the case example where the system user logs into its system network account, the system network will display on the system user's my meosk list, all meosk structures to which the system user is an inner circle member, including (i) meosk structures for which the system user is a master user (i.e. meosk master) of the meosk structure, and (ii) meosk structures for which the system user is a guest user (i.e. meosk guest) of the meosk structure. In alternative embodiments of the system network of the present invention, the meosk structure panels can be realized as graphical icons within the my meosks GUI screen, and users will use a client system 8A, 8B, 8C to select the graphical icon to instantiate and display its corresponding meosk structure on the system network.

In this illustrative embodiment, this registered system user is the meosk master of all the meosk structures shown in this meosk list, but it is understood that she could be a guest user of meosk structures that have been mastered (i.e. created) by other system users, and to which she is simply an inner circle guest with privileges set by the meosk master (i) during meosk creation and deployment steps illustrated in FIGS. 39K and 39M, or (ii) in the meosk control panel illustrated in FIGS. 90A and 90B. The rights and privileges over meosk structures which the meosk master has created are set (i) during the meosk creation and deployment steps illustrated in FIGS. 39J and 39L or (ii) subsequently in the meosk control panel illustrated in FIGS. 90A and 90B.

### Specification of an Activity-Specific Meosk Structure Created and Deployed on the System Network of the Present Invention

As shown, each GUI screen illustrated in FIGS. 23 through 38C contains numerous unique and recognizable icons which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities associated with selected icons and supporting modules. As shown, each GUI screen includes the basic GUI screen, containing the header control panel with various graphical interface objects, the display frame for displaying content, and the footer control panel with various graphical interface objects. The details of the my meosk module, its graphical icons and corresponding services will be described in greater detail hereinafter.

FIG. 23 shows the my meosks module displaying a selected meosk structure (e.g. Christopher's FM (First Moments) Meosk) for viewing and illustration of its various modules, namely, capture moments, my journal, my album, my favorites, print shop, my favorites (moments) channel, my brand channel, my brands and inner circle messaging center. As shown, each module in the activity-specific meosk structure is graphically represented as an unique and recognizable graphical icon in the GUI screen. Each module responsible for a specific moment storage/management function, such as my journal, my album(s), and my favorites, is graphically represented by an unique, recognizable moment function icon which, when selected, automatically triggers the generation and display of a new or transformed GUI screen on the client system 8A, 8B, 8C, to support the selection, review and management of the moment and associated content, indicated by the selected moment location icon. Also, each meosk-related function such as capture moments, print shop, my favorites channel, my brand channel, my brands and inner circle messaging center, is also graphically represented by an unique, recognizable meosk function icon which, when selected, triggers the generation and display of a new or transformed GUI screen on the client system 8A, 8B, 8C, to support the associated function represented by the selected graphical icon.

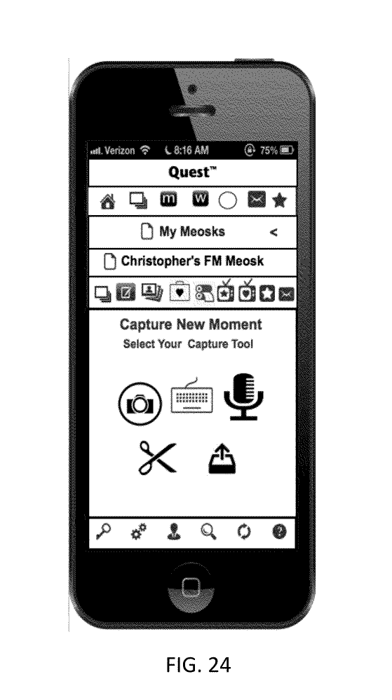

FIG. 24 shows the my meosks module displaying the selected meosk structure and the selected module, “capture new moment”, providing a selection of moment multi-media moment capture tools from which the user can select to capture new moments which will be automatically stored in one of the moment store locations within the meosk structure's virtual file and operating subsystem (VFOS) supported by the Apache Hadoop® distributed information file storage and retrieval system 15 on the system network 1, shown in FIGS. 1, 1A, 1B-1 and 1B-2.

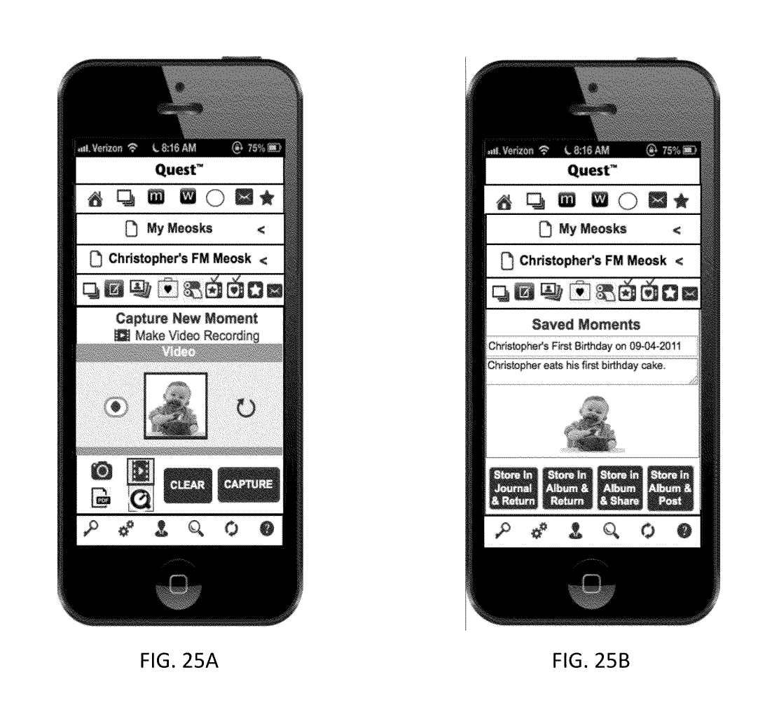

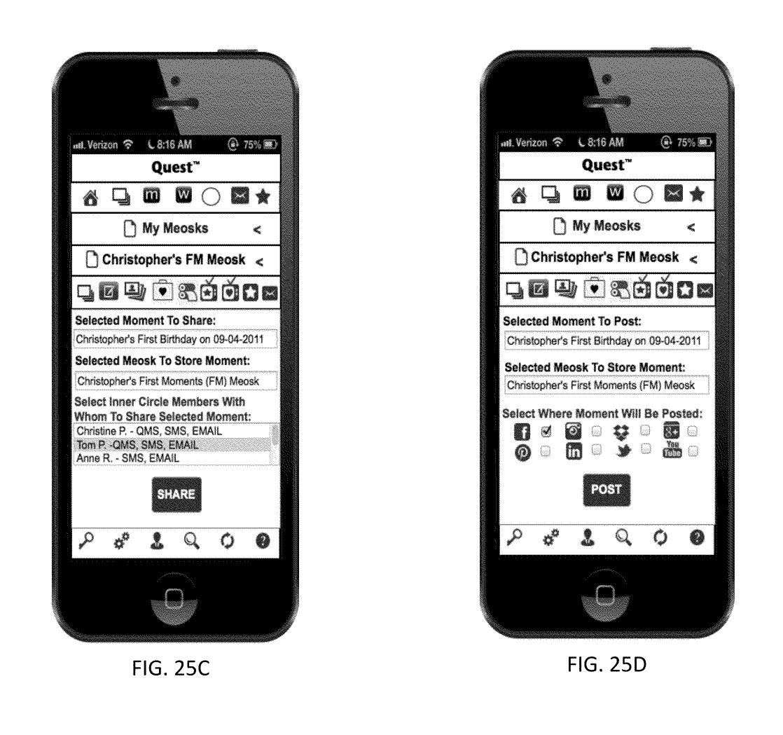

FIG. 25A shows the my meosks module displaying the selected meosk structure (e.g. Christopher's FM Meosk) and the selected module, capture new moment, providing a selection of moment multi-media moment capture tools from which the user can select to capture new video and photographic moments for automatic storage in one of the moment store locations selected within the meosk structure's GUI-based virtual file and operating system (VFOS) supported by the Apache Hadoop® distributed information file storage and retrieval system 15 on the system network 1, shown in FIGS. 1, 1A, 1B-1 and 1B-2.

FIG. 25A shows the my meosks module displaying the selected meosk structure and the selected module, capture new moment, where the video/image recording moment capture tool, indicated by the camera icon in FIG. 24, has been selected and used to capture a video/image recording moment.

FIG. 25B shows the my meosks module displaying the selected meosk structure and the selected module, capture new moment, where four options are shown for storing the captured video/image recording moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the captured moment along selected social media channels.

FIG. 25C shows the my meosks module displaying the selected meosk structure and the selected module, capture new moment, where the option (i) store in my album and share with members of the meosk inner circle, has been selected and displayed, and certain members of the meosk structure's inner circle are being selected for sharing.

FIG. 25D shows the my meosks module displaying the selected meosk structure and the selected module, capture new moment, where the option (i) store in my album and post along selected social media channels, has been selected and displayed, and certain social media channels are being selected for posting the captured moments. As shown, the guest or master user selects which social media channels to which the user wishes to post the captured sound recording. Here, again, it is understood that this moment posting option is only available to the “guest” system user if and only if the meosk master has enabled this moment posting option (i) during meosk creation and deployment steps illustrated in FIG. 39K, or (ii) in the meosk control panel illustrated in FIGS. 90A and 90B. The moment posting option is available to the “master” system user if and only if the meosk master has enabled this moment posting option (i) during meosk creation and deployment steps illustrated in FIG. 39J, or (ii) subsequently in the meosk control panel illustrated in FIGS. 90A and 90B.

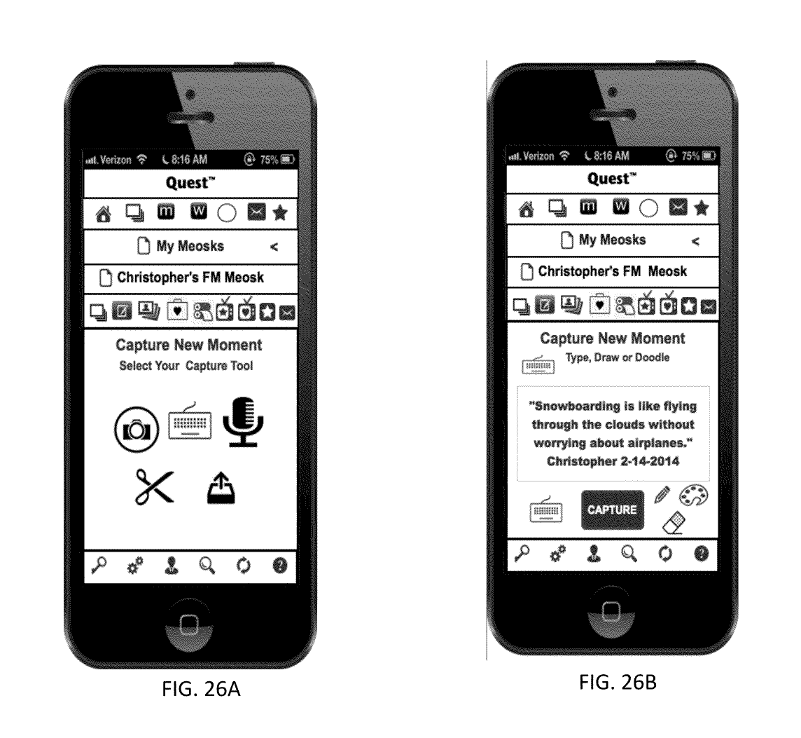

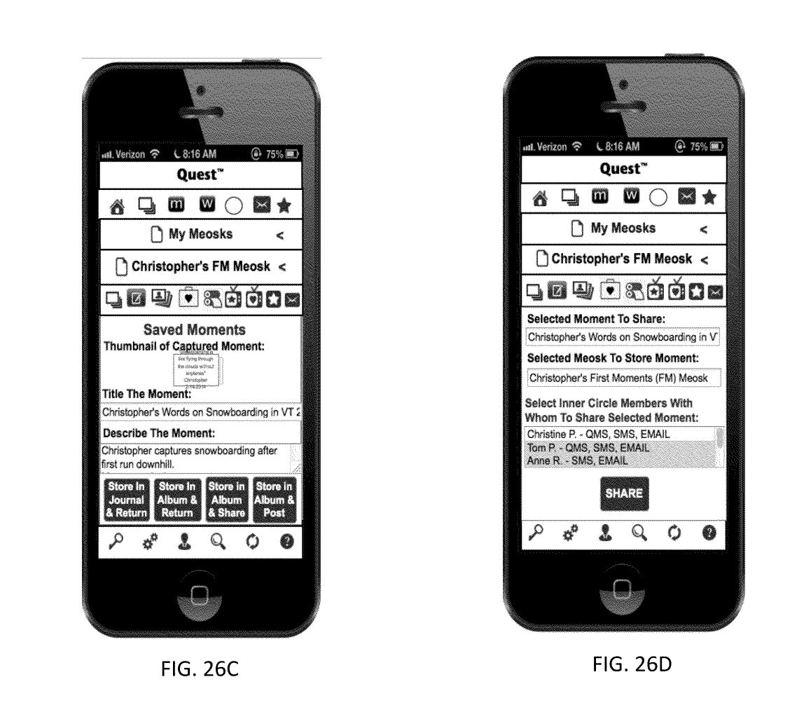

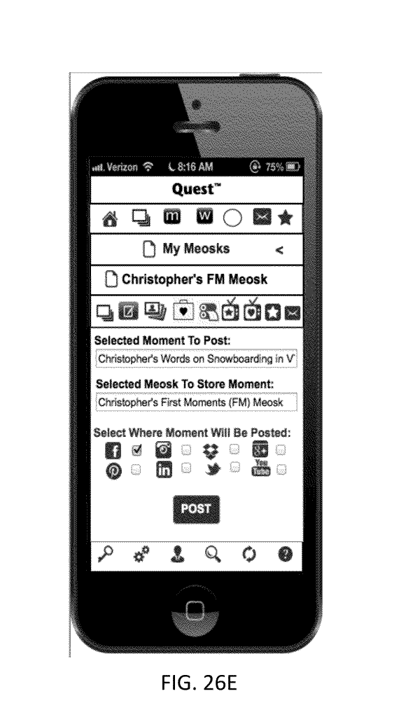

FIG. 26A shows the my meosks module displaying the selected meosk structure (e.g. Christopher's FM Meosk) and the selected module, capture new moment, providing a selection of moment multi-media moment capture tools from which the user can select to capture new moments for automatic storage in one of the moment store locations selected within the meosk structure's GUI-based virtual file and operating system (VFOS) supported by the Apache Hadoop® distributed information file storage and retrieval system 15 on the system network 1, shown in FIGS. 1, 1A, 1B-1 and 1B-2.

FIG. 26B shows the my meosks module displaying the selected meosk structure and the selected module, capture new moment, where the text moment capture tool, indicated by the typewriter icon in FIG. 26A, has been selected and used to capture a text-based moment.

FIG. 26C shows the my meosks module displaying the selected meosk structure and the selected module, capture new moment, where four options are shown for storing the captured text moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the captured moment along selected social media channels.

FIG. 26D shows the my meosks module displaying the selected meosk structure and the selected module, capture new moment, where the option (i) store in my album and share with members of the meosk inner circle, has been selected and displayed, and certain members of the meosk structure's inner circle are being selected for sharing.

FIG. 26E shows the my meosks module displaying the selected meosk structure and the selected module, capture new moment, where the option (i) store in my album and post along selected social media channels, has been selected and displayed, and certain social media channels are being selected for posting the captured text moments. As shown, the guest or master user selects which social media channels to which the user wishes to post the captured sound recording. Here, again, it is understood that this moment posting option is only available to the “guest” system user if and only if the meosk master has enabled this moment posting option (i) during meosk creation and deployment steps illustrated in FIG. 39K, or (ii) in the meosk control panel illustrated in FIGS. 90A and 90B. The moment posting option is available to the “master” system user if and only if the meosk master has enabled this moment posting option (i) during meosk creation and deployment steps illustrated in FIG. 39J, or (ii) subsequently in the meosk control panel illustrated in FIGS. 90A and 90B.

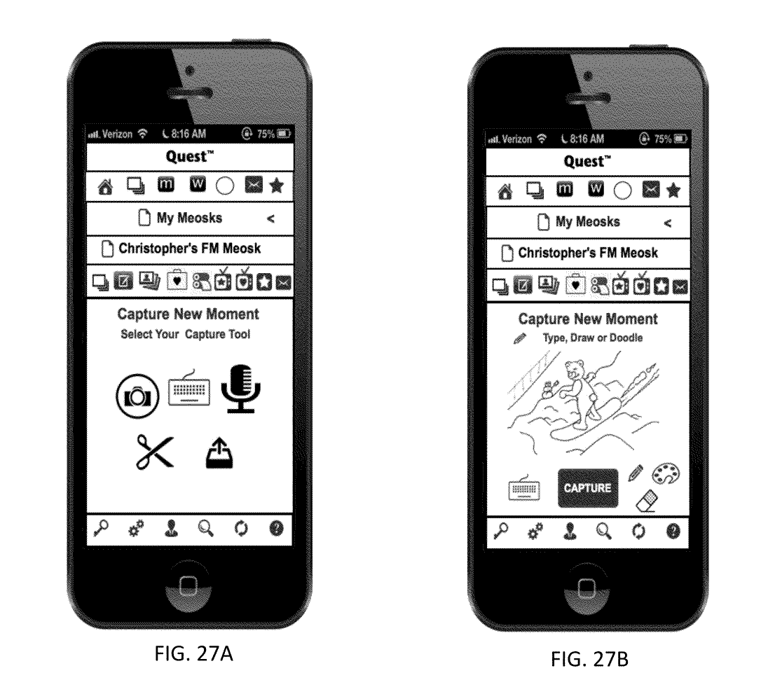

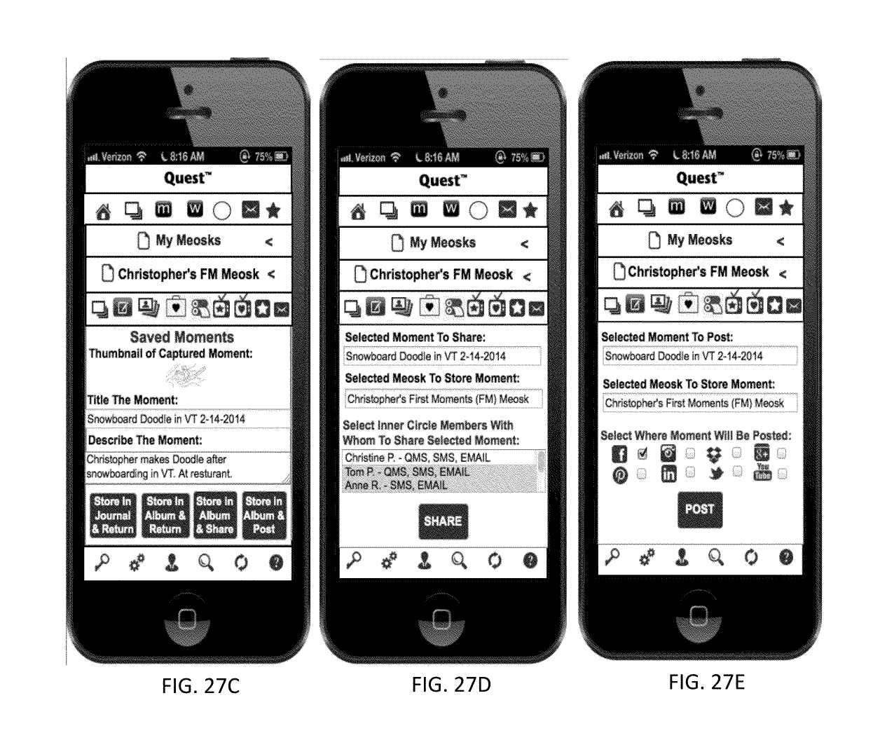

FIG. 27A shows the my meosks module displaying the selected meosk structure (e.g. Christopher's FM Meosk) and the selected module, capture new moment, providing a selection of moment multi-media moment capture tools from which the user can select to capture new moments for automatic storage in one of the moment store locations selected within the meosk structure's GUI-based virtual file and operating system (VFOS) supported by the Apache Hadoop® distributed information file storage and retrieval system 15 on the system network 1, shown in FIGS. 1, 1A, 1B-1 and 1B-2.

FIG. 27B shows the my meosks module displaying the selected meosk structure and the selected module, capture new moment, where the drawing/doodling moment capture tool, indicated by the pencil icon in FIGS. 26B and 27B, has been selected and used to capture a drawing/doodle-based moment.

FIG. 27C shows the my meosks module displaying the selected meosk structure and the selected module, capture new moment, where four options are shown for storing the captured drawing/doodle moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the captured moment along selected social media channels.

FIG. 27D shows the my meosks module displaying the selected meosk structure and the selected module, capture new moment, where the option (i) store in my album and share with members of the meosk inner circle, has been selected and displayed, and certain members of the meosk structure's inner circle are being selected for sharing.

FIG. 27E shows the my meosks module displaying the selected meosk structure and the selected module, capture new moment, where the option (i) store in my album and post along selected social media channels, has been selected and displayed, and certain social media channels are being selected for posting the captured text moments. As shown, the guest or master user selects which social media channels to which the user wishes to post the captured sound recording. Here, again, it is understood that this moment posting option is only available to the “guest” system user if and only if the meosk master has enabled this moment posting option (i) during meosk creation and deployment steps illustrated in FIG. 39K, or (ii) in the meosk control panel illustrated in FIGS. 90A and 90B. The moment posting option is available to the “master” system user if and only if the meosk master has enabled this moment posting option (i) during meosk creation and deployment steps illustrated in FIG. 39J, or (ii) subsequently in the meosk control panel illustrated in FIGS. 90A and 90B.

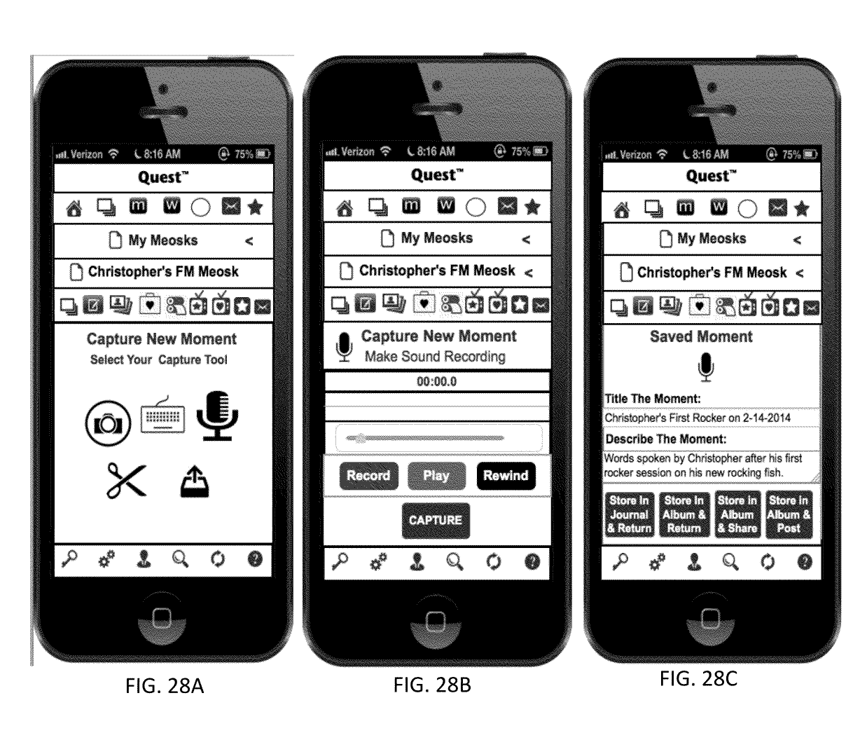

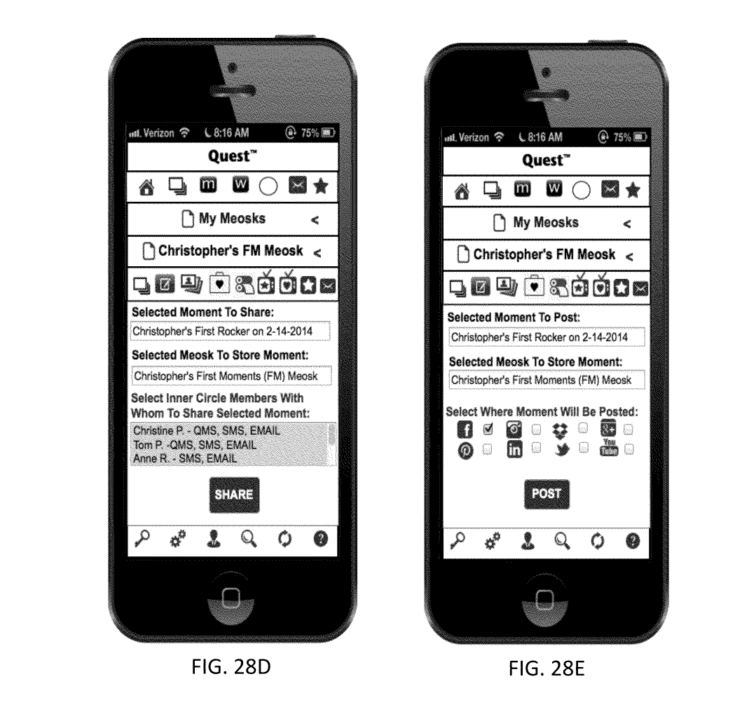

FIG. 28A shows the my meosks module displaying the selected meosk structure (e.g. Christopher's FM Meosk) and the selected module, capture new moment, providing a selection of moment multi-media moment capture tools from which the user can select to capture new moments for automatic storage in one of the moment store locations selected within the meosk structure's GUI-based virtual file and operating system (VFOS) supported by the Apache Hadoop® distributed information file storage and retrieval system 15 on the system network 1, shown in FIGS. 1, 1A, 1B-1 and 1B-2.

FIG. 28B shows the my meosks module displaying the selected meosk structure and the selected module, capture new moment, where the sound recording moment capture tool, indicated by the microphone icon in FIG. 28A, has been selected and used to capture a recorded sound moment.

FIG. 28C shows the my meosks module displaying the selected meosk structure and the selected module, capture new moment, where four options are shown for storing the captured sound moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the recorded sound moment along selected social media channels.

FIG. 28D shows the my meosks module displaying the selected meosk structure and the selected module, capture new moment, where the option (i) store in my album and share with members of the meosk inner circle, has been selected and displayed, and certain members of the meosk structure's inner circle are being selected for sharing.

FIG. 28E shows the my meosks module displaying the selected meosk the selected module, capture new moment, where the option (i) store in my album and post along selected social media channels, has been selected and displayed, and certain social media channels are being selected for posting the recorded sound moments. As shown, the guest or master user selects which social media channels to which the user wishes to post the captured sound recording. Here, again, it is understood that this moment posting option is only available to the “guest” system user if and only if the meosk master has enabled this moment posting option (i) during meosk creation and deployment steps illustrated in FIG. 39K, or (ii) in the meosk control panel illustrated in FIGS. 90A and 90B. The moment posting option is available to the “master” system user if and only if the meosk master has enabled this moment posting option (i) during meosk creation and deployment steps illustrated in FIG. 39J, or (ii) subsequently in the meosk control panel illustrated in FIGS. 90A and 90B.

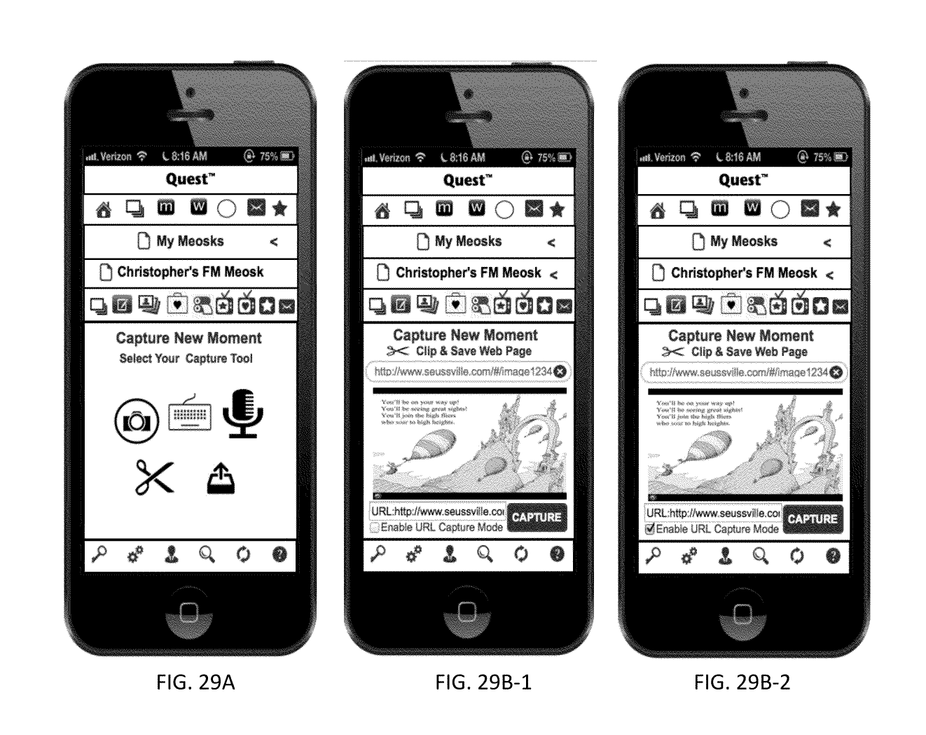

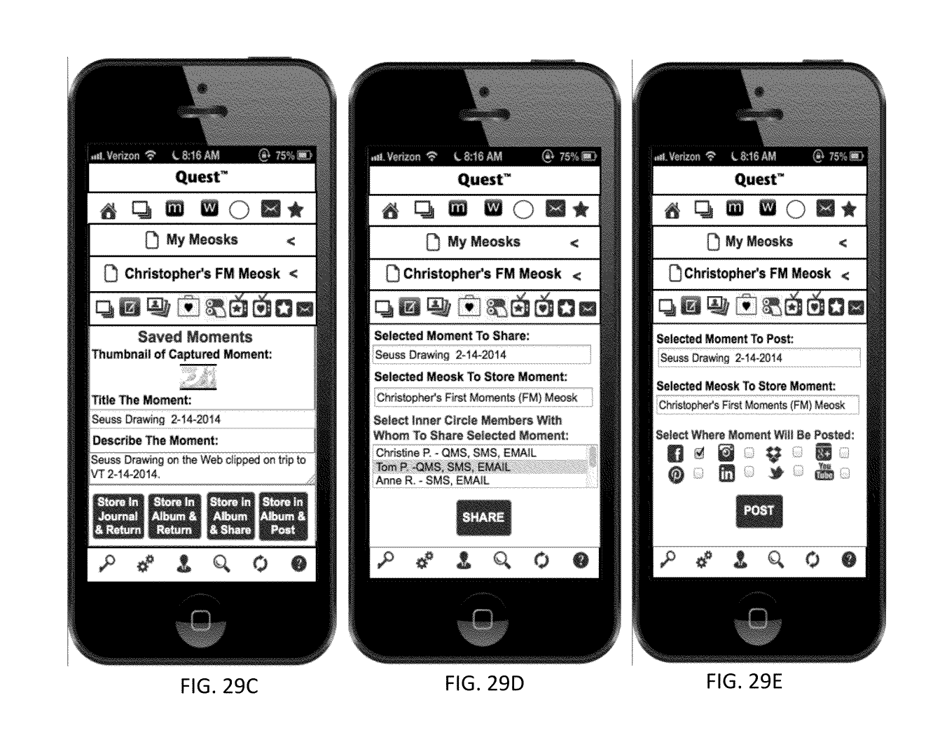

FIG. 29A shows the my meosks module displaying the selected meosk structure (e.g. Christopher's FM Meosk) and the selected module, capture new moment, providing a selection of moment multi-media moment capture tools from which the user can select to capture new moments for automatic storage in one of the moment store locations within the meosk structure's GUI-based virtual file and operating system (VFOS) supported by the Apache Hadoop® distributed data file storage and retrieval system 15 on the system network 1, shown in FIGS. 1, 1A, 1B-1 and 1B-2.

FIG. 29B-1 shows the my meosks module displaying the selected meosk structure and the selected module, capture new moment, where the web page clipping and moment capture tool, indicated by the scissors icon shown in FIG. 29A, has been selected and used to capture a clipped web-page moment as a pdf document. Using this tool, the system user has two options: (i) capturing a webpage or web-based object located at a particular URL on the Internet (e.g. WWW) and storing the entire file thereof, where possible, as a captured moment in the RDBMS 5, supported by the Apache Hadoop® distributed information file storage and retrieval system 15 on the system network 1, shown in FIGS. 1, 1A, 1B-1 and 1B-2; and (ii) capturing the URL of a webpage or web-based object located at a particular URL on the Internet (e.g. WWW) and storing only the URL as a captured moment in the RDBMS 5, supported by the Apache Hadoop® distributed information file storage and retrieval system 15 on the system network 1, shown in FIGS. 1, 1A, 1B-1 and 1B-2.

As shown in FIG. 29B-2, the capture moments tool is shown being used in its enable “URL Mode” to simply capture the URL of web-based object, as captured moment, indicated as option (ii) above, and store this captured URL in the system database 5 within the Apache Hadoop® system 15, for subsequent access and retrieval of the data file located at such captured URL. The system user only needs to select Enable URL Capture Mode to use this feature of this moment capture tool. When the URL mode is not enabled, this tool captures the entire webpage (i.e. HTML document/file) located at the particular URL and saves the web document in pdf format for storage in the system database 5 of the Apache Hadoop® system 15 supported on the system network 1 of the present invention.

FIG. 29C shows the my meosks module displaying the selected meosk structure and the selected module, capture new moment, where four options are shown for storing the captured web-clipped moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the web-page clipped moment along selected social media channels.

FIG. 29D shows the my meosks module displaying the selected meosk structure and the selected module, capture new moment, where the option (i) store in my album and share with members of the meosk inner circle, has been selected and displayed, and certain members of the meosk structure's inner circle are being selected for sharing.

FIG. 29E shows the my meosks module displaying the selected meosk structure and the selected module, capture new moment, where the option (i) store in my album and post along selected social media channels, has been selected and displayed, and certain social media channels are being selected for posting the web-page clipped moments. As shown, the guest or master user selects which social media channels to which the user wishes to post the captured sound recording. Here, again, it is understood that this moment posting option is only available to the “guest” system user if and only if the meosk master has enabled this moment posting option (i) during meosk creation and deployment steps illustrated in FIG. 39K, or (ii) in the meosk control panel illustrated in FIGS. 90A and 90B. The moment posting option is available to the “master” system user if and only if the meosk master has enabled this moment posting option (i) during meosk creation and deployment steps illustrated in FIG. 39J, or (ii) subsequently in the meosk control panel illustrated in FIGS. 90A and 90B.

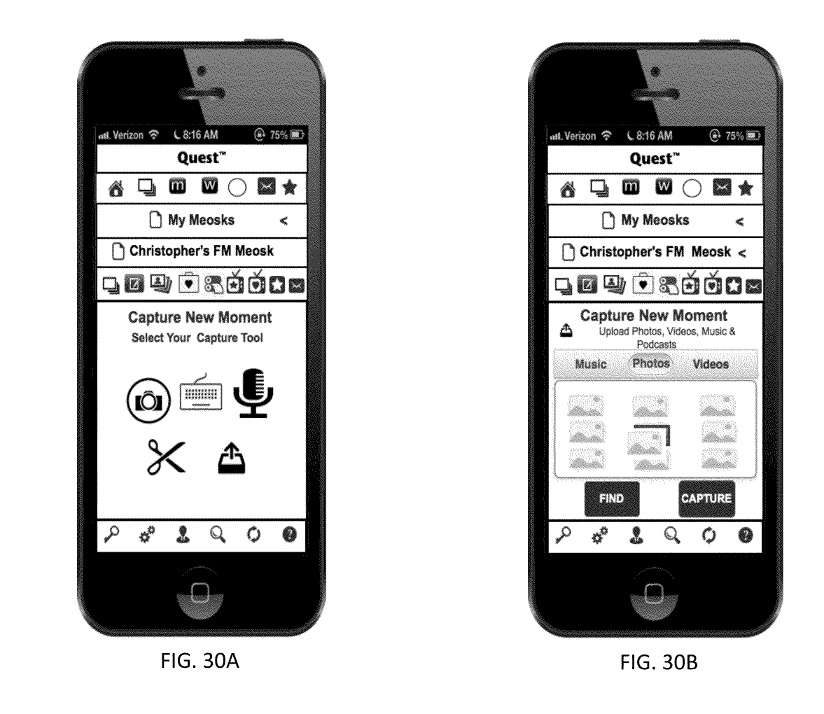

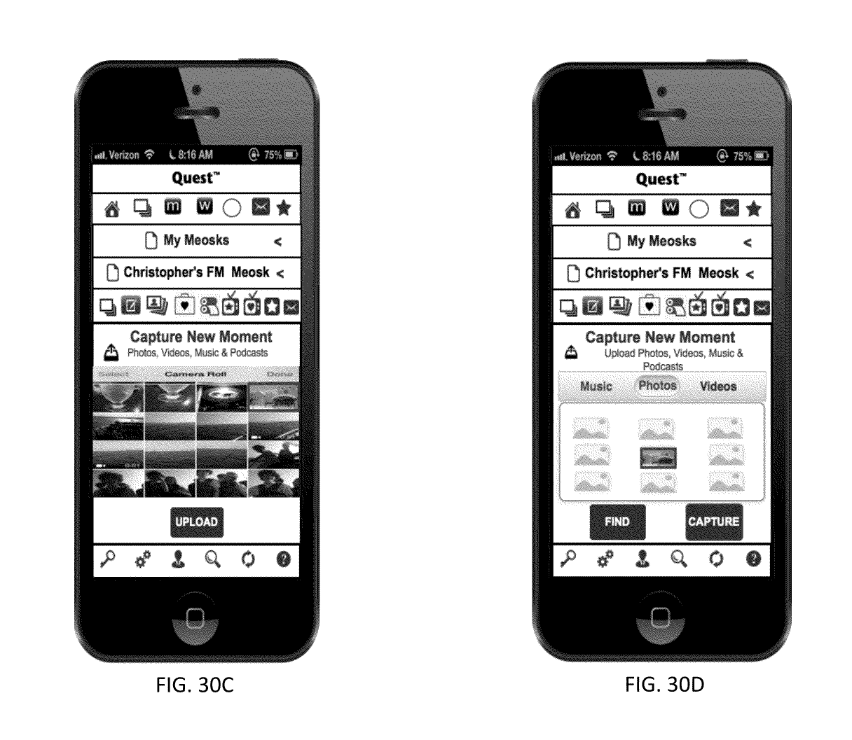

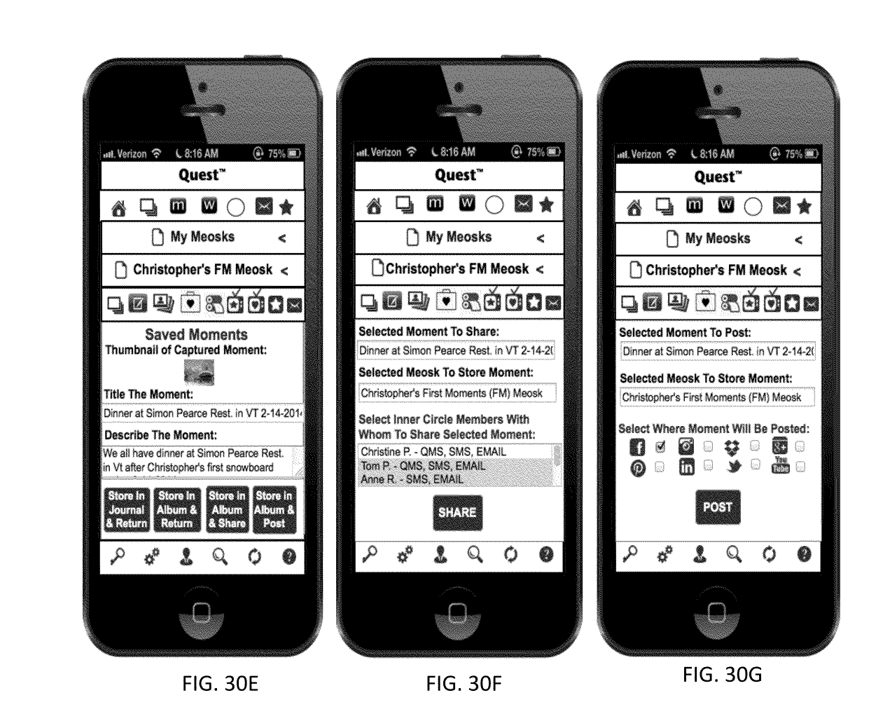

FIG. 30A shows the my meosks module displaying the selected meosk structure (e.g. Christopher's FM Meosk) and the selected module, capture new moment, providing a selection of moment multi-media moment capture tools from which the user can select to capture new moments for automatic storage in one of the moment store locations within the meosk structure's GUI-based virtual file and operating system (VFOS) structure.

FIG. 30B shows the my meosks module displaying the selected meosk structure and the selected module, capture new moment, where the file uploading and moment capture tool has been selected and used to find, upload and capture moments represented in uploaded files (e.g. photos, documents, applications etc).

FIG. 30C shows the my meosks module displaying the selected meosk structure and the selected module, capture new moment, where the file uploading and moment capture tool, indicated as the file upload icon in FIG. 30A, has been selected and used to find and upload uploaded files (e.g. photos, documents, applications etc).

FIG. 30D shows the my meosks module displaying the selected meosk structure and the selected module, capture new moment, where the file uploading and moment capture tool has been selected and used to captured moments in uploaded files (e.g. photos, documents, applications etc).

FIG. 30E shows the my meosks module displaying the selected meosk structure and the selected module, capture new moment, where four options are shown for storing the captured moment, namely, (i) store in my journal and return to capture tool menu, (ii) store in my album and return to the capture tool menu, (iii) store in my album and share with members of the inner circle of the selected meosk structure (i.e. GUI-based virtual file and operating system—VFOS), and (iv) store in my album and post the captured moment along selected social media channels.

FIG. 30F shows the my meosks module displaying the selected meosk structure and the selected module, capture new moment, where the option (i) store in my album and share with members of the meosk inner circle, has been selected and displayed, and certain members of the meosk structure's inner circle are being selected for sharing.

FIG. 30G shows the my meosks module displaying the selected meosk structure and the selected module, capture new moment, where the option (i) store in my album and post along selected social media channels, has been selected and displayed, and certain social media channels are being selected for posting the web-page clipped moments. As shown, the guest or master user selects which social media channels to which the user wishes to post the captured sound recording. Here, again, it is understood that this moment posting option is only available to the “guest” system user if and only if the meosk master has enabled this moment posting option (i) during meosk creation and deployment steps illustrated in FIG. 39K, or (ii) in the meosk control panel illustrated in FIGS. 90A and 90B. The moment posting option is available to the “master” system user if and only if the meosk master has enabled this moment posting option (i) during meosk creation and deployment steps illustrated in FIG. 39J, or (ii) subsequently in the meosk control panel illustrated in FIGS. 90A and 90B.

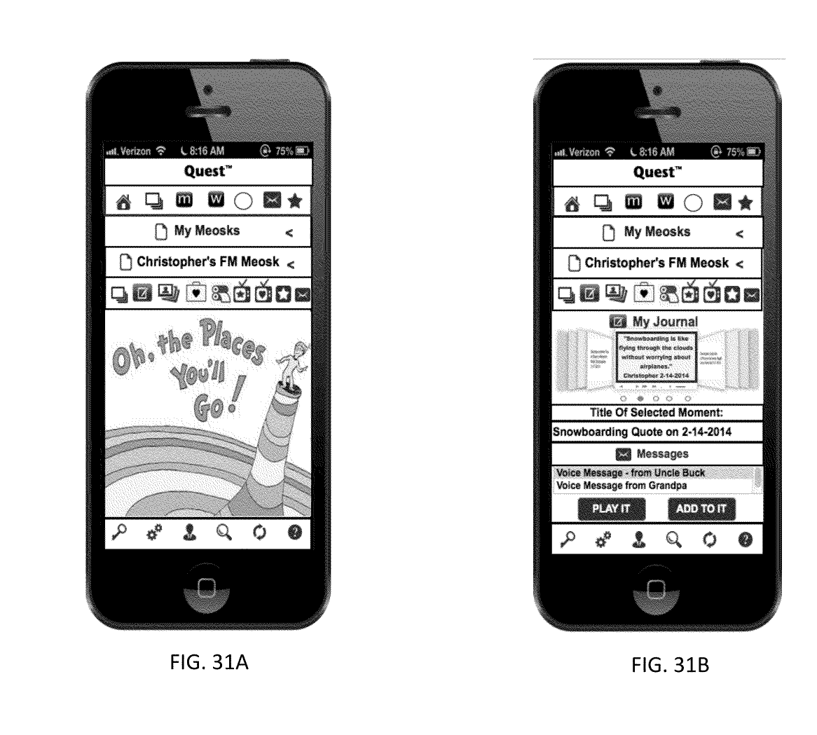

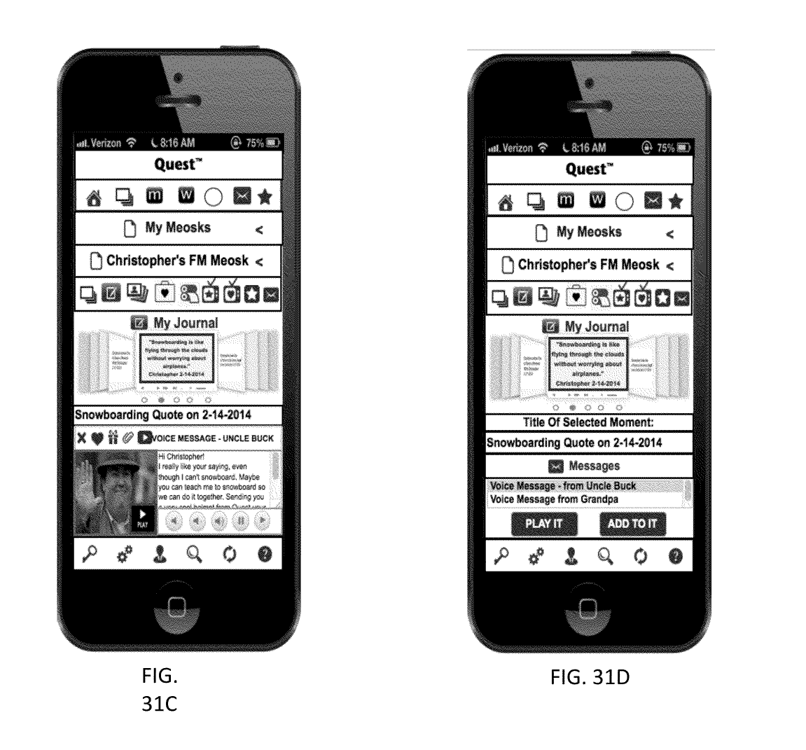

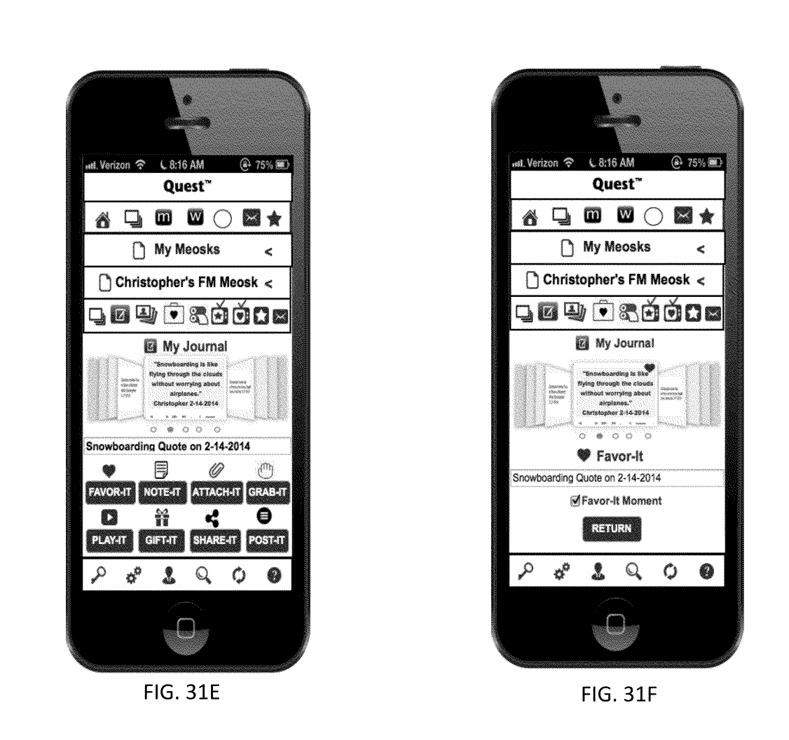

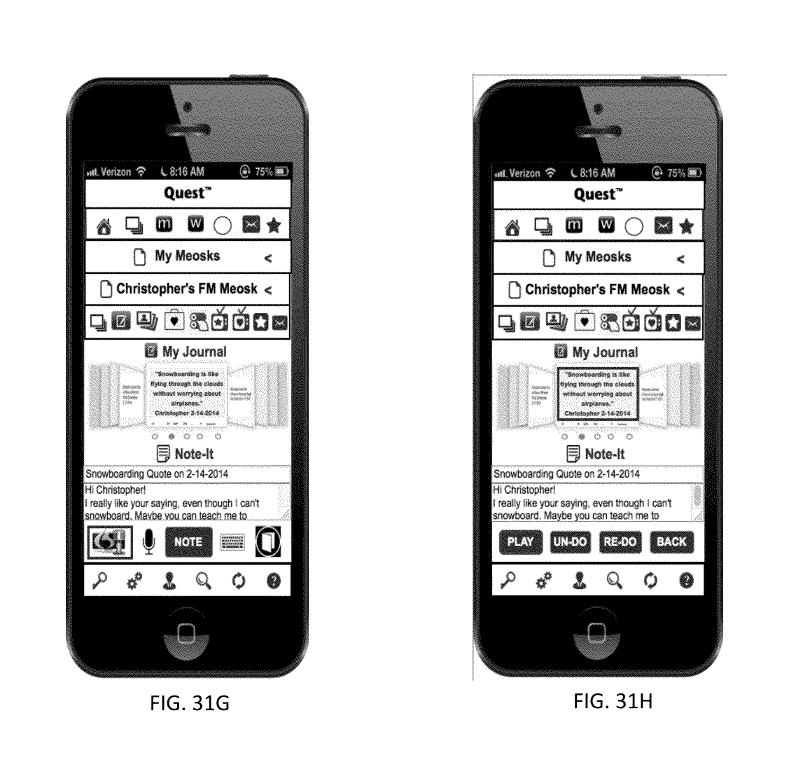

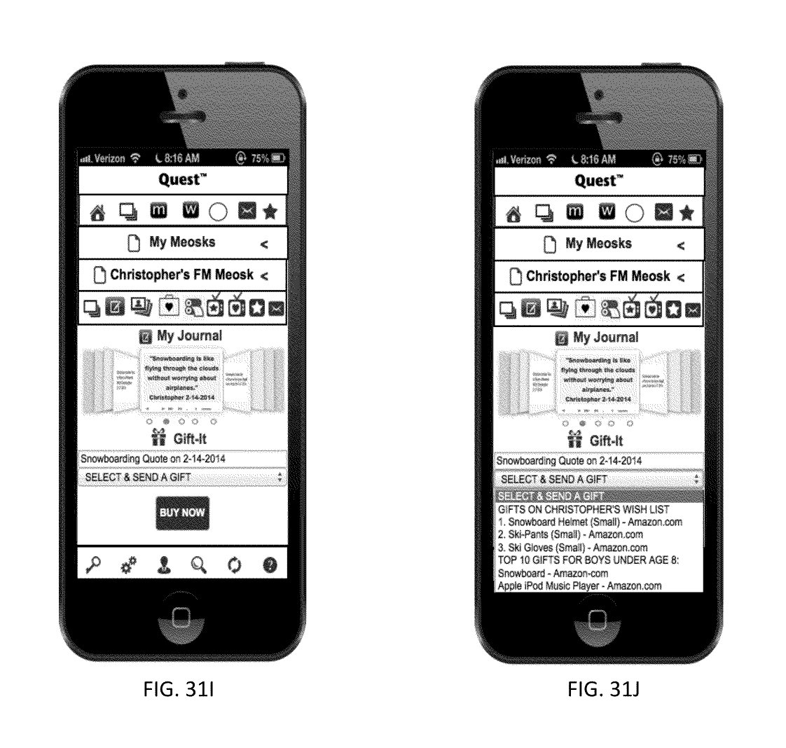

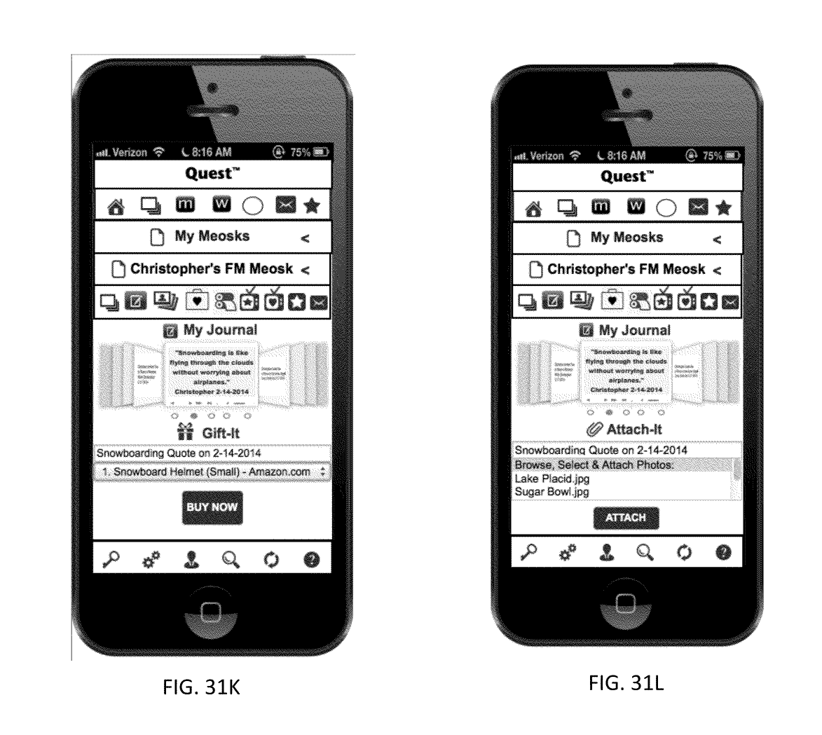

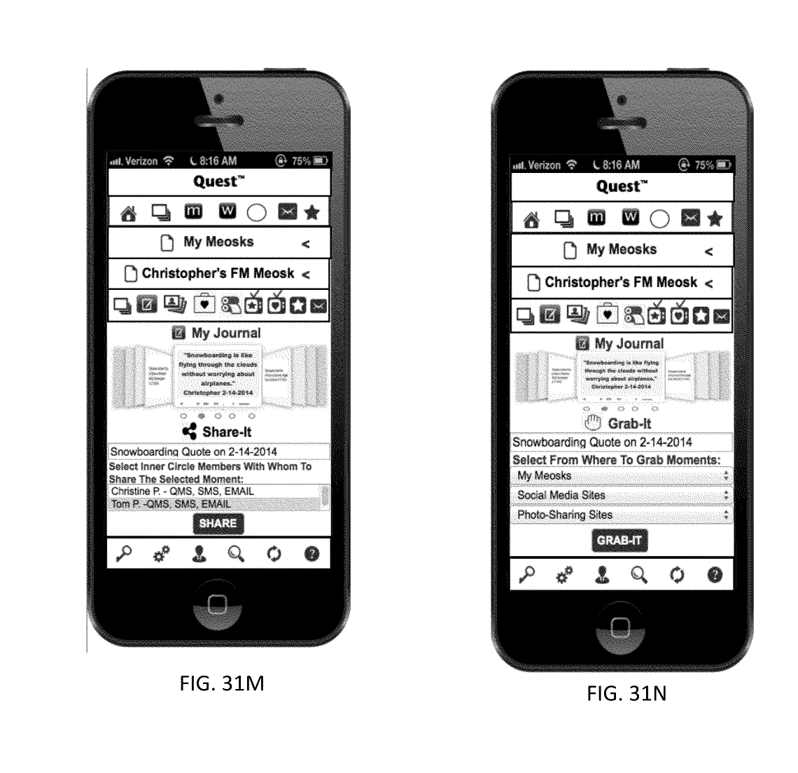

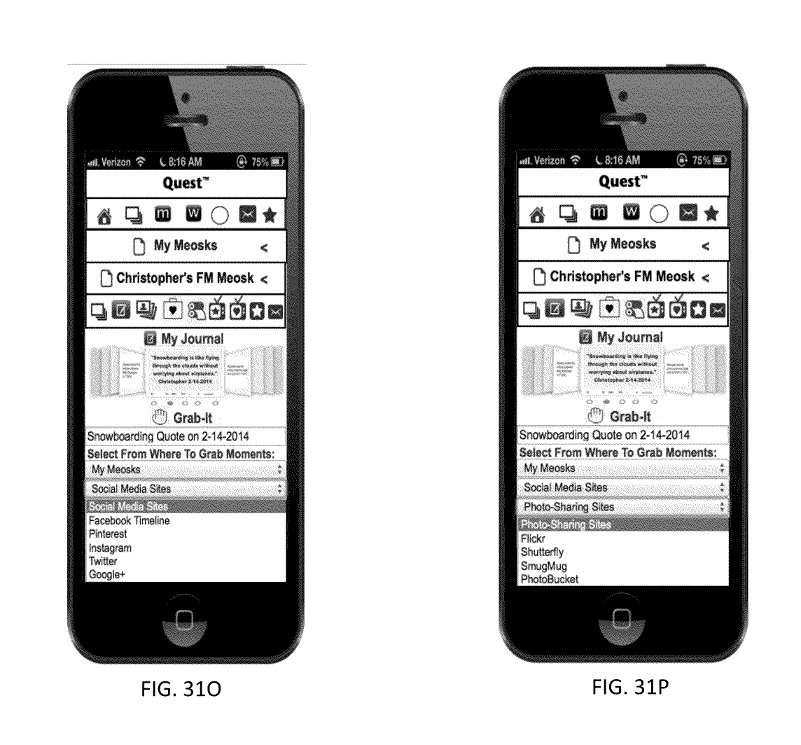

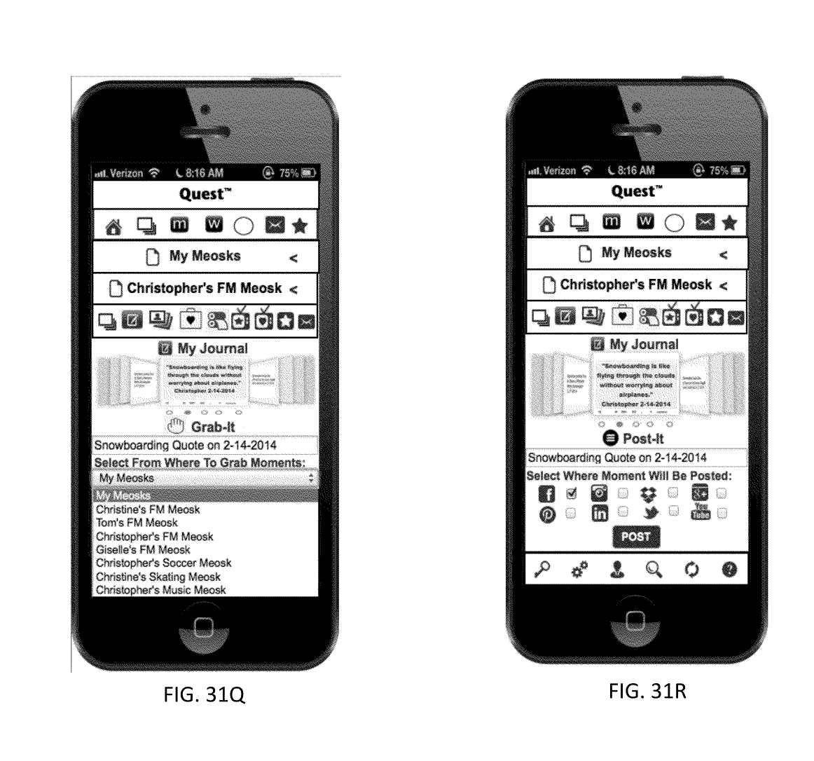

FIG. 31A shows the my meosks module displaying the selected meosk structure (e.g. Christopher's FM Meosk) and its menu of service functions that are supported within the GUI-based virtual file and operating system (VFOS) environment of each meosk structure supported on the system network 1 of the present invention.

FIG. 31B shows the my meosks module displaying the selected meosk structure and the selected module, “my journal”, where a particular moment is realized, for example, as a “page” in the journal, has been selected and all messages associated with (i.e. linked to) the moment, by inner circle members of the meosk structure, are displayed for the registered system user to either (i) play it (i.e. the selected moment) back for review and experience as illustrated in the GUI screens of FIGS. 31C and 31D, or (ii) add or contribute to the selected moment in any number of ways indicated in the GUI screens of FIGS. 31F through 31Y, hereinafter described below.

FIG. 31C shows the my meosks module displaying the selected meosk structure and the selected module, my journal, where a selected message associated with the selected moment is recalled from system network memory storage within the Apache Hadoop® system 15, and represented within the meosk structure for the registered user to experience the past message left by the inner circle member, regarding the once shared moment.

FIG. 31D shows the my meosks module displaying the selected meosk structure and the selected module, my journal, where the user is returned to the GUI screen shown in FIG. 31B, and makes the selection, to “add to it (the selected moment)”, advancing the client system to the GUI screen shown in FIG. 31E.

FIG. 31E shows the my meosks module displaying the selected meosk) and the selected module, my journal, where a menu of service function icons are displayed in connection with making a contribution to the selected moment in the my journal information store associated with the selected meosk structure.

FIG. 31F shows the my meosks module displaying the selected meosk structure and the selected module, my journal, where the “favorite it” service function was selected (via its displayed icon) and its corresponding GUI screen displayed allows the user to indicate that the moment should be indexed as a favorite moment.

FIG. 31G shows the my meosks module displaying the selected meosk structure and the selected module, my journal, where the “note it” service function was selected (via its displayed icon) and its corresponding GUI screen displayed allows the user to create and link a new message to the moment for persistent storage on the system network.

FIG. 31H shows the my meosks module displaying the selected meosk the selected module, my journal, where the a created message (i.e. note) is played back for review before linking it to the corresponding moment, for persistent storage on the system network.

FIGS. 31I, 31J and 31K show the my meosks module displaying the selected meosk structure and the selected module, my journal, where the “gift it” service function was selected (via its displayed icon) and its corresponding GUI screen displayed to allow the user to (i) buy a gift for the person associated with the moment, selected from either the person's wish list, or top ten or more trending gifts for the person in that gender/age group, and (ii) recording this gifting event associated with the moment for persistent storage on the system network.

FIG. 31L shows the my meosks module displaying the selected meosk structure and the selected module, my journal, where the “attach it” service function was selected (via its displayed icon) and its corresponding GUI screen displayed allow the user to attach another moment (e.g. associated one or more moments with a particular moment) and link for persistent storage on the system network.

FIG. 31M shows the my meosks module displaying the selected meosk structure and the selected module, my journal, where the “share it” service function was selected (via its displayed icon) and its corresponding GUI screen displayed allows the user to share the moment and associated messages and attachments with any one or more members of the meosk structure's inner circle, and store a persistent record thereof on the system network.

FIGS. 31N, 31O, 31P and 31Q shows the my meosks module displaying the selected meosk structure and the selected module, my journal, where the “grab it” service function was selected (via its displayed icon) and its corresponding displayed GUI screen allows the user to grab (i.e. point to and copy) any moment in any of the user's meosks or weosk structures, as well as social media sites, and photo-sharing sites, and copy it into the album store in the current meosk structure.

FIG. 31R shows the my meosks module displaying the selected meosk structure and the selected module, my journal, where the “post it” service function was selected (via its displayed icon) and its corresponding displayed GUI screen allows the user to post the moment and associated messages and attachments on any more or more of the user's social media channels, and store a persistent record thereof within the meosk structure.

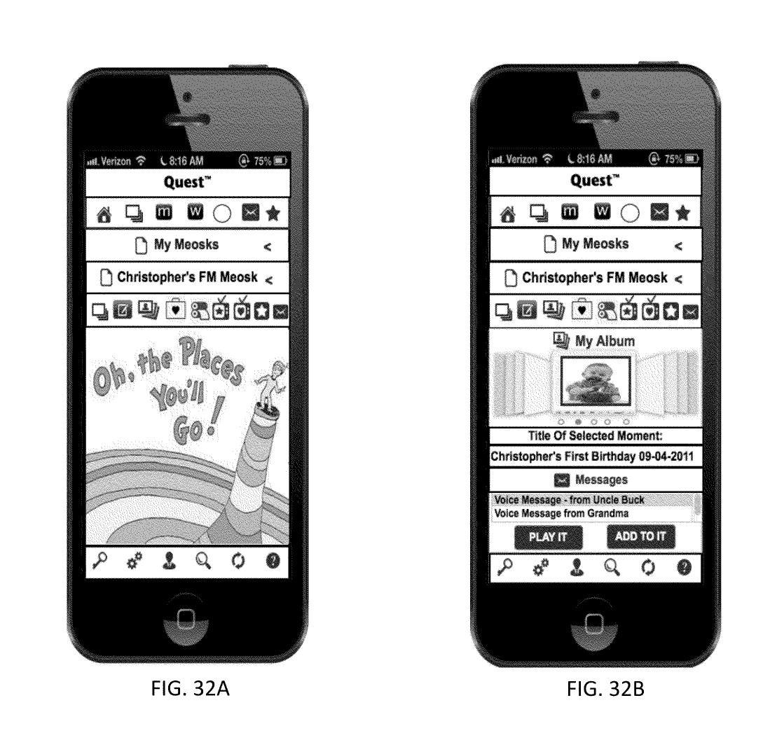

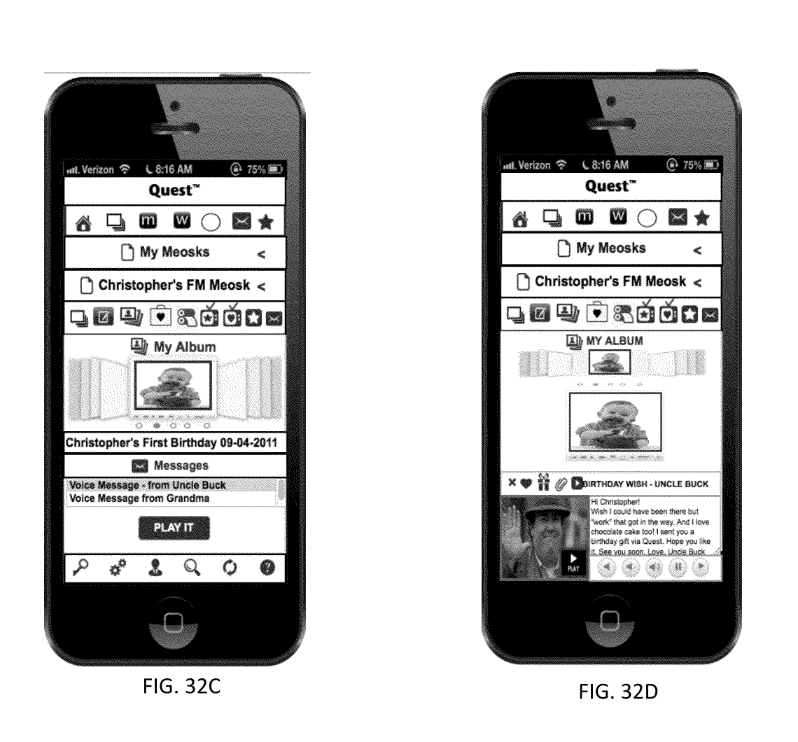

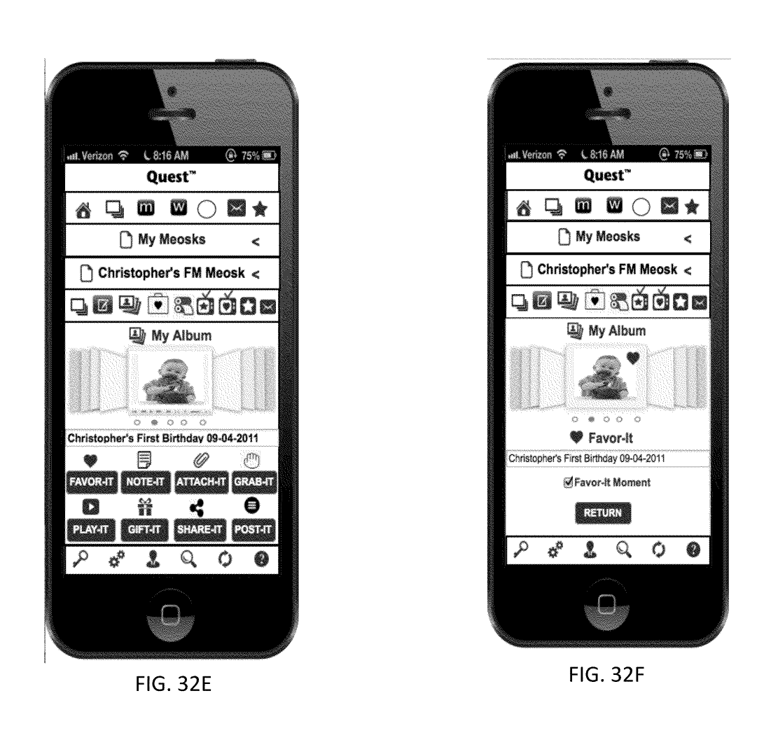

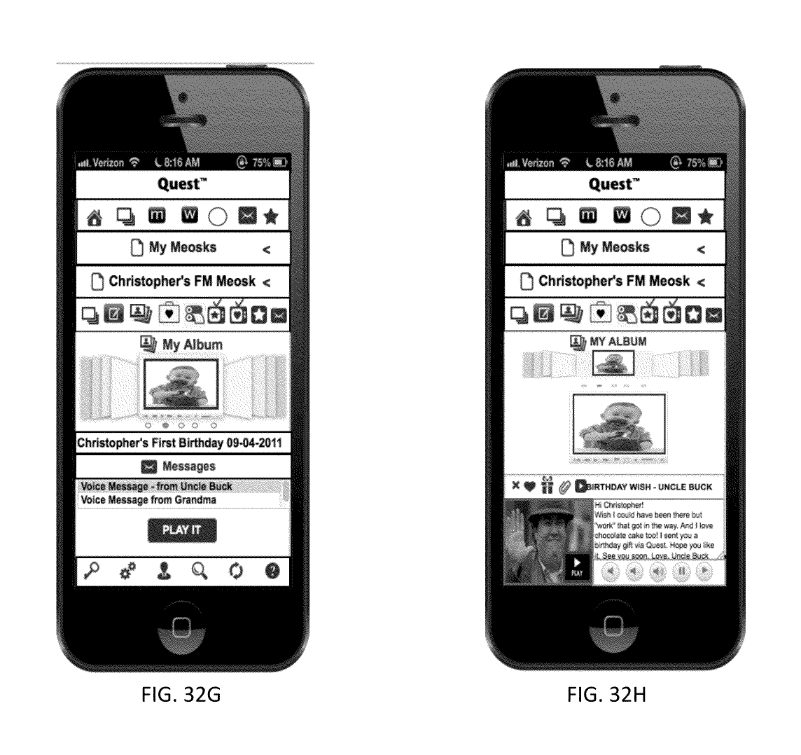

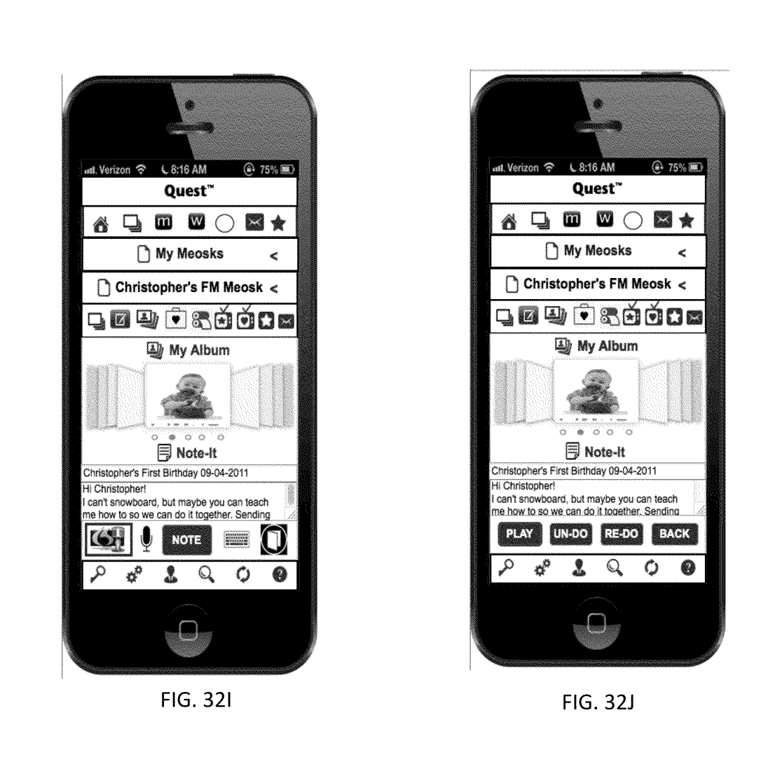

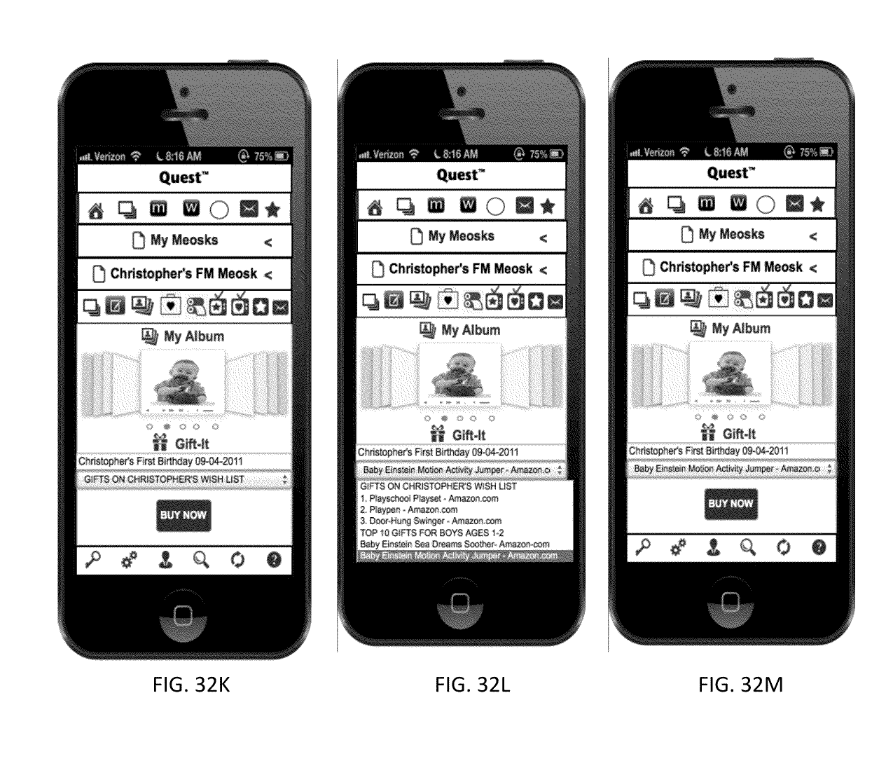

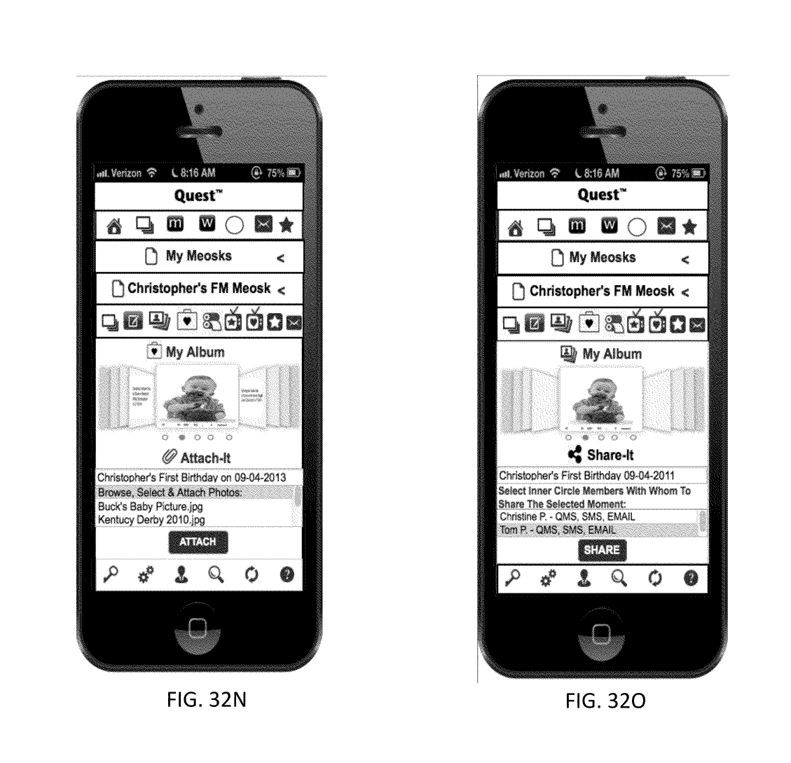

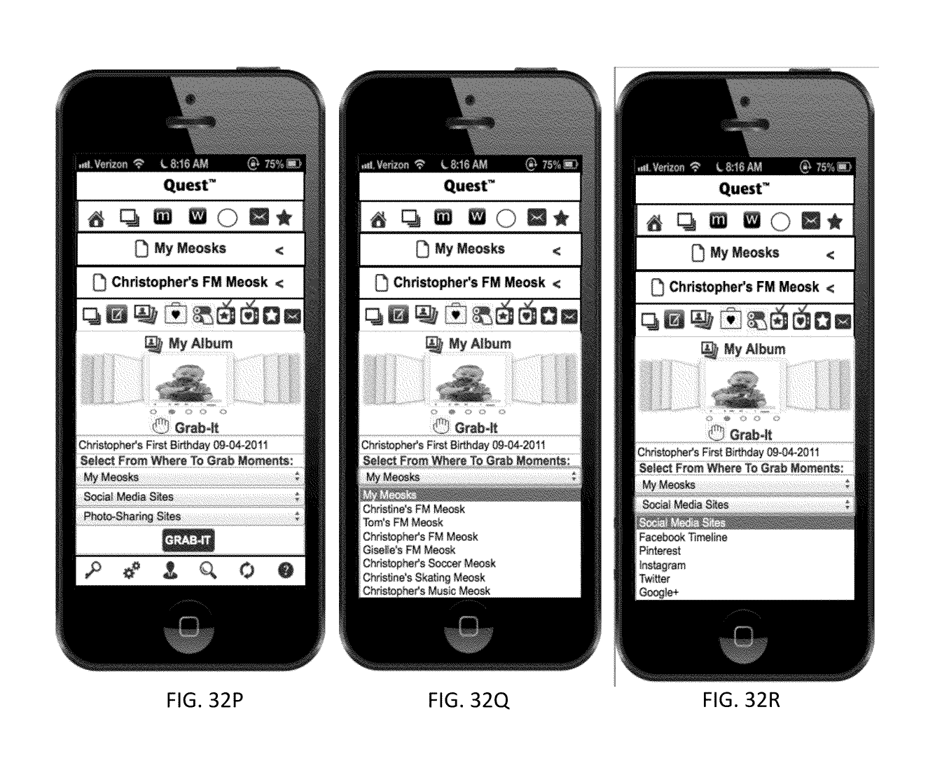

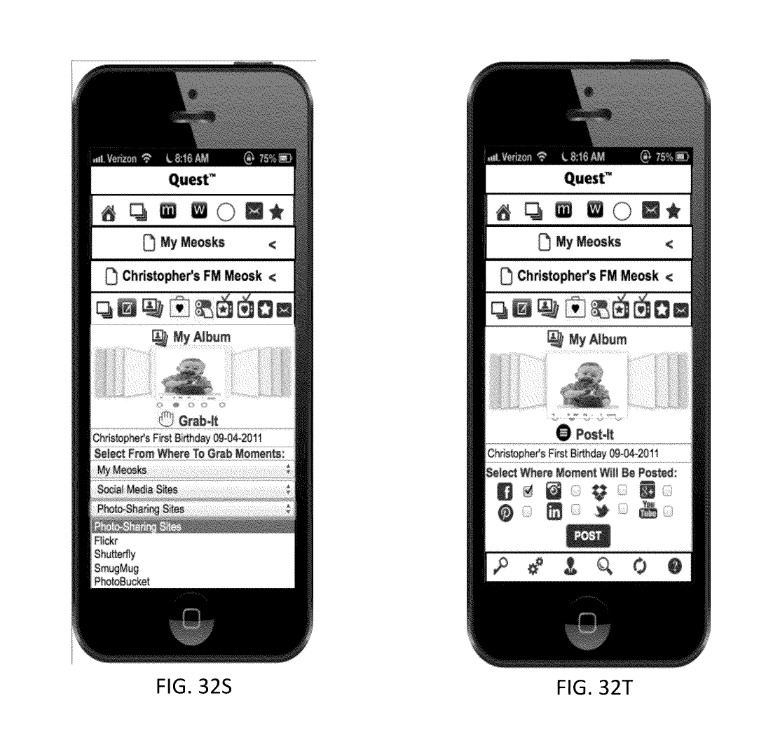

FIG. 32A shows the my meosks module displaying the selected meosk structure (i.e. Christopher's FM Meosk) and its menu of service functions that are supported within the GUI-based virtual file and operating system (VFOS) environment of each meosk structure (i.e. object-oriented subsystem) supported within the Quest web-based application.

FIG. 32B shows the my meosks module displaying the selected meosk structure and the selected module, “my album”, where a particular moment or “page” in the album has been selected and all messages associated with (i.e. linked to) the moment, by inner circle members of the meosk structure, are displayed for the register user to either (i) play it (i.e. the selected moment) back for review and experience as illustrated in the GUI screens of FIGS. 32C and 32D, or (ii) add or contribute to the selected moment in any number of ways indicated in the GUI screens of FIGS. 32F through 31T, described below.

FIG. 32C shows the my meosks module displaying the selected meosk structure and the selected module, my album, where a selected message associated with the selected moment is recalled from system network memory storage and represented within the meosk structure for the registered user to experience the past message left by the inner circle member, regarding the once shared moment.

FIG. 32D shows the my meosks module displaying the selected meosk structure and the selected module, my album, where the user is returned to the GUI screen shown in FIG. 31B, and makes the selection, to “add to it (the selected moment)”, advancing the client system to the GUI screen shown in FIG. 31E.

FIG. 32E shows the my meosks module displaying the selected meosk structure and the selected module, my album, where a menu of service function icons are displayed in connection with making a contribution to the selected moment in the my journal information store associated with the selected meosk structure.

FIG. 32F shows the my meosks module displaying the selected meosk structure and the selected module, my album, where the “favorite it” service function was selected (via its displayed icon) and its corresponding GUI screen displayed allows the user to indicate that the moment should be indexed as a favorite moment.

FIGS. 32G and 32H show the my meosks module displaying the selected meosk structure and the selected module, my album, where the a created message (i.e. note) is played back for review before linking it to the corresponding moment, for persistent storage within the meosk structure.

FIGS. 32I and 32J show the my meosks module displaying the selected meosk structure and the selected module, my album, where the “note it” service function was selected (via its displayed icon) and its corresponding GUI screen displayed allows the user to create and link a new message to the moment for persistent storage within the meosk structure.

FIGS. 32K, 32L and 32M show the my meosks module displaying the selected meosk structure and the selected module, my album, where the “gift it” service function was selected (via its displayed icon) and its corresponding GUI screen displayed to allow the user to (i) buy a gift for the person associated with the moment, selected from either the person's wish list, or top ten or more trending gifts for the person in that gender/age group, and (ii) recording this gifting event associated with the moment for persistent storage within the meosk structure.

FIG. 32N shows the my meosks module displaying the selected meosk structure and the selected module, my album, where the “attach it” service function was selected (via its displayed icon) and its corresponding GUI screen displayed allow the user to attach another moment (e.g. associated one or more moments with a particular moment) and link for persistent storage within the meosk structure.

FIG. 32O shows the my meosks module displaying the selected meosk structure and the selected module, my album, where the “share it” service function was selected (via its displayed icon) and its corresponding GUI screen displayed allows the user to share the moment and associated messages and attachments with any one or more members of the meosk structure's inner circle, and store a persistent record thereof within the meosk structure.

FIGS. 32P, 32Q, 32R and 32S shows the my meosks module displaying the selected meosk structure and the selected module, my album, where the “grab it” service function was selected (via its displayed icon) and its corresponding displayed GUI screen allows the user to grab (i.e. point to and copy) any moment in any of the user's meosks or weosk structures, as well as social media sites, and photo-sharing sites, and copy it into the album store in the current meosk structure.

FIG. 32T shows the my meosks module, and displaying the selected meosk structure and the selected module, my album, where the “post it” service function was selected (via its displayed icon) and its corresponding displayed GUI screen allows the user to post the moment and associated messages and attachments on any more or more of the user's social media channels, and store a persistent record thereof within the meosk structure.

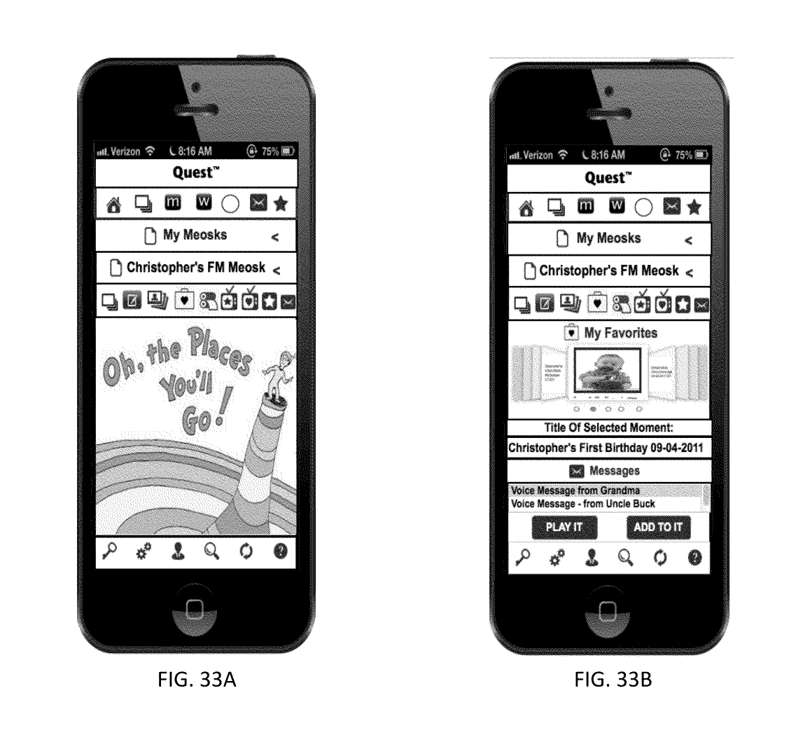

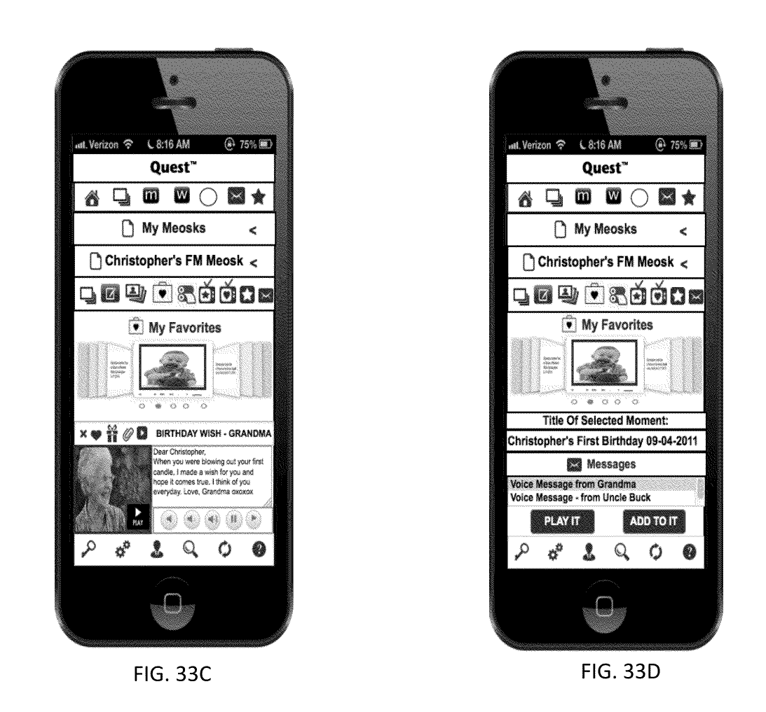

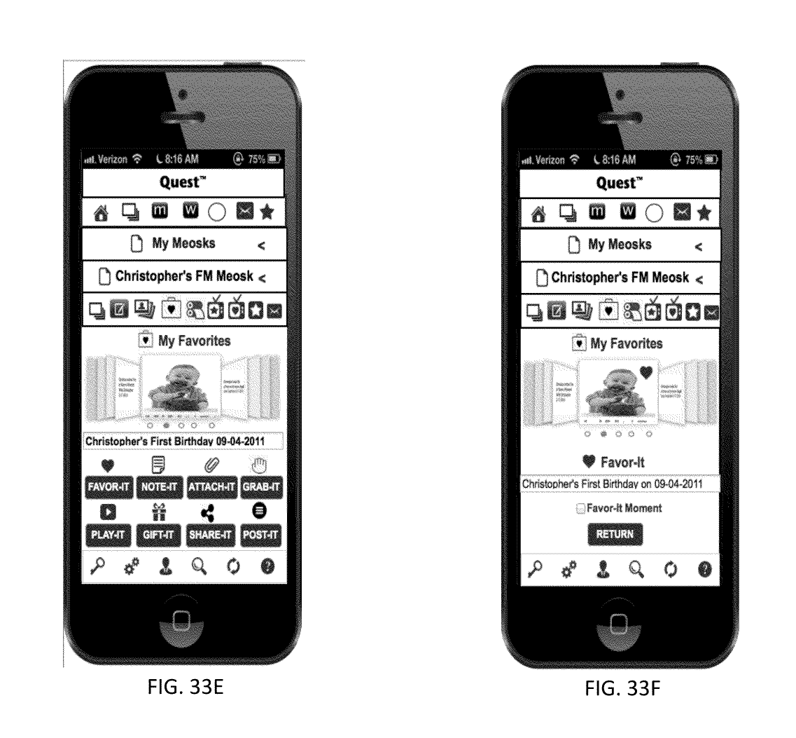

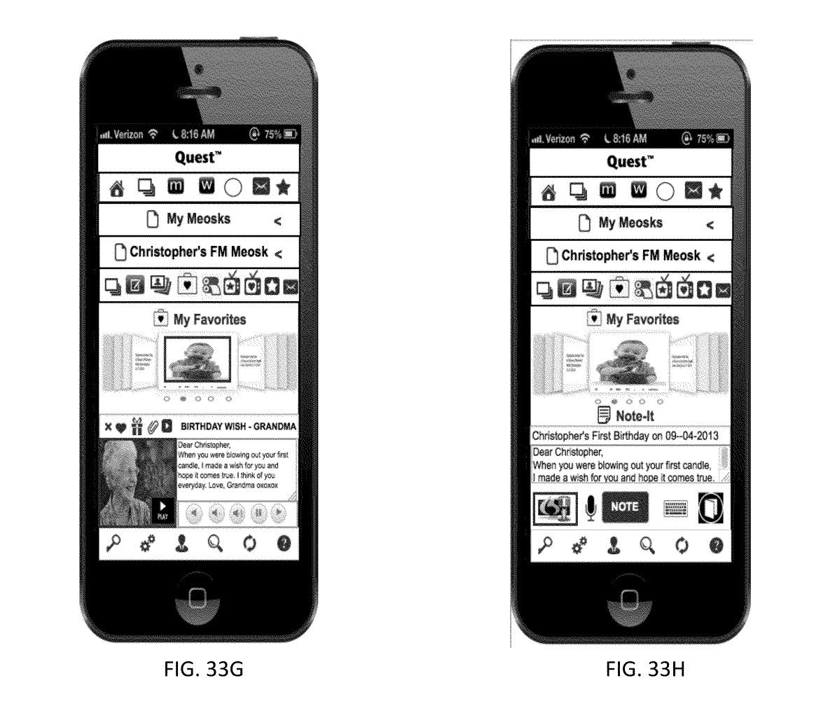

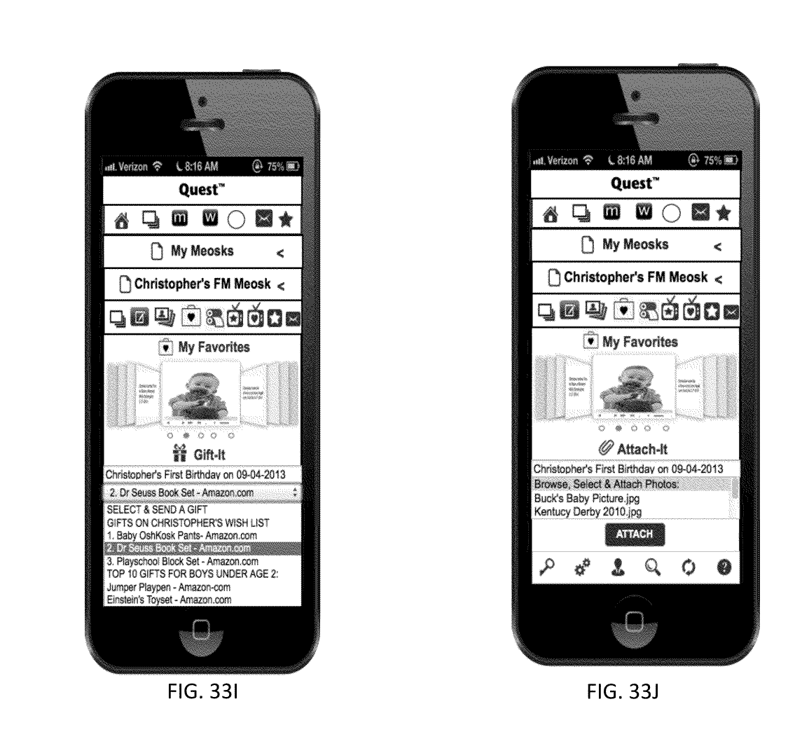

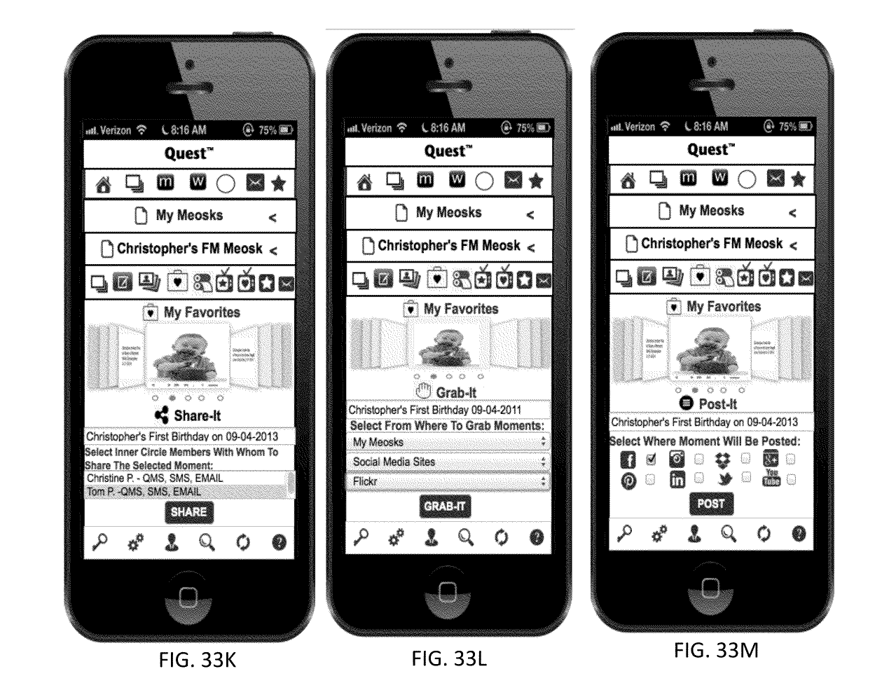

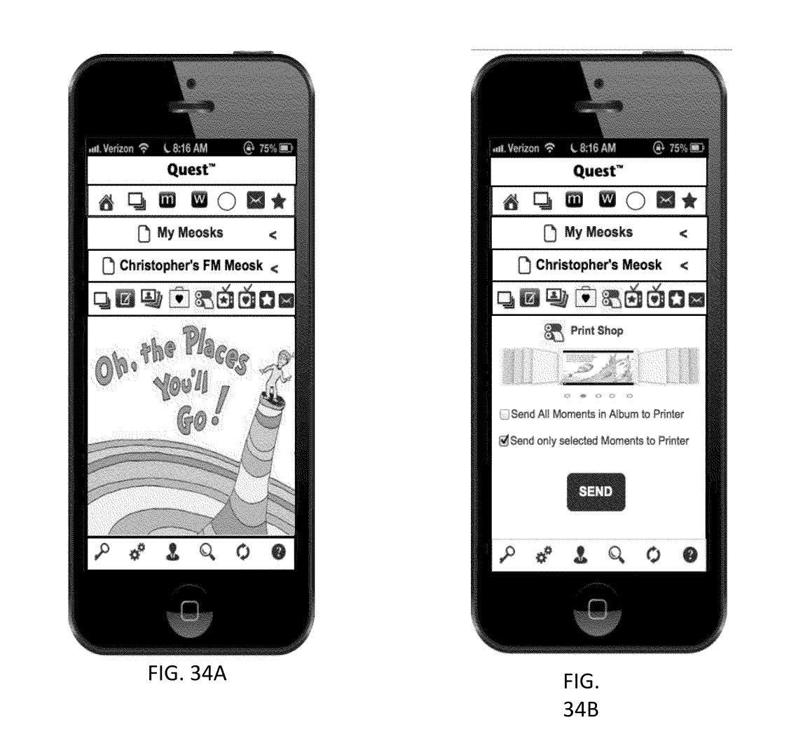

FIG. 33A shows the my meosks module displaying the selected meosk structure (i.e. Christopher's FM Meosk) and its menu of service functions that are supported within the GUI-based virtual file and operating system (VFOS) environment of each meosk structure (i.e. object-oriented subsystem) supported within the application servers on the system network.

FIG. 33B shows the my meosks module displaying the selected meosk structure and the selected module, “my favorites”, where a particular moment or “page” in the favorites album has been selected and all messages associated with (i.e. linked to) the moment, by inner circle members of the meosk structure, are displayed for the register user to either (i) play it (i.e. the selected moment) back for review and experience as illustrated in the GUI screens of FIGS. 33C and 33D, or (ii) add or contribute to the selected moment in any number of ways indicated in the GUI screens of FIGS. 33F through 33T, described below.

FIG. 33C shows the my meosks module displaying the selected meosk structure and the selected module, my favorites, where a selected message associated with the selected moment is recalled from system network memory storage and represented within the meosk structure for the registered user to experience the past message left by the inner circle member, regarding the once shared moment.

FIG. 33D shows the my meosks module displaying the selected meosk structure and the selected module, my favorites, where the user is returned to the GUI screen shown in FIG. 31B, and makes the selection, to “add to it (the selected moment)”, advancing the client system to the GUI screen shown in FIG. 33E.

FIG. 33E shows the my meosks module displaying the selected meosk structure and the selected module, my favorites, where a menu of service function icons are displayed in connection with making a contribution to the selected moment in the my journal information store associated with the selected meosk structure.

FIG. 33F shows the my meosks module displaying the selected meosk structure and the selected module, my favorites, where the “favorite it” service function was selected (via its displayed icon) and its corresponding GUI screen displayed allows the user to indicate that the moment should be indexed as a favorite moment.

FIG. 33G shows the my meosks module displaying the selected meosk structure and the selected module, my favorites, where the a created message (i.e. note) is played back for review before linking it to the corresponding moment, for persistent storage within the meosk structure.

FIG. 33H shows the my meosks module displaying the selected meosk structure and the selected module, my favorites, where the “note it” service function was selected (via its displayed icon) and its corresponding GUI screen displayed allows the user to create and link a new message to the moment for persistent storage within the meosk structure.

FIG. 33I shows the my meosks module displaying the selected meosk structure and the selected module, my favorites, where the “gift it” service function was selected (via its displayed icon) and its corresponding GUI screen displayed to allow the user to (i) buy a gift for the person associated with the moment, selected from either the person's wish list, or top ten or more trending gifts for the person in that gender/age group, and (ii) recording this gifting event associated with the moment for persistent storage within the meosk structure.

FIG. 33J shows the my meosks module displaying the selected meosk structure and the selected module, my favorites, where the “attach it” service function was selected (via its displayed icon) and its corresponding GUI screen displayed allow the user to attach another moment (e.g. associated one or more moments with a particular moment) and link for persistent storage within the meosk structure.

FIG. 33K shows the my meosks module displaying the selected meosk structure and the selected module, my favorites, where the “share it” service function was selected (via its displayed icon) and its corresponding GUI screen displayed allows the user to share the moment and associated messages and attachments with any one or more members of the meosk structure's inner circle, and store a persistent record thereof within the meosk structure.

FIG. 33L shows the my meosks module displaying the selected meosk structure and the selected module, my favorites, where the “grab it” service function was selected (via its displayed icon) and its corresponding displayed GUI screen allows the user to grab (i.e. point to and copy) any moment in any of the user's meosks or weosk structures, as well as social media sites, and photo-sharing sites, and copy it into the album store in the current meosk structure.

FIG. 33M shows the my meosks module displaying the selected meosk structure and the selected module, my favorites, where the “post it” service function was selected (via its displayed icon) and its corresponding displayed GUI screen allows the user to post the moment and associated messages and attachments on any more or more of the user's social media channels, and store a persistent record thereof within the meosk structure.

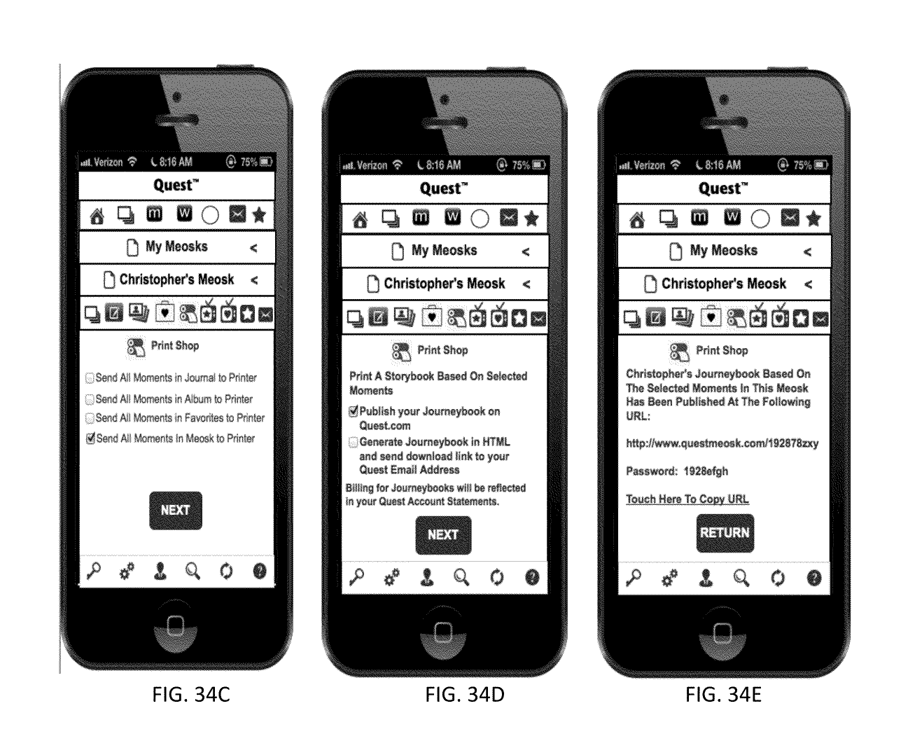

FIG. 34A shows the my meosks module displaying the selected meosk structure (i.e. Christopher's FM Meosk) and its menu of service functions that are supported within the GUI-based virtual file and operating system (VFOS) environment of each meosk structure (i.e. object-oriented subsystem) supported within the system network.

FIGS. 34B and 34C show the my meosks module displaying the selected meosk and the selected module, “print shop”, where all or certain moments, and associated messages, stored in selected albums of the meosk structure are selected and used to produce a journey book for the individual or individuals (e.g. ones children or grandchildren) who are uniquely associated with the meosk structure, so that that the journey book be generated and reviewed by such individuals at later date in their lives through any web browser running on any client machine, such as an iPad and like tablet computers.

FIG. 34D shows the my meosks module displaying the selected meosk structure (i.e. Christopher's FM Meosk) and the selected module, “Print Shop”, where moments, and associated messages, stored in selected albums in the meosk structure are selected for the production (i.e. printing) and publishing of either an online or offline version of an HTML-encoded journey book, for viewing either online or offline using a web browser.

FIG. 34E shows the my meosks module displaying the selected meosk structure (i.e. Christopher's FM Meosk) and the selected module, “Print Shop”, where the HTML-encoded journey book has been published at a predesignated URL on the WWW, for viewing using a web browser.

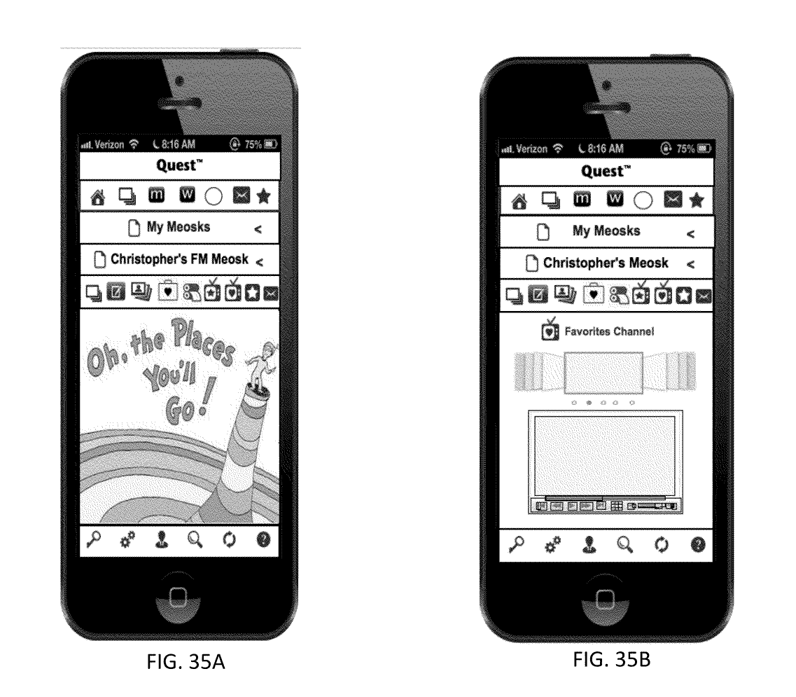

FIG. 35A shows the my meosks module displaying the selected meosk structure (i.e. Christopher's FM Meosk) and its menu of service functions that are supported within the GUI-based virtual file and operating system (VFOS) environment of each meosk structure (i.e. object-oriented subsystem) supported within the system network. FIG. 35B shows the my meosks module displaying the selected meosk structure (i.e. Christopher's FM Meosk) and the selected module, “favorites channel”, where all moments, and optionally all associated messages, that have been tagged or indexed as “favorite” in the meosk structure, are automatically displayed in a streamed manner within a playlist-driven media player embedded within the meosk structure. The play-list driven media player, implementing the favorites channel of each activity-specific meosk structure, is adapted to play videos and other audio-visual media content associated with the moments in the weosk structure that have been tagged or indexed as favorites by the inner circle members. The playlist-driven multi-media player embedded in the “favorites channel” shall support all media formats and technologies. Example file formats for images, movies and sound files that can be supported by the media-player include, but are not limited to: Images —.gif, .jpg, .jpeg, .jfif; .ps, .eps, .epsi, .tif, .tiff, .tga, .pict, .bmp, .pcx, .pbm, .ppm, .pgm, .psd, .cvs, .cgm, .wpg, .wmf, .xpm, .xbm; Movies —.avi, .flc, .fli, .mov, .MooV, .qt, .mpg, .mpeg; and Sound —.au, .iff, .mid, .rmi, .mod, .qt, .snd, .voc, .way.

FIG. 36A shows the my meosks module displaying the selected meosk structure (i.e. Christopher's FM Meosk) and its menu of service functions that are supported within the GUI-based virtual file and operating system (VFOS) environment of each meosk structure (i.e. object-oriented subsystem) supported within the system network. FIG. 36B shows the my meosks module displaying the selected meosk structure (i.e. Christopher's FM Meosk) and the selected module, “brand channel”, where brand advertisements, promotions and other marketing communications from brands associated with products and services associated with the specific-activity linked to the meosk structure, are automatically displayed in a streamed manner within a play-list driven or like media player embedded within the meosk structure. The play-list driven media player, implementing the brand channel of each activity-specific meosk structure, is adapted to play videos and other audio-visual media content in a programmed manner by the brand managers and/or staff of brands which the meosk master of the meosk structure has selected either during meosk creation and deployment or subsequently during meosk brand management operations supported by the system network. Example file formats for images, movies and sound files that can be supported by the media-player include, but are not limited to: Images —.gif, .jpg, .jpeg, .jfif; .ps, .eps, .epsi, .tif, .tiff, .tga, .pict, .bmp, .pcx, .pbm, .ppm, .pgm, .psd, .cvs, .cgm, .wpg, .wmf, .xpm, .xbm; Movies —.avi, .flc, .fli, .mov, .MooV, .qt, .mpg, .mpeg; and Sound —.au, .iff, .mid, .rmi, .mod, .qt, .snd, .voc, .way.

The brands use the programming tools supported in the brand manager module illustrated in FIGS. 6A-1 through 6F-15. In the event that a particular meosk structure has 5 different brands selected as part of the meosk master's my brands list, then each of these 5 brands will have the right to program video content sponsored by the selected brand in the embedded video player associated with the brand channel of the meosk structure. In some instances, meosk structures may be created and deployed with a single brand selected by the meosk master, in which case, this single brand will have the right to program exclusive content within the brand channel. Ideally, the sponsored video content will be related to the activity specified for the meosk structure, as well as the particular products and services which the brand provides to support the activity of the meosk master, and/or the beneficiary of the meosk structure in the event of the meosk structure being created and deployed under a trustee user account, as illustrated in FIG. 5D and described herein.

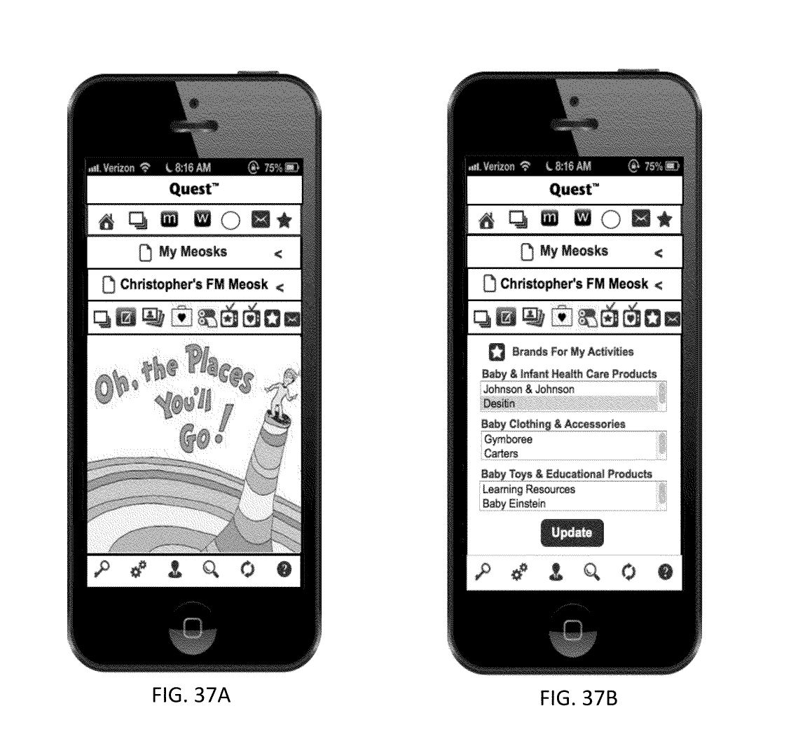

FIG. 37A shows the my meosks module displaying the selected meosk structure (i.e. Christopher's FM Meosk) and its menu of service functions that are supported within the GUI-based virtual file and operating system (VFOS) environment of each meosk structure (i.e. object-oriented subsystem) supported within the system network.

FIG. 37B shows a GUI screen supported by the my meosks module displaying the selected meosk structure and the selected module, “brand channel”, where brand advertisements, promotions, product/service information and other marketing communications from brand marketers associated with the products and services selected by the user for use with the specific-activity linked to the meosk structure, are automatically displayed in a streamed manner within a media player embedded within the meosk structure.

FIG. 38A shows the my meosks module displaying the selected meosk structure (i.e. Christopher's FM Meosk) and its menu of service functions that are supported within the GUI-based virtual file and operating system (VFOS) environment of each meosk structure (i.e. object-oriented subsystem) supported within the system network.

FIG. 38B the my meosks module displaying the selected meosk structure and the selected module, “Inner Circle Messaging”, where the user can send and receive messages with inner circle members associated with the meosk structure, as well as with any brands linked thereto.

FIG. 38C shows the my meosks module displaying the selected meosk structure and the selected module, “Inner Circle Messaging”, where the user receives a message from a brand to which the user sent a message, or from which the user has requested brand contact within the meosk structure.

### Specification of the Create New Meosk (for My Self) Module of the System Network of the Present Invention

In FIGS. 39A through 39R, each GUI screen contains numerous unique and recognizable icons which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities associated with selected icons and supporting modules. The details of this module, its graphical icons and corresponding services will be described in greater detail hereinafter.

FIG. 39A shows the “create new meosk” module displaying two options for creating a new meosk structure for my self (e.g. the user), and a new meosk structure for others (e.g. a child, spouse, grandparent of the user, or another beneficiary for whom the user will be acting in a trusted or trustee manner). Each of these create new meosk structure options are represented by horizontally-oriented user-selectable panels labeled “For My Self” and “For Others”. Selecting the first panel “For My Self” will generate a user-prompted series of GUI screens illustrated in FIGS. 39B through 39R. Selecting the second panel “For Others” will generate a user-prompted series of GUI screens illustrated in FIGS. 40B through 40R.

FIG. 39B shows the create new meosk module displaying the first steps involved in creating a new meosk structure for my self (i.e. for the user), involving (i) selecting a field of interest about which the user (or the meosk beneficiary) is passionate or has great interest, and (ii) selecting, in that field, an activity for which the user wishes to create a meosk structure (i.e. subsystem) in accordance with the principles of the present invention.

FIG. 39C shows the create new meosk module displaying a complete of all of the fields of interest supported by the system of the illustrated embodiment, and from which the user is urged to select a field of interest about which the user (or the meosk beneficiary) is passionate or has great interest.

FIG. 39D shows the create new meosk module supporting the first major step involved in creating a new meosk structure for my self (i.e. for the system user), involving the selection of an activity (e.g. ice skating) in the selected field of interest, for which the user wishes to create a meosk structure in accordance with the principles of the present invention.

FIG. 39D-1 shows a schematic representation symbolically representing exemplary activity sets (as) for different stages of an individual's life, for which one or more meosk structures and/or weosk structures might be created and deployed on the system network of the present invention.

FIGS. 39D-2 through 39D-21 show a tree structure representing a primary set of classes of human activity which can be used to (i) classify a very wide range of human activities and interests, and (ii) provide as a foundation for the activity/product/service/brand index used to support the reverse-inquiry based method of brand contact request and marketing communication supported by the meosk/weosk-based private and social media management and communication system network of the present invention.

FIG. 39E shows the create new meosk module supporting the second major step involved in creating a new meosk structure for my self (i.e. for the system user), involving proposing a name for the meosk being created.

FIG. 39F shows the create new meosk module supporting the third major step involved in creating a new meosk structure for my self (i.e. for the system user) involving the capturing of a digital photo or image (e.g. a thumbnail photo of the meosk structure's subject involved in his or her activity of interest) for assignment to the meosk structure to help the inner circle members to quickly identify the particular meosk structure within the client-side user environment of the system network 1.

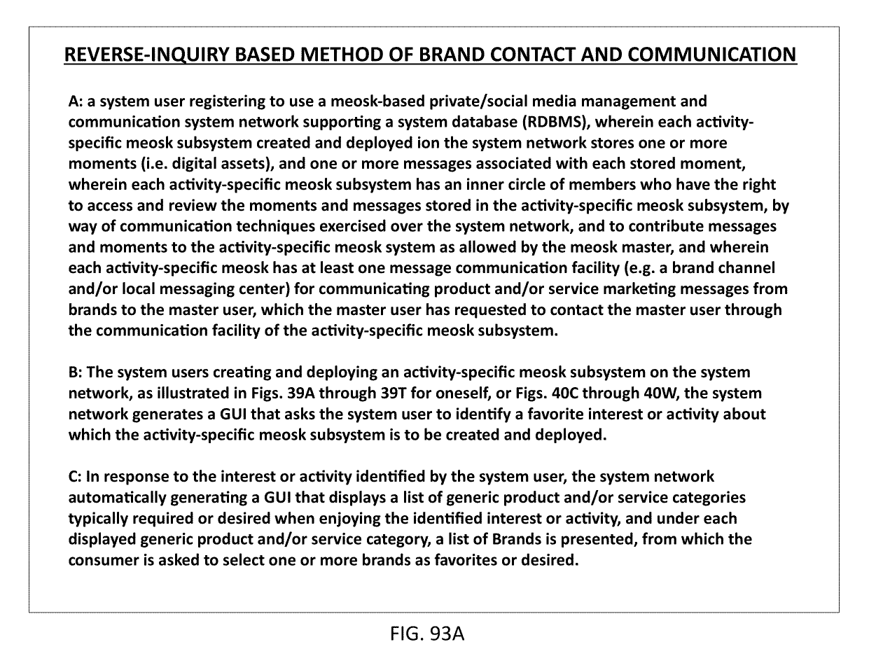

FIGS. 39G, 39H and 391 show the create new meosk module supporting the fourth major step involved in creating a new meosk structure for my self (i.e. for the system user), involving the building of an inner circle of users for the meosk selected from registered users, from selected the user's contacts, and/or added by name and email address (and SMS number), to build up the meosk structure's inner circle list.

FIG. 39J shows a GUI screen supported by the create new meosk module, and displaying the fifth major step involved in creating a new meosk structure for my self (i.e. for the system user). This GUI screen allows a master user (i.e. meosk master) to select and enable (i.e. activate) the following meosk functions: (i) tagging and copying moments anywhere, (ii) creating public views of meosk structures, (iii) tagging moments as private and non-copyable, (iv) posting meosk structures on social networks and WWW, (v) allowing inner circle members to add new members and expand the inner circle, (vi) linking group meosk structure to other meosk structures, and (vii) linking meosk structures to events. By selecting these meosk function icons on this GUI screen, the corresponding functions will be made active within the created and deployed meosk structure, for use by the master user within a client system 8A, 8B, 8C deployed on the system network 1.

FIG. 39K shows a GUI screen supported by the create new meosk module, and displaying the fifth major step involved in creating a new meosk structure for my self (i.e. for the system user). This GUI screen allows the master use to select and enable (i.e. activate) the following meosk functions: capture moments illustrated in FIGS. 24 through 30G; my journal illustrated in FIGS. 31B through 31R; my album(s) illustrated in FIGS. 32B through 32T; my favorites illustrated in FIGS. 33B though 33M; my print shop illustrated in FIGS. 34B through 34E; my brand channel illustrated in FIG. 36B; my favorites channel illustrated in FIG. 35B; my brands illustrated in FIG. 37B; and inner circle messaging illustrated in FIGS. 38B and 38C. By selecting the meosk function icons on this GUI screen, the corresponding meosk functions will be made active within the created and deployed meosk structure, and available for use by the master user.

FIG. 39L shows a GUI screen supported by the create new meosk module, and displaying the fifth major step involved in creating a new meosk structure for my self (i.e. for the system user). These GUI screens allow the master user to select and enable (i.e. activate) of moment functions such as: store-it illustrated in FIGS. 25B, 26C, 27C, 28C, 29C, 30E; favor-it illustrated in FIG. 32F; play-it illustrated in FIGS. 32C and 32D; note-it illustrated in FIGS. 31G and 31H; gift-it illustrated in FIGS. 31I, 31J, and 31K; attach-it illustrated in FIG. 31L; share-it illustrated in FIG. 31M; grab-it illustrated in FIGS. 31N, 31O, 31P and 31Q; and post-it illustrated in FIG. 31R. By selecting the moment function icons on this GUI screen, the corresponding moment functions will be made active within the created and deployed meosk structure, and available for use by the master user.

FIG. 39M shows a GUI screen supported by the create new meosk module, and displaying the fifth major step involved in creating a new meosk structure for my self (i.e. for the system user). This GUI screen allows the meosk master to select of functions that are to be supported within the meosk structure once deployed, for use by guest users, such as such: (i) as tagging and copying moments; (ii) tagging moments as private and non-copyable; (iii) posting meosk structures on social networks and the WWW; and (iv) and allowing inner circle members to add new members and expand the inner circle. By selecting the meosk function icons on this GUI screen, the corresponding moment functions will be made active within the created and deployed meosk structure, and available for use by the guest users.

FIG. 39N-1 shows a GUI screen supported by the create new meosk module, and displaying the sixth major step involved in creating a new meosk structure for my self (i.e. for the user). This GUI screen allows the master user to select meosk functions such as: capture moments; my journal; my album(s); my favorites; my print shop; my brand channel; my favorites channel; my brands; and inner circle messaging, as described hereinabove. By selecting the meosk function icons on this GUI screen, the corresponding meosk functions will be made active within the created and deployed meosk structure, and available for use by guest users.

FIGS. 39N-2 shows a series of GUI screens supported by the create new meosk module, and displaying the sixth major step involved in creating a new meosk structure for my self (i.e. for the user). This GUI screen allows master users to select and enable (i.e. activate) moment functions such as: store-it; favor-it; play-it; note-it; gift-it; attach-it; share-it; grab-it; and post-it, as described hereinabove. By selecting the moment function icons on this GUI screen, the corresponding moment functions will be made active within the created and deployed meosk structure, and available for use by guest users.

FIG. 39O shows the create new meosk module, supporting the seventh major step involved in creating a new meosk structure for my self (i.e. for the system user), involving the selection of brands and their products and services to support the activity-specific meosk being created.

FIG. 39P shows the create new meosk module supporting the eighth major step involved in creating a new meosk structure for my self (i.e. for the user), involving the acceptance of the selected brands and request to create the activity-specific meosk that has been specified in the previous steps described above.

FIG. 39Q shows the my meosk module supporting the current list of meosk structures that have been created and deployed on the system network.

FIG. 39R shows the my meosk module supporting the private soccer meosk created for another and listed on the user's my meosk list because the user is currently the master user of the private soccer meosk created for the benefit of the user's child.

In general, each private activity-specific meosk structure created using the create new meosk module described above in FIGS. 39A through 39R will be realized (i) as an object-oriented GUI-based subsystem, supporting a Web-based (i.e. HTML) GUI that is server-side driven, and allows secure-user access using a web-enabled browser application running on a client machine or other system 8A, 8B, 8C, or alternatively, (ii) as an object-oriented GUI-based subsystem, supporting a Web-enabled native-client GUI that is server-side driven but supports client-side functions independent of Internet connectivity, and allows secure-user access on a client machine or other system 8A, 8B, 8C. The Web-based GUI of the activity-specific meosk structure can be realized as a display-responsive design implemented using HTML5 technology and standards. Typically, the system network will support both kinds of client system implementations. Preferably, the object code enabling each activity-specific meosk structure will be indexed with an activity code (IA) code that follows a grammar and taxonomy used in classification of all possible activities and interests currently known to mankind that may be discovered and adopted by individuals at some point in time in the future, thus allowing the system of the present invention to adapt to the natural expansion of human knowledge and its diverse fields of activity and interest. An exemplary list of different classes of activities and interests for individuals during the different phases of their lifetime have been set forth in FIGS. 39D-2 through 39D-8 can be organized by any suitable taxonomy which will allow the individual user to quickly and efficiently drill-down one or more menu lists and find the activity and/or interest for which an activity-specific meosk structure is to be created and deployed on the system network, for current and future use.

The primary function of the activity-specific meosk structure is to contain and display diverse kinds of information (e.g. digital assets) relating to a specific activity (or interest) pursued by an individual consumer—information typically having a great level of emotional investment and/or sense of purpose and self-identification. Using the digital asset management facilities supported within each activity-specific meosk structure, the individual user is able to manage the diverse kinds of personal and public information (i.e. digital assets) selected and organized by the individual within the GUI of the meosk structure, preferably using one or more of the following meosk widgets: e.g. my album; my journal, my favorites album, my brand channel (play-list driven video/media player supporting all possible media formats); inner messaging center; e-commerce gift shop; and my brands manager. In each meosk structure, the meosk master can create additional albums, with user-assigned names, for storing moments (i.e. digital assets) that are important to the meosk master or its beneficiary (e.g. child or grandchild) during the activity or interest being pursued. Other kinds of information management widgets can be integrated into each meosk structure depending on the application at hand, and application environment for the system network.

In general, the individual user (i.e. consumer) and his or her guests will collect and manage digital assets (i.e. moments) in the private activity-specific meosk structure that has been organized around ones identified activity or interest during meosk set-up and creation. The digital assets may include videos, photos, diary notes/thoughts and other recording, digital creations, and digital widgets that tell the individual's unique story about the activity, interest and/or passion being pursued. How long the activity-specific meosk structure will be used by the individual user will depend on many factors, but it is expected that the individual user will use the meosk structure, for as long as the individual's passion for the activity burns within the heart of the individual which could persist for years, and possibly an entire lifetime. When an activity-specific meosk structure has been used for a predetermined period of time, the system network is programmed to automatically prompt the individual user if he or she would like to archive the meosk structure, in a compressed secure format, within the archival data stores within the system network, for future access and use, e.g. posterity purposes.

### Specification of the Create New Meosk for Others Module of the System Network of the Present Invention

In FIGS. 40A through 40R, each GUI screen contains numerous unique and recognizable icons which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities associated with selected icons and supporting modules. The details of this module, its graphical icons and corresponding services will be described in greater detail hereinafter.

FIG. 40A shows the “create new meosk” module displaying two options for creating a new meosk structure for my self (i.e. for the system user), and for creating a new meosk structure for others (e.g. a child, spouse, grandparent of the user, or another beneficiary for whom the user will be acting in a trusted or trustee manner).

FIG. 40B shows the create new meosk module supporting the first steps involved in creating a new meosk structure for others (e.g. a child, spouse, grandparent, etc) and identifying for whom the user wishes to create the meosk structure (i.e. name, email address, SMS number, year of birth, gender etc).

FIG. 40C the create new meosk module supporting the second steps involved in creating a new meosk structure for others, involving (i) selecting a field of interest about which the meosk beneficiary is passionate or has great interest, and (ii) selecting, in that field, an activity for which the user wishes to create a meosk structure (i.e. object-oriented subsystem) in accordance with the principles of the present invention.

FIG. 40D shows the create new meosk module supporting the third major step involved in creating a new meosk structure for another, involving the selection of an activity (e.g. ice skating) in the selected field of interest, for which the user wishes to create a meosk structure (i.e. object-oriented subsystem) in accordance with the principles of the present invention.

FIG. 40D-1 illustrates the tree structure representing a primary set of classes of human activity which can be used to (i) classify a very wide range of human activities and interests, and (ii) provide as a foundation for the activity/product/service/brand index used to support the reverse-inquiry based method of brand contact request and marketing communication supported by the meosk/weosk-based private and social media management and communication system network of the present invention.

FIG. 40E shows the create new meosk module supporting the fourth major step involved in creating a new meosk structure for another, involving proposing a name for the meosk being created.

FIG. 40F shows the create new meosk module supporting the fifth major step involved in creating a new meosk structure for another involving capturing a digital photo or image (e.g. a thumbnail photo of the meosk structure's subject involved in his or her activity of interest) to the new meosk structure to help inner circle members quickly identify it within the client-side user environment of the system network 1.

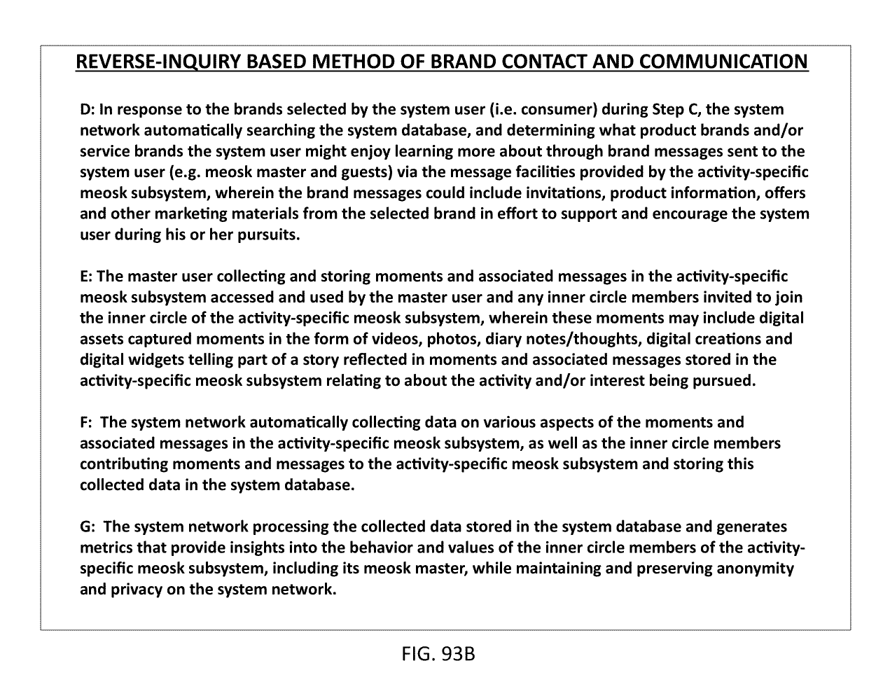

FIGS. 40G, 40H and 401 show the create new meosk module supporting the sixth major step involved in creating a new meosk structure for another, involving the building an inner circle of users for the meosk structure selected from registered users, from selected user's contacts, and/or by adding name and email address (and SMS number) directly into the system network, to build up the list of inner circle members for the meosk structure.

FIG. 40J shows a GUI screen supported by the create new meosk module, and displaying the seventh major step involved in creating a new meosk structure for another. This GUI screen allows the master user to select and enable (i.e. activate) meosk functions such as: (i) tagging and copying moments anywhere, (ii) creating public views of meosk structures, (iii) tagging moments as private and non-copyable, (iv) posting meosk structures on social networks and WWW, (v) allowing inner circle members to add new members and expand the inner circle, (vi) linking group meosk structure to other meosk structures, and (vii) linking meosk structures to events. By selecting the meosk function icons on this GUI screen, the corresponding meosk functions will be made active within the created and deployed meosk structure, and available for use by the master user.

FIG. 40K shows a GUI screen supported by the create new meosk module, and displaying the seventh major step involved in creating a new meosk structure for my self (i.e. for the system user). This GUI screen allows the master user (i.e. meosk master) involving the selection and enablement (i.e. activation) of meosk functions such as: capture moments; my journal; my album(s); my favorites; my print shop; my brand channel; my favorites channel; my brands; and inner circle messaging, as described hereinabove. By selecting the meosk function icons on this GUI screen, the corresponding meosk functions will be made active within the created and deployed meosk structure, and available for use by the master user.

FIG. 40L shows a GUI screen supported by the create new meosk module, and displaying the seventh major step involved in creating a new meosk structure for my self (i.e. for the system user). This GUI screen allows the master user to select and enable (i.e. activate) moment functions such as: store-it; favor-it; play-it; note-it; gift-it; attach-it; share-it; grab-it; and post-it, described above. By selecting the moment function icons on this GUI screen, the corresponding moment functions will be made active within the created and deployed meosk structure, and available for use by the master user.

FIG. 40M shows a GUI screen supported by the create new meosk module, and displaying the seventh major step involved in creating a new meosk structure for another. This GUI screen allows the master user to select and enable (i.e. activate) the meosk functions such as: (i) tagging and copying moments; (ii) tagging moments as private and non-copyable; (iii) posting meosk structures on social networks and WWW; and (iv) allowing inner circle members to add new members and expand the inner circle. By selecting the meosk function icons on this GUI screen, the corresponding meosk functions will be made active within the created and deployed meosk structure, and available for use by the guest users.

FIG. 40N-1 shows a GUI screen supported by the create new meosk module, and displaying the eighth major step involved in creating a new meosk structure for my self (i.e. for the system user). This GUI screen allows the master user to select and enable meosk functions such as: capture moments; my journal; my album(s); my favorites; my print shop; my brand channel, my favorites channel; my brands; and inner circle messaging, as described hereinabove. By selecting the meosk function icons on this GUI screen, the corresponding meosk functions will be made active within the created and deployed meosk structure, and available for use by the guest users.

FIG. 40N-2 shows a GUI screen supported by the create new meosk module, and displaying the ninth major step involved in creating a new meosk structure for other. This GUI screen allows the master user (i.e. meosk master) to select and enable (i.e. activate) moment functions such as: store-it; favor-it; play-it; note-it; gift-it; attach-it; share-it; grab-it; and post-it, as described hereinabove. By selecting the moment function icons on this GUI screen, the corresponding moment functions will be made active within the created and deployed meosk structure, and available for use by the guest users.

FIG. 40O shows the create new meosk module supporting the tenth major step involved in creating a new meosk structure for another, involving the selection of brands and their products and services to support the activity-specific meosk structure being created.

FIG. 40P shows the create new meosk module supporting the eleventh major step involved in creating a new meosk structure for another, involving the acceptance of the selected brands and request to create the activity-specific meosk structure that has been specified in the previous steps described above.

FIG. 40Q the my meosk module supporting the current list of meosk structures that have been created and deployed on the system network.

FIG. 40R shows the my meosk module supporting the First Moments (FM) meosk structure created for another (i.e. the system user's child, “Christopher”) and listed on the user's my meosk list because the user is currently the master user of the private soccer meosk structure created for the benefit of the user's child.

### Specification of the Inner Circle Module of the System Network of the Present Invention

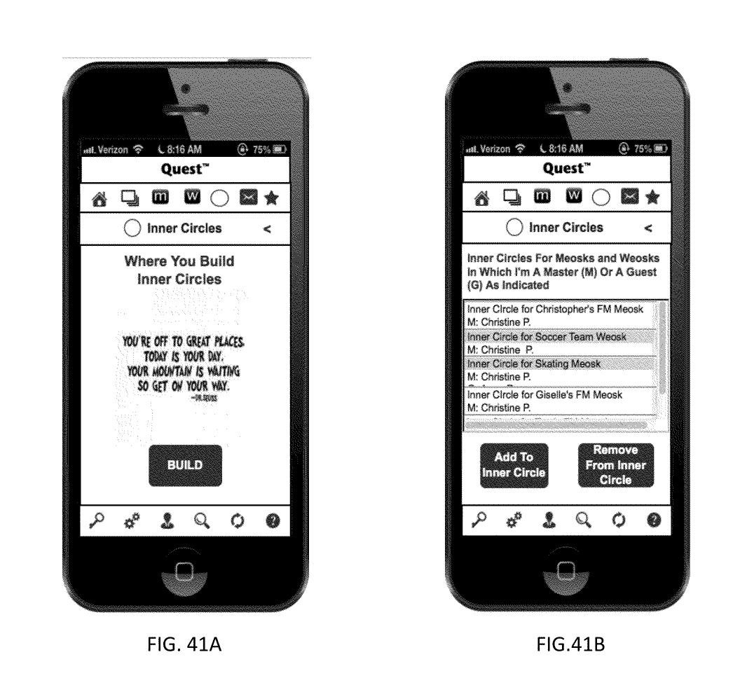

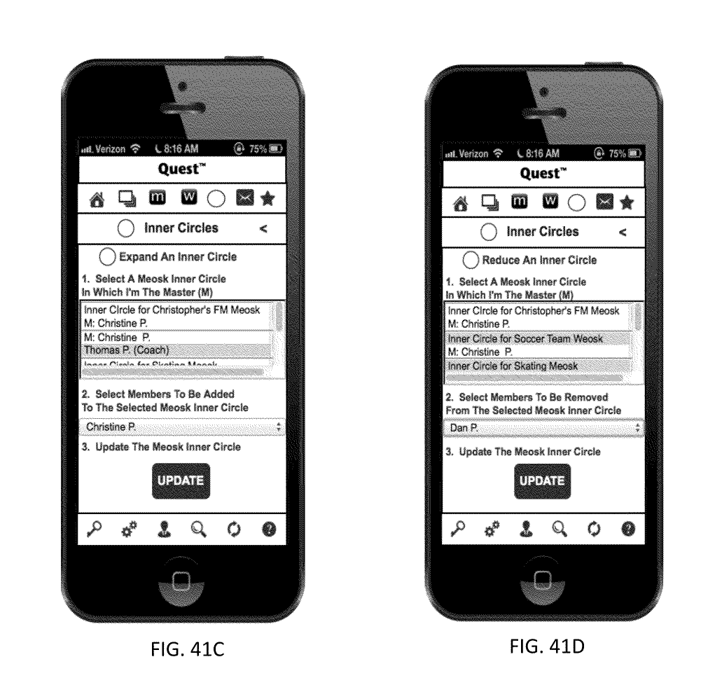

In FIGS. 41A through 41D, each GUI screen contains numerous menu/list-type “graphical interface objects” which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities required to add new members to the inner circle of a meosk structure to expand its inner circle, or remove current members from the inner circle of a meosk structure to reduce its inner circle. The details of this module, its graphical interface objects, and corresponding services will be described in greater detail hereinafter.

FIG. 41A shows the inner circles module generating a GUI screen displaying the introduction screen inviting users to build the inner circles for their meosk structures and weosk structures managed on the system network.

FIG. 41B shows the inner circles module generating a GUI screen displaying a list of inner circles for each meosk and weosk created and deployed by the user on the system network, and where options are provided for selecting a listed inner circle and then either adding members to it, or removing members from it, as the case may require or suggest.

FIG. 41C shows the inner circles module generating a GUI screen displaying a list of inner circles for each meosk and weosk created and deployed by the user on the system network, and where the user has selected one meosk inner circle and the option to add members to it and then update the same.

FIG. 41D shows the inner circles module generating a GUI screen displaying a list of inner circles for each meosk structure and weosk structure created and deployed by the user on the system network of the present invention, where the user has selected one meosk structure and the option to remove members from the inner circle and then update the same.

### Specification of the View My Bin Module of the System Network of the Present Invention

In FIGS. 42A through 42C, In FIGS. 41A through 41D, each GUI screen contains numerous menu/list-type “graphical interface objects” which, when selected, trigger server-side-driven, client-side-driven and/or client-server-driven processes and the generation and display of new or transformed GUI screens on client systems 8A, 8B, 8C. These GUI screens provide the master guest users with the services/functionalities required to (i) review moments sent to my bin, (ii) move moments to selected activity-specific meosk structures, and (iii) delete moments from the my bin. The details of this module, its graphical interface objects, and corresponding services will be described in greater detail hereinafter.

FIG. 42A shows the master meosks module displaying the view my bin module, where the user can view all un-stored moments in the user's “my bin” and then choose to delete a selected moment, or move it to a desired meosk structure for storage in one of its selected moment store locations (e.g. journal, album, favorites).

FIG. 42B shows the master meosks module displaying the view my bin module, where the user selects a moment for movement to a desired meosk structure, and storage in one of its selected moment store locations (e.g. journal, album, favorites).

FIG. 42C shows the master meosks module displaying the view my bin module, where the my bin reflects that the moment selected and moved in the workflow illustrated in the GUI screen of FIG. 42B is now removed from the my bin list.

### Specification of the Share Moments Module of the System Network of the Present Invention

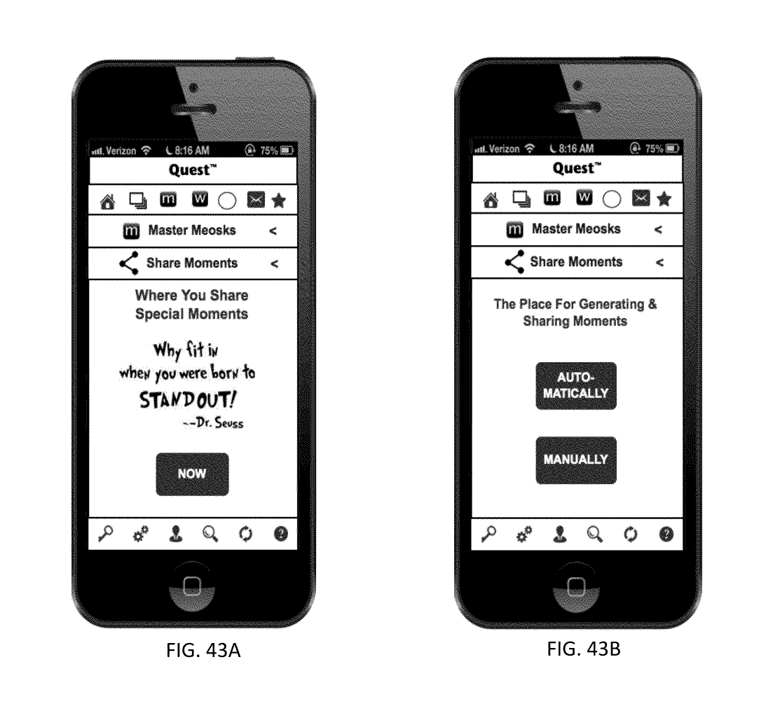

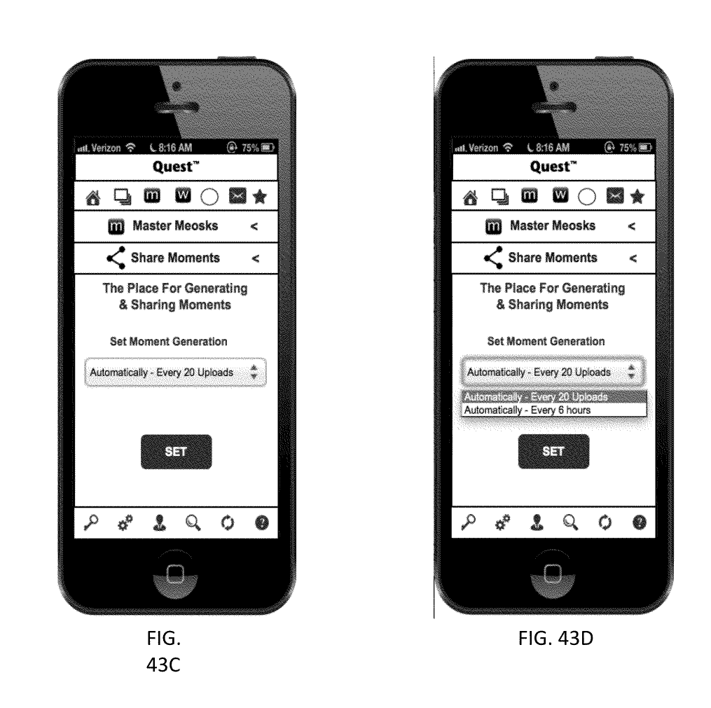

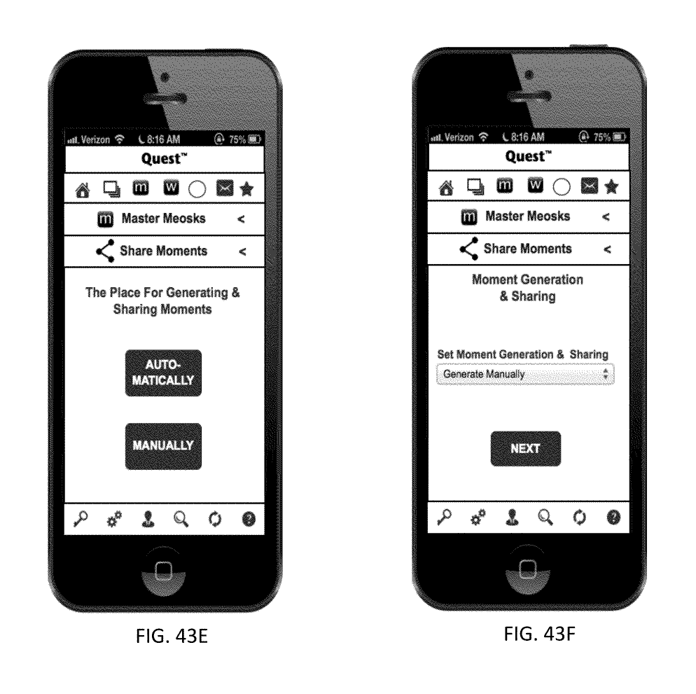

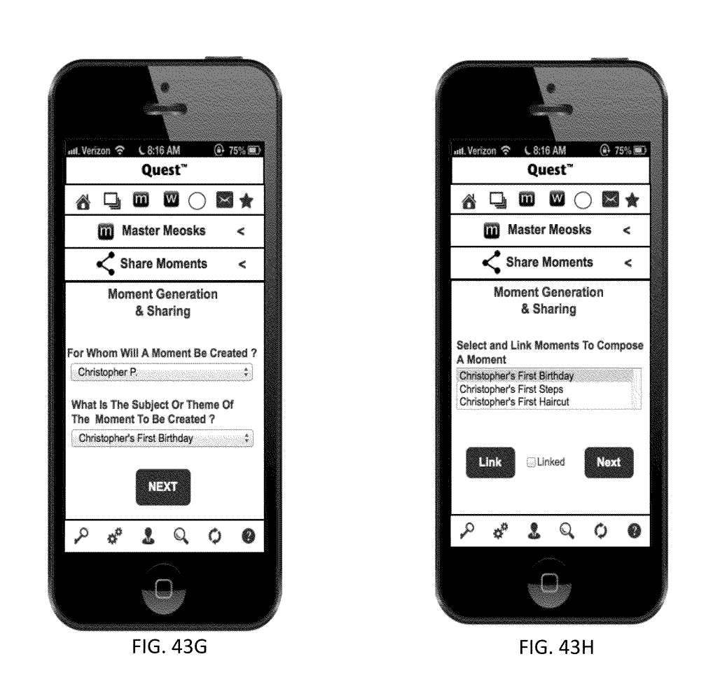

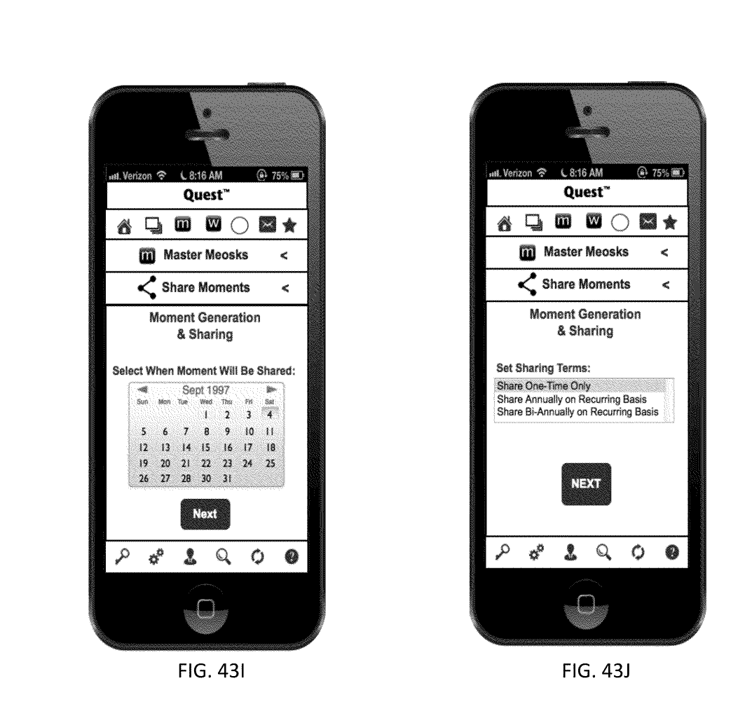

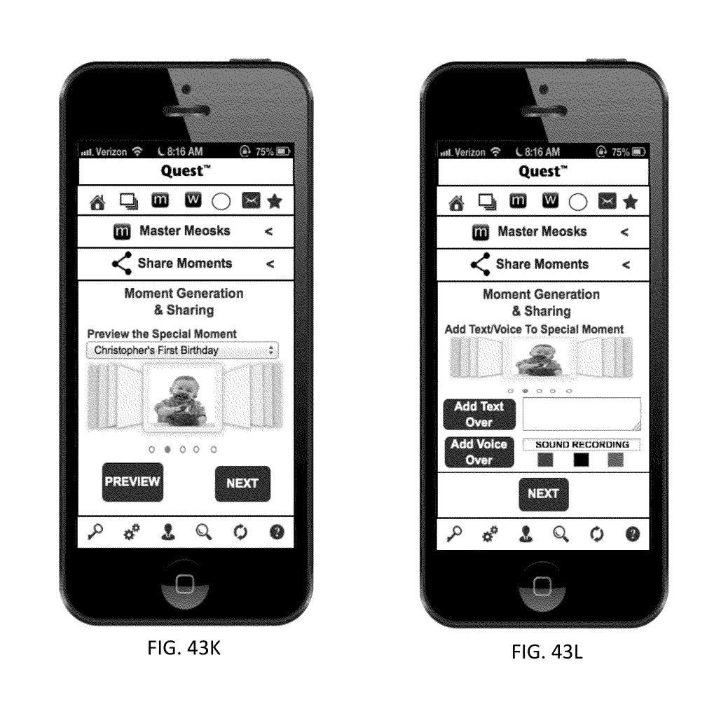

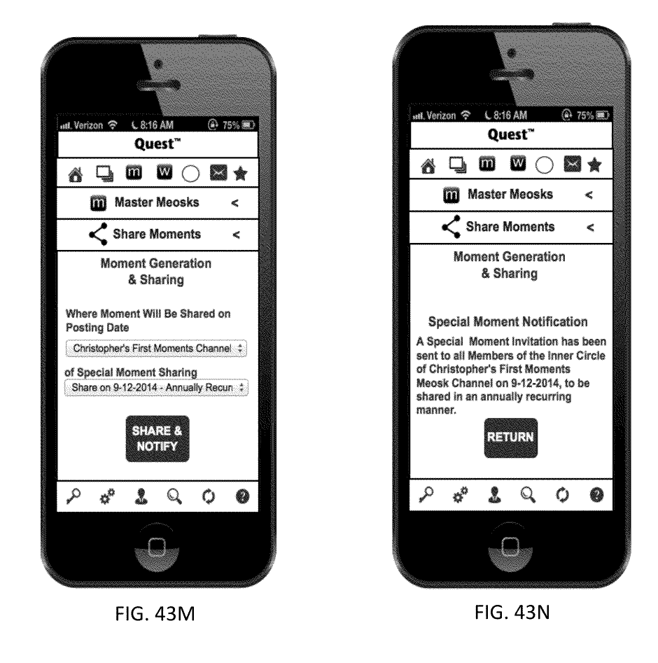

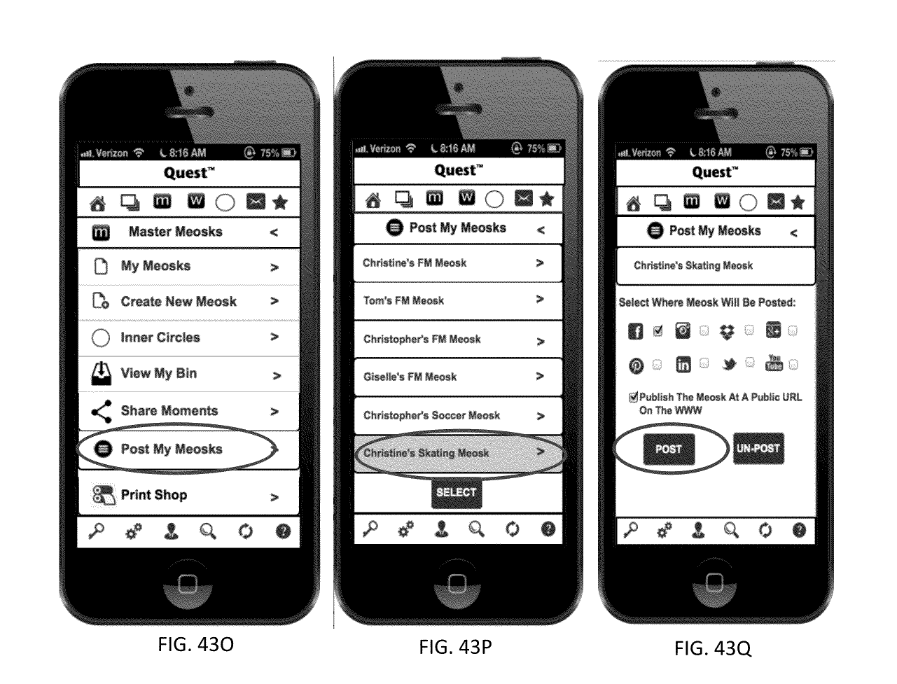

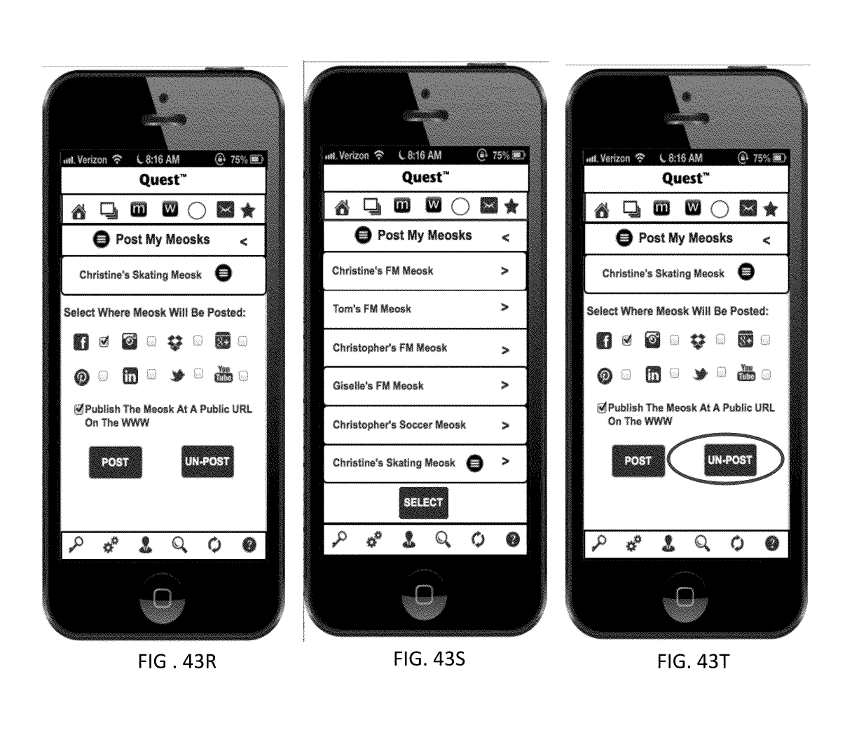

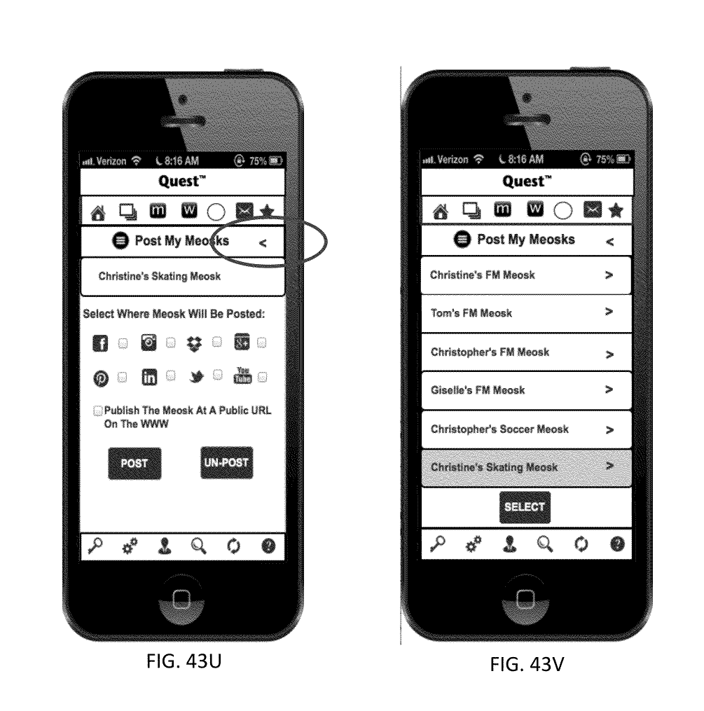

In FIGS. 43A through 43N, each GUI screen contains numerous unique and recognizable icons, as well as menu/list-type graphical interface objects which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities associated with selected icons and configuring, generating and sharing moments with members of the meosk structure's inner circle, according to the schedule set in FIGS. 43I, 43J and 43M. The details of this module, its graphical icons and corresponding services will be described in greater detail hereinafter.

FIG. 43A shows the master meosks module displaying the share moments module, where the user can share moments with inner circle members from meosk structures in either an automated or manual manner.

FIG. 43B shows the master meosks module displaying the share moments module, where buttons are provided for either an automated or manual mode selection.

FIG. 43C shows the master meosks module displaying the share moments module, where the user sets automatic moment generation to occur every 20 uploads to the meosk structure, but this figure could be greater or less than 20 by user selection and choice.

FIG. 43D shows the master meosks module displaying the share moments module, where the user proceeds to reset automatic moment generation to occur every 6 hours.

FIG. 43E shows the master meosks module displaying the share moments module, where the user returns to the mode selection GUI and selects “manually” created moment generation to occur within the meosk structure, and over its inner circle.

FIG. 43F shows the master meosks module displaying the share moments module, where the user sets manual moment generation within the meosk and over its inner circle;

FIG. 43G shows the master meosks module displaying the share moments module, where the user identifies for whom a moment will be created, and what is the subject or theme of the moment (optional).

FIG. 43H shows the master meosks module displaying the share moments module, where the user selects and links moments together to compose new moments.

FIG. 43I shows the master meosks module displaying the share moments module, where the user selects when the composed moment will be shared across the inner circle of the meosk;

FIG. 43J shows the master meosks module displaying the share moments module, where the user sets the terms for sharing the moment across the inner circle (e.g. share one time only, share annually on a recurring basis, share bi-annually on a recurring basis).

FIG. 43K shows the master meosks module displaying the share moments module, where the user previews the specially composed moment.

FIG. 43L shows the master meosks module displaying the share moments module, where the user can add text and/or voice over the specially composed moment by selecting the Add Text Over button to add typed in text, and selecting the Add Voice Over to record one's voice and add it over the specially created moment (e.g. photo, video, etc).

FIG. 43M shows the master meosks module displaying the share moments module, where the user indicates where the specially composed moment will be shared on the posting date (e.g. over Christopher's First Moments (FM) Channel) or other channel as the case may be.

FIG. 43N shows the master meosks module displaying the share moments module, where the user receives a notification that a special moment invitation has been sent to all members of the inner circle of the meosk structure (e.g. Christopher's FM Meosk Channel on Sep. 12, 2014), to be shared on an annually recurring basis.

### Specification of the Post My Meosk Module of the System Network of the Present Invention

In FIGS. 43O through 43V, each GUI screen contains numerous unique and recognizable icons, and also panel-type graphical interface objects which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities required to post meosk structures on social networks of the user's and publish the meosk structure at a public URL on the WWW. The details of this module, its graphical icons and corresponding services will be described in greater detail hereinafter.

FIG. 43O shows the master meosks module displaying icons for the various modules accessible from therein, including the post my meosks module, where the master user (i.e. meosk master) and also guests who have been authorized by the meosk master, can post meosk structures to their social media sites and/or photo-sharing sites, and also “un-post” their posted meosk structures as desired.

FIG. 43P shows the master meosks module displaying the post my meosks module, where the master user selects “Christine's Skating Meosk” structure for posting to a social media site which has been pre-configured with the system network 1.

FIG. 43Q shows the master meosks module displaying the post my meosks module, where the master user selects a social medial site (e.g. Facebook) to which the selected meosk should be posted using the application programming interface (API) used to interface the system network and this social media site network.

FIGS. 43R and 43S show the master meosks module displaying the post my meosks module, where the front panel of the Christine's Skating Meosk structure bears the (social media network) post icon, on both interfaces, for notification purposes.

FIG. 43T shows the master meosks module displaying the post my meosks module, where the master user selects the “un-post” button to remove Christine's Skating Meosk structure from its prior Facebook post (e.g. equivalent to a delete post on the Facebook platform).

FIGS. 43U and 43V shows the master meosks module displaying the post my meosks module, where the front panel of the un-posted meosk structure (i.e. Christine's Skating Meosk) no longer bears the post icon, on either user interfaces, for notification purposes.

### Specification of the Print Shop Module of the System Network of the Present Invention

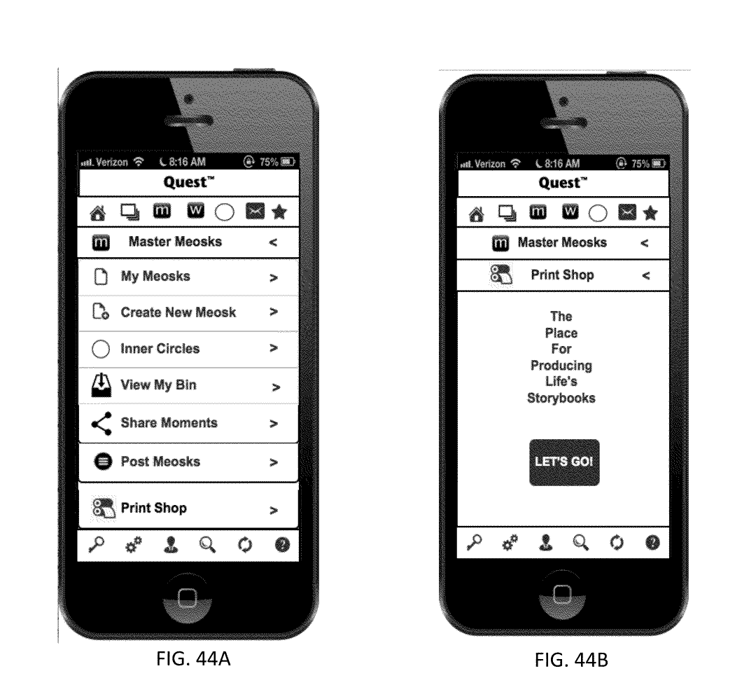

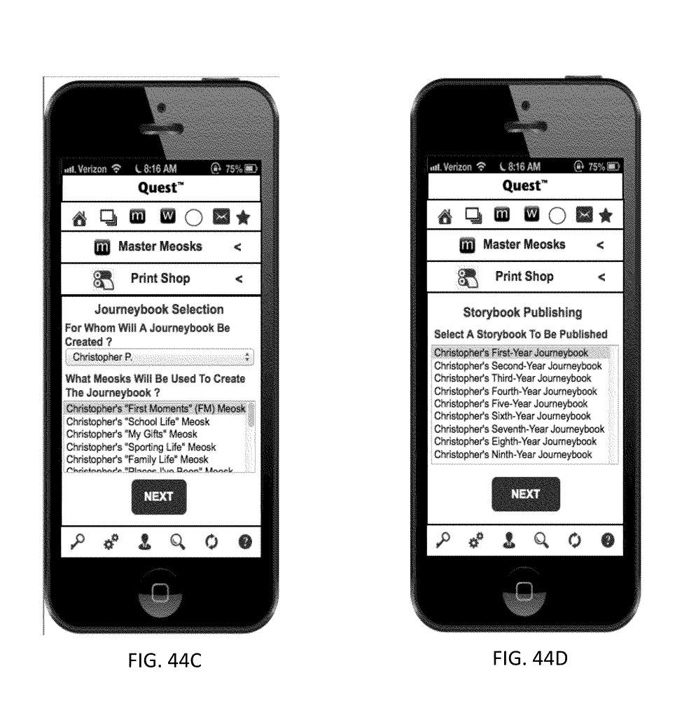

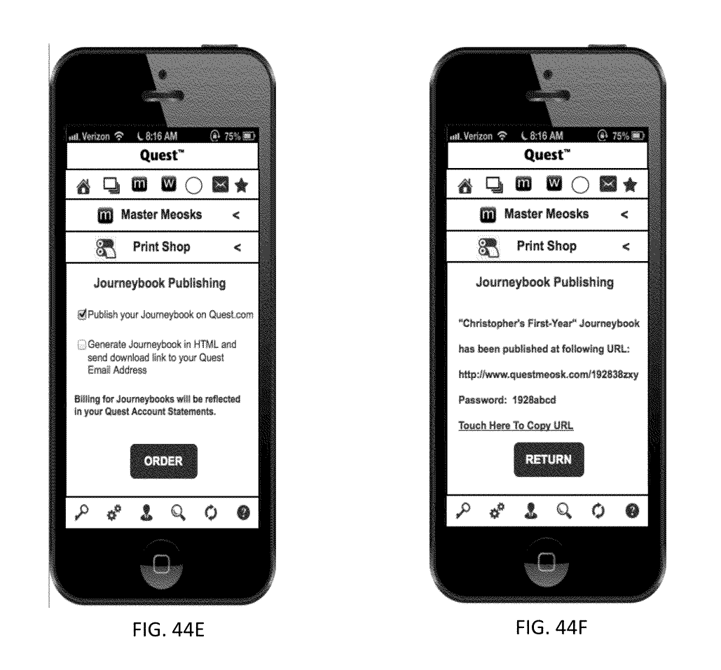

In FIGS. 44A through 40R, each GUI screen contains numerous unique and recognizable icons, as well as list/menu-type graphical interface objects, which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities for configuring and producing journey books of various kinds and types, from moment-based meosk structures on the system network. The details of this module, its graphical interface objects, and corresponding services will be described in greater detail hereinafter.

FIG. 44A shows the master meosks module displaying all of the modules available therewithin, including the print shop module where meosk masters and guest users alike can produce life storybooks based on the moments and messages collected with meosks over the course of time.

FIG. 44B shows the master meosks module displaying the introduction GUI screen for the print shop module, where the user is invited to proceed forward (i.e. “Let's Go!”) and produce journey books (i.e. storybooks) based on moments captured in meosk structures.

FIG. 44C shows the master meosks module displaying a GUI screen for the print shop module, where the user is asked to identify for whom a journey book is to be created, and then select particular meosks from which the journey book will be composed and prepared for private publishing.

FIG. 44D shows the master meosks module displaying a GUI screen for the print shop module, where the user is asked to select particular a journey book to be published.

FIG. 44E shows the master meosks module, and displaying a GUI screen for the print shop module, where the user is asked to publish the selected journey book on a particular host site (e.g. www.questmeosk.com) or generate an html-encoded journey book for downloading to the user's desktop or other computing device.

FIG. 44F shows the master meosks module, and displaying a GUI screen for the print shop module, where the user is notified of the fact that the selected journey book has been published at a designated URL and can be accessed and viewed using certain confidential credentials and any web-enabled client machine deployed on the system network 1.

### Creating and Deploying Activity-Specific Weosk Structures for Families and Groups of Individuals Having Common Interests or Engaged in Common Activities

Various methods have been disclosed above for creating, deploying and managing private activity-specific meosk structures, as well as public views thereof, by individuals using the system of the present invention. As disclosed, each activity-specific meosk structure is centered around a particular activity or interest that is being pursued by an individual user/consumer, and at any instant in time, the individual user can be managing numerous private interests covering a multiple of different activities and interests within the life of the individual user. It is also possible for administrators, such as parents, grandparents and/or guardians and agents of the individual, to be granted rights to create, deploy and manage private meosk structures for the individual under various circumstances and during the life-cycle of the individual, as previously discussed above.

However, there are instances when a group of individuals (i.e. two or more individuals, or family of individuals tied together in a family ecosystem) having a shared or common activity or interest may, wish to create and deploy, together, as a group, a private activity-specific weosk structure or subsystem network, centered around a particular interest or activity, and in such instances, the group would have shared and equal access privileges to create, deploy and manage such weosk subsystems, and also views thereof, in accordance with the principles of the present invention. All of the tools and methods described above for private meosks and public views thereof can be readily adapted to support the creation, deployment and management of private weosks and views thereof, as described above.

In such alternative embodiments, the reverse-inquiry based brand contact and communication method of the present invention shall be supported within weosk instruments created and deployed by the system of the present invention, and provide brands with the all the benefits associated with this integrated brand contact and communication method. Also, it provides the individuals with the benefits of invited, permission-based brand contact as they pursue their interests and activities for which the weosk has been created and deployed.

The applications for activity-specific weosks are wide-spread as (i) conventional wiki-based websites where multiple individuals have the right to manage the content of a particular wiki-based website, and also (ii) Groups supported on the Facebook web-based social network where groups of friends can share digital content among themselves in albums and comment on such postings while pursuing their group's purpose whatever that may be.

### Specification of the Master Weosks Module of the System Network of the Present Invention

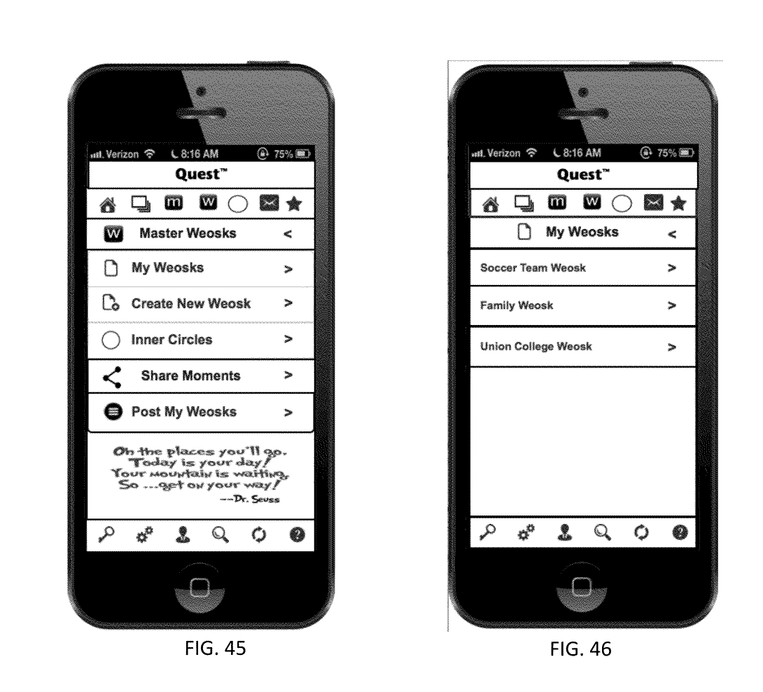

In FIGS. 45 and 46, each GUI screen contains numerous panel-type “graphical interface objects” which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities required to select the modules listed in the master weosks menu. The details of this module, its graphical interface objects, and corresponding services will be described in greater detail hereinafter.

FIG. 45 shows the master weosks module displaying all of the modules available therewithin, including my weosk structures, create new weosk structure, inner circles, and share moments.

FIG. 46 shows the master weosks module and the my weosks module, displaying a list of all created and deployed weosk structures, of which the user is an inner circle member. The weosk master or guest user simply selects the panel representing the weosk structure to be accessed, and the corresponding weosk module is automatically instantiated on the system network and the GUI screen for the weosk displayed for the master or guest user to interact therewith using a client machine operably connected to the system network.

### Specification of the My Weosks Module of the System Network of the Present Invention

In FIGS. 47A through 59E, each GUI screen contains numerous unique and recognizable graphical icons, as well as menu/list-type “graphical interface objects” which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities required to support any weosk structure created and deployed on the system network of the present invention. The details of this module, its graphical interface objects, and corresponding services will be described in greater detail hereinafter

FIG. 47A shows the my weosks module displaying the selected weosk structure (i.e. Soccer Weosk) and its menu of service functions that are supported within the GUI-based virtual file and operating system (VFOS) environment of each weosk structure (i.e. object-oriented subsystem) including weosk functions such as capture moments, guest book, our album, group calendar, gifts, favorites channel, brand channel, our brands, and inner circle messaging, wherein each weosk function is assigned an unique and recognizable graphical icons in the GUI screen.

FIG. 47B shows the my weosks module displaying the selected weosk structure and the selected module, “capture new moment”, providing a selection of moment multi-media moment capture tools from which the user can select to capture new moments which will be automatically stored in one of the moment store locations within the weosk structure's GUI-based virtual file and operating system (VFOS).

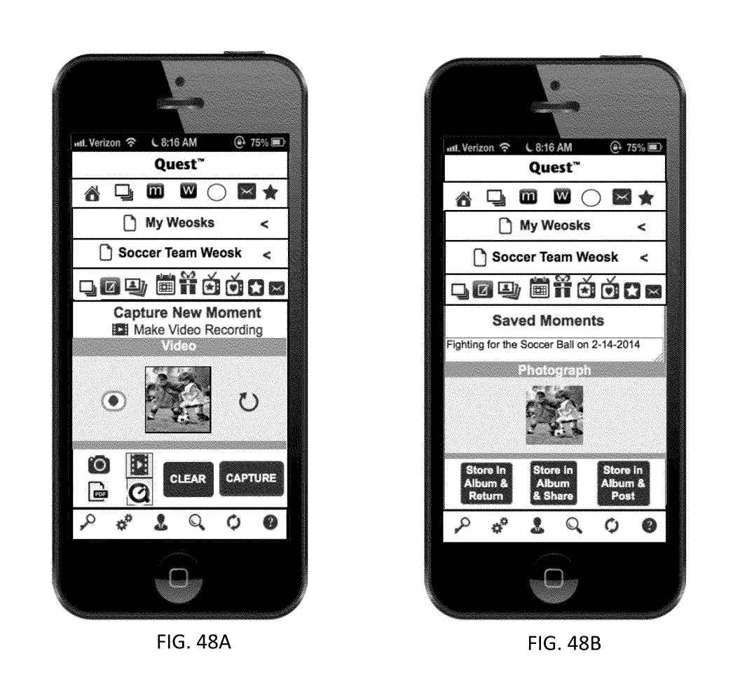

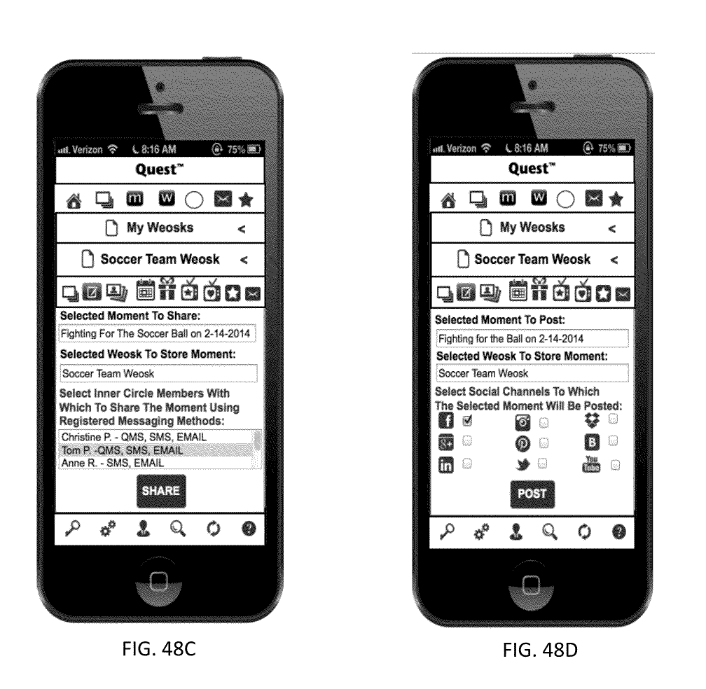

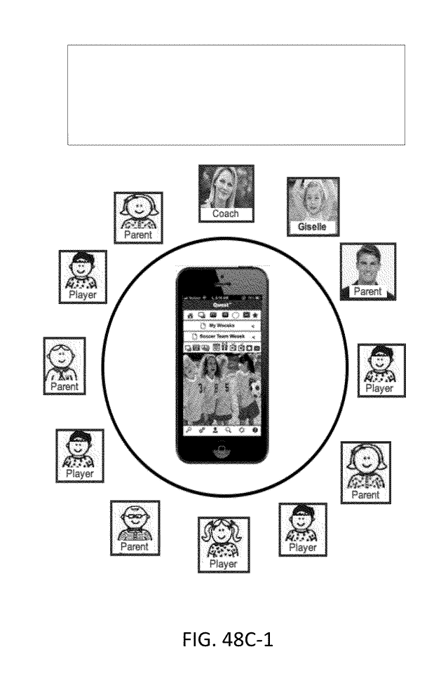

FIG. 48A shows the my weosks module displaying the selected weosk structure and the selected module, capture new moment, where the video/image recording moment capture tool has been selected and used to capture a video/image recording moment.

FIG. 48B shows the my weosks module displaying the selected weosk structure and the selected module, capture new moment, where three options are shown for storing the captured video/image recording moment, namely, (i) store in the shared album and return to the capture tool menu, (iii) store in the shared album and share with members of the inner circle of the selected weosk structure, and (iii) store in the shared album and post the captured moment along selected social media channels.

FIG. 48C shows the my weosks module displaying the selected weosk structure and the selected module, capture new moment, where the option (i) store in the shared album and share with members of the weosk structure's inner circle, has been selected and displayed, and certain members of the weosk structure's inner circle are being selected for sharing using the various sharing methods supported on the system network of the present invention.

FIG. 48C-1 shows a schematic representation of the client system application, configured in its weosk support mode, to share moments across the weosk structure's inner circle in connection with the exemplary soccer team weosk structure, where each inner circle member are able to share moments into the shared album of the weosk using any the email, SMS and internal messaging services (IMS) based techniques of the present invention illustrated in FIGS. 69 though 75B-4.

FIG. 48D shows the my weosks module displaying the selected weosk structure and the selected module, capture new moment, where the option (i) store in the shared album and post along selected social media channels, has been selected and displayed, and certain social media channels are being selected for posting the captured moments.

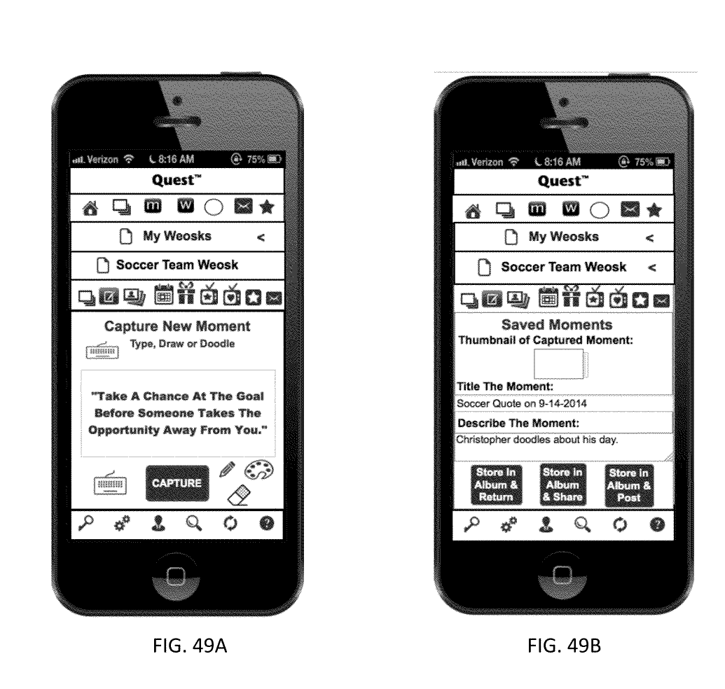

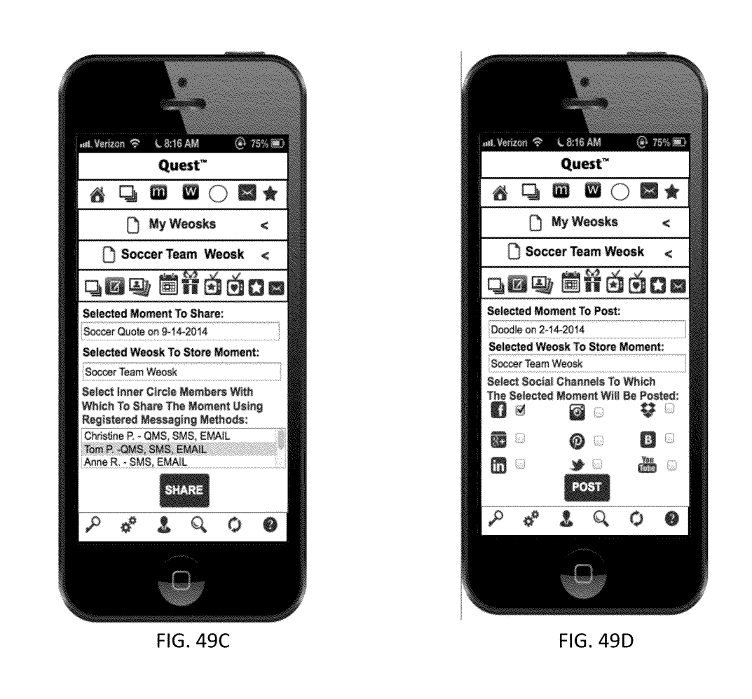

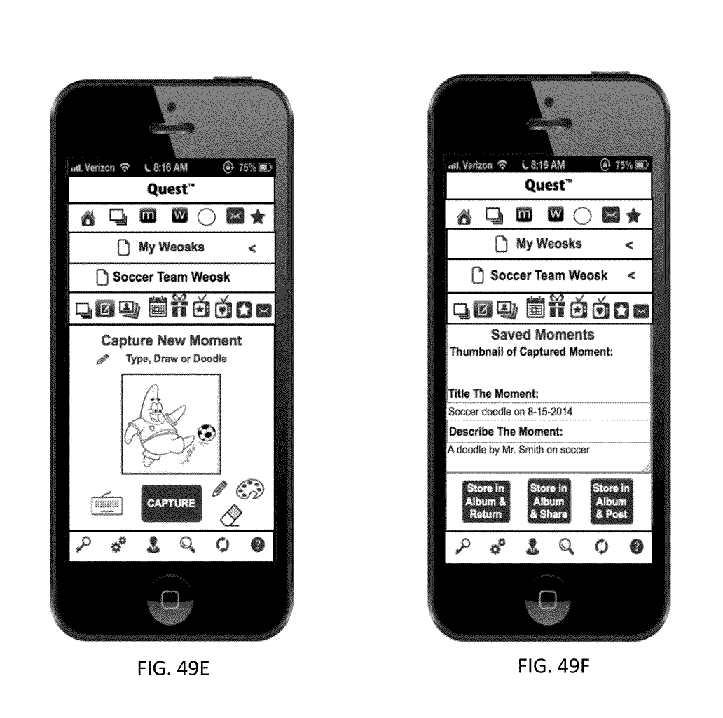

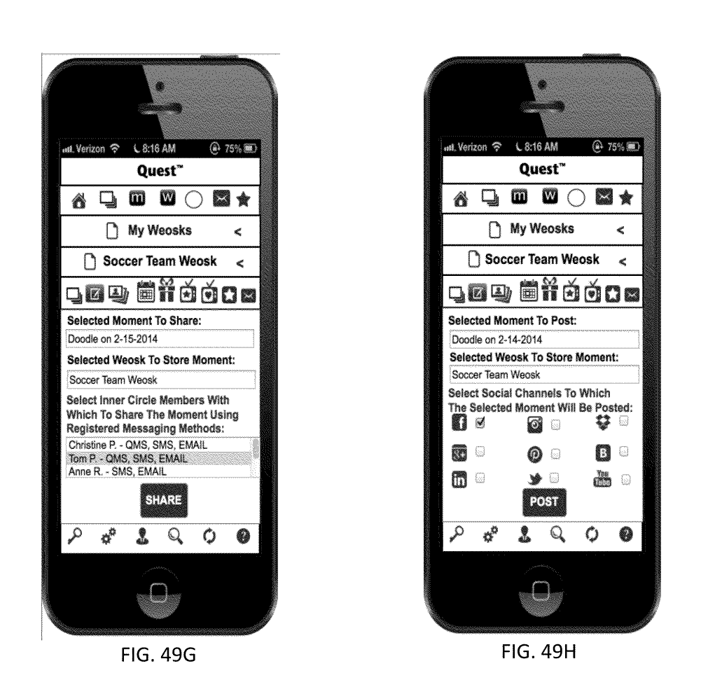

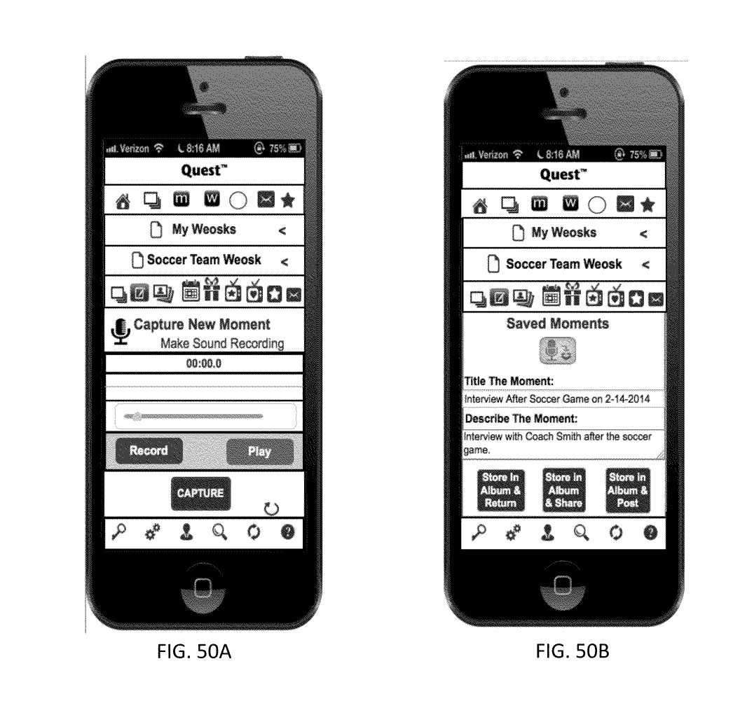

FIG. 49A shows the my weosks module, and displaying the selected weosk structure and the selected module, capture new moment, where the text moment capture tool has been selected and used to capture a text-based moment;

FIG. 49B shows the my weosks module displaying the selected weosk structure and the selected module, capture new moment, where three options are shown for storing the captured text moment, namely, (i) store in the shared album and return to the capture tool menu, (ii) store in the shared album and share with members of the inner circle of the selected weosk structure, and (iii) store in the shared album and post the captured moment along selected social media channels.

FIG. 49C shows the my weosks module displaying the selected weosk structure and the selected module, capture new moment, where the option (i) store in shared album and share with members of the weosk structure's inner circle, has been selected and displayed, and certain members of the weosk structure's inner circle are being selected for sharing.

FIG. 49D shows my weosks module displaying the selected weosk structure and the selected module, capture new moment, where the option (i), store in the shared album and post along selected social media channels, has been selected and displayed, and certain social media channels are being selected for posting the captured text moments.

FIG. 49E shows the my weosks module displaying the selected weosk structure and the selected module, capture new moment, where the drawing/doodling moment capture tool has been selected and used to capture a drawing/doodle-based moment.

FIG. 49F shows the my weosks module displaying the selected weosk structure and the selected module, capture new moment, where three options are shown for storing the captured drawing/doodle moment, namely, (i) store in the shared album and return to the capture tool menu, (iii) store in the shared album and share with members of the inner circle of the selected weosk structure, and (iii) store in the shared album and post the captured moment along selected social media channels.

FIG. 49G shows the my weosks module displaying the selected weosk structure and the selected module, capture new moment, where the option (i) store in the shared album and share with members of the weosk inner circle, has been selected and displayed, and certain members of the weosk structure's inner circle are being selected for sharing.

FIG. 49H shows the my weosks module displaying the selected weosk structure and the selected module, capture new moment, where the option (i) store in the shared album and post along selected social media channels, has been selected and displayed, and certain social media channels are being selected for posting the captured moments.

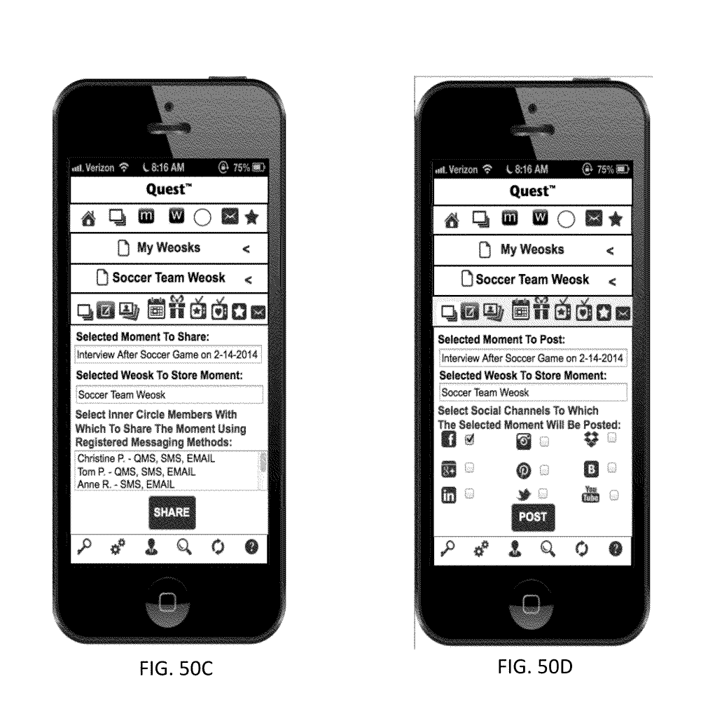

FIG. 50A shows the my weosks module, and displaying the selected weosk structure and the selected module, capture new moment, where the sound moment capture tool has been selected and used to capture a recorded sound moment.

FIG. 50B shows the my weosks module displaying the selected weosk structure and the selected module, capture new moment, where three options are shown for storing the captured sound moment, namely, (i) store in the shared album and return to the capture tool menu, (ii) store in the shared album and share with members of the inner circle of the selected weosk structure, and (iii) store in the shared album and post the recorded sound moment along selected social media channels.

FIG. 50C shows the my weosks module displaying the selected weosk structure and the selected module, capture new moment, where the option (i) store in the shared album and share with members of the weosk inner circle, has been selected and displayed, and certain members of the weosk structure's inner circle are being selected for sharing.

FIG. 50D shows the my weosks module displaying the selected weosk structure and the selected module, capture new moment, where the option (i) store in the shared album and post along selected social media channels, has been selected and displayed, and certain social media channels are being selected for posting the recorded sound moments.

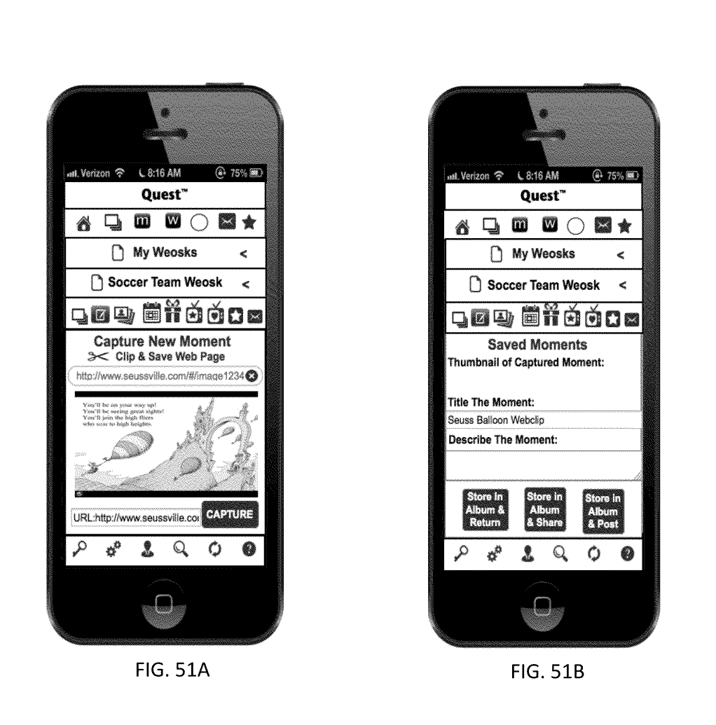

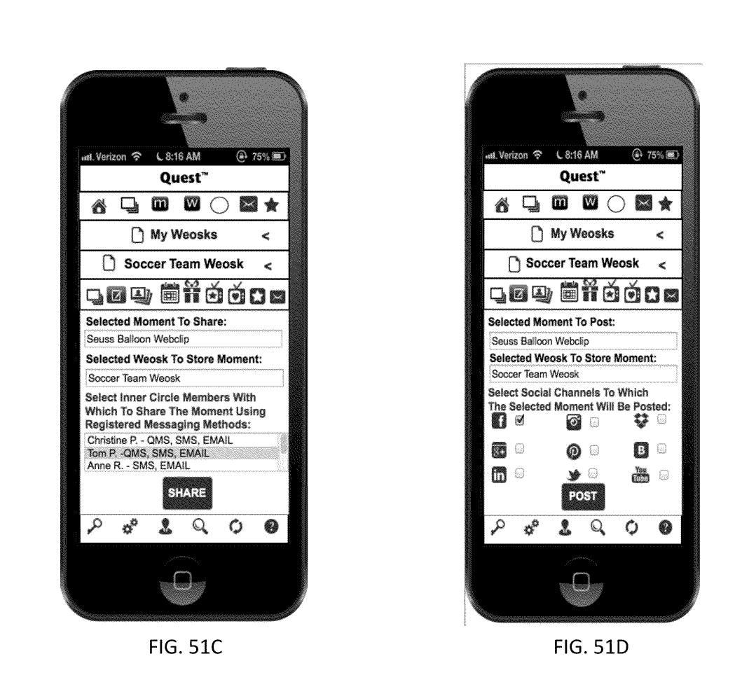

FIG. 51A shows the my weosks module displaying the selected and the selected module, capture new moment, where the web page clipping and moment capture tool has been selected and used to capture a clipped web-page moment or its URL for network storage.

FIG. 51B shows the my weosks module displaying the selected weosk structure and the selected module, capture new moment, where three options are shown for storing the captured web-clipped moment, namely, (i) store in the shared album and return to the capture tool menu, (ii) store in the shared album and share with members of the inner circle of the selected weosk structure, and (iii) store in the shared album and post the web-page clipped moment along selected social media channels.

FIG. 51C shows the my weosks module displaying the selected weosk structure and the selected module, capture new moment, where the option (i) store in the shared album and share with members of the weosk inner circle, has been selected and displayed, and certain members of the weosk structure's inner circle are being selected for sharing.

FIG. 51D shows the my weosks module displaying the selected weosk structure and the selected module, capture new moment, where the option (i) store in the shared album and post along selected social media channels, has been selected and displayed, and certain social media channels are being selected for posting the web-page clipped moments.

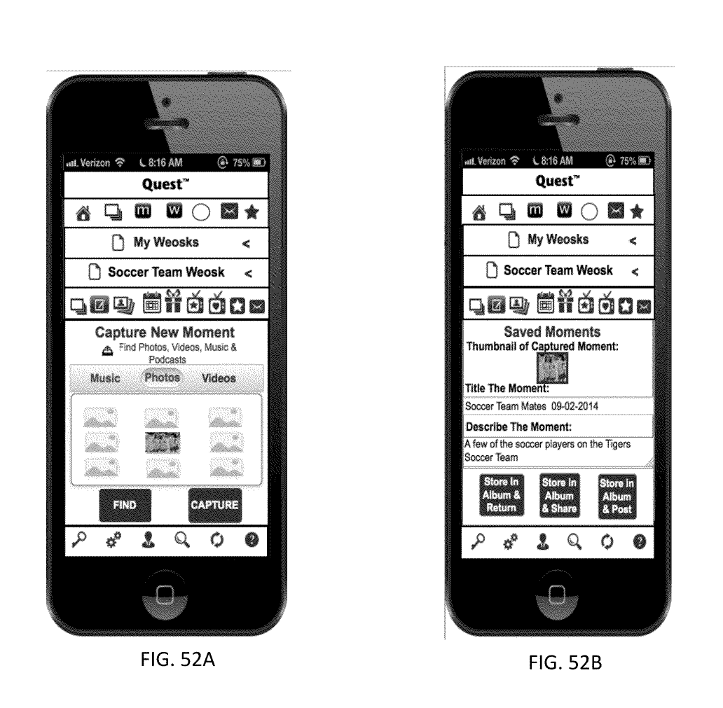

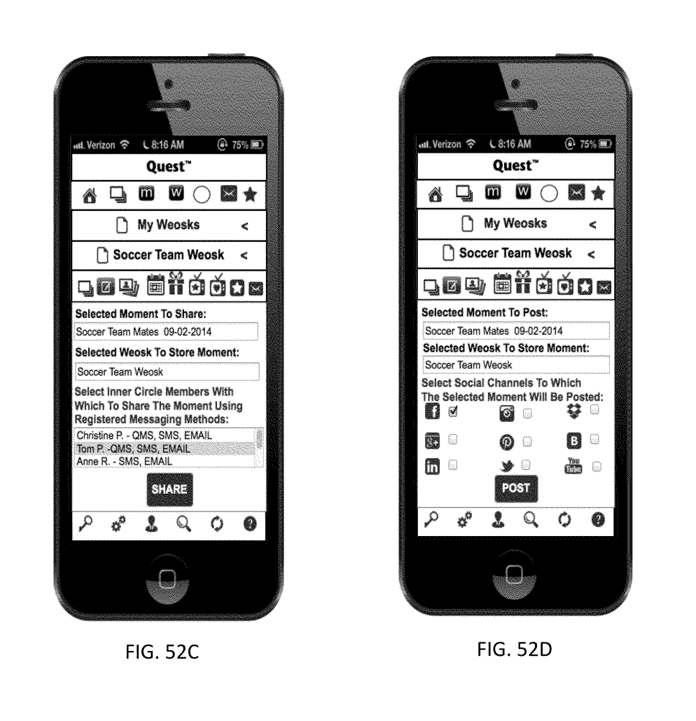

FIG. 52A shows the my weosks module displaying the selected weosk structure and the selected module, capture new moment, where the file uploading and moment capture tool has been selected and used to find and upload uploaded files (e.g. photos, documents, applications etc).

FIG. 52B shows the my weosks module displaying the selected weosk (and the selected module, capture new moment, where three options are shown for storing the captured moment, namely, (i) store in the shared album and return to the capture tool menu, (ii) store in the shared album and share with members of the inner circle of the selected weosk structure (i.e. GUI-based virtual file and operating system—VFOS), and (iii) store in the shared album and post the captured moment along selected social media channels.

FIG. 52C shows the my weosks module displaying the selected weosk (and the selected module, capture new moment, where the option (i), store in the shared album and share with members of the weosk inner circle, has been selected and displayed, and certain members of the weosk structure's inner circle are being selected for sharing.

FIG. 52D shows the my weosks module displaying the selected weosk structure and the selected module, capture new moment, where the option (i), store in the shared album and post along selected social media channels, has been selected and displayed, and certain social media channels are being selected for posting the web-page clipped moments.

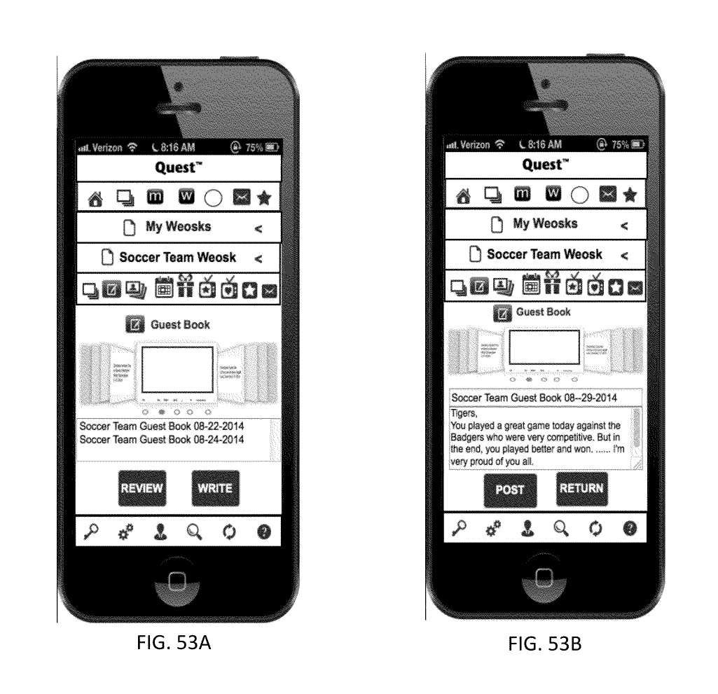

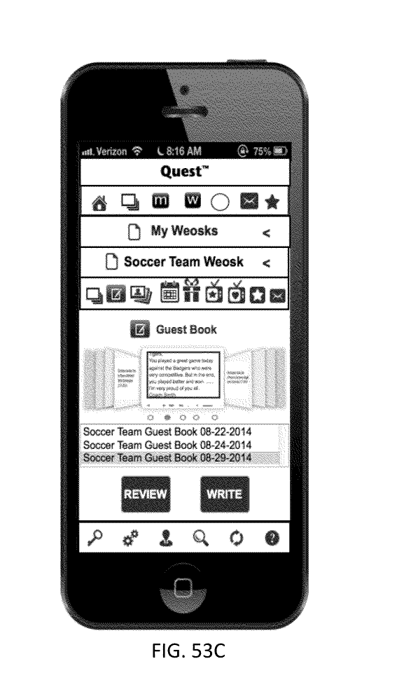

FIG. 53A shows the my weosks module displaying the selected weosk structure and the selected module, “guest book”, where a particular “page” in the guest book has been selected and all messages associated with (i.e. linked to) the page, by inner circle members of the weosk structure, are displayed for the registered user to review and/or write some notes on the page for posterity purposes.

FIG. 53B shows the my weosks module displaying the selected weosk structure and the selected module, “guest book”, where the user posts a note or message in the guest book.

FIG. 53C shows the my weosks module displaying the selected weosk structure and the selected module, “guest book”, where the user returns to the guest book after writing and posting a note to the guest book.

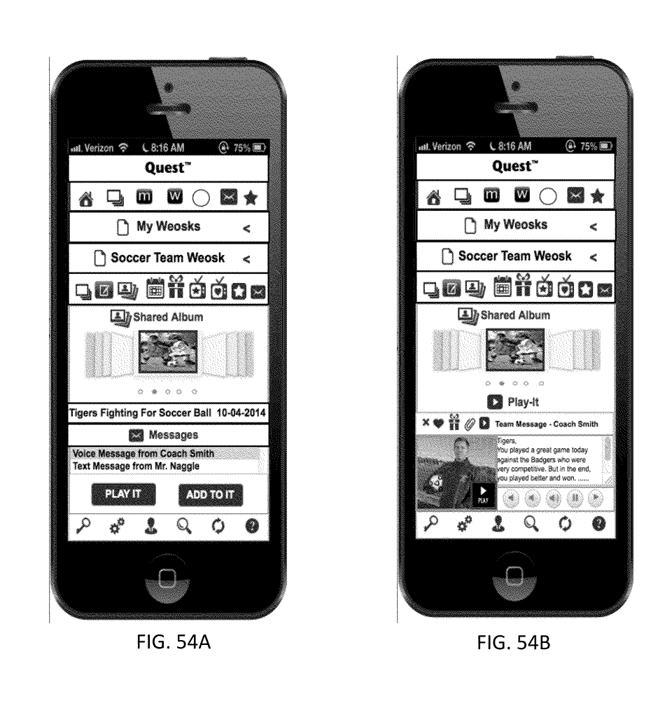

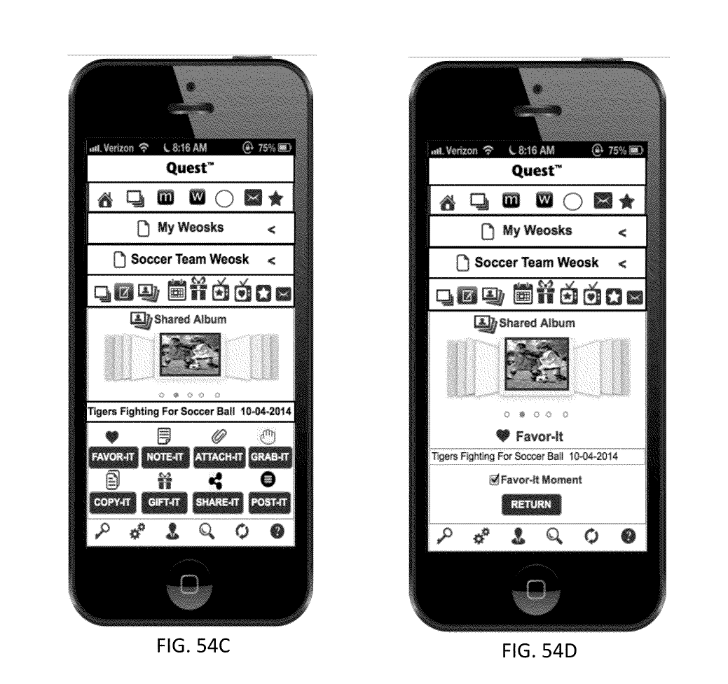

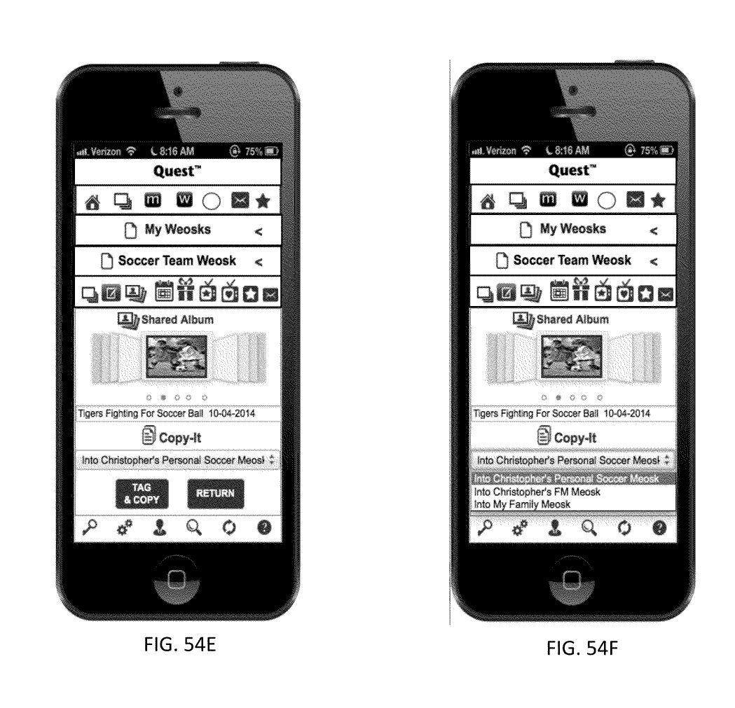

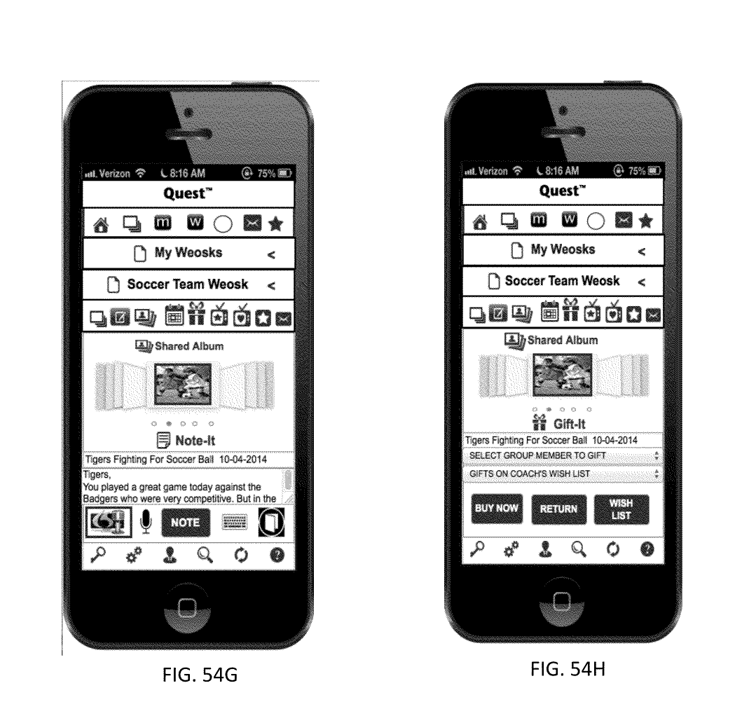

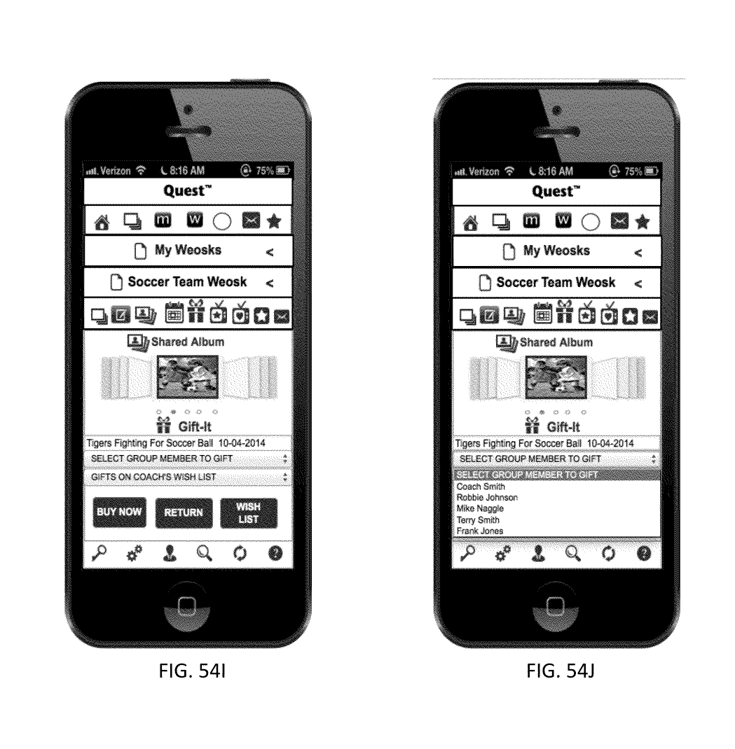

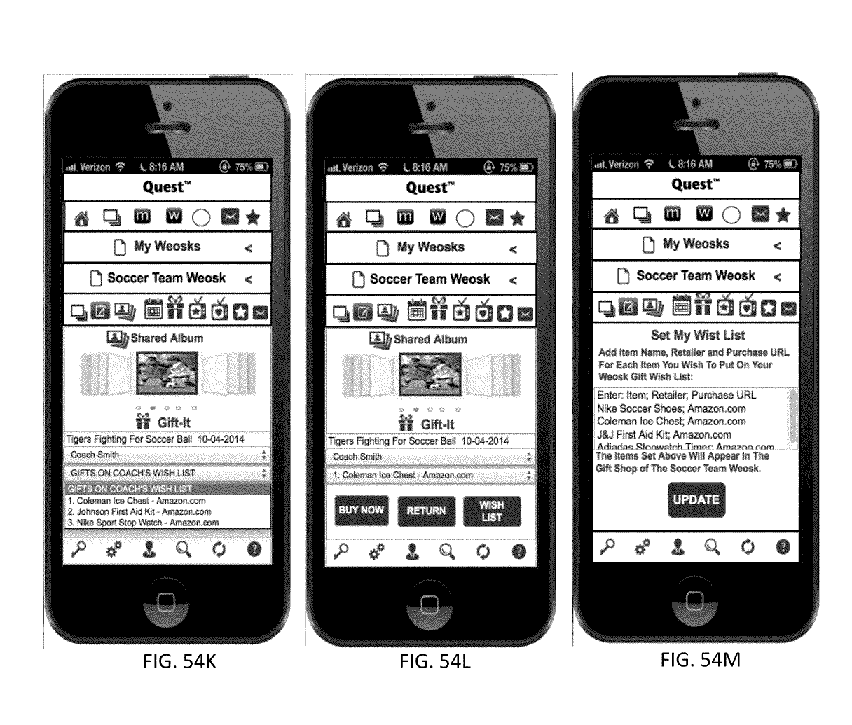

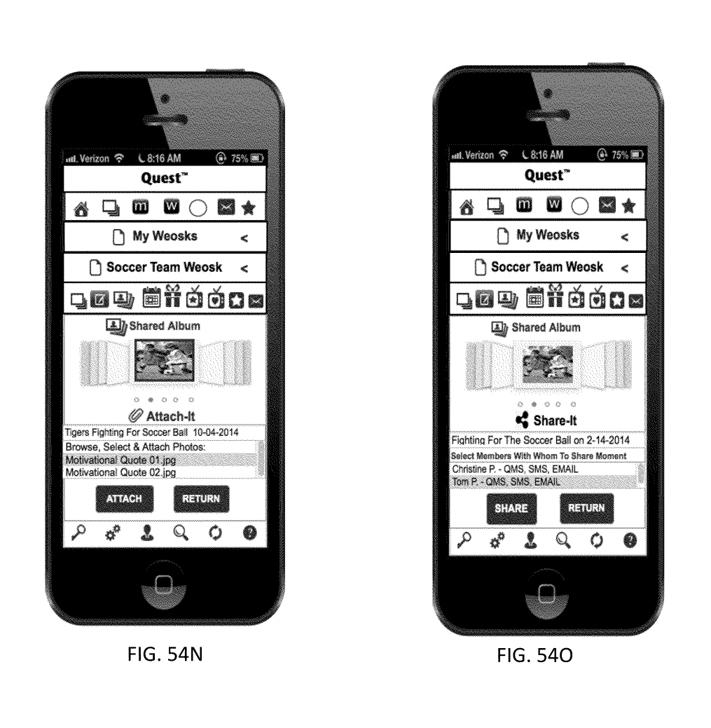

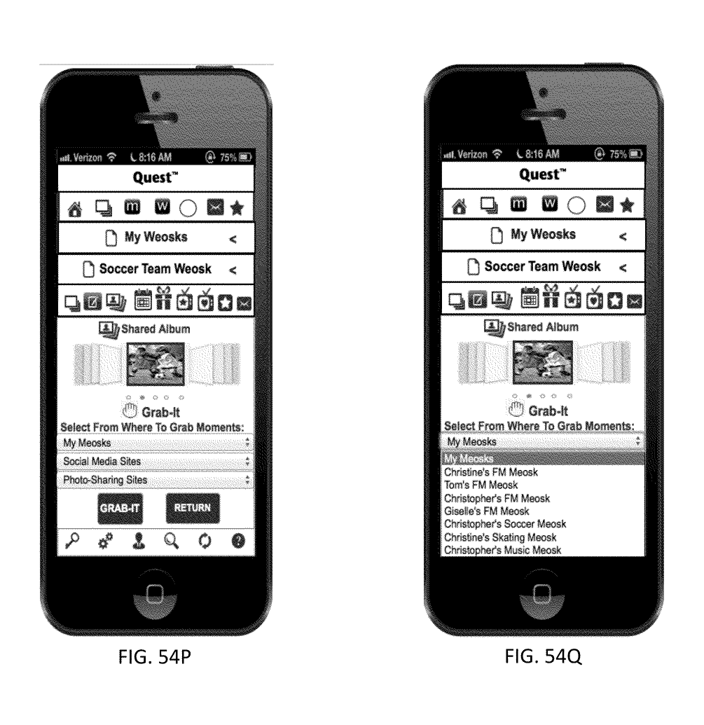

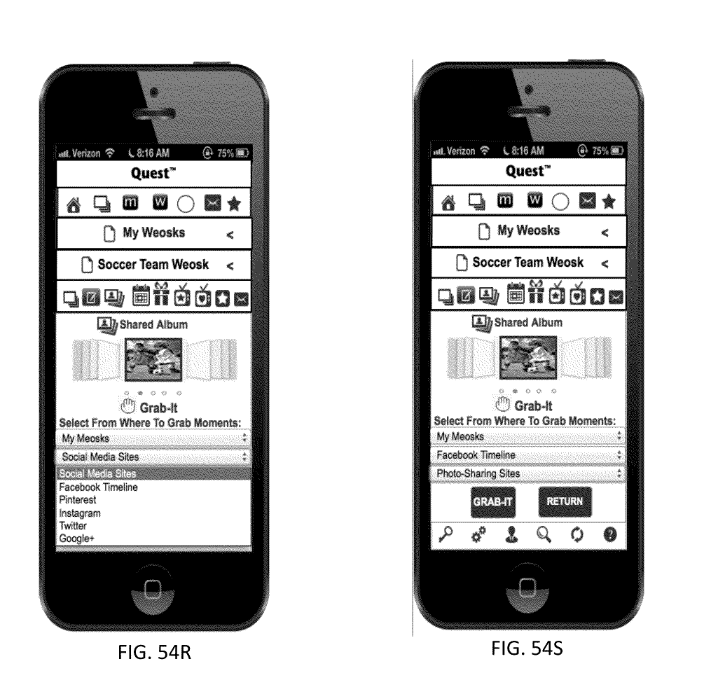

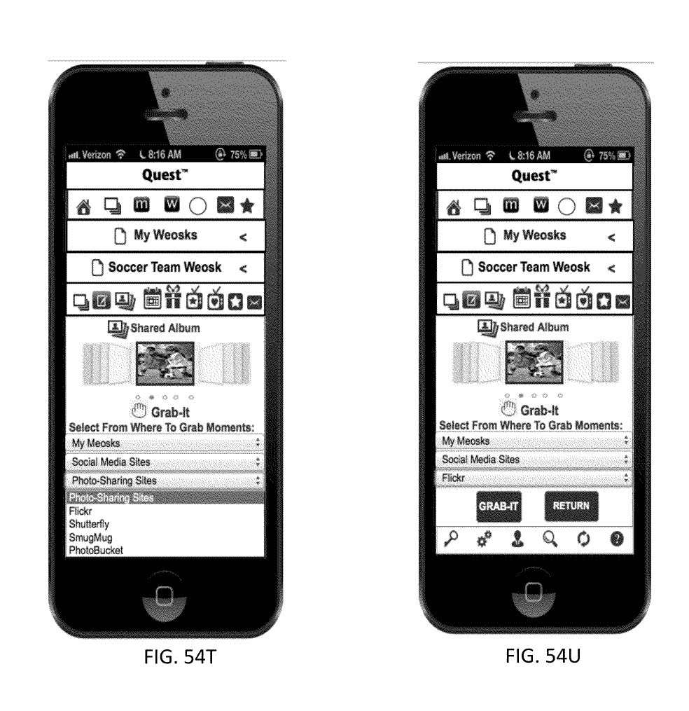

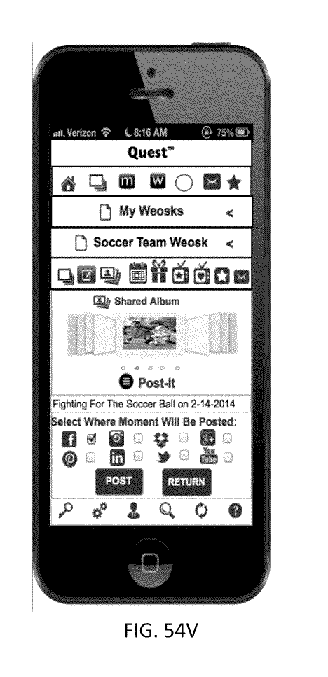

FIG. 54A shows the my weosks module displaying the selected weosk structure (i.e. soccer team weosk) and the selected module, “shared album”, where a particular moment or “page” in the shared album has been selected and all messages associated with (i e linked to) the moment by inner circle members of the weosk are displayed for the register user to either (i) play it (i.e. the selected moment) back for review and experience as illustrated in the GUI screens of FIG. 54B, or (ii) add or contribute to the selected moment in any number of ways indicated in the GUI screens of FIGS. 54C through 54T, described below.

FIG. 54B shows the my weosks module displaying the selected weosk structure and the selected module, shared album, where a selected message associated with the selected moment is recalled from system network memory storage and represented within the weosk structure for the registered user to experience the past message left by the inner circle member, regarding the once shared moment.

FIG. 54C shows the my weosks module displaying the selected weosk structure and the selected module, shared album, where upon selecting the “add to it (the selected moment)” selection shown in FIG. 54A, a menu of service function icons are displayed in connection with making a contribution to the selected moment in the shared journal store associated with the selected weosk structure.

FIG. 54D shows the my weosks module displaying the selected weosk structure and the selected module, shared album, where the “favorite it” service function was selected (via its displayed icon) and its corresponding GUI screen displayed allows the user to indicate that the moment should be indexed as a favorite moment.

FIGS. 54E and 54F show the my weosks module displaying the selected weosk structure and the selected module, shared album, where the “copy it” service function was selected (via its displayed icon) and its corresponding GUI screen displayed allows the user to tag moments selected in the shared album and copy the tagged moments into a selected meosk structure of the user (e.g. Christopher's Personal Soccer Meosk) for persistent storage on the system network.

FIG. 54G shows the my weosks module displaying the selected weosk structure and the selected module, shared album, where the “note it” service function was selected (via its displayed icon) and its corresponding GUI screen displayed allows the user to create a note in text or voice form and link it to a selected moment for persistent storage on the system network.

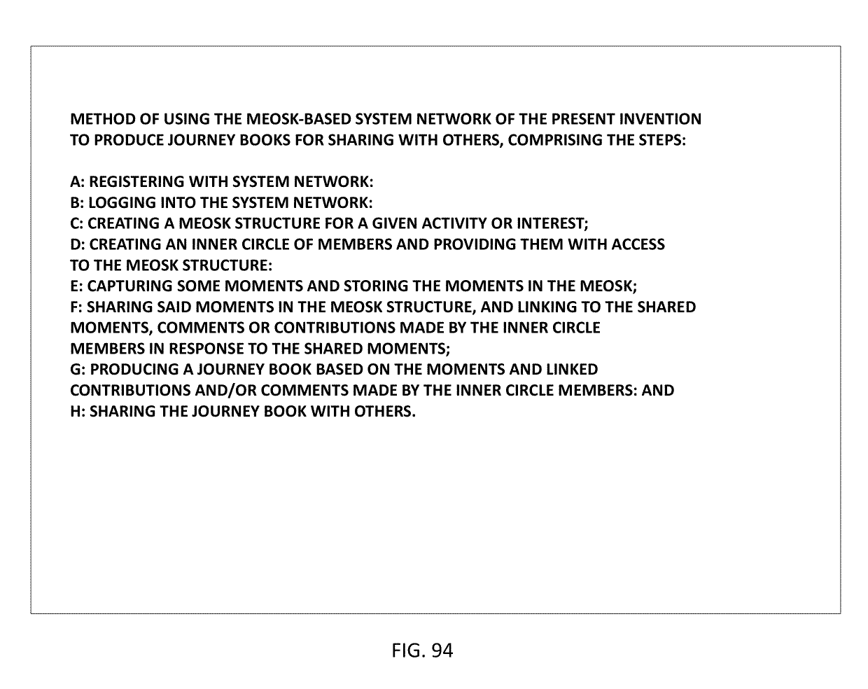

FIGS. 54H, 541, 54J, 54K, 54L and 54M show the my weosks module displaying the selected weosk structure and the selected module, shared album, where the “gift it” service function is selected (via its displayed icon) and corresponding GUI screens displayed to allow the user to (i) buy a gift for the person associated with the moment, selected from either the person's wish list, or top ten or more trending gifts for the person in that gender/age group, and (ii) recording this gifting event associated with the moment for persistent storage within the weosk.

FIG. 54N shows the my weosks module displaying the selected weosk structure and the selected module, the shared album, where the “attach it” service function has been selected (via its displayed icon) and its corresponding GUI screen displayed allowing the user to attach another moment (e.g. associated one or more moments with a particular moment) and link for persistent storage within the meosk structure.

FIG. 54O shows the my meosks module displaying the selected meosk structure (i.e. Christopher's FM Meosk) and the selected module, the shared album, where the “share it” service function has been selected (via its displayed icon) and its corresponding GUI screen displayed allowing the user to share the moment and associated messages and attachments with any one or more members of the meosk structure's inner circle, and store a persistent record thereof within the meosk structure.

FIGS. 54P, 54Q, 54R, 54S, 54T and 54U show the my weosks module, and displaying the selected weosk structure and the selected module, the shared album, where the “grab it” service function has been selected (via its displayed icon) and its corresponding displayed GUI screen allowing the user to grab (i.e. point to and copy) any moment in any of the user's meosk structures or weosk structures, as well as social media sites, and photo-sharing sites, and copy it into the shared album store in the current weosk structure.

FIG. 54V shows the my weosks module displaying the selected weosk structure and the selected module, the shared album, where the “post it” service function has been selected (via its displayed icon) and its corresponding GUI screen displayed allowing the user to post the moment and associated messages and attachments on any more or more of the user's social media channels, and store a persistent record thereof within the weosk structure.

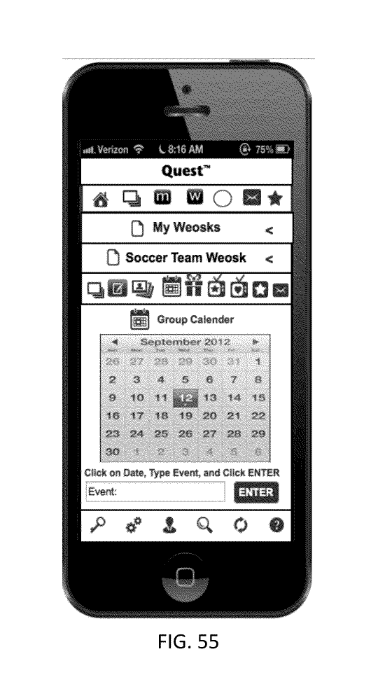

FIG. 55 shows the my weosks module displaying the selected weosk structure and the selected module, “group calendar”, where any user who is an inner circle member of the group can post events to the group calendar to notify members of upcoming events and the like.

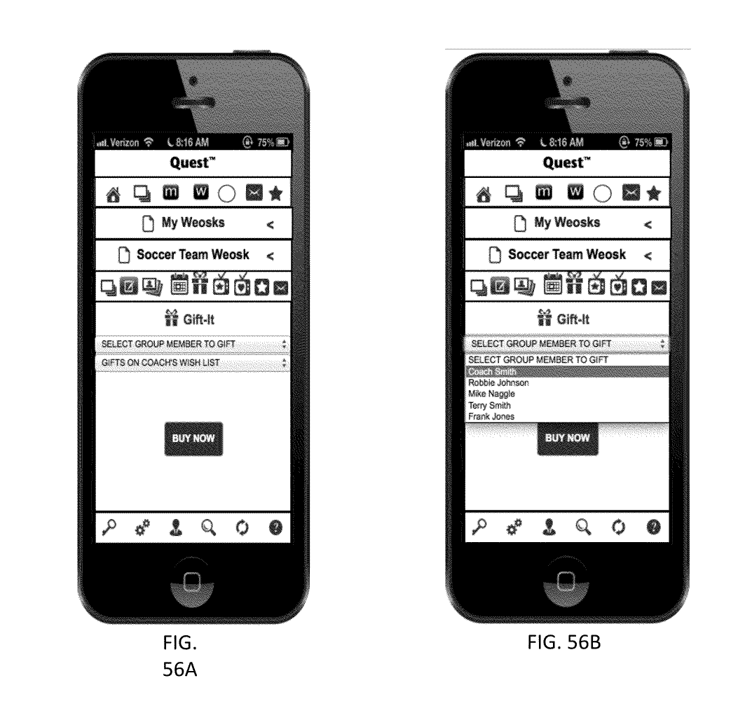

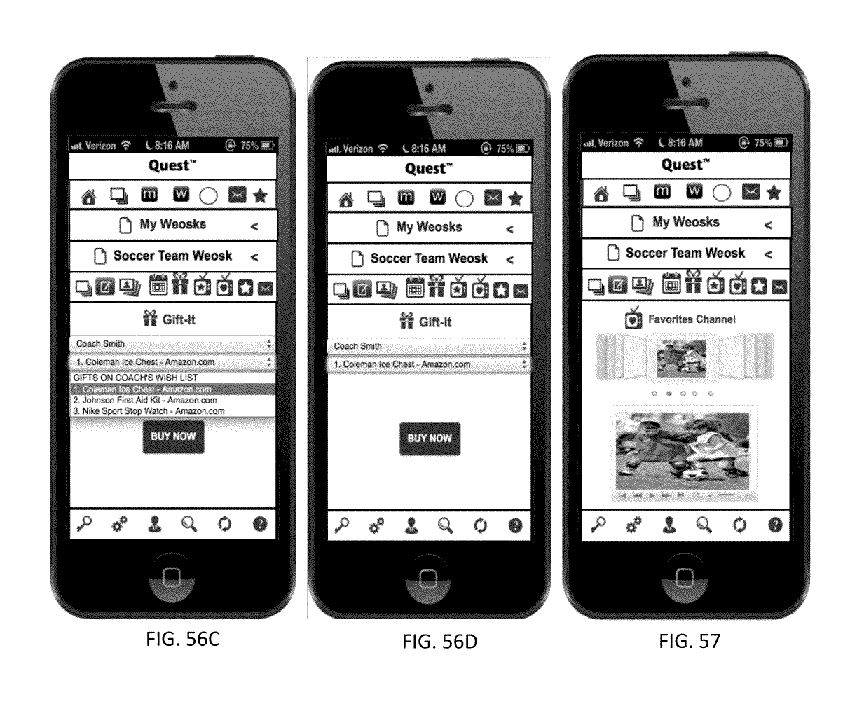

FIGS. 56A and 56B show the my weosks module displaying the selected weosk structure and the selected module, “gift shop” (or gift it), where a user selects a gift (e.g. for the soccer team coach) and sends it to her via the e-commerce services supported by the system network of the present invention.

FIG. 57 shows the my weosks displaying the selected weosk structure and the selected module, “favorites channel”, where a play-list driven media player is supported for displaying moments tagged as “favorite” in the weosk structure, in a manner and style determined by a program controlling the video streaming process(es) running on the media player integrated into the weosk structure. The play-list driven media player, implementing the favorites channel of each activity-specific meosk structure, is adapted to play videos and other audio-visual media content associated with the moments in the weosk structure that have been tagged or indexed as favorites by the inner circle members.

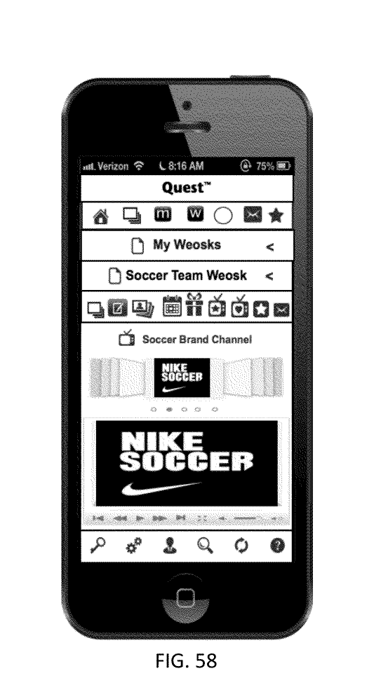

FIG. 58 show my weosks module displaying the selected weosk structure and the selected module, “brand channel”, where a play-list driven media player (supporting all media formats) is supported for displaying advertisements, promotions and product/service information associated with the brands selected by the different members of the weosk structure's inner circle. The play-list driven media player, implementing the brand channel of each activity-specific weosk structure, is adapted to play videos and other audio-visual media content in a programmed manner by the brand managers and/or staff of brands which the meosk master of the weosk structure has selected either during meosk creation and deployment or subsequently during weosk brand management operations supported by the system network. Example file formats for images, movies and sound files that can be supported by the media-player include, but are not limited to: Images —.gif, .jpg, .jpeg, .jfif; .ps, .eps, .epsi, .tif, .tiff, .tga, .pict, .bmp, .pcx, .pbm, .ppm, .pgm, .psd, .cvs, .cgm, .wpg, .wmf, .xpm, .xbm; Movies —.avi, .flc, .fli, .mov, .MooV, .qt, .mpg, .mpeg; and Sound —.au, .iff, .mid, .rmi, .mod, .qt, .snd, .voc, .way.

The brands use the programming tools supported in the brand manager module illustrated in FIGS. 6A-1 through 6F-15. In the event that a particular weosk structure has 5 different brands selected as part of the meosk master's my brands list, then each of these 5 brands will have the right to program video content sponsored by the selected brand in the embedded video player associated with the brand channel of the weosk structure. In some instances, weosk structures may be created and deployed with a single brand selected by the weosk master, in which case, this single brand will have the right to program exclusive content within the brand channel. Ideally, the sponsored video content will be related to the activity specified for the meosk structure, as well as the particular products and services which the brand provides to support the activity of the weosk master.

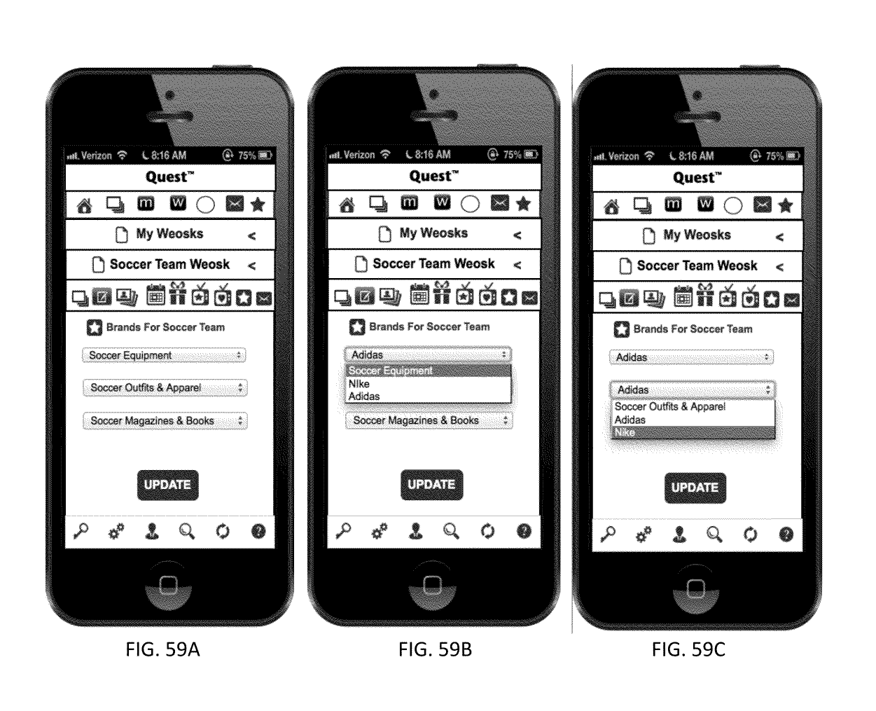

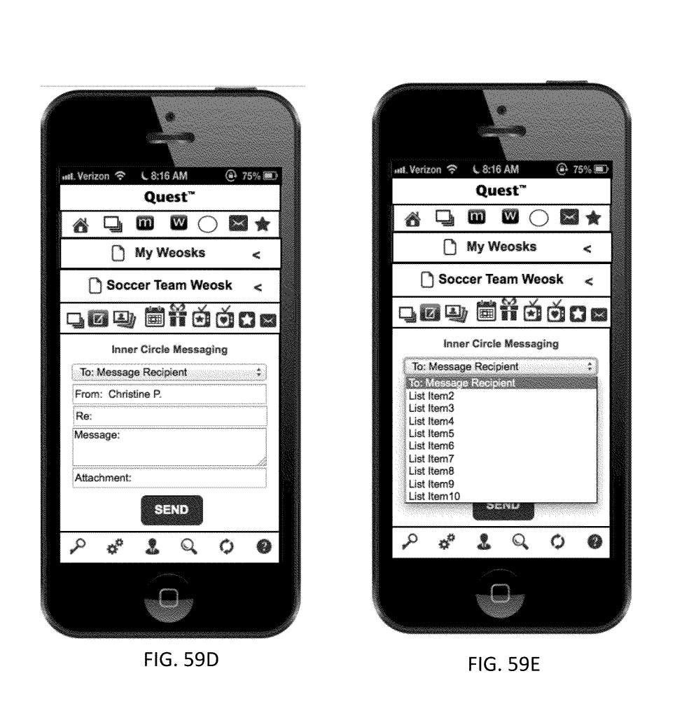

FIGS. 59A through 59C show the my weosks module displaying the selected weosk structure and the selected module, brands, where the user (i.e. inner circle member) can select the brands they wish to be associated with in the selected weosk structure, and receive contact and communication from such brands.

FIGS. 59D and 59E show the my weosks module displaying the soccer team weosk and its inner circle messaging module, wherein the user is provide with a GUI for sending a message to inner circle members currently listed on the inner circle weosk list, or any brand on the soccer team brand list.

### Specification of the Weosk Master Module on the System Network of the Present Invention

FIG. 60A shows the “master weosks” module displaying the various modules contained in this composite module including: the my weosks module illustrated in FIGS. 60C-1 through 62S; the create new weosk module illustrated in FIGS. 60B through 1DD;

the inner circles module illustrated in FIGS. 64A through 64D; the share moments module illustrated in FIGS. 62B through 62S; and the post my weosks module illustrated in FIGS. 62U through 62Z-2. In FIG. 60A, the GUI screen contains numerous unique and recognizable icons, as well as panel-type graphical interface objects, which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities for selecting and activating the different modules within the master weosk module on the system network. The details of this module, its graphical interface objects, and corresponding services will be described in greater detail hereinafter.

### Specification of the Create New Weosk (for My Family) Module of the System Network of the Present Invention

FIG. 60B shows the “master weosks” module displaying two options: (i) for selecting the “create new weosk” module for my family from a menu list of options; and (ii) for selecting the “create new weosk” for my group from the menu list of options. FIGS. 60C-1 through 60S show a series of GUI screens for creating a new weosk structure for the my family option. FIGS. 61B through 61DD show a series of GUI screens for creating a new weosk structure for the my group option.

In FIGS. 60C-1 through 60S, each GUI screen contains numerous unique and recognizable icons, as well as list/menu-type graphical interface objects, which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities for configuring, creating and deploying a new activity-specific weosk structure for the weosk master's family on the system network. The details of this module, its graphical interface objects, and corresponding services will be described in greater detail hereinafter.

FIG. 60C-1 shows the create new weosk module supporting the first step involved in creating a new weosk structure for my family, involving (i) identifying the family leader or leaders by name, year of birth, gender etc.

FIG. 60C-2 shows the create new weosk module displaying instructions for the second step involved in creating a new weosk involving providing (i) the name of the side of the family for which one is creating the weosk structure, or (ii) the names of both sides of the family for which one is creating the weosk structure.

FIG. 60D-1 shows the create new weosk module supporting the next two steps involved in creating a new weosk structure for my family, involving (i) selecting the field of interest about which the group is passionate (e.g. sports and athletics) and (ii) in the that field, selecting an activity for which the family's admin (i.e. weosk master) wishes to create a family weosk structure.

FIG. 60D-2 shows a schematic representation illustrating the tree structure representing a primary set of classes of human activity which can be used to classify a very wide range of human activities and interests, and provide a foundation for the activity/product/service/brand index used to support the reverse-inquiry based method of brand contact request and marketing communication supported by the meosk/weosk-based private and social media management and communication system network of the present invention.

FIG. 60E shows the create new weosk module supporting the third step involved in creating a new weosk structure for my family involving capturing a digital photo or image (e.g. a thumbnail photo of the family, grandparents or house or location identified involved with the family) for the weosk structure so that inner circle members can quickly identify the particular weosk structure along the client-side of the system network.

FIGS. 60F, 60G and 60H show the create new weosk module supporting the fourth step involved in creating a new weosk structure for my family, involving building an inner circle of users for the family weosk structure selected from registered users, the user's contacts, and/or individuals added by name and email address (and SMS number), to build up the family weosk structure's inner circle list.

FIG. 60I shows the create new weosk module supporting the fifth step involved in creating a new weosk structure for family, involving the optional identification of which members of the family inner circle have parents, grandparents, spouses and children, what are the names and years of birth of these parents, grandparents, spouses and children, to assist in the automatic generation of family inner circle structures that can facilitate communications and messaging on the system network.

FIG. 60J shows a GUI screen supported by the create new weosk module, and displaying the sixth major step involved in creating a new weosk structure for my family. This GUI screen allows the master user (i.e. meosk master) to select and enable (i.e. activate) weosk functions such as: (i) tagging and copying moments, (ii) create public views of the weosk structure, (iii) tag moments as private/non-copyable, (iv) post weosk on social networks & elsewhere on the WWW, (v) allowing inner circle members to add new members and expand the inner circle, and (vi) linking the weosk structure to events. By selecting the meosk function icons on this GUI screen, the corresponding weosk functions will be made active within the created and deployed weosk structure, and available for use by the master user.

FIG. 60K-1 shows a GUI screen supported by the create new weosk module, and displaying the sixth major step involved in creating a new weosk structure for my family. This GUI screen allows the master user to select and enable (i.e. activate) weosk functions such as: capture moments illustrated in FIGS. 47B through 52D; guest book illustrated in FIGS. 53A, 53B and 53C; shared album(s) illustrated in FIGS. 54A through 54V; group calendar illustrated in FIG. 55; gift shop illustrated in FIGS. 56A through 65D: brand channel illustrated in FIG. 58; favorites channel illustrated in FIG. 57; our brands illustrated in FIGS. 59A, 59B and 59C; and inner circle messaging illustrated in FIGS. 59D and 59E. By selecting the meosk function icons on this GUI screen, the corresponding weosk functions will be made active within the created and deployed weosk structure, and available for use by the master user.

FIG. 60K-2 shows a GUI screen supported by the create new weosk module, and displaying the sixth major step involved in creating a new weosk structure for my family. This GUI screen allows the master user to select and enable (i.e. activate) moment functions such as: (i) store-it illustrated in FIGS. 48B, 49B, 49F, 50B, 51B, 52B; favor-it illustrated in FIG. 54D; copy-it illustrated in FIGS. 54E and 54F; note-it illustrated in FIG. 54G; gift-it illustrated in FIGS. 54H through 54L; attach-it illustrated in FIG. 54N; share-it illustrated in FIG. 54O; grab-it illustrated in FIG. 54P through 54U; and post-it illustrated in FIG. 54V. By selecting the moment function icons on this GUI screen, the corresponding moment functions will be made active within the created and deployed weosk structure, and available for use by the master user.

FIG. 60K-3 shows a GUI screen supported by the create new weosk module, and displaying the seventh major step involved in creating a new weosk structure for another. This GUI screen allows the master user to select and enable (i.e. activate) of weosk functions such as: (i) tagging and copying moments; (ii) tagging moments as private and non-copyable; (iii) posting weosks on social networks and WWW; and (iv) allowing inner circle members to add new members and expand the inner circle. By selecting the weosk function icons on this GUI screen, the corresponding weosk functions will be made active within the created and deployed weosk structure, and available for use by the guest users.

FIG. 60K-4 shows a GUI screen supported by the create new weosk module, and displaying the seventh major step involved in creating a new weosk structure for my self (i.e. for the system user). This GUI screen allows the master user to select and enable (i.e. activate) weosk functions such as: capture moments illustrated in FIGS. 47B through 52D; guest book illustrated in FIGS. 53A, 53B and 53C; shared album(s) illustrated in FIGS. 54A through 54V; group calendar illustrated in FIG. 55; gift shop illustrated in FIGS. 56A through 65D: brand channel illustrated in FIG. 58; favorites channel illustrated in FIG. 57; our brands illustrated in FIGS. 59A, 59B and 59C; and inner circle messaging illustrated in FIGS. 59D and 59E. By selecting the weosk function icons on this GUI screen, the corresponding weosk functions will be made active within the created and deployed weosk structure, and available for use by the guest users.

FIG. 60K-5 shows a GUI screen supported by the create new weosk module, and displaying the seventh major step involved in creating a new weosk structure for my self (i.e. for the system user). This GUI screen allows the master user to select and enable (i.e. activate) moment functions such as: (i) store-it illustrated in FIGS. 48B, 49B, 49F, 50B, 51B, 52B; favor-it illustrated in FIG. 54D; copy-it illustrated in FIGS. 54E and 54F; note-it illustrated in FIG. 54G; gift-it illustrated in FIGS. 54H through 54L; attach-it illustrated in FIG. 54N; share-it illustrated in FIG. 54O; grab-it illustrated in FIG. 54P through 54U; and post-it illustrated in FIG. 54V. By selecting the moment function icons on this GUI screen, the corresponding moment functions will be made active within the created and deployed weosk structure, and available for use by the guest users.

FIG. 60L shows the create new weosk module supporting the eighth step involved in creating a new weosk structure for my family, involving the indication and identification of any event(s) that should be associated with the family weosk structure being created.

FIG. 60M shows the create new weosk module supporting the ninth step involved in creating a new weosk structure for my family, involving the listing and capturing of favorite family traditions.

FIG. 60N shows the create new weosk module supporting the tenth step involved in creating a new weosk structure for my family, involving the identification of brands to support my family, which may be selected from a variety of diverse fields such as finance and insurance, sports and entertainment, college and education, faith and religion, etc.

FIG. 60O shows the create new weosk module supporting the eleventh step involved in creating a new weosk structure for my family, involving the identification of local brand to support my family, which may be selected from a variety of diverse fields such retailers and restaurants, businesses and merchants, and schools, churches and associations, etc.

FIG. 60P shows the my weosk module supporting the twelfth step involved in creating a new weosk structure for my family, where the weosk administrator (i.e. weosk master) determines when to archive the family weosk structure on the system network of the present invention.

FIG. 60Q shows the my weosk module supporting the thirteen step involved in creating a new weosk structure for my family, involving the acceptance of the previous selections made and making a request to create my family weosk structure and invite all identified family members to join the weosk structure's inner circle.

FIG. 60R shows the my weosk module supporting the current lists of weosks that have been created and deployed on the network, and of which the logged-in user (e.g. a weosk master or weosk guest) is an inner circle member.

FIG. 60S shows the my weosk module supporting the GUI of the “family weosk” created during the previous illustrated workflow, and listed on the user's my weosk listed in FIG. 60R.

### Specification of the Create New Weosk (for My Group) Module of the System Network of the Present Invention

FIG. 61A shows the “master weosks” module displaying two options: (i) for selecting the “create new weosk” module for my family from a menu list of options; and (ii) for selecting the “create new weosk” for my group from the menu list of options. FIGS. 61B through 61DD show a series of GUI screens for creating a new weosk structure for the my group option.

In FIGS. 61B-1 through 61DD, each GUI screen contains numerous unique and recognizable icons, as well as list/menu-type graphical interface objects, which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities for configuring, creating and deploying a new activity-specific weosk structure for the weosk master's group on the system network. The details of this module, its graphical interface objects, and corresponding services will be described in greater detail hereinafter.

FIG. 61A shows the “master weosks” module displaying options for selecting the “create new weosk” module from a menu list of options.

FIG. 61B shows the “create new weosk” module displaying options for creating a new weosk structure for my group.

FIGS. 61C, 60D and 60E show the create new weosk module supporting the first step involved in creating a new weosk structure for my group, involving (i) selecting the field of interest about which the group is passionate (e.g. sports and athletics) and (ii) in the that field, selecting an activity for which the group's admin (i.e. weosk master) wishes to create a group weosk structure.

FIG. 61F shows the create new weosk module displaying instructions for the second step involved in creating a new weosk structure, allowing the weosk master to identify an event that should be associated with the creation of the group weosk structure.

FIG. 61G shows the create new weosk module supporting the second step involving indicating whether the planned or upcoming event (associated with the new weosk being created) is either a (ii) holiday, or (ii) special occasion.

FIGS. 61H and 611 show the create new weosk module, in response to the selection of “holiday” in FIG. 61G, allowing the weosk master to specify what is the name of the upcoming holiday event.

FIGS. 61J and 61K show the create new weosk module, in response to the selection of “special occasions” in FIG. 61G, allowing the weosk master to specify what is the name of the upcoming special occasion.

FIG. 61L shows the create new weosk module supporting the third step allowing the weosk master to specify when the specified event is the scheduled to happen, using a calendar widget supported within the weosk structure.

FIG. 61M shows the create new weosk module supporting the fourth step allowing the weosk master to specify where the specified event is the scheduled to happen, using a template driven widget supported within the weosk structure to capture such event location information, including online location (e.g. URL), GPS coordinates where appropriate and the like.

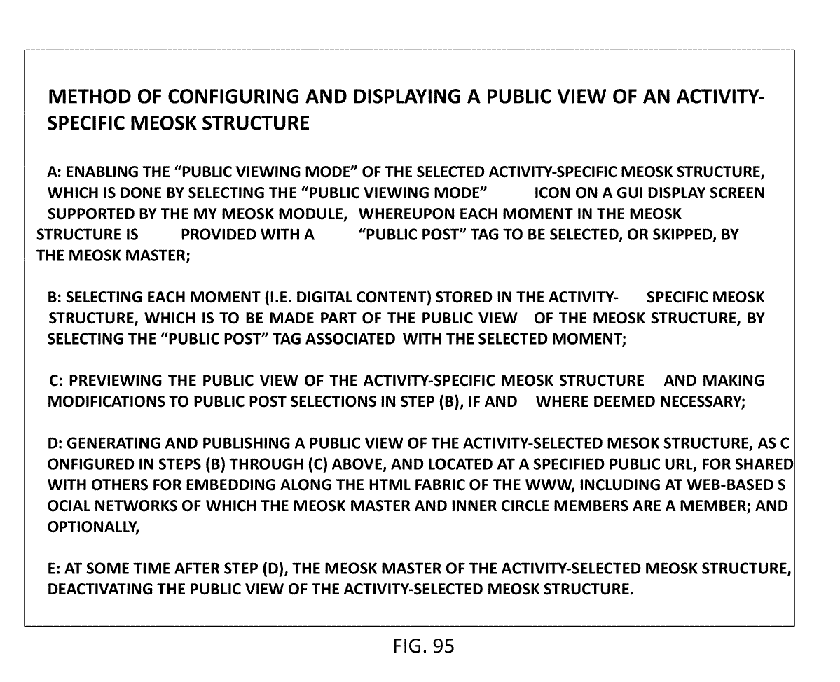

FIGS. 61N, 610 and 61P show the create new weosk module supporting the fifth step allowing the weosk master determining whether to activate or deactivate automatic moment generation across the inner circle of the weosk being created.

FIG. 61Q shows the create new weosk module supporting the sixth step allowing the weosk master to confirm and accept the name that the system proposes for the group weosk structure, or provide an alternative name desired by the weosk master.

FIG. 61R shows the create new weosk module supporting the seventh step allowing the weosk master to capture and assign a digital photo or image (e.g. a thumbnail photo of group members engaged in their activity of interest) to the weosk structure so as to help inner circle members quickly identify the particular weosk structure on the client-side of the system network 1.

FIGS. 61S, 61T and 61U show the create new weosk module supporting the eighth step involved in creating a new weosk structure for my group, involving building an inner circle of users for the group weosk selected from registered users, the user's contacts, and/or individuals added by name and email address (and SMS number), to build up the group weosk's inner circle list.

FIG. 61V shows the create new weosk module supporting the ninth step involved in creating a new weosk structure for my group, allowing the meosk master to identify the name and year or birth of each player or actor related to and associated with each member of the group's inner circle so as to facilitate communications among group members and players/actors.

FIG. 61W shows a GUI screen supported by the create new weosk module, and displaying the tenth step involved in creating a new weosk structure for my group. This GUI screen allows the master user to select and enable (i.e. activate) weosk functions such as: (i) tagging and copying moments, (ii) create public views of the weosk structure, (iii) tag moments as private/non-copyable, (iv) post weosk on social networks & elsewhere on the WWW, (v) allowing inner circle members to add new members and expand the inner circle, and (vi) linking the weosk structure to events. By selecting the weosk function icons on this GUI screen, the corresponding weosk functions will be made active within the created and deployed weosk structure, and available for use by the master user.

FIG. 61X-1 shows a GUI screen supported by the create new weosk module, and displaying the tenth major step involved in creating a new weosk structure for my group, involving the selection and enablement (i.e. activation) of weosk functions such as: capture moments illustrated in FIGS. 47B through 52D; guest book illustrated in FIGS. 53A, 53B and 53C; shared album(s) illustrated in FIGS. 54A through 54V; group calendar illustrated in FIG. 55; gift shop illustrated in FIGS. 56A through 65D: brand channel illustrated in FIG. 58; favorites channel illustrated in FIG. 57; our brands illustrated in FIGS. 59A, 59B and 59C; and inner circle messaging illustrated in FIGS. 59D and 59E. By selecting the weosk function icons on this GUI screen, the corresponding weosk functions will be made active within the created and deployed weosk structure, and available for use by the master user.

FIG. 61X-2 shows a GUI screen supported by the create new weosk module, and displaying the tenth major step involved in creating a new weosk structure for my group, involving the selection and enablement (i.e. activation) of moment functions such as: (i) store-it illustrated in FIGS. 48B, 49B, 49F, 50B, 51B, 52B; favor-it illustrated in FIG. 54D; copy-it illustrated in FIGS. 54E and 54F; note-it illustrated in FIG. 54G; gift-it illustrated in FIGS. 54H through 54L; attach-it illustrated in FIG. 54N; share-it illustrated in FIG. 54O; grab-it illustrated in FIG. 54P through 54U; and post-it illustrated in FIG. 54V. By selecting the moment function icons on this GUI screen, the corresponding moment functions will be made active within the created and deployed weosk structure, and available for use by the master user.

FIG. 61X-3 shows a GUI screen supported by the create new weosk module, and displaying the eleventh major step involved in creating a new weosk structure for my group. This GUI screen allows the master user to select and enable (i.e. activate) weosk functions such as: (i) tagging and copying moments; (ii) tagging moments as private and non-copyable; (iii) posting meosk structures on social networks and WWW; and (iv) allowing inner circle members to add new members and expand the inner circle. By selecting the weosk function icons on this GUI screen, the corresponding weosk functions will be made active within the created and deployed weosk structure, and available for use by the guest users.

FIG. 61X-4 shows a GUI screen supported by the create new weosk module, and displaying the eleventh major step involved in creating a new weosk structure for my group, involving the selection of meosk functions such as: capture moments illustrated in FIGS. 47B through 52D; guest book illustrated in FIGS. 53A, 53B and 53C; shared album(s) illustrated in FIGS. 54A through 54V; group calendar illustrated in FIG. 55; gift shop illustrated in FIGS. 56A through 65D: brand channel illustrated in FIG. 58; favorites channel illustrated in FIG. 57; our brands illustrated in FIGS. 59A, 59B and 59C; and inner circle messaging illustrated in FIGS. 59D and 59E. By selecting the weosk function icons on this GUI screen, the corresponding weosk functions will be made active within the created and deployed weosk structure, and available for use by the guest users.

FIG. 61X-5 shows a GUI screen supported by the create new weosk module, and displaying the eleventh major step involved in creating a new weosk structure for my group. This GUI screen allows the master user (i.e. weosk master) select and enable (i.e. activate) moment functions such as: (i) store-it illustrated in FIGS. 48B, 49B, 49F, 50B, 51B, 52B; favor-it illustrated in FIG. 54D; copy-it illustrated in FIGS. 54E and 54F; note-it illustrated in FIG. 54G; gift-it illustrated in FIGS. 54H through 54L; attach-it illustrated in FIG. 54N; share-it illustrated in FIG. 54O; grab-it illustrated in FIG. 54P through 54U; and post-it illustrated in FIG. 54V. By selecting the moment function icons on this GUI screen, the corresponding moment functions will be made active within the created and deployed weosk structure, and available for use by the guest users.

FIG. 61Y shows the create new weosk module supporting the twelfth step involved in creating a new weosk structure for my group, involving the weosk master selecting some initial global/national brands to support the group, selected from a variety of diverse fields related to the activity and interest about which the weosk structure is formed.

FIG. 61Z shows the create new weosk module supporting the thirteenth step involved in creating a new weosk structure for my group, involving the weosk master selecting some initial local brands to support the group, selected from a variety of diverse fields related to the activity and interest about which the weosk structure is formed.

FIG. 61AA shows the create new weosk module supporting the fourteenth step involved in creating a new weosk structure for my group, involving the weosk master selecting some initial global/national brands to support the group, selected from a variety of diverse fields related to the activity and interest about which the weosk structure is formed.

FIG. 61BB shows the create new weosk module supporting the fifteenth step involved in creating a new weosk structure for my group, where the weosk master requests the selected brands to contact and communicate with the weosk structure and create the group's weosk and invite the weosk inner circle members.

FIG. 61CC shows the my weosk module displaying the current lists of weosks that have been created and deployed on the system network, and of which the logged-in user is an inner circle member.

FIG. 61DD shows the my weosk module displaying the GUI of the “group weosk” structure created during the previous illustrated workflow, and listed on the user's my weosk listed in FIG. 61CC.

### Specification of the Share Moments Module of the System Network of the Present Invention

In FIGS. 62A-1 through 62S, each GUI screen contains numerous unique and recognizable icons, as well as list/menu-type graphical interface objects, which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities for configuring and sharing moments across the inner circle of the weosk structure. The details of this module, its graphical interface objects, and corresponding services will be described in greater detail hereinafter.

FIG. 62A shows the “master weosks” module displaying options for selecting the “share moments” module from a menu list of options.

FIG. 62B shows the “master weosks” module displaying the introduction screen for the share moments module.

FIG. 62C shows the “master weosks” module supporting the share moments module, where the user can share moments with inner circle members of a weosk in either an automated or manual manner.

FIG. 62D shows the master weosks module supporting the share moments module, where the user sets automatic moment generation to occur every 20 uploads to the weosk structure, although this figure could be greater or less than 20 by user selection and choice.

FIG. 62E shows the master weosks module supporting the share moments module, where the user proceeds to reset automatic moment generation to occur every 6 hours.

FIG. 62F shows the master weosks module supporting the share moments module, where the user returns to the mode selection GUI and selects manual moment generation to occur within the weosk structure, and over its inner circle.

FIG. 62G shows the master weosks module supporting the share moments module, where the user sets manual moment generation within the weosk structure and over its inner circle.

FIG. 62H shows the master weosks module supporting the share moments module, where the user identifies for whom a moment will be created (e.g. soccer team), and what is the subject or theme of the moment (e.g. team soccer).

FIG. 62I shows the master weosks module supporting the share moments module, where the user sets the terms for sharing the moment across the inner circle (e.g. share one time only, share annually on a recurring basis, share bi-annually on a recurring basis).

FIG. 62J shows the master weosks module supporting the share moments module, where the weosk master previews the specially composed moment.

FIG. 62K shows the master weosks module supporting the share moments module, where the user adds text and/or voice over the specially composed moment;

FIG. 62L shows a GUI screen supported by the master weosks module, and displaying the share moments module, where the user indicates where the specially composed moment will be shared on the posting date (e.g. over Soccer Team Moments Channel).

FIG. 62M shows the master weosks module supporting the share moments module, where the user receives an notification that a special moment invitation has been sent to all members of the inner circle of the weosk structure to be shared (e.g. Sep. 12, 2014) on an annually recurring basis.

FIG. 62N shows the master weosks module displaying a notification that an invitation has been sent to all members of the weosk inner circle that the special moment will be shared, for example, twice daily during the selected share period, and then annually.

FIGS. 62O and 62P show the master weosks module supporting the share moments module, where, during the selection of the automatic moment generation mode, the weosk master is allowed to set the frequency of moment generation and sharing (e.g. every 20 uploads, every 6 hours, etc.).

FIGS. 62Q and 62R show the master weosks module supporting the share moments module, where, during the selection of the automatic moment generation mode, the weosk master is allowed to set where the special moment will be shared on posting date.

FIG. 62S shows the master weosks module supporting the share moments module, where, during the selection of the automatic moment generation mode, the weosk master receives notification that an invitation has been sent to all members of the weosk structure's inner circle to be shared, for example, twice daily during the selected sharing period and then annually on a recurring basis.

### Specification of the Post My Weosk Module of the System Network of the Present Invention

FIG. 62T shows the master weosks module displaying icons for various modules therein, including the post my weosks module, where the master user (and also guest users authorized by weosk masters) can post weosk structures to social media sites and photo-sharing sites, and also un-post posted weosks as desired.

In FIGS. 62U through 62Z-2, each GUI screen contains numerous unique and recognizable icons, as well as panel and menu type graphical interface objects, which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities for configuring and posting weosk structures across the inner circle of the weosk structure. The details of this module, its graphical interface objects, and corresponding services will be described in greater detail hereinafter.

FIG. 62U shows the master weosks module supporting the post my weosks module, where the master user selects “soccer team weosk” for posting to a social media site which has been pre-configured with the system network.

FIG. 62V shows the master weosks module supporting the post my weosks module, where the master user selects a social medial site (e.g. Facebook) to which the selected weosk should be posted using the application programming interface (API) used to interface the system network and this social media site network.

FIGS. 62W and 62X shows the master weosks module supporting the post my weosks module, where the front panel of the soccer team weosk now bears the post icon, in both interfaces, for notification purposes.

FIG. 62Y shows the master weosks module supporting the post my weosks module, where the weosk master selects the “un-post” button to remove the soccer team weosk from its prior Facebook post (e.g. equivalent to a delete post on the Facebook platform.

FIGS. 62Z-1 and 62Z-2 shows the master weosks module supporting the post my weosk module, where the front panel of the un-posted weosk (i.e. soccer team weosk) no longer bears the post icon, on either interface, for notification purposes.

### Specification of the Message Center Module of the System Network of the Present Invention

In FIGS. 63A through 62I, each GUI screen contains numerous unique and recognizable icons, as well as list and menu type graphical interface objects, which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities associated with the message center module on the system network. The details of this module, its graphical interface objects, and corresponding services will be described in greater detail hereinafter.

FIG. 63A shows the message center module displaying a “Request to Build Inner Circles” notification in the Notifications Frame, and a first ordinary message (“When will you be visiting us . . . ”) from a first family member (“Grandma”) an inner circle member is displayed in the Messages Frame.

FIG. 63B shows the message center module displaying a “Request to Create New Meosks” notification in the Notifications Frame, and a first ordinary message (“When will you be visiting us . . . ”) from a first family member (“Grandma”) an inner circle member is displayed in the Messages Frame.

FIG. 63C shows the message center module displaying a “Request to View Shared Moment” notification in the Notifications Frame, and a first ordinary message (“When will you be visiting us . . . ”) from a first family member (“Grandma”) is displayed in the Messages Frame.

FIG. 63D shows the message center module displaying a “Request to Join Meosk Inner Circle” notification in the Notifications Frame, and a first ordinary message (“When will you be visiting us . . . ”) from a first family member (“Grandma”) is displayed in the Messages Frame.

FIG. 63E shows the message center module displaying a “Request to Join Weosk Inner Circle” notification in the Notifications Frame, and a second ordinary message (“When will you be visiting us . . . ”) from the first family member (“Grandma”) is displayed in the Messages Frame.

FIG. 63F shows a GUI screen supported by the message center module, and displaying a “Request to Build Inner Circles” notification in the Notifications Frame, and a second ordinary message (“Thank you for the beautiful . . . ”) from a second family (“Grandma”) in the Messages Frame;

FIG. 63G shows the message center module displaying a “Request to Build Inner Circles” notification in the Notifications Frame, and a third ordinary message (“Where will Thanksgiving Dinner . . . ”) from a second family (“Buck P.”) in the Messages Frame.

FIG. 63H shows the message center module displaying a “Request to Build Inner Circles” notification in the Notifications Frame, and a fourth ordinary message from an unspecified inner circle member in the Messages Frame.

### Specification of the Inner Circle Module of the System Network of the Present Invention

In FIGS. 64A through 64D, each GUI screen contains numerous unique and recognizable icons, as well as menu and list type graphical interface objects, which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities for expanding and reducing the inner circles of meosk structures and weosk structures on the system network. The details of this module, its graphical interface objects, and corresponding services will be described in greater detail hereinafter.

FIG. 64A shows the Inner Circle Module displaying an introductory screen inviting master and guest users alike to build inner circles for their meosks and weosks.

FIG. 64B shows the Inner Circle Module displaying a list of inner circles, of which the user is a meosk inner circle member or weosk inner circle member, and GUI buttons for (i) adding members to the inner circle of selected meosks or weosks of which the user is a master or a guest with the power to add new members, and (ii) removing members to the inner circle of selected meosks or weosks.

FIG. 64A shows the Inner Circle Module, displaying the selection of a meosk or weosk of which the user is a master, and the addition of members to the inner circle of selected meosk structures or weosk structures.

FIG. 64D shows the Inner Circle Module, displaying the selection of a meosk or weosk of which the user is a master or a guest with the power to add new members, and the removal of members to the inner circle of selected meosk structures or weosk structures.

### Specification of the Brand for My Meosks Module of the System Network of the Present Invention

In FIGS. 65A through 65H, each GUI screen contains numerous unique and recognizable icons, as well as menu and list type graphical interface objects, which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities for (i) adding and removing brands to meosk and weosk structures, as well as (ii) managing the meosk master's gift wish for the meosk structure viewable by guest users of the meosk structure. The details of this module, its graphical interface objects, and corresponding services will be described in greater detail hereinafter.

FIG. 65A shows the Brands For My Meosk Module displaying a list of deployed meosk structures, of which the user is either a master or guest and inner circle member.

FIGS. 65B through 65C shows the Brands For My Meosk Module, and Christopher's FM Meosk, where the master user of Christopher's FM Meosk is displayed, from the master's user account, a list of favorite brands associated with this meosk structure to which the master user can Add Brands and/or Remove Brands to update the products and service offers that might be displayed in the Brand Channel of Christopher's FM Meosk, and brand messages that might be sent to the messaging center of Christopher's FM Meosk.

FIGS. 65D and 65E shows the Brands For My Meosk Module, and Christopher's FM Meosk, where the master user of Christopher's FM Meosk views the Gift Wish List for the meosk structure, to which the master user can Add Gifts, from which the master user can Remove Gifts and also Update The List as well, so that the updated Gift Wish List appears in the Gift-It widget presented in different locations within Christophe's FM Meosk.

FIG. 65F shows the Brands For My Meosk Module, and the Christopher's FM Meosk, where the guest user of Christopher's FM Meosk is displayed, from the guest user's account, (i) a list of brands selected by the meosk master to support the meosk structure, and (ii) Gift-It widget enabling the guest user to select and send a gift from a master-managed gift wish list, as well as a top trending gift list.

Alternatively, the gift-it function can be configured and set up within the meosk structure for the purpose of selling products and/or services offered by the meosk master to help promote, drive and support e-commerce transactions from within the activity-specific meosk structure. In such embodiments, the meosk master can drive e-ecommerce from within the meosk structure while moments in the album are used to market and sell products and/or services features in the displayed moments, and comments of others can be used to help create the marketing impression around the product and services.

FIGS. 65G and 65H show the Brands For My Meosk Module, and the Christopher's FM Meosk, where the guest user of Christopher's FM Meosk selects a “Baby Oshkosh Pants” gift for purchase from the online retailer amazon.com, and then supports the consumer transaction, with the gift receipt being automatically stored in the journal of Christopher's FM Meosk.

Specification of the Journey Book Module of the System Network of the Present Invention, and Methods of Producing Journey Books from Meosks

Referring to FIGS. 66A through 66K, the journey book module of the present invention will be described in greater detail. This feature and functionality of the system network 1 provides any meosk master the opportunity to use the print shop module illustrated in FIGS. 34A through 34E to create and publish “journey” books, based on the digital content stored in one or more meosk structures created and deployed on the system network. This can be for diverse purposes ranging from an individual's journey along an early stage of life, to family heritage building, to corporate research, recipe books, invention development, to spiritual journey storytelling. The applications are limitless. For purposes of illustration only, FIGS. 66A through 66K show how family members can produce journey books for the family's younger generation, namely, producing journey books that are filled with shared moments and contributions (e.g. attachments, notes, gift receipts, etc) made by extended family members. But this is simply one example given for purposes of illustration, and is not to be construed as any form of limitation.

In FIGS. 66A through 66K, each GUI screen contains numerous unique and recognizable icons, as well as menu and list type graphical interface objects, which, when selected, trigger server-side-driven, client-side-driven and/or client-server-driven processes and the generation and display of new or transformed GUI screens on client systems 8A, 8B, 8C. These GUI screens provide the master and/or guest users with the services/functionalities for the journey book deployed on the system network. The details of this module, its graphical interface objects, and corresponding services will be described in greater detail hereinafter.

The system network module, called the journey book module, also provides any system user with the capacity to (i) produce meosk-based media-rich books and compositions on any subject, organized by topic or year, and (ii) share these compositions with others having access to the system network. Each journey book contains a library of year and activity books created for one's child, grandchild, or oneself, using the print shop tool illustrated in FIGS. 34A through 34E, for example.

In alternative embodiments, these interactive meosk-based books and compositions might be printed out as hard copies bound and distributed to readers around the world, or generated in a pdf or like format for distribution as media-rich documents with hyperlinks to videos and audio files hosted from remote information servers deployed on the system network 1. The possibilities are endless with this meosk-based technology.

As shown in FIG. 66A, the story book module generates GUI screens that provide web-based (or native-application) generated interfaces for displaying illustrative storybooks (e.g. meosk-based journey books) on a mobile client device 8A, 8B, 8C deployed on the system network of the present invention. In the illustrative embodiment, each journey book comprises a header function menu displaying icons that provide access to a user login module, a user library module, a (user configuration) settings module, a search module, and a technical support module.

As shown in the GUI screen of FIG. 66B, after selection of the my library icon from the header function menu in FIG. 66A, the journey book module presents the user with the option of viewing storybooks either by year or storybooks by activity of the subject user. FIG. 66C shows a GUI screen supported by the illustrative storybook of FIGS. 66A and 66B, displaying storybooks by the year of the subject of the story book (e.g. Christopher). FIG. 66D shows a GUI screen displaying the subject user's “First Year” storybook, presenting a set of moments (and all linked messages, attachments, gifts and responses associated with each moment) in an album, from which to select one and review and experience the moment and its associated messages (e.g. voice, text and video message types supported), attachments, gifts sent and responses associated with the moment. FIG. 66E shows a GUI screen displaying the subject user's “First Year” storybook, presenting a selected moment, and linked messages, attachments, gifts and responses associated with the moment, for playback and review by the subject user and others with access authorization, to help build memories of past events captured in such moments.

FIGS. 66F and 66G show a series of GUI screens displaying storybooks by activity of the subject user. FIGS. 66H, 661 and 66J show a series of GUI screens displaying the subject user's “Trinity College” storybook, presenting a set of moments (and all linked messages, attachments, gifts and responses associated with each moment) in “my favorites” album, from which the user selects, reviews and experiences one moment (e.g. singing in Trinity College Chapel) and its associated messages (e.g. voice, text and video message types supported) by a particular friend/relative who shared, an attachment (e.g. a photo of the Knott Memorial Library at Union College), a gift (e.g. a digital sheet musical gift card) sent and responses associated with the moment).

Journey books produced on the system network of the present invention help turn moments into memories and bring memories of loved ones alive. These books also helps bring ones extended family together, regardless of where everyone is living. The possibilities are endless. Indeed, “sometimes you will never know the value of a moment until it becomes a memory” (Dr. Seuss).

Composing Diverse Kinds of Journey Books from Multiple Activity-Specific Meosk Structures Created and Deployed by a Particular User

The print shop module supported on the system network 1 also enables any meosk master to easily combine the stores of moments contained in different activity-specific meosk structures of a particular user into a single journey book that explores the different aspects of the individual's life. FIGS. 44C and 44D illustrate the meosk selection process for combination of moments into composite journey books on whatever topic might be related to the meosk structures involved in the publishing process.

The print shop module also allows a meosk master to compose a life-story meosk from multiple activity-specific meosks created and deployed by a particular individual user over a lifetime or part thereof. The content selected for such a composition will typically reflect the life story of the individual whose activity-specific meosks have been used to create the Life-Story Meosk. Preferably, the output format of the life-story meosk structure is HTML5, and viewed via the storybook module shown in FIGS. 66A through 66K because of the richness in graphical detail and interactivity that is made possible with this technology standard, but it is understood that other formats are possible including MS Word, PDF, and the like.

The print shop module also allows meosk masters to create and send journey books (based on composted activity-specific meosk structures of particular individual user) to a brand contact for review and consideration of particular offers that might be available to the meosk master or associated consumer. The method of communication of such journey books can be via the system network of the present invention, transmitted URLs, email, SMS and other digital methods available.

The print shop module also allows meosk masters to create and send journey books (based on composted activity-specific meosk structures of particular individual user) to a colleges and universities for review and consideration in connection with an admission application that has been or will be submitted. The method of communication of such journey books can be via the system network of the present invention, transmitted URLs, email, SMS and other digital methods available.

The print shop module also allows meosk masters to create and send journey books (based on composted activity-specific meosk structures of particular individual user) to a prospective employer for review and consideration in connection with an employment application that has been or will be submitted. The method of communication of such journey books can be via the system network of the present invention, transmitted URLs, email, SMS and other digital methods available.

The print shop module can even be to enable meosk masters (and others who have authority) to create obituaries and eulogies (based on composted activity-specific meosk structures) for those who have passed away, and there is a need to preserve their memories with family, friends and the overall community.

First Use Case Specification—Mother with Young Child Encouraged to Create, Deploy and Maintain First Moments (FM) Meosk Structures Deployed on the System Network Of The Present Invention

At this juncture it is appropriate to provide a first exemplary use case for the meosk/weosk-based private and public media management and communication system network of the illustrative embodiment. The exemplary use case considers a mother of a one-year old baby boy. She is married with a husband, and has a five year old daughter, a mother and a father, several brothers and sisters, a grandmother and a grandfather, many aunts and uncles, many cousins, nieces and nephews, many family members and friends, and a dear friend (named Consuela), all of whom is considered a member of her extended family. She has registered with the system network of the present invention 1, and has installed a mobile native client software application on her Apple iPhone and iPad to connect with and become a client subsystem 8A, 8B, 8C on the system network 1.

A first step in the exemplary use case, the mother (i.e. a master user) captures life's precious moments using one of the capture tools supported on the client side of the system network. Referring to FIGS. 67A, 67B and 67C, a series of GUI screens are shown supporting the my meosks module, and displaying the user interface to the First Moments (FM) Meosk created for a young child of a user (e.g. the mother's young child or caregiver's young child), and capturing and storing a new moment using the meosk structure's integrated video capture tool module, while her young child is experiencing a first moment in his or her life.

As a second step in the exemplary use case, the master user stores these moments securely in the “First Moments (FM)” Meosk which has been created for the first moments in her child's (i.e. Christopher's) life, and organized the way she thinks and lives. Referring to FIGS. 68A-1 through 68B-6, a series of GUI screens are shown supporting the my meosks module, and displaying the user (e.g. a mother of a young child) visiting her child's first moments (FM) meosk structure (e.g. Christopher's FM Meosk), selecting the moment that was captured and stored in the my album store of the meosk structure. Then as shown in FIGS. 68B-1 and 68B-2, she adds a note (e.g. message) to the captured moment, as well as an e-card to the moment in FIG. 68B-3, sending a gift in connection with the moment as shown in FIG. 68B-4, and then playing back and reviewing the moment and its associated messages, attachments and gifts, as shown in FIGS. 68B-5 and 68B-6. She may also choose to add some additional photos and videos to complete the moment.

In the illustrative embodiment, shown in FIG. 68B-1 through 68B-4, the master user, as well as each family member who is asked to contribute to a shared moment within the exemplary meosk structure, is provided with assistance on the system network. Such assistance can be delivered by programmed artificial intelligence (AI)-based agents, embedded in the GUI screens of the meosk module and the weosk module, and providing the user with help, guidance and suggestions in making meaningful contributions to any given moment before them. Specifically, these AI-based agents can be designed to provide users with concierge-type services designed to help them (i) find the right words for messages, (ii) select the right e-cards and gifts to celebrate special moments, events and occasions, and (iii) automatically translate the language of the user's messages into the languages spoken by the members of the user's extended family structure.

As a third step in the exemplary use case, the master user shares the special moment with those who care across the inner circle of her child's FM Meosk, created, deployed and operated by the meosk master trustee, on behalf of her beneficiary child.

Referring to FIG. 69, a GUI screen is shown supporting the my meosks module, and displaying the user (e.g. the mother of a young child) visiting her child's FM meosk structure (e.g. Christopher's FM Meosk), where the user selects a particular moment stored in the my album of the meosk structure, and then decides to selects the share-it function to share this once privately maintained moment in a private FM meosk structure, with other selected members of the meosk structure's inner circle. The sharing function will be carried out by way of any and all of the methods of moment sharing supported on the system network of the present invention including, for example, HTTP/SMS/MMS based internal message sharing (IMS), SMS and email techniques supported by most conventional smart phones (e.g. Apple iPhone, Google Android devices, etc.).

FIG. 70 illustrates that there are three different methods of messaging communication supported on the system network of the present invention, including the protocols SMS, email (POP/IMAP) and SMS/MMS over http for internal messaging among messaging center modules supported on the system network 1. It is understood that there are many other messaging protocols that may be supported among client subsystems 8A, 8B, 8C deployed on the system network, across the different layers of the ISO communication model, incorporated herein by reference

Referring to FIG. 71, a social network illustration is shown comprising an inner circle of extended family members who have access rights to a meosk structure (i.e. subsystem) deployed on the system network of the present invention, in this case, by a parent mother for a child in a trustee-based relationship, as illustrated in FIG. 5D. As shown in the schematic diagram, this particular inner circle of family members and friends in the parent's family ecosystem is organized into a “his” inner family member circle, and a “her” inner family member circle for the family structure involved in this illustrative exemplary with the understanding than many different types and styles of family structures can be represented within and supported by the system network of the present invention, in accordance with the lifestyle and values of the diverse family members involved.

Notably, the method or methods of communication which the system will automatically use to share a moment or message, as the case may be, will depend on which methods of communication (e.g. email, SMS, and/or IMS—for registered master users of the system network) the meosk or weosk master identified for the invited inner circle member, at the time of inner circle member invitation. Notably, such inner circle member invitations can be made at the time a particular meosk structure is created, or any time thereafter, when the inner circle membership is extended or reduced by the meosk master. A during the first invitation to a meosk inner circle or a weosk inner circle, by email and/or SMS, the invited user will be asked to join the meosk structure or weosk structure, as the case may be, and subscribe to the terms and conditions of the system network, afterwards, a system network user name and password will be assigned and confirmation carried out using email address verification in a manner known in the art.

Referring to FIGS. 72A and 72B, a quick comparison can be made between GUI screens to reveal that all core meosk structure and weosk structure related functions supported in “native” mobile implementations of mobile client subsystems 8A, 8B and 8C are also supported in “web browser” mobile implementations of these mobile client subsystems 8A, 8B and 8C.

Specifically, referring to FIG. 72A, there is shown a GUI screen generated from a “native” mobile implementation of the client component of the system network, written in a native computer programming language (e.g. Objective-C for Apple IOS, Java for Android, and C for Microsoft) executing on a mobile operating system (OS), such as Apple IOS, or Google Android OS, or Microsoft CE, etc, supporting the my meosks module, and displaying the entire suite of functions (i.e. favor-it, play-it, note-it, gift-it, attach-it, share-it, grab-it and post-it) supported by the application within any meosk structure, or weosk subsystem network, created and deployed on the system network of the present invention of the illustrative embodiment. Similarly, referring to FIG. 72B, there is shown a GUI screen generated from a “web-browser” mobile implementation of the client component of the system network, written in a conventional mark-up language, such as HTML5 or alternative language, running within the web-browser application (e.g. Apple Safari, MS Explorer, Mozilla Firefox, etc) executing on a mobile operating system (OS), such as Apple IOS, or Google Android OS, or Microsoft CE, etc, and supporting the my meosks module, and displaying the entire suite of functions (i.e. favor-it, play-it, note-it, gift-it, attach-it, share-it, grab-it and post-it) supported by the application within any meosk structure, or weosk subsystem network, created and deployed on the system network of the present invention of the illustrative embodiment. Notably, the same set of core meosk and weosk functions are supported in both kinds of client subsystem implementations.

For purposes of illustration, the exemplary use case will be continued now with descriptions of the different techniques which the system network of the present invention supports to provide robust and very flexible communication reach with all inner circle members of meosk structure and weosk structure deployed on the system network of the present invention.

### Inner Circle Members Receiving and Reviewing a Request to View Shared Moment Using the Internal Messaging Services (IMS) of the Native Mobile Application Implemented Client Subsystem Supported by the System Network of the Present Invention

As a fourth step in the exemplary use case, a guest user (e.g. the child's grandmother) can receive and review a shared moment, using the internal messaging services (IMS) of the native mobile application implemented client subsystem supported by the system network of the present invention.

Referring to FIG. 73A, a GUI screen is shown supporting the my meosks module within the system network, where a first user displays a FM Meosk subsystem and selects to share a moment with one or more members of the meosk inner circle using the IMS method supported by a native mobile application implementation of the client subsystem 8A, 8B, 8C deployed on the system network 1.

Referring to FIGS. 73B-1 through 73B4, a series of GUI screens are shown supporting the message center module within the system network, where a second user, within the selected inner circle to which the moment is sent in FIG. 73A, receives in a notification in the Message Center shown in FIG. 73B-1 as to the moment shared by the first user in FIG. 73A, and the second user views this moment by selecting “Do It” in FIG. 73B-1, automatically taking the second user to the my meosks module shown in FIG. 73B-2 where the moment is displayed in the appropriate meosk structure (e.g. Christopher's FM Meosk) and the second user is allowed to play back the moment as shown in FIG. 73B-3, as well as add or contribute to the moment using the various functions displayed in FIG. 73B-4.

### Inner Circle Members Receiving and Reviewing a Request to View Shared Moment Using SMS and the Mobile Web Browser Application Implemented Client Subsystem Supported by the System Network of the Present Invention

As a fourth step in the exemplary use case, a guest user (e.g. the child's grandmother, aunt, uncle, et al) can receive and review a shared moment, using SMS and a mobile web browser implemented client subsystem 8A, 8B, 8C supported by the system network of the present invention.

Referring to FIG. 74A, a GUI screen is shown supporting the my meosks module within the system network, where a first user displays a FM Meosk subsystem and selects to share a moment with one or more members of the meosk inner circle using the SMS-based method supported on the system network.

FIGS. 74B-1 through 74B4 show a series of GUI screens illustrating the SMS client application on a mobile client device, operated by a second user within the selected inner circle to which the moment is sent in FIG. 74A, receiving an SMS message from an SMS gateway server supported on the system network as shown in FIGS. 1A, 1B and 74B-1 regarding the moment shared by the first user in FIG. 74A, and where the second user views this moment by selecting “VIEW MOMENT” html tag (URL) in the SMS message, as shown in FIG. 74B-1, automatically launching the web browser application on the mobile client device of the second user as shown in FIG. 74B-2 where the web application is executed and displayed in the web browser and the shared moment is displayed in the appropriate meosk structure (e.g. Christopher's FM Meosk) and the second user is allowed to play back the moment as shown in FIG. 74B-3, as well as add or contribute to the moment using the various functions displayed in FIG. 74B-4.

### Inner Circle Members Receiving and Reviewing a Request to View Shared Moment Using Email and the Mobile Web Browser Application Implemented Client Subsystem Supported by the System Network of the Present Invention

As a fourth step in the exemplary use case, a guest user (e.g. the child's grandmother, aunt or uncle) can also receive and review a shared moment using email and a mobile web browser implemented client subsystem 8A, 8B, 8C supported by the system network of the present invention.

Referring to FIG. 75A, a GUI screen is shown supporting the my meosks module within the system network, where a first user displays a FM Meosk subsystem and selects to share a moment with one or more members of the meosk inner circle using the Email-based method supported on the system network.

Referring to FIGS. 74B-1 through 74B4, a series of GUI screens are shown illustrating the e-mail client application on a mobile client device, operated by a second user within the selected inner circle to which the moment is sent in FIG. 74A, receiving an email message from an email server supported on the system network as shown in FIGS. 1A, 1B and 74B-1 regarding the moment shared by the first user in FIG. 74A, and where the second user views this moment by selecting “VIEW MOMENT” html tag (URL) in the email message, as shown in FIG. 74B-1, automatically launching the web browser application on the mobile client device of the second user as shown in FIG. 74B-2 where the web application is executed and displayed in the web browser and the shared moment is displayed in the appropriate meosk structure (e.g. Christopher's FM Meosk) and the second user is allowed to play back the moment as shown in FIG. 74B-3, as well as add or contribute to the moment using the various functions displayed in FIG. 74B-4.

Inner Circle Members Responding to a Request to View Shared Moment Using the “Add to” the Moment Functions Accessed Via Internal Messaging Services the Native Mobile Application Implemented Client Subsystem Supported by the System Network of the Present Invention

As a fifth step in the exemplary use case, the guest user (e.g. the child's grandmother, aunt, uncle et al) can respond to the shared moment using the “add to” the moment functions accessed via internal messaging service (IMS) (e.g. http/tcp/ip) supported in a native mobile application implemented client subsystem 8A, 8B, 8C supported by the system network of the present invention.

Referring to FIGS. 76A-1 and 76A-2, a series of GUI screens are shown supporting the my meosks module within the system network, where within Christopher's FM Meosk, a third user who is a member of the inner circle of the meosk reviews the moment captured and message/note created by Christopher's mother (i.e. the meosk master) and decides to contribute to the moment by selecting the note-it function supported in the GUI shown in FIG. 76A-2.

Referring to FIGS. 76B-1 through 76B-3, a series of GUI screens are also shown supporting the my meosks module within the system network, where within Christopher's FM Meosk, the third user contributes to the moment selected in FIGS. 76A-1 by creating and linking a note to the moment as shown in FIGS. 76B-1, then sending the meosk structure's subject (e.g. Christopher) a gift as shown in FIG. 76B-2, and thereafter reviewing the note and gift associated with the moment as shown in FIG. 76B-3.

Inner Circle Members Responding and Contributing to a Request to View Shared Moment Using the “Add to” the Moment Functions Accessed Via SMS and Email and Mobile Web Browser Application Implemented Client Subsystems Supported by the System Network of the Present Invention

As a fifth step in the exemplary use case, the guest user (e.g. the child's grandmother, aunt, uncle et al) can also respond to the shared moment using the “add to” the moment functions accessed via SMS or Email supported in a mobile web browser application implemented client subsystem 8A, 8B, 8C supported by the system network of the present invention. These two alternative options will be described in detail below with reference to FIG. 77 through

FIG. 77 is a schematic representation illustrating how any inner circle member of a meosk structure deployed on the system network of the present invention can use a mobile smart phone or like device to (i) receive a request to view a shared moment via an SMS message using the smart phone's SMS client application, or an email message using the smart phone's email client application, (ii) then use the smart phone and its web browser to access and view the shared moment stored within its meosk structure, and “play back” (i.e. review) the moment and its associated notes, attachments, gift receipts, and other messages using the play-it function supported in the web-browser based client application, and (iii) thereafter use the web browser application to add or contribute to the moment using any of the eight core functions supported by the client-server based system network of the present invention.

Inner Circle Members Responding and Contributing to a Request to View Shared Moment Using the “Add to” the Moment Functions Accessed Via Email and Mobile Web Browser Application Implemented Client Subsystems Supported by the System Network of the Present Invention

As a fifth step in the exemplary use case, the guest user (e.g. the child's grandmother, aunt, uncle et al) can also respond to the shared moment using the “add to” the moment functions accessed via Email supported in a mobile web browser application implemented client subsystem 8A, 8B, 8C supported by the system network of the present invention.

Referring to FIGS. 78A-1 through 78-A7, a series of GUI screens are shown supporting the web-browser implementation of the system network of the present invention, where any inner circle member of a meosk structure can use a mobile smart phone to (i) receive a request to view a shared moment via an email message using the smart phone's email client application as shown in FIG. 78A-1, (ii) then use the smart phone and its web browser to access and view the shared moment stored within its meosk structure on the system network of the present invention as shown in FIGS. 78A-1 and 78A-2, and “play back” (i.e. review) the moment and its associated notes, attachments, gift receipts, and other messages using the play-it function supported in the web-browser based client application as shown in FIGS. 78A-2 and 78A-3, and (iii) thereafter use the web browser application to add or contribute to the moment using any one or more of the eight core functions supported by the client-server based system network, as shown in FIG. 78A-4, including adding a note (e.g. voice, text and/or video message) to the moment as shown in FIG. 78A-5, and then reviewing the message as shown in FIGS. 78A-7 and 78A-7.

Inner Circle Members Responding and Contributing to a Request to View Shared Moment Using the “Add to” the Moment Functions Accessed Via SMS and Mobile Web Browser Application Implemented Client Subsystems Supported by the System Network of the Present Invention

As a fifth step in the exemplary use case, the guest user (e.g. the child's grandmother, aunt, uncle et al) can also respond to the shared moment using the “add to” the moment functions accessed via SMS supported in a mobile web browser application implemented client subsystem 8A, 8B, 8C supported by the system network of the present invention.

Referring to FIGS. 79A-1 through 79-A8, a series of GUI screens are shown supporting the web-browser implementation of the system network of the present invention, where any inner circle member of a meosk structure can use a mobile smart phone to (i) receive a request to view a shared moment via an SMS message using the smart phone's SMS client application as shown in FIG. 79A-1, (ii) then use the smart phone and its web browser to access and view the shared moment stored within its meosk structure on the system network of the present invention as shown in FIGS. 79A-1 and 79A-2, and “play back” (i.e. review) the moment and its associated notes, attachments, gift receipts, and other messages using the play-it function supported in the web-browser based client application as shown in FIGS. 79A-2 and 79A-3, and (iii) thereafter use the web browser application to add or contribute to the moment using any one or more of the eight core functions supported by the client-server based system network, as shown in FIG. 79A-4, including adding a note (e.g. voice, text and/or video message) to the moment as shown in FIG. 79A-5, and then reviewing the message as shown in FIGS. 79A-6 through 79A-8.

Create and Deploy Weosks to Help Capture, Store and Share the Moments of all Group Activity Participants, Allowing them to Post and Share Photos and Videos of Others Engaging in their Activity

In the exemplary use case, the mother's 5 year old daughter, Giselle, is a member of a local soccer team. For each child player, there is at least one parent participant, creating a dynamic social environment around the children's soccer team activities, and the opportunity for capturing moments and messages from the group's participants. So, it is desirable to see that a soccer team weosk is created, as shown in FIGS. 47A through 59E, and 61A through 61DD, to help her and other parents capture, store and share the moments of all group activity participants, allowing them to post and share photos and videos of children and others engaging in their activity. The soccer team weosk can be shared among the team's inner circle, as shown in FIG. 48C-1, with the freedom everyone needs.

Using the “Grab-it” Function Supported within Each Meosk Subsystem Deployed on the System Network, to Grab a Moment from any Social Network or Photo-Sharing Site and Copy it to a Destination Meosk Deployed on the System Network of the Present Invention

As a sixth step in the exemplary use case, master and guest users can use the grab-it function supported within each meosk structure deployed on the system network, and a grab a moment on a social network site or photo-sharing site, and copy it to a destination meosk deployed on the system network of the present invention. This grab-it function will be convenient in many circumstances.

For example, consider that the mother master user, in the exemplary use case example, who receives a Facebook notification that she and her baby boy have been tagged In a photo posted on her cousin's Facebook Timeline. As the system network of the present invention is interfaced with most social media and photo-sharing sites, including the Facebook Social Network, she “grabs” this photo from her cousin's Facebook Timeline, using Grab-It and copies this moment directly into Christopher's FM Meosk, and then attaches the photo to her shared “First Birthday” Moment, contributing further to this special memory.

Using the “Grab-it” Function Supported within Each Weosk Structure Deployed on the System Network, to Grab a Moment and Copy it to a Destination Meosk Deployed on the System Network of the Present Invention

As a sixth step in the exemplary use case, master and guest users can use the grab-it function supported within each meosk structure deployed on the system network, and a grab a moment on a social network site or photo-sharing site, and copy it to a destination meosk deployed on the system network of the present invention.

Referring to FIGS. 80A and 80B, a series of GUI screens are shown supporting the my meosks module of the system network, where the user selects the “grab-it” function supported within each meosk structure deployed on the system network, and then selects from where to grab and copy a moment (e.g. my meosk structures, my social networks or my photo-sharing sites) and then store the copied moment(s) to a destination meosk structure.

Referring to FIG. 80C, a GUI screen is shown supporting the my weosk module of the system network, displaying the soccer team weosk created by a weosk master, and having an inner circle of members who are parents of the players, one of which is the child of the exemplary user who is the parent of Christopher, the subject of Christopher's FM Meosk illustrated in the illustrative embodiment. FIG. 80D illustrates an inner circle of members having access to the weosk structure shown in FIG. 80C, including the soccer team coach, the parent of each player on the soccer team, and each player on the soccer team.

Inner Circle Members Contributing to a Moment Stored in a Weosk Shared Album Using the “Add to” the Moment Functions Accessed by Mobile Native and Web Browser Application Implemented Client Subsystems Supported by the System Network of the Present Invention

Once a weosk subsystem has been deployed on the system network, fortunately any inner circle member of the weosk can contribute to any moment stored in the shared album of the weosk structure, using the “add to” the moment functions accessed by mobile native and web browser application implemented client subsystems supported by the system network of the present invention. Such moment contribution functions in weosks are similar to those supported in meosks described above.

In the exemplary use case, the soccer coach of the meosk master's daughter Giselle, desires to contribute with a personal message to a particular moment she sees in the soccer team weosk (e.g. “Hi Giselle, Just want you to know that having you on our team has been a great pleasure for me as a coach, and all your team mates. Your positive attitude and kindness towards everyone is greatly appreciated and lifts everyone's spirits. Thank you for being you! Coach Smith”)

Referring to FIGS. 81A and 81B, a series of GUI screens are shown supporting the my weosks module of the system network, where the weosk master user is shown selecting and reviewing the voice/text message created, in this exemplary use case, by Giselle's soccer team coach (i.e. Coach Smith) for a specific moment stored in the shared album of the weosk structure. Such contributions to stored moments will occur naturally and frequently in weosk structures deployed on the system network of the present invention.

Selecting and Tagging Particular Moments in a Weosk Structure for Automatic Copying into Specific Storage Locations in a Specified Meosk Structure Deployed of the System Network of the Present Invention

Referring to FIG. 82, there is shown a cover GUI screen for the soccer team weosk shown in FIG. 80C, and a cover GUI screen for the personal soccer meosk created for one of the players. Referring to this schematic representation, there illustrated a process, whereby an inner circle member of the weosk structure (e.g. soccer team parent) selects and tags particular moment(s) stored in the weosk structure to be automatically copied over into specific storage locations in the personal soccer meosk by programmably-controlled operation of the system network.

In the exemplary use case, the meosk master mother “grabs” the moments relating to her daughter and her coach's inspiring message, and other moments and attached message which she likes in the soccer team's weosk (which may have been captured by other parents), and then automatically copies them into her child's my soccer meosk structure, so as to capture these moment forever in her private soccer meosk structure.

After such grabbed media moments are tagged and copied into the user's meosk moment stores, the meosk user is free to share these moments with the meosk inner circle, which is typically different than the inner circle for the weosk structure from which the grabbed moments were copied. So in the exemplary use case, the meosk master mother shares the grabbed and copied moments with her extended family their contributions and thoughts of support and love

FIG. 83 illustrates an inner circle of family and friends enjoying access to the meosk structure shown in FIG. 82, wherein each member has access to all the moments and linked messages, attachments, gift receipts and the like associated therewith, to help them build a robust memory around this moment (e.g. event) and others captured and stored moments in the life of the meosk subject.

### Inner Circle Members Sharing Moments Via SMS or Email and Mobile Web Browser Application Implemented Client Subsystems Supported by the System Network of the Present Invention

As a seventh step in the exemplary use case, the guest users (e.g. the child's grandmother, aunt, uncle et al) have multiple ways of sharing moments with the meosk master mother (i.e. master user) using SMS or email supported in a mobile web browser enabled client subsystem 8A, 8B, 8C supported by the system network of the present invention. These techniques will allow family members such as a grandmother, a grandfather, aunts and uncles and others to share moments (e.g. photographs, videos etc) with the meosk master(s) to help them build family memories and younger generation awareness of those family members who have contributed to their lives, at some time or another.

Referring to FIG. 84, there is shown a schematic representation illustrating that any inner circle member of a meosk structure deployed on the system network of the present invention can use a mobile smart phone or like device (i.e. client subsystem) to send a captured moment(s) (e.g. photographs, sound recordings, videos, etc) to the moment storage bin (i.e. “Bin”) of a specific meosk master, in a user-transparent manner, by way of either two different techniques, namely: (i) an SMS message sent to the meosk master's user-specific SMS number (assigned to the master by the system admin during user registration) using the SMS client application on the master's smart phone, or (ii) an email message sent to the meosk master's user-specific email number (assigned to the master by the system admin during user registration) using the email client application on the master's smart phone. After automated SMS/email message routing, handling and processing by the system network using the subsystem illustrated in FIGS. 2A, 2B, 2E and 2F, and upon arrival of the sent moment in the master's bin, a notification of a shared moment is transmitted to the message center of the master's client system (i.e. smart phone), and thereafter, the meosk master can access the bin and decide how to handle the received moment shared by the inner circle member (e.g. delete the moment or move it to one or more specific meosk storage locations. Each of these different methods will be described in greater detail below.

### Inner Circle Members Sharing Moments Via SMS and Mobile Web Browser Application Implemented Client Subsystems Supported by the System Network of the Present Invention

As a seventh step in the exemplary use case, the guest users (e.g. the child's grandmother, aunt, uncle et al) can share moments with meosk masters (i.e. master users) using SMS supported in a mobile web browser enabled client subsystem 8A, 8B, 8C wirelessly interfaced with the system network of the present invention.

FIGS. 85A-1 through 85B-3 show a series of GUI screens displayed on the mobile smart phone of a user who uses the integrated camera aboard the mobile smart phone to capture a photograph, sound recording or video of a special moment and uses its SMS client application, shown in FIG. 85A-4. The purpose is to send the captured moment(s) to a user-specific SMS number that is associated with a registered user and his/her mailbox hosted on the SMS gateway server supported by the system network, as illustrated in FIGS. 2E and 2F, so that the SMS gateway server can process the SMS message and retrieve the associated moment and transmit it to the bin of the client application of the intended registered user, as shown in FIG. 85B-1. Thereafter, the user can move the retrieved moment to a specified location in a particular meosk structure on the user's my meosk list, as shown in FIG. 85B-2, for eventual playback and review as illustrated in FIG. 85B-3.

### Inner Circle Members Sharing Moments Via Email and Mobile Web Browser Application Implemented Client Subsystems Supported by the System Network of the Present Invention

As a seventh step in the exemplary use case, the guest users (e.g. the child's grandmother, aunt, uncle et al) can share moments with meosk masters (i.e. master users) using email supported in a mobile web browser enabled client subsystem 8A, 8B, 8C wirelessly interfaced with the system network of the present invention 1.

Referring to FIGS. 86A-1 through 85B-3, a series of GUI screens are shown displayed on the mobile smart phone of a user using the camera roll (i.e. image store) of the integrated camera aboard the mobile smart phone to provide a photograph or video of a special moment, and its email client application to send the moment, as shown in FIG. 86A-3. The purpose is to send the captured moment(s) to a user-specific email number that is associated with a registered user and his/her mailbox hosted on the email server 13 supported by the system network 1, as illustrated in FIGS. 2A and 2B. The purpose of the email server 13 is to process the email message and retrieve the associated moment and transmit it to the bin of the client application of the intended registered user, as shown in FIG. 85B-1. Thereafter, the user can move the retrieved moment to a specified location in a particular meosk structure on the user's my meosk list, as shown in FIG. 86B-2, for eventual playback and review as illustrated in FIG. 86B-3.

Inner Circle Members Sharing Moments with Multiple Meosk Master Users Using the Email or SMS Based General-Message Delivery Service and Email or SMS Enabled Client Subsystems Supported by the System Network of the Present Invention

As an eighth step in the exemplary use case, inner circle members of meosk structures, who are guest users (e.g. the child's grandmother, aunt, uncle et al) can share moments with multiple meosk masters (i.e. master users) using the email or SMS based general-message delivery service supported by the system network, as illustrated in FIGS. 2C and 2D, and 2G and 2H, respectively, and accessed by an email or SMS enabled client subsystem 8A, 8B, 8C wirelessly interfaced therewith. Using such system network supported services, any inner circle member can use regular email or text/SMS services to attach photos, audio files and messages to shared moments, to any specific system user.

Referring to FIG. 87, a schematic representation is shown illustrating how any inner circle member of a meosk structure (i.e. subsystem) deployed on the system network of the present invention 1 can use a mobile smart phone or other computing device 8A, 8B, 8C to send a captured moment(s) (e.g. photographs, sound recordings, videos, etc) to the moment storage bins (i.e. “Bins”) of any number of specific meosk masters, in a user-transparent manner. This can be achieved by way of either (i) an SMS message sent to the “general-delivery” SMS number (assigned to the system by the system admin) using the SMS client application on the master's smart phone, or (ii) an email message sent to the “general-delivery” email number (assigned to the system by the system admin) using the email client application on the master's smart phone. Using this message delivery service, after automated SMS/email message routing, handling and processing by the system network using the subsystem illustrated in FIGS. 2C, 2D 2B, 2G, 2H, the user is automatically sent an SMS message, or email message, containing an embedded web-link (i.e. URL) pointing to a web page listing all master users of meosk structures, of which the user is an inner circle member, and requesting that the user decide and select the meosk masters to whom the attached moment(s) should be routed and sent. After sending the user a confirmation email message that the user's message/moment routing selections have been accepted and implemented, each selected meosk master is notified (by a notification message sent to the user's message center) that a moment has been sent to their bin, for access and retrieval and subsequent deletion or movement to an appropriate meosk structure, using the system network of the present invention.

Inner Circle Members Sharing Moments with Multiple Meosk Master Users Using the Email Based General-Message Delivery Service and Email Enabled Client Subsystems Supported by the System Network of the Present Invention

As an eighth step in the exemplary use case, inner circle members of meosk structures, who are guest users (e.g. the child's grandmother, aunt, uncle et al) can share moments with multiple meosk masters (i.e. master users) using the email based general-message delivery service supported by the system network, as illustrated in FIGS. 2C and 2D, and accessed by an email enabled client subsystem 8A, 8B, 8C wirelessly interfaced therewith.

Referring to FIGS. 88A-1 through 88B-2, a series of GUI screens are shown illustrating how any inner circle member of a meosk structure deployed on the system network of the present invention can use a mobile smart phone or like device to send a captured moment(s) (e.g. photographs, sound recordings, videos, etc) to the moment storage bin (i.e. “Bin”) of any number of specific meosk masters, in a user-transparent manner, by way of an email message sent to the “general-delivery” email address (assigned to the system by the system admin) using the email client application on the master's smart phone. Using this method, after automated email message routing, handling and processing by the system network using the subsystem illustrated in FIGS. 2C and 2D, the user is automatically sent an email message, as shown in FIG. 88A-2, containing an embedded web-link (i.e. URL) pointing to a web page displayed in the user's web browser, as shown in FIG. 88A-3, and listing all master users of meosk structures, of which the user is an inner circle member, and requesting that the user decide and select the meosk masters to whom the attached moment(s) should be sent. After sending the user a confirmation email message that the user's message/moment routing selections have been accepted and implemented, as shown in FIG. 88A-4, each selected meosk master is notified by a notification message sent to the message center, as shown in FIG. 63C, informing that a moment has been sent to their bin, as shown in FIG. 88B-1, for access and retrieval and subsequent deletion or movement to an appropriate meosk structure, as shown in FIG. 88B-2, using the system network of the present invention 1.

Inner Circle Members Sharing Moments with Multiple Meosk Master Users Using the SMS Based General-Message Delivery Service and SMS Enabled Client Subsystems Supported by the System Network of the Present Invention

As an eighth step in the exemplary use case, inner circle members of meosk structures, who are guest users (e.g. the child's grandmother, aunt, uncle et al) can share moments with multiple meosk masters (i.e. master users) using the SMS based general-message delivery service supported by the system network, as illustrated in FIGS. 2G and 2H, and accessed by an SMS enabled client subsystem 8A, 8B, 8C wirelessly interfaced therewith.

Referring to FIGS. 89A-1 through 89B-2, a series of GUI screens are shown illustrating how any inner circle member of a meosk structure (i.e. subsystem) deployed on the system network of the present invention can use a mobile smart phone or like device 8A, 8B, 8C to send a captured moment(s) (e.g. photographs, sound recordings, videos, etc) to the moment storage bin (i.e. “Bin”) of any number of specific meosk masters, as shown in FIGS. 42A through 42C, in a user-transparent manner, by way of a SMS message sent to the “general-delivery” SMS number (assigned to the system by the system admin) using the SMS client application on the master's smart phone. Using this method, after automated SMS message routing, handling and processing by the system network 1 using the subsystem illustrated in FIGS. 2G and 2H, the user is automatically sent an SMS message, as shown in FIG. 88A-2, containing an embedded web-link (i.e. URL) pointing to a web page displayed in the user's web browser, as shown in FIG. 88A-3, and listing all master users of meosk structures, of which the user is an inner circle member, and requesting that the user decide and select the meosk masters to whom the attached moment(s) should be sent. After sending the user a confirmation SMS message that the user's message/moment routing selections have been accepted and implemented, as shown in FIG. 89A-4, each selected meosk master is sent a notification that a moment has been sent to their bin, as shown in FIG. 88B-1, for access and retrieval and subsequent deletion or movement to an appropriate meosk structure, as shown in FIG. 88B-2, using the system network of the present invention 1.

### Method of Transferring a Trustee User Account to System User Account Maintained on the System Network of the Present Invention

Referring FIGS. 90A, 90B and 90C-1, a system user who has been a trustee user creating and managing meosk structures and weosk structures on behalf of a beneficiary (e.g. a child, grandchild or adult) can use the system network of the present invention to transfer its trustee user account(s), illustrated in FIG. 5D, to several possible system user account destinations. Such possible destinations include: (i) the beneficiary's active system user account on the system network when the beneficiary has capacity or otherwise older enough to handle such matters; and (ii) another trustee system user account, associated with another who will be responsible for taking over the managing of the beneficiary's trustee user account, including the meosk structures and weosk structures contained therein, along with their associated inner circles of friends and family members.

To transfer a trustee user account, the system user accesses the settings module from the footer control panel, available from any GUI screen displayed on the system network 1. As shown in FIGS. 90A and 90B, the settings module is accessed to display the trustee account transfer panel, from which the system user accesses the trustee account transfer module and displays its GUI display in FIG. 90C-1.

As shown in FIGS. 90C-1 and 90C2, the trustee account transfer module is displayed, and the system user selects (i) a particular trustee user account (e.g. Trustee User Account C for Beneficiary User C) and then (ii) the beneficiary system user (or alternative trustee system user) from the pull down menu list. Thereafter, the current trustee system user selects the transfer button and then automatically the system network transfers the selected Trustee User Account to its beneficiary system user account. As shown in FIG. 90C-2, the trustee system user retains copies of all meosk structures and weosk structures associated with the transferred trustee user account. In FIG. 90C-3, the trustee system user (i) retains copies of all meosks and weosks associated with the transferred trustee user account, and (ii) is made a joint master user of the transferred user account, including all meosk structures and weosk structures contained therein, and new meosk structures and weosk structures which might be created and deployed after the trustee account transfer process on the system network of the present invention.

As shown in FIG. 90C-4, the trustee system user selects another, different trustee user account (e.g. Trustee User Account D for Beneficiary User D) and beneficiary system user (e.g. Beneficiary System User D) so that the trustee system user can transfer this Trustee User Account back to this selected beneficiary who is now a system user and capable of managing this trustee user account, and its meosk structures and weosk structures, within the beneficiary's system user account. Notably, in this example, the trustee system user (i) retains copies of all meosks and weosks associated with the transferred trustee user account, and (ii) is made a joint master user of the transferred user account, including all meosk structures and weosk structures contained therein, and new meosk structures and weosk structures which might be created and deployed after the trustee account transfer process on the system network of the present invention.

By virtue of this user account management feature of the present invention, system users can automatically create trustee user accounts for beneficiaries (e.g. young children, grandchildren, grandparents and others in need) during the “create new meosk” process. During this account creation process, the trustee user account is automatically linked to the personal user account of the system user functioning as a trustee of sorts on behalf of the beneficiary, as illustrated in FIG. 5D, and the trustee user can create and deploy any number of meosks and weosks for the beneficiaries, managed under this linked trustee user account. Then, at some time in the future, the trustee system user can transfer the trustee user account to the beneficiary when they are ready to manage the user account on their own behalf, or another substitute trustee system user who is willing to assume the responsibility of managing the trustee account, and the meosk structures and weosk structures created thereunder. When a beneficiary is ready to take control and management of his or her trustee user account on the system network of the present invention, will depend on each beneficiary, trustee system user, and the family structure in which they live. Alternatively, the trustee system user can retain joint custody of a trustee user account, and thus act as joint masters to each and every meosk structure and weosk structure that is maintained within the transferred trustee user account, subject to retained right to be a joint system user with respect to the transferred trustee account and the meosks and weosks managed therein.

In the illustrative embodiment, it is also contemplated that the meosk structures and weosk structures maintained within a trustee user account, or any ordinary system user account supported on the system network, can be transferred to a designated user of a social network account (e.g. Facebook, Google+, etc) that supports an application programming interface (API) that can be used receive a meosk structure or weosk structure, in an appropriate format and schema (e.g. XML or other proprietary format). The objective of the meosk structure/module transfer would be so that the meosk structure, and all of its media and message content, can be seamlessly imported into the RDBMS of the social network and then be viewed and used as desired within the operating framework of the social network. The designated user of the social network could be the user and owner of the meosk structure to be transferred, or to someone else who the system user wishes to enjoy the digital content contained in the meosk structure being transferred. Preferably, the social network will provide the user with the option to grab, copy and use moments and messages and other files associated with the transferred/imported meosk structure, in the social network application.

### Method of Creating and Deploying Activity-Specific Meosk Structures on the System Network of the Present Invention, Using a Robust Library of Object-Oriented Program Classes Supported by the System Network

FIGS. 91A through 91D, taken together, provide a flow chart describing the primary steps of the method of creating and deploying activity-specific meosk structures (i.e. subsystems) on the system network 1 of the present invention, using a robust set of object-oriented program classes supported by the system network and identified in FIGS. 5A-1 through 55C-1, where the objects comprising the object-oriented system of the present invention are instances of classes within the set of classes.

As shown in FIGS. 91A through 91D, a novel method of creating and deploying an activity-specific meosk structure (i.e. subsystem) on the meosk-based private and social media management and communication system network 1 is described in great detail. As shown, the meosk-based private and social media management and communication system network 1 supports system database (RDBMS) 5. Each activity-specific meosk structure stores one or more moments (i.e. digital assets), and one or more messages associated with each stored moment. Each activity-specific meosk structure has an inner circle of members who have the right to access and review the moments and messages organized and managed in the activity-specific meosk structure, by way of communication techniques exercised over the system network, and to contribute messages and moments to the activity-specific meosk structure as allowed by the meosk master. Also, each activity-specific meosk structure has at least one message communication facility (e.g. a brand channel as shown in FIG. 36B and/or local messaging center as shown in FIG. 38B) for communicating product and/or service marketing messages from brands to the master user, which the master user has requested to contact the master user through the communication facility of the activity-specific meosk structure.

As indicated at Block A in the flow chart of FIG. 91A, during the first step of the method, the system network 1 displays a GUI to the master user, for creating and deploying an activity-specific meosk structure on the system network.

As indicated at Block B in FIG. 92A, the system network 1 displays a GUI requesting the master user to select a field of interest about which the master user or beneficiary user is passionate, and that is to be associated with the activity-specific meosk structure to be created and deployed on the system network.

As indicated at Block C in FIG. 92B, the system network 1 displays a GUI requesting the master user, within the selected field of interest, to select a specific activity for which the master user wishes to create and deploy an activity-specific meosk structure on the system network.

As indicated at Block D in FIG. 92B, the system network 1 displays a GUI requesting the master user to approve the name to be assigned by the system network to the activity-specific meosk structure to be created, or provide an alternative name for the activity-specific meosk structure to be created and deployed on the system network.

As indicated at Block E in FIG. 92B, the system network 1 requests the master user to selects an icon or thumbnail image for the activity-specific meosk structure to be created and deployed on the system network.

As indicated at Block F in FIG. 91B, the system network 1 displays a GUI requesting the master user to invite one or more members to join the inner circle of the activity-specific meosk structure.

As indicated at Block G in FIG. 92B, the system network 1 displays a GUI requesting the meosk master to enable one or more moment processing functions to be supported within the activity-specific meosk structure to be created and deployed on the system network.

As indicated at Block H in FIG. 91C, the system network 1 generates and deploys the activity-specific meosk structure, configured during Block A through Block I for access and use by the master user and the inner circle members invited to join the inner circle of the activity-specific meosk structure.

As indicated at Block I in FIG. 92B, the system network 1 displays a GUI requesting the meosk master to select brands of choice or preference for a category of goods and/or services that might be used in connection with the selected activity or interest associated with the activity-specific meosk structure to be created and deployed on the system network, wherein, in the system database 5, each category of goods and/or services is linked to the activity or interest assigned to the activity-specific meosk structure to be created and deployed on the system network 1.

As indicated at Block J in FIG. 91C, the master user selects which brands from the display categories of products and/or service, which the master user wishes to contact the master user through the messaging facilities provided within the activity-specific meosk structure to be created and deployed by the system network.

As indicated at Block K in FIG. 91C, the master user collects and manages moments and associated messages in its activity-specific meosk structure organized around the identified interest or activity, wherein these moments may include digital assets captured moments in the form of videos, photos, diary notes/thoughts, digital creations and digital widgets telling part of a story reflected in moments and associated messages stored in the activity-specific meosk structure relating to about the activity and/or interest being pursued.

As indicated at Block L in FIG. 91C, system network 1 automatically collects data on various aspects of the moments and associated messages in the activity-specific meosk structure, as well as the inner circle members contributing moments and messages to the activity-specific meosk structure and storing this collected data in the system database 5.

As indicated at Block M in FIG. 91C, the system network 1 processes the collected data stored in the system database 5 and generates metrics that provide insights into the behavior and values of the inner circle members of the activity-specific meosk structure, including its meosk master, while maintaining and preserving anonymity and privacy on the system network.

### A Reverse-Inquiry Based Method of and Information Processing Apparatus for Brand Contact Request and Communication Supported by the System Network of the Present Invention

It is appropriate at this juncture to describe in greater detail, the reverse-inquiry based brand contact and communication process supported on the system network 1 of the present invention. As shown therein, brands use this process to establish and maintain 1-on-1 contact and communications with individual consumers (or groups of consumers) while consumers enjoy special offers, rewards, benefits and privileges associated with such brands. Notably, this novel service is carried out and practiced along private brand communication channels that are supported within the activity-specific meosk structures that have been created and deployed on the system of the present invention. When using the system network of the present invention to create each activity-specific meosk structure, the individual user/consumer is first asked what is their favorite activity or special interest they enjoy pursuing, or otherwise invest a significant amount of time and energy therein. Then, the system network automatically presents the individual consumer with various generic product and/or service categories, and various brands associated therewith, which they might enjoy using when engaging in the identified activity, and would like to be contacted by the brand's marketing team. Based on the brands selected/identified by the individual consumer, the system network automatically reaches out to the selected brands and requests that the brands contact the requesting consumers and establish a 1-on-1 brand-consumer relationship with them using the system network. Many new opportunities can arise from such new techniques, providing revolutionary possibilities in the brand marketing communication and e-commerce/show-n-tell marketplace. The details of this reverse-inquiry based method of brand-consumer contact and communication will be described below with reference to FIGS. 92A through 92C.

FIGS. 92A, 92B and 92C, taken together, describe the primary steps of the reverse-inquiry based method of and information processing apparatus for brand contact request and communication, supported by the system network 1 of the present invention.

As shown in the flow chart of FIGS. 92A and 92B, a novel method of reverse-inquiry based method of brand contact and communication, on the meosk-based private and social media management and communication system network 1, is described in great detail.

As indicated at Block A in FIG. 93A, the individual consumer learns about the system network of the present invention, and its activity-specific meosk technology, and registers to use the system network, as an individual user/consumer. This involves the system user to register to use a meosk-based private and social media management and communication system network 1 supporting a system database (RDBMS) 5. Each activity-specific meosk structure created and deployed on the system network stores one or more moments (i.e. digital assets), and one or more messages associated with each stored moment. Each activity-specific meosk structure has an inner circle of members who have the right to access and review the moments and messages organized and managed in the activity-specific meosk structure, by way of communication techniques exercised over the system network, and to contribute messages and moments to the activity-specific meosk system as allowed by the meosk master. Also, each activity-specific meosk structure has at least one message communication facility (e.g. a brand channel and/or local messaging center) for communicating product and/or service marketing messages from brands to the master user, which the master user has requested to contact the master user through the communication facility of the activity-specific meosk structure.

As indicated at Block B in FIG. 93A, the system user creates and deploys an activity-specific meosk structure on the system network, as illustrated in FIGS. 39A through 39T for oneself, or FIGS. 40C through 40W. During this process, the system network generates a GUI that asks the system user to identify a favorite interest or activity about which the activity-specific meosk structure is to be created and deployed, wherein this inquiry may be achieved (i) directly (e.g. asking directly what is the activity around which you wish to create and deploy a meosk?), or (ii) indirectly by a multi-step process, involving first asking the system user for a field of interest, selected from a pull-down menu, as illustrated in FIG. 39D-2, and then second asking for a specific activity, as illustrated in FIGS. 39D-3 through 39D-8, within the selected field of interest, as illustrated in FIG. 39D-2. In short, when creating an activity-specific meosk structure, the individual consumer is asked to identify a favorite activity from a drop-down list. Clearly, different kinds of activities call for different meosk configurations, optimally configured to organize different kinds of digital assets (i.e. information) about the selected activity/interest and the individual consumer's pursuit thereof, as the case may be.

As indicated at Block C in FIG. 93A, in response to the interest or activity identified by the system user, the system network automatically generating a GUI that displays a list of generic product and/or service categories typically required or desired when enjoying the identified interest or activity, and under each displayed generic product and/or service category, a list of Brands is presented, from which the consumer is asked to select one or more brands as favorites or desired. During this step, the system network generates different pre-designed templates that are used to identify and select: (i) different kinds of generic “things” (e.g. goods, products and/or services) that are typically used to enjoy the selected “activity”, and also (ii) particular brands of such generic goods that the consumer enjoys or likes to use in connection with the activity.

As indicated at Block D in FIG. 93B, in response to the brands selected by the system user (i.e. consumer) during Block C, the system network automatically searching the system database, and determining what product brands and/or service brands the system user might enjoy learning more about through brand messages sent to the system via the message facilities provided by the activity-specific meosk structure, wherein the brand messages could include invitations, product information, offers and other marketing materials from the selected brand in effort to support and encourage the system user during his or her pursuits.

Based on the consumer's selected activity, selected generic things and selected/identified brands of interest, the system network assists the selected brands in generating and sending messages to the consumers in various ways possible (e.g. sending them offers, premiums/freemiums, brand assets such as videos etc, promotions, discounts, and possibly sponsorship applications in certain situations). Such brand contact may also include offers on a limited right to use the brand's logos in meosk-view based communications and enjoy other privileges provided by the brand while the consumer is using the activity-specific meosk structure. The brands will use the brand management module described above to communicate directly with consumers in their private meosks via the message center and programmable brand channels, receive metrics on their meosk structures, and maintain 1-on-1 relationships with consumers who may be choose to become members of the brand's social street-marketing team.

Using the brand manager module illustrated in FIG. 6A-1 through 6F-15, brand manager (e.g. management team members) then send brand assets and corresponding messages to the system database (RDBMS 5), via XHTMLftp, or other IP-based protocols, so that the brands are free to use these brand assets to support their marketing communications with the master and guest users of the activity-specific meosk and weosk structures, via messages sent through the messaging center and/or content programming through the brand channels of activity-specific meosk structures and activity-specific weosk structures.

Using the tools supported by the brand management module, brands can begin 1-to-1 communications with consumers within the consumer's private meosks deployed on the system network. The exchange of messages that might occur between a brand and consumer might be facilitated using a communication tool in the suite of marketing communication tools supported within the brand manager module, wherein the brand may send a message to requesting consumer inviting the consumer to enjoy various kinds of offers, brand marketing collateral, rights and privileges. This may also include invitations to be a member of the brand's street-team, and as a member, having the right to enjoy the use of the brand's logo and other benefits made available during the relationship. Using the message center supported within the consumer's meosk structure, the consumer can accept, reject or ignore the brand's messages, including its offers and/or invitations. The consumer can strengthen its relationship with brands over time, depending on how they feel about the relationship.

The individual consumer is free to accept, reject or ignore any requested brand contact or communication; and if accepted, the consumer can expect to receive messages and offers from the brand, including the right to download of all kinds of digital assets that may be of great interest and value to the individual consumer. This allows brands to build a 1-to-1 relationship with their consumers and gain deeper insights into how they think and value the world.

As indicated at Block E in FIG. 93B, the master user collecting and storing moments and associated messages in the activity-specific meosk structure accessed and used by the master user and any inner circle members invited to join the inner circle of the activity-specific meosk structure, wherein these moments may include digital assets captured moments in the form of videos, photos, diary notes/thoughts, digital creations and digital widgets telling part of a story reflected in moments and associated messages stored in the activity-specific meosk structure relating to about the activity and/or interest being pursued. The digital assets collected and managed within the private and social activity-specific meosk structure may include videos, photos, diary notes/thoughts, digital creations and digital widgets that tell the individual's unique story about the interest or passion being pursued.

As indicated at Block F in FIG. 93B, the system network 1 automatically collecting data on various aspects of the moments and associated messages in the activity-specific meosk structure, as well as the inner circle members contributing moments and messages to the activity-specific meosk structure and storing this collected data in the system database.

As indicated at Block G in FIG. 93B, the system network 1 processing the collected data stored in the system database and generates metrics that provide insights into the behavior and values of the inner circle members of the activity-specific meosk structure, including its meosk master, while maintaining and preserving anonymity and privacy on the system network.

Using this method of brand marketing communication, the consumer may maintain a 1-on-1 relationship with their brands—anonymously and privately, as they choose. The consumer may choose to open and accept the brand's message, reject their message and whatever it may offer, or simply ignore the brand's message. While the individual consumer is encouraged to strengthen its relationship with its brand supporter, but may expressly terminate the relationship, or neglect the relationship, however the case may be, both informing and providing insight to the brand's management team.

### Specification of Method of Producing Journey Books Using the Meosk/Weosk-Based Private and Social Media Management and Communication System Network of the Present Invention

FIG. 94 is a flow chart describing the primary steps involved in carrying out the method of using the meosk-based system network of the present invention to produce journey books for sharing with others, comprising the steps of (a) registering with system network, (b) logging into the system network, (c) creating a meosk structure for a given activity or interest, (d) creating an inner circle of members and providing them with access to the meosk structure, (e) capturing some moments and storing the moments in the meosk structure, (f) sharing the moments in the meosk structure, and linking to the shared moments, comments or contributions made by the inner circle members in response to the shared moments, (g) producing a journey book based on the moments and linked contributions and/or comments made by the inner circle members, and (h) sharing the journey book with others.

### Alternative Methods of Creating and Deploying Activity-Specific Meosk Structures Around Specific Interests or Activities

A preferred method has been described in detail for creating and deploying activity-specific meosk structures or subsystems on the system network of the present invention. This method has been designed to streamline the number of questions that might be required to identify the recognized activity or interest represented within an information index to be used by the system network to support its reverse-inquiry brand marketing communication techniques on the system network of the present invention.

A primary function of the create new meosk module is to enable individuals to easily create new meosk structures, each organized around one or more “interests” or activities pursued by the individual user/consumer. Once deployed, the meosk masters can check the brand message center in each activity/interest-specific meosk for messages (e.g. invitations) received from the client brands from which the individual consumer(s) requested contact and communication, while preserving the consumer's identity on the system network. Also, the meosk master and guests can share moments stored in the activity/interest specific meosk structures with others over diverse social, and may also post the meosk structures on social network as well as e-commerce channels during meosk posting operations.

It is understood that the create new meosk module of the illustrative embodiment can be modified in many ways to meet the needs of consumers, brands and administrators alike. In particular, there any many possible ways of requesting the identify of the individual user for whom will the activity-specific meosk be created and deployed. The answer can be for the individual meosk master himself/herself, or other person (e.g. a child, grandchild, or for someone whom the user is acting as an agent, employee, assistant, aid or consultant). When identifying the meosk creator or another person for whom a meosk structure is to be created, the answers that might be given at this stage of questioning can fall within a range of possible user categories, namely: (i) Unborn child; (ii) Newborn child or infant (0-2); (iii) Toddler (3-5); (iv) Youngster (6-9); (v) Pre-teenager (10-12); (vi) Teenager (13-19); (vii) College undergraduate student (18-22); (viii) College graduate student (23-26); (ix) Young adult (25-39); (x) Middle age adult (40-64); and (xi) Elderly adult (65-100). These simple questions can be answered by the user using pull down menu or other suitable techniques. Based on the age and possibly gender, this approach could help narrow down the list of possible activities to be displayed to the system user from the master index in a pull-down menu manner. Based on this upfront age/gender inquiry, many different intelligent processes can be proposed for assisting an individual user to quickly identify the particular interest or activity for which an activity-specific meosk structure will be created and deployed on the system of the present invention. An alternative exemplary process will be proposed below. However, is understood that other processes are possible and will be developed during the practice of any given embodiment of the present invention.

Exemplary Process for Assisting an Individual User to Quickly Identify the Particular Interest or Activity for which an Activity-Specific Meosk Will be Created and Deployed on the System Network of the Present Invention

In the illustrative embodiment of the system network of the present invention, FIGS. 39A through 40P, and 60A through 61CC, illustrate exemplary methods of creating and deploying activity-specific meosk structures, and activity-specific weosk structures, driven by a powerful Activity/Products/Services/Brands-Index shown in FIGS. 39D-2 through 39D-9. These are only exemplary methods and it is understood that other methods are possible, and may be desired in certain applications. One such alternative process, described below, can be implemented to assist an individual system user to quickly identify the particular interest or activity for which an activity-specific meosk structure will be created and deployed on the system network of the present invention.

Based on the possible user categories described above (i.e. (i) Unborn child; (ii) Newborn child or infant (0-2); (iii) Toddler (3-5); (iv) Youngster (6-9); (v) Pre-teenager (10-12); (vi) Teenager (13-19); (vii) College undergraduate student (18-22); (viii) College graduate student (23-26); (ix) Young adult (25-39); (x) Middle age adult (40-64); and (xi) Elderly adult (65-100)) a series of possible questions are formulated below each possible case (Ci).

C1: If the meosk structure is being created for an unborn child, then the system network automatically generates and displays the following question to the user:

Q: Do you know the gender of the unborn baby? Boy? Girl? Don't Know

Then the system network automatically generates and loads an “unborn baby” meosk structure and advises the individual that the meosk structure is ready to use.

C2: If the meosk structure is being created for a Newborn Child or infant (0-2), then the system network automatically generates and displays the following question to the user:

Q: What is the gender of the Newborn Child? Boy? Girl?

Then the system network automatically generates and loads a “Newborn Child” meosk structure and advises the individual that the meosk structure is ready to use.

C3: If the meosk structure is being created for a Toddler (2-5), then the system network automatically generates and displays the following question to the user:

Q: What is the gender of the toddler? Boy? Girl?

Then the system network automatically generates and displays the following question to the user (i.e. parent, grandparent or guardian):

Q: For what activit(ies) would you like to create a meosk structure for one's child? (check one or more activities)

Playing With Friends?

Playing With Toys

Drawing?

Reading?

Watching Videos?

Singing Songs?

Dancing to Music?

Speaking′?

Writing?

Musical Instruments?

Then, the system network automatically generates and display another set of questions to narrow down on the activity or interest for the meosk structure.

Eventually, the system network automatically generates and loads an activity-specific meosk structure for the Toddler and advises the individual creating the meosk structure that the meosk structure is ready to use.

C5: If the meosk structure is being created for a Pre-Teenager (10-12), then the system network automatically generates and displays the following question to the user:

Q: What is the gender of the Pre-teenager? Boy? Girl?

Then the system network automatically generates and displays the following Question to the user (i.e. parent, grandparent or guardian):

Q: For what activit(ies) would you like to create a meosk structure for a Pre-teenager child? (select one or more activities from the menu below)

Drawing?

Reading Books?

Singing?

Dancing?

Writing?

Musical Instruments?

Sports?

Arts?

Religious Education?

Family?

Hobbies?

Collecting Things?

Making Things? (Crafts)?

Volunteering?

Clubs? (Boy Scouts or Girl Scouts?)

Then, the system network automatically generates and display another set of questions to narrow down on the activity or interest for the meosk structure, based on the menu selection above.

Eventually, the system network automatically generates and loads an activity-specific meosk structure for the Pre-Teenager, and advises the individual creating the meosk structure that the meosk structure is ready to use.

C6: If the meosk structure is being created for a Teenager (3-19), then the system network automatically generates and displays the following question to the user:

Q: Gender? Male? Female?

Then the system network automatically generates and displays the following Question to the individual user (i.e. teenager, parent, grandparent and/or guardian): For what kind of activity would you like to create a meosk structure ?

A Recreational Activity?

Hobbies?

Collecting Things?

Making Things? (Crafts)?

An Academic Activity?

A Family Activity?

An College Search Activity?

A Social Activity?

A Civic Activity?

A Religious or Spiritual Activity?

Then, the system network automatically generates and displays a more detailed set of activities based on the selected class of activity above, for the meosk structure to be created.

The system network automatically generates and loads an activity-specific meosk structure for the Teenager, based on the identified activity, and advises the individual creating the meosk structure that the meosk structure is available in his or her my meosk structure list, and is ready to use.

C7: If the meosk structure is being created for a College Student (18-21), then the system network automatically generates and displays the following question to the user:

Q: Gender? Male? Female?

Then the system network automatically generates and displays the following Question

to the individual user (i.e. teenager, parent, grandparent and/or guardian):

For what kind of activity would you like to create a meosk structure?

A Recreational Activity?

Hobbies?

Collecting Things?

Making Things? (Crafts)?

An Academic Activity?

A Family Activity?

A Career Activity

A Social Activity?

A Civic Activity?

A Religious or Spiritual Activity?

Then, the system network automatically generates and displays a more detailed set of activities embraced by the selected class of activity above, for the meosk structure to be created.

Then the system network automatically generates and loads an activity-specific meosk structure for the College Student, based on the identified activity, and advises the individual creating the meosk structure that the meosk structure is ready to use.

C8: If the meosk structure is being created for a College/Post Graduate Student (22-26), then the system network automatically generates and displays the following question to the user:

Q: Gender? Male? Female?

Then the system network automatically generates and displays the following Question to the individual user:

For what kind of activity would you like to create a meosk structure ?

A Recreational Activity?

An Academic Activity?

A Family Activity?

A Career Activity

A Social Activity?

A Civic Activity?

A Religious or Spiritual Activity?

Then, the system network automatically generates and displays a more detailed set of activities embraced by the selected class of activity above, for the meosk structure to be created, based on the menu selection made above.

Then the system network automatically generates and loads an activity-specific meosk structure for the College Graduate Student, based on the identified activity, and advises the individual creating the meosk structure that the meosk structure is ready to use.

C9: If the meosk structure is being created for a Young Adult (22-35), then the system network automatically generates and displays the following question to the user:

Q: Gender? Male? Female?

Then the system network automatically generates and displays the following Question to the individual user:

For what kind of activity would you like to create a meosk structure ?

A Recreational Activity?

An Academic Activity?

A Family Activity?

A Career Activity

A Social Activity?

A Civic Activity?

A Religious or Spiritual Activity?

Then, the system automatically generates and displays a more detailed set of activities based on the selected class of activity above, for the meosk structure to be created.

Then the system network automatically generates and loads an activity-specific meosk for the Young Adult, based on the identified activity, and advises the individual creating the meosk that the meosk structure is ready to use.

C10: If the meosk structure is being created for an Adult (35-44), then the system network automatically generates and displays the following question to the user:

Q: Gender? Male? Female?

Then the system automatically generates and displays the following Question to the individual user:

For what kind of activity would you like to create a meosk structure ?

A Recreational Activity?

An Academic Activity?

A Family Activity?

A Career Activity

A Social Activity?

A Civic Activity?

A Religious or Spiritual Activity?

Then, the system automatically generates and displays a more detailed set of activities based on the selected class of activity above, for the meosk structure to be created.

The system automatically generates and loads an activity-specific meosk for the Adult, based on the identified activity, and advises the individual creating the meosk that the meosk structure is ready to use.

C11: If the meosk structure is being created for an Middle Age Adult (45-61), then the system network automatically generates and displays the following question to the user:

Q: Gender? Male? Female?

Then the system network automatically generates and displays the following Question to the individual user:

For what kind of activity would you like to create a meosk structure ?

A Recreational Activity?

An Academic Activity?

A Family Activity?

A Career Activity

A Social Activity?

A Civic Activity?

A Religious or Spiritual Activity?

Then, the system network automatically generates and displays a more detailed set of activities based on the selected class of activity above, for the meosk structure to be created.

Then the system network automatically generates and loads an activity-specific meosk structure for the Middle Age Adult, based on the identified activity, and advises the individual creating the meosk structure that the meosk structure is ready to use.

C12 If the meosk structure is being created for a Senior Adult (62-100), then the system network automatically generates and displays the following question to the user:

Q: Gender? Male? Female?

Then the system network automatically generates and displays the following Question to the individual user (i.e. senior and grandchildren and children):

For what kind of activity would you like to create a meosk structure?

A Recreational Activity?

An Academic Activity?

A Family Activity?

A Career Activity

A Social Activity?

A Civic Activity?

A Religious or Spiritual Activity?

In response to the user's selection, the system network automatically generates and displays a more detailed set of activities based on the selected class of activity above, for the meosk structure to be created.

Then the system automatically generates and loads an activity-specific meosk structure for the Senior Adult, based on the identified activity, and advises the individual creating the meosk that the meosk structure is ready to use.

Based on the category of activity selected above, the create new meosk module automatically displays on a GUI screen, for the system user (i.e. meosk master), a selection of goods and/or services that are typically used in connection with the selected activity or interest associated with the meosk structure to be created and deployed. Also, associated with each good or service linked to the activity or interest, a set of brands are displayed in a list or menu format for selection by the individual user (i.e. meosk master).

Once a brand has been registered with the system network, and the system admin has received approval to use the brand's logo, then brand's logo will appear in the GUI screens supported on the system network. If a given brand has not yet been registered with the system network, then the brand's logo will be typically not displayed, but rather only the brand's mark in block letters. Also, the generic products/services associated with the selected will be pre-recorded in the system RDBMS 5 after careful industry and market research.

The number of actual brands under any given generic product will depend on a number of factors including the country of the individual, the marketplace, the number of competitors in the marketspace, etc. Most, if not all, major and smaller brands should be represented in the list of brands under each generic product/service category list in the create new meosk module, providing the individual user with as much choice as possible. The GUI screens can be designed so that the individual user can enter any brand not otherwise listed in the menu, listed under a generic good/service associated with the selected activity/interest. This information from individual users of the system network will serve to inform the market research team behind the system to update the system RDBMS 5, so that future displayed good/service lists will more accurately reflect the actual brands enjoyed and desired by individual users in the marketplace.

Configuring Activity-Specific Meosk Structures to Support E-Commerce Transactions within Moment Stores Enabled/Activated Therein

Activity-specific meosk structures can be easily configured to support e-commerce transactions on the system network, where any particular moment or set of moments in an activated/enabled moment store (e.g. my album illustrated in FIG. 32E) can display one or more photos and/or videos of particular products (and/or services) to be marketed and offered for sale over the Internet. This can be done by meosk masters (i.e. master users) enabling the gift-it function during meosk creation and deployment, and programming the gift wish list (illustrated in FIG. 65E) for the meosk structure with URLs that point to e-commerce ordering and fulfillment WebPages that might be supported by (i) custom-created and deployed e-commerce ordering and fulfillment platforms, or alternatively, by (ii) any number of third-party service providers including amazon.com, e-bay.com and hundreds of other e-commerce online stores and sites doing business on the Internet. Also, the system network can be readily programmed to replace the “gift-it” moment function terminology illustrated in FIGS. 31I, 31J and 31K, with “buy-it” or like terminology and corresponding icons, so as to invite others who are within the inner circle of any such meosk structures to buy products and/or services being displayed therein. In some embodiments, it might make sense for the meosk master to configure the my journal so as to function as a shoppers/browsers blog, leaving notes, thoughts, comments, experiences, product ratings, and/or consumer suggestions about the products/services being offered for sale in the e-commerce driven meosk structure. The meosk structure's brand channel and/or favorites channel may be enabled or disabled as desired by the meosk master configuring the meosk structure. By enabling/activating the note-it, attach-it, grab-it, share-it and post-it functions within the product/service showcasing meosks structure, as well as enabling the add new members and expand the inner circle and post meosk functions, the meosk master can create and deploy e-commerce-driven marketing communication vehicles across and around social communication networks with an unprecedented level of flexibility and control, offering new outlets for individuals, entrepreneurs and others to market and sell their merchandise to almost anyone, anywhere on the WWW.

Uploading and Managing Digital Content Directly within Activity-Specific Meosk Structures Deployed on the System Network of the Present Invention

After meosk structure creation and deployment on the system network, the meosk master as well as the inner circle of meosk members (in most cases) will quickly instances where it is desired to upload, link and/or logically store a “moment” or digital content (e.g. digital video, audio, photos, executable files, etc) in a store enabled in the meosk structure (e.g. my journal, my album(s), my favorites, etc.) that may be supported in the meosk structure on the system network 1. This digital content uploading and linking process will typically involve the meosk master and inner circle members uploading moments (e.g. digital content such as text, pictures, videos, sound files, widgets, etc) directly to the Apache Hadoop® distributed data file storage system 15, via the control and virtual file management functionality of the activity-specific meosk structure (e.g. using the View My Bin, Capture and Store It, Attach-It, Note-It, Grab-It, Copy-It functions described above) for long-term secure Internet-based storage on the system network of the present invention. As described throughout the present Specification, such digital asset uploading operations can be carried out using, for example, any HTML5-based or native-based device 8A, 8B or 8C supported by the system network illustrated in FIGS. 1, 1A, 1B, 1B-1 and 1B-2.

In the illustrative embodiment, the GUIs screens within each activity-specific meosk structure supported on the system network 1 will enable uploading of digital assets (from local systems and devices) to network servers and storage devices within RDBMS servers 5 of the Apache Hadoop® distributed data file storage system 15, as shown in FIGS. 1A through 1B-2, in a manner transparent to the individual system users. When managing moments and other digital assets within their meosk and weosk structures, all that master and guest system users will see are the GUI screens supported by the meosk and weosk structures, and the many GUIs screens associated with the many different modules supported through the client systems 8A, 8B, 8C deployed on the system network 1, as described in great detail herein throughout. Also, using the WebClipper module illustrated in FIGS. 19B-1, 19B-2 and 19B-3, system network of the present invention also supports the uploading of URLs (specifying the network location of specific digital content/files and services hosted on remote information servers on the WWW. In the illustrative embodiment, several different tools are provided for capturing and storing URLs for the purposes described above, namely: (i) the URL moment capture tool supported within the capture moments module as illustrated in FIGS. 19B-1 and 19B-2; and also (ii) the URL moment capture tool supported in each meosk structure as illustrated in FIGS. 29B-1 and 29B-2.

Regardless of the source of the moments (i.e. digital assets) to be uploaded and managed, the digital asset will be organized within the meosk structure's virtual file directory system and digital asset management system network, by information type, with time/date stamping, and other tagging to assist the individual in organizing collected activity-specific information within the meosk structure.

Remotely Uploading Digital Content into the BIN Inbox of an Individual Master User of the System Network of the Present Invention, for Subsequent Transfer to a Selected Private Activity-Specific Meosk Structure Deployed on the System Network of the Present Invention

After an activity-specific meosk structure has been created and deployed on the system network, the meosk master identifies digital content (e.g. digital video, audio, photos, executable files, etc) for uploading or linking to any digital content store supported in its private meosk structure on the system network of the present invention. The meosk master or an inner circle guest uploads either the URL of the digital asset, or the actual file, to a specific store in the meosk structure, which ultimately is stored in the system database 5 and its supporting Apache Hadoop® distributed information file storage and retrieval system 15. Such digital asset management operations can be carried out using mobile, tablet and desktop devices 8A, 8B, 8C supported by the system network of the present invention. For digital assets (i.e. moments) shared by the meosk master among inner circle guests using any of the techniques illustrated in FIGS. 69 through 89B-2, the moment will be temporarily stored in the meosk master's View My Bin module. Therefore, after receiving a notification of a shared moment in the message center, the meosk master goes to the View My Bin illustrated in FIG. 42A, and thereafter, selects a digital asset (i.e. moment) in the BIN and transfers it to a particular private meosk deployed on the system network, as shown in FIGS. 42A and 42B. This process is repeated for each moment (i.e. digital asset) residing in the My BIN of the View My Bin Module supported on the system network, until there are no longer any moments to be reviewed and moved or the meosk master no longer wishes to manage moments in the View My Bin module.

Allowing Brands to Program Subject Matter Content within the Brand Channel Media Player OF an Activity-Specific Meosk Structure

In certain activity-specific meosk structures, it might make sense for particular brands sponsor and/or produce one or more programmed subject channels that are integrated into the GUI structure, and related to the activity of the private meosk structure created and deployed by the individual, or administrator, as the case may be. This can be achieved by adding a separate subject channel media player to the each activity-specific meosk structure, or allowing select subject matter experts to function as executive producers of compelling and exciting subject matter content that is programmed in the brand channel media player of each activity-specific meosk structure, as illustrated in FIGS. 36A and 36B.

For example, in the case where the activity of a particular meosk structure is “capturing early childhood memories” (i.e. early-childhood meosk), each such private meosk might support an integrated programmed subject channel on the topic of “infant or early child health care” providing knowledge, guidance and instruction to young parents raising a child. This programmed subject channel can be realized using the brand channel illustrated in FIG. 36B, or an additional media player could be installed within the activity-specific meosk structure.

In the case where activity of a particular meosk structure is “pursuing admission to a college with interest in science, technology, engineering and math (STEM)” (i.e. a STEM meosk”), each such private meosk might support an integrated programmed subject channel on the topic of “applications of science and math in healthcare, finance, manufacturing and industry” providing insights how particular mathematics topics and/or scientific principles are applied to solve particular problems, everyday, in various fields of human activity.

In the case where the activity of a particular meosk structure is a “pursuing a career in healthcare technology” (i.e. career meosk), each such private meosk structure might support an integrated programmed subject channel on the topic of “applications of technology in the healthcare industry” providing insights into which companies and institutions are doing extraordinary things in the healthcare industry, from delivery of quality service, diagnosis, treatment and cost management.

In the case where the activity of a particular meosk structure is “pursuing ways to promote a cleaner and healthier environment” (i.e. an environmental meosk), each such private meosk might support an integrated programmed subject channel on the topic of “applications of technology in clean technology” providing insights into new ways companies and institutions are doing good things in the power and manufacturing industries, to promote an environmentally clean and safe environment using advanced applications of science and technology.

In a college-specific meosk structure, supporting an individual's quest for a college that would allow him or her to study biology and natural life sciences, one of the programmed channels supported within the video player widget of the meosk might include a short video by the Cornell Ornithology Laboratory, on the “Birds of Paradise” illustrating the kinds of groundbreaking research and study conducted by departments of the college. The topics on which programmed subject channels can be produced and integrated within private activity-specific meosk structures are limited only by ones imagination and quest for learning and doing whatever individuals might dream about pursuing with passion in their own lifetimes.

Creating, Exporting and Sharing Master Activity/Interest Course Lists of an Individual with Others

As will be described in greater detail hereinafter, the individual will typically create, deploy and maintain a set of activity-specific meosk structures on a number of different activities and interests being pursued by the individual at any moment in time. This master activity/interest course (MAC) list can be exported as a pdf or like document and shared with family, friends and others trusted persons, from whom the individual wishes support and encouragement during their pursuits. The master activity course (MAC) list, being time/date stamped, can be compared with others master course at different points of time and at different stages of an individual's life to see how an individual's activities and interests have changed, and evolved, over time, providing an opportunity for reflection and consideration, and development of self-awareness and knowledge.

Also, as described previously above, the system will maintain pre-designed master activity course (MAC) lists within its RDBMS 5 for quick selection and pursuit by individuals with particular life goals in mind. When any Master Activity Course (MAC) list is selected from the GUI of meosk manager tool available in the settings module, the system will automatically set up activity-specific meosk structures for the individual that are indexed to the prescribed activities in the selected MAC list, and then these MACs can be customized by the individual (or its life coach) by removing and/or adding particular activities to the master activity course (MAC) list being pursued by the specific individual. This can expedite the setting up of an individual's master meosk course plan (i.e. curriculum).

Sharing Digital Content Organized and Managed within an Activity-Specific Meosk Deployed within the System of the Present Invention

After a private activity-specific meosk structure has been created and deployed by an individual Consumer (i.e. meosk master), and then has populated with information (i.e. moments) related to the particular activity for which it was created, the individual consumer (e.g. creator) is free to share any digital content stored (e.g. programmed) in the meosk over diverse social communication channels via moment sharing and posting, as shown in FIGS. 32O and 33M, and even meosk posting supported on the system meosk illustrated in FIGS. 21, and 43O through 43V.

Each private activity-specific meosk structure can have an inner circle containing only the meosk master, or it may contain other trusted members who have been carefully selected to be members of the meosk structure's inner circle. The nature and composition of any inner circle will depend on many factors including the subject of the meosk itself, the meosk master user, and the social network of the meosk master.

In the preferred embodiment, the share moments feature shown in FIG. 32O is supported within the GUI of the my meosk module, and can be used to share digital content with inner circle members using the techniques specified above, as well as using any other digital IP-based communication protocol, practiced in posting operations over diverse other social communication networks (e.g. Facebook, Google+, Twitter, Instagram, Tumblr, Pinterest, Linked-In, etc) upon login and authentication. Using the share-it function supported in the my meosk module, individual system users can share selected digital assets (i.e. moments) stored in albums with others over the meosk structure's inner circle, and post moments to social network channels using the post-it function. Meosk masters can also post complete meosk structures to social networks using the post meosks feature illustrated in FIGS. 21, and 43O through 43V. Similar post features are supported on weosk structures as illustrated in FIGS. 45 and 62T through 62Z-2.

Below are the primary steps undertaken by an individual user sharing with others, over diverse communication channels, any digital content organized and managed within a private activity-specific meosk structure deployed within the system network of the present invention.

After a private meosk structure has been created and the individual user has populated it with information (i.e. moments) related to the particular activity or interest for which it was created, the individual user selects a digital moment stored in the activity-specific meosk structure.

The individual then selects the share-it function illustrated in FIG. 33K along with a group of inner circle members for the meosk structure, or the post-in function illustrated in FIG. 33M and a group of social communication channel (e.g. Facebook, Google+, Twitter, Instagram, Tumblr, Pinterest, Linked-In, etc) over which the selected digital asset is to be posted/shared.

Then the individual user shares (e.g. transmits) the selected digital asset with his or her inner circle members, or over selected social communication channel, where it is then received by its intended recipients.

This method of digital asset sharing provides a flexible way of sharing digital assets, including direct links, with others to the marketplace for a different kind of sharing.

### Method of Archiving Digital Content Organized in Private Meosks Supported on the System Network

Anytime after a meosk structure has been created and deployed on the system network, the individual user can archive part or all of the meosk structure onto one's desktop, or anywhere in the cloud, with the touch of the button or click of the mouse. This archiving feature provides an important opportunity for users to secure and protect the investment made in themselves, others and family, even though they have moved on with other interests and pursuits in new chapters of their lives. The individual user accesses the settings module at the footer control panel, illustrated in FIG. 90B, and then selects the archiving module at the bottom of the list. The user selects which meosks and weosks (if not all of them) to be archived on the cloud and/or desktop. Upon making the archive now selection, the computing resources on the system network encrypts and compresses the selected meosk/weosks-based digital assets into a compressed date/time-stamped encrypted data package. The compressed encrypted data package is then moved to the selected archival data store, for subsequent retrieval and decompression by the individual user, or his/her estate, as the case may be.

### Posting Private Activity-Specific Meosk Structures as Web Objects Along Public Social Channels and Locations

The private and confidential nature of private activity-specific meosks allows the individual to collect and organize all kinds of digitally-encoded information about their activity and/or interest, for reflection, planning and even strategic purposes. The benefits of maintaining a private reserve of information about each important activity and/or interest in the individual's life cannot be under-estimated, because it allows the individual to put their best face forward when the individual decides it is the right time to share such information with friends, associates, and other members of the public, at large. Functioning as a staging, or pre-processing stage, each private meosk structure allows the individual to reflect upon and carefully think about how best to release what information organized in the private meosk structure that relates to their activity or interest (e.g. subject or pursuit) prior to release to the public (i.e. prior to publication). This approach is consistent with the screening and decision making methods practiced by most product and service brand management teams around the world, prior to their releasing their brand assets to the public at large, including streams of social information and commerce and the like.

As indicated in FIGS. 5E and 5F, meosk structures and weosk structures can exist along the privacy continuum between strict privacy (i.e. secrecy) to full public disclosure. Meosks and weosks deployed on the system network 1 can be configured between these extremes as required by their meosk and weosk masters.

Using “post my meosks” module supported by the system network, illustrated in FIGS. 43O through 43V, any meosk master can automatically generate web-based HTML5-encoded Web object version of the meosk structure containing essentially the same contents in the meosk structure deployed on the system network. For example, FIGS. 42O through 43V shows a series of screens for posting a meosk (i.e. creating public view of a meosk structure) along diverse over diverse communication channels. Alternatively, using the post my meosks module, a meosk structure can be published to a public URL specified on the WWW, and the URL embedded along the fabric of the WWW, and/or in documents for launching the meosk therefrom. The meosk master just selects the “Publish The Meosk At A Public URL On the WWW” box shown in FIG. 43Q, then select the POST button, and the meosk structure will be published at a URL on the WWW. The meosk master will receive an email and/or SMS message advising the meosk master about this public URL at which the meosk structure has been published for subsequent trafficking to various locations on the WWW. The meosk guest can also received notifications of this published meosk URL. Notwithstanding the meosk structure is published on the WWW, privacy setting can be configured so that only meosk inner circle guests can gain access to the contents of the published meosk structure upon logging into the system network using proper credentials. In other circumstances, the published meosk structure can be configured so that it is accessible to anyone who has been invited as an inner circle member. It can also be configured so that it is widely open to the public without passwords. On the system network of the present invention, each meosk master has both the tools for treating, and the choice on whether to treat, each created and deployed meosk structure as either a strictly private media object, or a highly public social media object, or an object residing somewhere between these two extremes along the privacy continuum, as illustrated in FIGS. 5E and 5F.

Using “post my weosks” module supported by the system network of the present invention, illustrated in FIGS. 62Y through 62Z-2, any weosk master can automatically generate web-based HTML5-encoded web object version of the weosk structure containing essentially the same contents in the weosk structure deployed on the system network. For example, FIGS. 62Y through 62Z-2 shows a series of screens for posting a weosk structure (i.e. creating public view of a weosk structure) along diverse over diverse communication channels. Alternatively, using the post my weosks module, a weosk structure can be published to a public URL specified on the WWW, and the URL embedded along the fabric of the WWW, and/or in documents for launching the weosk therefrom. The weosk master just selects the “Publish The Weosk At A Public URL On the WWW” box shown in FIG. 43Q, then select the POST button, and the weosk structure will be published at a URL on the WWW. The weosk master will receive an email and/or SMS message advising the weosk master about this public URL at which the weosk structure has been published for subsequent trafficking to various locations on the WWW. The weosk guest can also received notifications of this published weosk URL. Notwithstanding the weosk structure is published on the WWW, privacy setting can be configured so that only weosk inner circle guests can gain access to the contents of the published weosk structure upon logging into the system network using proper credentials. In other circumstances, the published weosk structure can be configured so that it is accessible to anyone who has been invited as an inner circle member.

Once a meosk structure has been shared via posting on the WWW at a public URL or along social network channels, the meosk master, and guest users if and as authorized by the meosk master, can modify any of the digital content in the posted meosk structure. Likewise, once a weosk structure has been shared via posting on the WWW at a public URL or along social network channels, the weosk master, and guest users if and as authorized by the weoek master, can modify any of the digital content in the posted weosk structure.

### Updating Brand Contact Requests Across all Deployed Activity-Specific Meosk Structures

Using the “brands for my meosks” module illustrated in master view in FIGS. 65A through 65E, the system network of the present invention allows meosk masters to easily manage the brands who may make contact and communicate with each meosk created and deployed the meosk master. The meosk master simply selects the meosk structure to be managed from the list shown in the GUI screen of FIG. 65A, and then using GUI screens shown in FIGS. 65B and 65C, the meosk master adds and removes brands as desired for the selected activity-specific meosk structure. In the GUI screens shown in FIGS. 65 and 65B, the system database 5 will provide updated brands who offer products and services for the selected activity/interest, about which the activity-specific meosk structure has been created. When the meosk master sees a brand and its product in which there is interest, the meosk master selects ADD BRAND, and the system network 1 automatically sends the updated contact requests to the brand's management and marketing team, whereupon they will then reach out and make contact with the meosk master by sending messages via the message center module, as well as marketing communications via the brand channel within the meosk structure. When a meosk master is no longer interested in a brand in which brand contact has been previously requested, the meosk master selects REMOVE BRAND and the system network 1 automatically removes the brand from the my meosk brand list, and messaging and communication from the brand are terminated, with only a few survey messages supported to bring closure to the consumer-brand relationship. At a later date, the consumer may choose to revitalize the brand contact relationship by sending a request for brand contact through the system user's messaging center, accessible from within (i) an activity-specific meosk structure, (ii) the messaging center module, and/or (iii) the my brands module, each described in great detail hereinabove.

### Illustrative Use Case Examples for the System Network of the Present Invention

In general, the activity-specific meosk and weosk structure creation, deployment and management system network of the present invention described in great detail hereinabove can be used by individual users, and groups of individuals, having interest in specific kinds of activities during the different phases of any individual's lifetime. During certain phases, the individual user, for which the activity-specific meosk structure is created and deployed, can be administered by a system user who is not the individual who is the subject of the meosk structure, and this trustee-beneficiary relationship can be supported on the system network using the trustee user account module described in FIG. 5D and elsewhere hereinabove.

An exemplary use case has been described above in great detail with reference to FIGS. 67A through 89B-2, involving a young mother of two children, married, and part of a rather large extended family ecosystem network. In this first exemplary use case, an individual mother is shown using first moments (FM) meosk structures for her young children as they take their first steps in so many new ways each day of their lives, while involving her family ecosystem into the lives of her children and family in significant and life affirmative ways. In the preferred embodiment, the brand channel of her children's FM meosk structures, illustrated in FIGS. 36A, 36B, will have programmed video channels (i.e. brand channel) containing content related to children and child care and development, as this is an FM meosk structure organized for the early steps in a young child's life, and also the caregivers who will be there by the child each step of the journey. These programmed content of the brand channel should instruct, support, motivate and/or inspire the mother and other caregivers along this first steps journey, during which they will capture photos, videos, notes, voice/text, and/or special moments of their child's life. They will also be encouraged to send these captured digital moments to the FM meosk structure which the mother has created and developed for the benefit of her child. At the same time, the brands which the mother has requested to contact her send offers/specials, product/service information and other forms of support (perhaps even sponsorship offers) via the private and anonymous messaging, and/or other digital channel channels supported between the FM meosk structure illustrated in FIGS. 23 through 38C, and the brand control center of the system network, illustrated in FIGS. 6A-1 through 6F-15. Collectively, the support by the requested brands and the programmed content channels supports the mother as she documents her child's first steps and special moments in life, and shares captured content with family and friends via the inner circle of the child's FM meosk structure, as well as optionally, and selectively sharing particular moments via posting operations across social communication network channels. Over time, the child's first-moments (FM) meosk structure will filled up with precious and special first moments of the child's young life, contributing to the legacy of the individual child's life, and the many contributions made by those in her extended family ecosystem network, who care and love for them.

To further illustrate the diverse applications to which the system network of the present invention can be put, it will be helpful to cover several additions use cases below.

Second Use Case Specification—Pre-Teenager Encouraged to Create, Deploy and Maintain Activity-Specific Meosk Structures with Parental Support

The second use case involves an exemplary activity-specific meosk structure created and deployed by a pre-teenager who is encouraged to create, deploy and maintain one or more activity-specific meosk structures with parental support. Product and/or service brands and the individual registers with the system network 1 of the present invention as described hereinabove. Then, the product and service brands use the brand control module illustrated in FIGS. 6A-1 through 6F-15 to manage their brand assets and setup and push their marketing communications (using their customized library) to individual consumers who have requested to be contacted by the brands, by sending a brand contact request from the activity-specific meosk structure(s), to the brand control center illustrated in FIGS. 6A-1 through 6F-15. The individual preteen and/or parent who is managing the system and meosk structure is exposed to various kinds of events, including programmed video channels containing content relative to the pre-teenager's life. These events and programmed content material prompt or otherwise help motivate and/or inspire the pre-teenager and/or parent to capture photos, videos, notes, voice/text, and/or hallmark moments of the pre-teenager's life, and send these captured digital assets to the system RDBMS 5 for storage and organization with the activity-specific meosk structure which the parent/pre-teenager has created and developed for the benefit of the pre-teenager. At the same time, the brands which the parent/pre-teenager has requested to contact her send offers/specials, product/service information and other forms of support (perhaps even sponsorship offers) via the private and anonymous messages and/or other digital channels supported between the meosk structure and the brand control module of the system network, illustrated in FIGS. 6A-1 through 6F-15. Collectively, the support by the requested brands and the programmed content channels helps the mother as she documents her child's first steps and hallmark moments in life, and can selectively share captured content with family and friends, by sharing among inner circular members and/or posting on social communication networks. Over time, the meosk structure will be filled up with precious and hallmark moments of the pre-teenager's life, contributing to the legacy of his or her life.

### Third Use Case Specification—High School Student Encouraged to Create, Deploy and Maintain Activity-Specific Meosk Structure to Support Pursuit of a STEM College Admission

The third use case involves an exemplary activity-specific meosk structure created and deployed by a high school student who is encouraged to create, deploy and maintain an activity-specific meosk structure to support the pursuit of STEM college admission. Product and/or service brands and the individual registers with the system of the present invention. Then the product and service brands use the brand control module to manage their brand assets and setup and push their marketing communications (using their customized library) to individual consumers who have requested to be contacted by the brands, by sending a brand contact request from the activity-specific meosk structure (i.e. internal messaging center illustrated in FIG. 14F-1, 38B, 38C to the brand manager's brand control center illustrated in FIGS. 6C-3, 6C-4 and 6C-5. The individual high school student who is managing the system and meosk structure is exposed to various kinds of events, including programmed video channels containing content relative to the high school student's life and STEM college admission pursuits. These events and programmed content material prompt or otherwise help motivate and/or inspire the high school student to capture photos, videos, notes, voice/text, and/or hallmark moments of high school student's life, and send these captured digital files (i.e. moments) to the system RDBMS 5 for storage and organization according to the moment storage schema supported within each activity-specific meosk structure which has been created and developed by the parent/pre-teenager pair for the benefit of the teenager high school student. At the same time, the brands which the high school student has requested to contact her or him, send offers/specials, product/service information and other forms of support (perhaps even sponsorship offers) via the private and anonymous messaging and/or the brand channel supported between the STEM meosk structure and the brand control module of the system network, illustrated in FIGS. 6A-1 through 6F-15. Collectively, the support by the requested brands and the programmed brand channel(s) aids the high school student as she documents her/his steps and hallmark moments pursuing STEM college admission, and can selective share captured content with family and friends via shared moments and/or shared meosk structures (i.e. shared views), or by sharing particular moments via posting on social communication networks, as described herein. Over time, the meosk structure will be filled up with precious and hallmark moments of the high school student's life, contributing to the legacy of his or her life.

### Fourth Use Case Specification—High School Student Encouraged to Create, Deploy and Maintain Activity-Specific Meosk Structures to Support Pursuit of a STEM College Admission

The fourth use case involves an exemplary activity-specific meosk structure created and deployed by a senior adult who is encouraged to create, deploy and maintain an activity-specific meosk structures by children and/or grandchildren to support the development of the grandparent's lifetime legacy. Product and/or service brands and the individuals registers with the system network of the present invention. Then the product and service brands use the brand control module to manage their brand assets and setup and push their marketing communications (using their customized library) to individual consumers who have requested to be contacted by the brands, by sending a brand contact request from the activity-specific meosk or meosk manager, to the brand control center. The individual senior adult and/or children/grandchildren who are managing the meosk structures are exposed to various kinds of events, including programmed video channels containing content relative to the senior adult's life and life legacy pursuits. These events and programmed content material prompt or otherwise help motivate and/or inspire the senior adult and children/grandchildren to capture photos, videos, notes, voice/text, and/or hallmark moments of senior adult's life, and send these captured moments to the RDBMS 5 of the Apache Hadoop® storage system 15 for storage and organization with the activity-specific meosk structure which the senior adult and/or children/grandchildren have created and developed for the benefit of the senior adult's life legacy. At the same time, the brands which the senior adult has requested to contact her or him, send offers/specials, product/service information and other forms of support (perhaps even sponsorship offers) via the private and anonymous email to the messaging center, and/or the brand channel supported between the meosk structure and the brand control module, illustrated in FIGS. 6A-1 through 6F-15. Collectively, the support by the requested brands and the programmed content channels aids the senior adult as she documents her/his steps and hallmark moments in his or her lifetime, and can selective share captured content with family and friends, by sharing particular moments or via posting on social communication networks. Over time, the meosk structure will be filled up with precious and hallmark moments of the senior adult's life, contributing to the legacy of his or her life.

Below are some more examples of other use cases of the present invention expressed in a more compact format, but illustrative of utility and applicability of the system network and methods disclosed herein.

Use Case Example No. 1: Where an Individual is Involved in an Activity and Showing Off a Performance for Social Review and Comment—without E-Commerce Support for Product Purchase Offers

### Exemplary Use Case Profile:

### 1: Individual: Female Under 25 Years

### 2: Interest/Activity: Ballet

### 3: Good/Service Of The Brand Used By Individual: Ballet Shoes

### 4: Sponsoring Brands: Ballet Shoe Brand X

### 5: The Individual's Creation/Performance: Recital

6: During Public View Of The Meosk Structure Posted on A Social Media Platform, An Inquirer/Buyer/Browser Does Something That Relates Back To The Brand Sponsor Or The Creation/Service/Performance Illustrated In The Public View of The Meosk Structure: Inquirer Sends Message To Ballet Shoe Brand Inquiring About Its Brand
Illustrative Use Case No. 2: Where an Individual is Involved in an Activity and Showing Off a Creation for Social Review and Comment—with E-Commerce Support for Product Purchase Offers

### Exemplary Use Case Profile:

### 1: Individual: Female Under 25 Years

### 2: Interest/Activity: Ballet

### 3: Good/Service Of The Brand Used By Individual: Sewing Machine Brands

### 4: Sponsoring Brands: Sewing Machine Brand X

### 5: The Individual's Creation/Performance: Ballet Tutu

6: During Public View Of The Meosk, An Inquirer/Buyer/Browser Does Something That Relates Back To The Brand Sponsor Or The Creation/Service/Performance Illustrated In The Public View Of The Meosk Structure: Inquirer Sends Message To Sewing Machine Brand Inquiring About Its Brand
Illustrative Use Case No. 3: Where an Individual is Involved in an Activity and Showing Off a Creation for Review and Purchase—with E-Commerce Support for Product Purchase Offers

### Exemplary Use Case Profile:

### 1: Individual: Male Under 30 Years

### 2: Interest/Activity: Wood Carving

### 3: Good/Service Of The Brand Used By Individual: Carving Tools

### 4: Sponsoring Brands: Carving Tool Brand X

### 5: The Individual's Creation/Performance: Wood Carvings

6: During Public View Of The Meosk, An Inquirer/Buyer/Browser Does Something That Relates Back To The Brand Sponsor Or The Creation/Service/Performance Illustrated In The Public View of The Meosk Structure: Buyer Sends Purchase Order For Wood Carving Displayed In Meosk Structure
Illustrative Use Case No. 4: Where an Individual is Involved in an Activity and Showing Off a Creation for Review and Comment—without E-Commerce Support for Product Purchase Offers

### Exemplary Use Case Profile:

### 1: Individual: Male Under 30 Years

### 2: Interest/Activity: Wood Carving

### 3: Good/Service Of The Brand Used By Individual: Carving Tools

### 4: Sponsoring Brands: Carving Tool Brand X

### 5: The Individual's Creation/Performance: Wood Carvings

6: During Public View Of The Meosk, An Inquirer/Buyer/Browser Does Something That Relates Back To The Brand Sponsor Or The Creation/Service/Performance Illustrated In The Public View Of The Meosk Structure: Buyer Sends Purchase Order For Wood Carving Displayed In The Meosk Structure
Illustrative Use Case No. 5: Wherein an Individual is Involved in an Activity and Showing Off Performance for Review and Comment—with E-Commerce Support for Product Purchase Offers

### Exemplary Use Case Profile:

### 1: Individual: High School Student

### 2: Interest/Activity: Study of Science, Technology and Mathematics (STEM)

### 3: Good/Service Of The Brand Used By Individual: Lab Instrument

### 4: Sponsoring Brands: Lab Instrument Brand X

### 5: The Individual's/Creation Performance: Science Fair Exhibit on Biological Topic

6: During Public View Of The Meosk Structure, An Inquirer/Buyer/Browser Does Something That Relates Back To The Brand Sponsor Or The Creation/Performance Illustrated In The Public View Of The Meosk Structure: Inquirer Sends Message To High School Student or Cell Counter Brand
Illustrative Use Case No. 6: A Career-Path-Specific Meosk Structure about which Individual User Content can be Collected and Organized for Supporting Applications

### Exemplary Use Case Profile:

### 1: Individual: High School Student

2: Interest/Activity: Pursuing a career in a particular field of study or human endeavor

### 3: Good/Service Of The Brand Used/Desired By Individual: Colleges A, B, C . . .

### 4: Brands: Colleges A, B, C, . . .

5: The Individual's Performance: Participating in after-school activities relating to the career pursuit

### 6: Public View Of The Meosk Structure: None

Once the career-specific meosk structure has been created and maintained for a period of time, the individual user can link (or other generate in pdf format and attach) a private activity-specific meosk structure to ones college application, as described hereinabove, to provide evidentiary support that the individual's claimed interests are deep, sincere and true.

In this use case example, the system network of the present invention allows an individual to select an interest such as learning about science and math as a student, or teaching science and math (STEM subjects) in a high school environment, select product/service brands which the individual uses, and the system network automatically generates requests/invitations and sends the invitations to the selected brands for sponsorship, collecting information about this activity in one's private activity-specific meosk structure.

Illustrative Use Case No. 7: Wherein an Individual Creates a Career-Path-Specific Meosk Structure Having a Preprogrammed Content Channel about which Individual User Content can be Collected and Organized

### Exemplary Use Case Profile:

### 1: Individual: High School Student

2: Interest/Activity: Pursuing a career in a particular field of study or human endeavor

### 3: Good/Service Of The Brand Used/Desired By Individual: Computers, Smartphone and Soda

### 4: Sponsoring Brands: Colleges A, B, C, . . .

5: The Individual's Performance: Participating in after-school activities relating to the college pursuit.

### 6: Public View Of The Meosk Structure: None

In this use case, an activity-specific meosk structure is created and deployed in the form of a career-path-specific meosk structure having one or more preprogrammed brand (subject content) channels, about which individual user and subject-specific content can be collected and organized, and designed to influence the career path of individuals in a positive manner. Here, the activity-specific meosk structure deployed on the system network has one or more integrated pre-programmed channels, managed by producers working in the interests of brand sponsors, illustrating how individuals can learn about various topics, events and opportunities relating to the interest or activity for which the private meosk structure was created and deployed.

The system network of the present invention allows any individual to select an interest such as learning about science and math as a student, or teaching science and math in a high school environment, select product/service brands which the individual uses, or wishes to use, and the system network, driven by a robust Activity/Interest/Product/Service/Brand-indexed database, as illustrated in FIGS. 39D-2 through 39D-8, and supported within the RDBMS 5, automatically generates requests/invitations and sends the invitations to the selected brands for sponsorship, collecting information about this activity in one's private activity-specific meosk structure.

It is understood diverse kinds of college or career type activity-specific meosk structures can be created and deployed on the system of the present invention, and each such meosk structure can have an integrated programmed subject content channel relating to the particular kind of activity on which the meosk structures has been created and deployed. Such programmed content channels could include, for example, business, finance, marketing, sports, music, performing arts, etc. In the case of a performing arts channel, the content might explain to the audience/individuals how to get on stage, in front of a camera, behind a camera, how to maintaining and care for a particular instrument, etc. with limitless possibilities.

Illustrative Use Case No. 8: Wherein a Product or Service Brand Team Creates a Activity-Specific Weosk Structure Having a Preprogrammed Content and Questions about Products and/or Services and Adapted to Collect and Organize their Responses and Comments to Focus Group Questions within the Weosk Structure

In this use case, an activity-specific weosk structure is created and deployed in the form of an activity-specific weosk structure having a preprogrammed content channel and other media asking questions about products and/or services, or issues of one kind or another, and collecting and organizing focus group responses within the weosk structure itself, for subsequent analysis and study by marketers and research analysts. The weosk master could be a brand manager or team member of a product or service brand team, or anyone interested in conducting focus groups within activity-specific weosk structures of the present invention. Also, the weosk structure could be configured so that inner circle members are selected by the brand for a focus group, and their responses/comments etc are contained in the weosk structure. Alternatively, inner circle members could be permitted to add members to the inner circle to bring more views and perspectives on a particular topic or subject of interest.

The above use cases are simply examples of how activity-specific meosk structures and weosk structures might be used on the system network of the present invention, and there will certainly be thousands of alternative uses for this meosk/weosk private and social media management and communication system/platform. In the illustrative embodiments shown in the Figure Drawings, the parent/child and family ecosystem use case was explored in significant detail, but this use case example, too is only illustrative of possible ways of using and practicing the principles of the present invention disclosed and taught herein, and those having the benefit of reviewing the present patent Specification and learning from the teachings contained therein will readily think of alternative embodiments and modifications which fall within the scope and spirit of the present invention.

### Methods of Publicly Viewing Private Activity-Specific Meosk Structures Created and Deployed on the System Network by Meosk Masters

In the illustrative embodiments of activity-specific meosk structures described hereinabove, specified moments (logically) stored in such meosk structures can be posted individually on social network and media sites of the meosk master, and guest inner circle members where authorized by the meosk master, for viewing by others who have adequate privileges on such social network sites, relative to the meosk master or guest inner circle member, as the case may be. This moment social-network posting feature is illustrated in FIGS. 16E, 17I, 18E, 19E, 20G, 25D, 26E, 27E, 28E, 29E, 30G, 31R, 32T, 49H, 50D, 51D, 52D, 54V. Also, if desired and authorized by the meosk master, the entire meosk structure itself can be posted on social network, as well as any other URL-specific location on the WWW by simply exporting the meosk structure's public URL and sharing and trafficking the URL to the target location in the html fabric of the WWW, for embedding, wherever that might be in any given case. The meosk structure's public URL can also be embedded in portable documents such as pdf documents, digital images, sound files, character-based files, binary files, and virtually any kind of digitally-implemented document type. Such documents with embedded URLs can be transported and shared with others using diverse file transport/sharing methods and technologies and ultimately viewed using any appropriate program capable of interpreting the schema of the document (i.e. file), and supporting a web-browser program for the viewing of the public view of the activity-specific meosk structure.

In alternative embodiments, it will be desirable to publish a public view of a meosk structure or weosk structure, where only selected moments and related content are selected by the meosk master for viewing by the public through the display schema of the meosk structure, or weosk structure, as the case may be.

Referring to FIGS. 91A through 91F, a public meosk/weosk structure viewing mechanism, supported on an extended functionality embodiment of the system network of the present invention, will now be described in great detail.

In general, the public viewing method supported by the system network of the present invention involves configuring and displaying a public view of an activity-specific meosk structure, in accordance with the method illustrated in FIG. 95, with reference to the GUI screens illustrated in FIGS. 91A through 91F.

As indicated at Block A in FIG. 95, the first step of the method involves the meosk master enabling the “public viewing mode” of a selected activity-specific meosk structure. In the illustrative embodiment this is done by selecting the “public viewing mode” icon from the footer control module of Christopher's FM meosk structure, illustrated in FIG. 91A.

As shown in FIG. 91B, a GUI screen displays an array of selectable panels, each labeled with the name assigned to each of the moment stores enabled/activated in the selected meosk structure (e.g. Christopher's FM Meosk Structure). The purpose of this GUI screen is to allow the meosk master to select certain moments, if not all of them, and related content in the meosk structure for the public viewing thereof in the published meosk structure located on the WWW at a specified public URL, after previewing and selecting the “publish” button on the GUI display screen shown in FIG. 91F.

As indicated at Block B in FIG. 95, the second step in the method involves the meosk master selecting each moment (i.e. digital content) stored in the activity-specific meosk structure, which is to be made part of the public view of the meosk structure, by selecting the “public post” tag associated with the selected moment. FIG. 91C shows a GUI screen displaying the selected “My Album” panel for the purpose of allowing the meosk master to select certain, if not all moments stored therein, to be published in the public view of the meosk structure.

As indicated at Block C in FIG. 95, the third step of the method involves the meosk master previewing the public view configured for the activity-specific meosk structure, and thereafter making any modifications that might desired or required to public post selections made at Block B. FIG. 91D shows the GUI screen for selecting of the “preview” mode of the my meosk module. FIG. 91E shows a GUI screen supported by the my meosk module, for displaying the preview of the configured public view for the selected meosk structure.

As indicated at Block D in FIG. 95, the fourth step of the method involves generating and publishing the “public view” of the activity-selected meosk structure, as configured at Blocks B and C above. The location of the public view of the meosk structure will be a WWW location specified by a public URL generated by the system network. The meosk master will share this public URL with others for embedding along the html fabric of the WWW, including web-based social networks, of which the meosk master and inner circle members are members.

As indicated at Block E in FIG. 95, the fifth step of the method involves, at some time after Block D, the meosk master deactivating the public view of the activity-selected meosk structure. FIG. 91F shows a GUI screen for selecting of the “publish” mode of the my meosk module, which will produce a new GUI screen indicating how and where the URL can downloaded.

The above described method of configuring and generating a “public view” for an activity-specific meosk structure, is just one illustrative method. There will be other methods of public meosk structure viewing that can be practiced in accordance with the spirit of the present invention.

Also, it is understand that all moments stored within deployed meosk structures, and weosk structures as well, are logically stored in the system RDBMS 5, while the actual digital data files associated therewith are stored on the clusters of distributed file servers used to implement the Apache Hadoop® distributed data file storage and retrieval system 15, or functionally equivalent file storage system(s), deployed on the system network of the present invention.

Also, when implementing a “public view” of a meosk structure, or any other view of data elements stored according to the schema of the system RDBMS 5, this operation will involve the viewing mechanism supported within RDBMS technology used to implement the system database 5 on the system network of the present invention. Notwithstanding, alternative database technologies may be used and viewing might be supported using different kinds of mechanisms that currently employed in conventional RDBMS technology.

### Modifications of the Illustrative Embodiments of the Present Invention

The present invention has been described in great detail with reference to the above illustrative embodiments. It is understood, however, that numerous modifications will readily occur to those with ordinary skill in the art having had the benefit of reading the present disclosure.

For example, in alternative embodiments of the present invention described hereinabove, the system can be realized as a stand-alone application, or as an application embedded within a social communication network. Such alternative system configurations will depend on particular end-user applications and target markets for products and services using the principles and technologies of the present invention.

These and all other such modifications and variations are deemed to be within the scope and spirit of the present invention as defined by the accompanying Claims to Invention.

1. A meosk/weosk-based private and social media management and communication system network for creating and deploying (i) a plurality of activity-specific meosk structures for organizing and managing information-based moments related to the activities of individuals and (ii) a plurality of activity-specific weosk structures for organizing and managing information-based moments related to the activities of group of individuals sharing an interest in a common activity, said meosk/weosk-based private and social media management and communication system network comprising:
a plurality of communication servers, operably connected to the infrastructure of the Internet, for supporting http and other TCP/IP based communication protocols on said meosk/weosk-based private and social media management and communication system network;
a plurality of client systems operably connected to the infrastructure of the Internet, and each said client subsystem having a computing platform and a display screen for displaying graphical user interfaces (GUIs) associated with one or more programs executing on said computing platform, and supporting services for system users on said system network;
a distributed information file storage and retrieval system including (i) a relational database management system (RDBMS) for organizing information files associated with information-based moments organized and managed in each said activity-specific meosk structure and each said activity-specific weosk structure created and deployed on said meosk/weosk-based private and social media management and communication system network, and (ii) information storage devices for storing the information files associated with said information-based moments organized in said plurality of activity-specific meosk structures and said plurality of activity-specific weosk structures;
one or more object-oriented application servers operably connected to the infrastructure of the Internet and said RDBMS, for storing and executing modules of object-oriented code and generating processes having a server-side and a client-side and supporting a graphical user interface (GUI) based environment available on said client-side and displayed on said client systems;
wherein each said client subsystem supports the client-side of said processes generated by said one or more modules of object-oriented code executing on said one or object-oriented application servers; and
wherein said object-oriented application servers and said modules are configured so that system users can receive the following enumerated services, through said GUI screens displayed on the display screen of each said client system:
(1) enabling each individual to register as a system user on said meosk/weosk-based private and social media management and communication system network, and automatically create and assign a system network user account to said system user upon completing registration on said meosk/weosk-based private and social media management and communication system network,
wherein said system network user account is stored and maintained within the information storage devices of said distributed information file storage and retrieval system, and
wherein said system user can be any individual seeking to use said meosk/weosk-based private and social media management and communication system network while pursuing ones interests and activities during ones life, as well as any brand management team member seeking to use said meosk/weosk-based private and social media management and communication system network while promoting a particular brand of products and/or services on the WWW;
(2) enabling any said system user to create and deploy an activity-specific meosk structure for organizing and managing information-based moments related to the activities of an individual,
wherein each said activity-specific meosk structure is assigned an activity specific (AS) code identifying the activity for which said activity-specific meosk structure is being created and deployed,
wherein the system user creating and deploying said activity-specific meosk structure identifies and invites one or more other system users to be inner circle members who shall have access to information-based moments organized and managed within said activity-specific meosk structure,
wherein transmission of the invitation by said system user (i.e. meosk master) to said other system users, to join the inner circle of said activity-specific meosk structure, can be sent using (i) a messaging facility supported on said meosk/weosk-based private and social media management and communication system network, (ii) an active email address supported on the Internet, and (iii) an active SMS account supported by one of said client systems;
wherein said one or more system users identified as said inner circle members shall include the system user creating said activity-specific meosk structure, who shall also be identified as a or master administrator of said activity-specific meosk structure, or its meosk master,
wherein the system user creating and deploying said activity-specific meosk structure identifies and invites one or more other system users to be inner circle members, who shall have access to information-based moments organized and managed within said activity-specific meosk structure,
wherein transmission of the invitation by said system user (i.e. meosk master) to said other system users, to join the inner circle of said activity-specific meosk structure, and acceptance or rejection thereof can be transmitted using (i) a messaging facility supported on said meosk/weosk-based private and social media management and communication system network, (ii) an active email address supported on the Internet, and (iii) an active SMS account supported by one of said client systems;
wherein said activity-specific meosk structure contains a plurality of moment store icons logically representing different locations where information-based moments can be organized and managed, while information files, corresponding to said information-based moments, are stored in the information storage devices of said distributed information file storage and retrieval system,
wherein each said moment store icon indicates a unique location where a collection of moment icons is grouped, and
wherein each said moment icon represents at least one said information-based moment having a corresponding information file that is stored in the information storage devices of said distributed information file storage and retrieval system;
(3) enabling any said system user to create and deploy an activity-specific weosk structures for organizing and managing information-based moments related to the activities of group of individuals sharing an interest in or around a common activity,
wherein each said activity-specific weosk structure is assigned an activity specific (AS) code identifying the activity for which said activity-specific weosk structure is being created and deployed,
wherein the system user, creating and deploying said activity-specific weosk structure, identifies one or more system users to be inner circle members who shall have access to the information-based moments organized and managed within said activity-specific weosk structure,
wherein said one or more system users identified as said inner circle members shall include the system user creating said activity-specific weosk structure, who shall also be identified as a master administrator of said activity-specific weosk structure, or its weosk master,
wherein the system user creating and deploying said activity-specific weosk structure identifies and invites one or more other system users to be inner circle members, who shall have access to information-based moments organized and managed within said activity-specific weosk structure,
wherein transmission of the invitation by said system user (i.e. weosk master) to said other system users, to join the inner circle of said activity-specific weosk structure, and acceptance or rejection thereof, can be transmitted using (i) a messaging facility supported on said meosk/weosk-based private and social media management and communication system network, (ii) an active email address supported on the Internet, and (iii) an active SMS account supported by one of said client systems;
wherein said activity-specific weosk structure contains a plurality of moment store icons logically representing different locations where information-based moments can be organized and managed, while information files, corresponding to said information-based moments, are stored in the information storage devices of said distributed information file storage and retrieval system,
(4) enabling any system user to capture an information-based moment using moment capture tools accessed on one of the client machines deployed on said meosk/weosk-based private and social media management and communication system network, store the information file corresponding to the captured information-based moment in the information storage devices of said distributed information file storage and retrieval system, and organize and manage the moment icon associated with the captured information-based moment within one of said activity-specific meosk structures.

2. The meosk/weosk-based private and social media management and communication system network of claim 1, wherein said object-oriented application servers and said modules are configured so that system users can further receive the following services, through said GUI screens displayed on the display screen of each said client system:
(5) enabling any system user to capture an information-based moment using a moment capture tool accessed from within one of said activity-specific meosk structures deployed on said meosk/weosk-based private and social media management and communication system network, store the information file corresponding to the captured information-based moment in the information storage devices of said distributed information file storage and retrieval system, and organize and manage the moment icon associated with the captured information-based moment within said activity-specific meosk structure; and
(6) enabling any system user to capture an information-based moment using a moment capture tool accessed from within one of said activity-specific weosk structures deployed on said meosk/weosk-based private and social media management and communication system network, store the information file corresponding to the captured information-based moment in the information storage devices of said distributed information file storage and retrieval system, and organize and manage the moment icon associated with the captured information-based moment within said activity-specific weosk structure.

3. The meosk/weosk-based private and social media management and communication system network of claim 2, wherein said object-oriented application servers and said modules are configured so that system users can further receive the following services, through said GUI screens displayed on the display screen of each said client system:
(7) enabling any system user, who is an inner circle member to any one of said activity-specific meosk structures, to use a messaging facility supported within said activity-specific meosk structure for sending messages to and receiving messages from other members in the inner circle of said activity-specific meosk structure;
(8) enabling any system user, who is an inner circle member to any one of said activity-specific weosk structures, to use a messaging facility supported within said activity-specific weosk structure for sending messages to and receiving messages from other members in the inner circle of said activity-specific weosk structure;
(9) enabling any system user, who is an inner circle member of one said activity-specific meosk structures, to organize and manage the moment icons assigned to information-based moments within said activity-specific meosk structure, while corresponding information files associated with these information-based moments are stored in the information storage devices of said distributed information file storage and retrieval system;
(10) enabling any system user, who is an inner circle member of one said activity-specific meosk structures, to access and review said information-based moments having moment icons organized and managed within said activity-specific meosk based structures, while corresponding information files are stored in the information storage devices of said distributed information file storage and retrieval system.

4. The meosk/weosk-based private and social media management and communication system network of claim 3, wherein said object-oriented application servers and said modules are configured so that system users can further receive the following services, through said GUI screens displayed on the display screen of each said client system:
(11) enabling any system user, who is an inner circle member of one said activity-specific meosk structures, to attach a note to any information-based moment organized and managed within said activity-specific meosk structure, while the information file corresponding to the note is stored in the information storage devices of said distributed information file storage and retrieval system;
(12) enabling any system user, who is an inner circle member of one of said activity-specific meosk structures, to attach an information-based moment to any information-based moment having moment icons organized and managed in said activity-specific meosk structure, while the information file corresponding to the information-based moment is stored in the information storage devices of said distributed information file storage and retrieval system.

5. The meosk/weosk-based private and social media management and communication system network of claim 3, wherein said object-oriented application servers and said modules are configured so that system users can further receive the following services, through said GUI screens displayed on the display screen of each said client system:
(13) enabling any system user, who is an inner circle member of one said activity-specific meosk structures, to affix a favorite index to any selected information-based moment having a moment icon organized and managed within said activity-specific meosk structure, while the information file corresponding to the favorite index is stored in the information storage devices of said distributed information file storage and retrieval system.

6. The meosk/weosk-based private and social media management and communication system network of claim 3, wherein said object-oriented application servers and said modules are configured so that system users can further receive the following services, through said GUI screens displayed on the display screen of each said client system:
(14) enabling any system user, who is an inner circle member of one said activity-specific meosk structures, to grab information-based moments located on one or more of social networks deployed on said WWW, and copy and store the information-based moments in the information storage devices of said distributed information file storage and retrieval system, while organizing and managing the moment icons corresponding to the grabbed and copied information-based moments under the moment store icons of said activity-specific meosk structure.

7. The meosk/weosk-based private and social media management and communication system network of claim 3, wherein said object-oriented application servers and said modules are configured so that system users can further receive the following services, through said GUI screens displayed on the display screen of each said client system:
(15) enabling any system user, who is an inner circle member of one said activity-specific meosk structures, to share said information-based moments having moment icons organized and managed within said activity-specific meosk structure, with selected inner circle members of said activity-specific meosk based structure, while information files corresponding to the shared information-based moments are stored in the information storage devices of said distributed information file storage and retrieval system;
wherein said sharing of said information-based moments among inner circle members involves sending each inner circle member a notification that an information-based moment has been sent.

8. The meosk/weosk-based private and social media management and communication system network of claim 3, wherein said object-oriented application servers and said modules are configured so that system users can further receive the following services, through said GUI screens displayed on the display screen of each said client system:
(16) enabling any system user, who is an inner circle member of one said activity-specific meosk structures, to post on one or more of said social networks, one or more of said information-based moments having moment icons organized and managed within said activity-specific meosk structure, while the information files corresponding to the posted moments are stored in the information storage devices of said distributed information file storage and retrieval system.

9. The meosk/weosk-based private and social media management and communication system network of claim 3, wherein said object-oriented application servers and said modules are configured so that system users can further receive the following services, through said GUI screens displayed on the display screen of each said client system:
(19) enabling any system user, who is an inner circle member of one of said activity-specific meosk structures, and a master user of said activity-specific meosk structure, to allow guest users in the inner circle of said activity-specific meosk structure to add other system users to, or remove system users from, the inner circle of said activity-specific meosk structure, to either expand or reduce the inner circle thereof, respectively.

10. The meosk/weosk-based private and social media management and communication system network of claim 3, wherein said object-oriented application servers and said modules are configured so that system users can further receive the following services, through said GUI screens displayed on the display screen of each said client system:
(20) enabling any system user, who is a master user of one of said activity-specific weosk structures, to configure said object-oriented application servers and said modules so that a private activity-specific meosk structure is automatically created and deployed for each inner circle member of said activity-specific weosk structure;
whereupon the inner circle member tags and copied selected moments in said activity-specific weosk structure using tag an copy icons within said activity-specific weosk structure, while information files corresponding to tagged and copied moments are stored in the information storage files of said distributed information file storage and retrieval system, and moment icons for the tagged and copied information-based moments appear in said private activity-specific meosk structure, while information filed corresponding to said tagged and copied moment icons are stored in the information storage devices of the distributed information storage and retrieval system.

11. The meosk/weosk-based private and social media management and communication system network of claim 3, wherein said object-oriented application servers and said modules are configured so that system users can further receive the following services, through said GUI screens displayed on the display screen of each said client system:
(21) enabling any system user, who is a master user of one of said activity-specific weosk structures, to allow guest users to tag information-based moments having moment icons organized and managed within a first one of said activity-specific meosk structures, and to copy the tagged information-based moments to a second one or said activity-specific meosk structures, while the information files corresponding to the tagged and copied information-based moments are stored in the information storage devices of said distributed information file storage and retrieval system.

12. The meosk/weosk-based private and social media management and communication system network of claim 3, wherein said object-oriented application servers and said modules are configured so that system users can further receive the following services, through said GUI screens displayed on the display screen of each said client system:
(22) enabling any system user, who is a master user of one of said activity-specific meosk structures, to link a selected one of said activity-specific meosks structures to a particular event marked on a calendar maintained for said activity-specific meosk structure, deployed on said meosk-based private and social media management and communication system network.

13. The meosk/weosk-based private and social media management and communication system network of claim 3, wherein said object-oriented application servers and said modules are configured so that system users can further receive the following services, through said GUI screens displayed on the display screen of each said client system:
(23) enabling any system user, who is a master user of one of said activity-specific weosk structures, to link a first selected one of said activity-specific meosk structures to a second selected one of said activity-specific meosk structures, deployed on said meosk-based private and social media management and communication system network.

14. The meosk/weosk-based private and social media management and communication system network of claim 3, wherein said object-oriented application servers and said modules are configured so that system users can further receive the following services, through said GUI screens displayed on the display screen of each said client system:
(24) during or after the creation and deployment of each activity-specific meosk structure, the system user creating said activity-specific meosk structure (i.e. meosk master) is (i) presented with one or more GUI screens displaying a generic list of products and/or services, related to the practice of the activity identified by the activity code assigned to said activity-specific meosk structure, and (ii) requested to select one or more brands of product and/or services about which said meosk master would like to receive information and/or contact from the brand by way of messaging services supported on said meosk/weosk-based private and social media management and communication network.

15. The meosk/weosk-based private and social media management and communication system network of claim 3, wherein said object-oriented application servers and said modules are configured so that system users can further receive the following services, through said GUI screens displayed on the display screen of each said client system:
(25) enabling any system user, who is a master user of one of said activity-specific meosk structures, to enabling a media-player implemented brand channel supported within said activity-specific meosk structure so that members of the inner circle of said activity-specific meosk structure can view videos and other programmed media played by said media-player implemented brand channel, and wherein the brands which said system user has selected for brand contact have a right to contribute to the programming of said media-player implemented brand channel.

16. The meosk/weosk-based private and social media management and communication system network of claim 3, wherein said object-oriented application servers and said modules are configured so that system users can further receive the following services, through said GUI screens displayed on the display screen of each said client system:
(26) enabling any system user, who is a master user of one of said activity-specific meosk structures, to enabling a media-player implemented favorites channel supported within said activity-specific meosk structure so that members of the inner circle of said activity-specific meosk structure can view information-based moments indexed as favorite, can be programmed into and displayed for viewing from said media-player implemented favorites channel.

17. The meosk/weosk-based private and social media management and communication system network of claim 3, wherein said object-oriented application servers and said modules are configured so that system users can further receive the following services, through said GUI screens displayed on the display screen of each said client system:
(27) enabling any system user, who is a master user of one of said activity-specific meosk structures, to enabling the generation of journey books, each composed of moments selected from particular said activity-specific meosk structures, which the meosk master has created and deployed.

18. The meosk/weosk-based private and social media management and communication system network of claim 3, wherein said object-oriented application servers and said modules are configured so that system users can further receive the following services, through said GUI screens displayed on the display screen of each said client system:
(28) enabling any system user, who is an inner circle member of one of the activity-specific meosk structures, to send information-based moments to another system user who is a master user of one the activity-specific meosk structure, by way of user-specific SMS message delivery method supported on said system network.

19-59. (canceled)

60. An Internet-based system for creating, deploying and managing activity-specific meosk structures, wherein the individual user is prompted to select an interest or activity around which to create and deploy an activity-specific meosk structure, and thereafter, in response to the activity selection by the individual user, the system automatically generates and displays the following items in a graphical user interface (GUIs):
(i) a set of generic groups or classes of equipment/goods and/or services that are typically required or used in connection with the selected activity and/or interest; and also
(ii) a set of particular brands for each generic group or class of equipment/goods required by the selected activity, from which the individual is requested to select a favorite brand and provide permission to be contacted by the brand for relationship building and other marketing communication purposes which may include, but are not limited to, brand support and sponsorship during the individual's pursuit of his or her activity, for which said activity-specific meosk structure has been created.

61-62. (canceled)

63. An Internet-based method of creating, deploying and managing activity-specific meosk structures, wherein the individual user is prompted to select an interest or activity around which to create and deploy an activity-specific meosk structure, and thereafter, in response to the activity selection by the individual user, the system automatically generates and displays the following items in a graphical user interface (GUIs):
(i) a set of generic groups or classes of equipment/goods and/or services that are typically required or used in connection with the selected activity and/or interest; and also
(ii) a set of particular brands for each generic group or class of equipment/goods required by the selected activity, from which the individual is requested to select a favorite brand and provide permission to be contacted by the brand for relationship building and other marketing communication purposes which may include, but are not limited to, brand support and sponsorship during the individual's pursuit of his or her activity, for which the activity-specific meosk structure has been created.

64.-69. (canceled)
